(19) United States
(12) Patent Application Publication
(10) Pub. No.: US 2021/0198603 A1
(43) Pub. Date: Jul. 1, 2021

(54) ALCOHOLIC BEVERAGES PRODUCED FROM INDIVIDUAL COMPONENTS

(71) Applicant: Ava Food Labs, Inc., San Francisco, CA (US)

(72) Inventors: Mardonn Carl Chua, San Francisco, CA (US); Alec Kremonic Lee, San Francisco, CA (US); Joshua Canaria Decolongon, San Francisco, CA (US); Ethan Charles Beswick, San Francisco, CA (US); Leslie P. Silva, Emeryville, CA (US); Jillian Angela Jastrzembski, San Francisco, CA (US); Taylor Shulman, Berkeley, CA (US); Erica Nicole Bilodeau, San Carlos, CA (US); Joshua Lundquist, Dublin, CA (US)

(21) Appl. No.: 16/971,533

(22) PCT Filed: Feb. 22, 2019
(86) PCT No.: PCT/US2019/019314

§ 371 Date: Aug. 20, 2020

Related U.S. Application Data
(60) Provisional application No. 62/634,784, filed on Feb. 23, 2018.

(51) Int. Cl. C12G 3/02; C12G 3/04

(52) U.S. Cl. CPC C12G 3/02; C12G 3/04

(57) ABSTRACT

Materials and methods for producing alcoholic beverage replicas from individual components are provided herein.

### CROSS-REFERENCE TO RELATED APPLICATIONS

This application is a National Stage application under 35 U.S.C. § 371 of International Application No. PCT/US2019/019314 having an International Filing Date of Feb. 22, 2019, which claims benefit of priority from U.S. Provisional Application Ser. No. 62/634,784, filed Feb. 23, 2018.

### TECHNICAL FIELD

This document relates to materials and methods for producing alcoholic beverages (e.g., wines and spirits) from individual components.

### BACKGROUND

Traditional methods for producing alcoholic beverages are often lengthy and costly, involving the harvesting of fastidious crops, followed by processing, fermenting, and aging steps. Each component of the traditional process has an inherent variability and risk, including climate, crop disease, and contamination, which can render such methods and their resulting products inconsistent. The use of traditional wine production methods requires difficult controls for variability, often involving adulteration of the final product with ingredients to mask imperfections.

### SUMMARY

This document is based, at least in part, on the discovery that compounds that contribute to the flavor and aroma of various alcoholic beverages (e.g., white wines, red wines, blush wines, and spirits) can be identified and combined to yield alcoholic beverage replicas that have the taste, aroma, and other characteristics of traditionally generated alcoholic beverages. Because each ingredient is added individually, the methods disclosed herein can reduce many of the risks and variability associated with traditional production of alcoholic beverages. In some cases, one or more ingredients (e.g., at least 50%, 60%, 70%, 80%, 90%, 95%, 99%, or 100% of the ingredients) can be highly defined (e.g., by lot analysis). In some cases, one or more ingredients (e.g., at least 50%, 60%, 70%, 80%, 90%, 95%, 99%, or 100% of the ingredients) can be highly pure (e.g., at least 90%, 95%, 96%, 97%, 98%, 99%, 99.5%, or 99.9% pure). The methods also can provide infinite reproducibility of a recipe, which is not possible with traditional production methods. Further, the methods described herein allow for unique flexibility in optimization of the flavors, aromas, and textures of alcoholic beverages, and greatly reduce or even eliminate the possibility that the resulting beverages will contain detrimental or undesired components. Moreover, the methods disclosed herein differ from currently existing methods in that they are rapid, reproducible, and cost-effective.

Traditional alcoholic beverages are complex mixtures on a chemical level. In some aspects, this document provides alcoholic beverage replicas that are less complex than a traditional alcoholic beverage. It was surprising that the replicas disclosed herein, do not need to have the complexity of a traditional alcoholic beverage in order to be perceived as such. It was also surprising that some compounds, which by themselves have an unpleasant taste and/or smell, can enhance the taste and/or smell of the alcoholic beverage replicas disclosed herein. Non-limiting examples of such components include isovaleric acid (which has been associated with foot smell) and butyric acid (which has been associated with the smell of vomit). It was further surprising that the exclusion of some compounds found in all tested traditional alcoholic beverages was not detrimental to the alcoholic beverage replicas described herein. Similarly, it was surprising that some compounds that were not found in any tested traditional alcoholic beverage could be beneficial to the alcoholic beverage replicas described herein. It was also surprising that alcoholic beverage replicas described herein containing some compounds in amounts greater than the highest measured amount in any tested traditional alcoholic beverage or lower than the lowest measured amount in any tested traditional alcoholic beverage were superior to replicas that contained the same compounds in amounts within the measured range of traditional alcoholic beverage. Therefore, in another aspect, this document provides alcoholic beverage replicas that are not mere replicas of existing products, but instead provide a similar sensory experience with a different chemical composition.

In one aspect, this document features an alcoholic beverage replica that includes ethanol, water, and one or more additional volatile organic compounds (VOCs), where the one or more additional VOCs include at least one VOC that is not present in a corresponding traditional alcoholic beverage. In some cases, the one or more additional VOCs do not include at least one VOC that is present in a corresponding traditional alcoholic beverage. This document also features an alcoholic beverage replica that includes ethanol, water, and one or more additional VOCs, where the one or more additional VOCs do not include at least one VOC that is present in a corresponding traditional alcoholic beverage.

The one or more additional VOCs can include one or more, two or more, three or more, four or more, five or more, six or more, or all seven of butyl formate, ethyl octanoate, ethyl propionate, ethyl-2-methylbutyrate, isoamyl acetate, isoamyl alcohol, and isobutanol. In some cases, the one or more additional VOCs include no more than six, no more than five, or no more than four of butyl formate, ethyl octanoate, ethyl propionate, ethyl-2-methylbutyrate, isoamyl acetate, isoamyl alcohol, and isobutanol.

The alcoholic beverage replica can further include one or more non-volatile compounds, where the one or more non-volatile compounds include at least one compound that is not present in a corresponding traditional alcoholic beverage. The alcoholic beverage replica can further include one or more non-volatile compounds, where the one or more non-volatile compounds do not include at least one non-volatile compound that is present in a corresponding traditional alcoholic beverage.

The one or more additional VOCs can include an ester; an acid; an alcohol; an aldehyde, a ketone, or an aldehyde and a ketone; a terpene, an isoprenoid, or a terpene and an isoprenoid; a phenol; a lactone; and an amine, a pyrazine, or an amine and a pyrazine. The one or more additional VOCs comprise one or more esters, one or more acids, one or more alcohols, one or more aldehydes or ketones, one or more terpenes or isoprenoids, one or more phenols, one or more lactones, one or more amines or pyrazines, and/or one or more thiols.

The alcoholic beverage replica can further include one or more non-volatile compounds. The one or more non-volatile compounds can have less than 90%, less than 80%, less than 70%, less than 60%, less than 50%, or less than 40% identity to the non-volatile compounds in a corresponding traditional alcoholic beverage.

The one or more additional VOCs can have less than 90%, less than 80%, less than 70%, less than 60%, less than 50%, or less than 40% identity to the VOCs in a single corresponding traditional alcoholic beverage.

The alcoholic beverage replica can lack one or more of Escherichia. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, heavy metal, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

In another aspect, this document features an alcoholic beverage replica that includes ethanol, water, and one or more non-volatile compounds, where the one or more non-volatile compounds include at least one compound that is not present in a corresponding traditional alcoholic beverage. In some cases, the one or more non-volatile compounds do not include at least one non-volatile compound that is present in a corresponding traditional alcoholic beverage. This document also features an alcoholic beverage replica that includes ethanol, water, and one or more non-volatile compounds, where the one or more non-volatile compounds do not include least one non-volatile compound that is present in a corresponding traditional alcoholic beverage.

The non-volatile compounds can have less than 90%, less than 80%, less than 70%, less than 60%, less than 50%, or less than 40% identity to the non-volatile compounds in a single corresponding traditional alcoholic beverage.

The alcoholic beverage replica can further include one or more additional VOCs. The one or more additional VOCs can include one or more, two or more, three or more, four or more, five or more, six or more, or all seven of butyl formate, ethyl octanoate, ethyl propionate, ethyl-2-methylbutyrate, isoamyl acetate, isoamyl alcohol, and isobutanol. In some cases, the one or more additional VOCs include no more than six, no more than five, or no more than four of butyl formate, ethyl octanoate, ethyl propionate, ethyl-2-methylbutyrate, isoamyl acetate, isoamyl alcohol, and isobutanol.

The one or more additional VOCs can include an ester; an acid; an alcohol; an aldehyde, a ketone, or an aldehyde and a ketone; a terpene, an isoprenoid, or a terpene and an isoprenoid; a phenol; a lactone; and an amine, a pyrazine, or an amine and a pyrazine. The one or more additional VOCs can include one or more esters, one or more acids, one or more alcohols, one or more aldehydes or ketones, one or more terpenes or isoprenoids, one or more phenols, one or more lactones, one or more amines or pyrazines, and/or one or more thiols.

The additional VOCs can have less than 90%, less than 80%, less than 70%, less than 60%, less than 50%, or less than 40% identity to the VOCs in a single corresponding traditional alcoholic beverage.

The alcoholic beverage replica can lack one or more of Escherichia. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, heavy metal, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the description below. Other features, objects, and advantages of the invention will be apparent from the description and from the claims.

### DETAILED DESCRIPTION

This document provides alcoholic beverage replicas (including, without limitation, wines such as red wines, white wines, blush wines, and sparkling wines, and spirits such as whiskey, tequila, sake, and rum), as well as methods for making alcoholic beverage replicas by combining water and ethanol with individual VOCs and non-volatile organic compounds. The alcoholic beverage replicas described herein have characteristics—including taste, aroma, mouthfeel, and appearance—of traditionally generated alcoholic beverages, and are meant to be consumed and enjoyed in the same manner as traditional alcoholic beverages. Alcoholic beverage replicas that can be made as described herein include, without limitation, red wines such as Syrah/Shiraz, Merlot, cabernet sauvignon, Malbec, pinot noir, and zinfandel; white wines such as Moscato, pinot grigio, Chardonnay, Sauvignon blanc, and Riesling; blush wines such as white zinfandel, blush Chablis, and red rosé; and spirits such as tequila, whiskey, vodka, gin, sake, baijiu, brandy, soju, and rum.

As used herein, the terms “traditional” and “reference” alcoholic beverages refer to alcoholic beverages produced through standard winemaking (vinification) and distilling processes that include the fermentation of plant matter such as corn, barley, peat, blue agave, and various fruits, including grapes. “Traditionally-produced” alcoholic beverages are alcoholic beverages that are generated using standard processes.

In some embodiments, an alcoholic beverage replica can consist of the ingredients included in a particular list, or can have a VOC content (or non-volatile compound content) that consists of the VOCs or non-volatile compounds included in a particular list. Further, an alcoholic beverage replica can consist essentially of the ingredients included in a particular list, or can have a VOC content (or non-volatile compound content) that consists essentially of the VOCs or non-volatile compounds that are included in a particular list. By “consisting essentially of” is meant that an alcoholic beverage replica contains specified ingredients/VOCs/non-volatile compounds, and can contain additional ingredients/VOCs/non-volatile compounds that do not materially affect the basic and novel characteristics of the alcoholic beverage replica.

In general, the alcoholic beverage replicas include the following components, or classes of components:

a) a source of water, either pure or with mineral content present to improve flavor;

b) a source of distilled ethanol with a concentration between about 20% and 100% weight by volume;

c) one or more VOCs; and

d) one or more non-volatile compounds.

Water is the main component of the replicas, acting as a solvent for all the other ingredients. The ethanol component provides the alcoholic content to the replicas. The VOCs can provide both aroma and flavor to the wine, including fruity, floral, earthy, herbaceous, oak, yeast, spice, and/or mineral aromas and flavors. The non-volatile components can provide acidity and much of the flavor, aftertaste, and mouthfeel perception of the replicas.

In some embodiments, an alcoholic beverage replica can include water, ethanol, and (a) one or more additional VOCs (i.e., VOCs in addition to ethanol), where the one or more additional VOCs are not present in a corresponding reference alcoholic beverage; (b) one or more additional VOCs, where the one or more additional VOCs do not include one or more VOCs that are present in a corresponding reference alcoholic beverage; (c) one or more non-volatile compounds, where the one or more non-volatile compounds are not present in a corresponding reference alcoholic beverage; (d) one or more non-volatile compounds, where the one or more non-volatile compounds do not include one or more non-volatile compounds that are present in a corresponding reference alcoholic beverage; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)].

In general, the alcoholic beverage replicas provided herein can have an ethanol content of about 3% to about 70% (v/v) (e.g., about 3% to about 7%, about 5% to about 10%, about 7% to about 12%, about 10% to about 20%, about 20% to about 30%, about 30% to about 40%, about 40% to about 50%, about 50% to about 60%, or about 60% to about 70% (v/v)). For example, a wine replica can have an ethanol content of about 3% to about 12% (v/v) (e.g., about 3%, about 4%, about 5%, about 6%, about 7%, about 8%, about 9%, about 10%, about 11%, about 12%, about 3 to 5%, about 4 to 6%, about 4.5 to 6.5%, about 5 to 7%, about 5.5 to 7.5%, about 6 to 8%, about 7 to 9%, about 8 to 10%, about 9 to 11%, about 10 to 12%, about 3 to 6%, about 4 to 7%, about 5 to 8%, about 5.5 to 9%, about 6 to 9%, about 6 to 9.5%, about 6.5 to 10%, about 7 to 10%, about 8 to 11%, or about 9 to 12% v/v). A spirit such as whiskey may have an ethanol content of about 30% to about 50% (v/v) (e.g., about 30% to about 35%, about 35% to about 40%, about 40% to about 45%, or about 45% to about 50%). Other alcoholic beverage replicas can have an ethanol content within any range between about 3% and about 70% (v/v).

It is to be noted, however, that the ethanol component can be omitted in order to generate a “non-alcoholic” version of an alcoholic beverage replica. In such ethanol-free embodiments, the amounts of the other components may be changed, and the ethanol may be replaced at least in part by water.

The additional VOCs present in an alcoholic beverage replica can include compounds that fall into several categories, including esters, acids, higher alcohols, terpenes/isoprenoids, phenols, lactones, amines/pyrazines, thiols/thiazoles/sulfides, ethers, acetals, and furans. In some embodiments, for example, an alcoholic beverage replica can include an ester and an alcohol (in addition to ethanol). In some embodiments, for example, an alcoholic beverage replica can contain VOCs that include an ester, an acid, an alcohol in addition to the ethanol, an aldehyde, ketone, or both, a terpene, isoprenoid, or both, a phenol, a lactone, and an amine, pyrazine, or both. It will be appreciated that any and all stereoisomers can be used when no stereochemistry is specified.

Esters, including ethyl, methyl, and acetate esters, can contribute to the fruity and floral characteristics of an alcoholic beverage. Esters that may be used in an alcoholic beverage replica include, without limitation, one or more of ethyl acetate, isoamyl acetate, ethyl lactate, 2-phenylethylacetate, ethyl octanoate, ethyl hexanoate, ethyl butyrate, butyl acetate, ethyl decanoate, dimethyl succinate, isobutyl acetate, butyl formate, ethyl laurate, ethyl isovalerate, ethyl valerate, linalyl butyrate, linalyl acetate, linalyl formate, hexyl acetate, ethyl cinnamate, methyl vanillate, 2-methylbutyl acetate, ethyl myristate, ethyl palmitate, ethyl-2-mercaptopropionate, ethyl isobutyrate, butyl isovalerate, ethyl-2-methylbutyrate, methyl octanoate, methyl salicylate, methyl laurate, ethyl undecanoate, ethyl propionate, ethyl-3-hydroxybutyrate, ethyl heptanoate, benzyl acetate, ethyl nonanoate, ethyl anthranilate, geranyl acetate, isoamyl octanoate, hexyl hexanoate, phenethyl propionate, phenethyl butyrate, phenethyl isobutyrate, phenethyl octanoate, methyl hexanoate, methyl decanoate, methyl dihydrojasmonate, amyl butyrate, ethyl phenyl acetate, ethyl-trans-2-butenoate, ethyl-trans-3-hexenoate, cis-3-hexenyl acetate, isoamyl hexanoate, octyl acetate, heptyl acetate, propyl hexanoate, amyl formate, citronellyl acetate, dimethyl succinate, geranyl acetate, and neryl acetate, and any combination thereof. Any appropriate number of esters can be used, for example, 1 to 100, 1 to 50, 1 to 25, 1 to 10, 1 to 5, 5 to 100, 5 to 50, 5 to 25, 5 to 10, 10 to 100, 10 to 50, 10 to 25, 25 to 50, 25 to 100. Esters can make up any suitable portion of the additional VOCs. In some embodiments, the one or more esters can be present in a total amount of about 0.009 mg/L to about 1.5 g/L (e.g., about 0.009 to about 0.05 mg/L, about 0.01 to about 0.05 mg/L, about 0.05 to about 0.1 mg/L, about 0.1 to about 0.5 mg/L, about 0.5 to about 1 mg/L, about 1 to about 2 mg/L, about 1 to about 5 mg/L, about 1 to about 10 mg/L, about 5 to about 10 mg/L, about 10 to about 20 mg/L, about 10 to about 50 mg/L, about 50 to about 100 mg/L, about 100 to about 200 mg/L, about 100 to about 500 mg/L, about 500 mg/L to about 1 g/L, about 1.0 g/L to about 1.5 g/L, or about 0.5 to about 1.5 g/L).

In some embodiments, an alcoholic beverage replica can include at least one (e.g., at least 2, at least 5, at least 10, at least 20, at least 30, at least 50, at least 75, at least 100, 1 to 5, 1 to 10, 1 to 25, 1 to 50, 1 to 100, 5 to 10, 5 to 25, 5 to 50, 5 to 100, 10 to 25, 10 to 50, 10 to 100, 25 to 50, 25 to 100, or 50 to 100) ester selected from the group consisting of 2-methylbutyl acetate, 2-methylbutyl isovalerate, 2-phenylethylacetate, 3-heptyl acetate, 3-methylthio hexyl acetate, 3-phenylpropyl acetate, allyl heptanoate, allyl hexanoate, amyl acetate, amyl butyrate, amyl formate, anisyl acetate, anisyl butyrate, benzyl acetate, benzyl benzoate, benzyl butyrate, benzyl formate, benzyl propionate, butyl acetate, butyl butyryllactate, butyl formate, butyl isovalerate, cis-3-hexenyl acetate, cis-3-hexenyl butyrate, cis-3-hexenyl caproate, cis-3-hexenyl valerate, citronellyl acetate, diethyl malate, diethyl succinate, dimethyl anthranilate, dimethyl succinate, ethyl 2-furoate, ethyl 2-trans-4-cis-decadienoate, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl hydrocinnamate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl pyruvate, ethyl salicylate, ethyl sorbate, ethyl undecanoate, ethyl valerate, ethyl(methylthio) acetate, ethyl-2-mercaptopropionate, ethyl-2-methylbutyrate, ethyl-3-hydroxybutyrate, ethyl-trans-2-butenoate, ethyl-trans-3-hexenoate, furfuryl acetate, geranyl acetate, geranyl butyrate, geranyl propionate, heptyl acetate, hexyl 3-methylbutanoate, hexyl acetate, hexyl butyrate, hexyl formate, hexyl hexanoate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, linalyl butyrate, linalyl formate, methionyl acetate (3-methylthio-propylacetate), methionyl butyrate, methyl acetate, methyl anthranilate, methyl benzoate, methyl cinnamate, methyl decanoate, methyl dihydrojasmonate, methyl hexanoate, methyl laurate, methyl octanoate, methyl salicylate, methyl vanillate, neryl acetate, octyl acetate, phenethyl 2-methylbutyrate, phenethyl acetate, phenethyl butyrate, phenethyl formate, phenethyl isobutyrate, phenethyl octanoate, phenethyl propionate, phenethyl tiglate, propyl acetate, propyl butyrate, propyl hexanoate, and propyl isovalerate.

In some embodiments, an alcoholic beverage replica can include at least one (e.g., at least 2, at least 5, at least 10, at least 20, at least 30, at least 50, at least 70, 1 to 5, 1 to 10, 1 to 25, 1 to 50, 1 to 70, 5 to 10, 5 to 25, 5 to 50, 5 to 70, 10 to 25, 10 to 50, 10 to 70, 25 to 50, 25 to 70, or 50 to 70) ester selected from the group consisting of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl malate, diethyl succinate, dimethyl anthranilate, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl undecanoate, ethyl valerate, ethyl(methylthio) acetate, ethyl-2-mercaptopropionate, ethyl-2-methylbutyrate, ethyl-3-hydroxybutyrate, ethyl-trans-2-butenoate, ethyl-trans-3-hexenoate, geranyl acetate, heptyl acetate, hexyl acetate, hexyl hexanoate, isoamyl acetate, isoamyl hexanoate, isoamyl isobutyrate, isoamyl isovalerate, isoamyl octanoate, isobutyl acetate, linalyl acetate, linalyl butyrate, linalyl formate, methyl acetate, methyl anthranilate, methyl decanoate, methyl dihydrojasmonate, methyl hexanoate, methyl laurate, methyl octanoate, methyl salicylate, methyl vanillate, octyl acetate, phenethyl acetate, phenethyl butyrate, phenethyl formate, phenethyl isobutyrate, phenethyl octanoate, phenethyl propionate, propyl acetate, propyl butyrate, and propyl hexanoate.

Acids may contribute to “sour” or “fermented” aromas or flavors, which can be important to the general character of an alcoholic beverage. Acids that may be included in an alcoholic beverage replica include, without limitation, octanoic acid, hexanoic acid, butyric acid, decanoic acid, isovaleric acid, isobutyric acid, propanoic acid, 3,7-dimethyl-6-octanoic acid, 3,7-dimethyl-6-octenoic acid, and any combination thereof. Any appropriate number of acids can be used, for example, 1 to 25, 1 to 10, 1 to 5, 5 to 25, 5 to 10, or 10 to 25. Acids can make up any suitable portion of the additional VOCs. In some embodiments, the one or more acids can be present in a total amount of about 0.03 mg/L to about 325 mg/L (e.g., about 0.03 to about 0.05 mg/L, about 0.05 to about 0.1 mg/L, about 0.1 to about 0.5 mg/L, about 0.5 to about 1 mg/L, about 1 to about 2 mg/L, about 1 to about 5 mg/L, about 1 to about 10 mg/L, about 5 to about 10 mg/L, about 10 to about 20 mg/L, about 10 to about 50 mg/L, about 50 to about 100 mg/L, about 100 to about 325 mg/L, about 100 to about 200 mg/L, about 200 to about 300 mg/L, or about 200 to about 325 mg/L).

In some embodiments, an alcoholic beverage replica can include at least one (e.g., at least 2, at least 3, at least 4, at least 5, 1 to 12, 1 to 10, 1 to 5, 2 to 12, 2 to 10, or 2 to 5) acid selected from the group consisting of 3,7-dimethyl-6-octanoic acid, 3,7-dimethyl-6-octenoic acid, butyric acid, decanoic acid, hexanoic acid, isobutyric acid, isovaleric acid, nonanoic acid, octanoic acid, phenylacetic acid, propanoic acid, and valeric acid.

In some embodiments, an alcoholic beverage replica can include at least one (e.g., at least 2, at least 3, at least 4, at least 5, 1 to 10, 1 to 5, 2 to 10, or 2 to 5) acid selected from the group consisting of 3,7-dimethyl-6-octanoic acid, 3,7-dimethyl-6-octenoic acid, butyric acid, decanoic acid, hexanoic acid, isobutyric acid, isovaleric acid, nonanoic acid, octanoic acid, and propanoic acid.

Higher alcohols (e.g., alcohols that are not ethanol) can provide various flavor and/or aroma components to alcoholic beverages, including banana, spice, grassiness, and oxidized characteristics. Higher alcohols also can be important for adding roundness to the general aroma of an alcoholic beverage, as well as some weight on the palate. Higher alcohols that can be present in the alcoholic beverage replicas provided herein include, without limitation, isoamyl alcohol, isobutanol, 2-phenylethanol, 2-methyl-1-butanol, propanol, cis-3-hexen-1-ol, 1-octen-3-ol, hexanol, benzyl alcohol, amyl alcohol, butanol, 3-methyl-1-pentanol, cis-2-hexenol, trans-2-hexen-1-ol, 1-decanol, 1-octanol, and any combination thereof. Any appropriate number of alcohols can be used, for example, 1 to 25, 1 to 10, 1 to 5, 5 to 25, 5 to 10, or 10 to 25. Alcohols can make up any suitable portion of the additional VOCs. In some embodiments, the one or more alcohols can be present in a total amount of about 0.08 mg/L to about 4.5 mg/L (e.g., about 0.08 to about 0.1 mg/L, about 0.1 to about 0.5 mg/L, about 0.5 to about 1 mg/L, about 1 to about 4 mg/L, about 1 to about 3 mg/L, about 1 to about 2 mg/L, about 0.5 to about 1.5 mg/L, about 1.5 to about 2.5 mg/L, about 2.5 to about 3.5 mg/L, or about 3.5 to about 4.5 mg/L).

In some embodiments, an alcoholic beverage replica can include at least one (e.g., at least 2, at least 5, at least 10, at least 20, at least 25, 1 to 5, 1 to 10, 1 to 25, 5 to 10, 5 to 25, or 10 to 25) alcohol selected from the group consisting of 1-decanol, 1-octanol, I-octen-3-ol, 2-(methylthio)ethanol, 2-heptanol, 2-methyl-1-butanol, 2-nonanol, 2-phenylethanol, 3-(methylthio)-1-propanol, 3-methyl-1-pentanol, amyl alcohol, anisyl alcohol, benzyl alcohol, butanol, cherry propanol, cis-2-hexenol, cis-3-hexen-1-ol, cis-5-octen-1-ol, cis-6-nonen-1-ol, DL-3-methyl-2-butanol, hexadecanol, hexanol, isoamyl alcohol, isobutanol, propanol, and trans-2-hexen-1-ol.

In some embodiments, an alcoholic beverage replica can include at least one (e.g., at least 2, at least 5, at least 10, at least 15, at least 20, 1 to 5, 1 to 10, 1 to 15, 1 to 20, 5 to 10, 5 to 15, 5 to 20, 10 to 15, or 10 to 20) alcohol selected from the group consisting of I-decanol, 1-octanol, 1-octen-3-ol, 2-(methylthio)ethanol, 2-methyl-1-butanol, 2-phenylethanol, 3-(methylthio)-1-propanol, 3-methyl-1-pentanol, amyl alcohol, benzyl alcohol, butanol, cis-2-hexenol, cis-3-hexen-1-ol, DL-3-methyl-2-butanol, hexadecanol, hexanol, isoamyl alcohol, isobutanol, propanol, and trans-2-hexen-1-ol.

Aldehydes and ketones can provide flavors and/or aromas that are important to the general character of alcoholic beverages. For example, acetaldehyde is a by-product of alcoholic fermentation that gives a vinous and oxidized aroma, diacetyl is a by-product of malolactic fermentation that provides a buttery flavor, and sotolon can provide a maple-like scent that is indicative in oxidized wines. Non-limiting examples of aldehydes/ketones that may be used in the alcoholic beverage replicas provided herein include acetaldehyde, acetaldehyde diethyl acetal, sotolon, diacetyl, isovaleraldehyde, acetal, benzaldehyde, furfural, maltol, nonanal, methional, 4-hydroxy-2,5-dimethyl-3(2H)-furanone, 2,3-pentadione, p-anisaldehyde, 2-methylbutyraldehyde, 2-nonanone, 2-heptanone, trans-2-pentenal, cinnamaldehyde, 3-nonen-2-one, trans-2-hexen-1-al, trans-2-heptenal, decanal, hexanal, 2,6-dimethyl-5-heptenal, phenethyl acetaldehyde dimethyl acetal, damascene, 2-undecanone, 4-(4-hydroxyphenyl)-2-butanone, and any combination thereof. Any appropriate number of aldehydes and/or ketones can be used, for example, 1 to 50, 1 to 25, 1 to 10, 1 to 5, 5 to 50, 5 to 25, 5 to 10, 10 to 50, 10 to 25, or 25 to 50. Aldehydes and/or ketones can make up any suitable portion of the additional VOCs. In some embodiments, the one or more aldehydes and/or ketones can be present in a total amount of about 0.02 mg/L to about 14 mg/L (e.g., about 0.02 to about 0.05 mg/L, about 0.05 to about 0.1 mg/L, about 0.1 to about 0.5 mg/L, about 0.5 to about 1 mg/L, about 1 to about 2 mg/L, about 1 to about 5 mg/L, about 5 to about 10 mg/L, or about 10 to about 14 mg/L).

In some embodiments, an alcoholic beverage replica can include at least one (e.g., at least 2, at least 5, at least 10, 1 to 50, 1 to 25, 1 to 10, 1 to 5, 5 to 50, 5 to 25, 5 to 10, 10 to 50, 10 to 25, or 25 to 50) aldehyde or ketone selected from the group consisting of 2,3-hexanedione, 2,3-pentadione, 2,6-dimethyl-5-heptenal, 2-acetyl-1-methylpyrrole, 2-heptanone, 2-methoxycinnamaldehyde, 2-methylbutyraldehyde, 2-nonanone, 2-octanone, 2-undecanone, 3-nonen-2-one, 3-phenylpropanal, 4-(4-hydroxyphenyl)-2-butanone, 4-hydroxy-2,5-dimethyl-3(2H)-furanone, 5-ethyl-3-hydroxy-4-methyl-2(5H)-furanone (maple furanone), 5-methyl furfural, 5-methyl-2-phenyl-2-hexenal, 6-methyl-5-hepten-2-one, acetaldehyde, acetoin, acetophenone, acetovanillone, benzaldehyde, butyraldehyde, cinnamaldehyde, cuminaldehyde, damascenone, decanal, diacetyl, furfural, hexanal, isobutyraldehyde, isovaleraldehyde, maltol, methional, methyl cyclopentenolone, methyl β-naphthyl ketone, methyl-2-pyrrolyl ketone, nonanal, octanal, p-anisaldehyde, phenylacetaldehyde, propanal, propionaldehyde, salicylaldehyde, sotolon, trans-2-heptenal, trans-2-hexen-1-al, trans-2-nonenal, trans-2-pentenal, and valeraldehyde.

In some embodiments, an alcoholic beverage replica can include at least one (e.g., at least 2, at least 5, at least 10, 1 to 25, 1 to 10, 1 to 5, 5 to 25, 5 to 10, or 10 to 25) aldehyde or ketone selected from the group consisting of 2,3-pentadione, 2-heptanone, 2-methylbutyraldehyde, 2-nonanone, 2-undecanone, 3-nonen-2-one, 5-ethyl-3-hydroxy-4-methyl-2(5H)-furanone (maple furanone), 5-methyl furfural, 6-methyl-5-hepten-2-one, acetaldehyde, acetoin, acetophenone, benzaldehyde, cinnamaldehyde, damascenone, diacetyl, furfural, isobutyraldehyde, isovaleraldehyde, maltol, methional, methyl cyclopentenolone, methyl β-naphthyl ketone, nonanal, p-anisaldehyde, phenylacetaldehyde, salicylaldehyde, trans-2-heptenal, trans-2-hexen-1-al, trans-2-pentenal, and valeraldehyde.

Terpenes and isoprenoids can contribute floral and green characteristics to, for example, wines, that may or may not be specific to a certain grape variety. For example, linalool can be important in aromatic grapes such as Muscat, while limonene can contribute citrus flavors. Terpenes and isoprenoids that can be included in the alcoholic beverage replicas provided herein include, without limitation, linalool, linalool oxide, limonene, damascenone, nerol, geraniol, citronellol, (−)-cis-rose-oxide, eucalyptol, gamma-terpinene, p-cymene, alpha-terpineol, alpha-ionone, (−)alpha-pinene, (−)beta-pinene, L/D-carvone (also called carvone, L-carvone, or D-carvone), 4-carvomenthenol, 3-carene, alpha-phellandrene, isoborneol, myrcene, myrtenol, beta-ionone, and any combination thereof. Any appropriate number of terpenes and/or isoprenoids can be used, for example, 1 to 40, 1 to 25, 1 to 10, 1 to 5, 5 to 40, 5 to 25, 5 to 10, 10 to 40, 10 to 25, or 25 to 40. Terpenes and/or isoprenoids can make up any suitable portion of the additional VOCs. In some embodiments, the one or more terpenes and/or isoprenoids can be present in a total amount of about 0.0002 mg/L to about 95 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 1 to about 10 mg/L, about 10 to about 20 mg/L, about 10 to about 30 mg/L, about 10 to about 50 mg/L, about 50 to about 95 mg/L, about 30 to about 50 mg/L, about 50 to about 70 mg/L, about 70 to about 90 mg/L, or about 70 to about 95 mg/L).

In some embodiments, an alcoholic beverage replica can include at least one (e.g., at least 2, at least 5, at least 10, 1 to 40, 1 to 25, 1 to 10, 1 to 5, 5 to 40, 5 to 25, 5 to 10, 10 to 40, 10 to 25, or 25 to 40) terpene or isoprenoid selected from the group consisting of (−)alpha-pinene, (−)cis-rose-oxide, 1,4-cineole, 3-carene, 4,5,6,7-tetrahydro-3,6-dimethylbenzofuran, 4-carvomenthenol, 4-ethylguaiacol, a-ionone, a-phellandrene, a-terpineol, b-caryophellene, beta pinene, beta-ionone, carvacrol, carvone, citral, citronellol, camascone, D-camphor, d-fenchone, eucalyptol, farnesol, gamma-terpinene, geraniol, geranyl acetone, isoborneol, limonene, linalool, linalool oxide, L-menthyl acetate, myrcene, myrtenol, nerol, nerolidol, p,a-dimethylstyrene, p-cymene, perillaldehyde, terpinolene, tetrahydrolinalool, thymol, and valencene.

In some embodiments, an alcoholic beverage replica can include at least one (e.g., at least 2, at least 5, at least 10, 1 to 40, 1 to 25, 1 to 10, 1 to 5, 5 to 40, 5 to 25, 5 to 10, 10 to 40, 10 to 25, or 25 to 40) terpene or isoprenoid selected from the group consisting of (−)alpha-pinene, (−)cis-rose-oxide, 3-carene, 4-carvomenthenol, 4-ethylguaiacol, a-ionone, a-phellandrene, a-terpineol, b-caryophellene, beta pinene, beta-ionone, carvone, citral, citronellol, D-camphor, eucalyptol, farnesol, gamma-terpinene, geraniol, geranyl acetone, isoborneol, limonene, linalool, linalool oxide, myrcene, myrtenol, nerol, nerolidol, p,a-dimethylstyrene, p-cymene, and terpinolene.

Phenols can contribute to the smoky characteristics that may be found in alcoholic beverages as a result of oak exposure, and they also can contribute earthy characteristics. Examples of phenols that can be used in the alcoholic beverage replicas described herein include, without limitation, guaiacol, 4-ethylphenol, 4-ethylguaiacol, eugenol, p-cresol, 2-methoxy-4-propyl-phenol, 2-methoxy-4-methylphenol, and any combination thereof. Any appropriate number of phenols can be used, for example, 1 to 10, 1 to 8, 1 to 5, 2 to 10, 2 to 8, 2 to 5, 3 to 5, 3 to 8, or 3 to 10). Phenols can make up any suitable portion of the additional VOCs. In some embodiments, the one or more phenols can be present in a total amount of 0.00007 mg/L to about 5 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 1 to about 3 mg/L, or about 3 to about 5 mg/L).

In some embodiments, an alcoholic beverage replica can include at least one (e.g., at least 2, at least 3, at least 4, at least 5, at least 6, at least 7, at least 8, 1 to 9, 1 to 7, 1 to 5, 1 to 3, 2 to 9, 2 to 7, 2 to 5, 2 to 3, 3 to 9, 3 to 7, or 3 to 5) phenol selected from the group consisting of 2,4,6-trimethylphenol (mesitol), 2-methoxy-4-methylphenol, 2-methoxy-4-propyl-phenol, 4-ethylphenol, 4-vinylphenol, eugenol, guaiacol, isoeugenol, and p-cresol.

In some embodiments, an alcoholic beverage replica can include at least one (e.g., at least 2, at least 3, at least 4, at least 5, at least 6, 1 to 7, 1 to 5, 1 to 3, 2 to 7, 2 to 5, 2 to 3, 3 to 7, or 3 to 5) phenol selected from the group consisting of 2,4,6-trimethylphenol (mesitol), 2-methoxy-4-methylphenol, 2-methoxy-4-propyl-phenol, 4-ethylphenol, eugenol, guaiacol, and p-cresol.

Lactones are mainly found in alcoholic beverages that have been exposed to oak, which is a common treatment for wines made from non-aromatic grapes such as Chardonnay, although lactones also may be present in other wine varieties. Non-limiting examples of lactones that can be included in the alcoholic beverage replicas provided herein include cis-whiskey lactone, gamma-decalactone, jasmine lactone, delta-decalactone, gamma-octalactone, gamma-nonalactone, gamma-undecalactone, gamma-dodecalactone, and any combination thereof. Any appropriate number of lactones can be used, for example, 1 to 10, 1 to 8, 1 to 5, 2 to 10, 2 to 8, 2 to 5, 3 to 5, 3 to 8, or 3 to 10). Lactones can make up any suitable portion of the additional VOCs. In some embodiments, the one or more lactones can be present in a total amount of about 0.00007 mg/L to about 10 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 1 to about 2 mg/L, about 2 to about 4 mg/L, about 4 to about 6 mg/L, about 6 to about 8 mg/L, or about 8 to about 10 mg/L).

In some embodiments, an alcoholic beverage replica can include at least one (e.g., at least 2, at least 3, at least 4, at least 5, at least 6, at least 7, at least 8, at least 9, at least 10, 1 to 13, 1 to 11, 1 to 9, 1 to 7, 1 to 5, 1 to 3, 2 to 13, 2 to 11, 2 to 9, 2 to 7, 2 to 5, 2 to 3, 3 to 13, 3 to 11, 3 to 9, 3 to 7, or 3 to 5) lactone selected from the group consisting of delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, jasmine lactone, omega-pentadecalactone, and whiskey lactone.

In some embodiments, an alcoholic beverage replica can include at least one (e.g., at least 2, at least 3, at least 4, at least 5, at least 6, at least 7, 1 to 8, 1 to 5, 1 to 3, 2 to 8, 2 to 5, 2 to 3, 3 to 8, or 3 to 5) lactone selected from the group consisting of delta-decalactone, gamma-decalactone, gamma-hexalactone, gamma-nonalactone, gamma-octalactone, gamma-undecalactone, Jasmine lactone, and whiskey lactone.

Amines and pyrazines can contribute unique characteristics that may be found in specific grapes. Pyrazines, for example, can contribute to the green bell pepper flavors found in grapes such as Sauvignon Blanc and Cabernet Sauvignon. Examples of amines and pyrazines that can be used in an alcoholic beverage replica as provided herein include, without limitation, 2-isobutyl-3-methoxypyrazine, 2-isopropyl-3-methoxypyrazine, methyl anthranilate, 2-acetylpyridine, dimethyl anthranilate, 2,6-dimethylpyrazine, and any combination thereof. Any appropriate number of amines and/or pyrazines can be used, for example, 1 to 10, 1 to 8, 1 to 5, 2 to 10, 2 to 8, 2 to 5, 3 to 5, 3 to 8, or 3 to 10). Amines and/or pyrazines can make up any suitable portion of the additional VOCs. In some embodiments, the one or more amines and/or pyrazines can be present in a total amount of 0.00007 mg/L to about 0.09 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.09 mg/L, about 0.01 to about 0.03 mg/L, about 0.03 to about 0.05 mg/L, about 0.05 to about 0.07 mg/L, or about 0.07 to about 0.09 mg/L).

In some embodiments, an alcoholic beverage replica can include at least one (e.g., at least 2, at least 3, at least 4, at least 5, at least 6, at least 7, at least 8, 1 to 9, 1 to 7, 1 to 5, 1 to 3, 2 to 9, 2 to 7, 2 to 5, 2 to 3, 3 to 8, or 3 to 5) amine or pyrazine selected from the group consisting of 2,5-dimethylpyrazine, 2,6-dimethylpyrazine, 2-acetylpyridine, 2-ethyl-3(5 or 6)-dimethylpyrazine, 2-ethyl-3-methylpyrazine, 2-isobutyl-3-methoxypyrazine, 2-isopropyl-3-methoxypyrazine, 2-methoxy-3-(1-methylpropyl) pyrazine, and indole.

In some embodiments, an alcoholic beverage replica can include at least one (e.g., at least two, 1 to 3, 1 to 2, or 3) amine or pyrazine selected from the group consisting of 2-acetylpyridine, 2-isobutyl-3-methoxypyrazine, and 2-isopropyl-3-methoxypyrazine.

Like amines and pyrazines, thiols, thiazoles, and/or sulfides can contribute to the signature flavors of wines. For example, 3-mercaptohexyl acetate can contribute tropical flavors to Sauvignon Blanc from New Zealand. Examples of thiols that may be included in the alcoholic beverage replicas provided herein are, without limitation, 3-mercaptohexylacetate, 3-(methylthio)-1-propanol, dimethyl sulfide, furfuryl mercaptan, 2-(methylthio)ethanol, and any combination thereof. Any appropriate number of thiols, thiazoles, or sulfides can be used, for example, 1 to 10, 1 to 8, 1 to 5, 2 to 10, 2 to 8, 2 to 5, 3 to 5, 3 to 8, or 3 to 10). thiols, thiazoles, or sulfides can make up any suitable portion of the additional VOCs. In some embodiments, the one or more thiols, thiazoles, or sulfides can be present in a total amount of about 0.00007 mg/L to about 0.45 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.5 to about 0.1 mg/L, about 0.10 to about 0.45 mg/L, about 0.1 to about 0.4 mg/L, about 0.1 to about 0.2 mg/L, about 0.1 to about 0.3 mg/L, about 0.2 to about 0.4 mg/L, about 0.2 to about 0.3 mg/L, about 0.20 to about 0.45 mg/L, about 0.3 to about 0.4 mg/L, or about 0.30 to about 0.45 mg/L).

In some embodiments, an alcoholic beverage replica can include at least one (e.g., at least 2, at least 3, at least 4, at least 5, at least 6, at least 7, 1 to 8, 1 to 7, 1 to 5, 1 to 3, 2 to 8, 2 to 7, 2 to 5, 2 to 3, 3 to 8, or 3 to 5) thiols, thiazoles, or sulfides selected from the group consisting of 1-para-menthene-8-thiol, 2-isopropyl-4-methyl thiazole, 3-mercaptohexylacetate, 4-mercapto-4-methyl-2-pentanone, dimethyl sulfide, dimethyl trisulfide, furfuryl mercaptan, and furfuryl thioacetate.

In some embodiments, an alcoholic beverage replica can include at least one (e.g., at least two, 1 to 3, 1 to 2, or 3) thiols, thiazoles, or sulfides selected from the group consisting of 3-mercaptohexylacetate, dimethyl sulfide, and furfuryl mercaptan.

Ethers can also contribute to the flavors of alcoholic beverage replicas. Examples of ethers that may be included in the alcoholic beverage replicas provided herein are, without limitation, furfuryl ether, vanillyl butyl ether, and vanillyl ethyl ether. Any appropriate number of ethers can be used, for example, 1 to 10, 1 to 8, 1 to 5, 2 to 10, 2 to 8, 2 to 5, 3 to 5, 3 to 8, or 3 to 10). Ethers can make up any suitable portion of the additional VOCs. In some embodiments, the one or more ethers can be present in a total amount of about 0.01 to about 0.05 mg/L (e.g., about 0.01 to about 0.03 mg/L, about 0.02 to about 0.04 mg/L, or about 0.03 to about 0.05 mg/L).

In some embodiments, an alcoholic beverage replica can include at least one (e.g., at least two, 1 to 3, 1 to 2, or 3) ether selected from the group consisting of furfuryl ether, vanillyl butyl ether, and vanillyl ethyl ether.

In some embodiments, an alcoholic beverage replica can include vanillyl ethyl ether.

Acetals can also contribute to the flavors of alcoholic beverage replicas. Examples of acetals that may be included in the alcoholic beverage replicas provided herein are, without limitation, 2-isobutyl-4-methyl-1,3-dioxolane, acetal (also called 1,1-diethoxyethane), acetaldehyde diethyl acetal, b-ethoxypropionaldehyde diethyl acetal, and phenethyl acetaldehyde dimethyl acetal. Any appropriate number of acetals can be used, for example, 1 to 10, 1 to 8, 1 to 5, 2 to 10, 2 to 8, 2 to 5, 3 to 5, 3 to 8, or 3 to 10). acetals can make up any suitable portion of the additional VOCs. In some embodiments, the one or more acetals can be present in a total amount of about 0.15 mg/L to about 28 mg/L (e.g., about 0.15 mg/L to about 0.5 mg/L, about 0.5 mg/L to about 1 mg/L, about 1 to about 5 mg/L, about 5 to about 10 mg/L, about 10 to about 20 mg/L, or about 20 to about 28 mg/L).

In some embodiments, an alcoholic beverage replica can include at least one (e.g., at least two, at least 3, at least 4, 1 to 5, 1 to 4, 1 to 3, 1 to 2, 2 to 5, 2 to 4, 2 to 3, 3 to 5, 3 to 4, or 4 to 5) acetal selected from the group consisting of 2-isobutyl-4-methyl-1,3-dioxolane, acetal, acetaldehyde diethyl acetal, b-ethoxypropionaldehyde diethyl acetal, and phenethyl acetaldehyde dimethyl acetal.

In some embodiments, an alcoholic beverage replica can include at least (e.g., at least two, 1 to 3, 1 to 2, or 3) acetal selected from the group consisting of acetal, acetaldehyde diethyl acetal, and phenethyl acetaldehyde dimethyl acetal.

Furans can also contribute to the flavors of alcoholic beverage replica. A non-limiting example of a furan that may be included in the alcoholic beverage replicas provided herein is 2-pentyl furan. Any appropriate number of furans can be used. Acetals can make up any suitable portion of the additional VOCs. In some embodiments, an alcoholic beverage replica can include 2-pentyl furan.

In some embodiments, an alcoholic beverage replica can include one or more (e.g., one, two, three, four, five, six, or all seven) VOCs selected from the group consisting of butyl formate, ethyl octanoate, ethyl propionate, ethyl-2-methylbutyrate, isoamyl acetate, isoamyl alcohol, and isobutanol.

For example, in some cases, an alcoholic beverage replica can include two compounds selected from the group consisting of butyl formate, ethyl octanoate, ethyl propionate, ethyl-2-methylbutyrate, isoamyl acetate, isoamyl alcohol, and isobutanol, where the two compounds are butyl formate and ethyl octanoate; butyl formate and ethyl propionate; butyl formate and ethyl-2-methylbutyrate; butyl formate and isoamyl acetate; butyl formate and isoamyl alcohol; butyl formate and isobutanol; ethyl octanoate and ethyl propionate; ethyl octanoate and ethyl-2-methylbutyrate; ethyl octanoate and isoamyl acetate; ethyl octanoate and isoamyl alcohol; ethyl octanoate and isobutanol; ethyl propionate and ethyl-2-methylbutyrate; ethyl propionate and isoamyl acetate; ethyl propionate and isoamyl alcohol; ethyl propionate and isobutanol; ethyl-2-methylbutyrate and isoamyl acetate; ethyl-2-methylbutyrate and isoamyl alcohol; ethyl-2-methylbutyrate and isobutanol; isoamyl acetate and isoamyl alcohol; isoamyl acetate and isobutanol; or isoamyl alcohol and isobutanol.

In some cases, an alcoholic beverage replica can include three compounds selected from the group consisting of butyl formate, ethyl octanoate, ethyl propionate, ethyl-2-methylbutyrate, isoamyl acetate, isoamyl alcohol, and isobutanol. The three compounds can be butyl formate, ethyl octanoate, and ethyl propionate; butyl formate, ethyl octanoate, and ethyl-2-methylbutyrate; butyl formate, ethyl octanoate, and isoamyl acetate; butyl formate, ethyl octanoate, and isoamyl alcohol; butyl formate, ethyl octanoate, and isobutanol; butyl formate, ethyl propionate, and ethyl-2-methylbutyrate; butyl formate, ethyl propionate, and isoamyl acetate; butyl formate, ethyl propionate, and isoamyl alcohol; butyl formate, ethyl propionate, and isobutanol; butyl formate, ethyl-2-methylbutyrate, and isoamyl acetate; butyl formate, ethyl-2-methylbutyrate, and isoamyl alcohol; butyl formate, ethyl-2-methylbutyrate, and isobutanol; butyl formate, isoamyl acetate, and isoamyl alcohol; butyl formate, isoamyl acetate, and isobutanol; butyl formate, isoamyl alcohol, and isobutanol; ethyl octanoate, ethyl propionate, and ethyl-2-methylbutyrate; ethyl octanoate, ethyl propionate, and isoamyl acetate; ethyl octanoate, ethyl propionate, and isoamyl alcohol; ethyl octanoate, ethyl propionate, and isobutanol; ethyl octanoate, ethyl-2-methylbutyrate, and isoamyl acetate; ethyl octanoate, ethyl-2-methylbutyrate, and isoamyl alcohol; ethyl octanoate, ethyl-2-methylbutyrate, and isobutanol; ethyl octanoate, isoamyl acetate, and isoamyl alcohol; ethyl octanoate, isoamyl acetate, and isobutanol; ethyl octanoate, isoamyl alcohol, and isobutanol; ethyl propionate, ethyl-2-methylbutyrate, and isoamyl acetate; ethyl propionate, ethyl-2-methylbutyrate, and isoamyl alcohol; ethyl propionate, ethyl-2-methylbutyrate, and isobutanol; ethyl propionate, isoamyl acetate, and isoamyl alcohol; ethyl propionate, isoamyl acetate, and isobutanol; ethyl propionate, isoamyl alcohol, and isobutanol; ethyl-2-methylbutyrate, isoamyl acetate, and isoamyl alcohol; ethyl-2-methylbutyrate, isoamyl acetate, and isobutanol; ethyl-2-methylbutyrate, isoamyl alcohol, and isobutanol; or isoamyl acetate, isoamyl alcohol, and isobutanol.

In some cases, an alcoholic beverage replica can include four compounds selected from the group consisting of butyl formate, ethyl octanoate, ethyl propionate, ethyl-2-methylbutyrate, isoamyl acetate, isoamyl alcohol, and isobutanol. The four compounds can be butyl formate, ethyl octanoate, ethyl propionate, and ethyl-2-methylbutyrate; butyl formate, ethyl octanoate, ethyl propionate, and isoamyl acetate; butyl formate, ethyl octanoate, ethyl propionate, and isoamyl alcohol; butyl formate, ethyl octanoate, ethyl propionate, and isobutanol; butyl formate, ethyl octanoate, ethyl-2-methylbutyrate, and isoamyl acetate; butyl formate, ethyl octanoate, ethyl-2-methylbutyrate, and isoamyl alcohol; butyl formate, ethyl octanoate, ethyl-2-methylbutyrate, and isobutanol; butyl formate, ethyl octanoate, isoamyl acetate, and isoamyl alcohol; butyl formate, ethyl octanoate, isoamyl acetate, and isobutanol; butyl formate, ethyl octanoate, isoamyl alcohol, and isobutanol; butyl formate, ethyl propionate, ethyl-2-methylbutyrate, and isoamyl acetate; butyl formate, ethyl propionate, ethyl-2-methylbutyrate, and isoamyl alcohol; butyl formate, ethyl propionate, ethyl-2-methylbutyrate, and isobutanol; butyl formate, ethyl propionate, isoamyl acetate, and isoamyl alcohol; butyl formate, ethyl propionate, isoamyl acetate, and isobutanol; butyl formate, ethyl propionate, isoamyl alcohol, and isobutanol; butyl formate, ethyl-2-methylbutyrate, isoamyl acetate, and isoamyl alcohol; butyl formate, ethyl-2-methylbutyrate, isoamyl acetate, and isobutanol; butyl formate, ethyl-2-methylbutyrate, isoamyl alcohol, and isobutanol; butyl formate, isoamyl acetate, isoamyl alcohol, and isobutanol; ethyl octanoate, ethyl propionate, ethyl-2-methylbutyrate, and isoamyl acetate; ethyl octanoate, ethyl propionate, ethyl-2-methylbutyrate, and isoamyl alcohol; ethyl octanoate, ethyl propionate, ethyl-2-methylbutyrate, and isobutanol; ethyl octanoate, ethyl propionate, isoamyl acetate, and isoamyl alcohol; ethyl octanoate, ethyl propionate, isoamyl acetate, and isobutanol; ethyl octanoate, ethyl propionate, isoamyl alcohol, and isobutanol; ethyl octanoate, ethyl-2-methylbutyrate, isoamyl acetate, and isoamyl alcohol; ethyl octanoate, ethyl-2-methylbutyrate, isoamyl acetate, and isobutanol; ethyl octanoate, ethyl-2-methylbutyrate, isoamyl alcohol, and isobutanol; ethyl octanoate, isoamyl acetate, isoamyl alcohol, and isobutanol; ethyl propionate, ethyl-2-methylbutyrate, isoamyl acetate, and isoamyl alcohol; ethyl propionate, ethyl-2-methylbutyrate, isoamyl acetate, and isobutanol; ethyl propionate, ethyl-2-methylbutyrate, isoamyl alcohol, and isobutanol; ethyl propionate, isoamyl acetate, isoamyl alcohol, and isobutanol; or ethyl-2-methylbutyrate, isoamyl acetate, isoamyl alcohol, and isobutanol.

In some cases, an alcoholic beverage replica can include five compounds selected from the group consisting of butyl formate, ethyl octanoate, ethyl propionate, ethyl-2-methylbutyrate, isoamyl acetate, isoamyl alcohol, and isobutanol. The five compounds can be butyl formate, ethyl octanoate, ethyl propionate, ethyl-2-methylbutyrate, and isoamyl acetate; butyl formate, ethyl octanoate, ethyl propionate, ethyl-2-methylbutyrate, and isoamyl alcohol; butyl formate, ethyl octanoate, ethyl propionate, ethyl-2-methylbutyrate, and isobutanol; butyl formate, ethyl octanoate, ethyl propionate, isoamyl acetate, and isoamyl alcohol; butyl formate, ethyl octanoate, ethyl propionate, isoamyl acetate, and isobutanol; butyl formate, ethyl octanoate, ethyl propionate, isoamyl alcohol, and isobutanol; butyl formate, ethyl octanoate, ethyl-2-methylbutyrate, isoamyl acetate, and isoamyl alcohol; butyl formate, ethyl octanoate, ethyl-2-methylbutyrate, isoamyl acetate, and isobutanol; butyl formate, ethyl octanoate, ethyl-2-methylbutyrate, isoamyl alcohol, and isobutanol; butyl formate, ethyl octanoate, isoamyl acetate, isoamyl alcohol, and isobutanol; butyl formate, ethyl propionate, ethyl-2-methylbutyrate, isoamyl acetate, and isoamyl alcohol; butyl formate, ethyl propionate, ethyl-2-methylbutyrate, isoamyl acetate, and isobutanol; butyl formate, ethyl propionate, ethyl-2-methylbutyrate, isoamyl alcohol, and isobutanol; butyl formate, ethyl propionate, isoamyl acetate, isoamyl alcohol, and isobutanol; butyl formate, ethyl-2-methylbutyrate, isoamyl acetate, isoamyl alcohol, and isobutanol; ethyl octanoate, ethyl propionate, ethyl-2-methylbutyrate, isoamyl acetate, and isoamyl alcohol; ethyl octanoate, ethyl propionate, ethyl-2-methylbutyrate, isoamyl acetate, and isobutanol; ethyl octanoate, ethyl propionate, ethyl-2-methylbutyrate, isoamyl alcohol, and isobutanol; ethyl octanoate, ethyl propionate, isoamyl acetate, isoamyl alcohol, and isobutanol; ethyl octanoate, ethyl-2-methylbutyrate, isoamyl acetate, isoamyl alcohol, and isobutanol; or ethyl propionate, ethyl-2-methylbutyrate, isoamyl acetate, isoamyl alcohol, and isobutanol.

In some cases, an alcoholic beverage replica can include six compounds selected from the group consisting of butyl formate, ethyl octanoate, ethyl propionate, ethyl-2-methylbutyrate, isoamyl acetate, isoamyl alcohol, and isobutanol. The six compounds can be butyl formate, ethyl octanoate, ethyl propionate, ethyl-2-methylbutyrate, isoamyl acetate, and isoamyl alcohol; butyl formate, ethyl octanoate, ethyl propionate, ethyl-2-methylbutyrate, isoamyl acetate, and isobutanol; butyl formate, ethyl octanoate, ethyl propionate, ethyl-2-methylbutyrate, isoamyl alcohol, and isobutanol; butyl formate, ethyl octanoate, ethyl propionate, isoamyl acetate, isoamyl alcohol, and isobutanol; butyl formate, ethyl octanoate, ethyl-2-methylbutyrate, isoamyl acetate, isoamyl alcohol, and isobutanol; butyl formate, ethyl propionate, ethyl-2-methylbutyrate, isoamyl acetate, isoamyl alcohol, and isobutanol; or ethyl octanoate, ethyl propionate, ethyl-2-methylbutyrate, isoamyl acetate, isoamyl alcohol, and isobutanol.

In some embodiments, an alcoholic beverage replica as provided herein can include no more than six (e.g., six, five, four, three, two, one, or none), no more than five (e.g., five, four, three, two, one, or none), or no more than four (e.g., four, three, two, one, or none) of the VOCs in the group consisting of butyl formate, ethyl octanoate, ethyl propionate, ethyl-2-methylbutyrate, isoamyl acetate, isoamyl alcohol, and isobutanol.

In some embodiments, the alcoholic beverage replicas provided herein can include one or more (e.g., one, two, three, four, five, six, seven eight, nine, ten, or more than then) VOCs that are not present in a corresponding traditional alcoholic beverage. The presence, absence, and/or amount of VOCs and non-volatile compounds in traditional alcoholic beverages and in alcoholic beverage replicas is assessed using gas chromatography/mass spectrometry (GC-MS) and liquid chromatography/mass spectrometry (LC-MS) methods as described herein. A volatile or non-volatile compound that is “not present” in a reference alcoholic beverage is one that is not detected in the reference alcoholic beverage using the methods set forth in Example 1. Limits of detection for various VOCs are disclosed in TABLES 1A, 1B, 1C, and 1D herein, and limits of detection for various non-volatile compounds are disclosed in TABLES 9A and 9B herein.

In some embodiments, the additional VOCs can include one or more VOCs compounds that are not present in a corresponding traditional alcoholic beverage. Non-limiting examples of such compounds can include 1,4-cineole, 1-para-menthene-8-thiol, 2,3-hexanedione, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-nonanol, 2-octanone, 2-pentylfuran, 3-heptyl acetate, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, allyl heptanoate, allyl hexanoate, anisyl acetate, anisyl alcohol, anisyl butyrate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, dihydrocoumarin, ethyl 2-trans-4-cis-decadienoate, furfuryl thioacetate, gamma-dodecalactone, gamma-heptalactone, geranyl butyrate, geranyl propionate, hexanal, hexyl 3-methylbutanoate, hexyl butyrate, hexyl isobutyrate, hexyl propionate, IBMP (3-isobutyl-2-methoxypyrazine), indole, isoamyl cinnamate, isoamyl phenylacetate, isobutyl butyrate, isobutyl propionate, isoeugenol, L-menthyl acetate, methionyl acetate (3-methylthio-propylacetate), methionyl butyrate, methyl benzoate, methyl cinnamate, methyl-2-pyrrolyl ketone, octanal, omega-pentadecalactone, perillaldehyde, phenethyl 2-methylbutyrate, phenethyl tiglate, propanal, propionaldehyde, propyl isovalerate, tetrahydrolinalool, thymol, valencene, valeric acid, and vanillyl butyl ether. In some embodiments, an alcoholic beverage replica can include at least one (e.g., at least 1, at least 2, at least 3, at least 4, at least 5, at least 10, at least 15, at least 20, at least 30, at least 40, at least 50, at least 60, at least 70, at least 80, 1 to 80, 1 to 70, 1 to 60, 1 to 50, 1 to 40, 1 to 30, 1 to 20, 1 to 10, 1 to 5, 1 to 4, 1 to 3, 1 to 2, 2 to 80, 2 to 70, 2 to 60, 2 to 50, 2 to 40, 2 to 30, 2 to 20, 2 to 10, 2 to 5, 2 to 4, 2 to 3, 3 to 80, 3 to 70, 3 to 60, 3 to 50, 3 to 40, 3 to 30, 3 to 20, 3 to 10, 3 to 5, 3 to 4, 4 to 80, 4 to 70, 4 to 60, 4 to 50, 4 to 40, 4 to 30, 4 to 20, 4 to 10, 4 to 5, 5 to 80, 5 to 70, 5 to 60, 5 to 50, 5 to 40, 5 to 30, 5 to 20, 5 to 10, 10 to 80, 10 to 70, 10 to 60, 10 to 50, 10 to 40, 10 to 30, or 10 to 20) compounds selected from the group consisting of 1,4-cineole, 1-para-menthene-8-thiol, 2,3-hexanedione, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-nonanol, 2-octanone, 2-pentylfuran, 3-heptyl acetate, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, allyl heptanoate, allyl hexanoate, anisyl acetate, anisyl alcohol, anisyl butyrate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, dihydrocoumarin, ethyl 2-trans-4-cis-decadienoate, furfuryl thioacetate, gamma-dodecalactone, gamma-heptalactone, geranyl butyrate, geranyl propionate, hexanal, hexyl 3-methylbutanoate, hexyl butyrate, hexyl isobutyrate, hexyl propionate, IBMP (3-isobutyl-2-methoxypyrazine), indole, isoamyl cinnamate, isoamyl phenylacetate, isobutyl butyrate, isobutyl propionate, isoeugenol, L-menthyl acetate, methionyl acetate (3-methylthio-propylacetate), methionyl butyrate, methyl benzoate, methyl cinnamate, methyl-2-pyrrolyl ketone, octanal, omega-pentadecalactone, perillaldehyde, phenethyl 2-methylbutyrate, phenethyl tiglate, propanal, propionaldehyde, propyl isovalerate, tetrahydrolinalool, thymol, valencene, valeric acid, and vanillyl butyl ether.

In some embodiments, the additional VOCs can exclude one or more VOCs that are present in a corresponding traditional alcoholic beverage. Non-limiting examples of such compounds include 2,4,6-trimethylphenol (mesitol), 5-ethyl-3-hydroxy-4-methyl-2(5H)-furanone (maple furanone), 6-methyl-5-hepten-2-one, b-caryophellene, cis-2-hexenol, hexadecanol, methyl cyclopentenolone, nonanoic acid, and terpinolene. In some embodiments, an alcoholic beverage replica can include at least one (e.g., at least 1, at least 2, at least 3, at least 4, at least 5, at least 6, at least 7, at least 8, 1 to 9, 1 to 8, 1 to 7, 1 to 6, 1 to 5, 1 to 4, 1 to 3, 1 to 2, 2 to 9, 2 to 8, 2 to 7, 2 to 6, 2 to 5, 2 to 4, 2 to 3, 3 to 9, 3 to 8, 3 to 7, 3 to 6, 3 to 5, 3 to 4, 4 to 9, 4 to 8, 4 to 7, 4 to 6, 4 to 5, 5 to 9, 5 to 8, 5 to 7, or 5 to 6) compounds selected from the group consisting of 2,4,6-trimethylphenol (mesitol), 5-ethyl-3-hydroxy-4-methyl-2(5H)-furanone (maple furanone), 6-methyl-5-hepten-2-one, b-caryophellene, cis-2-hexenol, hexadecanol, methyl cyclopentenolone, nonanoic acid, and terpinolene.

An alcoholic beverage replica can include any appropriate number of additional VOCs. For example, an alcoholic beverage replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) additional VOCs. In some cases, the number of additional VOCs in an alcoholic beverage replica can be less than the number of additional VOCs in a single corresponding reference alcoholic beverage.

Further, in some embodiments, the alcoholic beverage replicas provided herein can lack one or more (e.g., one, two, three, four, five, ten, 15, 20, or more than 20) VOCs that are present in a corresponding traditional alcoholic beverage. In some cases, the overall population of additional (non-ethanol) VOCs in an alcoholic beverage replica can have less than 95% identity to the VOCs in a corresponding reference alcoholic beverage (e.g., in a single type of traditionally made alcoholic beverage corresponding to the replica). For example, the additional VOCs in an alcoholic beverage replica can have less than 90%, less than 80%, less than 70%, less than 60%, less than 50%, or less than 40% identity to the population of VOCs in a corresponding reference alcoholic beverage made by traditional methods. Some alcoholic beverage replicas may contain at least 10 (e.g., at least 15, at least 20, at least 25, at least 30, at least 35, at least 40, at least 45, or at least 50) VOCs that are not found in a single reference alcoholic beverage. Moreover, some alcoholic beverage replicas may contain no more than 50 (e.g., no more than 45, 40, 35, 30, 25, 20, 15, or 10) VOCs that are present in a single reference alcoholic beverage. For example, in some embodiments, an alcoholic beverage replica can have at least n additional VOCs and wherein less than n (e.g., n−1, n−2, n−3, n−4, n−5, n−6, n−7, n−8, n−9, n−10, n−15, n−20, and the like, as applicable) of the additional VOCs are found in a single reference alcoholic beverage; in some embodiments, n can be equal to 5, 6, 7, 8, 9, 10, 11, 12, 13, 14, 15, 16, 17, 18, 19, 20, 25, 30, 35, 40, 45, 50, 55, 60, 65, 70, 75, 80, or 85.

As noted above, the amounts of VOCs in reference alcoholic beverages are measured using the GC-MS methods described herein. In some embodiments, the amount of a particular VOC in an alcoholic beverage replica can be an amount, based on concentration or percent composition, that is within a range 30% higher and lower than a measured amount for that VOC in a corresponding reference alcoholic beverage. For example, a VOC can be present in an alcoholic beverage replica in an amount that is 70 to 90%, 80 to 100%, 90 to 110%, 100 to 120%, 110 to 130%, 70 to 100%, 80 to 110%, 90 to 120%, or 100 to 130% of an amount measured for that VOC in a corresponding reference alcoholic beverage.

In some cases, the total amount of VOCs in an alcoholic beverage replica can be less than the total amount of VOCs in a reference alcoholic beverage. For example, an alcoholic beverage replica can have a total VOC content (in mg/L) that is less than 95% (e.g., less than 90%, 85%, 80%, 70%, 60%, 50% or 40%) of the total VOC content (in mg/L) of a corresponding reference alcoholic beverage.

In some cases, the total amount of VOCs in an alcoholic beverage replica can be less than the total amount of VOCs in a corresponding reference alcoholic beverage. Further, the amount of any particular VOC in an alcoholic beverage replica may be different than the amount of that VOC in a corresponding reference alcoholic beverage. In some cases, the amount of a VOC in an alcoholic beverage replica can be 75% or less (e.g., 70% or less, 60% or less, 50% or less, 40% or less, 30% or less, 20% or less, or 10% or less), by concentration or percent mass, than the amount of the same VOC in a corresponding reference alcoholic beverage. In some cases, the amount of a VOC in an alcoholic beverage replica can be 125% or more (e.g., 150% or more, 200% or more, or 300% or more), by concentration or percent mass, than the amount of the same VOC in a corresponding reference alcoholic beverage.

It will be understood that when both a range (or subrange) and an “at least” or “less than” amount (or percent by mass) are disclosed, these together disclose all ranges that exist in the overlap of the range (or subrange) and one of the “at least” or “less than” values in any combination. By way of example only, (−)alpha-pinene can be present in an amount of about 0.0002 mg/L to about 2 mg/L and the one or more additional VOCs can include (−)alpha-pinene in an amount of at least about 0.0024 mg/L. Therefore, (−)alpha-pinene can be present in an amount of about 0.0024 mg/L to about 2 mg/L (e.g., about 0.0024 to about to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 2 mg/L); (−)alpha-pinene can be present in an amount of about 0.005 mg/L to about 2 mg/L (e.g., about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 2 mg/L); (−)alpha-pinene can be present in an amount of about 0.01 mg/L to about 2 mg/L (e.g., about 0.01 to about 0.05 mg/L, about 0.05 to about 0.1 mg/L, about 0.1 to about 0.5 mg/L, about 0.5 to about 1 mg/L, or about 1 to about 2 mg/L); (−)alpha-pinene can be present in an amount of about 0.05 mg/L to about 2 mg/L (e.g., about 0.05 to about 0.1 mg/L, about 0.1 to about 0.5 mg/L, about 0.5 to about 1 mg/L, or about 1 to about 2 mg/L); (−)alpha-pinene can be present in an amount of about 0.1 mg/L to about 2 mg/L (e.g., about 0.1 to about 0.5 mg/L, about 0.5 to about 1 mg/L, or about 1 to about 2 mg/L); (−)alpha-pinene can be present in an amount of about 0.5 mg/L to about 2 mg/L (e.g., about 0.5 to about 1 mg/L, or about 1 to about 2 mg/L); or (−)alpha-pinene can be present in an amount of about 1 mg/L to about 2 mg/L.

Further, it will be understood that if both a range and an “at least” or “less than” value are described for an alcoholic beverage replica, the interpretation will be the largest overlap of those descriptions. For example, if an alcoholic beverage replica is described with both “(−)alpha-pinene can be present in an amount of about 0.0002 mg/L to about 2 mg/L” and “the one or more additional VOCs include (−)alpha-pinene in an amount of at least about 0.0024 mg/L”, the interpretation shall be that (−)alpha-pinene is present in an amount of about 0.0024 mg/L to about 2 mg/L.

The one or more additional VOCs in an alcoholic beverage replica can include (−) alpha-pinene (also called a-pinene, alpha-pinene, or alpha pinene). In some embodiments, the (−)alpha-pinene can be present in an amount of about 0.0002 mg/L to about 2 mg/L (e.g., about 0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 2 mg/L). In some embodiments, the (−)alpha-pinene can be present in an amount of at least about 0.0024 mg/L (e.g., at least about 0.005 mg/L, at least about 0.01 mg/L, at least about 0.05 mg/L, at least about 0.1 mg/L, at least about 0.5 mg/L, or at least about 1 mg/L). It is believed that (−)alpha-pinene can add a pine-like freshness to certain alcoholic beverages, so it may be elevated in some alcoholic beverage replicas. In some embodiments, the one or more additional VOCs can include no (−) alpha-pinene.

The one or more additional VOCs in an alcoholic beverage replica can include (−) cis-rose-oxide (also called cis-rose oxide or L-rose oxide). In some embodiments, the (−) cis-rose-oxide can be present in an amount of about 0.00009 mg/L to about 0.04 mg/L (e.g., about 0.00009 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.04 mg/L). In some embodiments, the (−)cis-rose-oxide can be present in an amount of at least about 0.0028 mg/L (e.g., at least about 0.005 mg/L, at least about 0.01 mg/L, at least about 0.02 mg/L, or at least about 0.03 mg/L). It is believed that (−)cis-rose-oxide can contribute to a signature aroma and flavor in Moscato replicas as well as some floral notes in other alcoholic beverage replicas. In some embodiments, the one or more additional VOCs can include no (−)cis-rose-oxide.

The one or more additional VOCs in an alcoholic beverage replica can include 1-decanol. In some embodiments, the 1-decanol can be present in an amount of about 0.00001 mg/L to about 0.5 mg/L (e.g., about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01, about 0.01 to about 0.05 mg/L, about 0.05 to about 0.1 mg/L, or about 0.1 to about 0.5 mg/L). In some embodiments, the one or more additional VOCs can include no 1-decanol.

The one or more additional VOCs in an alcoholic beverage replica can include 1-octanol. In some embodiments, the 1-octanol can be present in an amount of about 0.00005 mg/L to about 0.25 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.25 mg/L). In some embodiments, the one or more additional VOCs can include no 1-octanol.

The one or more additional VOCs in an alcoholic beverage replica can include 1-octen-3-ol. In some embodiments, the 1-octen-3-ol can be present in an amount of about 0.0002 mg/L to about 0.6 mg/L (e.g., about 0.0002 mg/L to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, or about 0.5 to about 0.6 mg/L). In some embodiments, the one or more additional VOCs can include no 1-octen-3-ol.

The one or more additional VOCs in an alcoholic beverage replica can include 2-(methylthio)ethanol. In some embodiments, the 2-(methylthio)ethanol can be present in an amount of about 0.00005 mg/L to about 0.002 mg/L (e.g., about 0.00005 to about 0.0001 mg/L, about 0.0001 to about 0.0005 mg/L, about 0.0005 to about 0.001 mg/L, or about 0.001 to about 0.002 mg/L). In some embodiments, the one or more additional VOCs can include no 2-(methylthio)ethanol.

The one or more additional VOCs in an alcoholic beverage replica can include 2,3-pentadione. In some embodiments, the 2,3-pentadione can be present in an amount of about 0.0001 mg/L to about 0.5 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.5 mg/L). In some embodiments, the one or more additional VOCs can include no 2,3-pentadione.

The one or more additional VOCs in an alcoholic beverage replica can include 2-acetylpyridine. In some embodiments, the 2-acetylpyridine can be present in an amount of about 0.00005 mg/L to about 0.02 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.02 mg/L). In some embodiments, the one or more additional VOCs can include no 2-acetylpyridine.

The one or more additional VOCs in an alcoholic beverage replica can include 2-heptanone. In some embodiments, the 2-heptanone can be present in an amount of about 0.0001 mg/L to about 0.07 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.07 mg/L). In some embodiments, the one or more additional VOCs can include no 2-heptanone.

The one or more additional VOCs in an alcoholic beverage replica can include 2-isobutyl-3-methoxypyrazine. In some embodiments, the 2-isobutyl-3-methoxypyrazine can be present in an amount of about 0.0015 mg/L to about 0.09 mg/L (e.g., about 0.0015 to about 0.005 mg/L, about 0.005 to about 0.01 mg/L, about 0.01 to about 0.05 mg/L, or about 0.05 to about 0.09 mg/L). In some embodiments, the one or more additional VOCs can include no 2-isobutyl-3-methoxypyrazine.

The one or more additional VOCs in an alcoholic beverage replica can include 2-isopropyl-3-methoxypyrazine. In some embodiments, the 2-isopropyl-3-methoxypyrazine can be present in an amount of about 0.00005 mg/L to about 0.09 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.09 mg/L). In some embodiments, the one or more additional VOCs can include no 2-isopropyl-3-methoxypyrazine.

The one or more additional VOCs in an alcoholic beverage replica can include 2-methoxy-4-methylphenol. In some embodiments, the 2-methoxy-4-methylphenol can be present in an amount of about 0.00025 mg/L to about 0.06 mg/L (e.g., about 0.00025 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.06 mg/L). In some embodiments, the one or more additional VOCs can include no 2-methoxy-4-methylphenol.

The one or more additional VOCs in an alcoholic beverage replica can include 2-methoxy-4-propylphenol. In some embodiments, the 2-methoxy-4-propylphenol can be present in an amount of about 0.00005 mg/L to about 0.05 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.05 mg/L). In some embodiments, the one or more additional VOCs can include no 2-methoxy-4-propylphenol.

The one or more additional VOCs in an alcoholic beverage replica can include 2-methyl-1-butanol. In some embodiments, the 2-methyl-1-butanol can be present in an amount of about 0.04 mg/L to about 7.200 g/L (e.g., about 0.04 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, or about 5 to about 7.2 g/L). In some embodiments, the one or more additional VOCs can include no 2-methyl-1-butanol.

The one or more additional VOCs in an alcoholic beverage replica can include 2-methylbutyl acetate. In some embodiments, the 2-methylbutyl acetate can be present in an amount of about 0.005 mg/L to about 1.2 mg/L (e.g., about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 1.2 mg/L). In some embodiments, the one or more additional VOCs can include no 2-methylbutyl acetate.

The one or more additional VOCs in an alcoholic beverage replica can include 2-methylbutyraldehyde. In some embodiments, the 2-methylbutyraldehyde can be present in an amount of about 0.0004 mg/L to about 0.3 mg/L (e.g., about 0.0004 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.5 to about 0.1 mg/L, or about 0.1 to about 0.3 mg/L).

The one or more additional VOCs in an alcoholic beverage replica can include 2-nonanone. In some embodiments, the 2-nonanone can be present in an amount of about 0.00005 mg/L to about 0.2 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, the 2-nonanone can be present in an amount of at least about 0.085 mg/L (e.g., at least about 0.1 mg/L, or at least about 0.15 mg/L). It is believed that 2-nonanone can contribute a positive waxy and oily aroma and flavor commonly associated with aged alcoholic beverages. In some embodiments, the one or more additional VOCs can include no 2-nonanone.

The one or more additional VOCs in an alcoholic beverage replica can include 2-phenylethanol. In some embodiments, the 2-phenylethanol can be present in an amount of about 0.004 mg/L to about 175 mg/L (e.g., about 0.004 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 150 mg/L, or about 150 to about 175 mg/L).

The one or more additional VOCs in an alcoholic beverage replica can include 2-phenylethylacetate (also called phenethyl acetate). In some embodiments, the 2-phenylethylacetate can be present in an amount of about 0.00005 mg/L to about 90 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, or about 50 to about 90 mg/L).

The one or more additional VOCs in an alcoholic beverage replica can include 2-undecanone. In some embodiments, the 2-undecanone can be present in an amount of about 0.00004 mg/L to about 0.003 mg/L (e.g., about 0.00004 to about 0.00005 mg/L, about 0.00005 to about 0.0001 mg/L, about 0.0001 to about 0.0005 mg/L, about 0.0005 to about 0.001 mg/L, or about 0.001 to about 0.003 mg/L). In some embodiments, the 2-undecanone can be present in an amount of at least about 0.0014 mg/L (e.g., at least about 0.0015 mg/L, at least about 0.002 mg/L, or at least about 0.0025 mg/L). It is believed that 2-undecanone can contribute a positive waxy and crisp aroma and flavor, so in some embodiments, it can be used to add freshness. In some embodiments, the one or more additional VOCs can include no 2-undecanone.

The one or more additional VOCs in an alcoholic beverage replica can include 3-(methylthio)-1-propanol. In some embodiments, the 3-(methylthio)-1-propanol can be present in an amount of about 0.15 mg/L to about 6 mg/L (e.g., about 0.15 to about 0.5 mg/L, about 0.5 to about 1 mg/L, about 1 to about 2 mg/L, about 2 to about 4 mg/L, or about 4 to about 6 mg/L). In some embodiments, the one or more additional VOCs can include no 3-(methylthio)-1-propanol.

The one or more additional VOCs in an alcoholic beverage replica can include 3,7-dimethyl-6-octanoic acid. In some embodiments, the 3,7-dimethyl-6-octanoic acid can be present in an amount of about 0.0006 mg/L to about 0.08 mg/L (e.g., about 0.0006 to about 0.001 mg/L, about 0.001 to about 0.005 mg/L, about 0.005 to about 0.01 mg/L, about 0.01 to about 0.05 mg/L, or about 0.05 to about 0.08 mg/L). In some embodiments, the one or more additional VOCs can include no 3,7-dimethyl-6-octanoic acid.

The one or more additional VOCs in an alcoholic beverage replica can include 3,7-dimethyl-6-octenoic acid. In some embodiments, the 3,7-dimethyl-6-octenoic acid can be present in an amount of about 0.0001 mg/L to about 0.0015 mg/L (e.g., about 0.0001 to about 0.0005 mg/L, about 0.0005 to about 0.001 mg/L, or about 0.001 to about 0.0015 mg/L). In some embodiments, the one or more additional VOCs can include no 3,7-dimethyl-6-octenoic acid.

The one or more additional VOCs in an alcoholic beverage replica can include 3-carene. In some embodiments, the 3-carene can be present in an amount of about 0.00005 mg/L to about 2.5 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 2 mg/L, or about 2 to about 2.5 mg/L). In some embodiments, the 3-carene can be present in an amount of at least about 0.036 mg/L (e.g., at least about 0.05 mg/L, at least about 0.1 mg/L, at least about 0.5 mg/L, at least about 1 mg/L, or at least about 2 mg/L). In some embodiments, 3-carene can be used to add a subtle green and herbaceous aroma to an alcoholic beverage replica. In some embodiments, the one or more additional VOCs can include no 3-carene.

The one or more additional VOCs in an alcoholic beverage replica can include 3-mercaptohexylacetate. In some embodiments, the 3-mercaptohexylacetate can be present in an amount of about 0.00005 mg/L to about 0.0007 mg/L (e.g., about 0.00005 to about 0.0001 mg/L, about 0.0001 to about 0.0003 mg/L, about 0.0003 to about 0.0005 mg/L, or about 0.0005 to about 0.0007 mg/L). In some embodiments, the one or more additional VOCs can include no 3-mercaptohexylacetate.

The one or more additional VOCs in an alcoholic beverage replica can include 3-methyl-1-pentanol. In some embodiments, the 3-methyl-1-pentanol can be present in an amount of about 0.0002 mg/L to about 0.35 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.35 mg/L). In some embodiments, the one or more additional VOCs can include no 3-methyl-1-pentanol.

The one or more additional VOCs in an alcoholic beverage replica can include 3-nonen-2-one. In some embodiments, the 3-nonen-2-one can be present in an amount of about 0.00005 mg/L to about 0.005 mg/L (e.g., about 0.00005 to about 0.0001 mg/L, about 0.0001 to about 0.0005 mg/L, about 0.0005 to about 0.001 mg/L, or about 0.001 to about 0.005 mg/L). In some embodiments, the one or more additional VOCs can include no 3-nonen-2-one.

The one or more additional VOCs in an alcoholic beverage replica can include 4-carvomenthenol. In some embodiments, the 4-carvomenthenol can be present in an amount of about 0.00003 mg/L to about 0.07 mg/L (e.g., about 0.00003 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.07 mg/L). In some embodiments, the 4-carvomenthenol can be present in an amount of at least about 0.026 mg/L (e.g., at least about 0.03 mg/L, at least about 0.04 mg/L, at least about 0.05 mg/L, or at least about 0.06 mg/L). In some embodiments, 4-carvomenthenol can be used to add a slightly green and fresh note similar to notes found in parsley. In some embodiments, the one or more additional VOCs can include no 4-carvomenthenol.

The one or more additional VOCs in an alcoholic beverage replica can include 4-ethylguaiacol. In some embodiments, the 4-ethylguaiacol can be present in an amount of about 0.00005 mg/L to about 95 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, or about 50 to about 95 mg/L). In some embodiments, the one or more additional VOCs can include no 4-ethylguaiacol.

The one or more additional VOCs in an alcoholic beverage replica can include 4-ethyl phenol. In some embodiments, the 4-ethyl phenol can be present in an amount of about 0.00005 mg/L to about 40 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 40 mg/L). In some embodiments, the 4-ethyl phenol can be present in an amount of at least about 0.21 mg/L (e.g., at least about 0.5 mg/L, at least about 1 mg/L, at least about 5 mg/L, at least about 10 mg/L, at least about 20 mg/L, or at least about 30 mg/L). It is believed that smokiness and earthiness can be common features in alcoholic beverages, and 4-ethylphenol can be a main contributor to those aromas. In some embodiments, the one or more additional VOCs can include no 4-ethyl phenol.

The one or more additional VOCs in an alcoholic beverage replica can include acetal (also called 1,1-diethoxyethane). In some embodiments, the acetal can be present in an amount of about 0.07 mg/L to about 8 mg/L (e.g., about 0.07 to about 0.1 mg/L, about 0.1 to about 0.5 mg/L, about 0.5 to about 1 mg/L, about 1 to about 4 mg/L, or about 4 to about 8 mg/L). In some embodiments, the one or more additional VOCs can include no 1,1-diethoxyethane.

The one or more additional VOCs in an alcoholic beverage replica can include acetaldehyde. In some embodiments, the acetaldehyde can be present in an amount of about 0.006 mg/L to about 5 mg/L (e.g., about 0.006 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 5 mg/L). In some embodiments, the one or more additional VOCs can include no acetaldehyde.

The one or more additional VOCs in an alcoholic beverage replica can include acetaldehyde, diethyl acetal. In some embodiments, the acetaldehyde, diethyl acetal can be present in an amount of about 4.5 mg/L to about 28 mg/L (e.g., about 4.5 to about 7 mg/L, about 7 to about 10 mg/L, about 10 to about 15 mg/L, about 15 to about 20 mg/L, about 20 to about 25 mg/L, or about 25 to about 28 mg/L). In some embodiments, the one or more additional VOCs can include no acetaldehyde, diethyl acetal.

The one or more additional VOCs in an alcoholic beverage replica can include alpha ionone (also called a-ionone). In some embodiments, the alpha ionone can be present in an amount of about 0.00005 mg/L to about 0.015 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.015 mg/L). In some embodiments, the one or more additional VOCs can include no alpha ionone.

The one or more additional VOCs in an alcoholic beverage replica can include amyl alcohol. In some embodiments, the amyl alcohol can be present in an amount of about 0.001 mg/L to about 0.6 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, or about 0.5 to about 0.6 mg/L). In some embodiments, the one or more additional VOCs can include no amyl alcohol.

The one or more additional VOCs in an alcoholic beverage replica can include amyl butyrate. In some embodiments, the amyl butyrate can be present in an amount of about 0.0000008 mg/L to about 0.1 mg/L (e.g., about 0.0000008 to about 0.000001 mg/L, about 0.000001 to about 0.000005 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.001 mg/L, about 0.001 to about 0.005 mg/L, about 0.005 to about 0.01 mg/L, about 0.01 to about 0.05 mg/L, or about 0.05 to about 0.1 mg/L). In some embodiments, the amyl butyrate can be present in an amount of at least about 0.032 mg/L (e.g., at least about 0.05 mg/L, at least about 0.07 mg/L, or at least about 0.09 mg/L). It is believed that amyl butyrate can contribute a combination of sweet chewing gum-like sweetness along with some earthiness which can be beneficial in some alcoholic beverage replicas. In some embodiments, the one or more additional VOCs can include no amyl butyrate.

The one or more additional VOCs in an alcoholic beverage replica can include a-phellandrene. In some embodiments, the a-phellandrene can be present in an amount of about 0.00005 mg/L to about 0.02 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.02 mg/L). In some embodiments, the one or more additional VOCs can include no a-phellandrene.

The one or more additional VOCs in an alcoholic beverage replica can include a-terpineol (also called alpha-terpineol). In some embodiments, the a-terpineol can be present in an amount of about 0.0002 mg/L to about 1 mg/L (e.g., 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, or about 0.5 to about 1 mg/L). In some embodiments, the one or more additional VOCs can include no a-terpineol.

The one or more additional VOCs in an alcoholic beverage replica can include benzaldehyde. In some embodiments, the benzaldehyde can be present in an amount of about 0.0001 mg/L to about 0.25 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.25 mg/L). In some embodiments, the one or more additional VOCs can include no benzaldehyde.

The one or more additional VOCs in an alcoholic beverage replica can include benzyl acetate. In some embodiments, the benzyl acetate can be present in an amount of about 0.00005 mg/L to about 0.0025 mg/L (e.g., about 0.00005 to about 0.0001 mg/L, about 0.0001 to about 0.0005 mg/L, about 0.0005 to about 0.001 mg/L, or about 0.001 to about 0.0025 mg/L). In some embodiments, the one or more additional VOCs can include no benzyl acetate.

The one or more additional VOCs in an alcoholic beverage replica can include benzyl alcohol. In some embodiments, the benzyl alcohol can be present in an amount of about 0.00005 mg/L to about 3.5 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 3.5 mg/L). In some embodiments, the one or more additional VOCs can include no benzyl alcohol.

The one or more additional VOCs in an alcoholic beverage replica can include beta-pinene (also called b-pinene and (−)-beta-pinene). In some embodiments, the beta-pinene can be present in an amount of about 0.00001 mg/L to about 15 mg/L (e.g., about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 15 mg/L). In some embodiments, the one or more additional VOCs can include no beta-pinene.

The one or more additional VOCs in an alcoholic beverage replica can include beta-ionone. In some embodiments, the beta-ionone can be present in an amount of about 0.00006 mg/L to about 0.4 mg/L (e.g., about 0.00006 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.4 mg/L). In some embodiments, the beta-ionone can be present in an amount of at least about 0.036 mg/L (e.g., at least about 0.04 mg/L, at least about 0.08 mg/L, at least about 0.1 mg/L, or at least about 0.2 mg/L). It is believed that beta-ionone can add a violet-like aroma, especially where these subtle floral additions are key. In some embodiments, the one or more additional VOCs can include no beta-ionone.

The one or more additional VOCs in an alcoholic beverage replica can include butanol. In some embodiments, the butanol can be present in an amount of about 0.02 mg/L to about 25 mg/L (e.g., about 0.02 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 20 mg/L, or about 20 to about 25 mg/L). In some embodiments, the one or more additional VOCs can include no butanol.

The one or more additional VOCs in an alcoholic beverage replica can include butyl acetate. In some embodiments, the butyl acetate can be present in an amount of about 0.00007 mg/L to about 1.3 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 1.3 mg/L). In some embodiments, the one or more additional VOCs can include no butyl acetate.

The one or more additional VOCs in an alcoholic beverage replica can include butyl formate. In some embodiments, the butyl formate can be present in an amount of about 0.007 mg/L to about 8 mg/L (e.g., about 0.007 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 4 mg/L, or about 4 to about 8 mg/L). In some embodiments, the one or more additional VOCs can include no butyl formate.

The one or more additional VOCs in an alcoholic beverage replica can include butyl isovalerate. In some embodiments, the butyl isovalerate can be present in an amount of about 0.00005 mg/L to about 0.0008 mg/L (e.g., about 0.00005 to about 0.0001 mg/L, about 0.0001 to about 0.0004 mg/L, or about 0.0004 to about 0.0008 mg/L). In some embodiments, the one or more additional VOCs can include no butyl isovalerate.

The one or more additional VOCs in an alcoholic beverage replica can include butyric acid. In some embodiments, the butyric acid can be present in an amount of about 0.0007 mg/L to about 150 mg/L (e.g., about 0.0007 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, or about 100 to about 150 mg/L). In some embodiments, the one or more additional VOCs can include no butyric acid.

The one or more additional VOCs in an alcoholic beverage replica can include cinnamaldehyde. In some embodiments, the cinnamaldehyde can be present in an amount of about 0.000007 mg/L to about 10 mg/L (e.g., about 0.000007 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, or about 5 to about 10 mg/L). In some embodiments, the one or more additional VOCs can include no cinnamaldehyde.

The one or more additional VOCs in an alcoholic beverage replica can include cis-2-hexenol. In some embodiments, the cis-2-hexenol can be present in an amount of about 0.02 mg/L to about 0.3 mg/L (e.g., 0.02 to about 0.05 mg/L, about 0.05 to about 0.1 mg/L, about 0.1 to about 0.2 mg/L, or about 0.2 to about 0.3 mg/L).

The one or more additional VOCs in an alcoholic beverage replica can include cis-3-hexen-1-ol. In some embodiments, the cis-3-hexen-1-ol can be present in an amount of about 0.001 mg/L to about 0.2 mg/L (e.g., about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, the one or more additional VOCs can include no cis-3-hexen-1-ol.

The one or more additional VOCs in an alcoholic beverage replica can include cis-3-hexenyl acetate. In some embodiments, the cis-3-hexenyl acetate can be present in an amount of about 0.0004 mg/L to about 0.015 mg/L (e.g., about 0.0004 to about 0.001 mg/L, about 0.001 to about 0.005 mg/L, about 0.005 to about 0.01 mg/L, or about 0.01 to about 0.015 mg/L). In some embodiments, the one or more additional VOCs can include no cis-3-hexenyl acetate.

The one or more additional VOCs in an alcoholic beverage replica can include citronellol. In some embodiments, the citronellol can be present in an amount of about 0.00003 mg/L to about 2.8 mg/L (e.g., about 0.00003 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 2.8 mg/L). In some embodiments, the citronellol can be present in an amount of at least about 0.95 mg/L (e.g., at least about 1 mg/L, at least about 1.5 mg/L, or at least about 2 mg/L). Reminiscent of lemons and certain flowers, citronellol can be used above the what is found in reference alcoholic beverages to add both citrus flavors and freshness. In some embodiments, the one or more additional VOCs can include no citronellol.

The one or more additional VOCs in an alcoholic beverage replica can include damascenone. In some embodiments, the damascenone can be present in an amount of about 0.0004 mg/L to about 28 mg/L (e.g., about 0.0004 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 20 mg/L, or about 20 to about 28 mg/L). In some embodiments, the damascenone can be present in an amount of at least about 3.8 mg/L (e.g., at least about 5 mg/L, at least about 10 mg/L, at least about 15 mg/L, or at least about 20 mg/L). Damascenone is a compound that can add flavors of plum, leather, and tea, and also can add a mellowing effect to the overall aroma and flavor of alcoholic beverage replicas. In some embodiments, the one or more additional VOCs can include no damascenone.

The one or more additional VOCs in an alcoholic beverage replica can include damascone. In some embodiments, the damascone can be present in an amount of about 0.5 mg/L to about 0.9 mg/L (e.g., about 0.5 to about 0.6 mg/L, about 0.6 to about 0.7 mg/L, about 0.7 to about 0.8 mg/L, or about 0.8 to about 0.9 mg/L). In some embodiments, the one or more additional VOCs can include no damascone.

The one or more additional VOCs in an alcoholic beverage replica can include decanoic acid. In some embodiments, the decanoic acid can be present in an amount of about 0.00005 mg/L to about 30 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 20 mg/L, or about 20 to about 30 mg/L). In some embodiments, the decanoic acid can be present in an amount of at least about 1 mg/L (e.g., at least about 2 mg/L, at least about 5 mg/L, at least about 10 mg/L, or at least about 20 mg/L). Decanoic acid adds a slightly rancid and earthy aroma that can balance out many sweeter aromas in alcoholic beverage replicas. In some embodiments, the one or more additional VOCs can include no decanoic acid.

The one or more additional VOCs in an alcoholic beverage replica can include delta-decalactone. In some embodiments, the delta-decalactone can be present in an amount of about 0.00005 mg/L to about 5.5 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 3 mg/L, or about 3 to about 5.5 mg/L). In some embodiments, the delta-decalactone can be present in an amount of at least about 0.009 mg/L (e.g., at least about 0.01 mg/L, at least about 0.05 mg/L, at least about 0.1 mg/L, at least about 0.5 mg/L, at least about 1 mg/L, or at least about 3 mg/L). It is believed that delta-decalactone gives a sweet and slightly waxy aroma and flavor that contributes to oak flavors in alcoholic beverages. In some embodiments, the one or more additional VOCs can include no delta-decalactone.

The one or more additional VOCs in an alcoholic beverage replica can include diacetyl. In some embodiments, the diacetyl can be present in an amount of about 0.02 mg/L to about 5.5 mg/L (e.g., about 0.02 to about 0.05 mg/L, about 0.05 to about 0.1 mg/L, about 0.1 to about 0.5 mg/L, about 0.5 to about 1 mg/L, about 1 to about 3 mg/L, or about 3 to about 5.5 mg/L). In some embodiments, the one or more additional VOCs can include no diacetyl.

The one or more additional VOCs in an alcoholic beverage replica can include diethyl succinate. In some embodiments, the diethyl succinate can be present in an amount of about 0.0004 mg/L to about 70 mg/L (e.g., about 0.0004 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 30 mg/L, about 30 to about 50 mg/L, or about 50 to about 70 mg/L). In some embodiments, the one or more additional VOCs can include no diethyl succinate.

The one or more additional VOCs in an alcoholic beverage replica can include dimethyl anthranilate. In some embodiments, the dimethyl anthranilate can be present in an amount of about 0.00005 mg/L to about 0.15 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.15 mg/L). In some embodiments, the one or more additional VOCs can include no dimethyl anthranilate.

The one or more additional VOCs in an alcoholic beverage replica can include dimethyl sulfide. In some embodiments, the dimethyl sulfide can be present in an amount of about 0.0009 mg/L to about 0.5 mg/L (e.g., about 0.0009 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.5 mg/L). In some embodiments, the one or more additional VOCs can include no dimethyl sulfide.

The one or more additional VOCs in an alcoholic beverage replica can include ethyl acetate. In some embodiments, the ethyl acetate can be present in an amount of about 0.7 mg/L to about 10 g/L (e.g., about 0.7 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, or about 5 to about 10 g/L). In some embodiments, the one or more additional VOCs can include no ethyl acetate.

The one or more additional VOCs in an alcoholic beverage replica can include ethyl anthranilate. In some embodiments, the ethyl anthranilate can be present in an amount of about 0.00005 mg/L to about 0.003 mg/L (e.g., about 0.00005 to about 0.0001 mg/L, about 0.0001 to about 0.0005 mg/L, about 0.0005 to about 0.001 mg/L, or about 0.001 to about 0.003 mg/L). In some embodiments, the one or more additional VOCs can include no ethyl anthranilate.

The one or more additional VOCs in an alcoholic beverage replica can include ethyl butanoate (also called ethyl butyrate). In some embodiments, the ethyl butanoate can be present in an amount of about 0.00035 mg/L to about 20 mg/L (e.g., about 0.00035 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 20 mg/L). In some embodiments, the ethyl butanoate can be present in an amount of at least about 2.1 mg/L (e.g., at least about 3 mg/L, at least about 5 mg/L, at least about 10 mg/L, or at least about 15 mg/L). Ethyl butanoate can be one of the main esters in an alcoholic beverage replica that contributes apple and tropical aromas and flavors.

The one or more additional VOCs in an alcoholic beverage replica can include ethyl cinnamate. In some embodiments, the ethyl cinnamate can be present in an amount of about 0.00002 mg/L to about 0.02 mg/L (e.g., about 0.00002 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.02 mg/L). In some embodiments, the one or more additional VOCs can include no ethyl cinnamate.

The one or more additional VOCs in an alcoholic beverage replica can include ethyl decanoate. In some embodiments, the ethyl decanoate can be present in an amount of about 0.00005 mg/L to about 50 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 25 mg/L, or about 25 to about 50 mg/L). In some embodiments, the ethyl decanoate can be present in an amount of at least about 30.6 mg/L (e.g., at least about 35 mg/L, at least about 40 mg/L, or at least about 45 mg/L). Ethyl decanoate is a compound that can elevate an earthy or bitter-like aroma and flavor to alcoholic beverage replicas.

The one or more additional VOCs in an alcoholic beverage replica can include ethyl heptanoate. In some embodiments, the ethyl heptanoate can be present in an amount of about 0.0001 mg/L to about 0.01 mg/L (e.g., about 0.0001 to about 0.0005 mg/L, about 0.0005 to about 0.001 mg/L, about 0.001 to about 0.005 mg/L, about 0.005 to about 0.01 mg/L). In some embodiments, the one or more additional VOCs can include no ethyl heptanoate.

The one or more additional VOCs in an alcoholic beverage replica can include ethyl hexanoate. In some embodiments, the ethyl hexanoate can be present in an amount of about 0.0014 mg/L to about 9 mg/L (e.g., about 0.0014 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, or about 5 to about 9 mg/L). In some embodiments, the ethyl hexanoate can be present in an amount of at least about 5.1 mg/L (e.g., at least about 5.5 mg/L, at least about 6 mg/L, at least about 7 mg/L, or at least about 8 mg/L). It is believed that ethyl hexanoate aids in adding a ripe apple and pineapple-like aroma and flavor found in many reference alcoholic beverages. In alcoholic beverage replicas, it can be used above the commercial max in order to compensate for other similar smelling compounds that may not be added for various reasons. In some embodiments, the one or more additional VOCs can include no ethyl hexanoate.

The one or more additional VOCs in an alcoholic beverage replica can include ethyl isobutyrate. In some embodiments, the ethyl isobutyrate can be present in an amount of about 0.001 mg/L to about 150 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, or about 100 to about 150 mg/L). In some embodiments, the one or more additional VOCs can include no ethyl isobutyrate.

The one or more additional VOCs in an alcoholic beverage replica can include ethyl isovalerate. In some embodiments, the ethyl isovalerate can be present in an amount of about 0.00005 mg/L to about 4 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 2 mg/L, or about 2 to about 4 mg/L). In some embodiments, the ethyl isovalerate can be present in an amount of at least about 1.7 mg/L (e.g., at least about 2 mg/L, at least about 2.5 mg/L, at least about 3 mg/L, or at least about 3.5 mg/L). It is believed that ethyl isovalerate is one of the few compounds that can add characteristics of red fruit, which is can be important in certain alcoholic beverage replicas. In some embodiments, the one or more additional VOCs can include no ethyl isovalerate.

The one or more additional VOCs in an alcoholic beverage replica can include ethyl lactate. In some embodiments, the ethyl lactate can be present in an amount of about 0.0008 mg/L to about 800 mg/L (e.g., about 0.0008 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, or about 500 to about 800 mg/L). In some embodiments, the one or more additional VOCs can include no ethyl lactate.

The one or more additional VOCs in an alcoholic beverage replica can include ethyl laurate. In some embodiments, the ethyl laurate can be present in an amount of about 0.00005 mg/L to about 45 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 45 mg/L). In some embodiments, the one or more additional VOCs can include no ethyl laurate.

The one or more additional VOCs in an alcoholic beverage replica can include ethyl myristate. In some embodiments, the ethyl myristate can be present in an amount of about 0.00004 mg/L to about 3.5 mg/L (e.g., about 0.00004 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 3.5 mg/L).

The one or more additional VOCs in an alcoholic beverage replica can include ethyl nonanoate. In some embodiments, the ethyl nonanoate can be present in an amount of about 0.00004 mg/L to about 3 mg/L (e.g., about 0.00004 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 3 mg/L). In some embodiments, the one or more additional VOCs can include no ethyl nonanoate.

The one or more additional VOCs in an alcoholic beverage replica can include ethyl octanoate. In some embodiments, the ethyl octanoate can be present in an amount of about 0.008 mg/L to about 300 mg/L (e.g., about 0.008 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, or about 100 to about 300 mg/L).

The one or more additional VOCs in an alcoholic beverage replica can include ethyl palmitate. In some embodiments, the ethyl palmitate can be present in an amount of about 0.0002 mg/L to about 30 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 30 mg/L). In some embodiments, the one or more additional VOCs can include no ethyl palmitate.

The one or more additional VOCs in an alcoholic beverage replica can include ethyl phenyl acetate. In some embodiments, the ethyl phenyl acetate can be present in an amount of about 0.00005 mg/L to about 5 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 5 mg/L). In some embodiments, the one or more additional VOCs can include no ethyl phenyl acetate.

The one or more additional VOCs in an alcoholic beverage replica can include ethyl propionate. In some embodiments, the ethyl propionate can be present in an amount of about 0.01 mg/L to about 2 mg/L (e.g., about 0.01 to about 0.05 mg/L, about 0.05 to about 0.1 mg/L, about 0.1 to about 0.5 mg/L, about 0.5 to about 1 mg/L, or about 1 to about 2 mg/L).

The one or more additional VOCs in an alcoholic beverage replica can include ethyl undecanoate. In some embodiments, the ethyl undecanoate can be present in an amount of about 0.00005 mg/L to about 0.3 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.3 mg/L). In some embodiments, the ethyl undecanoate can be present in an amount of at least about 0.018 mg/L (e.g., at least about 0.05 mg/L, at least about 0.08 mg/L, at least about 0.1 mg/L, or at least about 0.2 mg/L). It is believed that ethyl undecanoate has a waxy and mineral-like aroma and flavor, which can be used to both balance out sweeter aromas in alcoholic beverages and also mellow out the general characteristics. In some embodiments, the one or more additional VOCs can include no ethyl undecanoate.

The one or more additional VOCs in an alcoholic beverage replica can include ethyl valerate. In some embodiments, the ethyl valerate can be present in an amount of about 0.00005 mg/L to about 0.2 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, the one or more additional VOCs can include no ethyl valerate.

The one or more additional VOCs in an alcoholic beverage replica can include ethyl-2-mercaptopropionate. In some embodiments, the ethyl-2-mercaptopropionate can be present in an amount of about 0.00005 mg/L to about 0.3 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.3 mg/L). In some embodiments, the one or more additional VOCs can include no ethyl-2-mercaptopropionate.

The one or more additional VOCs in an alcoholic beverage replica can include ethyl-2-methylbutyrate. In some embodiments, the ethyl-2-methylbutyrate can be present in an amount of about 0.00005 mg/L to about 1 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, or about 0.5 to about 1 mg/L). In some embodiments, the one or more additional VOCs can include no ethyl-2-methylbutyrate.

The one or more additional VOCs in an alcoholic beverage replica can include ethyl-3-hydroxybutyrate. In some embodiments, the ethyl-3-hydroxybutyrate can be present in an amount of about 0.00007 mg/L to about 4 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 4 mg/L). In some embodiments, the one or more additional VOCs can include no ethyl-3-hydroxybutyrate.

The one or more additional VOCs in an alcoholic beverage replica can include ethyl-trans-2-butenoate. In some embodiments, the ethyl-trans-2-butenoate can be present in an amount of about 0.00003 mg/L to about 0.025 mg/L (e.g., about 0.00003 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.025 mg/L). In some embodiments, the one or more additional VOCs can include no ethyl-trans-2-butenoate.

The one or more additional VOCs in an alcoholic beverage replica can include ethyl-trans-3-hexenoate. In some embodiments, the ethyl-trans-3-hexenoate can be present in an amount of about 0.00005 mg/L to about 0.003 mg/L (e.g., about 0.00005 to about 0.0001 mg/L, about 0.0001 to about 0.0005 mg/L, about 0.0005 to about 0.001 mg/L, or about 0.001 to about 0.003 mg/L). In some embodiments, the one or more additional VOCs can include no ethyl-trans-3-hexenoate.

The one or more additional VOCs in an alcoholic beverage replica can include eucalyptol. In some embodiments, the eucalyptol can be present in an amount of about 0.00007 mg/L to about 0.05 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.05 mg/L). In some embodiments, the one or more additional VOCs can include no eucalyptol.

The one or more additional VOCs in an alcoholic beverage replica can include eugenol. In some embodiments, the eugenol can be present in an amount of about 0.00005 mg/L to about 0.5 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.5 mg/L). In some embodiments, the one or more additional VOCs can include no eugenol.

The one or more additional VOCs in an alcoholic beverage replica can include furfural. In some embodiments, the furfural can be present in an amount of about 0.003 mg/L to about 25 mg/L (e.g., about 0.003 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 25 mg/L).

The one or more additional VOCs in an alcoholic beverage replica can include furfuryl mercaptan. In some embodiments, the furfuryl mercaptan can be present in an amount of about 0.00005 mg/L to about 0.2 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, the one or more additional VOCs can include no furfuryl mercaptan.

The one or more additional VOCs in an alcoholic beverage replica can include gamma-decalactone. In some embodiments, the gamma-decalactone can be present in an amount of about 0.00005 mg/L to about 4 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 4 mg/L). In some embodiments, the gamma-decalactone can be present in an amount of at least about 0.2 mg/L (e.g., at least about 0.5 mg/L, at least about 1 mg/L, at least about 2 mg/L, or at least about 3 mg/L). It is believed that gamma-decalactone is one of the main compounds that can add a creamy aroma, along with peach flavors and coconut nuances to alcoholic beverage replicas. In some embodiments, gamma-decalactone can be used in an amount greater than in a reference alcoholic beverage in order to compensate for other cream-like compounds that cannot be added for various reasons. In some embodiments, the one or more additional VOCs can include no gamma-decalactone.

The one or more additional VOCs in an alcoholic beverage replica can include gamma-nonalactone. In some embodiments, the gamma-nonalactone can be present in an amount of about 0.00005 mg/L to about 0.08 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.08 mg/L). In some embodiments, the one or more additional VOCs can include no gamma-nonalactone.

The one or more additional VOCs in an alcoholic beverage replica can include gamma-octalactone. In some embodiments, the gamma-octalactone can be present in an amount of about 0.00005 mg/L to about 0.006 mg/L (e.g., about 0.00005 to about 0.0001 mg/L, about 0.0001 to about 0.0005 mg/L, about 0.0005 to about 0.001 mg/L, about 0.001 to about 0.005 mg/L, or about 0.005 to about 0.006 mg/L). In some embodiments, the one or more additional VOCs can include no gamma-octalactone.

The one or more additional VOCs in an alcoholic beverage replica can include gamma-terpinene. In some embodiments, the gamma-terpinene can be present in an amount of about 0.00005 mg/L to about 0.4 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.4 mg/L). In some embodiments, the gamma-terpinene can be present in an amount of at least about 0.04 mg/L (e.g., at least about 0.05 mg/L, at least about 0.1 mg/L, at least about 0.2 mg/L, or at least about 0.3 mg/L). It is believed that gamma-terpinene can add both a green freshness and a lime-like aroma and flavor found in some reference alcoholic beverages. In some embodiments, the one or more additional VOCs can include no gamma-terpinene.

The one or more additional VOCs in an alcoholic beverage replica can include gamma-undecalactone. In some embodiments, the gamma-undecalactone can be present in an amount of about 0.0002 mg/L to about 0.05 mg/L (e.g., about 0.0002 to about 0.0005 mg/L, about 0.0005 to about 0.001 mg/L, about 0.001 to about 0.005 mg/L, about 0.005 to about 0.01 mg/L, or about 0.01 to about 0.05 mg/L). In some embodiments, the one or more additional VOCs can include no gamma-undecalactone.

The one or more additional VOCs in an alcoholic beverage replica can include geraniol. In some embodiments, the geraniol can be present in an amount of about 0.0002 mg/L to about 6 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, or about 5 to about 6 mg/L). In some embodiments, the one or more additional VOCs can include no geraniol.

The one or more additional VOCs in an alcoholic beverage replica can include geranyl acetate. In some embodiments, the geranyl acetate can be present in an amount of about 0.00005 mg/L to about 0.015 mg/L (e.g., about 0.00005 to about 0.0001 mg/L, about 0.0001 to about 0.0005 mg/L, about 0.0005 to about 0.001 mg/L, about 0.001 to about 0.005 mg/L, or about 0.005 to about 0.015 mg/L). In some embodiments, the one or more additional VOCs can include no geranyl acetate.

The one or more additional VOCs in an alcoholic beverage replica can include guaiacol. In some embodiments, the guaiacol can be present in an amount of about 0.0007 mg/L to about 5 mg/L (e.g., about 0.0007 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 5 mg/L). In some embodiments, the one or more additional VOCs can include no guaiacol.

The one or more additional VOCs in an alcoholic beverage replica can include heptyl acetate. In some embodiments, the heptyl acetate can be present in an amount of about 0.00005 mg/L to about 0.002 mg/L (e.g., about 0.00005 to about 0.0001 mg/L, about 0.0001 to about 0.0005 mg/L, about 0.0005 to about 0.001 mg/L, or about 0.001 to about 0.002 mg/L). In some embodiments, the one or more additional VOCs can include no heptyl acetate.

The one or more additional VOCs in an alcoholic beverage replica can include hexanoic acid. In some embodiments, the hexanoic acid can be present in an amount of about 0.07 mg/L to about 280 mg/L (e.g., about 0.07 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 200 mg/L, or about 200 to about 280 mg/L). In some embodiments, the one or more additional VOCs can include no hexanoic acid.

The one or more additional VOCs in an alcoholic beverage replica can include hexanol (also called hexyl alcohol). In some embodiments, the hexanol can be present in an amount of about 0.004 mg/L to about 4 mg/L (e.g., about 0.004 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 4 mg/L). In some embodiments, the one or more additional VOCs can include no hexanol.

The one or more additional VOCs in an alcoholic beverage replica can include hexyl acetate. In some embodiments, the hexyl acetate can be present in an amount of about 0.00005 mg/L to about 0.7 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, or about 0.5 to about 0.7 mg/L). In some embodiments, the hexyl acetate can be present in an amount of at least about 0.04 mg/L (e.g., at least about 0.05 mg/L, at least about 0.1 mg/L, at least about 0.3 mg/L, or at least about 0.5 mg/L). It is believed that hexyl acetate contributes a fresh pear scent, which can be an important contributor to fruity aromas found in almost all alcoholic beverages. In some embodiments, the one or more additional VOCs can include no hexyl acetate.

The one or more additional VOCs in an alcoholic beverage replica can include hexyl hexanoate. In some embodiments, the hexyl hexanoate can be present in an amount of about 0.0001 mg/L to about 0.006 mg/L (e.g., about 0.0001 to about 0.0005 mg/L, about 0.0005 to about 0.001 mg/L, about 0.001 to about 0.005 mg/L, or about 0.005 to about 0.006 mg/L).

The one or more additional VOCs in an alcoholic beverage replica can include isoamyl acetate. In some embodiments, the isoamyl acetate can be present in an amount of about 0.01 mg/L to about 40 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 20 mg/L, or about 20 to about 40 mg/L). In some embodiments, the isoamyl acetate can be present in an amount of at least about 8.2 mg/L (e.g., at least about 10 mg/L, at least about 20 mg/L, or at least about 30 mg/L). It is believed that isoamyl acetate is one of the most important aroma and flavor compounds in reference alcoholic beverages, adding mainly adding banana-like characteristics but also contributing to the general fruitiness and intensity. In some embodiments, the one or more additional VOCs can include no isoamyl acetate.

The one or more additional VOCs in an alcoholic beverage replica can include isoamyl alcohol. In some embodiments, the isoamyl alcohol can be present in an amount of about 0.7 mg/L to about 2.500 g/L (e.g., about 0.7 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, or about 1 to about 2.5 g/L). In some embodiments, the one or more additional VOCs can include no isoamyl alcohol.

The one or more additional VOCs in an alcoholic beverage replica can include isoamyl hexanoate. In some embodiments, the isoamyl hexanoate can be present in an amount of about 0.00005 mg/L to about 0.04 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.04 mg/L). In some embodiments, the isoamyl hexanoate can be present in an amount of at least about 0.0016 mg/L (e.g., at least about 0.002 mg/L, at least about 0.005 mg/L, at least about 0.01 mg/L, or at least about 0.02 mg/L). it is believed that isoamyl hexanoate can help to balance out the fruitiness of an alcoholic beverage, contributing a dusty and oily fragrance. In some embodiments, the one or more additional VOCs can include no isoamyl hexanoate.

The one or more additional VOCs in an alcoholic beverage replica can include isoamyl octanoate. In some embodiments, the isoamyl octanoate can be present in an amount of about 0.00005 mg/L to about 1.400 g/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, or about 1 to about 1.4 g/L). In some embodiments, the one or more additional VOCs can include no isoamyl octanoate.

The one or more additional VOCs in an alcoholic beverage replica can include isoborneol. In some embodiments, the isoborneol can be present in an amount of about 0.00005 mg/L to about 0.005 mg/L (e.g., about 0.00005 to about 0.0001 mg/L, about 0.0001 to about 0.0005 mg/L, about 0.0005 to about 0.001 mg/L, or about 0.001 to about 0.005 mg/L). In some embodiments, the one or more additional VOCs can include no isoborneol.

The one or more additional VOCs in an alcoholic beverage replica can include isobutanol. In some embodiments, the isobutanol can be present in an amount of about 1 mg/L to about 1100 mg/L (e.g., about 1 to about 5 mg/L, about 5 to about 10 mg/L, about 10 to about 50 mg/L, about 50 to about 100 mg/L, about 100 to about 500 mg/L, about 500 mg/L to about 1 g/L, or about 1 to about 1.1 g/L).

The one or more additional VOCs in an alcoholic beverage replica can include isobutyl acetate. In some embodiments, the isobutyl acetate can be present in an amount of about 0.001 mg/L to about 1.3 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 1.3 mg/L).

The one or more additional VOCs in an alcoholic beverage replica can include isobutyric acid. In some embodiments, the isobutyric acid can be present in an amount of about 0.07 mg/L to about 200 mg/L (e.g., about 0.07 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, or about 100 to about 200 mg/L). In some embodiments, the one or more additional VOCs can include no isobutyric acid.

The one or more additional VOCs in an alcoholic beverage replica can include isovaleraldehyde. In some embodiments, the isovaleraldehyde can be present in an amount of about 0.001 mg/L to about 1.1 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 1.1 mg/L). In some embodiments, the one or more additional VOCs can include no isovaleraldehyde.

The one or more additional VOCs in an alcoholic beverage replica can include isovaleric acid. In some embodiments, the isovaleric acid can be present in an amount of about 0.00005 mg/L to about 30 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 30 mg/L). In some embodiments, the one or more additional VOCs can include no isovaleric acid.

The one or more additional VOCs in an alcoholic beverage replica can include Jasmine lactone. In some embodiments, the Jasmine lactone can be present in an amount of about 0.003 mg/L to about 0.015 mg/L (e.g., about 0.003 to about 0.005 mg/L, about 0.005 to about 0.01 mg/L, or about 0.01 to about 0.015 mg/L). In some embodiments, the one or more additional VOCs can include no Jasmine lactone.

The one or more additional VOCs in an alcoholic beverage replica can include carvone (e.g., L-carvone, D-carvone, or a mixture thereof). In some embodiments, the carvone can be present in an amount of about 0.00005 mg/L to about 0.015 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.015 mg/L). In some embodiments, the one or more additional VOCs can include no carvone.

The one or more additional VOCs in an alcoholic beverage replica can include limonene (also called 1-limonene). In some embodiments, the limonene can be present in an amount of about 0.000005 mg/L to about 1.2 mg/L (e.g., about 0.000005 to about 0.000001 mg/L, about 0.000001 to about 0.000005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 1.2 mg/L). In some embodiments, the limonene can be present in an amount of at least about 0.012 mg/L (e.g., at least about 0.02 mg/L, at least about 0.05 mg/L, at least about 0.1 mg/L, at least about 0.5 mg/L, or at least about 1 mg/L). It is believed that limonene is one of the main aroma compounds that contributes to a citrusy aroma and flavor, so it is oftentimes used above the commercial max in order to compensate for other citrus-like compounds that we cannot add. In some embodiments, the one or more additional VOCs can include no limonene.

The one or more additional VOCs in an alcoholic beverage replica can include linalool (also called 1-linalool). In some embodiments, the linalool can be present in an amount of about 0.0000007 mg/L to about 2.2 mg/L (e.g., about 0.0000007 to about 0.000001 mg/L, about 0.000001 to about 0.000005 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 2.2 mg/L). In some embodiments, the linalool can be present in an amount of at least about 0.5 mg/L (e.g., at least about 0.7 mg/L, at least about 1 mg/L, at least about 1.5 mg/L, or at least about 2 mg/L). It is believed that linalool can be a key aroma and flavor compound often found in wines, and contributes to the typicity of commercial Moscato wines. In some embodiments, the one or more additional VOCs can include no linalool.

The one or more additional VOCs in an alcoholic beverage replica can include linalool oxide. In some embodiments, the linalool oxide can be present in an amount of about 0.004 mg/L to about 2 mg/L (e.g., about 0.004 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 2 mg/L). In some embodiments, the one or more additional VOCs can include no linalool oxide.

The one or more additional VOCs in an alcoholic beverage replica can include linalyl acetate. In some embodiments, the linalyl acetate can be present in an amount of about 0.00005 mg/L to about 30 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 30 mg/L). In some embodiments, the one or more additional VOCs can include no linalyl acetate.

The one or more additional VOCs in an alcoholic beverage replica can include linalyl butyrate. In some embodiments, the linalyl butyrate can be present in an amount of about 0.00005 mg/L to about 2.2 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 2.2 mg/L). In some embodiments, the one or more additional VOCs can include no linalyl butyrate.

The one or more additional VOCs in an alcoholic beverage replica can include linalyl formate. In some embodiments, the linalyl formate can be present in an amount of about 0.007 mg/L to about 0.015 mg/L (e.g., about 0.007 to about 0.01 mg/L, about 0.01 to about 0.0125 mg/L, or about 0.0125 to about 0.015 mg/L). In some embodiments, the one or more additional VOCs can include no linalyl formate.

The one or more additional VOCs in an alcoholic beverage replica can include maltol. In some embodiments, the maltol can be present in an amount of about 0.00006 mg/L to about 5 mg/L (e.g., about 0.00006 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 5 mg/L). In some embodiments, the one or more additional VOCs can include no maltol.

The one or more additional VOCs in an alcoholic beverage replica can include methional. In some embodiments, the methional can be present in an amount of about 0.00005 mg/L to about 0.005 mg/L (e.g., about 0.00005 to about 0.0001 mg/L, about 0.0001 to about 0.0005 mg/L, about 0.0005 to about 0.001 mg/L, or about 0.001 to about 0.005 mg/L). In some embodiments, the one or more additional VOCs can include no methional.

The one or more additional VOCs in an alcoholic beverage replica can include methyl anthranilate. In some embodiments, the methyl anthranilate can be present in an amount of about 0.00005 mg/L to about 0.02 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.02 mg/L). In some embodiments, the one or more additional VOCs can include no methyl anthranilate.

The one or more additional VOCs in an alcoholic beverage replica can include methyl decanoate. In some embodiments, the methyl decanoate can be present in an amount of about 0.00002 mg/L to about 0.025 mg/L (e.g., about 0.00002 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.025 mg/L). In some embodiments, the methyl decanoate can be present in an amount of at least about 0.0084 mg/L (e.g., at least about 0.009 mg/L, at least about 0.01 mg/L, or at least about 0.02 mg/L). It is believed that methyl decanoate adds a faint dustiness used to balance out fruitiness found in reference alcoholic beverages. In some embodiments, the one or more additional VOCs can include no methyl decanoate.

The one or more additional VOCs in an alcoholic beverage replica can include methyl dihydrojasmonate. In some embodiments, the methyl dihydrojasmonate can be present in an amount of about 0.003 mg/L to about 0.01 mg/L (e.g., about 0.003 to about 0.005 mg/L, about 0.005 to about 0.008 mg/L, or about 0.008 to about 0.01 mg/L). In some embodiments, the one or more additional VOCs can include no methyl dihydrojasmonate.

The one or more additional VOCs in an alcoholic beverage replica can include methyl hexanoate. In some embodiments, the methyl hexanoate can be present in an amount of about 0.0007 mg/L to about 5 mg/L (e.g., about 0.0007 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 5 mg/L). In some embodiments, the one or more additional VOCs can include no methyl hexanoate.

The one or more additional VOCs in an alcoholic beverage replica can include methyl laurate. In some embodiments, the methyl laurate can be present in an amount of about 0.000007 mg/L to about 0.015 mg/L (e.g., about 0.000007 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.015 mg/L). In some embodiments, the one or more additional VOCs can include no methyl laurate.

The one or more additional VOCs in an alcoholic beverage replica can include methyl octanoate. In some embodiments, the methyl octanoate can be present in an amount of about 0.00000007 mg/L to about 0.15 mg/L (e.g., about 0.00000007 to about 0.0000001 mg/L, about 0.0000001 to about 0.0000005 mg/L, about 0.0000005 to about 0.000001 mg/L, about 0.000001 to about 0.000005 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.15 mg/L). In some embodiments, the one or more additional VOCs can include no methyl octanoate.

The one or more additional VOCs in an alcoholic beverage replica can include methyl salicylate. In some embodiments, the methyl salicylate can be present in an amount of about 0.00001 mg/L to about 0.02 mg/L (e.g., about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.02 mg/L). In some embodiments, the one or more additional VOCs can include no methyl salicylate.

The one or more additional VOCs in an alcoholic beverage replica can include methyl vanillate. In some embodiments, the methyl vanillate can be present in an amount of about 0.01 mg/L to about 1.6 mg/L (e.g., about 0.01 to about 0.05 mg/L, about 0.05 to about 0.1 mg/L, about 0.1 to about 0.5 mg/L, about 0.5 to about 1 mg/L, or about 1 to about 1.6 mg/L). In some embodiments, the one or more additional VOCs can include no methyl vanillate.

The one or more additional VOCs in an alcoholic beverage replica can include myrcene. In some embodiments, the myrcene can be present in an amount of about 0.000004 mg/L to about 0.015 mg/L (e.g., about 0.000004 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.015 mg/L). In some embodiments, the one or more additional VOCs can include no myrcene.

The one or more additional VOCs in an alcoholic beverage replica can include myrtenol. In some embodiments, the myrtenol can be present in an amount of about 0.00005 mg/L to about 0.6 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, or about 0.5 to about 0.6 mg/L). In some embodiments, the one or more additional VOCs can include no myrtenol.

The one or more additional VOCs in an alcoholic beverage replica can include nerol. In some embodiments, the nerol can be present in an amount of about 0.00005 mg/L to about 0.25 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.25 mg/L). In some embodiments, the nerol can be present in an amount of at least about 0.017 mg/L (e.g., at least about 0.02 mg/L, at least about 0.05 mg/L, at least about 0.1 mg/L, or at least about 0.2 mg/L). Nerol contributes a floral aroma as well as a subtle grapefruit aroma to alcoholic beverages, the latter aroma which few aroma/flavor compounds can contribute. In some embodiments, the one or more additional VOCs can include no nerol.

The one or more additional VOCs in an alcoholic beverage replica can include nonanal. In some embodiments, the nonanal can be present in an amount of about 0.00005 mg/L to about 0.05 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.05 mg/L). In some embodiments, the nonanal can be present in an amount of at least about 0.03 mg/L (e.g., at least about 0.035 mg/L, at least about 0.04 mg/L, or at least about 0.045 mg/L). It is believed that nonanal has a piercing earthy and petrichor-like aroma which can help balance out fruitiness and also adds an earthy fermented-like character in alcoholic beverage replicas. In some embodiments, the one or more additional VOCs can include no nonanal.

The one or more additional VOCs in an alcoholic beverage replica can include octanoic acid. In some embodiments, the octanoic acid can be present in an amount of about 0.3 mg/L to about 40 mg/L (e.g., about 0.3 to about 0.5 mg/L, about 0.5 to about 1 mg/L, about 1 to about 5 mg/L, about 5 to about 10 mg/L, about 10 to about 20 mg/L, or about 20 to about 40 mg/L). In some embodiments, the one or more additional VOCs can include no octanoic acid.

The one or more additional VOCs in an alcoholic beverage replica can include octyl acetate. In some embodiments, the octyl acetate can be present in an amount of about 0.00005 mg/L to about 0.0015 mg/L (e.g., about 0.00005 to about 0.0001 mg/L, about 0.0001 to about 0.0005 mg/L, about 0.0005 to about 0.001 mg/L, or about 0.001 to about 0.0015 mg/L). In some embodiments, the one or more additional VOCs can include no octyl acetate.

The one or more additional VOCs in an alcoholic beverage replica can include p-anisaldehyde. In some embodiments, the p-anisaldehyde can be present in an amount of about 0.00005 mg/L to about 0.06 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.06 mg/L). In some embodiments, the one or more additional VOCs can include no p-anisaldehyde.

The one or more additional VOCs in an alcoholic beverage replica can include p-cresol. In some embodiments, the p-cresol can be present in an amount of about 0.0001 mg/L to about 3.5 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 3.5 mg/L). In some embodiments, the one or more additional VOCs can include no p-cresol.

The one or more additional VOCs in an alcoholic beverage replica can include p-cymene. In some embodiments, the p-cymene can be present in an amount of about 0.000001 mg/L to about 0.004 mg/L (e.g., about 0.000001 to about 0.000005 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, or about 0.001 to about 0.004 mg/L). In some embodiments, the one or more additional VOCs can include no p-cymene.

The one or more additional VOCs in an alcoholic beverage replica can include phenethyl acetaldehyde dimethyl acetal. In some embodiments, the phenethyl acetaldehyde dimethyl acetal can be present in an amount of about 0.00005 mg/L to about 0.002 mg/L (e.g., about 0.00005 to about 0.0001 mg/L, about 0.0001 to about 0.0005 mg/L, about 0.0005 to about 0.001 mg/L, or about 0.001 to about 0.002 mg/L). In some embodiments, the one or more additional VOCs can include no phenethyl acetaldehyde dimethyl acetal.

The one or more additional VOCs in an alcoholic beverage replica can include phenethyl butyrate. In some embodiments, the phenethyl butyrate can be present in an amount of about 0.0000003 mg/L to about 0.025 mg/L (e.g., about 0.0000003 to about 0.0000005 mg/L, about 0.0000005 to about 0.000001 mg/L, about 0.000001 to about 0.000005 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.025 mg/L). In some embodiments, the one or more additional VOCs can include no phenethyl butyrate.

The one or more additional VOCs in an alcoholic beverage replica can include phenethyl isobutyrate. In some embodiments, the phenethyl isobutyrate can be present in an amount of about 0.0004 mg/L to about 0.006 mg/L (e.g., about 0.0004 to about 0.0007 mg/L, about 0.0007 to about 0.001 mg/L, about 0.001 to about 0.003 mg/L, or about 0.003 to about 0.006 mg/L).

The one or more additional VOCs in an alcoholic beverage replica can include phenethyl octanoate. In some embodiments, the phenethyl octanoate can be present in an amount of about 0.00005 mg/L to about 0.004 mg/L (e.g., about 0.00005 to about 0.0001 mg/L, about 0.0001 to about 0.0005 mg/L, about 0.0005 to about 0.001 mg/L, or about 0.001 to about 0.004 mg/L). In some embodiments, the one or more additional VOCs can include no phenethyl octanoate.

The one or more additional VOCs in an alcoholic beverage replica can include phenethyl propionate. In some embodiments, the phenethyl propionate can be present in an amount of about 0.00006 mg/L to about 0.12 mg/L (e.g., about 0.00006 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.12 mg/L). In some embodiments, the phenethyl propionate can be present in an amount of at least about 0.0045 mg/L (e.g., at least about 0.005 mg/L, at least about 0.01 mg/L, at least about 0.05 mg/L, or at least about 0.1 mg/L). It is believed that phenethyl propionate can be used to add a bitter and ink-like violet aroma in alcoholic beverage replicas. In some embodiments, the one or more additional VOCs can include no phenethyl propionate.

The one or more additional VOCs in an alcoholic beverage replica can include propanoic acid. In some embodiments, the propanoic acid can be present in an amount of about 1.6 mg/L to about 200 mg/L (e.g., about 1.6 to about 5 mg/L, about 5 to about 10 mg/L, about 10 to about 50 mg/L, about 50 to about 100 mg/L, about 100 to about 150 mg/L, or about 150 to about 200 mg/L). In some embodiments, the one or more additional VOCs can include no propanoic acid.

The one or more additional VOCs in an alcoholic beverage replica can include propanol. In some embodiments, the propanol can be present in an amount of about 0.3 mg/L to about 800 mg/L (e.g., about 0.3 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 400 mg/L, or about 400 to about 800 mg/L). In some embodiments, the propanol can be present in an amount of less than about 1.35 mg/L (e.g., less than about 1.2 mg/L, less than about 1 mg/L, or less than about 0.5 mg/L). It is believed that propanol can have a savory, heavy characteristic to it. Lower levels can help to emphasize fresher aromas and flavors in alcoholic beverage replicas.

The one or more additional VOCs in an alcoholic beverage replica can include propyl hexanoate. In some embodiments, the propyl hexanoate can be present in an amount of about 0.00005 mg/L to about 0.00015 mg/L (e.g., about 0.00005 to about 0.00007 mg/L, about 0.00007 to about 0.0001 mg/L, or about 0.0001 to about 0.00015 mg/L). In some embodiments, the one or more additional VOCs can include no propyl hexanoate.

The one or more additional VOCs in an alcoholic beverage replica can include trans-2-heptenal. In some embodiments, the trans-2-heptenal can be present in an amount of about 0.0002 mg/L to about 0.003 mg/L (e.g., about 0.0002 to about 0.0005 mg/L, about 0.0005 to about 0.001 mg/L, or about 0.001 to about 0.003 mg/L). In some embodiments, the one or more additional VOCs can include no trans-2-heptenal.

The one or more additional VOCs in an alcoholic beverage replica can include trans-2-hexen-1-al. In some embodiments, the trans-2-hexen-1-al can be present in an amount of about 0.00005 mg/L to about 0.03 mg/L (e.g., about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.03 mg/L). In some embodiments, the one or more additional VOCs can include no trans-2-hexen-1-al.

The one or more additional VOCs in an alcoholic beverage replica can include trans-2-hexen-1-ol. In some embodiments, the trans-2-hexen-1-ol can be present in an amount of about 0.0007 mg/L to about 0.25 mg/L (e.g., about 0.0007 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.25 mg/L). In some embodiments, the one or more additional VOCs can include no trans-2-hexen-1-ol.

The one or more additional VOCs in an alcoholic beverage replica can include trans-2-pentenal. In some embodiments, the trans-2-pentenal can be present in an amount of about 0.01 mg/L to about 0.2 mg/L (e.g., about 0.01 to about 0.05 mg/L, about 0.05 to about 0.1 mg/L, about 0.1 to about 0.15 mg/L, or about 0.15 to about 0.2 mg/L). In some embodiments, the one or more additional VOCs can include no trans-2-pentenal.

The one or more additional VOCs in an alcoholic beverage replica can include whiskey lactone. In some embodiments, the whiskey lactone can be present in an amount of about 0.0005 mg/L to about 10 mg/L (e.g., about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, or about 5 to about 10 mg/L). In some embodiments, the one or more additional VOCs can include no whiskey lactone.

The one or more additional VOCs in an alcoholic beverage replica can include 2-methylbutyl isovalerate. In some embodiments, the 2-methylbutyl isovalerate can be present in an amount of about 0.0002 mg/L to about 0.0004 mg/L (e.g., about 0.0002 to about 0.00025 mg/L, about 0.00025 to about 0.0003 mg/L, about 0.0003 to about 0.00035 mg/L, or about 0.00035 to about 0.0004 mg/L). In some embodiments, the one or more additional VOCs can include no 2-methylbutyl isovalerate.

The one or more additional VOCs in an alcoholic beverage replica can include acetoin. In some embodiments, the acetoin can be present in an amount of about 0.005 mg/L to about 1.5 mg/L (e.g., about 0.005 to about 0.01 mg/L, about 0.01 to about 0.05 mg/L, about 0.05 to about 0.1 mg/L, about 0.1 to about 0.5 mg/L, about 0.5 to about 1 mg/L, or about 1 to about 1.5 mg/L). In some embodiments, the acetoin can be present in an amount of at least about 0.015 mg/L (e.g., at least about 0.02 mg/L, at least about 0.05 mg/L, at least about 0.1 mg/L, at least about 0.5 mg/L, or at least about 1 mg/L). It is believed that acetoin can add a butterscotch, cream-like, and fermented-like characteristic found in alcoholic beverages; it can also add a specific roundness and sweetness that not many compounds can contribute. In some embodiments, the one or more additional VOCs can include no acetoin.

The one or more additional VOCs in an alcoholic beverage replica can include acetophenone. In some embodiments, the acetophenone can be present in an amount of about 0.0006 mg/L to about 0.06 mg/L (e.g., about 0.0006 to about 0.001 mg/L, about 0.001 to about 0.005 mg/L, about 0.005 to about 0.01 mg/L, about 0.01 to about 0.05 mg/L, or about 0.05 to about 0.06 mg/L). In some embodiments, the one or more additional VOCs can include no acetophenone.

The one or more additional VOCs in an alcoholic beverage replica can include butyraldehyde. In some embodiments, the butyraldehyde can be present in an amount of about 0.01 mg/L to about 0.03 mg/L (e.g., about 0.01 to about 0.015 mg/L, about 0.015 to about 0.02 mg/L, about 0.02 to about 0.025 mg/L, or about 0.025 to about 0.03 mg/L). In some embodiments, the one or more additional VOCs can include no butyraldehyde.

The one or more additional VOCs in an alcoholic beverage replica can include diethyl malate. In some embodiments, the diethyl malate can be present in an amount of about 0.1 mg/L to about 45 mg/L (e.g., about 0.1 to about 0.5 mg/L, about 0.5 to about 1 mg/L, about 1 to about 5 mg/L, about 5 to about 10 mg/L, or about 10 to about 45 mg/L). In some embodiments, the one or more additional VOCs can include no diethyl malate.

The one or more additional VOCs in an alcoholic beverage replica can include ethyl 3-hydroxyhexanoate. In some embodiments, the ethyl 3-hydroxyhexanoate can be present in an amount of about 0.0015 mg/L to about 0.02 mg/L (e.g., about 0.0015 to about 0.005 mg/L, about 0.005 to about 0.01 mg/L, or about 0.01 to about 0.02 mg/L). In some embodiments, the one or more additional VOCs can include no ethyl 3-hydroxyhexanoate.

The one or more additional VOCs in an alcoholic beverage replica can include ethyl benzoate. In some embodiments, the ethyl benzoate can be present in an amount of about 0.00004 mg/L to about 0.025 mg/L (e.g., about 0.00004 to about 0.0001 mg/L, about 0.0001 to about 0.0005 mg/L, about 0.0005 to about 0.001 mg/L, about 0.001 to about 0.005 mg/L, about 0.005 to about 0.01 mg/L, or about 0.01 to about 0.025 mg/L). In some embodiments, the one or more additional VOCs can include no ethyl benzoate.

The one or more additional VOCs in an alcoholic beverage replica can include ethyl levulinate. In some embodiments, the ethyl levulinate can be present in an amount of about 0.002 mg/L to about 0.15 mg/L (e.g., about 0.002 to about 0.005 mg/L, about 0.005 to about 0.01 mg/L, about 0.01 to about 0.05 mg/L, about 0.05 to about 0.1 mg/L, or about 0.1 to about 0.15 mg/L). In some embodiments, the one or more additional VOCs can include no ethyl levulinate.

The one or more additional VOCs in an alcoholic beverage replica can include ethyl salicylate. In some embodiments, the ethyl salicylate can be present in an amount of about 0.00002 mg/L to about 0.002 mg/L (e.g., about 0.00002 to about 0.00005 mg/L, about 0.00005 to about 0.0001 mg/L, about 0.0001 to about 0.0005 mg/L, about 0.0005 to about 0.001 mg/L, or about 0.001 to about 0.002 mg/L). In some embodiments, the one or more additional VOCs can include no ethyl salicylate.

The one or more additional VOCs in an alcoholic beverage replica can include ethyl(methylthio) acetate. In some embodiments, the ethyl(methylthio) acetate can be present in an amount of about 0.0007 mg/L to about 0.0015 mg/L (e.g., about 0.0007 to about 0.001 mg/L, about 0.001 to about 0.00125 mg/L, or about 0.00125 to about 0.0015 mg/L). In some embodiments, the one or more additional VOCs can include no ethyl(methylthio) acetate.

The one or more additional VOCs in an alcoholic beverage replica can include farnesol. In some embodiments, the farnesol can be present in an amount of about 0.002 mg/L to about 0.06 mg/L (e.g., about 0.002 to about 0.005 mg/L, about 0.005 to about 0.01 mg/L, about 0.01 to about 0.03 mg/L, or about 0.03 to about 0.06 mg/L). In some embodiments, the one or more additional VOCs can include no farnesol.

The one or more additional VOCs in an alcoholic beverage replica can include 6,10-dimethyl-5,9-undecadien-2-one (also called geranyl acetone). In some embodiments, the 6,10-dimethyl-5,9-undecadien-2-one can be present in an amount of about 0.001 mg/L to about 0.02 mg/L (e.g., about 0.001 to about 0.005 mg/L, about 0.005 to about 0.01 mg/L, or about 0.01 to about 0.02 mg/L). In some embodiments, the one or more additional VOCs can include no 6,10-dimethyl-5,9-undecadien-2-one.

The one or more additional VOCs in an alcoholic beverage replica can include isoamyl isobutyrate. In some embodiments, the isoamyl isobutyrate can be present in an amount of about 0.00003 mg/L to about 0.00006 mg/L (e.g., about 0.00003 to about 0.00004 mg/L, about 0.00004 to about 0.00005 mg/L, or about 0.00005 to about 0.00006 mg/L). In some embodiments, the one or more additional VOCs can include no isoamyl isobutyrate.

The one or more additional VOCs in an alcoholic beverage replica can include isoamyl isovalerate. In some embodiments, the isoamyl isovalerate can be present in an amount of about 0.0002 mg/L to about 0.025 mg/L (e.g., about 0.0002 to about 0.0005 mg/L, about 0.0005 to about 0.001 mg/L, about 0.001 to about 0.005 mg/L, about 0.005 to about 0.01 mg/L, or about 0.01 to about 0.025 mg/L). In some embodiments, the isoamyl isovalerate can be present in an amount of at least about 0.014 mg/L (e.g., at least about 0.015 mg/L, at least about 0.018 mg/L, at least about 0.02 mg/L, or at least about 0.023 mg/L). it is believed that isoamyl isovalerate can add a combination of banana, peach, and candied green apple-like fruitiness to alcoholic beverages. In some embodiments, the one or more additional VOCs can include no isoamyl isovalerate.

The one or more additional VOCs in an alcoholic beverage replica can include isobutyl isobutyrate. In some embodiments, the isobutyl isobutyrate can be present in an amount of about 0.0006 mg/L to about 0.001 mg/L (e.g., about 0.0006 to about 0.0007 mg/L, about 0.0007 to about 0.0008 mg/L, about 0.0008 to about 0.0009 mg/L, or about 0.0009 to about 0.001 mg/L). In some embodiments, the one or more additional VOCs can include no isobutyl isobutyrate.

The one or more additional VOCs in an alcoholic beverage replica can include isobutyraldehyde. In some embodiments, the isobutyraldehyde can be present in an amount of about 0.0002 mg/L to about 13 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 13 mg/L). In some embodiments, the one or more additional VOCs can include no isobutyraldehyde.

The one or more additional VOCs in an alcoholic beverage replica can include methyl acetate. In some embodiments, the methyl acetate can be present in an amount of about 0.01 mg/L to about 0.2 mg/L (e.g., about 0.01 to about 0.05 mg/L, about 0.05 to about 0.1 mg/L, about 0.1 to about 0.15 mg/L, or about 0.15 to about 0.2 mg/L). In some embodiments, the one or more additional VOCs can include no methyl acetate.

The one or more additional VOCs in an alcoholic beverage replica can include nonanoic acid. In some embodiments, the nonanoic acid can be present in an amount of about 0.0002 mg/L to about 0.2 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, the nonanoic acid can be present in an amount of less than about 0.022 mg/L (e.g., less than about 0.02 mg/L, less than about 0.01 mg/L, less than about 0.005 mg/L, less than about 0.001 mg/L, or less than about 0.0005 mg/L). Nonanoic acid has a slightly rancid aroma that can balance out fruity aromas. In some embodiments, the one or more additional VOCs can include no nonanoic acid.

The one or more additional VOCs in an alcoholic beverage replica can include phenethyl formate. In some embodiments, the phenethyl formate can be present in an amount of about 0.002 mg/L to about 0.1 mg/L (e.g., about 0.002 to about 0.005 mg/L, about 0.005 to about 0.01 mg/L, about 0.01 to about 0.05 mg/L, or about 0.05 to about 0.1 mg/L). In some embodiments, the phenethyl formate can be present in an amount of at least about 0.055 mg/L (e.g., at least about 0.06 mg/L, at least about 0.7 mg/L, at least about 0.08 mg/L, or at least about 0.9 mg/L). Phenethyl formate contributes to a very unique combination of black cherry and floral aromas/flavors in alcoholic beverages. In some embodiments, the one or more additional VOCs can include no phenethyl formate.

The one or more additional VOCs in an alcoholic beverage replica can include propionaldehyde (also called propanal). In some embodiments, the propionaldehyde can be present in an amount of about 0.07 mg/L to about 0.15 mg/L (e.g., about 0.07 to about 0.1 mg/L, about 0.1 to about 0.125 mg/L, or about 0.125 to about 0.15 mg/L). In some embodiments, the one or more additional VOCs can include no propionaldehyde.

The one or more additional VOCs in an alcoholic beverage replica can include propyl acetate. In some embodiments, the propyl acetate can be present in an amount of about 0.002 mg/L to about 0.15 mg/L (e.g., about 0.002 to about 0.005 mg/L, about 0.005 to about 0.01 mg/L, about 0.01 to about 0.05 mg/L, about 0.05 to about 0.1 mg/L, or about 0.1 to about 0.15 mg/L). In some embodiments, the one or more additional VOCs can include no propyl acetate.

The one or more additional VOCs in an alcoholic beverage replica can include salicylaldehyde. In some embodiments, the salicylaldehyde can be present in an amount of about 0.00007 mg/L to about 0.07 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.07 mg/L). In some embodiments, the salicylaldehyde can be present in an amount of at least about 0.022 mg/L (e.g., at least about 0.025 mg/L, at least about 0.04 mg/L, at least about 0.05 mg/L, or at least about 0.06 mg/L). Flavors of oxidation can be difficult to recreate, but salicylaldehyde can be used to contribute to nutty and sherry-like aromas found in more aged alcoholic beverages. In some embodiments, the one or more additional VOCs can include no salicylaldehyde.

The one or more additional VOCs in an alcoholic beverage replica can include valeraldehyde. In some embodiments, the valeraldehyde can be present in an amount of about 0.00007 mg/L to about 0.06 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, or about 0.05 to about 0.06 mg/L). In some embodiments, the valeraldehyde can be present in an amount of at least about 0.00022 mg/L (e.g., at least about 0.0005 mg/L, at least about 0.001 mg/L, at least about 0.005 mg/L, at least about 0.01 mg/L, or at least about 0.05 mg/L). It is believed that valeraldehyde contributes to a cracker-like bready aroma which can be important in adding a more fermented-like or yeast-like character in alcoholic beverage replicas. In some embodiments, the one or more additional VOCs can include no valeraldehyde.

The one or more additional VOCs in an alcoholic beverage replica can include valeric acid. In some embodiments, the valeric acid can be present in an amount of about 0.05 mg/L to about 0.08 mg/L (e.g., about 0.05 to about 0.06 mg/L, about 0.06 to about 0.07 mg/L, or about 0.07 to about 0.08 mg/L). In some embodiments, the one or more additional VOCs can include no valeric acid.

The one or more additional VOCs in an alcoholic beverage replica can include vanillyl ethyl ether. In some embodiments, the vanillyl ethyl ether can be present in an amount of about 0.01 mg/L to about 0.07 mg/L (e.g., about 0.01 to about 0.03 mg/L, about 0.03 to about 0.05 mg/L, or about 0.05 to about 0.07 mg/L). In some embodiments, the one or more additional VOCs can include no vanillyl ethyl ether.

The one or more additional VOCs in an alcoholic beverage replica can include 4-vinylphenol. In some embodiments, the 4-vinylphenol can be present in an amount of about 0.1 mg/L to about 0.2 mg/L (e.g., about 0.1 to about 0.13 mg/L, about 0.13 to about 0.17 mg/L, or about 0.17 to about 0.2 mg/L). In some embodiments, the one or more additional VOCs can include no 4-vinylphenol.

The one or more additional VOCs in an alcoholic beverage replica can include acetovanillone. In some embodiments, the acetovanillone can be present in an amount of about 0.0005 mg/L to about 0.0008 mg/L (e.g., about 0.0005 to about 0.0006 mg/L, about 0.0006 to about 0.0007 mg/L, or about 0.0007 to about 0.0008 mg/L). In some embodiments, the one or more additional VOCs can include no acetovanillone.

The one or more additional VOCs in an alcoholic beverage replica can include phenethyl acetate. In some embodiments, the phenethyl acetate can be present in an amount of about 0.005 mg/L to about 0.015 mg/L (e.g., about 0.005 to about 0.007 mg/L, about 0.007 to about 0.01 mg/L, about 0.01 to about 0.0125 mg/L, or about 0.0125 to about 0.015 mg/L).

The one or more additional VOCs in an alcoholic beverage replica can include DL-3-methyl-2-butanol. In some embodiments, the DL-3-methyl-2-butanol can be present in an amount of about 0.01 mg/L to about 0.04 mg/L (e.g., about 0.01 to about 0.02 mg/L, about 0.02 to about 0.03 mg/L, or about 0.03 to about 0.04 mg/L). In some embodiments, the one or more additional VOCs can include no DL-3-methyl-2-butanol.

The one or more additional VOCs in an alcoholic beverage replica can include nerolidol. In some embodiments, the nerolidol can be present in an amount of about 0.001 mg/L to about 0.003 mg/L (e.g., about 0.001 to about 0.002 mg/L, or about 0.002 to about 0.003 mg/L). In some embodiments, the one or more additional VOCs can include no nerolidol.

The one or more additional VOCs in an alcoholic beverage replica can include methyl β-naphthyl ketone. In some embodiments, the methyl β-naphthyl ketone can be present in an amount of about 0.01 mg/L to about 0.03 mg/L (e.g., about 0.01 to about 0.02 mg/L, or about 0.02 to about 0.03 mg/L). In some embodiments, the one or more additional VOCs can include no methyl β-naphthyl ketone.

The one or more additional VOCs in an alcoholic beverage replica can include p,a-dimethylstyrene. In some embodiments, the p,a-dimethylstyrene can be present in an amount of about 0.0001 mg/L to about 0.0004 mg/L (e.g., 0.0001 to about 0.0002 mg/L, about 0.0002 to about 0.0003 mg/L, or about 0.0003 to about 0.0004 mg/L). In some embodiments, the one or more additional VOCs can include no p,a-dimethylstyrene.

The one or more additional VOCs in an alcoholic beverage replica can include D-camphor. In some embodiments, the D-camphor can be present in an amount of about 0.01 mg/L to about 0.03 mg/L (e.g., about 0.01 to about 0.02 mg/L, or about 0.02 to about 0.03 mg/L). In some embodiments, the one or more additional VOCs can include no D-camphor.

The one or more additional VOCs in an alcoholic beverage replica can include b-caryophellene. In some embodiments, the b-caryophellene can be present in an amount of about 0.004 mg/L to about 0.009 mg/L (e.g., about 0.004 to about 0.005 mg/L, about 0.005 to about 0.007 mg/L, about 0.007 to about 0.008 mg/L, or about 0.008 to about 0.009 mg/L). In some embodiments, the one or more additional VOCs can include no b-caryophellene.

The one or more additional VOCs in an alcoholic beverage replica can include phenylacetaldehyde. In some embodiments, the phenylacetaldehyde can be present in an amount of about 0.02 mg/L to about 0.08 mg/L (e.g., about 0.02 to about 0.04 mg/L, about 0.04 to about 0.06 mg/L, or about 0.06 to about 0.08 mg/L). In some embodiments, the one or more additional VOCs can include no phenylacetaldehyde.

The one or more additional VOCs in an alcoholic beverage replica can include gamma-hexalactone. In some embodiments, the gamma-hexalactone can be present in an amount of about 0.01 mg/L to about 0.03 mg/L (e.g., about 0.01 to about 0.02 mg/L, or about 0.02 to about 0.03 mg/L). In some embodiments, the one or more additional VOCs can include no gamma-hexalactone. In some embodiments, the one or more additional VOCs can include no gamma-hexalactone.

The one or more additional VOCs in an alcoholic beverage replica can include citral. In some embodiments, the citral can be present in an amount of about 0.005 mg/L to about 0.01 mg/L (e.g., about 0.005 to about 0.007 mg/L, about 0.007 to about 0.008 mg/L, or about 0.008 to about 0.01 mg/L). In some embodiments, the one or more additional VOCs can include no citral.

The one or more additional VOCs in an alcoholic beverage replica can include 2,4,6-trimethylphenol (mesitol). In some embodiments, the 2,4,6-trimethylphenol (mesitol) can be present in an amount of about 0.0015 mg/L to about 0.0035 mg/L (e.g., about 0.0015 to about 0.0025 mg/L, or about 0.0025 to about 0.0035 mg/L). In some embodiments, the one or more additional VOCs can include no 2,4,6-trimethylphenol.

The one or more additional VOCs in an alcoholic beverage replica can include hexadecanol. In some embodiments, the hexadecanol can be present in an amount of about 0.005 mg/L to about 0.025 mg/L (e.g., about 0.005 to about 0.0075 mg/L, about 0.0075 to about 0.01 mg/L, about 0.01 to about 0.02 mg/L, or about 0.02 to about 0.025 mg/L). In some embodiments, the one or more additional VOCs can include no hexadecanol.

The one or more additional VOCs in an alcoholic beverage replica can include 5-methyl furfural. In some embodiments, the 5-methyl furfural can be present in an amount of about 0.006 mg/L to about 0.04 mg/L (e.g., about 0.006 to about 0.01 mg/L, about 0.01 to about 0.02 mg/L, or about 0.02 to about 0.04 mg/L). In some embodiments, the one or more additional VOCs can include no 5-methyl furfural.

The one or more additional VOCs in an alcoholic beverage replica can include methyl cyclopentenolone. In some embodiments, the methyl cyclopentenolone can be present in an amount of about 0.02 mg/L to about 0.06 mg/L (e.g., about 0.02 to about 0.03 mg/L, about 0.03 to about 0.04 mg/L, about 0.04 to about 0.05 mg/L, or about 0.05 to about 0.06 mg/L). In some embodiments, the one or more additional VOCs can include no methyl cyclopentenolone.

The one or more additional VOCs in an alcoholic beverage replica can include 5-ethyl-3-hydroxy-4-methyl-2(5H)-furanone (also called maple furanone). In some embodiments, the 5-ethyl-3-hydroxy-4-methyl-2(5H)-furanone can be present in an amount of about 0.04 mg/L to about 0.15 mg/L (e.g., about 0.04 to about 0.05 mg/L, about 0.05 to about 0.075 mg/L, about 0.075 to about 0.1 mg/L, about 0.1 to about 0.125 mg/L, or about 0.125 to about 0.15 mg/L). In some embodiments, the one or more additional VOCs can include no maple furanone.

The one or more additional VOCs in an alcoholic beverage replica can include propyl butyrate. In some embodiments, the propyl butyrate can be present in an amount of about 0.0015 mg/L to about 0.003 mg/L (e.g., about 0.0015 to about 0.002 mg/L, about 0.002 to about 0.0025 mg/L, or about 0.0025 to about 0.003 mg/L). In some embodiments, the one or more additional VOCs can include no propyl butyrate.

The one or more additional VOCs in an alcoholic beverage replica can include terpinolene. In some embodiments, the terpinolene can be present in an amount of about 0.001 mg/L to about 0.003 mg/L (e.g., about 0.001 to about 0.002 mg/L, or about 0.002 to about 0.003 mg/L). In some embodiments, the one or more additional VOCs can include no terpinolene.

The one or more additional VOCs in an alcoholic beverage replica can include 6-methyl-5-hepten-2-one. In some embodiments, the 6-methyl-5-hepten-2-one can be present in an amount of about 0.0008 mg/L to about 0.002 mg/L (e.g., about 0.0008 to about 0.001 mg/L, about 0.001 to about 0.0015 mg/L, or about 0.0015 to about 0.002 mg/L). In some embodiments, the one or more additional VOCs can include no 6-methyl-5-hepten-2-one.

For example, an alcoholic beverage replica can include one more of the following: (−)alpha-pinene in an amount of at least about 0.0024 mg/L (e.g., at least about 0.0025, 0.0026, or 0.0027 mg/L), (−)cis-rose-oxide in an amount of at least about 0.0028 mg/L (e.g., at least about 0.0029, 0.0030, or about 0.0035 mg/L), 2-nonanone in an amount of at least about 0.085 mg/L (e.g., at least about 0.0086, 0.0088, or 0.009 mg/L), 2-undecanone in an amount of at least about 0.0014 mg/L (e.g., about 0.0015, 0.0016, or 0.0017 mg/L), 3-carene in an amount of at least about 0.036 mg/L (e.g., about 0.037, 0.038, or 0.039 mg/L), 4-carvomenthenol in an amount of at least about 0.026 mg/L (e.g., about 0.027, 0.028, or 0.029 mg/L), 4-ethyl phenol in an amount of at least about 0.21 mg/L (e.g., at least about 0.22, 0.23, or 0.24 mg/L), amyl butyrate in an amount of at least about 0.032 mg/L (e.g., at least about 0.033, 0.034, or 0.035 mg/L), beta-ionone in an amount of at least about 0.036 mg/L (e.g., at least about 0.036, 0.037, or 0.038 mg/L), citronellol in an amount of at least about 0.95 mg/L (e.g., at least about 0.96, 0.98, or 1 mg/L), damascenone in an amount of at least about 3.8 mg/L (e.g., at least about 3.9, 4.0, or 4.1 mg/L), decanoic acid in an amount of at least about 1 mg/L (e.g., at least about 1.1, 1.2, or 1.3 mg/L), delta-decalactone in an amount of at least about 0.009 mg/L (e.g., at least about 0.010, 0.011, or 0.012 mg/L), ethyl butanoate in an amount of at least about 2.1 mg/L (e.g., at least about 2.2, 2.3, or 2.4 mg/L), ethyl decanoate in an amount of at least about 30.6 mg/L (e.g., at least about 30.7, 30.8, or 40 mg/L), ethyl hexanoate in an amount of at least about 5.1 mg/L (e.g., at least about 5.2, 5.3, or 5.4 mg/L), ethyl isovalarate in an amount of at least about 1.7 mg/L (e.g., at least about 1.8, 1.9, or 2 mg/L), ethyl undecanoate in an amount of at least about 0.018 mg/L (e.g., at least about 0.019, 0.020, or 0.021 mg/L), gamma-decalactone in an amount of at least about 0.2 mg/L (e.g., at least about 0.3, 0.4, or 0.5 mg/L), gamma-terpinene in an amount of at least about 0.04 mg/L (e.g., at least about 0.04, 0.05, or 0.06 mg/L), hexyl acetate in an amount of at least about 0.04 mg/L (e.g., at least about 0.04, 0.05, or 0.06 mg/L), isoamyl acetate in an amount of at least about 8.2 mg/L (e.g., at least about 8.3, 8.4, or 8.5 mg/L), isoamyl hexanoate in an amount of at least about 0.0016 mg/L (e.g., at least about 0.0017, 0.0018, or 0.019 mg/L), limonene in an amount of at least about 0.012 mg/L (e.g., at least about 0.013, 0.014, or 0.015 mg/L), linalool in an amount of at least about 0.5 mg/L (e.g., at least about 0.6, 0.7, or 0.8 mg/L), methyl decanoate in an amount of at least about 0.0084 mg/L (e.g., at least about 0.0085, 0.0086, or 0.0087 mg/L), nerol in an amount of at least about 0.017 mg/L (e.g., at least about 0.018, 0.019, or 0.02 mg/L), nonanal in an amount of at least about 0.03 mg/L (e.g., at least about 0.04, 0.05, or 0.06 mg/L), phenethyl propionate in an amount of at least about 0.0045 mg/L (e.g., at least about 0.0046, 0.0048, or 0.005 mg/L), propanol in an amount of less than about 1.35 mg/L (e.g., less than about 1.34, 1.32, or 1.30 mg/L), acetoin in an amount of at least about 0.015 mg/L (e.g., at least about 0.016, 0.018, or 0.02 mg/L), isoamyl isovalerate in an amount of at least about 0.014 mg/L (e.g., at least about 0.014, 0.015, or 0.016 mg/L), nonanoic acid in an amount of less than about 0.022 mg/L (e.g., less than about 0.021, 0.020, or 0.019 mg/L), phenethyl formate in an amount of at least about 0.055 mg/L (e.g., at least about 0.056, 0.058, or 0.06 mg/L), salicylaldehyde in an amount of at least about 0.022 mg/L (e.g., at least about 0.023, 0.024, or 0.025 mg/L), valeraldehyde in an amount of at least about 0.00022 mg/L (e.g., at least about 0.00023, 0.00024, or 0.00035 mg/L).

In some embodiments, an alcoholic beverage replica can include at least 5 (e.g., at least 10, at least 15, at least 20, at least 25, at least 30, 5 to 135, 5 to 125, 5 to 100, 5 to 75, 5 to 50, 5 to 40, 5 to 30, 5 to 20, 5 to 10, 10 to 135, 10 to 125, 10 to 100, 10 to 75, 10 to 50, 10 to 40, 10 to 30, 10 to 20, 20 to 135, 20 to 125, 20 to 100, 20 to 75, 20 to 50, 20 to 40, 20 to 30, 30 to 135, 30 to 125, 30 to 100, 30 to 75, 30 to 50, or 30 to 40), compounds selected from the group consisting of 1-decanol, 1-octanol, 1-octen-3-ol, 2,3-pentadione, 2,4,6-trimethylphenol (mesitol), 2-heptanone, 2-isopropyl-3-methoxypyrazine, 2-methyl-1-butanol, 2-methylbutyl acetate, 2-methylbutyraldehyde, 2-phenylethanol, 2-phenylethylacetate, 2-undecanone, 3-(methylthio)-1-propanol, 3,7-dimethyl-6-octanoic acid, 3,7-dimethyl-6-octenoic acid, 3-methyl-1-pentanol, 4-carvomenthenol, 4-ethylguaiacol, 4-ethylphenol, 5-ethyl-3-hydroxy-4-methyl-2(5H)-furanone (maple furanone), 5-methyl furfural, 6-methyl-5-hepten-2-one, acetal, acetaldehyde, acetaldehyde, diethyl acetal, acetophenone, amyl alcohol, a-phellandrene, a-terpineol, b-caryophellene, benzaldehyde, beta pinene, butanol, butyl acetate, butyl formate, butyric acid, cinnamaldehyde, cis-2-hexenol, citral, citronellol, damascenone, D-camphor, decanoic acid, delta-decalactone, diacetyl, diethyl malate, diethyl succinate, dimethyl anthranilate, dimethyl sulfide, DL-3-methyl-2-butanol, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eugenol, farnesol, furfural, gamma-decalactone, gamma-hexalactone, gamma-nonalactone, gamma-octalactone, geraniol, geranyl acetone, guaiacol, hexadecanol, hexanol, hexyl hexanoate, isoamyl acetate, isoamyl alcohol, isoamyl octanoate, isobutanol, isobutyl acetate, isobutyraldehyde, isobutyric acid, isovaleraldehyde, isovaleric acid, limonene, linalool, linalool oxide, linalyl acetate, maltol, methional, methyl acetate, methyl anthranilate, methyl cyclopentenolone, methyl decanoate, methyl hexanoate, methyl laurate, methyl salicylate, methyl β-naphthyl ketone, myrtenol, nerol, nerolidol, nonanoic acid, octanoic acid, p,a-dimethylstyrene, p-cymene, phenethyl acetate, phenethyl formate, phenethyl isobutyrate, phenethyl octanoate, phenethyl propionate, phenylacetaldehyde, propanoic acid, propanol, propyl acetate, propyl butyrate, salicylaldehyde, terpinolene, trans-2-heptenal, trans-2-hexen-1-al, trans-2-hexen-1-ol, trans-2-pentenal, vanillyl ethyl ether, and whiskey lactone.

In some embodiments, an alcoholic beverage replica can include at least 1 (e.g., at least 2, at least 3, at least 4, at least 5, at least 10, 1 to 50, 1 to 40, 1 to 30, 1 to 20, 1 to 10, 1 to 5, 1 to 4, 1 to 3, 1 to 2, 2 to 50, 2 to 40, 2 to 30, 2 to 20, 2 to 10, 2 to 5, 2 to 4, 2 to 3, 5 to 50, 5 to 40, 5 to 30, 5 to 20, or 5 to 10) compounds selected from the group consisting of (−)alpha-pinene, (−)cis-rose-oxide, 2-(methylthio)ethanol, 2-acetylpyridine, 2-isobutyl-3-methoxypyrazine, 2-methoxy-4-methylphenol, 2-methoxy-4-propyl-phenol, 2-methylbutyl isovalerate, 2-nonanone, 3-carene, 3-mercaptohexylacetate, 3-nonen-2-one, acetoin, a-ionone, amyl butyrate, benzyl acetate, benzyl alcohol, beta-ionone, butyl isovalerate, carvone, cis-3-hexen-1-ol, cis-3-hexenyl acetate, ethyl salicylate, ethyl(methylthio) acetate, ethyl-2-mercaptopropionate, ethyl-trans-2-butenoate, ethyl-trans-3-hexenoate, eucalyptol, furfuryl mercaptan, gamma-terpinene, gamma-undecalactone, geranyl acetate, heptyl acetate, hexanoic acid, hexyl acetate, isoamyl hexanoate, isoamyl isobutyrate, isoamyl isovalerate, isoborneol, jasmine lactone, linalyl butyrate, linalyl formate, methyl dihydrojasmonate, methyl octanoate, methyl vanillate, myrcene, nonanal, octyl acetate, p-anisaldehyde, p-cresol, phenethyl acetaldehyde dimethyl acetal, phenethyl butyrate, propyl hexanoate, valeraldehyde.

In some embodiments, an alcoholic beverage replica can include non-volatile compounds.

In some embodiments, the non-volatile compounds can include one or more non-volatile compounds that are not present in a corresponding traditional alcoholic beverage. Non-limiting examples of such compounds can include cysteine, cystine, epicatechin gallate, methyl 2-pyrrolyl ketone, and rutin. In some embodiments, an alcoholic beverage replica can include at least one (e.g., at least 1, at least 2, at least 3, at least 4, 1 to 5, 1 to 4, 1 to 3, 1 to 2, 2 to 5, 2 to 4, 2 to 3, 3 to 5, 3 to 4, or 4 to 5) compounds selected from the group consisting of cysteine, cystine, epicatechin gallate, methyl 2-pyrrolyl ketone, and rutin.

In some embodiments, the non-volatile compounds can exclude one or more non-volatile compounds that are present in a corresponding traditional alcoholic beverage. Non-limiting examples of such compounds include 4-guanidinobutyric acid, adenine, cytidine, cytosine, homoserine, and uracil. In some embodiments, an alcoholic beverage replica can include at least one (e.g., at least 1, at least 2, at least 3, at least 4, at least 5, 1 to 6, 1 to 5, 1 to 4, 1 to 3, 1 to 2, 2 to 6, 2 to 5, 2 to 4, 2 to 3, 3 to 6, 3 to 5, 3 to 4, 4 to 6, 4 to 5, or 5 to 6) compounds selected from the group consisting of 4-guanidinobutyric acid, adenine, cytidine, cytosine, homoserine, and uracil.

The non-volatile compounds present in an alcoholic beverage replica can include compounds that fall into any of several categories, including amino acids, acids, sugars, sugar alcohols, lipids, vitamins, other flavorants, colors, tannin components, salt (e.g., NaCl), and pH-modifying compounds (e.g., KOH). It will be appreciated that any of these components can be provided in any appropriate form. For example, it will be appreciated that amino acids can be provided in the form of a salt (e.g., an HCl salt). It will also be appreciated that any and all stereoisomers can be used when no stereochemistry is specified.

Amino acids that may be present in an alcoholic beverage replica as provided herein include, without limitation, alanine, arginine, asparagine, aspartic acid, beta-alanine, citrulline, cysteine, gamma-aminobutyric acid (GABA), glutamic acid, glutamine, glycine, histidine, isoleucine, leucine, lysine, methionine, phenylalanine, proline, serine, threonine, tryptophan, tyrosine, valine, and any combination thereof. In some embodiments, an amino acid can be provided as the L-stereoisomer.

Examples of acids that can be included in an alcoholic beverage replica include, without limitation, acetic acid, citric acid, D-gluconolactone (gluconic acid), fumaric acid, lactic acid, malic acid, pyruvic acid, succinic acid, syringic acid, tartaric acid, vanillic acid, and any combination thereof.

Sugars that can be used in an alcoholic beverage replica include, without limitation, fructose, glucosamine, glucose, mannose, and any combination thereof.

Sugar alcohols that can be present in an alcoholic beverage replica include, without limitation, glycerol, inositol, mannitol, sorbitol, and any combination thereof.

An alcoholic beverage replica can include lipids such as, for example, choline or a surfactant (e.g., a surfactant from Quillaja saponaria), or a combination thereof.

In some cases, an alcoholic beverage replica can include one or more vitamins [e.g., pantothenic acid (vitamin B5), pyridoxine (vitamin B6), or a combination thereof].

Flavorants that can be included in an alcoholic beverage replica include, without limitation, acetovanillone, carnitine, disodium 5′ ribonucleotides (e.g., 5′-guanylate and/or 5′-inosinate), monosodium glutamate (MSG), syringaldehyde, vanillin, or any combination thereof.

Colorants that may be used in the alcoholic beverage replicas provided herein include, without limitation, Amber, Caramel food color, Carotene, Fruit Punch, Purple Mist, Rustic Brown, Scarlet Red, Vineyard Select, and any combination thereof. Alternatively or in addition, colorants can include natural colorants derived from fruits and vegetables such as beet, carrot, and cabbage [e.g., annatto extract, beet extract, beta carotene, caramel carmine (cochineal extract), elderberry extract, paprika, saffron, titanium dioxide, and turmeric], as well as synthetic dyes (e.g., FD+C/synthetic colors). See, e.g., www.ttb.gov/spirits/bam/chapter7.pdf

In some cases, an alcoholic beverage replica may include one or more tannin components. Suitable tannin components include, without limitation, apple tannin, chardonnay seed extract, gallic acid, grape seed tannin, grape tannin, mannoprotein, oak chip extract, oak tannin, quercetin, tannic acid, tannin synthesis product, tea extract, and any combination thereof. As used herein, a “tannin synthesis component” includes acetic acid, fructose, tannic acid, gallic acid, ellagic acid, vanillin, vanillic acid, cinnamic acid, and syringaldehyde.

In some embodiments, the alcoholic beverage replicas provided herein can include one or more (e.g., one, two, three, four, five, six, seven, eight, nine, ten, 15, 20, or more than 20) non-volatile compounds that are not present in a corresponding traditional alcoholic beverage.

Again, non-volatile compounds can be detected in traditional alcoholic beverages using any suitable method, including the LC-MS method described in Example 1 herein. A non-volatile compound that is “not present” in a reference alcoholic beverage is one that is not detected in the reference alcoholic beverage using the methods set forth in Example 1. Limits of detection for various non-volatile compounds are disclosed in TABLES 9A and 9B herein.

An alcoholic beverage replica can include any appropriate number of non-volatile compounds. For example, an alcoholic beverage replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) non-volatile compounds. In some cases, the number of non-volatile compounds in an alcoholic beverage replica can be less than the number of non-volatile compounds in a single corresponding reference alcoholic beverage.

Further, in some embodiments, the alcoholic beverage replicas provided herein can lack one or more (e.g., one, two, three, four, five, six, seven, eight, nine, ten, or more than ten) non-volatile compounds that are present in corresponding traditional alcoholic beverages. In some cases, the overall population of non-volatile compounds in an alcoholic beverage replica can have less than 95% identity to the non-volatile compounds in a corresponding reference alcoholic beverage (e.g., in a single type of traditionally made alcoholic beverage corresponding to the replica). For example, the non-volatile compounds in an alcoholic beverage replica can have less than 90%, less than 80%, less than 70%, less than 60%, less than 50%, or less than 40% identity to the population of non-volatile compounds in a corresponding reference alcoholic beverage. Some alcoholic beverage replicas may contain at least 10 (e.g., at least 15, at least 20, at least 25, or at least 30) non-volatile compounds that are not found in a single reference alcoholic beverage. Moreover, some alcoholic beverage replicas may contain no more than 50 (e.g., no more than 45, 40, 35, 30, 25, 20, 15, or 10) non-volatile compounds that are present in a single reference alcoholic beverage. For example, in some embodiments, an alcoholic beverage replica can have at least m non-volatile compounds and less than m (e.g., m−1, m−2, m−3, m−4, m−5, m−6, m−7, m−8, m−9, m−10, m−15, m−20, and the like, as applicable) of the non-volatile compounds are found in a single reference alcoholic beverage; in some embodiments, m can be equal to 5, 6, 7, 8, 9, 10, 11, 12, 13, 14, 15, 16, 17, 18, 19, 20, 25, 30, 35, 40, 45, 50, 55, or 60.

As noted above, the amounts of non-volatile compounds in reference alcoholic beverages are measured using the LC-MS methods described herein. In some embodiments, the amount of a particular non-volatile compound in an alcoholic beverage replica can be an amount, based on concentration or percent composition, that is within a range 30% higher and lower than a measured amount for that non-volatile compound in a corresponding reference alcoholic beverage. For example, a non-volatile compound can be present in an alcoholic beverage replica in an amount that is 70 to 90%, 80 to 100%, 90 to 110%, 100 to 120%, 110 to 130%, 70 to 100%, 80 to 110%, 90 to 120%, or 100 to 130% of an amount measured for that non-volatile compound in a corresponding reference alcoholic beverage.

In some cases, the amount of any particular non-volatile compound in an alcoholic beverage replica may be different than the amount of that non-volatile compound in a corresponding reference alcoholic beverage. In some cases, the amount of a non-volatile compound in an alcoholic beverage replica can be 75% or less (e.g., 70% or less, 60% or less, 50% or less, 40% or less, 30% or less, 20% or less, or 10% or less), by concentration or percent mass, than the amount of the same non-volatile compound in a corresponding reference alcoholic beverage. In some cases, the amount of a non-volatile compound in an alcoholic beverage replica can be 125% or more (e.g., 150% or more, 200% or more, or 300% or more), by concentration or percent mass, than the amount of the same non-volatile compound in a corresponding reference alcoholic beverage.

The one or more non-volatile compounds in an alcoholic beverage replica can include alanine. In some embodiments, the alanine can be present in an amount of about 1 mg/L to about 85 mg/L (e.g., about 1 to about 5 mg/L, about 5 to about 10 mg/L, about 10 to about 50 mg/L, about 50 to about 85 mg/L, about 10 to about 30 mg/L, about 30 to about 50 mg/L, about 50 to about 70 mg/L, or about 70 to about 85 mg/L). In some embodiments, the one or more non-volatile compounds can include no alanine.

The one or more non-volatile compounds in an alcoholic beverage replica can include arginine. In some embodiments, the arginine can be present in an amount of about 0.04 mg/L to about 400 mg/L (e.g., about 0.04 to about 0.1 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 400 mg/L, about 100 to about 200 mg/L, about 200 to about 300 mg/L, or about 300 to about 400 mg/L). In some embodiments, the one or more non-volatile compounds can include no arginine.

The one or more non-volatile compounds in an alcoholic beverage replica can include asparagine. In some embodiments, the asparagine can be present in an amount of about 0.01 mg/L to about 100 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L about 5 to about 10 mg/L, about 10 to about 50 mg/L, about 50 to about 100 mg/L, about 10 to about 20 mg/L, about 20 to about 40 mg/L, about 40 to about 60 mg/L, about 60 to about 80 mg/L, or about 80 to about 100 mg/L). In some embodiments, the one or more non-volatile compounds can include no asparagine.

The one or more non-volatile compounds in an alcoholic beverage replica can include aspartic acid. In some embodiments, the aspartic acid can be present in an amount of about 0.01 mg/L to about 125 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 1 to about 10 mg/L, about 10 to about 50 mg/L, about 50 to about 100 mg/L, about 50 to about 125 mg/L, about 1 to about 25 mg/L, about 25 to about 50 mg/L, about 50 to about 75 mg/L, about 75 to about 100 mg/L, or about 100 to about 125 mg/L). In some embodiments, the one or more non-volatile compounds can include no aspartic acid.

The one or more non-volatile compounds in an alcoholic beverage replica can include beta-alanine (also called b-alanine). In some embodiments, the beta-alanine can be present in an amount of about 0.09 mg/L to about 270 mg/L (e.g., about 0.09 to about 0.5 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 200 mg/L, about 200 to about 270 mg/L, about 100 to about 150 mg/L, about 150 to about 200 mg/L, about 200 to about 250 mg/L, or about 250 to about 270 mg/L). In some embodiments, the one or more non-volatile compounds can include no beta-alanine.

The one or more non-volatile compounds in an alcoholic beverage replica can include citrulline. In some embodiments, the citrulline can be present in an amount of about 0.003 mg/L to about 26 mg/L (e.g., about 0.003 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 20 mg/L, about 10 to about 26 mg/L, about 10 to about 15 mg/L, about 15 to about 20 mg/L, about 15 to about 25 mg/L, about 15 to about 26 mg/L, about 20 to about 25 mg/L, or about 20 to about 26 mg/L). In some embodiments, the one or more non-volatile compounds can include no citrulline.

The one or more non-volatile compounds in an alcoholic beverage replica can include GABA (gamma-aminobutyric acid). In some embodiments, the GABA can be present in an amount of about 0.005 mg/L to about 225 mg/L (e.g., about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 200 mg/L, about 100 to about 225 mg/L, about 100 to about 150 mg/L, about 150 to about 200 mg/L, about 150 to about 225 mg/L, or about 200 to about 225 mg/L). In some embodiments, the one or more non-volatile compounds can include no GABA.

The one or more non-volatile compounds in an alcoholic beverage replica can include glutamic acid. In some embodiments, the glutamic acid can be present in an amount of about 0.01 mg/L to about 220 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 200 mg/L, about 100 to about 220 mg/L, about 100 to about 150 mg/L, about 150 to about 200 mg/L, about 150 to about 220 mg/L, or about 200 to about 220 mg/L). In some embodiments, the one or more non-volatile compounds can include no glutamic acid.

The one or more non-volatile compounds in an alcoholic beverage replica can include glutamine. In some embodiments, the glutamine can be present in an amount of about 0.01 mg/L to about 20 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 20 mg/L). In some embodiments, the one or more non-volatile compounds can include no glutamine.

The one or more non-volatile compounds in an alcoholic beverage replica can include glycine. In some embodiments, the glycine can be present in an amount of about 0.2 mg/L to about 200 mg/L (e.g., about 0.2 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 150 mg/L, about 150 to about 200 mg/L, or about 100 to about 200 mg/L). In some embodiments, the one or more non-volatile compounds can include no glycine.

The one or more non-volatile compounds in an alcoholic beverage replica can include histidine. In some embodiments, the histidine can be present in an amount of about 0.05 mg/L to about 50 mg/L (e.g., about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 10 to about 20 mg/L, about 20 to about 30 mg/L, about 30 to about 40 mg/L, or about 40 to about 50 mg/L). In some embodiments, the one or more non-volatile compounds can include no histidine.

The one or more non-volatile compounds in an alcoholic beverage replica can include isoleucine. In some embodiments, the isoleucine can be present in an amount of about 0.03 mg/L to about 85 mg/L (e.g., about 0.03 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 10 to about 30 mg/L, about 30 to about 50 mg/L, about 50 to about 70 mg/L, about 70 to about 85 mg/L, or about 50 to about 85 mg/L). In some embodiments, the one or more non-volatile compounds can include no isoleucine.

The one or more non-volatile compounds in an alcoholic beverage replica can include leucine. In some embodiments, the leucine can be present in an amount of about 0.04 mg/L to about 250 mg/L (e.g., about 0.04 to about 0.1 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 150 mg/L, about 150 to about 200 mg/L, about 200 to about 250 mg/L, about 100 to about 200 mg/L, or about 150 to about 250 mg/L). In some embodiments, the one or more non-volatile compounds can include no leucine.

The one or more non-volatile compounds in an alcoholic beverage replica can include lysine. In some embodiments, the lysine can be present in an amount of about 0.07 mg/L to about 55 mg/L (e.g., about 0.07 to about 0.1 mg/L, about 0.1 to about 0.5 mg/L, about 0.5 to about 1 mg/L, about 1 to about 5 mg/L about 5 to about 10 mg/L, about 10 to about 50 mg/L, about 10 to about 55 mg/L, about 10 to about 20 mg/L, about 20 to about 30 mg/L, about 30 to about 40 mg/L, about 40 to about 50 mg/L, about 40 to about 55 mg/L, or about 50 to about 55 mg/L). In some embodiments, the one or more non-volatile compounds can include no lysine.

The one or more non-volatile compounds in an alcoholic beverage replica can include methionine. In some embodiments, the methionine can be present in an amount of about 0.01 mg/L to about 18 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 15 mg/L, about 10 to about 18 mg/L, or about 15 to about 18 mg/L). In some embodiments, the one or more non-volatile compounds can include no methionine.

The one or more non-volatile compounds in an alcoholic beverage replica can include phenylalanine. In some embodiments, the phenylalanine can be present in an amount of about 0.02 mg/L to about 110 mg/L (e.g., about 0.02 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, or about 50 to about 110 mg/L). In some embodiments, the one or more non-volatile compounds can include no phenylalanine.

The one or more non-volatile compounds in an alcoholic beverage replica can include proline. In some embodiments, the proline can be present in an amount of about 0.01 mg/L to about 1.75 g/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, or about 1.0 g/L to about 1.75 g/L). In some embodiments, the one or more non-volatile compounds can include no proline.

The one or more non-volatile compounds in an alcoholic beverage replica can include serine. In some embodiments, the serine can be present in an amount of about 0.02 mg/L to about 110 mg/L (e.g., about 0.02 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, or about 50 to about 110 mg/L). In some embodiments, the one or more non-volatile compounds can include no serine.

The one or more non-volatile compounds in an alcoholic beverage replica can include threonine. In some embodiments, the threonine can be present in an amount of about 0.01 mg/L to about 55 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 10 to about 55 mg/L, about 10 to about 20 mg/L, about 20 to about 30 mg/L, about 30 to about 40 mg/L, about 40 to about 50 mg/L, about 40 to about 55 mg/L, or about 50 to about 55 mg/L). In some embodiments, the one or more non-volatile compounds can include no threonine.

The one or more non-volatile compounds in an alcoholic beverage replica can include tryptophan. In some embodiments, the tryptophan can be present in an amount of about 0.009 mg/L to about 10 mg/L (e.g., about 0.009 to about 0.05 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 1 to about 2 mg/L, about 2 to about 4 mg/L, about 4 to about 6 mg/L, about 6 to about 8 mg/L, or about 8 to about 10 mg/L). In some embodiments, the one or more non-volatile compounds can include no tryptophan.

The one or more non-volatile compounds in an alcoholic beverage replica can include tyrosine. In some embodiments, the tyrosine can be present in an amount of about 0.005 mg/L to about 290 mg/L (e.g., about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 150 mg/L, about 150 to about 200 mg/L, about 200 to about 250 mg/L, about 250 to about 290 mg/L, about 100 to about 200 mg/L, or about 200 to about 290 mg/L). In some embodiments, the one or more non-volatile compounds can include no tyrosine.

The one or more non-volatile compounds in an alcoholic beverage replica can include valine. In some embodiments, the valine can be present in an amount of about 0.1 mg/L to about 1.6 g/L (e.g., about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1.0 g/L to about 1.5 g/L, or about 1.0 g/L to about 1.6 g/L). In some embodiments, the one or more non-volatile compounds can include no valine.

The one or more non-volatile compounds in an alcoholic beverage replica can include tyramine. In some embodiments, the tyramine can be present in an amount of about 0.001 mg/L to about 0.005 mg/L (e.g., about 0.001 to about 0.003 mg/L, about 0.002 to about 0.004 mg/L, or about 0.003 to about 0.005 mg/L). In some embodiments, the one or more non-volatile compounds can include no tyramine.

The one or more non-volatile compounds in an alcoholic beverage replica can include ornithine. In some embodiments, the ornithine can be present in an amount of about 0.07 mg/L to about 0.2 mg/L (e.g., 0.07 to about 0.1 mg/L, or about 0.1 to about 0.2 mg/L). In some embodiments, the one or more non-volatile compounds can include no ornithine.

The one or more non-volatile compounds in an alcoholic beverage replica can include betaine. In some embodiments, the betaine can be present in an amount of about 2.5 mg/L to about 6 mg/L (e.g., about 2.5 to about 3.0 mg/L, about 3 to about 5 mg/L, about 2.4 to about 4.0 mg/L, about 3 to about 6 mg/L, or about 4 to about 6 mg/L). In some embodiments, the one or more non-volatile compounds can include no betaine.

The one or more non-volatile compounds in an alcoholic beverage replica can include trans-4-hydroxyproline. In some embodiments, the trans-4-hydroxyproline can be present in an amount of about 0.009 mg/L to about 2 mg/L (e.g., 0.009 to about 0.05 mg/L, about 0.01 to about 0.05 mg/L, about 0.05 to about 0.1 mg/L, about 0.1 to about 0.5 mg/L, about 0.5 mg/L to about 1 mg/L, or about 1 to about 2 mg/L). In some embodiments, the one or more non-volatile compounds can include no trans-4-hydroxyproline.

The one or more non-volatile compounds in an alcoholic beverage replica can include carnosine. In some embodiments, the carnosine can be present in an amount of about 0.03 mg/L to about 0.3 mg/L (e.g., about 0.03 to about 0.05 mg/L, about 0.05 to about 0.1 mg/L, about 0.1 to about 0.3 mg/L, about 0.1 to about 0.2 mg/L, or about 0.2 to about 0.3 mg/L). In some embodiments, the one or more non-volatile compounds can include no carnosine.

The one or more non-volatile compounds in an alcoholic beverage replica can include homoserine. In some embodiments, the homoserine can be present in an amount of about 0.2 mg/L to about 1 mg/L (e.g., about 0.2 to about 0.5 mg/L, about 0.5 to about 1 mg/L, about 0.2 to about 0.4 mg/L, about 0.4 to about 0.6 mg/L, about 0.6 to about 0.8 mg/L, or about 0.8 to about 1 mg/L). In some embodiments, the one or more non-volatile compounds can include no homoserine.

The one or more non-volatile compounds in an alcoholic beverage replica can include acetic acid. In some embodiments, the acetic acid can be present in an amount of about 0.3 (% v/v) to about 2.6 (% v/v) (e.g., about 0.3% to about 0.5% (% v/v), about 0.5% to about 1% (% v/v), about 1% to about 2% (% v/v) about 1.0% to about 1.5% (% v/v), about 1.5% to about 2.0% (% v/v), about 2.0% to about 2.5% (% v/v), or about 2.0% to about 2.6% (% v/v)). In some embodiments, the one or more non-volatile compounds can include no acetic acid.

The one or more non-volatile compounds in an alcoholic beverage replica can include citric acid. In some embodiments, the citric acid can be present in an amount of about 0.1 mg/L to about 1 g/L (e.g., about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, or about 500 mg/L to about 1 g/L). In some embodiments, the one or more non-volatile compounds can include no citric acid.

The one or more non-volatile compounds in an alcoholic beverage replica can include D-gluconolactone (gluconic acid). In some embodiments, the D-gluconolactone can be present in an amount of about 7 mg/L to about 1.5 g/L (e.g., about 7 to about 10 mg/L, about 10 to about 50 mg/L, about 50 to about 100 mg/L, about 100 to about 500 mg/L, about 500 mg/L to about 1 g/L, about 500 mg/L to about 1.5 g/L, or about 1.0 to about 1.5 g/L). In some embodiments, the one or more non-volatile compounds can include no D-gluconolactone.

The one or more non-volatile compounds in an alcoholic beverage replica can include fumaric acid. In some embodiments, the fumaric acid can be present in an amount of about 0.0005 mg/L to about 22 mg/L (e.g., about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 20 mg/L, or about 10 to about 22 mg/L). In some embodiments, the one or more non-volatile compounds can include no fumaric acid.

The one or more non-volatile compounds in an alcoholic beverage replica can include lactic acid. In some embodiments, the lactic acid can be present in an amount of about 0.01 mg/L to about 6 g/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, or about 1 to about 6 g/L). In some embodiments, the one or more non-volatile compounds can include no lactic acid.

The one or more non-volatile compounds in an alcoholic beverage replica can include malic acid. In some embodiments, the malic acid can be present in an amount of about 0.04 mg/L to about 6 g/L (e.g., about 0.04 to about 0.1 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, or about 1 to about 6 g/L). In some embodiments, the one or more non-volatile compounds can include no malic acid.

The one or more non-volatile compounds in an alcoholic beverage replica can include pyruvic acid. In some embodiments, the pyruvic acid can be present in an amount of about 0.04 mg/L to about 95 mg/L (e.g., about 0.04 to about 0.1 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, or about 50 to about 95 mg/L). In some embodiments, the one or more non-volatile compounds can include no pyruvic acid.

The one or more non-volatile compounds in an alcoholic beverage replica can include succinic acid. In some embodiments, the succinic acid can be present in an amount of about 0.03 mg/L to about 2.5 g/L (e.g., about 0.03 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 2 g/L, about 500 mg/L to about 1.0 g/L, about 1.0 to about 1.5 g/L, about 1.5 to about 2.0 g/L, about 2.0 to about 2.5 g/L, about 500 mg/L to about 1.5 g/L, or about 1.5 to about 2.5 g/L). In some embodiments, the one or more non-volatile compounds can include no succinic acid.

The one or more non-volatile compounds in an alcoholic beverage replica can include syringic acid. In some embodiments, the syringic acid can be present in an amount of about 0.01 mg/L to about 32 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 30 mg/L, about 10 to about 32 mg/L, about 10 to about 20 mg/L, about 20 to about 30 mg/L, or about 20 to about 32 mg/L). In some embodiments, the one or more non-volatile compounds can include no syringic acid.

The one or more non-volatile compounds in an alcoholic beverage replica can include tartaric acid. In some embodiments, the tartaric acid can be present in an amount of about 0.04 mg/L to about 8 g/L (e.g., about 0.04 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, about 1 to about 8 g/L, about 1 to about 2 g/L, about 2 to about 4 g/L, about 4 to about 6 g/L, or about 6 to about 8 g/L). In some embodiments, the one or more non-volatile compounds can include no tartaric acid.

The one or more non-volatile compounds in an alcoholic beverage replica can include vanillic acid. In some embodiments, the vanillic acid can be present in an amount of about 0.3 mg/L to about 660 mg/L (e.g., about 0.3 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, or about 100 to about 660 mg/L). In some embodiments, the one or more non-volatile compounds can include no vanillic acid.

The one or more non-volatile compounds in an alcoholic beverage replica can include sorbic acid. In some embodiments, the sorbic acid can be present in an amount of about 1.2 mg/L to about 8.3 mg/L (e.g., about 1.2 to about 1.5 mg/L, about 1.5 to about 2 mg/L, about 2 to about 4 mg/L, about 4 to about 6 mg/L, about 6 to about 8 mg/L, about 2 to about 8 mg/L, or about 6.0 to about 8.3 mg/L). In some embodiments, the one or more non-volatile compounds can include no sorbic acid.

The one or more non-volatile compounds in an alcoholic beverage replica can include D-glucuronic acid. In some embodiments, the D-glucuronic acid can be present in an amount of about 0.06 mg/L to about 1.8 g/L (e.g., about 0.06 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1.0 to about 1.8 g/L, about 1.0 to about 1.5 g/L, or about 1.5 to about 1.8 g/L). In some embodiments, the one or more non-volatile compounds can include no D-glucuronic acid.

The one or more non-volatile compounds in an alcoholic beverage replica can include quinic acid. In some embodiments, the quinic acid can be present in an amount of about 0.002 mg/L to about 14 mg/L (e.g., about 0.002 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 14 mg/L). In some embodiments, the one or more non-volatile compounds can include no quinic acid.

The one or more non-volatile compounds in an alcoholic beverage replica can include gallic acid. In some embodiments, the gallic acid can be present in an amount of about 0.05 mg/L to about 40 mg/L (e.g., about 0.05 to about 0.1 mg/L, about 0.1 to about 0.5 mg/L, about 0.5 to about 1 mg/L, about 1 to about 5 mg/L, about 5 to about 10 mg/L, about 10 to about 40 mg/L, about 10 to about 30 mg/L, or about 20 to about 40 mg/L). In some embodiments, the one or more non-volatile compounds can include no gallic acid.

The one or more non-volatile compounds in an alcoholic beverage replica can include 2-furoic acid. In some embodiments, the 2-furoic acid can be present in an amount of about 8.3 mg/L to about 16 mg/L (e.g., about 8.3 to about 10 mg/L, about 10 to about 15 mg/L, about 10 to about 16 mg/L, about 10 to about 12 mg/L, about 12 to about 14 mg/L, or about 14 to about 16 mg/L). In some embodiments, the one or more non-volatile compounds can include no 2-furoic acid.

The one or more non-volatile compounds in an alcoholic beverage replica can include 3,4-dihydroxybenzoic acid. In some embodiments, the 3,4-dihydroxybenzoic acid can be present in an amount of about 0.005 mg/L to about 1 mg/L (e.g., about 0.005 to about 0.01 mg/L, about 0.01 to about 0.05 mg/L, about 0.05 to about 0.1 mg/L, about 0.1 to about 0.5 mg/L, or about 0.5 to about 1 mg/L). In some embodiments, the one or more non-volatile compounds can include no 3,4-dihydroxybenzoic acid.

The one or more non-volatile compounds in an alcoholic beverage replica can include 2-isopropylmalic acid. In some embodiments, the 2-isopropylmalic acid can be present in an amount of about 0.03 mg/L to about 16 mg/L (e.g., about 0.03 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 15 mg/L, or about 10 to about 16 mg/L). In some embodiments, the one or more non-volatile compounds can include no 2-isopropylmalic acid.

The one or more non-volatile compounds in an alcoholic beverage replica can include pipecolinic acid. In some embodiments, the pipecolinic acid can be present in an amount of about 0.7 mg/L to about 2.2 mg/L (e.g., about 0.7 to about 1 mg/L, about 1 to about 2 mg/L, about 1.0 to about 1.5 mg/L, about 1.5 to about 2.0 mg/L, about 1.5 to about 2.2 mg/L, or about 1 to about 2.2 mg/L). In some embodiments, the one or more non-volatile compounds can include no pipecolinic acid.

The one or more non-volatile compounds in an alcoholic beverage replica can include adipic acid. In some embodiments, the adipic acid can be present in an amount of about 0.02 mg/L to about 0.15 mg/L (e.g., about 0.02 to about 0.05 mg/L, about 0.05 to about 0.1 mg/L, or about 0.10 to about 0.15 mg/L). In some embodiments, the one or more non-volatile compounds can include no adipic acid.

The one or more non-volatile compounds in an alcoholic beverage replica can include trans-ferulic acid. In some embodiments, the trans-ferulic acid can be present in an amount of about 0.01 mg/L to about 0.5 mg/L (e.g., about 0.01 to about 0.05 mg/L, about 0.05 to about 0.1 mg/L, or about 0.1 to about 0.5 mg/L). In some embodiments, the one or more non-volatile compounds can include no trans-ferulic acid.

The one or more non-volatile compounds in an alcoholic beverage replica can include sinapinic acid. In some embodiments, the sinapinic acid can be present in an amount of about 0.04 mg/L to about 0.1 mg/L (e.g., about 0.04 to about 0.06 mg/L, about 0.06 to about 0.08 mg/L, or about 0.08 to about 0.1 mg/L). In some embodiments, the one or more non-volatile compounds can include no sinapinic acid.

The one or more non-volatile compounds in an alcoholic beverage replica can include ellagic acid. In some embodiments, the ellagic acid can be present in an amount of about 0.03 mg/L to about 20 mg/L (e.g., about 0.03 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 10 to about 20 mg/L). In some embodiments, the one or more non-volatile compounds can include no ellagic acid.

The one or more non-volatile compounds in an alcoholic beverage replica can include salicylic acid. In some embodiments, the salicylic acid can be present in an amount of about 0.03 mg/L to about 0.09 mg/L (e.g., about 0.03 to about 0.06 mg/L, about 0.06 to about 0.09 mg/L, about 0.03 to about 0.05 mg/L, about 0.05 to about 0.07 mg/L, or about 0.07 to about 0.09 mg/L). In some embodiments, the one or more non-volatile compounds can include no salicylic acid.

The one or more non-volatile compounds in an alcoholic beverage replica can include caffeic acid. In some embodiments, the caffeic acid can be present in an amount of about 0.9 mg/L to about 14 mg/L (e.g., about 0.9 to about 1 mg/L, about 0.9 to about 5 mg/L, about 1 to about 5 mg/L, about 5 to about 10 mg/L, or about 10 to about 14 mg/L). In some embodiments, the one or more non-volatile compounds can include no caffeic acid.

The one or more non-volatile compounds in an alcoholic beverage replica can include cinnamic acid. In some embodiments, the cinnamic acid can be present in an amount of about 0.1 mg/L to about 6 mg/L (e.g., about 0.1 to about 0.5 mg/L, about 0.5 to about 1 mg/L, about 1 to about 5 mg/L, about 1 to about 6 mg/L, about 1 to about 2 mg/L, about 2 to about 4 mg/L, or about 4 to about 6 mg/L). In some embodiments, the one or more non-volatile compounds can include no cinnamic acid.

The one or more non-volatile compounds in an alcoholic beverage replica can include coumaric acid. In some embodiments, the coumaric acid can be present in an amount of about 0.01 mg/L to about 5 mg/L (e.g., about 0.01 to about 0.05 mg/L, about 0.05 to about 0.1 mg/L, about 0.1 to about 0.5 mg/L, about 0.5 to about 1 mg/L, about 1 to about 3 mg/L, about 3 to about 5 mg/L, or about 1 to about 5 mg/L). In some embodiments, the one or more non-volatile compounds can include no coumaric acid.

The one or more non-volatile compounds in an alcoholic beverage replica can include kynurenic acid. In some embodiments, the kynurenic acid can be present in an amount of about 0.003 mg/L to about 0.1 mg/L (e.g., about 0.003 to about 0.005 mg/L, about 0.005 to about 0.01 mg/L, about 0.01 to about 0.05 mg/L, or about 0.05 to about 0.1 mg/L). In some embodiments, the one or more non-volatile compounds can include no kynurenic acid.

The one or more non-volatile compounds in an alcoholic beverage replica can include fructose. In some embodiments, the fructose can be present in an amount of about 1.3 mg/L to about 160 g/L (e.g., about 1.3 to about 5 mg/L, about 2 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, about 5 to about 10 g/L, about 10 to about 50 g/L, about 50 to about 100 g/L, about 100 to about 150 g/L, or about 100 to about 160 g/L). In some embodiments, the one or more non-volatile compounds can include no fructose.

The one or more non-volatile compounds in an alcoholic beverage replica can include glucosamine. In some embodiments, the glucosamine can be present in an amount of about 0.015 mg/L to about 100 mg/L (e.g., 0.015 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, or about 50 to about 100 mg/L). In some embodiments, the one or more non-volatile compounds can include no glucosamine.

The one or more non-volatile compounds in an alcoholic beverage replica can include glucose. In some embodiments, the glucose can be present in an amount of about 0.4 mg/L to about 125 g/L (e.g., 0.4 to about 1 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, about 5 to about 10 g/L, about 10 to about 50 g/L, about 50 to about 100 g/L, about 50 to about 125 g/L, or about 100 to about 125 g/L). In some embodiments, the one or more non-volatile compounds can include no glucose.

The one or more non-volatile compounds in an alcoholic beverage replica can include mannose. In some embodiments, the mannose can be present in an amount of about 3 mg/L to about 1.4 g/L (e.g., about 3 to about 5 mg/L, about 5 to about 10 mg/L, about 10 to about 50 mg/L, about 50 to about 100 mg/L, about 100 to about 500 mg/L, about 500 mg/L to about 1 g/L, about 1.0 to about 1.4 g/L, or about 500 mg/L to about 1.4 g/L). In some embodiments, the one or more non-volatile compounds can include no mannose.

The one or more non-volatile compounds in an alcoholic beverage replica can include ribose. In some embodiments, the ribose can be present in an amount of about 0.1 mg/L to about 70 mg/L (e.g., about 0.1 to about 0.5 mg/L, about 0.5 to about 1 mg/L, about 1 to about 5 mg/L, about 5 to about 10 mg/L, about 10 to about 50 mg/L, about 10 to about 70 mg/L, about 10 to about 30 mg/L, about 30 to about 50 mg/L, or about 50 to about 70 mg/L). In some embodiments, the one or more non-volatile compounds can include no ribose.

The one or more non-volatile compounds in an alcoholic beverage replica can include arabitol. In some embodiments, the arabitol can be present in an amount of about 0.03 mg/L to about 15 mg/L (e.g., about 0.03 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 5 to about 15 mg/L, or about 10 to about 15 mg/L). In some embodiments, the one or more non-volatile compounds can include no arabitol.

The one or more non-volatile compounds in an alcoholic beverage replica can include rhamnose. In some embodiments, the rhamnose can be present in an amount of about 0.05 mg/L to about 60 mg/L (e.g., about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 10 to about 60 mg/L, about 10 to about 20 mg/L, about 20 to about 40 mg/L, or about 40 to about 60 mg/L). In some embodiments, the one or more non-volatile compounds can include no rhamnose.

The one or more non-volatile compounds in an alcoholic beverage replica can include galactose. In some embodiments, the galactose can be present in an amount of about 1.9 mg/L to about 22 mg/L (e.g., about 1.9 to about 5 mg/L, about 2 to about 5 mg/L, about 5 to about 10 mg/L, about 10 to about 20 mg/L, about 10 to about 22 mg/L, about 10 to about 15 mg/L, about 15 to about 20 mg/L, or about 15 to about 22 mg/L). In some embodiments, the one or more non-volatile compounds can include no galactose.

The one or more non-volatile compounds in an alcoholic beverage replica can include xylose. In some embodiments, the xylose can be present in an amount of about 0.3 mg/L to about 40 g/L (e.g., 0.3 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, about 5 to about 10 g/L, about 10 to about 40 g/L, about 10 to about 30 g/L, or about 20 to about 40 g/L). In some embodiments, the one or more non-volatile compounds can include no xylose.

The one or more non-volatile compounds in an alcoholic beverage replica can include fucose. In some embodiments, the fucose can be present in an amount of about 0.1 mg/L to about 3.4 g/L (e.g., about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 3 g/L, about 1 to about 2 g/L, about 2 to about 3 g/L, about 1.0 to about 3.4 g/L, or about 2.0 to about 2.4 g/L). In some embodiments, the one or more non-volatile compounds can include no fucose.

The one or more non-volatile compounds in an alcoholic beverage replica can include glycerol. In some embodiments, the glycerol can be present in an amount of about 900 mg/L to about 26 g/L (e.g., about 900 mg/L to about 1 g/L, about 900 mg/L to about 5 g/L, about 1 to about 5 g/L, about 5 to about 10 g/L, about 10 to about 20 g/L, about 10 to about 15 g/L, about 15 to about 20 g/L, about 5 to about 15 g/L, about 15 to about 25 g/L, about 15 to about 26 g/L, about 20 to about 25 g/L, or about 20 to about 26 g/L). In some embodiments, the one or more non-volatile compounds can include no glycerol.

The one or more non-volatile compounds in an alcoholic beverage replica can include mannitol. In some embodiments, the mannitol can be present in an amount of about 0.06 mg/L to about 6.5 g/L (e.g., about 0.06 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, about 1 to about 6 g/L, about 1.0 to about 6.5 g/L, about 1 to about 3 g/L, about 3 to about 5 g/L, about 5.0 to about 6.5 g/L, about 2 to about 4 g/L, about 4 to about 6 g/L, or about 4.0 to about 6.5 g/L). In some embodiments, the one or more non-volatile compounds can include no mannitol.

The one or more non-volatile compounds in an alcoholic beverage replica can include inositol (e.g., myo-inositol). In some embodiments, the inositol can be present in an amount of about 0.08 mg/L to about 6.5 g/L (e.g., about 0.08 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 500 mg/L, about 500 mg/L to about 1 g/L, about 1 to about 5 g/L, about 1 to about 6 g/L, about 1.0 to about 6.5 g/L, about 1 to about 3 g/L, about 3 to about 5 g/L, about 2 to about 4 g/L, about 4 to about 6 g/L, or about 4.0 to about 6.5 g/L). In some embodiments, the one or more non-volatile compounds can include no inositol.

The one or more non-volatile compounds in an alcoholic beverage replica can include sorbitol. In some embodiments, the sorbitol can be present in an amount of about 0.02 mg/L to about 500 mg/L (e.g., about 0.02 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, or about 100 to about 500 mg/L). In some embodiments, the one or more non-volatile compounds can include no sorbitol.

The one or more non-volatile compounds in an alcoholic beverage replica can include choline. In some embodiments, the choline can be present in an amount of about 0.001 mg/L to about 220 mg/L (e.g., 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 200 mg/L, or about 100 to about 220 mg/L). In some embodiments, the one or more non-volatile compounds can include no choline.

The one or more non-volatile compounds in an alcoholic beverage replica can include a surfactant. In some embodiments, the surfactant (% v/v) can be present in an amount of about 0.002 (% v/v) to about 0.006 (% v/v) (e.g., about 0.002 (% v/v) to about 0.004 (% v/v) or about 0.004 (% v/v) to about 0.006 (% v/v)). In some embodiments, the one or more non-volatile compounds can include no surfactant.

The one or more non-volatile compounds in an alcoholic beverage replica can include pantothenic acid. In some embodiments, the pantothenic acid can be present in an amount of about 0.7 mg/L to about 1.3 mg/L (e.g., about 0.7 to about 0.9 mg/L, about 0.9 to about 1.1 mg/L, about 1.1 to about 1.3 mg/L, about 0.7 to about 1 mg/L, or about 1.0 to about 1.3 mg/L). In some embodiments, the one or more non-volatile compounds can include no pantothenic acid.

The one or more non-volatile compounds in an alcoholic beverage replica can include pyridoxine. In some embodiments, the pyridoxine can be present in an amount of about 0.0007 mg/L to about 0.9 mg/L (e.g., about 0.0007 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.1 to about 0.9 mg/L, about 0.5 to about 0.9 mg/L, about 0.1 to about 0.3 mg/L, about 0.3 to about 0.5 mg/L, about 0.5 to about 0.7 mg/L, or about 0.7 to about 0.9 mg/L). In some embodiments, the one or more non-volatile compounds can include no pyridoxine.

The one or more non-volatile compounds in an alcoholic beverage replica can include acetovanillone. In some embodiments, the acetovanillone can be present in an amount of about 0.0005 mg/L to about 0.6 mg/L (e.g., about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, or about 0.1 to about 0.6 mg/L). In some embodiments, the one or more non-volatile compounds can include no acetovanillone.

The one or more non-volatile compounds in an alcoholic beverage replica can include carnitine. In some embodiments, the carnitine can be present in an amount of about 0.0001 mg/L to about 3.5 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 3 mg/L, about 1.0 to about 3.5 mg/L, about 1 to about 2 mg/L, about 1.5 to about 3.5 mg/L, about 1.5 to about 2.5 mg/L, or about 2.5 to about 3.5 mg/L). In some embodiments, the one or more non-volatile compounds can include no carnitine.

The one or more non-volatile compounds in an alcoholic beverage replica can include disodium 5′ ribonucleotides (e.g., 5′-guanylate & 5′-inosinate). In some embodiments, the disodium 5′ ribonucleotides can be present in an amount of about 0.4 mg/L to about 0.8 mg/L (e.g., about 0.4 to about 0.6 mg/L or about 0.6 to about 0.8 mg/L). In some embodiments, the one or more non-volatile compounds can include no disodium 5′ ribonucleotides.

The one or more non-volatile compounds in an alcoholic beverage replica can include monosodium glutamate. In some embodiments, the monosodium glutamate can be present in an amount of about 7 mg/L to about 13 mg/L (e.g., about 7 to about 10 mg/L, about 10 to about 13 mg/L, about 7 to about 9 mg/L, about 9 to about 11 mg/L, or about 11 to about 13 mg/L). In some embodiments, the one or more non-volatile compounds can include no monosodium glutamate.

The one or more non-volatile compounds in an alcoholic beverage replica can include syringaldehyde. In some embodiments, the syringaldehyde can be present in an amount of about 0.01 mg/L to about 11 mg/L (e.g., about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, or about 5 to about 11 mg/L). In some embodiments, the one or more non-volatile compounds can include no syringaldehyde.

The one or more non-volatile compounds in an alcoholic beverage replica can include vanillin. In some embodiments, the vanillin can be present in an amount of about 0.003 mg/L to about 35 mg/L (e.g., about 0.003 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 35 mg/L, about 10 to about 20 mg/L, about 20 to about 30 mg/L, about 5 to about 15 mg/L, about 15 to about 25 mg/L, or about 25 to about 35 mg/L). In some embodiments, the one or more non-volatile compounds can include no vanillin.

The one or more non-volatile compounds in an alcoholic beverage replica can include pyridine. In some embodiments, the pyridine can be present in an amount of about 1 mg/L to about 4 mg/L (e.g., about 1 to about 3 mg/L or about 2 to about 4 mg/L). In some embodiments, the one or more non-volatile compounds can include no pyridine.

The one or more non-volatile compounds in an alcoholic beverage replica can include 2,3-dimethylpyrazine. In some embodiments, the 2,3-dimethylpyrazine can be present in an amount of about 0.08 mg/L to about 0.3 mg/L (e.g., about 0.08 to about 0.1 mg/L, about 0.1 to about 0.3 mg/L, about 0.1 to about 0.2 mg/L, or about 0.2 to about 0.3 mg/L). In some embodiments, the one or more non-volatile compounds can include no 2,3-dimethylpyrazine.

The one or more non-volatile compounds in an alcoholic beverage replica can include camphoric acid. In some embodiments, the camphoric acid can be present in an amount of about 5 mg/L to about 45 mg/L (e.g., about 5 to about 10 mg/L, about 10 to about 45 mg/L, about 10 to about 20 mg/L, about 20 to about 30 mg/L, about 30 to about 40 mg/L, about 5 to about 15 mg/L, about 15 to about 25 mg/L, about 25 to about 35 mg/L, or about 35 to about 45 mg/L). In some embodiments, the one or more non-volatile compounds can include no camphoric acid.

The one or more non-volatile compounds in an alcoholic beverage replica can include adenine. In some embodiments, the adenine can be present in an amount of about 0.0003 mg/L to about 3.5 mg/L (e.g., about 0.0003 to about 0.0005 mg/L, about 0.0005 to about 0.001 mg/L, about 0.001 to about 0.005 mg/L, about 0.005 to about 0.01 mg/L, about 0.01 to about 0.05 to about 0.1 mg/L, about 0.1 to about 0.5 mg/L, about 0.5 to about 1 mg/L, about 1 to about 3 mg/L, about 1.0 to about 3.5 mg/L, about 1 to about 2 mg/L, about 2 to about 3 mg/L, about 0.5 to about 1.5 mg/L, about 1.5 to about 2.5 mg/L, or about 2.5 to about 3.5 mg/L). In some embodiments, the one or more non-volatile compounds can include no adenine.

The one or more non-volatile compounds in an alcoholic beverage replica can include cytidine. In some embodiments, the cytidine can be present in an amount of about 0.2 mg/L to about 0.5 mg/L (e.g., about 0.2 to about 0.4 mg/L or about 0.3 to about 0.5 mg/L). In some embodiments, the one or more non-volatile compounds can include no cytidine.

The one or more non-volatile compounds in an alcoholic beverage replica can include guanine. In some embodiments, the guanine can be present in an amount of about 0.0001 mg/L to about 500 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.5 to about 1 mg/L, about 1 to about 5 mg/L, about 5 to about 10 mg/L, about 10 to about 50 mg/L, about 50 to about 100 mg/L, or about 100 to about 500 mg/L). In some embodiments, the one or more non-volatile compounds can include no guanine.

The one or more non-volatile compounds in an alcoholic beverage replica can include uracil. In some embodiments, the uracil can be present in an amount of about 1.2 mg/L to about 4.5 mg/L (e.g., about 1.2 to about 2 mg/L, about 2 to about 3 mg/L, about 3 to about 4 mg/L, about 2 to about 4 mg/L, about 1.5 to about 2.5 mg/L, about 2.5 to about 3.5 mg/L, about 3.5 to about 4.5 mg/L, or about 2.0 to about 4.5 mg/L). In some embodiments, the one or more non-volatile compounds can include no uracil.

The one or more non-volatile compounds in an alcoholic beverage replica can include catechin. In some embodiments, the catechin can be present in an amount of about 0.03 mg/L to about 2.4 mg/L (e.g., about 0.03 to about 0.05 mg/L, about 0.05 to about 0.1 mg/L, about 0.1 to about 0.5 mg/L, about 0.5 to about 1 mg/L, about 1 to about 2 mg/L, or about 1.0 to about 2.4 mg/L). In some embodiments, the one or more non-volatile compounds can include no catechin.

The one or more non-volatile compounds in an alcoholic beverage replica can include methyl gallate. In some embodiments, the methyl gallate can be present in an amount of about 0.04 mg/L to about 0.2 mg/L (e.g., about 0.04 to about 0.1 mg/L, about 0.05 to about 0.1 mg/L, or about 0.1 to about 0.2 mg/L). In some embodiments, the one or more non-volatile compounds can include no methyl gallate.

The one or more non-volatile compounds in an alcoholic beverage replica can include epicatechin. In some embodiments, the epicatechin can be present in an amount of about 0.04 mg/L to about 0.5 mg/L (e.g., about 0.04 to about 0.1 mg/L, about 0.05 to about 0.1 mg/L, about 0.1 to about 0.5 mg/L, about 0.1 to about 0.3 mg/L, or about 0.3 to about 0.5 mg/L). In some embodiments, the one or more non-volatile compounds can include no epicatechin.

The one or more non-volatile compounds in an alcoholic beverage replica can include resveratrol. In some embodiments, the resveratrol can be present in an amount of about 0.005 mg/L to about 0.01 mg/L (e.g., about 0.005 to about 0.007 mg/L, about 0.007 to about 0.009 mg/L, about 0.006 to about 0.008 mg/L, or about 0.008 to about 0.01 mg/L). In some embodiments, the one or more non-volatile compounds can include no resveratrol.

The one or more non-volatile compounds in an alcoholic beverage replica can include propyl gallate. In some embodiments, the propyl gallate can be present in an amount of about 0.03 mg/L to about 0.3 mg/L (e.g., about 0.03 to about 0.05 mg/L, about 0.05 to about 0.1 mg/L, about 0.1 to about 0.3 mg/L, about 0.1 to about 0.2 mg/L, or about 0.2 to about 0.3 mg/L). In some embodiments, the one or more non-volatile compounds can include no propyl gallate.

The one or more non-volatile compounds in an alcoholic beverage replica can include quercetin. In some embodiments, the quercetin can be present in an amount of about 0.1 mg/L to about 0.9 mg/L (e.g., about 0.1 to about 0.5 mg/L, about 0.5 to about 0.9 mg/L, about 0.1 to about 0.3 mg/L, about 0.3 to about 0.5 mg/L, about 0.5 to about 0.7 mg/L, or about 0.7 to about 0.9 mg/L). In some embodiments, the one or more non-volatile compounds can include no quercetin.

The one or more non-volatile compounds in an alcoholic beverage replica can include polydatin. In some embodiments, the polydatin can be present in an amount of about 0.15 mg/L to about 0.55 mg/L (e.g., about 0.15 to about 0.2 mg/L, about 0.2 to about 0.5 mg/L, about 0.2 to about 0.4 mg/L, about 0.3 to about 0.5 mg/L, about 0.15 to about 0.25 mg/L, about 0.25 to about 0.35 mg/L, about 0.35 to about 0.45 mg/L, or about 0.45 to about 0.55 mg/L). In some embodiments, the one or more non-volatile compounds can include no polydatin.

In some embodiments, an alcoholic beverage replica can include at least two (e.g., at least 3, at least 4, at least 5, at least 6, at least 7, at least 8, at least 9, at least 10, at least 15, at least 20, at least 25, at least 30, at least 40, at least 50, at least 60, 2 to 70, 2 to 60, 2 to 50, 2 to 40, 2 to 30, 2 to 10, 2 to 5, 5 to 70, 5 to 60, 5 to 50, 5 to 40, 5 to 30, 5 to 20, 5 to 10, 10 to 70, 10 to 60, 10 to 50, 10 to 40, 10 to 30, 10 to 20, 20 to 70, 20 to 60, 20 to 50, 20 to 40, or 20 to 30) compounds selected from the group consisting of 2,3,5,6-tetramethylpyrazine, 2,3,5-trimethylpyrazine, 2,3-dimethylpyrazine, 2-isopropylmalic acid, 3,4-dihydroxybenzoic acid, 4-guanidinobutyric acid, acetic acid, acetovanillone, adenine, adipic acid, alanine, arabitol, arginine, aspartic acid, betaine, caffeic acid, camphoric acid, carnitine, catechin, choline, citric acid, citrulline, coumaric acid, cytidine, cytosine, D-glucuronic acid, disodium 5′ ribonucleotides (e.g., 5′-guanylate and 5′-inosinate), ellagic acid, epicatechin, fructose, fucose, fumaric acid, GABA, galactose, gallic acid, glucose, glutamic acid, guanine, histidine, homoserine, kynurenic acid, lactic acid, lysine, malic acid, mannitol, methionine, methyl gallate, monosodium glutamate, inositol, phenylalanine, pipecolinic acid, proline, propyl gallate, pyridine, pyridoxine, pyruvic acid, quercetin, quinic acid, rhamnose, ribose, salicylic acid, serine, sorbitol, succinic acid, syringaldehyde, tartaric acid, trans-4-hydroxyproline, trans-ferulic acid, uracil, vanillic acid, and vanillin.

In some embodiments, an alcoholic beverage replica can include at least one (e.g., at least 2, at least 3, at least 4, at least 5, at least 6, at least 7, at least 8, at least 9, at least 10, at least 15, at least 20, at least 25, 1 to 29, 1 to 25, 1 to 20, 1 to 15, 1 to 10, 1 to 5, 1 to 2, 2 to 29, 2 to 25, 2 to 20, 2 to 15, 2 to 10, 2 to 5, 5 to 29, 5 to 25, 5 to 20, 5 to 15, 5 to 10, 10 to 29, 10 to 25, 10 to 20, or 10 to 15) compounds selected from the group consisting of 2-furoic acid, asparagine, beta-alanine, carnosine, cinnamic acid, D-gluconolactone (gluconic acid), glucosamine, glutamine, glycerol, glycine, hesperetin, isoleucine, leucine, mannose, ornithine, pantothenic acid, piperine, polydatin, resveratrol, sinapinic acid, sorbic acid, a surfactant, syringic acid, threonine, tryptamine, tryptophan, tyramine, tyrosine, valine, and xylose.

In some embodiments, an alcoholic beverage replica can include at least one (e.g., at least 2, 1 to 3, 1 to 2, or 3) compounds selected from the group consisting of a surfactant, gum arabic, and pectin.

Because of the methods by which they are made, the alcoholic beverage replicas provided herein typically lack contaminants and other detrimental compounds that sometimes are encountered in traditional alcoholic beverages. These include, without limitation, organisms such as Escherichia. coli, Salmonella sp., Brettanomyces sp., Lactobacillales, Saccharomyces sp. (which are often used by distillers and brewers), Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, and Verticillium psalliotae (strains that have been isolated from the corks of corked wine; see, www.ncbi.nlm.nih.gov/pmc/articles/PMC134401/), as well as heavy metal, mold, mildew, rot, insects, insect eggs, insect filth, rodent filth, mammalian excreta, insect lecithins, hydrogen sulfide, hydrogen disulfide, 2,4,6-trichloranisole (which has been linked to a skunked wine smell), 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

It is noted that while alcoholic beverage replicas can include volatile and non-volatile compounds as listed herein, the added compounds may react with one another to generate additional compounds, or to change the effective amount of one or more of the added compounds within the whiskey replica formulation.

This document also provides methods for making alcoholic beverage replicas. Any of the alcoholic beverage replicas described herein can be made by methods as disclosed herein. In some embodiments, the methods provided herein can be carried out by first mixing one or more organic acids with water, adding ethanol and non-volatile ingredients, and then adding small quantities of diluted VOCs. In general, water, ethanol, organic acids, VOCs, amino acids, and certain texture and flavor modifying ingredients are all necessary to generate a final product having the characteristics of a traditionally-produced alcoholic beverage.

In some embodiments, the methods provided herein can include combining water one or more acids, one or more sugars or sugar alcohols, a base, one or more nucleotide monophosphates, one or more amino acids, ethanol, and ten or more additional VOCs. In some embodiments, the methods also can include adding a coloring agent (e.g., carotene and/or caramel), a surfactant, gum arabic, pectin, or any combination thereof.

This document also provides methods for generating concentrated versions of any alcoholic beverage replica, where the concentrated versions include all of the additional VOCs and non-volatile components of the final product, but without the bulk of the ethanol and water. Such concentrates can be manufactured and then shipped to a second location, where water and ethanol can be added at the appropriate ABV and volume to create a finished product.

Any suitable concentration of additional VOCs and non-volatile compounds can be used. For example, a concentrated alcoholic beverage replica can include additional VOCs and non-volatile components in a concentration of at least 1.1-fold (e.g., 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold concentrations, as compared to their concentrations in the final product, such that they can be diluted by at least about 1.1-fold (e.g., 1.2-fold, 1.3-fold, 1.5-fold, 1.6-fold, 1.7-fold, 1.8-fold, 1.9-fold, 2-fold, 5-fold, 8-fold, 10-fold, 15-fold, or 20-fold), respectively, with water and ethanol to yield the final product. The concentrates provided herein can contain all of the formulaic flavor, acid, and other components (as well as any grain neutral spirits) that are present in the final product. In general, such concentrates can be prepared in much the same way as a non-concentrated alcoholic beverage replica, by combining the desired amounts of additional VOCs and non-volatile components but omitting the water and the bulk of the ethanol. It is noted that in some cases, some amount of ethanol can be included in the concentrate in order to facilitate dissolution of the additional VOCs and non-volatile compounds.

Any of the alcoholic beverage replicas described herein can be made as a concentrate, e.g., using the methods disclosed herein. It will be appreciated that the amount of any component (e.g., additional VOC or non-volatile) disclosed herein as an amount for an alcoholic beverage replica (e.g., a 1× alcoholic beverage replica) can be multiplied by the concentration factor (e.g., 1.1-fold, 1.2-fold, 1.3-fold, 1.5-fold, 1.6-fold, 1.7-fold, 1.8-fold, 1.9-fold 2-fold, 3-fold, 5-fold, 8-fold, 10-fold, 15-fold, or 20-fold) for the appropriate concentrated amount.

### Exemplary Embodiments

Embodiment 1 is an alcoholic beverage replica comprising ethanol, water, and one or more additional VOCs, wherein the one or more additional VOCs comprise at least one VOC that is not present in a corresponding traditional alcoholic beverage.

Embodiment 2 is the alcoholic beverage replica of embodiment 1, wherein the one or more additional VOCs do not comprise at least one VOC that is present in a corresponding traditional alcoholic beverage.

Embodiment 3 is an alcoholic beverage replica comprising ethanol, water, and one or more additional VOCs, wherein the one or more additional VOCs do not comprise at least one VOC that is present in a corresponding traditional alcoholic beverage.

Embodiment 4 is the alcoholic beverage replica of embodiment 3, wherein the one or more additional VOCs comprise at least one VOC that is not present in a corresponding traditional alcoholic beverage.

Embodiment 5 is the alcoholic beverage replica of embodiment 1 or embodiment 4, wherein the at least one VOC that is not present in a corresponding traditional alcoholic beverage is selected from the group consisting of 1,4-cineole, 1-para-menthene-8-thiol, 2,3-hexanedione, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-nonanol, 2-octanone, 2-pentylfuran, 3-heptyl acetate, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, allyl heptanoate, allyl hexanoate, anisyl acetate, anisyl alcohol, anisyl butyrate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, dihydrocoumarin, ethyl 2-trans-4-cis-decadienoate, furfuryl thioacetate, gamma-dodecalactone, gamma-heptalactone, geranyl butyrate, geranyl propionate, hexanal, hexyl 3-methylbutanoate, hexyl butyrate, hexyl isobutyrate, hexyl propionate, IBMP (3-isobutyl-2-methoxypyrazine), indole, isoamyl cinnamate, isoamyl phenylacetate, isobutyl butyrate, isobutyl propionate, isoeugenol, L-menthyl acetate, methionyl acetate (3-methylthio-propylacetate), methionyl butyrate, methyl benzoate, methyl cinnamate, methyl-2-pyrrolyl ketone, octanal, omega-pentadecalactone, perillaldehyde, phenethyl 2-methylbutyrate, phenethyl tiglate, propanal, propionaldehyde, propyl isovalerate, tetrahydrolinalool, thymol, valencene, valeric acid, vanillyl butyl ether.

Embodiment 6 is the alcoholic beverage replica of any one of embodiments 1 to 5, wherein the one or more additional VOCs comprise one or more of butyl formate, ethyl octanoate, ethyl propionate, ethyl-2-methylbutyrate, isoamyl acetate, isoamyl alcohol, and isobutanol.

Embodiment 7 is the alcoholic beverage replica of any one of embodiments 1 to 5, wherein the one or more additional VOCs comprise two or more of butyl formate, ethyl octanoate, ethyl propionate, ethyl-2-methylbutyrate, isoamyl acetate, isoamyl alcohol, and isobutanol.

Embodiment 8 is the alcoholic beverage replica of any one of embodiments 1 to 5, wherein the one or more additional VOCs comprise three or more of butyl formate, ethyl octanoate, ethyl propionate, ethyl-2-methylbutyrate, isoamyl acetate, isoamyl alcohol, and isobutanol.

Embodiment 9 is the alcoholic beverage replica of any one of embodiments 1 to 5, wherein the one or more additional VOCs comprise four or more of butyl formate, ethyl octanoate, ethyl propionate, ethyl-2-methylbutyrate, isoamyl acetate, isoamyl alcohol, and isobutanol.

Embodiment 10 is the alcoholic beverage replica of any one of embodiments 1 to 5, wherein the one or more additional VOCs comprise five or more of butyl formate, ethyl octanoate, ethyl propionate, ethyl-2-methylbutyrate, isoamyl acetate, isoamyl alcohol, and isobutanol.

Embodiment 11 is the alcoholic beverage replica of any one of embodiments 1 to 5, wherein the one or more additional VOCs comprise six or more of butyl formate, ethyl octanoate, ethyl propionate, ethyl-2-methylbutyrate, isoamyl acetate, isoamyl alcohol, and isobutanol.

Embodiment 12 is the alcoholic beverage replica of any one of embodiments 1 to 5, wherein the one or more additional VOCs comprise butyl formate, ethyl octanoate, ethyl propionate, ethyl-2-methylbutyrate, isoamyl acetate, isoamyl alcohol, and isobutanol.

Embodiment 13 is the alcoholic beverage replica of any one of embodiments 1 to 5, wherein the one or more additional VOCs comprise no more than 6 of butyl formate, ethyl octanoate, ethyl propionate, ethyl-2-methylbutyrate, isoamyl acetate, isoamyl alcohol, and isobutanol.

Embodiment 14 is the alcoholic beverage replica of any one of embodiments 1 to 5, wherein the one or more additional VOCs comprise no more than 5 of butyl formate, ethyl octanoate, ethyl propionate, ethyl-2-methylbutyrate, isoamyl acetate, isoamyl alcohol, and isobutanol.

Embodiment 15 is the alcoholic beverage replica of any one of embodiments 1 to 5, wherein the one or more additional VOCs comprise no more than 4 of butyl formate, ethyl octanoate, ethyl propionate, ethyl-2-methylbutyrate, isoamyl acetate, isoamyl alcohol, and isobutanol.

Embodiment 16 is the alcoholic beverage replica of any one of embodiments 1-15, wherein the one or more additional VOCs comprise (−)alpha-pinene in an amount of at least about 0.0024 mg/L.

Embodiment 17 is the alcoholic beverage replica of any one of embodiments 1-16, wherein the one or more additional VOCs comprise (−)cis-rose-oxide in an amount of at least about 0.0028 mg/L.

Embodiment 18 is the alcoholic beverage replica of any one of embodiments 1-17, wherein the one or more additional VOCs comprise 2-nonanone in an amount of at least about 0.085 mg/L.

Embodiment 19 is the alcoholic beverage replica of any one of embodiments 1-18, wherein the one or more additional VOCs comprise 2-undecanone in an amount of at least about 0.0014 mg/L.

Embodiment 20 is the alcoholic beverage replica of any one of embodiments 1-19, wherein the one or more additional VOCs comprise 3-carene in an amount of at least about 0.036 mg/L.

Embodiment 21 is the alcoholic beverage replica of any one of embodiments 1-20, wherein the one or more additional VOCs comprise 4-carvomenthenol in an amount of at least about 0.026 mg/L.

Embodiment 22 is the alcoholic beverage replica of any one of embodiments 1-21, wherein the one or more additional VOCs comprise 4-ethyl phenol in an amount of at least about 0.21 mg/L.

Embodiment 23 is the alcoholic beverage replica of any one of embodiments 1-22, wherein the one or more additional VOCs comprise amyl butyrate in an amount of at least about 0.032 mg/L.

Embodiment 24 is the alcoholic beverage replica of any one of embodiments 1-23, wherein the one or more additional VOCs comprise beta-ionone in an amount of at least about 0.036 mg/L.

Embodiment 25 is the alcoholic beverage replica of any one of embodiments 1-24, wherein the one or more additional VOCs comprise citronellol in an amount of at least about 0.95 mg/L.

Embodiment 26 is the alcoholic beverage replica of any one of embodiments 1-25, wherein the one or more additional VOCs comprise damascenone in an amount of at least about 3.8 mg/L.

Embodiment 27 is the alcoholic beverage replica of any one of embodiments 1-26, wherein the one or more additional VOCs comprise decanoic acid in an amount of at least about 1 mg/L.

Embodiment 28 is the alcoholic beverage replica of any one of embodiments 1-27, wherein the one or more additional VOCs comprise delta-decalactone in an amount of at least about 0.009 mg/L.

Embodiment 29 is the alcoholic beverage replica of any one of embodiments 1-28, wherein the one or more additional VOCs comprise ethyl butanoate in an amount of at least about 2.1 mg/L.

Embodiment 30 is the alcoholic beverage replica of any one of embodiments 1-29, wherein the one or more additional VOCs comprise ethyl decanoate in an amount of at least about 30.6 mg/L.

Embodiment 31 is the alcoholic beverage replica of any one of embodiments 1-30, wherein the one or more additional VOCs comprise ethyl hexanoate in an amount of at least about 5.1 mg/L.

Embodiment 32 is the alcoholic beverage replica of any one of embodiments 1-31, wherein the one or more additional VOCs comprise ethyl isovalarate in an amount of at least about 1.7 mg/L.

Embodiment 33 is the alcoholic beverage replica of any one of embodiments 1-32, wherein the one or more additional VOCs comprise ethyl undecanoate in an amount of at least about 0.018 mg/L.

Embodiment 34 is the alcoholic beverage replica of any one of embodiments 1-33, wherein the one or more additional VOCs comprise gamma-decalactone in an amount of at least about 0.2 mg/L.

Embodiment 35 is the alcoholic beverage replica of any one of embodiments 1-34, wherein the one or more additional VOCs comprise gamma-terpinene in an amount of at least about 0.04 mg/L.

Embodiment 36 is the alcoholic beverage replica of any one of embodiments 1-35, wherein the one or more additional VOCs comprise hexyl acetate in an amount of at least about 0.04 mg/L.

Embodiment 37 is the alcoholic beverage replica of any one of embodiments 1-36, wherein the one or more additional VOCs comprise isoamyl acetate in an amount of at least about 8.2 mg/L.

Embodiment 38 is the alcoholic beverage replica of any one of embodiments 1-37, wherein the one or more additional VOCs comprise isoamyl hexanoate in an amount of at least about 0.0016 mg/L.

Embodiment 39 is the alcoholic beverage replica of any one of embodiments 1-38, wherein the one or more additional VOCs comprise limonene in an amount of at least about 0.012 mg/L.

Embodiment 40 is the alcoholic beverage replica of any one of embodiments 1-39, wherein the one or more additional VOCs comprise linalool in an amount of at least about 0.5 mg/L.

Embodiment 41 is the alcoholic beverage replica of any one of embodiments 1-40, wherein the one or more additional VOCs comprise methyl decanoate in an amount of at least about 0.0084 mg/L.

Embodiment 42 is the alcoholic beverage replica of any one of embodiments 1-41, wherein the one or more additional VOCs comprise nerol in an amount of at least about 0.017 mg/L.

Embodiment 43 is the alcoholic beverage replica of any one of embodiments 1-42, wherein the one or more additional VOCs comprise nonanal in an amount of at least about 0.03 mg/L.

Embodiment 44 is the alcoholic beverage replica of any one of embodiments 1-43, wherein the one or more additional VOCs comprise phenethyl propionate in an amount of at least about 0.0045 mg/L.

Embodiment 45 is the alcoholic beverage replica of any one of embodiments 1-44, wherein the one or more additional VOCs comprise propanol in an amount of less than about 1.35 mg/L.

Embodiment 46 is the alcoholic beverage replica of any one of embodiments 1-45, wherein the one or more additional VOCs comprise acetoin in an amount of at least about 0.015 mg/L.

Embodiment 47 is the alcoholic beverage replica of any one of embodiments 1-46, wherein the one or more additional VOCs comprise isoamyl isovalerate in an amount of at least about 0.014 mg/L.

Embodiment 48 is the alcoholic beverage replica of any one of embodiments 1-47, wherein the one or more additional VOCs comprise nonanoic acid in an amount of less than about 0.022 mg/L.

Embodiment 49 is the alcoholic beverage replica of any one of embodiments 1-48, wherein the one or more additional VOCs comprise phenethyl formate in an amount of at least about 0.055 mg/L.

Embodiment 50 is the alcoholic beverage replica of any one of embodiments 1-49, wherein the one or more additional VOCs comprise salicylaldehyde in an amount of at least about 0.022 mg/L.

Embodiment 51 is the alcoholic beverage replica of any one of embodiments 1-50, wherein the one or more additional VOCs comprise valeraldehyde in an amount of at least about 0.00022 mg/L.

Embodiment 52 is the alcoholic beverage replica of any one of embodiments 1 to 51, wherein the one or more additional VOCs comprise an ester; an alcohol; optionally, an acid;

optionally, an aldehyde, a ketone, or an aldehyde and a ketone; optionally, a terpene, an isoprenoid, or a terpene and an isoprenoid; optionally, a phenol; optionally, a lactone; optionally, an amine, a pyrazine, or an amine and a pyrazine; optionally, a thiol, a thiazole, a sulfide, or any combination thereof; optionally, an ether; optionally, an acetal; and optionally, a furan.

Embodiment 53 is the alcoholic beverage replica of any one of embodiments 1 to 52, wherein the one or more additional VOCs comprise one or more esters.

Embodiment 54 is the alcoholic beverage replica of embodiment 53, wherein the one or more esters are selected from the group consisting of 2-methylbutyl acetate, 2-methylbutyl isovalerate, 2-phenylethylacetate, 3-heptyl acetate, 3-methylthio hexyl acetate, 3-phenylpropyl acetate, allyl heptanoate, allyl hexanoate, amyl acetate, amyl butyrate, amyl formate, anisyl acetate, anisyl butyrate, benzyl acetate, benzyl benzoate, benzyl butyrate, benzyl formate, benzyl propionate, butyl acetate, butyl butyryllactate, butyl formate, butyl isovalerate, cis-3-hexenyl acetate, cis-3-hexenyl butyrate, cis-3-hexenyl caproate, cis-3-hexenyl valerate, citronellyl acetate, diethyl malate, diethyl succinate, dimethyl anthranilate, dimethyl succinate, ethyl 2-furoate, ethyl 2-trans-4-cis-decadienoate, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl hydrocinnamate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl pyruvate, ethyl salicylate, ethyl sorbate, ethyl undecanoate, ethyl valerate, ethyl(methylthio) acetate, ethyl-2-mercaptopropionate, ethyl-2-methylbutyrate, ethyl-3-hydroxybutyrate, ethyl-trans-2-butenoate, ethyl-trans-3-hexenoate, furfuryl acetate, geranyl acetate, geranyl butyrate, geranyl propionate, heptyl acetate, hexyl 3-methylbutanoate, hexyl acetate, hexyl butyrate, hexyl formate, hexyl hexanoate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, linalyl butyrate, linalyl formate, methionyl acetate (3-methylthio-propylacetate), methionyl butyrate, methyl acetate, methyl anthranilate, methyl benzoate, methyl cinnamate, methyl decanoate, methyl dihydrojasmonate, methyl hexanoate, methyl laurate, methyl octanoate, methyl salicylate, methyl vanillate, neryl acetate, octyl acetate, phenethyl 2-methylbutyrate, phenethyl acetate, phenethyl butyrate, phenethyl formate, phenethyl isobutyrate, phenethyl octanoate, phenethyl propionate, phenethyl tiglate, propyl acetate, propyl butyrate, propyl hexanoate, propyl isovalerate, and mixtures thereof.

Embodiment 55 is the alcoholic beverage replica of embodiment 53 or embodiment 54, wherein the one or more esters are selected from the group consisting of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl malate, diethyl succinate, dimethyl anthranilate, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl undecanoate, ethyl valerate, ethyl(methylthio) acetate, ethyl-2-mercaptopropionate, ethyl-2-methylbutyrate, ethyl-3-hydroxybutyrate, ethyl-trans-2-butenoate, ethyl-trans-3-hexenoate, geranyl acetate, heptyl acetate, hexyl acetate, hexyl hexanoate, isoamyl acetate, isoamyl hexanoate, isoamyl isobutyrate, isoamyl isovalerate, isoamyl octanoate, isobutyl acetate, linalyl acetate, linalyl butyrate, linalyl formate, methyl acetate, methyl anthranilate, methyl decanoate, methyl dihydrojasmonate, methyl hexanoate, methyl laurate, methyl octanoate, methyl salicylate, methyl vanillate, octyl acetate, phenethyl acetate, phenethyl butyrate, phenethyl formate, phenethyl isobutyrate, phenethyl octanoate, phenethyl propionate, propyl acetate, propyl butyrate, propyl hexanoate, and mixtures thereof.

Embodiment 56 is the alcoholic beverage replica of any one of embodiments 53-55, wherein the one or more esters are present in a total amount of about 0.009 mg/L to about 1.5 g/L.

Embodiment 57 is the alcoholic beverage replica of any one of embodiments 1 to 56, wherein the one or more additional VOCs comprise one or more acids.

Embodiment 58 is the alcoholic beverage replica of embodiment 57, wherein the one or more acids are selected from the group consisting of 3,7-dimethyl-6-octanoic acid, 3,7-dimethyl-6-octenoic acid, butyric acid, decanoic acid, hexanoic acid, isobutyric acid, isovaleric acid, nonanoic acid, octanoic acid, phenylacetic acid, propanoic acid, and valeric acid, and mixtures thereof.

Embodiment 59 is the alcoholic beverage replica of embodiment 57 or embodiment 58, wherein the one or more acids are selected from the group consisting of 3,7-dimethyl-6-octanoic acid, 3,7-dimethyl-6-octenoic acid, butyric acid, decanoic acid, hexanoic acid, isobutyric acid, isovaleric acid, nonanoic acid, octanoic acid, propanoic acid, and mixtures thereof.

Embodiment 60 is the alcoholic beverage replica of any one of embodiments 57-59, wherein the one or more acids are present in a total amount of about 0.03 mg/L to about 325 mg/L.

Embodiment 61 is the alcoholic beverage replica of any one of embodiments 1 to 60, wherein the one or more additional VOCs comprise one or more alcohols.

Embodiment 62 is the alcoholic beverage replica of embodiment 61, wherein the one or more alcohols are selected from the group consisting of 1-decanol, 1-octanol, 1-octen-3-ol, 2-(methylthio)ethanol, 2-heptanol, 2-methyl-1-butanol, 2-nonanol, 2-phenylethanol, 3-(methylthio)-1-propanol, 3-methyl-1-pentanol, amyl alcohol, anisyl alcohol, benzyl alcohol, butanol, cherry propanol, cis-2-hexenol, cis-3-hexen-1-ol, cis-5-octen-1-ol, cis-6-nonen-1-ol, DL-3-methyl-2-butanol, hexadecanol, hexanol, isoamyl alcohol, isobutanol, propanol, trans-2-hexen-1-ol, and mixtures thereof.

Embodiment 63 is the alcoholic beverage replica of embodiment 61 or embodiment 62, wherein the one or more alcohols are selected from the group consisting of 1-decanol, 1-octanol, 1-octen-3-ol, 2-(methylthio)ethanol, 2-methyl-1-butanol, 2-phenylethanol, 3-(methylthio)-1-propanol, 3-methyl-1-pentanol, amyl alcohol, benzyl alcohol, butanol, cis-2-hexenol, cis-3-hexen-1-ol, DL-3-methyl-2-butanol, hexadecanol, hexanol, isoamyl alcohol, isobutanol, propanol, trans-2-hexen-1-ol, and mixtures thereof.

Embodiment 64 is the alcoholic beverage replica of any one of embodiments 60-63, wherein the one or more alcohols are present in a total amount of about 0.08 mg/L to about 4.5 mg/L.

Embodiment 65 is the alcoholic beverage replica of any one of embodiments 1 to 64, wherein the one or more additional VOCs comprise one or more aldehydes or ketones.

Embodiment 66 is the alcoholic beverage replica of embodiment 65, wherein the one or more aldehydes or ketones are selected from the group consisting of 2,3-hexanedione, 2,3-pentadione, 2,6-dimethyl-5-heptenal, 2-acetyl-1-methylpyrrole, 2-heptanone, 2-methoxycinnamaldehyde, 2-methylbutyraldehyde, 2-nonanone, 2-octanone, 2-undecanone, 3-nonen-2-one, 3-phenylpropanal, 4-(4-hydroxyphenyl)-2-butanone, 4-hydroxy-2,5-dimethyl-3(2H)-furanone, 5-ethyl-3-hydroxy-4-methyl-2(5H)-furanone (maple furanone), 5-methyl furfural, 5-methyl-2-phenyl-2-hexenal, 6-methyl-5-hepten-2-one, acetaldehyde, acetoin, acetophenone, acetovanillone, benzaldehyde, Butyraldehyde, cinnamaldehyde, cuminaldehyde, damascenone, decanal, diacetyl, furfural, hexanal, isobutyraldehyde, isovaleraldehyde, maltol, methional, Methyl cyclopentenolone, Methyl β-naphthyl ketone, methyl-2-pyrrolyl ketone, nonanal, octanal, p-anisaldehyde, phenylacetaldehyde, propanal, propionaldehyde, salicylaldehyde, sotolon, trans-2-heptenal, trans-2-hexen-1-al, trans-2-nonenal, trans-2-pentanal, valeraldehyde, and mixtures thereof.

Embodiment 67 is the alcoholic beverage replica of embodiment 65 or embodiment 66, wherein the one or more aldehydes or ketones are selected from the group consisting of 2,3-pentadione, 2-heptanone, 2-methylbutyraldehyde, 2-nonanone, 2-undecanone, 3-nonen-2-one, 5-ethyl-3-hydroxy-4-methyl-2(5H)-furanone (maple furanone), 5-methyl furfural, 6-methyl-5-hepten-2-one, acetaldehyde, acetoin, acetophenone, benzaldehyde, cinnamaldehyde, damascenone, diacetyl, furfural, isobutyraldehyde, isovaleraldehyde, maltol, methional, methyl cyclopentenolone, methyl 3-naphthyl ketone, nonanal, p-anisaldehyde, phenylacetaldehyde, salicylaldehyde, trans-2-heptenal, trans-2-hexen-1-al, trans-2-pentanal, valeraldehyde, and mixtures thereof.

Embodiment 68 is the alcoholic beverage replica of any one of embodiments 65-67, wherein the one or more aldehydes or ketones are present in a total amount of about 0.02 mg/L to about 14 mg/L.

Embodiment 69 is the alcoholic beverage replica of any one of embodiments 1 to 68, wherein the one or more additional VOCs comprise one or more terpenes or isoprenoids.

Embodiment 70 is the alcoholic beverage replica of embodiment 69, wherein the one or more terpenes or isoprenoids are selected from the group consisting of (−)alpha-pinene, (−)cis-rose-oxide, 1,4-cineole, 3-carene, 4,5,6,7-tetrahydro-3,6-dimethylbenzofuran, 4-carvomenthenol, 4-ethylguaiacol, a-ionone, a-phellandrene, a-terpineol, b-caryophellene, beta pinene, beta-ionone, carvacrol, carvone, citral, citronellol, camascone, D-camphor, d-fenchone, eucalyptol, farnesol, gamma-terpinene, geraniol, geranyl acetone, isoborneol, limonene, linalool, linalool oxide, L-menthyl acetate, myrcene, myrtenol, nerol, nerolidol, p,a-dimethylstyrene, p-cymene, perillaldehyde, terpinolene, tetrahydrolinalool, thymol, valencene, and mixtures thereof.

Embodiment 71 is the alcoholic beverage of embodiment 69 or embodiment 70, wherein the one or more terpenes or isoprenoids are selected from the group consisting of (−)alpha-pinene, (−)cis-rose-oxide, 3-carene, 4-carvomenthenol, 4-ethylguaiacol, a-ionone, a-phellandrene, a-terpineol, b-caryophellene, beta pinene, beta-ionone, carvone, citral, citronellol, D-camphor, eucalyptol, farnesol, gamma-terpinene, geraniol, geranyl acetone, isoborneol, limonene, linalool, linalool oxide, myrcene, myrtenol, nerol, nerolidol, p,a-dimethylstyrene, p-cymene, terpinolene, and mixtures thereof.

Embodiment 72 is the alcoholic beverage replica of any one of embodiments 69-71, wherein the one or more terpenes or isoprenoids are present in a total amount of about 0.0002 mg/L to about 95 mg/L.

Embodiment 73 is the alcoholic beverage replica of any one of embodiments 1 to 72, wherein the one or more additional VOCs comprise one or more phenols.

Embodiment 74 is the alcoholic beverage replica of embodiment 73, wherein the one or more phenols are selected from the group consisting of 2,4,6-trimethylphenol (mesitol), 2-methoxy-4-methylphenol, 2-methoxy-4-propyl-phenol, 4-ethylphenol, 4-vinylphenol, eugenol, guaiacol, isoeugenol, p-cresol, and mixtures thereof.

Embodiment 75 is the alcoholic beverage replica of embodiment 73 or embodiment 74, wherein the one or more phenols are selected from the group consisting of 2,4,6-trimethylphenol (mesitol), 2-methoxy-4-methylphenol, 2-methoxy-4-propyl-phenol, 4-ethylphenol, eugenol, guaiacol, p-cresol, and mixtures thereof.

Embodiment 76 is the alcoholic beverage replica of any one of embodiments 73-75, wherein the one or more phenols are present in a total amount of about 0.00007 mg/L to about 5 mg/L.

Embodiment 77 is the alcoholic beverage replica of any one of embodiments 1 to 76, wherein the one or more additional VOCs comprise one or more lactones.

Embodiment 78 is the alcoholic beverage replica of embodiment 77, wherein the one or more lactones are selected from the group consisting of delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, jasmine lactone, omega-pentadecalactone, whiskey lactone, and mixtures thereof.

Embodiment 79 is the alcoholic beverage replica of embodiment 77 or embodiment 78, wherein the one or more lactones are selected from the group consisting of delta-decalactone, gamma-decalactone, gamma-hexalactone, gamma-nonalactone, gamma-octalactone, gamma-undecalactone, Jasmine lactone, whiskey lactone, and mixtures thereof.

Embodiment 80 is the alcoholic beverage replica of any one of embodiments 77-79, wherein the one or more lactones are present in a total amount of about 0.00007 mg/L to about 10 mg/L.

Embodiment 81 is the alcoholic beverage replica of any one of embodiments 1 to 80, wherein the one or more additional VOCs comprise one or more amines or pyrazines.

Embodiment 82 is the alcoholic beverage replica of embodiment 81, wherein the one or more amines or pyrazines are selected from the group consisting of 2,5-dimethylpyrazine, 2,6-dimethylpyrazine, 2-acetylpyridine, 2-ethyl-3(5 or 6)-dimethylpyrazine, 2-ethyl-3-methylpyrazine, 2-isobutyl-3-methoxypyrazine, 2-isopropyl-3-methoxypyrazine, 2-methoxy-3-(1-methylpropyl) pyrazine, indole, and mixtures thereof.

Embodiment 83 is the alcoholic beverage replica of embodiment 81 or embodiment 82, wherein the one or more amines or pyrazines are selected from the group consisting of 2-acetylpyridine, 2-isobutyl-3-methoxypyrazine, 2-isopropyl-3-methoxypyrazine, and mixtures thereof.

Embodiment 84 is the alcoholic beverage replica of any one of embodiments 81-83, wherein the one or more amines or pyrazines are present in a total amount of about 0.00007 mg/L to about 0.09 mg/L.

Embodiment 85 is the alcoholic beverage replica of any one of embodiments 1 to 84, wherein the one or more additional VOCs comprise one or more thiols, thiazoles, or sulfides.

Embodiment 86 is the alcoholic beverage replica of embodiment 84, wherein the one or more thiols, thiazoles, or sulfides are selected from the group consisting of 1-para-menthene-8-thiol, 2-isopropyl-4-methyl thiazole, 3-mercaptohexylacetate, 4-mercapto-4-methyl-2-pentanone, dimethyl sulfide, dimethyl trisulfide, furfuryl mercaptan, furfuryl thioacetate, and mixtures thereof.

Embodiment 87 is the alcoholic beverage replica of embodiment 84 or embodiment 85, wherein the one or more thiols, thiazoles, or sulfides are selected from the group consisting of 3-mercaptohexylacetate, dimethyl sulfide, furfuryl mercaptan, and mixtures thereof.

Embodiment 88 is the alcoholic beverage replica any one of embodiments 84-87, wherein the one or more thiols, thiazoles, or sulfides are present in a total amount of about 0.00007 mg/L to about 0.45 mg/L.

Embodiment 89 is the alcoholic beverage replica of any one of embodiments 1-88, wherein the one or more additional VOCs comprise one or more ethers.

Embodiment 90 is the alcoholic beverage replica of embodiment 89, wherein the one or more ethers are selected from the group consisting of furfuryl ether, vanillyl butyl ether, vanillyl ethyl ether, and mixtures thereof.

Embodiment 91 is the alcoholic beverage replica of embodiment 89 or embodiment 90, wherein the one or more ethers comprise vanillyl ethyl ether.

Embodiment 92 is the alcoholic beverage replica of any one of embodiments 89-91, wherein the one or more ethers are present in a total amount of about 0.01 to about 0.05 mg/L.

Embodiment 93 is the alcoholic beverage replica of any one of embodiments 1 to 92, wherein the one or more additional VOCs comprise one or more acetals.

Embodiment 94 is the alcoholic beverage replica of embodiment 93, wherein the one or more acetals are selected from the group consisting of 2-isobutyl-4-methyl-1,3-dioxolane, acetal, acetaldehyde diethyl acetal, b-ethoxypropionaldehyde diethyl acetal, phenethyl acetaldehyde dimethyl acetal, and mixtures thereof.

Embodiment 95 is the alcoholic beverage replica of embodiment 93 or embodiment 94, wherein the one or more acetals are selected from the group consisting of acetal, acetaldehyde diethyl acetal, phenethyl acetaldehyde dimethyl acetal, and mixtures thereof.

Embodiment 96 is the alcoholic beverage replica of any one of embodiments 93-95, wherein the one or more acetals are present in an amount of about 0.15 mg/L to about 28 mg/L.

Embodiment 97 is the alcoholic beverage replica of any one of embodiments 1 to 96, wherein the one or more additional VOCs comprise one or more furans.

Embodiment 98 is the alcoholic beverage replica of embodiment 97, wherein the one or more furans comprise 2-pentyl furan.

Embodiment 99 is the alcoholic beverage replica of any one of embodiments 1-98, wherein the one or more additional VOCs comprise at least 5 compounds selected from the group consisting of 1-decanol, 1-octanol, 1-octen-3-ol, 2,3-pentadione, 2,4,6-trimethylphenol (mesitol), 2-heptanone, 2-isopropyl-3-methoxypyrazine, 2-methyl-1-butanol, 2-methylbutyl acetate, 2-methylbutyraldehyde, 2-phenylethanol, 2-phenylethylacetate, 2-undecanone, 3-(methylthio)-1-propanol, 3,7-dimethyl-6-octanoic acid, 3,7-dimethyl-6-octenoic acid, 3-methyl-1-pentanol, 4-carvomenthenol, 4-ethylguaiacol, 4-ethylphenol, 5-ethyl-3-hydroxy-4-methyl-2(5H)-furanone (maple furanone), 5-methyl furfural, 6-methyl-5-hepten-2-one, acetal, acetaldehyde, acetaldehyde, diethyl acetal, acetophenone, amyl alcohol, a-phellandrene, a-terpineol, b-caryophellene, benzaldehyde, beta pinene, butanol, butyl acetate, butyl formate, butyric acid, cinnamaldehyde, cis-2-hexenol, citral, citronellol, damascenone, D-camphor, decanoic acid, delta-decalactone, diacetyl, diethyl malate, diethyl succinate, dimethyl anthranilate, dimethyl sulfide, DL-3-methyl-2-butanol, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eugenol, farnesol, furfural, gamma-decalactone, gamma-hexalactone, gamma-nonalactone, gamma-octalactone, geraniol, geranyl acetone, guaiacol, hexadecanol, hexanol, hexyl hexanoate, isoamyl acetate, isoamyl alcohol, isoamyl octanoate, isobutanol, isobutyl acetate, isobutyraldehyde, isobutyric acid, isovaleraldehyde, isovaleric acid, limonene, linalool, linalool oxide, linalyl acetate, maltol, methional, methyl acetate, methyl anthranilate, methyl cyclopentenolone, methyl decanoate, methyl hexanoate, methyl laurate, methyl salicylate, methyl β-naphthyl ketone, myrtenol, nerol, nerolidol, nonanoic acid, octanoic acid, p,a-dimethylstyrene, p-cymene, phenethyl acetate, phenethyl formate, phenethyl isobutyrate, phenethyl octanoate, phenethyl propionate, phenylacetaldehyde, propanoic acid, propanol, propyl acetate, propyl butyrate, salicylaldehyde, terpinolene, trans-2-heptenal, trans-2-hexen-1-al, trans-2-hexen-1-ol, trans-2-pentanal, vanillyl ethyl ether, and whiskey lactone.

Embodiment 100 is the alcoholic beverage replica of any one of embodiments 1-98, wherein the one or more additional VOCs comprise at least 10 compounds selected from the group consisting of 1-decanol, 1-octanol, 1-octen-3-ol, 2,3-pentadione, 2,4,6-trimethylphenol (mesitol), 2-heptanone, 2-isopropyl-3-methoxypyrazine, 2-methyl-1-butanol, 2-methylbutyl acetate, 2-methylbutyraldehyde, 2-phenylethanol, 2-phenylethylacetate, 2-undecanone, 3-(methylthio)-1-propanol, 3,7-dimethyl-6-octanoic acid, 3,7-dimethyl-6-octenoic acid, 3-methyl-1-pentanol, 4-carvomenthenol, 4-ethylguaiacol, 4-ethylphenol, 5-ethyl-3-hydroxy-4-methyl-2(5H)-furanone (maple furanone), 5-methyl furfural, 6-methyl-5-hepten-2-one, acetal, acetaldehyde, acetaldehyde diethyl acetal, acetophenone, amyl alcohol, a-phellandrene, a-terpineol, b-caryophellene, benzaldehyde, beta pinene, butanol, butyl acetate, butyl formate, butyric acid, cinnamaldehyde, cis-2-hexenol, citral, citronellol, damascenone, D-camphor, decanoic acid, delta-decalactone, diacetyl, diethyl malate, diethyl succinate, dimethyl anthranilate, dimethyl sulfide, DL-3-methyl-2-butanol, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eugenol, farnesol, furfural, gamma-decalactone, gamma-hexalactone, gamma-nonalactone, gamma-octalactone, geraniol, geranyl acetone, guaiacol, hexadecanol, hexanol, hexyl hexanoate, isoamyl acetate, isoamyl alcohol, isoamyl octanoate, isobutanol, isobutyl acetate, isobutyraldehyde, isobutyric acid, isovaleraldehyde, isovaleric acid, limonene, linalool, linalool oxide, linalyl acetate, maltol, methional, methyl acetate, methyl anthranilate, methyl cyclopentenolone, methyl decanoate, methyl hexanoate, methyl laurate, methyl salicylate, methyl β-naphthyl ketone, myrtenol, nerol, nerolidol, nonanoic acid, octanoic acid, p,a-dimethylstyrene, p-cymene, phenethyl acetate, phenethyl formate, phenethyl isobutyrate, phenethyl octanoate, phenethyl propionate, phenylacetaldehyde, propanoic acid, propanol, propyl acetate, propyl butyrate, salicylaldehyde, terpinolene, trans-2-heptenal, trans-2-hexen-1-al, trans-2-hexen-1-ol, trans-2-pentanal, vanillyl ethyl ether, and whiskey lactone.

Embodiment 101 is the alcoholic beverage replica of any one of embodiments 1-98, wherein the one or more additional VOCs comprise at least 20 compounds selected from the group consisting of 1-decanol, 1-octanol, 1-octen-3-ol, 2,3-pentadione, 2,4,6-trimethylphenol (mesitol), 2-heptanone, 2-isopropyl-3-methoxypyrazine, 2-methyl-1-butanol, 2-methylbutyl acetate, 2-methylbutyraldehyde, 2-phenylethanol, 2-phenylethylacetate, 2-undecanone, 3-(methylthio)-1-propanol, 3,7-dimethyl-6-octanoic acid, 3,7-dimethyl-6-octenoic acid, 3-methyl-1-pentanol, 4-carvomenthenol, 4-ethylguaiacol, 4-ethylphenol, 5-ethyl-3-hydroxy-4-methyl-2(5H)-furanone (maple furanone), 5-methyl furfural, 6-methyl-5-hepten-2-one, acetal, acetaldehyde, acetaldehyde diethyl acetal, acetophenone, amyl alcohol, a-phellandrene, a-terpineol, b-caryophellene, benzaldehyde, beta pinene, butanol, butyl acetate, butyl formate, butyric acid, cinnamaldehyde, cis-2-hexenol, citral, citronellol, damascenone, D-camphor, decanoic acid, delta-decalactone, diacetyl, diethyl malate, diethyl succinate, dimethyl anthranilate, dimethyl sulfide, DL-3-methyl-2-butanol, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eugenol, farnesol, furfural, gamma-decalactone, gamma-hexalactone, gamma-nonalactone, gamma-octalactone, geraniol, geranyl acetone, guaiacol, hexadecanol, hexanol, hexyl hexanoate, isoamyl acetate, isoamyl alcohol, isoamyl octanoate, isobutanol, isobutyl acetate, isobutyraldehyde, isobutyric acid, isovaleraldehyde, isovaleric acid, limonene, linalool, linalool oxide, linalyl acetate, maltol, methional, methyl acetate, methyl anthranilate, methyl cyclopentenolone, methyl decanoate, methyl hexanoate, methyl laurate, methyl salicylate, methyl β-naphthyl ketone, myrtenol, nerol, nerolidol, nonanoic acid, octanoic acid, p,a-dimethylstyrene, p-cymene, phenethyl acetate, phenethyl formate, phenethyl isobutyrate, phenethyl octanoate, phenethyl propionate, phenylacetaldehyde, propanoic acid, propanol, propyl acetate, propyl butyrate, salicylaldehyde, terpinolene, trans-2-heptenal, trans-2-hexen-1-al, trans-2-hexen-1-ol, trans-2-pentanal, vanillyl ethyl ether, and whiskey lactone.

Embodiment 102 is the alcoholic beverage replica of any one of embodiments 1-101, wherein the one or more additional VOCs comprise at least 1 compound selected from the group consisting of (−)alpha-pinene, (−)cis-rose-oxide, 2-(methylthio)ethanol, 2-acetylpyridine, 2-isobutyl-3-methoxypyrazine, 2-methoxy-4-methylphenol, 2-methoxy-4-propyl-phenol, 2-methylbutyl isovalerate, 2-nonanone, 3-carene, 3-mercaptohexylacetate, 3-nonen-2-one, acetoin, a-ionone, amyl butyrate, benzyl acetate, benzyl alcohol, beta-ionone, butyl isovalerate, carvone, cis-3-hexen-1-ol, cis-3-hexenyl acetate, ethyl salicylate, ethyl(methylthio) acetate, ethyl-2-mercaptopropionate, ethyl-trans-2-butenoate, ethyl-trans-3-hexenoate, eucalyptol, furfuryl mercaptan, gamma-terpinene, gamma-undecalactone, geranyl acetate, heptyl acetate, hexanoic acid, hexyl acetate, isoamyl hexanoate, isoamyl isobutyrate, isoamyl isovalerate, isoborneol, jasmine lactone, linalyl butyrate, linalyl formate, methyl dihydrojasmonate, methyl octanoate, methyl vanillate, myrcene, nonanal, octyl acetate, p-anisaldehyde, p-cresol, phenethyl acetaldehyde dimethyl acetal, phenethyl butyrate, propyl hexanoate, valeraldehyde.

Embodiment 103 is the alcoholic beverage replica of any one of embodiments 1-101, wherein the one or more additional VOCs comprise at least 5 compounds selected from the group consisting of (−)alpha-pinene, (−)cis-rose-oxide, 2-(methylthio)ethanol, 2-acetylpyridine, 2-isobutyl-3-methoxypyrazine, 2-methoxy-4-methylphenol, 2-methoxy-4-propyl-phenol, 2-methylbutyl isovalerate, 2-nonanone, 3-carene, 3-mercaptohexylacetate, 3-nonen-2-one, acetoin, a-ionone, amyl butyrate, benzyl acetate, benzyl alcohol, beta-ionone, butyl isovalerate, carvone, cis-3-hexen-1-ol, cis-3-hexenyl acetate, ethyl salicylate, ethyl(methylthio) acetate, ethyl-2-mercaptopropionate, ethyl-trans-2-butenoate, ethyl-trans-3-hexenoate, eucalyptol, furfuryl mercaptan, gamma-terpinene, gamma-undecalactone, geranyl acetate, heptyl acetate, hexanoic acid, hexyl acetate, isoamyl hexanoate, isoamyl isobutyrate, isoamyl isovalerate, isoborneol, jasmine lactone, linalyl butyrate, linalyl formate, methyl dihydrojasmonate, methyl octanoate, methyl vanillate, myrcene, nonanal, octyl acetate, p-anisaldehyde, p-cresol, phenethyl acetaldehyde dimethyl acetal, phenethyl butyrate, propyl hexanoate, valeraldehyde.

Embodiment 104 is the alcoholic beverage replica of any one of embodiments 1 to 103, wherein the one or more additional VOCs have less than 90% identity to the VOCs in a single corresponding traditional alcoholic beverage.

Embodiment 105 is the alcoholic beverage replica of any one of embodiments 1 to 103, wherein the one or more additional VOCs have less than 80% identity to the VOCs in a single corresponding traditional alcoholic beverage.

Embodiment 106 is the alcoholic beverage replica of any one of embodiments 1 to 103, wherein the one or more additional VOCs have less than 70% identity to the VOCs in a single corresponding traditional alcoholic beverage.

Embodiment 107 is the alcoholic beverage replica of any one of embodiments 1 to 103, wherein the one or more additional VOCs have less than 60% identity to the VOCs in a single corresponding traditional alcoholic beverage.

Embodiment 108 is the alcoholic beverage replica of any one of embodiments 1 to 103, wherein the one or more additional VOCs have less than 50% identity to the VOCs in a single corresponding traditional alcoholic beverage.

Embodiment 109 is the alcoholic beverage replica of any one of embodiments 1 to 103, wherein the one or more additional VOCs have less than 40% identity to the VOCs in a single corresponding traditional alcoholic beverage.

Embodiment 110 is the alcoholic beverage replica of any one of embodiments 1 to 109, further comprising one or more non-volatile compounds.

Embodiment 111 is the alcoholic beverage replica of embodiment 110, wherein the one or more non-volatile compounds comprise one or more non-volatile compounds that are not present in a corresponding traditional alcoholic beverage.

Embodiment 112 is the alcoholic beverage replica of embodiment 111, wherein the one or more non-volatile compounds that are not present in a traditional alcoholic beverage are selected from the group consisting of cysteine, cystine, epicatechin gallate, methyl 2-pyrrolyl ketone, and rutin.

Embodiment 113 is the alcoholic beverage replica of any one of embodiments 110-112, wherein the one or more non-volatile compounds do not comprise one or more non-volatile compounds that are present in a corresponding traditional alcoholic beverage.

Embodiment 114 is the alcoholic beverage replica of embodiment 113, wherein the one or more non-volatile compounds that are present in a corresponding traditional alcoholic beverage are selected from the group consisting of 4-guanidinobutyric acid, adenine, cytidine, cytosine, homoserine, and uracil.

Embodiment 115 is the alcoholic beverage of any one of embodiments 110-114, wherein the one or more non-volatile compounds comprise at least 5 compounds selected from the group consisting of 2,3,5,6-tetramethylpyrazine, 2,3,5-trimethylpyrazine, 2,3-dimethylpyrazine, 2-isopropylmalic acid, 3,4-dihydroxybenzoic acid, 4-guanidinobutyric acid, acetic acid, acetovanillone, adenine, adipic acid, alanine, arabitol, arginine, aspartic acid, betaine, caffeic acid, camphoric acid, carnitine, catechin, choline, citric acid, citrulline, coumaric acid, cytidine, cytosine, D-glucuronic acid, disodium 5′ ribonucleotides (5′-guanylate & 5′-inosinate), ellagic acid, epicatechin, fructose, fucose, fumaric acid, GABA, galactose, gallic acid, glucose, glutamic acid, guanine, histidine, homoserine, kynurenic acid, lactic acid, lysine, malic acid, mannitol, methionine, methyl gallate, monosodium glutamate, inositol, phenylalanine, pipecolinic acid, proline, propyl gallate, pyridine, pyridoxine, pyruvic acid, quercetin, quinic acid, rhamnose, ribose, salicylic acid, serine, sorbitol, succinic acid, syringaldehyde, tartaric acid, trans-4-hydroxyproline, trans-ferulic acid, uracil, vanillic acid, and vanillin.

Embodiment 116 is the alcoholic beverage of any one of embodiments 110-114, wherein the one or more non-volatile compounds comprise at least 10 compounds selected from the group consisting of 2,3,5,6-tetramethylpyrazine, 2,3,5-trimethylpyrazine, 2,3-dimethylpyrazine, 2-isopropylmalic acid, 3,4-dihydroxybenzoic acid, 4-guanidinobutyric acid, acetic acid, acetovanillone, adenine, adipic acid, alanine, arabitol, arginine, aspartic acid, betaine, caffeic acid, camphoric acid, carnitine, catechin, choline, citric acid, citrulline, coumaric acid, cytidine, cytosine, D-glucuronic acid, disodium 5′ ribonucleotides (5′-guanylate & 5′-inosinate), ellagic acid, epicatechin, fructose, fucose, fumaric acid, GABA, galactose, gallic acid, glucose, glutamic acid, guanine, histidine, homoserine, kynurenic acid, lactic acid, lysine, malic acid, mannitol, methionine, methyl gallate, monosodium glutamate, inositol, phenylalanine, pipecolinic acid, proline, propyl gallate, pyridine, pyridoxine, pyruvic acid, quercetin, quinic acid, rhamnose, ribose, salicylic acid, serine, sorbitol, succinic acid, syringaldehyde, tartaric acid, trans-4-hydroxyproline, trans-ferulic acid, uracil, vanillic acid, and vanillin.

Embodiment 117 is the alcoholic beverage of any one of embodiments 110-114, wherein the one or more non-volatile compounds comprise at least 15 compounds selected from the group consisting of 2,3,5,6-tetramethylpyrazine, 2,3,5-trimethylpyrazine, 2,3-dimethylpyrazine, 2-isopropylmalic acid, 3,4-dihydroxybenzoic acid, 4-guanidinobutyric acid, acetic acid, acetovanillone, adenine, adipic acid, alanine, arabitol, arginine, aspartic acid, betaine, caffeic acid, camphoric acid, carnitine, catechin, choline, citric acid, citrulline, coumaric acid, cytidine, cytosine, D-glucuronic acid, disodium 5′ ribonucleotides (5′-guanylate & 5′-inosinate), ellagic acid, epicatechin, fructose, fucose, fumaric acid, GABA, galactose, gallic acid, glucose, glutamic acid, guanine, histidine, homoserine, kynurenic acid, lactic acid, lysine, malic acid, mannitol, methionine, methyl gallate, monosodium glutamate, inositol, phenylalanine, pipecolinic acid, proline, propyl gallate, pyridine, pyridoxine, pyruvic acid, quercetin, quinic acid, rhamnose, ribose, salicylic acid, serine, sorbitol, succinic acid, syringaldehyde, tartaric acid, trans-4-hydroxyproline, trans-ferulic acid, uracil, vanillic acid, and vanillin.

Embodiment 118 is the alcoholic beverage replica of any one of embodiments 110-117, wherein the one or more non-volatile compounds comprise at least 1 compound selected from the group consisting of 2-furoic acid, asparagine, beta-alanine, carnosine, cinnamic acid, D-gluconolactone (gluconic acid), glucosamine, glutamine, glycerol, glycine, hesperetin, isoleucine, leucine, mannose, ornithine, pantothenic acid, piperine, polydatin, resveratrol, sinapinic acid, sorbic acid, a surfactant, syringic acid, threonine, tryptamine, tryptophan, tyramine, tyrosine, valine, and xylose.

Embodiment 119 is the alcoholic beverage replica of any one of embodiments 110-117, wherein the one or more non-volatile compounds comprise at least 5 compounds selected from the group consisting of 2-furoic acid, asparagine, beta-alanine, carnosine, cinnamic acid, D-gluconolactone (gluconic acid), glucosamine, glutamine, glycerol, glycine, hesperetin, isoleucine, leucine, mannose, ornithine, pantothenic acid, piperine, polydatin, resveratrol, sinapinic acid, sorbic acid, a surfactant, syringic acid, threonine, tryptamine, tryptophan, tyramine, tyrosine, valine, and xylose.

Embodiment 120 is the alcoholic beverage replica of any one of embodiments 110-119, wherein the non-volatile compounds comprise one or more compounds selected from the group consisting of a surfactant, gum arabic, and pectin.

Embodiment 121 is the alcoholic beverage replica of any one of embodiments 110-120, wherein the one or more non-volatile compounds have less than 90% identity to the non-volatile compounds in a corresponding traditional alcoholic beverage.

Embodiment 122 is the alcoholic beverage replica of any one of embodiments 110-120, wherein the one or more non-volatile compounds have less than 80% identity to the non-volatile compounds in a corresponding traditional alcoholic beverage.

Embodiment 123 is the alcoholic beverage replica of any one of embodiments 110-120, wherein the one or more non-volatile compounds have less than 70% identity to the non-volatile compounds in a corresponding traditional alcoholic beverage.

Embodiment 124 is the alcoholic beverage replica of any one of embodiments 110-120, wherein the one or more non-volatile compounds have less than 60% identity to the non-volatile compounds in a corresponding traditional alcoholic beverage.

Embodiment 125 is the alcoholic beverage replica of any one of embodiments 110-120, wherein the one or more non-volatile compounds have less than 50% identity to the non-volatile compounds in a corresponding traditional alcoholic beverage.

Embodiment 126 is the alcoholic beverage replica of any one of embodiments 110-120, wherein the one or more non-volatile compounds have less than 40% identity to the non-volatile compounds in a corresponding traditional alcoholic beverage.

Embodiment 127 is the alcoholic beverage replica of any one of embodiments 1 to 126, wherein the alcoholic beverage replica does not comprise one or more of Escherichia. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, heavy metal, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

Embodiment 128 is an alcoholic beverage replica comprising ethanol, water, and one or more non-volatile compounds, wherein the one or more non-volatile compounds comprise one or more compounds that are not present in a corresponding traditional alcoholic beverage.

Embodiment 129 is the alcoholic beverage replica of embodiment 128, wherein the one or more non-volatile compounds do not comprise at least one non-volatile compound that is present in a corresponding traditional alcoholic beverage.

Embodiment 130 is an alcoholic beverage replica comprising ethanol, water, and one or more non-volatile compounds, wherein the one or more non-volatile compounds do not comprise at least one non-volatile compound that is present in a corresponding traditional alcoholic beverage.

Embodiment 131 is the alcoholic beverage replica of embodiment 130, wherein the one or more non-volatile compounds comprise at least one non-volatile compound that is not present in a corresponding traditional alcoholic beverage.

Embodiment 132 is the alcoholic beverage replica of embodiment 129 or embodiment 130, wherein the one or more non-volatile compounds that are present in a corresponding traditional alcoholic beverage are selected from the group consisting of 4-guanidinobutyric acid, adenine, cytidine, cytosine, homoserine, and uracil.

Embodiment 133 is the alcoholic beverage replica of embodiment 128 or embodiment 131, wherein the one or more non-volatile compounds that are not present in a traditional alcoholic beverage are selected from the group consisting of cysteine, cystine, epicatechin gallate, methyl 2-pyrrolyl ketone, and rutin.

Embodiment 134 is the alcoholic beverage of any one of embodiments 128-133, wherein the one or more non-volatile compounds comprise at least 5 compounds selected from the group consisting of 2,3,5,6-tetramethylpyrazine, 2,3,5-trimethylpyrazine, 2,3-dimethylpyrazine, 2-isopropylmalic acid, 3,4-dihydroxybenzoic acid, 4-guanidinobutyric acid, acetic acid, acetovanillone, adenine, adipic acid, alanine, arabitol, arginine, aspartic acid, betaine, caffeic acid, camphoric acid, carnitine, catechin, choline, citric acid, citrulline, coumaric acid, cytidine, cytosine, D-glucuronic acid, disodium 5′ ribonucleotides (5′-guanylate & 5′-inosinate), ellagic acid, epicatechin, fructose, fucose, fumaric acid, GABA, galactose, gallic acid, glucose, glutamic acid, guanine, histidine, homoserine, kynurenic acid, lactic acid, lysine, malic acid, mannitol, methionine, methyl gallate, monosodium glutamate, inositol, phenylalanine, pipecolinic acid, proline, propyl gallate, pyridine, pyridoxine, pyruvic acid, quercetin, quinic acid, rhamnose, ribose, salicylic acid, serine, sorbitol, succinic acid, syringaldehyde, tartaric acid, trans-4-hydroxyproline, trans-ferulic acid, uracil, vanillic acid, and vanillin.

Embodiment 135 is the alcoholic beverage of any one of embodiments 128-133, wherein the one or more non-volatile compounds comprise at least 10 compounds selected from the group consisting of 2,3,5,6-tetramethylpyrazine, 2,3,5-trimethylpyrazine, 2,3-dimethylpyrazine, 2-isopropylmalic acid, 3,4-dihydroxybenzoic acid, 4-guanidinobutyric acid, acetic acid, acetovanillone, adenine, adipic acid, alanine, arabitol, arginine, aspartic acid, betaine, caffeic acid, camphoric acid, carnitine, catechin, choline, citric acid, citrulline, coumaric acid, cytidine, cytosine, D-glucuronic acid, disodium 5′ ribonucleotides (5′-guanylate & 5′-inosinate), ellagic acid, epicatechin, fructose, fucose, fumaric acid, GABA, galactose, gallic acid, glucose, glutamic acid, guanine, histidine, homoserine, kynurenic acid, lactic acid, lysine, malic acid, mannitol, methionine, methyl gallate, monosodium glutamate, inositol, phenylalanine, pipecolinic acid, proline, propyl gallate, pyridine, pyridoxine, pyruvic acid, quercetin, quinic acid, rhamnose, ribose, salicylic acid, serine, sorbitol, succinic acid, syringaldehyde, tartaric acid, trans-4-hydroxyproline, trans-ferulic acid, uracil, vanillic acid, and vanillin.

Embodiment 136 is the alcoholic beverage of any one of embodiments 128-133, wherein the one or more non-volatile compounds comprise at least 15 compounds selected from the group consisting of 2,3,5,6-tetramethylpyrazine, 2,3,5-trimethylpyrazine, 2,3-dimethylpyrazine, 2-isopropylmalic acid, 3,4-dihydroxybenzoic acid, 4-guanidinobutyric acid, acetic acid, acetovanillone, adenine, adipic acid, alanine, arabitol, arginine, aspartic acid, betaine, caffeic acid, camphoric acid, carnitine, catechin, choline, citric acid, citrulline, coumaric acid, cytidine, cytosine, D-glucuronic acid, disodium 5′ ribonucleotides (5′-guanylate & 5′-inosinate), ellagic acid, epicatechin, fructose, fucose, fumaric acid, GABA, galactose, gallic acid, glucose, glutamic acid, guanine, histidine, homoserine, kynurenic acid, lactic acid, lysine, malic acid, mannitol, methionine, methyl gallate, monosodium glutamate, inositol, phenylalanine, pipecolinic acid, proline, propyl gallate, pyridine, pyridoxine, pyruvic acid, quercetin, quinic acid, rhamnose, ribose, salicylic acid, serine, sorbitol, succinic acid, syringaldehyde, tartaric acid, trans-4-hydroxyproline, trans-ferulic acid, uracil, vanillic acid, and vanillin.

Embodiment 137 is the alcoholic beverage replica of any one of embodiments 128-136, wherein the one or more non-volatile compounds comprise at least 1 compound selected from the group consisting of 2-furoic acid, asparagine, beta-alanine, carnosine, cinnamic acid, D-gluconolactone (gluconic acid), glucosamine, glutamine, glycerol, glycine, hesperetin, isoleucine, leucine, mannose, ornithine, pantothenic acid, piperine, polydatin, resveratrol, sinapinic acid, sorbic acid, a surfactant, syringic acid, threonine, tryptamine, tryptophan, tyramine, tyrosine, valine, and xylose.

Embodiment 138 is the alcoholic beverage replica of any one of embodiments 128-136, wherein the one or more non-volatile compounds comprise at least 5 compounds selected from the group consisting of 2-furoic acid, asparagine, beta-alanine, carnosine, cinnamic acid, D-gluconolactone (gluconic acid), glucosamine, glutamine, glycerol, glycine, hesperetin, isoleucine, leucine, mannose, ornithine, pantothenic acid, piperine, polydatin, resveratrol, sinapinic acid, sorbic acid, a surfactant, syringic acid, threonine, tryptamine, tryptophan, tyramine, tyrosine, valine, and xylose.

Embodiment 139 is the alcoholic beverage replica of any one of embodiments 128-138, wherein the non-volatile compounds comprise one or more compounds selected from the group consisting of a surfactant, gum arabic, and pectin.

Embodiment 140 is the alcoholic beverage replica of any one of embodiments 128 to 139, wherein the non-volatile compounds have less than 90% identity to the non-volatile compounds in a single corresponding traditional alcoholic beverage.

Embodiment 141 is the alcoholic beverage replica of any one of embodiments 128 to 139, wherein the non-volatile compounds have less than 80% identity to the non-volatile compounds in a single corresponding traditional alcoholic beverage.

Embodiment 142 is the alcoholic beverage replica of any one of embodiments 128 to 139, wherein the non-volatile compounds have less than 70% identity to the non-volatile compounds in a single corresponding traditional alcoholic beverage.

Embodiment 143 is the alcoholic beverage replica of any one of embodiments 128 to 139, wherein the non-volatile compounds have less than 60% identity to the non-volatile compounds in a single corresponding traditional alcoholic beverage.

Embodiment 144 is the alcoholic beverage replica of any one of embodiments 128 to 139, wherein the non-volatile compounds have less than 50% identity to the non-volatile compounds in a single corresponding traditional alcoholic beverage.

Embodiment 145 is the alcoholic beverage replica of any one of embodiments 128 to 139, wherein the non-volatile compounds have less than 40% identity to the non-volatile compounds in a single corresponding traditional alcoholic beverage.

Embodiment 146 is the alcoholic beverage replica of any one of embodiments 128 to 145, further comprising one or more additional VOCs.

Embodiment 147 is the alcoholic beverage replica of embodiment 146, wherein the one or more additional VOCs do not comprise at least one VOC that is present in a corresponding traditional alcoholic beverage.

Embodiment 148 is the alcoholic beverage replica of embodiment 147, wherein the at least one VOC that is present in a corresponding traditional alcoholic beverage is selected from the group consisting of 2,4,6-trimethylphenol (mesitol), 5-ethyl-3-hydroxy-4-methyl-2(5H)-furanone (maple furanone), 6-methyl-5-hepten-2-one, b-caryophellene, cis-2-hexenol, hexadecanol, methyl cyclopentenolone, nonanoic acid, and terpinolene.

Embodiment 149 is the alcoholic beverage replica of any one of embodiments 146-148, wherein the one or more additional VOCs comprise at least one VOC that is not present in a corresponding traditional alcoholic beverage.

Embodiment 150 is the alcoholic beverage replica of embodiment 149, wherein the at least one VOC that is not present in a corresponding traditional alcoholic beverage is selected from the group consisting of 1,4-cineole, 1-para-menthene-8-thiol, 2,3-hexanedione, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-nonanol, 2-octanone, 2-pentylfuran, 3-heptyl acetate, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, allyl heptanoate, allyl hexanoate, anisyl acetate, anisyl alcohol, anisyl butyrate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, dihydrocoumarin, ethyl 2-trans-4-cis-decadienoate, furfuryl thioacetate, gamma-dodecalactone, gamma-heptalactone, geranyl butyrate, geranyl propionate, hexanal, hexyl 3-methylbutanoate, hexyl butyrate, hexyl isobutyrate, hexyl propionate, IBMP (3-isobutyl-2-methoxypyrazine), indole, isoamyl cinnamate, isoamyl phenylacetate, isobutyl butyrate, isobutyl propionate, isoeugenol, L-menthyl acetate, methionyl acetate (3-methylthio-propylacetate), methionyl butyrate, methyl benzoate, methyl cinnamate, methyl-2-pyrrolyl ketone, octanal, omega-pentadecalactone, perillaldehyde, phenethyl 2-methylbutyrate, phenethyl tiglate, propanal, propionaldehyde, propyl isovalerate, tetrahydrolinalool, thymol, valencene, valeric acid, vanillyl butyl ether.

Embodiment 151 is the alcoholic beverage replica of any one of embodiments 146-150, wherein the one or more additional VOCs comprise one or more of butyl formate, ethyl octanoate, ethyl propionate, ethyl-2-methylbutyrate, isoamyl acetate, isoamyl alcohol, and isobutanol.

Embodiment 152 is the alcoholic beverage replica of any one of embodiments 146-150, wherein the one or more additional VOCs comprise two or more of butyl formate, ethyl octanoate, ethyl propionate, ethyl-2-methylbutyrate, isoamyl acetate, isoamyl alcohol, and isobutanol.

Embodiment 153 is the alcoholic beverage replica of any one of embodiments 146-150, wherein the one or more additional VOCs comprise three or more of butyl formate, ethyl octanoate, ethyl propionate, ethyl-2-methylbutyrate, isoamyl acetate, isoamyl alcohol, and isobutanol.

Embodiment 154 is the alcoholic beverage replica of any one of embodiments 146-150, wherein the one or more additional VOCs comprise four or more of butyl formate, ethyl octanoate, ethyl propionate, ethyl-2-methylbutyrate, isoamyl acetate, isoamyl alcohol, and isobutanol.

Embodiment 155 is the alcoholic beverage replica of any one of embodiments 146-150, wherein the one or more additional VOCs comprise five or more of butyl formate, ethyl octanoate, ethyl propionate, ethyl-2-methylbutyrate, isoamyl acetate, isoamyl alcohol, and isobutanol.

Embodiment 156 is the alcoholic beverage replica of any one of embodiments 146-150, wherein the one or more additional VOCs comprise six or more of butyl formate, ethyl octanoate, ethyl propionate, ethyl-2-methylbutyrate, isoamyl acetate, isoamyl alcohol, and isobutanol.

Embodiment 157 is the alcoholic beverage replica of any one of embodiments 146-150, wherein the one or more additional VOCs comprise butyl formate, ethyl octanoate, ethyl propionate, ethyl-2-methylbutyrate, isoamyl acetate, isoamyl alcohol, and isobutanol.

Embodiment 158 is the alcoholic beverage replica of any one of embodiments 146-150, wherein the one or more additional VOCs comprise no more than 6 of butyl formate, ethyl octanoate, ethyl propionate, ethyl-2-methylbutyrate, isoamyl acetate, isoamyl alcohol, and isobutanol.

Embodiment 159 is the alcoholic beverage replica of any one of embodiments 146-150, wherein the one or more additional VOCs comprise no more than 5 of butyl formate, ethyl octanoate, ethyl propionate, ethyl-2-methylbutyrate, isoamyl acetate, isoamyl alcohol, and isobutanol.

Embodiment 160 is the alcoholic beverage replica of any one of embodiments 146-150, wherein the one or more additional VOCs comprise no more than 4 of butyl formate, ethyl octanoate, ethyl propionate, ethyl-2-methylbutyrate, isoamyl acetate, isoamyl alcohol, and isobutanol.

Embodiment 161 is the alcoholic beverage replica of any one of embodiments 146-160, wherein the one or more additional VOCs comprise (−)alpha-pinene in an amount of at least about 0.0024 mg/L.

Embodiment 162 is the alcoholic beverage replica of any one of embodiments 146-161, wherein the one or more additional VOCs comprise (−)cis-rose-oxide in an amount of at least about 0.0028 mg/L.

Embodiment 163 is the alcoholic beverage replica of any one of embodiments 146-162, wherein the one or more additional VOCs comprise 2-nonanone in an amount of at least about 0.085 mg/L.

Embodiment 164 is the alcoholic beverage replica of any one of embodiments 146-163, wherein the one or more additional VOCs comprise 2-undecanone in an amount of at least about 0.0014 mg/L.

Embodiment 165 is the alcoholic beverage replica of any one of embodiments 146-164, wherein the one or more additional VOCs comprise 3-carene in an amount of at least about 0.036 mg/L.

Embodiment 166 is the alcoholic beverage replica of any one of embodiments 146-165, wherein the one or more additional VOCs comprise 4-carvomenthenol in an amount of at least about 0.026 mg/L.

Embodiment 167 is the alcoholic beverage replica of any one of embodiments 146-166, wherein the one or more additional VOCs comprise 4-ethyl phenol in an amount of at least about 0.21 mg/L.

Embodiment 168 is the alcoholic beverage replica of any one of embodiments 146-167, wherein the one or more additional VOCs comprise amyl butyrate in an amount of at least about 0.032 mg/L.

Embodiment 169 is the alcoholic beverage replica of any one of embodiments 146-168, wherein the one or more additional VOCs comprise beta-ionone in an amount of at least about 0.036 mg/L.

Embodiment 170 is the alcoholic beverage replica of any one of embodiments 146-169, wherein the one or more additional VOCs comprise citronellol in an amount of at least about 0.95 mg/L.

Embodiment 171 is the alcoholic beverage replica of any one of embodiments 146-170, wherein the one or more additional VOCs comprise damascenone in an amount of at least about 3.8 mg/L.

Embodiment 172 is the alcoholic beverage replica of any one of embodiments 146-171, wherein the one or more additional VOCs comprise decanoic acid in an amount of at least about 1 mg/L.

Embodiment 173 is the alcoholic beverage replica of any one of embodiments 146-172, wherein the one or more additional VOCs comprise delta-decalactone in an amount of at least about 0.009 mg/L.

Embodiment 174 is the alcoholic beverage replica of any one of embodiments 146-173, wherein the one or more additional VOCs comprise ethyl butanoate in an amount of at least about 2.1 mg/L.

Embodiment 175 is the alcoholic beverage replica of any one of embodiments 146-174, wherein the one or more additional VOCs comprise ethyl decanoate in an amount of at least about 30.6 mg/L.

Embodiment 176 is the alcoholic beverage replica of any one of embodiments 146-175, wherein the one or more additional VOCs comprise ethyl hexanoate in an amount of at least about 5.1 mg/L.

Embodiment 177 is the alcoholic beverage replica of any one of embodiments 146-176, wherein the one or more additional VOCs comprise ethyl isovalarate in an amount of at least about 1.7 mg/L.

Embodiment 178 is the alcoholic beverage replica of any one of embodiments 146-177, wherein the one or more additional VOCs comprise ethyl undecanoate in an amount of at least about 0.018 mg/L.

Embodiment 179 is the alcoholic beverage replica of any one of embodiments 146-178, wherein the one or more additional VOCs comprise gamma-decalactone in an amount of at least about 0.2 mg/L.

Embodiment 180 is the alcoholic beverage replica of any one of embodiments 146-179, wherein the one or more additional VOCs comprise gamma-terpinene in an amount of at least about 0.04 mg/L.

Embodiment 181 is the alcoholic beverage replica of any one of embodiments 146-180, wherein the one or more additional VOCs comprise hexyl acetate in an amount of at least about 0.04 mg/L.

Embodiment 182 is the alcoholic beverage replica of any one of embodiments 146-181, wherein the one or more additional VOCs comprise isoamyl acetate in an amount of at least about 8.2 mg/L.

Embodiment 183 is the alcoholic beverage replica of any one of embodiments 146-182, wherein the one or more additional VOCs comprise isoamyl hexanoate in an amount of at least about 0.0016 mg/L.

Embodiment 184 is the alcoholic beverage replica of any one of embodiments 146-183, wherein the one or more additional VOCs comprise limonene in an amount of at least about 0.012 mg/L.

Embodiment 185 is the alcoholic beverage replica of any one of embodiments 146-184, wherein the one or more additional VOCs comprise linalool in an amount of at least about 0.5 mg/L.

Embodiment 186 is the alcoholic beverage replica of any one of embodiments 146-185, wherein the one or more additional VOCs comprise methyl decanoate in an amount of at least about 0.0084 mg/L.

Embodiment 187 is the alcoholic beverage replica of any one of embodiments 146-186, wherein the one or more additional VOCs comprise nerol in an amount of at least about 0.017 mg/L.

Embodiment 188 is the alcoholic beverage replica of any one of embodiments 146-187, wherein the one or more additional VOCs comprise nonanal in an amount of at least about 0.03 mg/L.

Embodiment 189 is the alcoholic beverage replica of any one of embodiments 146-188, wherein the one or more additional VOCs comprise phenethyl propionate in an amount of at least about 0.0045 mg/L.

Embodiment 190 is the alcoholic beverage replica of any one of embodiments 146-189, wherein the one or more additional VOCs comprise propanol in an amount of less than about 1.35 mg/L.

Embodiment 191 is the alcoholic beverage replica of any one of embodiments 146-190, wherein the one or more additional VOCs comprise acetoin in an amount of at least about 0.015 mg/L.

Embodiment 192 is the alcoholic beverage replica of any one of embodiments 146-191, wherein the one or more additional VOCs comprise isoamyl isovalerate in an amount of at least about 0.014 mg/L.

Embodiment 193 is the alcoholic beverage replica of any one of embodiments 146-192, wherein the one or more additional VOCs comprise nonanoic acid in an amount of less than about 0.022 mg/L.

Embodiment 194 is the alcoholic beverage replica of any one of embodiments 146-193, wherein the one or more additional VOCs comprise phenethyl formate in an amount of at least about 0.055 mg/L.

Embodiment 195 is the alcoholic beverage replica of any one of embodiments 146-194, wherein the one or more additional VOCs comprise salicylaldehyde in an amount of at least about 0.022 mg/L.

Embodiment 196 is the alcoholic beverage replica of any one of embodiments 146-195, wherein the one or more additional VOCs comprise valeraldehyde in an amount of at least about 0.00022 mg/L.

Embodiment 197 is the alcoholic beverage replica of any one of embodiments 146 to 196, wherein the one or more additional VOCs comprise an ester; an alcohol; optionally, an acid; optionally, an aldehyde, a ketone, or an aldehyde and a ketone; optionally, a terpene, an isoprenoid, or a terpene and an isoprenoid; optionally, a phenol; optionally, a lactone; optionally, an amine, a pyrazine, or an amine and a pyrazine; optionally, a thiol, a thiazole, a sulfide, or any combination thereof; optionally, an ether; optionally, an acetal; and optionally, a furan.

Embodiment 198 is the alcoholic beverage replica of any one of embodiments 146 to 197, wherein the one or more additional VOCs comprise one or more esters.

Embodiment 199 is the alcoholic beverage replica of embodiment 198, wherein the one or more esters are selected from the group consisting of 2-methylbutyl acetate, 2-methylbutyl isovalerate, 2-phenylethylacetate, 3-heptyl acetate, 3-methylthio hexyl acetate, 3-phenylpropyl acetate, allyl heptanoate, allyl hexanoate, amyl acetate, amyl butyrate, amyl formate, anisyl acetate, anisyl butyrate, benzyl acetate, benzyl benzoate, benzyl butyrate, benzyl formate, benzyl propionate, butyl acetate, butyl butyryllactate, butyl formate, butyl isovalerate, cis-3-hexenyl acetate, cis-3-hexenyl butyrate, cis-3-hexenyl caproate, cis-3-hexenyl valerate, citronellyl acetate, diethyl malate, diethyl succinate, dimethyl anthranilate, dimethyl succinate, ethyl 2-furoate, ethyl 2-trans-4-cis-decadienoate, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl hydrocinnamate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl pyruvate, ethyl salicylate, ethyl sorbate, ethyl undecanoate, ethyl valerate, ethyl(methylthio) acetate, ethyl-2-mercaptopropionate, ethyl-2-methylbutyrate, ethyl-3-hydroxybutyrate, ethyl-trans-2-butenoate, ethyl-trans-3-hexenoate, furfuryl acetate, geranyl acetate, geranyl butyrate, geranyl propionate, heptyl acetate, hexyl 3-methylbutanoate, hexyl acetate, hexyl butyrate, hexyl formate, hexyl hexanoate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, linalyl butyrate, linalyl formate, methionyl acetate (3-methylthio-propylacetate), methionyl butyrate, methyl acetate, methyl anthranilate, methyl benzoate, methyl cinnamate, methyl decanoate, methyl dihydrojasmonate, methyl hexanoate, methyl laurate, methyl octanoate, methyl salicylate, methyl vanillate, neryl acetate, octyl acetate, phenethyl 2-methylbutyrate, phenethyl acetate, phenethyl butyrate, phenethyl formate, phenethyl isobutyrate, phenethyl octanoate, phenethyl propionate, phenethyl tiglate, propyl acetate, propyl butyrate, propyl hexanoate, propyl isovalerate, and mixtures thereof.

Embodiment 200 is the alcoholic beverage replica of embodiment 198 or embodiment 199, wherein the one or more esters are selected from the group consisting of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl malate, diethyl succinate, dimethyl anthranilate, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl undecanoate, ethyl valerate, ethyl(methylthio) acetate, ethyl-2-mercaptopropionate, ethyl-2-methylbutyrate, ethyl-3-hydroxybutyrate, ethyl-trans-2-butenoate, ethyl-trans-3-hexenoate, geranyl acetate, heptyl acetate, hexyl acetate, hexyl hexanoate, isoamyl acetate, isoamyl hexanoate, isoamyl isobutyrate, isoamyl isovalerate, isoamyl octanoate, isobutyl acetate, linalyl acetate, linalyl butyrate, linalyl formate, methyl acetate, methyl anthranilate, methyl decanoate, methyl dihydrojasmonate, methyl hexanoate, methyl laurate, methyl octanoate, methyl salicylate, methyl vanillate, octyl acetate, phenethyl acetate, phenethyl butyrate, phenethyl formate, phenethyl isobutyrate, phenethyl octanoate, phenethyl propionate, propyl acetate, propyl butyrate, propyl hexanoate, and mixtures thereof.

Embodiment 201 is the alcoholic beverage replica of any one of embodiments 198-200, wherein the one or more esters are present in a total amount of about 0.009 mg/L to about 1.5 g/L.

Embodiment 202 is the alcoholic beverage replica of any one of embodiments 146 to 201, wherein the one or more additional VOCs comprise one or more acids.

Embodiment 203 is the alcoholic beverage replica of embodiment 202, wherein the one or more acids are selected from the group consisting of 3,7-dimethyl-6-octanoic acid, 3,7-dimethyl-6-octenoic acid, butyric acid, decanoic acid, hexanoic acid, isobutyric acid, isovaleric acid, nonanoic acid, octanoic acid, phenylacetic acid, propanoic acid, and valeric acid, and mixtures thereof.

Embodiment 204. is the alcoholic beverage replica of embodiment 202 or embodiment 203, wherein the one or more acids are selected from the group consisting of 3,7-dimethyl-6-octanoic acid, 3,7-dimethyl-6-octenoic acid, butyric acid, decanoic acid, hexanoic acid, isobutyric acid, isovaleric acid, nonanoic acid, octanoic acid, propanoic acid, and mixtures thereof.

Embodiment 205 is the alcoholic beverage replica of any one of embodiments 202-204, wherein the one or more acids are present in a total amount of about 0.03 mg/L to about 325 mg/L.

Embodiment 206 is the alcoholic beverage replica of any one of embodiments 146 to 205, wherein the one or more additional VOCs comprise one or more alcohols.

Embodiment 207 is the alcoholic beverage replica of embodiment 206, wherein the one or more alcohols are selected from the group consisting of 1-decanol, 1-octanol, 1-octen-3-ol, 2-(methylthio)ethanol, 2-heptanol, 2-methyl-1-butanol, 2-nonanol, 2-phenylethanol, 3-(methylthio)-1-propanol, 3-methyl-1-pentanol, amyl alcohol, anisyl alcohol, benzyl alcohol, butanol, cherry propanol, cis-2-hexenol, cis-3-hexen-1-ol, cis-5-octen-1-ol, cis-6-nonen-1-ol, DL-3-methyl-2-butanol, hexadecanol, hexanol, isoamyl alcohol, isobutanol, propanol, trans-2-hexen-1-ol, and mixtures thereof.

Embodiment 208 is the alcoholic beverage replica of embodiment 206 or embodiment 207, wherein the one or more alcohols are selected from the group consisting of 1-decanol, 1-octanol, 1-octen-3-ol, 2-(methylthio)ethanol, 2-methyl-1-butanol, 2-phenylethanol, 3-(methylthio)-1-propanol, 3-methyl-1-pentanol, amyl alcohol, benzyl alcohol, butanol, cis-2-hexenol, cis-3-hexen-1-ol, DL-3-methyl-2-butanol, hexadecanol, hexanol, isoamyl alcohol, isobutanol, propanol, trans-2-hexen-1-ol, and mixtures thereof.

Embodiment 209 is the alcoholic beverage replica of any one of embodiments 206-208, wherein the one or more alcohols are present in a total amount of about 0.08 mg/L to about 4.5 mg/L.

Embodiment 210 is the alcoholic beverage replica of any one of embodiments 146 to 209, wherein the one or more additional VOCs comprise one or more aldehydes or ketones.

Embodiment 211 is the alcoholic beverage replica of embodiment 210, wherein the one or more aldehydes or ketones are selected from the group consisting of 2,3-hexanedione, 2,3-pentadione, 2,6-dimethyl-5-heptenal, 2-acetyl-1-methylpyrrole, 2-heptanone, 2-methoxycinnamaldehyde, 2-methylbutyraldehyde, 2-nonanone, 2-octanone, 2-undecanone, 3-nonen-2-one, 3-phenylpropanal, 4-(4-hydroxyphenyl)-2-butanone, 4-hydroxy-2,5-dimethyl-3(2H)-furanone, 5-ethyl-3-hydroxy-4-methyl-2(5H)-furanone (maple furanone), 5-methyl furfural, 5-methyl-2-phenyl-2-hexenal, 6-methyl-5-hepten-2-one, acetaldehyde, acetoin, acetophenone, acetovanillone, benzaldehyde, Butyraldehyde, cinnamaldehyde, cuminaldehyde, damascenone, decanal, diacetyl, furfural, hexanal, isobutyraldehyde, isovaleraldehyde, maltol, methional, Methyl cyclopentenolone, Methyl β-naphthyl ketone, methyl-2-pyrrolyl ketone, nonanal, octanal, p-anisaldehyde, phenylacetaldehyde, propanal, propionaldehyde, salicylaldehyde, sotolon, trans-2-heptenal, trans-2-hexen-1-al, trans-2-nonenal, trans-2-pentanal, valeraldehyde, and mixtures thereof.

Embodiment 212 is the alcoholic beverage replica of embodiment 210 or embodiment 211, wherein the one or more aldehydes or ketones are selected from the group consisting of 2,3-pentadione, 2-heptanone, 2-methylbutyraldehyde, 2-nonanone, 2-undecanone, 3-nonen-2-one, 5-ethyl-3-hydroxy-4-methyl-2(5H)-furanone (maple furanone), 5-methyl furfural, 6-methyl-5-hepten-2-one, acetaldehyde, acetoin, acetophenone, benzaldehyde, cinnamaldehyde, damascenone, diacetyl, furfural, isobutyraldehyde, isovaleraldehyde, maltol, methional, methyl cyclopentenolone, methyl 3-naphthyl ketone, nonanal, p-anisaldehyde, phenylacetaldehyde, salicylaldehyde, trans-2-heptenal, trans-2-hexen-1-al, trans-2-pentanal, valeraldehyde, and mixtures thereof.

Embodiment 213 is the alcoholic beverage replica of any one of embodiments 210-212, wherein the one or more aldehydes or ketones are present in a total amount of about 0.02 mg/L to about 14 mg/L.

Embodiment 214 is the alcoholic beverage replica of any one of embodiments 146 to 213, wherein the one or more additional VOCs comprise one or more terpenes or isoprenoids.

Embodiment 215 is the alcoholic beverage replica of embodiment 214, wherein the one or more terpenes or isoprenoids are selected from the group consisting of (−) alpha-pinene, (−)cis-rose-oxide, 1,4-cineole, 3-carene, 4,5,6,7-tetrahydro-3,6-dimethylbenzofuran, 4-carvomenthenol, 4-ethylguaiacol, a-ionone, a-phellandrene, a-terpineol, b-caryophellene, beta pinene, beta-ionone, carvacrol, carvone, citral, citronellol, camascone, D-camphor, d-fenchone, eucalyptol, farnesol, gamma-terpinene, geraniol, geranyl acetone, isoborneol, limonene, linalool, linalool oxide, L-menthyl acetate, myrcene, myrtenol, nerol, nerolidol, p,a-dimethylstyrene, p-cymene, perillaldehyde, terpinolene, tetrahydrolinalool, thymol, valencene, and mixtures thereof.

Embodiment 216 is the alcoholic beverage of embodiment 214 or embodiment 215, wherein the one or more terpenes or isoprenoids are selected from the group consisting of (−)alpha-pinene, (−)cis-rose-oxide, 3-carene, 4-carvomenthenol, 4-ethylguaiacol, a-ionone, a-phellandrene, a-terpineol, b-caryophellene, beta pinene, beta-ionone, carvone, citral, citronellol, D-camphor, eucalyptol, farnesol, gamma-terpinene, geraniol, geranyl acetone, isoborneol, limonene, linalool, linalool oxide, myrcene, myrtenol, nerol, nerolidol, p,a-dimethylstyrene, p-cymene, terpinolene, and mixtures thereof.

Embodiment 217 is the alcoholic beverage replica of any one of embodiments 214-216, wherein the one or more terpenes or isoprenoids are present in a total amount of about 0.0002 mg/L to about 95 mg/L.

Embodiment 218 is the alcoholic beverage replica of any one of embodiments 146 to 217, wherein the one or more additional VOCs comprise one or more phenols.

Embodiment 219 is the alcoholic beverage replica of embodiment 218, wherein the one or more phenols are selected from the group consisting of 2,4,6-trimethylphenol (mesitol), 2-methoxy-4-methylphenol, 2-methoxy-4-propyl-phenol, 4-ethylphenol, 4-vinylphenol, eugenol, guaiacol, isoeugenol, p-cresol, and mixtures thereof.

Embodiment 220 is the alcoholic beverage replica of embodiment 218 or embodiment 219, wherein the one or more phenols are selected from the group consisting of 2,4,6-trimethylphenol (mesitol), 2-methoxy-4-methylphenol, 2-methoxy-4-propyl-phenol, 4-ethylphenol, eugenol, guaiacol, p-cresol, and mixtures thereof.

Embodiment 221 is the alcoholic beverage replica of any one of embodiments 218-220, wherein the one or more phenols are present in a total amount of about 0.00007 mg/L to about 5 mg/L.

Embodiment 222 is the alcoholic beverage replica of any one of embodiments 146 to 221, wherein the one or more additional VOCs comprise one or more lactones.

Embodiment 223 is the alcoholic beverage replica of embodiment 222, wherein the one or more lactones are selected from the group consisting of delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, jasmine lactone, omega-pentadecalactone, whiskey lactone, and mixtures thereof.

Embodiment 224 is the alcoholic beverage replica of embodiment 222 or embodiment 223, wherein the one or more lactones are selected from the group consisting of delta-decalactone, gamma-decalactone, gamma-hexalactone, gamma-nonalactone, gamma-octalactone, gamma-undecalactone, Jasmine lactone, whiskey lactone, and mixtures thereof.

Embodiment 225 is the alcoholic beverage replica of any one of embodiments 222-224, wherein the one or more lactones are present in a total amount of about 0.00007 mg/L to about 10 mg/L.

Embodiment 226 is the alcoholic beverage replica of any one of embodiments 146 to 225, wherein the one or more additional VOCs comprise one or more amines or pyrazines.

Embodiment 227 is the alcoholic beverage replica of embodiment 226, wherein the one or more amines or pyrazines are selected from the group consisting of 2,5-dimethylpyrazine, 2,6-dimethylpyrazine, 2-acetylpyridine, 2-ethyl-3(5 or 6)-dimethylpyrazine, 2-ethyl-3-methylpyrazine, 2-isobutyl-3-methoxypyrazine, 2-isopropyl-3-methoxypyrazine, 2-methoxy-3-(1-methylpropyl) pyrazine, indole, and mixtures thereof.

Embodiment 228 is the alcoholic beverage replica of embodiment 226 or embodiment 227, wherein the one or more amines or pyrazines are selected from the group consisting of 2-acetylpyridine, 2-isobutyl-3-methoxypyrazine, 2-isopropyl-3-methoxypyrazine, and mixtures thereof.

Embodiment 229 is the alcoholic beverage replica of any one of embodiments 226-228, wherein the one or more amines or pyrazines are present in a total amount of about 0.00007 mg/L to about 0.09 mg/L.

Embodiment 230 is the alcoholic beverage replica of any one of embodiments 146 to 229, wherein the one or more additional VOCs comprise one or more thiols, thiazoles, or sulfides.

Embodiment 231 is the alcoholic beverage replica of embodiment 230, wherein the one or more thiols, thiazoles, or sulfides are selected from the group consisting of 1-para-menthene-8-thiol, 2-isopropyl-4-methyl thiazole, 3-mercaptohexylacetate, 4-mercapto-4-methyl-2-pentanone, dimethyl sulfide, dimethyl trisulfide, furfuryl mercaptan, furfuryl thioacetate, and mixtures thereof.

Embodiment 232 is the alcoholic beverage replica of embodiment 230 or embodiment 231, wherein the one or more thiols, thiazoles, or sulfides are selected from the group consisting of 3-mercaptohexylacetate, dimethyl sulfide, furfuryl mercaptan, and mixtures thereof.

Embodiment 233 is the alcoholic beverage replica any one of embodiments 230-232, wherein the one or more thiols, thiazoles, or sulfides are present in a total amount of about 0.00007 mg/L to about 0.45 mg/L.

Embodiment 234 is the alcoholic beverage replica of any one of embodiments 146-233, wherein the one or more additional VOCs comprise one or more ethers.

Embodiment 235 is the alcoholic beverage replica of embodiment 234, wherein the one or more ethers are selected from the group consisting of furfuryl ether, vanillyl butyl ether, vanillyl ethyl ether, and mixtures thereof.

Embodiment 236 is the alcoholic beverage replica of embodiment 234 or embodiment 235, wherein the one or more ethers comprise vanillyl ethyl ether.

Embodiment 237 is the alcoholic beverage replica of any one of embodiments 234-236, wherein the one or more ethers are present in a total amount of about 0.01 to about 0.05 mg/L.

Embodiment 238 is the alcoholic beverage replica of any one of embodiments 146 to 237, wherein the one or more additional VOCs comprise one or more acetals.

Embodiment 239 is the alcoholic beverage replica of embodiment 238, wherein the one or more acetals are selected from the group consisting of 2-isobutyl-4-methyl-1,3-dioxolane, acetal, acetaldehyde diethyl acetal, b-ethoxypropionaldehyde diethyl acetal, phenethyl acetaldehyde dimethyl acetal, and mixtures thereof.

Embodiment 240 is the alcoholic beverage replica of embodiment 238 or embodiment 239, wherein the one or more acetals are selected from the group consisting of acetal, acetaldehyde diethyl acetal, phenethyl acetaldehyde dimethyl acetal, and mixtures thereof.

Embodiment 241 is the alcoholic beverage replica of any one of embodiments 238-240, wherein the one or more acetals are present in an amount of about 0.15 mg/L to about 28 mg/L.

Embodiment 242 is the alcoholic beverage replica of any one of embodiments 146 to 241, wherein the one or more additional VOCs comprise one or more furans.

Embodiment 243 is the alcoholic beverage replica of embodiment 242, wherein the one or more furans comprise 2-pentyl furan.

Embodiment 244 is the alcoholic beverage replica of any one of embodiments 146-243, wherein the one or more additional VOCs comprise at least 5 compounds selected from the group consisting of 1-decanol, 1-octanol, 1-octen-3-ol, 2,3-pentadione, 2,4,6-trimethylphenol (mesitol), 2-heptanone, 2-isopropyl-3-methoxypyrazine, 2-methyl-1-butanol, 2-methylbutyl acetate, 2-methylbutyraldehyde, 2-phenylethanol, 2-phenylethylacetate, 2-undecanone, 3-(methylthio)-1-propanol, 3,7-dimethyl-6-octanoic acid, 3,7-dimethyl-6-octenoic acid, 3-methyl-1-pentanol, 4-carvomenthenol, 4-ethylguaiacol, 4-ethylphenol, 5-ethyl-3-hydroxy-4-methyl-2(5H)-furanone (maple furanone), 5-methyl furfural, 6-methyl-5-hepten-2-one, acetal, acetaldehyde, acetaldehyde, diethyl acetal, acetophenone, amyl alcohol, a-phellandrene, a-terpineol, b-caryophellene, benzaldehyde, beta pinene, butanol, butyl acetate, butyl formate, butyric acid, cinnamaldehyde, cis-2-hexenol, citral, citronellol, damascenone, D-camphor, decanoic acid, delta-decalactone, diacetyl, diethyl malate, diethyl succinate, dimethyl anthranilate, dimethyl sulfide, DL-3-methyl-2-butanol, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eugenol, farnesol, furfural, gamma-decalactone, gamma-hexalactone, gamma-nonalactone, gamma-octalactone, geraniol, geranyl acetone, guaiacol, hexadecanol, hexanol, hexyl hexanoate, isoamyl acetate, isoamyl alcohol, isoamyl octanoate, isobutanol, isobutyl acetate, isobutyraldehyde, isobutyric acid, isovaleraldehyde, isovaleric acid, limonene, linalool, linalool oxide, linalyl acetate, maltol, methional, methyl acetate, methyl anthranilate, methyl cyclopentenolone, methyl decanoate, methyl hexanoate, methyl laurate, methyl salicylate, methyl β-naphthyl ketone, myrtenol, nerol, nerolidol, nonanoic acid, octanoic acid, p,a-dimethylstyrene, p-cymene, phenethyl acetate, phenethyl formate, phenethyl isobutyrate, phenethyl octanoate, phenethyl propionate, phenylacetaldehyde, propanoic acid, propanol, propyl acetate, propyl butyrate, salicylaldehyde, terpinolene, trans-2-heptenal, trans-2-hexen-1-al, trans-2-hexen-1-ol, trans-2-pentanal, vanillyl ethyl ether, and whiskey lactone.

Embodiment 245 is the alcoholic beverage replica of any one of embodiments 146-243, wherein the one or more additional VOCs comprise at least 10 compounds selected from the group consisting of 1-decanol, 1-octanol, 1-octen-3-ol, 2,3-pentadione, 2,4,6-trimethylphenol (mesitol), 2-heptanone, 2-isopropyl-3-methoxypyrazine, 2-methyl-1-butanol, 2-methylbutyl acetate, 2-methylbutyraldehyde, 2-phenylethanol, 2-phenylethylacetate, 2-undecanone, 3-(methylthio)-1-propanol, 3,7-dimethyl-6-octanoic acid, 3,7-dimethyl-6-octenoic acid, 3-methyl-1-pentanol, 4-carvomenthenol, 4-ethylguaiacol, 4-ethylphenol, 5-ethyl-3-hydroxy-4-methyl-2(5H)-furanone (maple furanone), 5-methyl furfural, 6-methyl-5-hepten-2-one, acetal, acetaldehyde, acetaldehyde diethyl acetal, acetophenone, amyl alcohol, a-phellandrene, a-terpineol, b-caryophellene, benzaldehyde, beta pinene, butanol, butyl acetate, butyl formate, butyric acid, cinnamaldehyde, cis-2-hexenol, citral, citronellol, damascenone, D-camphor, decanoic acid, delta-decalactone, diacetyl, diethyl malate, diethyl succinate, dimethyl anthranilate, dimethyl sulfide, DL-3-methyl-2-butanol, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eugenol, farnesol, furfural, gamma-decalactone, gamma-hexalactone, gamma-nonalactone, gamma-octalactone, geraniol, geranyl acetone, guaiacol, hexadecanol, hexanol, hexyl hexanoate, isoamyl acetate, isoamyl alcohol, isoamyl octanoate, isobutanol, isobutyl acetate, isobutyraldehyde, isobutyric acid, isovaleraldehyde, isovaleric acid, limonene, linalool, linalool oxide, linalyl acetate, maltol, methional, methyl acetate, methyl anthranilate, methyl cyclopentenolone, methyl decanoate, methyl hexanoate, methyl laurate, methyl salicylate, methyl β-naphthyl ketone, myrtenol, nerol, nerolidol, nonanoic acid, octanoic acid, p,a-dimethylstyrene, p-cymene, phenethyl acetate, phenethyl formate, phenethyl isobutyrate, phenethyl octanoate, phenethyl propionate, phenylacetaldehyde, propanoic acid, propanol, propyl acetate, propyl butyrate, salicylaldehyde, terpinolene, trans-2-heptenal, trans-2-hexen-1-al, trans-2-hexen-1-ol, trans-2-pentanal, vanillyl ethyl ether, and whiskey lactone.

Embodiment 246 is the alcoholic beverage replica of any one of embodiments 146-243, wherein the one or more additional VOCs comprise at least 20 compounds selected from the group consisting of 1-decanol, 1-octanol, 1-octen-3-ol, 2,3-pentadione, 2,4,6-trimethylphenol (mesitol), 2-heptanone, 2-isopropyl-3-methoxypyrazine, 2-methyl-1-butanol, 2-methylbutyl acetate, 2-methylbutyraldehyde, 2-phenylethanol, 2-phenylethylacetate, 2-undecanone, 3-(methylthio)-1-propanol, 3,7-dimethyl-6-octanoic acid, 3,7-dimethyl-6-octenoic acid, 3-methyl-1-pentanol, 4-carvomenthenol, 4-ethylguaiacol, 4-ethylphenol, 5-ethyl-3-hydroxy-4-methyl-2(5H)-furanone (maple furanone), 5-methyl furfural, 6-methyl-5-hepten-2-one, acetal, acetaldehyde, acetaldehyde diethyl acetal, acetophenone, amyl alcohol, a-phellandrene, a-terpineol, b-caryophellene, benzaldehyde, beta pinene, butanol, butyl acetate, butyl formate, butyric acid, cinnamaldehyde, cis-2-hexenol, citral, citronellol, damascenone, D-camphor, decanoic acid, delta-decalactone, diacetyl, diethyl malate, diethyl succinate, dimethyl anthranilate, dimethyl sulfide, DL-3-methyl-2-butanol, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eugenol, farnesol, furfural, gamma-decalactone, gamma-hexalactone, gamma-nonalactone, gamma-octalactone, geraniol, geranyl acetone, guaiacol, hexadecanol, hexanol, hexyl hexanoate, isoamyl acetate, isoamyl alcohol, isoamyl octanoate, isobutanol, isobutyl acetate, isobutyraldehyde, isobutyric acid, isovaleraldehyde, isovaleric acid, limonene, linalool, linalool oxide, linalyl acetate, maltol, methional, methyl acetate, methyl anthranilate, methyl cyclopentenolone, methyl decanoate, methyl hexanoate, methyl laurate, methyl salicylate, methyl β-naphthyl ketone, myrtenol, nerol, nerolidol, nonanoic acid, octanoic acid, p,a-dimethylstyrene, p-cymene, phenethyl acetate, phenethyl formate, phenethyl isobutyrate, phenethyl octanoate, phenethyl propionate, phenylacetaldehyde, propanoic acid, propanol, propyl acetate, propyl butyrate, salicylaldehyde, terpinolene, trans-2-heptenal, trans-2-hexen-1-al, trans-2-hexen-1-ol, trans-2-pentanal, vanillyl ethyl ether, and whiskey lactone.

Embodiment 247 is the alcoholic beverage replica of any one of embodiments 146-246, wherein the one or more additional VOCs comprise at least 1 compound selected from the group consisting of (−)alpha-pinene, (−)cis-rose-oxide, 2-(methylthio)ethanol, 2-acetylpyridine, 2-isobutyl-3-methoxypyrazine, 2-methoxy-4-methylphenol, 2-methoxy-4-propyl-phenol, 2-methylbutyl isovalerate, 2-nonanone, 3-carene, 3-mercaptohexylacetate, 3-nonen-2-one, acetoin, a-ionone, amyl butyrate, benzyl acetate, benzyl alcohol, beta-ionone, butyl isovalerate, carvone, cis-3-hexen-1-ol, cis-3-hexenyl acetate, ethyl salicylate, ethyl(methylthio) acetate, ethyl-2-mercaptopropionate, ethyl-trans-2-butenoate, ethyl-trans-3-hexenoate, eucalyptol, furfuryl mercaptan, gamma-terpinene, gamma-undecalactone, geranyl acetate, heptyl acetate, hexanoic acid, hexyl acetate, isoamyl hexanoate, isoamyl isobutyrate, isoamyl isovalerate, isoborneol, jasmine lactone, linalyl butyrate, linalyl formate, methyl dihydrojasmonate, methyl octanoate, methyl vanillate, myrcene, nonanal, octyl acetate, p-anisaldehyde, p-cresol, phenethyl acetaldehyde dimethyl acetal, phenethyl butyrate, propyl hexanoate, valeraldehyde.

Embodiment 248 is the alcoholic beverage replica of any one of embodiments 146-246, wherein the one or more additional VOCs comprise at least 5 compounds selected from the group consisting of (−)alpha-pinene, (−)cis-rose-oxide, 2-(methylthio)ethanol, 2-acetylpyridine, 2-isobutyl-3-methoxypyrazine, 2-methoxy-4-methylphenol, 2-methoxy-4-propyl-phenol, 2-methylbutyl isovalerate, 2-nonanone, 3-carene, 3-mercaptohexylacetate, 3-nonen-2-one, acetoin, a-ionone, amyl butyrate, benzyl acetate, benzyl alcohol, beta-ionone, butyl isovalerate, carvone, cis-3-hexen-1-ol, cis-3-hexenyl acetate, ethyl salicylate, ethyl(methylthio) acetate, ethyl-2-mercaptopropionate, ethyl-trans-2-butenoate, ethyl-trans-3-hexenoate, eucalyptol, furfuryl mercaptan, gamma-terpinene, gamma-undecalactone, geranyl acetate, heptyl acetate, hexanoic acid, hexyl acetate, isoamyl hexanoate, isoamyl isobutyrate, isoamyl isovalerate, isoborneol, jasmine lactone, linalyl butyrate, linalyl formate, methyl dihydrojasmonate, methyl octanoate, methyl vanillate, myrcene, nonanal, octyl acetate, p-anisaldehyde, p-cresol, phenethyl acetaldehyde dimethyl acetal, phenethyl butyrate, propyl hexanoate, valeraldehyde.

Embodiment 249 is the alcoholic beverage replica of any one of embodiments 146-248, wherein the additional VOCs have less than 90% identity to the VOCs in a single corresponding traditional alcoholic beverage.

Embodiment 250 is the alcoholic beverage replica of any one of embodiments 146-248, wherein the additional VOCs have less than 80% identity to the VOCs in a single corresponding traditional alcoholic beverage

Embodiment 251 is the alcoholic beverage replica of any one of embodiments 146-248, wherein the additional VOCs have less than 70% identity to the VOCs in a single corresponding traditional alcoholic beverage

Embodiment 252 is the alcoholic beverage replica of any one of embodiments 146-248, wherein the additional VOCs have less than 60% identity to the VOCs in a single corresponding traditional alcoholic beverage

Embodiment 253 is the alcoholic beverage replica of any one of embodiments 146-248, wherein the additional VOCs have less than 50% identity to the VOCs in a single corresponding traditional alcoholic beverage

Embodiment 254 is the alcoholic beverage replica of any one of embodiments 146-248, wherein the additional VOCs have less than 40% identity to the VOCs in a single corresponding traditional alcoholic beverage

Embodiment 255 is the alcoholic beverage replica of any one of embodiments 128 to 254, wherein the alcoholic beverage replica does not comprise one or more of Escherichia. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, heavy metal, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

Embodiment 256 is a method of making an alcoholic beverage replica, the method comprising combining ingredients comprising water, ethanol, and five or more additional VOCs, wherein at least five of the five or more additional VOCs are provided as separate ingredients.

Embodiment 257 is the method of embodiment 256, comprising 10 or more additional VOCs, wherein at least 10 of the 10 or more additional VOCs are provided as separate ingredients.

Embodiment 258 is the method of embodiment 256, comprising 15 or more additional VOCs, wherein at least 15 of the 15 or more additional VOCs are provided as separate ingredients.

Embodiment 259 is the method of embodiment 256, comprising 20 or more additional VOCs, wherein at least 20 of the 20 or more additional VOCs are provided as separate ingredients.

Embodiment 260 is the method of any one of embodiments 256-259, wherein the ingredients further comprise a non-volatile compound.

Embodiment 261 is the method of embodiment 260, wherein the non-volatile compound is a sugar or a sugar alcohol, an acid, a pH-modifying salt, a nucleotide monophosphate, an amino acid, or a combination thereof.

Embodiment 262 is the method of embodiment 261, wherein the acid comprises tartaric acid, malic acid, citric acid, succinic acid, lactic acid, acetic acid, or a combinations thereof.

Embodiment 263 is the method of embodiment 261 or embodiment 262, wherein the sugar or sugar alcohol comprises glycerol, glucose, fructose, sorbitol, inositol, mannose, mannitol, or a combination thereof.

Embodiment 264 is the method of any one of embodiments 261-263, wherein the pH-modifying salt comprises potassium hydroxide.

Embodiment 265 is the method of any one of embodiments 261-264, wherein the nucleotide monophosphate comprises guanosine monophosphate, inosine monophosphate, or a combination thereof.

Embodiment 266 is the method of any one of embodiments 261-265, wherein the amino acid comprises arginine, asparagine, b-alanine, glutamic acid, glutamine, histidine, lysine, phenylalanine, proline, tryptophan, tyrosine, valine, alanine, aspartic acid, gamma-aminobutyric acid (GABA), glycine, isoleucine, leucine, methionine, monosodium glutamate, serine, threonine, or a combination thereof.

Embodiment 267 is the method of any one of embodiments 260-266, wherein the non-volatile compound comprises a coloring agent.

Embodiment 268 is the method of any one of embodiments 260-267, wherein the non-volatile compound comprises a surfactant.

Embodiment 269 is the method of any one of embodiments 260-268, wherein the non-volatile compound comprises a compound selected from the group consisting of gum arabic, pectin, and combinations thereof.

Embodiment 270 is the method of any one of embodiments 260-269, wherein the non-volatile compound comprises at least one non-volatile compound that is not present in a corresponding traditional alcoholic beverage.

Embodiment 271 is the method of any one of embodiments 260-270, wherein the non-volatile compound does not comprise at least one non-volatile compound that is present in a corresponding traditional alcoholic beverage.

Embodiment 272 is the method of any one of embodiments 256-271, wherein the one or more additional VOCs comprise at least one VOC that is not present in a corresponding traditional alcoholic beverage.

Embodiment 273 is the method of any one of embodiments 256-272, wherein the one or more additional VOCs do not comprise at least one VOC that is present in a corresponding traditional alcoholic beverage.

Embodiment 274 is a method of making a spirit or wine replica, the method comprising providing a composition comprising, ethanol, water, and one or more additional VOCs, wherein at least one of the one or more additional VOCs is present in a concentration of at least about 2-fold the concentration of the same VOC in a corresponding traditional spirit or wine, and adding to the composition ethanol, water, or a combination thereof such that the concentration of the at least one additional VOC is reduced to about the concentration of the same VOC in a corresponding traditional spirit or wine.

Embodiment 275 is the method of embodiment 274, wherein the one or more additional VOCs comprise at least one VOC that is not present in a corresponding traditional spirit or wine.

Embodiment 276 is the method of embodiment 274 or embodiment 275, wherein the one or more additional VOCs do not comprise at least one VOC that is present in a corresponding traditional spirit or wine.

Embodiment 277 is the method of any one of embodiments 274-276, wherein the spirit or wine replica further comprises one or more non-volatile compounds, and wherein the one or more non-volatile compounds comprise at least one non-volatile compound that is not present in a corresponding traditional spirit or wine.

Embodiment 278 is the method of any one of embodiments 274-277, wherein the spirit or wine replica further comprises one or more non-volatile compounds, and wherein the one or more non-volatile compounds do not comprise at least one non-volatile compound that is present in a corresponding traditional spirit or wine.

Embodiment 279 is the method of any one of embodiments 274-278, wherein the one or more additional VOCs are present in the composition in a concentration of at least about 5-fold the concentration of the same VOCs in a corresponding traditional spirit or wine.

Embodiment 280 is the method of any one of embodiments 274-278, wherein the one or more additional VOCs are present in the composition in a concentration of at least about 10-fold the concentration of the same VOC in a corresponding traditional spirit or wine.

Embodiment 281 is the method of any one of embodiments 274-278, wherein the one or more additional VOCs are present in the composition in a concentration of at least about 15-fold the concentration of the same VOCs in a corresponding traditional spirit or wine.

Embodiment 282 is the method of any one of embodiments 274-278, wherein the one or more additional VOCs are present in the composition in a concentration of at least about 20-fold the concentration of the same VOCs in a corresponding traditional spirit or wine.

Embodiment 283 is the method of any one of embodiments 274-282, wherein the composition comprises five or more additional VOCs, wherein at least five of the five or more additional VOCs are present in a concentration of at least about 5-fold the concentration of the same VOCs in a corresponding traditional spirit or wine.

Embodiment 284 is the method of any one of embodiments 274-283, wherein the total amount (in mg/L) of the one or more additional VOCs in the composition is greater than 5-fold the total amount of the same VOCs (in mg/L) in a corresponding traditional spirit or wine.

Embodiment 285 is a method of making a spirit or wine replica, the method comprising providing a composition comprising ethanol, water, and one or more additional non-volatile compounds, wherein at least one of the one or more non-volatile compounds is present in a concentration of at least about 2-fold the concentration of the same non-volatile compound in a corresponding traditional spirit or wine, and adding to the composition ethanol, water, or a combination thereof such that the concentration of the at least one non-volatile compound is reduced to about the concentration of the same non-volatile compound in a corresponding traditional spirit or wine.

Embodiment 286 is the method of any one of embodiment 285, wherein the one or more non-volatile compounds comprise at least one non-volatile compound that is not present in a corresponding traditional spirit or wine.

Embodiment 287 is the method of embodiment 12 or embodiment 286, wherein the one or more non-volatile compounds do not comprise at least one non-volatile compound that is present in a corresponding traditional spirit or wine.

Embodiment 288 is the method of any one of embodiments 285-287, wherein the spirit or wine replica further comprises one or more additional VOCs, and wherein the one or more additional VOCs comprise at least one VOC that is not present in a corresponding traditional spirit or wine.

Embodiment 289 is the method of any one of embodiments 285-287, wherein the spirit or wine replica further comprises one or more additional VOCs, and wherein the one or more additional VOCs do not comprise at least one VOC that is present in a corresponding traditional spirit or wine.

Embodiment 290 is the method of any one of embodiments 285-287, wherein the one or more non-volatile compounds are present in the composition in a concentration of at least about 5-fold the concentration of the same non-volatile compounds in a corresponding traditional spirit or wine.

Embodiment 291 is the method of any one of embodiments 285-287, wherein the one or more non-volatile compounds are present in the composition in a concentration of at least about 10-fold the concentration of the same non-volatile compounds in a corresponding traditional spirit or wine.

Embodiment 292 is the method of any one of embodiments 285-287, wherein the one or more non-volatile compounds are present in the composition in a concentration of at least about 15-fold the concentration of the same non-volatile compounds in a corresponding traditional spirit or wine.

Embodiment 293 is the method of any one of embodiments 285-287, wherein the one or more non-volatile compounds are present in the composition in a concentration of at least about 20-fold the concentration of the same non-volatile compounds in a corresponding traditional spirit or wine.

Embodiment 294 is the method of any one of embodiments 285-293, wherein the composition comprises five or more non-volatile compounds, wherein at least five of the five or more non-volatile compounds are present in a concentration of at least about 5-fold the concentration of the same non-volatile compounds in a corresponding traditional spirit or wine.

Embodiment 295 is the method of any one of embodiments 285-294, wherein the total amount (in mg/L) of the one or more non-volatile compounds in the composition is greater than 5-fold the total amount of the same non-volatile compounds (in mg/L) in a corresponding traditional spirit or wine.

Embodiment 296 is a method of making a spirit or wine replica concentrate, the method comprising combining ethanol, water, and one or more additional VOCs, wherein at least one of the one or more additional VOCs is present in a concentration of at least about 2-fold the concentration of the same VOC in a corresponding traditional spirit or wine.

Embodiment 297 is the method of embodiment 296, wherein the one or more additional VOCs comprise at least one VOC that is not present in a corresponding traditional spirit or wine.

Embodiment 298 is the method of embodiment 296 or embodiment 297, wherein the one or more additional VOCs do not comprise at least one VOC that is present in a corresponding traditional spirit or wine.

Embodiment 299 is the method of any one of embodiments 296-298, wherein the spirit or wine replica concentrate further comprises one or more non-volatile compounds, and wherein the one or more non-volatile compounds comprise at least one non-volatile compound that is not present in a corresponding traditional spirit or wine.

Embodiment 300 is the method of any one of embodiments 296-299, wherein the spirit or wine replica concentrate further comprises one or more non-volatile compounds, and wherein the one or more non-volatile compounds do not comprise at least one non-volatile compound that is present in a corresponding traditional spirit or wine.

Embodiment 301 is the method of any one of embodiments 296-300, wherein the one or more additional VOCs are present in the concentrate in a concentration of at least about 5-fold the concentration of the same VOCs in a corresponding traditional spirit or wine.

Embodiment 302 is the method of any one of embodiments 296-300, wherein the one or more additional VOCs are present in the concentrate in a concentration of at least about 10-fold the concentration of the same VOCs in a corresponding traditional spirit or wine.

Embodiment 303 is the method of any one of embodiments 296-300, wherein the one or more additional VOCs are present in the concentrate in a concentration of at least about 15-fold the concentration of the same VOCs in a corresponding traditional spirit or wine.

Embodiment 304 is the method of any one of embodiments 296-300, wherein the one or more additional VOCs are present in the concentrate in a concentration of at least about 20-fold the concentration of the same VOC in a corresponding traditional spirit or wine.

Embodiment 305 is the method of any one of embodiments 296-300, wherein the concentrate comprises five or more additional VOCs, wherein at least five of the five or more additional VOCs are present in a concentration of at least about 5-fold the concentration of the same VOCs in a corresponding traditional spirit or wine.

Embodiment 306 is the method of any one of embodiments 296-305, wherein the total amount (in mg/L) of the one or more additional VOCs in the concentrate is greater than 5-fold the total amount of the same VOCs (in mg/L) in a corresponding traditional spirit or wine.

Embodiment 307 is a method of making a spirit or wine replica concentrate, the method comprising combining ethanol, water, and one or more non-volatile compounds, wherein at least one of the one or more non-volatile compounds is present in a concentration of at least about 2-fold the concentration of the same non-volatile compound in a corresponding traditional spirit or wine.

Embodiment 308 is the method of embodiment 307, wherein the one or more non-volatile compounds comprise at least one non-volatile compound that is not present in a corresponding traditional spirit or wine.

Embodiment 309 is the method of embodiment 307 or embodiment 308, wherein the one or more non-volatile compounds do not comprise at least one non-volatile compound that is present in a corresponding traditional spirit or wine.

Embodiment 310 is the method of any one of embodiments 307-309, wherein the spirit or wine replica concentrate further comprises one or more additional VOCs, and wherein the one or more additional VOCs comprise at least one VOC that is not present in a corresponding traditional spirit or wine.

Embodiment 311. is the method of any one of embodiments 307-310, wherein the spirit or wine replica concentrate further comprises one or more additional VOCs, and wherein the one or more additional VOCs do not comprise at least one VOC that is present in a corresponding traditional spirit or wine.

Embodiment 312. is the method of any one of embodiments 309-311, wherein the one or more non-volatile compounds are present in the concentrate in a concentration of at least about 5-fold the concentration of the same non-volatile compounds in a corresponding traditional spirit or wine.

Embodiment 313 is the method of any one of embodiments 309-311, wherein the one or more non-volatile compounds are present in the concentrate in a concentration of at least about 10-fold the concentration of the same non-volatile compounds in a corresponding traditional spirit or wine.

Embodiment 314 is the method of any one of embodiments 309-311, wherein the one or more non-volatile compounds are present in the concentrate in a concentration of at least about 15-fold the concentration of the same non-volatile compounds in a corresponding traditional spirit or wine.

Embodiment 315 is the method of any one of embodiments 309-311, wherein the one or more non-volatile compounds are present in the concentrate in a concentration of at least about 20-fold the concentration of the same non-volatile compounds in a corresponding traditional spirit or wine.

Embodiment 316 is the method of any one of embodiments 309-315, wherein the concentrate comprises five or more non-volatile compounds, wherein at least five of the five or more non-volatile compounds are present in a concentration of at least about 5-fold the concentration of the same non-volatile compounds in a corresponding traditional spirit or wine.

Embodiment 317 is the method of any one of embodiments 309-316, wherein the total amount (in mg/L) of the one or more non-volatile compounds in the concentrate is greater than 5-fold the total amount of the same non-volatile compounds (in mg/L) in a corresponding traditional spirit or wine.

Embodiment 318 is a spirit or wine replica concentrate comprising ethanol, water, and one or more additional VOCs, wherein at least one of the one or more additional VOCs is present in a concentration of at least about 2-fold the concentration of the same VOC in a corresponding traditional spirit or wine.

Embodiment 319 is the spirit or wine replica concentrate of embodiment 318, wherein the one or more additional VOCs comprise at least one VOC that is not present in a corresponding traditional spirit or wine.

Embodiment 320 is the spirit or wine replica concentrate of embodiment 318 or embodiment 319, wherein the one or more additional VOCs do not comprise at least one VOC that is present in a corresponding traditional spirit or wine.

Embodiment 321 is the spirit or wine replica concentrate of any one of embodiments 318-320, wherein the spirit or wine replica concentrate further comprises one or more non-volatile compounds, and wherein the one or more non-volatile compounds comprise at least one non-volatile compound that is not present in a corresponding traditional spirit or wine.

Embodiment 322 is the spirit or wine replica concentrate of any one of embodiments 318-321, wherein the spirit or wine replica concentrate further comprises one or more non-volatile compounds, and wherein the one or more non-volatile compounds do not comprise at least one non-volatile compound that is present in a corresponding traditional spirit or wine.

Embodiment 323 is the spirit or wine replica concentrate of any one of embodiments 318-322, wherein the one or more additional VOCs are present in the concentrate in a concentration of at least about 5-fold the concentration of the same VOCs in a corresponding traditional spirit or wine.

Embodiment 324 is the spirit or wine replica concentrate of any one of embodiments 318-322, wherein the one or more additional VOCs are present in the concentrate in a concentration of at least about 10-fold the concentration of the same VOCs in a corresponding traditional spirit or wine.

Embodiment 325 is the spirit or wine replica concentrate of any one of embodiments 318-322, wherein the one or more additional VOCs are present in the concentrate in a concentration of at least about 15-fold the concentration of the same VOCs in a corresponding traditional spirit or wine.

Embodiment 326 is the spirit or wine replica concentrate of any one of embodiments 318-322, wherein the one or more additional VOCs are present in the concentrate in a concentration of at least about 20-fold the concentration of the same VOCs in a corresponding traditional spirit or wine.

Embodiment 327 is the spirit or wine replica concentrate of any one of embodiments 318-326, wherein the concentrate comprises five or more additional VOCs, wherein at least five of the five or more additional VOCs are present in a concentration of at least about 5-fold the concentration of the same VOCs in a corresponding traditional spirit or wine.

Embodiment 328 is the spirit or wine replica concentrate of any one of embodiments 318-327, wherein the total amount (in mg/L) of the one or more additional VOCs in the concentrate is greater than 5-fold the total amount of the same VOCs (in mg/L) in a corresponding traditional spirit or wine.

Embodiment 329 is a spirit or wine replica concentrate comprising ethanol, water, and one or more non-volatile compounds, wherein at least one of the one or more non-volatile compounds is present in a concentration of at least about 2-fold the concentration of the same non-volatile compound in a corresponding traditional spirit or wine.

Embodiment 330 is the spirit or wine replica concentrate of embodiment 329, wherein the one or more non-volatile compounds comprise at least one non-volatile compound that is not present in a corresponding traditional spirit or wine.

Embodiment 331 is the spirit or wine replica concentrate embodiment 329 or 330, wherein the one or more non-volatile compounds do not comprise at least one non-volatile compound that is present in a corresponding traditional spirit or wine.

Embodiment 332 is the spirit or wine replica concentrate of any one of embodiments 329-331, wherein the spirit or wine replica concentrate further comprises one or more additional VOCs, and wherein the one or more additional VOCs comprise at least one VOC that is not present in a corresponding traditional spirit or wine.

Embodiment 333 is the spirit or wine replica concentrate of any one of embodiments 329-332, wherein the spirit or wine replica concentrate further comprises one or more additional VOCs, and wherein the one or more additional VOCs do not comprise at least one VOC that is present in a corresponding traditional spirit or wine.

Embodiment 334 is the spirit or wine replica concentrate of any one of embodiments 329-333, wherein the one or more non-volatile compounds is present in the concentrate in a concentration of at least about 5-fold the concentration of the same non-volatile compound in a corresponding traditional spirit or wine.

Embodiment 335 is the spirit or wine replica concentrate of any one of embodiments 329-333, wherein the one or more non-volatile compounds is present in the concentrate in a concentration of at least about 10-fold the concentration of the same non-volatile compound in a corresponding traditional spirit or wine.

Embodiment 336 is the spirit or wine replica concentrate of any one of embodiments 329-333, wherein the one or more non-volatile compounds is present in the concentrate in a concentration of at least about 15-fold the concentration of the same non-volatile compound in a corresponding traditional spirit or wine.

Embodiment 337 is the spirit or wine replica concentrate of any one of embodiments 329-333, wherein the one or more non-volatile compounds is present in the concentrate in a concentration of at least about 20-fold the concentration of the same non-volatile compound in a corresponding traditional spirit or wine.

Embodiment 338 is the spirit or wine replica concentrate of any one of embodiments 329-337, wherein the concentrate comprises five or more non-volatile compounds, wherein at least five of the five or more additional non-volatile compounds are present in a concentration of at least about 5-fold the concentration of the same non-volatile compounds in a corresponding traditional spirit or wine.

Embodiment 339 is the spirit or wine replica concentrate of any one of embodiments 329-338, wherein the total amount (in mg/L) of the one or more non-volatile compounds in the concentrate is greater than 5-fold the total amount of the same non-volatile compounds (in mg/L) in a corresponding traditional spirit or wine.

The invention will be further described in the following examples, which do not limit the scope of the invention described in the claims.

### EXAMPLES

### Example 1—Methods for Detecting VOCs and Non-Volatile Compounds

GC-MS/MS was used to assess the amounts of various VOCs in several traditional Moscato wines and whiskeys.

GC-MS/MS Conditions:

All analyses were performed using an Agilent 7890B GC interfaced with a 7000D Triple Quadrupole mass spectrometer, and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco; Bellefonte, Pa.). HS-SPME autosampler conditions were as follows: pre-incubation time of 5 minutes, incubation temperature of 60° C., extraction time of 15 minutes, and desorption time 2 minutes. Post-desorption fiber conditioning time was 30 minutes. For liquid injection experiments, the injection volume was 0.5 μL. Both liquid and SPME injections had a split ratio of 1:20, with a desorption temperature of 250° C. The column was a 30 m×0.25 mm×0.25 Agilent HP-5 ms or DB-WAX (ultra inert). Helium was used as the carrier gas at a constant flow rate of 1 mL/min. The MS ion source temperature and interface temperature were 250° C. The temperature program was as follows: initial temperature 40° C., held for 5 minutes, then increased to 180° C. at a rate of 4° C./min, and then increased to 240° C. at a rate of 45° C./min, and held for 10 minutes, for a total run time of 52 minutes.

Selection of Target Compounds and MRM Method Development:

An outline of the general workflow for GC-MS analyses is as follows. Real samples were first analyzed by HS-SPME-GC/MS in full scan mode (m/z 40-200) to identify potential target compounds. Collected data were analyzed manually using Agilent MassHunter Qualitative Analysis Version B.07.00, or using Agilent MassHunter Unknowns Analysis Version B.08.00. Additional compounds may have been targeted based on literature research. Multiple Reaction Monitoring (MRM) optimization was performed for commercially available standards. First, full scan experiments were repeated with liquid injection (5 mg/L in pure EtOH) to verify retention time and potential precursor ions. Product ion scans were performed using liquid injection and varying collision energies across a range of 5-35 V. Optimized MRM transitions and collision energies were selected, and are displayed in TABLES 1A, 1B, and 1D. A dynamic MRM (dMRM) method was developed for the generation of calibration curves, as described below. Compounds were divided into two methods (A and B, TABLES 1A and 1B respectively) to minimize simultaneous transitions (no greater than 6).

Preparation of Calibration Curves:

All calibration solutions were prepared as 10 mL of 10% EtOH in milliQ water in 20-mL amber vials, with 3 g of salt added to enhance volatility. This concentration of EtOH minimized swelling of the SPME fiber to maximize signal despite the dilution factor. The concentration range was varied by compound, based on the expected range in real samples.

Quantification in Real Samples:

All samples (reference samples and replica samples) were prepared as 10 mL in 20-mL amber vials with 3 g of salt, and were diluted in milliQ water to achieve a final concentration of 10% EtOH. Concentrations were later corrected to account for the dilution factor of the sample. All data were collected in triplicate, and were analyzed using Agilent Quantitative Analysis (for QQQ). Values reported as not detected (ND or NF, zero) may be considered to be below the limits of detection (LODs) listed in TABLES 1A, 1B, 1C, and 1D. LODs were approximated based on S/N ratios as generated by the MassHunter software.

Various reference alcoholic beverage samples were assayed by GC-MS, and the levels of VOCs therein are shown in TABLES 2A, 2B, 3A, 3B, 3C, 17A, 17B, 17C, 17D, 17E, and 17F.

TABLE 1A
Method A Transitions and Figures of Merit

| Compound Method | | | | Qualifier 1 Method | | | |
|---|---|---|---|---|---|---|---|
| | | | Collision | | Collision | Calibration | LOD |
| Name | RT (min) | Transition | Energy | Transition | Energy | Range (mg/L) | (mg/L) |
| propanol | 1.96 | 59.0 → 31.0 | 10 | 42.0 → 39.0 | 35 | 1-200 | 0.5 |
| ethyl acetate | 2.30 | 61.0 → 43.0 | 15 | 45.0 → 43.0 | 35 | 1-200 | 1 |
| isobutanol | 2.40 | 43.0 → 39.0 | 35 | 74.0 → 41.0 | 25 | 1-200 | 0.5 |
| isovaleraldehyde | 2.68 | 44.0 → 43.0 | 10 | 41.0 → 39.0 | 10 | 0.001-0.05 | 0.001 |
| butanol | 2.79 | 56.0 → 41.0 | 10 | 56.0 → 39.0 | 15 | 0.02-1 | 0.01 |
| 1,1-diethoxyethane | 3.91 | 73.0 → 45.0 | 10 | 103.0 → 47.0 | 10 | 0.05-2.5 | N/A |
| isoamyl alcohol | 4.03 | 70.0 → 55.0 | 15 | 55.0 → 39.0 | 15 | 15-750 | N/A |
| 2-methyl-1-butanol | 4.04 | 70.0 → 41.0 | 25 | 55.0 → 40.0 | 25 | 1-200 | 0.5 |
| ethyl isobutyrate | 4.66 | 43.0 → 27.0 | 20 | 71.0 → 43.0 | 10 | 0.001-0.05 | 0.0005 |
| isobutyl acetate | 5.11 | 73.0 → 43.0 | 5 | 56.0 → 41.0 | 15 | 0.001-0.05 | 0.001 |
| ethyl butyrate | 6.05 | 71.0 → 43.0 | 10 | 88.0 → 61.0 | 10 | 0.001-.2 | 0.0001 |
| ethyl lactate | 6.57 | 45.0 → 29.0 | 15 | 45.0 → 27.0 | 15 | 0.5-25 | 0.5 |
| ethyl-2-methylbutyrate | 7.97 | 102.0 → 74.0 | 10 | 85.0 → 57.0 | 5 | 0.001-0.05 | 0.0005 |
| ethyl isovalerate | 8.12 | 70.0 → 55.0 | 5 | 88.0 → 61.0 | 5 | 0.001-0.2 | 0.0001 |
| isoamyl acetate | 8.77 | 70.0 → 55.0 | 10 | 55.0 → 29.0 | 10 | 0.02-1 | 0.001 |
| hexanol | 9.09 | 69.0 → 41.0 | 15 | 56.0 → 41.0 | 15 | 0.001-0.05 | 0.001 |
| benzaldehyde | 12.50 | 105.0 → 51.0 | 35 | 106.0 → 77.0 | 35 | 0.001-0.05 | 0.001 |
| (—)-beta-pinene | 13.12 | 93.0 → 77.0 | 15 | 93.0 → 51.0 | 25 | 0.001-0.01 | 0.0001 |
| ethyl hexanoate | 14.31 | 88.0 → 61.0 | 5 | 99.0 → 43.0 | 5 | 0.005-1 | 0.001 |
| linalool oxide | 17.18 | 59.0 → 31.0 | 18 | 94.0 → 79.0 | 10 | 0.001-0.2 | 0.0005 |
| guaiacol | 17.85 | 109.0 → 81.0 | 15 | 124.0 → 109.0 | 15 | 0.001-0.2 | 0.0005 |
| linalool | 18.29 | 71.0 → 43.0 | 15 | 55.0 → 39.0 | 25 | 0.001-0.2 | 0.0001 |
| 2-phenylethanol | 18.77 | 122.0 → 91.0 | 15 | 92.0 → 65.0 | 25 | 0.2-10 | 0.05 |
| myrtenol | 18.77 | 79.0 → 51.0 | 35 | 91.0 → 65.0 | 35 | 0.001-0.05 | 0.001 |
| alpha-terpineol | 21.69 | 93.0 → 51.0 | 25 | 121.0 → 77.0 | 25 | 0.001-0.05 | 0.0001 |
| ethyl octanoate | 22.01 | 88.0 → 43.0 | 25 | 101.0 → 55.0 | 25 | 0.05-2.5 | 0.001 |
| citronellol | 23.10 | 69.0 → 41.0 | 10 | 41.0 → 39.0 | 10 | 0.001-0.2 | 0.0001 |
| linalyl acetate | 24.07 | 93.0 → 77.0 | 15 | 121.0 → 105.0 | 10 | 0.001-0.2 | 0.0001 |
| 4-ethyl guaiacol | 24.86 | 152.0 → 94.0 | 35 | 137.0 → 66.0 | 35 | 0.01-1 | 0.005 |
| ethyl nonanoate | 25.48 | 88.0 → 61.0 | 10 | 101.0 → 73.0 | 10 | 0.001-0.05 | 0.0001 |
| cis-whiskey lactone | 26.37 | 99.0 → 43.0 | 10 | 99.0 → 41.0 | 20 | 0.01-0.1 | 0.005 |
| eugenol | 27.51 | 164.0 →149.0 | 10 | 164.0 → 104.0 | 15 | 0.05-2.5 | 0.005 |
| damascenone | 28.41 | 69.0 → 41.0 | 20 | 121.0 → 77.0 | 20 | 0.001-0.05 | 0.0005 |
| ethyl decanoate | 28.75 | 88.0 → 43.0 | 20 | 61.0 → 43.0 | 20 | 0.05-2.5 | 0.005 |
| ethyl cinnamate | 30.93 | 131.0 → 103.0 | 10 | 131.0 → 77.0 | 25 | 0.0004-0.004 | 0.0001 |
| beta-ionone | 31.59 | 177.0 → 147.0 | 35 | 135.0 → 43.0 | 35 | 0.001-0.05 | 0.0001 |
| ethyl laurate | 34.75 | 88.0 → 61.0 | 15 | 101.0 → 55.0 | 25 | 0.001-0.05 | 0.0001 |

TABLE 1B
Method B Transitions and Figures of Merit

| Compound Method | | | | Qualifier 1 Method | | | |
|---|---|---|---|---|---|---|---|
| | | | Collision | | Collision | Calibration | LOD |
| Name | RT (min) | Transition | Energy | Transition | Energy | Range (mg/L) | (mg/L) |
| 2-methylbutyraldehyde | 2.79 | 57.0 → 39.0 | 25 | 58.0 → 31.0 | 25 | 0.005-0.05 | 0.001 |
| 2,3-pentadione | 3.20 | 100.0 → 57.0 | 5 | 57.0 → 42.0 | 30 | 0.005-0.05 | 0.001 |
| ethyl propionate | 3.52 | 102.0 → 46.0 | 35 | 75.0 → 57.0 | 35 | 0.005-0.05 | 0.005 |
| butyl formate | 3.75 | 73.0 → 45.0 | 15 | 56.0 → 41.0 | 15 | 0.005-0.05 | N/A |
| amyl alcohol | 4.92 | 70.0 → 55.0 | 5 | 55.0 → 53.0 | 35 | 0.005-0.05 | 0.005 |
| butyl acetate | 6.53 | 56.0 → 41.0 | 15 | 73.0 → 43.0 | 5 | 0.005-0.05 | N/A |
| furfural | 7.30 | 95.0 → 53.0 | 35 | 96.0 → 95.0 | 25 | 0.005-0.05 | 0.005 |
| 3-methyl-1-pentanol | 7.78 | 69.0 → 41.0 | 20 | 56.0 → 39.0 | 20 | 0.005-0.05 | 0.001 |
| ethyl valerate | 10.10 | 57.0 → 41.0 | 10 | 88.0 → 61.0 | 10 | 0.005-0.05 | 0.001 |
| 1-octen-3-ol | 13.42 | 57.0 → 31.0 | 25 | 72.0 → 43.0 | 15 | 0.005-0.05 | 0.001 |
| 3-(methylthio)-1-propanol | 13.50 | 106.0 → 58.0 | 10 | 88.0 → 73.0 | 10 | 0.005-0.05 | 0.005 |
| p-cymene | 15.20 | 134.0 → 91.0 | 35 | 119.0 → 77.0 | 35 | 0.005-0.05 | 0.001 |
| limonene | 15.34 | 93.0 → 77.0 | 15 | 68.0 → 53.0 | 15 | 0.005-0.05 | 0.001 |
| butyl isovalerate | 16.22 | 85.0 → 41.0 | 15 | 57.0 → 41.0 | 15 | 0.005-0.05 | 0.0005 |
| gamma-terpinene | 16.62 | 93.0 → 51.0 | 35 | 136.0 → 77.0 | 25 | 0.005-0.05 | 0.0005 |
| p-cresol | 17.39 | 108.0 → 107.0 | 0 | 107.0 → 77.0 | 0 | 0.005-0.05 | 0.001 |
| propyl hexanoate | 17.66 | 99.0 → 43.0 | 10 | 117.0 → 43.0 | 15 | 0.005-0.05 | 0.005 |
| 2-nonanone | 18.00 | 58.0 → 43.0 | 15 | 71.0 → 43.0 | 15 | 0.005-0.05 | 0.0001 |
| amyl butyrate | 18.10 | 71.0 → 43.0 | 10 | 89.0 → 43.0 | 15 | 0.005-0.05 | 0.0001 |
| ethyl heptanoate | 18.36 | 113.0 → 57.0 | 10 | 88.0 → 61.0 | 15 | 0.005-0.05 | N/A |
| nonanal | 18.47 | 98.0 → 56.0 | 5 | 57.0 → 39.0 | 15 | 0.005-0.05 | 0.0005 |
| 4-ethylphenol | 20.86 | 108.0 → 78.0 | 25 | 121.0 → 77.0 | 25 | 0.005-0.05 | 0.005 |
| isoamyl hexanoate | 23.57 | 70.0 → 55.0 | 10 | 99.0 → 43.0 | 10 | 0.005-0.05 | N/A |
| ethyl phenyl acetate | 23.69 | 91.0 → 65.0 | 35 | 164.0 → 91.0 | 10 | 0.005-0.05 | 0.0001 |
| phenylethyl acetate | 24.10 | 91.0 → 65.0 | 35 | 104.0 → 78.0 | 25 | 0.005-0.05 | 0.005 |
| cinnamaldehyde | 24.54 | 131.0 → 77.0 | 35 | 103.0 → 77.0 | 25 | 0.005-0.05 | 0.001 |
| 1-decanol | 24.63 | 70.0 → 55.0 | 15 | 55.0 → 51.0 | 40 | 0.005-0.05 | 0.0005 |
| gamma-nonalactone | 27.66 | 85.0 → 57.0 | 25 | 114.0 → 70.0 | 25 | 0.005-0.05 | 0.005 |
| damascone | 29.37 | 123.0 → 41.0 | 25 | 69.0 → 41.0 | 25 | 0.005-0.05 | 0.0005 |
| gamma-decalactone | 31.00 | 99.0 → 43.0 | 25 | 71.0 → 41.0 | 25 | 0.005-0.05 | 0.005 |
| ethyl myristate | 40.20 | 101.0 → 73.0 | 5 | 88.0 → 61.0 | 5 | 0.005-0.05 | 0.0005 |
| ethyl palmitate | 42.26 | 101.0 → 73.0 | 5 | 88.0 → 61.0 | 5 | 0.005-0.05 | 0.0005 |

TABLE 1C
Additional LODs in GCMS assays

| Compound | LOD (mg/L) |
|---|---|
| (—)cis-rose oxide | <0.001 |
| 1-octanol | <0.0005 |
| 2-heptanone | <0.0025 |
| 2-methoxy-4-propylphenol | <0.0001 |
| 2-methylbutyl acetate | <0.01 |
| 2-methylbutyl isovalerate | <0.005 |
| 2-nonanol | 0.0025 |
| 2-undecanone | <0.0001 |
| 3-carene | <0.0025 |
| 4-carvomenthenol | <0.0025 |
| acetophenone | <0.0025 |
| alpha ionone | <0.0005 |
| a-pinene | <0.005 |
| benzyl acetate | <0.0025 |
| butyric acid | 0.01 |
| carvone | <0.00025 |
| cis-3-hexen-1-ol | <0.02 |
| cis-3-hexenyl acetate | <0.00025 |
| decanoic acid | <0.01 |
| delta-decalactone | <1 |
| diethyl malate | 0.0025 (on wax); 0.25 (on DB5 |
| | column) |
| diethyl succinate | <1 |
| ethyl 3-hydroxyhexanoate | <0.005 |
| ethyl benzoate | <0.0005 |
| ethyl levulinate | <0.0025 |
| ethyl salicylate | <0.001 |
| ethyl trans-2-butenoate | <0.0025 |
| ethyl trans-3-hexenoate | <0.02 |
| ethyl undecanoate | <0.0005 |
| ethyl(methylthio) acetate | <0.0025 |
| eucalyptol | <0.00025 |
| farnesol | <0.0025 |
| geraniol | <0.005 |
| geranyl acetone | <0.005 |
| heptyl acetate | <0.0025 |
| isoamyl isobutyrate | <0.0025 |
| isoamyl isovalerate | <0.0025 |
| isoamyl octanoate | <0.0005 |
| isobutyl isobutyrate | <0.0025 |
| isobutyraldehyde | 0.0025 |
| Isobutyric Acid | 0.05 |
| methyl acetate | <0.5 |
| methyl hexanoate | <0.0025 |
| methyl laurate | <0.0005 |
| Methyl Octanoate | <0.0005 |
| methyl salicylate | <0.0025 |
| Myrcene | <0.0025 |
| octanoic acid | <0.1 |
| p-anisaldehyde | 0.00025 |
| Phenethyl Butyrate | <0.0001 |
| phenethyl formate | 0.005 |
| phenethyl octanoate | <0.0005 |
| phenethyl propionate | <0.0001 |
| propyl acetate | <0.0025 |
| salicylaldehyde | <0.0025 |
| vanillyl ethyl ether | 0.0025 |

TABLE 1D
Additional LODs in GCMS assays

| | | | | | | Calibration | LOD |
|---|---|---|---|---|---|---|---|
| Compound | RT | Quantifier | CE | Qualifier | CE | Range (mg/L) | (mg/L) |
| propanal | 4.834 | 58 → 57 | 5 | 57 → 29 | 10 | 0.05-0.2 | 0.05 |
| myrcene | 8.804 | 69.0 → 41.0 | 10 | 93.0 → 77.0 | 25 | 0.05-0.2 | 0.0005 |
| heptyl acetate | 11.39 | 56.0 → 41.0 | 15 | 70.0 → 55.0 | 15 | 0.05-0.2 | 0.0002 |
| methyl octanoate | 11.509 | 74.0 → 43.0 | 15 | 87.0 → 55.0 | 15 | 0.05-0.2 | 0.00005 |
| isobutyric acid | 13.503 | 88 → 73 | 5 | 73 → 55 | 20 | 0.05-0.2 | 0.1 |
| phenethyl propionate | 17.094 | 104.0 → 78.0 | 25 | 57.0 → 42.0 | 25 | 0.01-0.04 | 0.0001 |
| phenethyl octanoate | 22.009 | 104.0 → 78.0 | 15 | 127.0 → 57.0 | 5 | 0.05-0.2 | 0.00005 |
| isobutyraldehyde | 4.911 | 72.0 → 43.0 | 5 | 72.0 → 57.0 | 5 | 0.05-0.2 | 0.001 |
| eucalyptol | 9.424 | 108.0 → 77.0 | 15 | 81.0 → 53.0 | 35 | 0.05-0.2 | 0.005 |
| isoamyl isobutyrate | 10.095 | 70.0 → 55.0 | 10 | 115.0 → 71.0 | 5 | 0.05-0.2 | 0.005 |
| acetoin | 10.468 | 88 → 45 | 5 | 45 → 29.27 | 20 | 0.05-0.2 | 0.05 |
| methyl laurate | 16.12 | 74.0 → 43.0 | 15 | 87.0 → 55.0 | 15 | 0.05-0.2 | 0.0001 |
| phenethyl butyrate | 17.85 | 104.0 → 78.0 | 25 | 71.0 → 41.0 | 10 | 0.01-0.04 | 0.0001 |
| p-anisaldehyde | 18.566 | 135 → 77 | 25 | 77 → 51 | 25 | 0.05-0.2 | 0.01 |
| methyl acetate | 5.072 | 74.0 → 43.0 | 5 | 74.0 → 59.0 | 5 | 0.05-0.2 | 0.005 |
| propyl acetate | 6.385 | 73.0 → 43.0 | 5 | 73.0 → 55.0 | 15 | 0.05-0.2 | 0.001 |
| isobutyl isobutyrate | 8.02 | 71.0 → 43.0 | 10 | 89.0 → 43.0 | 15 | 0.05-0.2 | 0.0005 |
| methyl hexanoate | 9.136 | 74.0 → 43.0 | 15 | 87.0 → 55.0 | 15 | 0.05-0.2 | 0.0004 |
| methyl decanoate | 13.96 | 74.0 → 43.0 | 25 | 87.0 → 55.0 | 25 | 0.05-0.2 | 0.00005 |
| isoamyl octanoate | 14.655 | 70.0 → 55.0 | 15 | 127.0 → 57.0 | 5 | 0.005-0.02 | 0.00005 |
| D-carvone | 15.68 | 82 → 54 | 15 | 54 → 39 | 15 | 0.005-0.02 | 0.0001 |
| methyl salicylate | 16.181 | 92.0 → 63.0 | 25 | 120.0 → 64.0 | 15 | 0.005-0.02 | 0.0005 |
| maltol | 17.956 | 126 → 71 | 20 | 71 → 43 | 10 | 0.05-0.2 | 0.05 |
| Butyraldehyde | 5.441 | 72 → 57 | 10 | 72 → 29 | 20 | 0.05-0.2 | 0.01 |
| isoamyl isovalerate | 10.454 | 85.0 → 57.0 | 5 | 115.0 → 73.0 | 10 | 0.05-0.2 | <0.00001 |
| salicylaldehyde | 15.112 | 122 → 121 | 15 | 121 → 65 | 15 | 0.05-0.2 | 0.005 |
| ethyl undecanoate | 15.53 | 101.0 → 73.0 | 5 | 88.0 → 61.0 | 5 | 0.05-0.2 | 0.0001 |
| geraniol | 16.504 | 69.0 → 41.0 | 30 | 93.0 → 51.0 | 15 | 0.05-0.2 | 0.1 |
| vanillyl ethyl ether Results | 21.382 | 137.0 → 94.0 | 20 | 182.0 → 138.0 | 5 | 0.05-0.2 | 0.001 |
| phenethyl formate | 16.094 | 104.0 → 78.0 | 15 | 91.0 → 65.0 | 15 | 0.1-0.4 | 0.1 |
| hexanoic acid | 16.408 | 73 → 55 | 25 | 60 → 42 | 25 | 0.5-2 | 0.01 |
| farnesol | 21.08 | 93.0 → 77.0 | 15 | 107.0 → 91.0 | 15 | 0.1-0.4 | 0.01 |
| linalyl butyrate | 14.887 | 93 → 77 | 10 | 80 → 79 | 15 | 0.11-0.44 | 0.0001 |
| nerol | 15.932 | 93 → 51 | 25 | 69 → 53 | 25 | 0.055-0.22 | 0.05 |
| acetaldehyde, diethyl acetal | 5.43 | 73 → 45 | 10 | 103 → 47 | 10 | n/a | |
| 2-isopropyl-3-methoxypyrazine | n/a | 107 → 51 | 35 | 77 → 51 | 25 | NDR | |
| 3,7-dimethyl-6-octanoic acid | n/a | 69 → 41 | 15 | 95 → 55 | 25 | NDR | |
| methyl dihydrojasmonate | n/a | 83 → 55 | 40 | 153 → 83 | 25 | NDR | |
| phenethyl isobutyrate | 17.03 | 105 → 79 | 15 | 104 → 78 | 15 | NDR | |
| furfuryl mercaptan | 12.234 | 114 → 53 | 35 | 81 → 53 | 35 | NDR | |
| 3-methylthio hexyl acetate | 16.094 | 115 → 81 | 5 | 190 → 115 | 10 | NDR | |
| *ug/L | | | | | | | |
| IBMP (3-Isobutyl-2- | 13.3 | 124 → 94 | 10 | 124 → 95.81 | 20 | NDR | |
| methoxypyrazine) | | | | | | | |
| dimethyl anthranilate | 18.988 | 165 → 105 | 15 | 105 → 104 | 10 | NDR | |
| ethyl-trans-3-hexenoate | 10.51 | 69.0 → 41.0 | 10 | 42.0 → 39.0 | 25 | NDR | |
| octyl acetate | 12.546 | 70 → 55 | 15 | 83 → 55 | 15 | NDR | |
| Amyl formate | 8.08 | 73 → 55 | 15 | 45 → 27 | 15 | NDR | |
| hexyl hexanoate | 14.101 | 99 → 43 | 15 | 117 → 43 | 15 | NDR | |
| Jasmine lactone | 20.421,20.85 | 99 → 77 | 5 | 71 → 43 | 5 | NDR | |
| trans-2-pentenal | n/a | 83 → 55 | 35 | 84 → 55 | 15 | NDR | |
| hexanal | n/a | 56 → 39 | 15 | 57 → 31 | 25 | NDR | |
| 2-(methylthio)ethanol | n/a | 92 → 61 | 5 | 61 → 45 | 35 | NDR | |
| trans-2-hexen-1-ol | n/a | 57 → 31 | 25 | 67 → 41 | 35 | NDR | |
| ethyl-2-mercaptopropionate | n/a | 61 → 46 | 35 | 88 → 59 | 15 | NDR | |
| trans-2-heptenal | n/a | 83 → 55 | 30 | 70 → 41 | 15 | NDR | |
| 2,6-dimethyl-5-heptenal | n/a | 82 → 67 | 15 | 67 → 41 | 0 | NDR | |
| 3-nonen-2-one | n/a | 55 → 39 | 35 | 125 → 55 | 15 | NDR | |
| isoborneol | n/a | 95 → 55 | 25 | 110 → 95 | 5 | NDR | |
| linalyl formate | n/a | 93 → 77 | 15 | 121 → 77 | 20 | NDR | |
| furfuryl ether | n/a | 82 → 53 | 25 | 81 → 53 | 35 | NDR | |
| citronellyl acetate | n/a | 69 → 41 | 15 | 81 → 41 | 35 | NDR | |
| geranyl acetate | n/a | 69 → 41 | 10 | 93 → 77 | 10 | NDR | |
| ethyl anthranilate | n/a | 119 → 64 | 25 | 92 → 63 | 25 | NDR | |
| methyl vanillate | n/a | 182 → 122 | 15 | 151 → 65 | 15 | NDR | |
| DL-3-methyl-2-butanol | 7.949 | 73 → 45 | 10 | 45 → 27 | 15 | 0.005-0.2 | 0.005 |
| 1,4-cineole | 8.933 | 125 → 43 | 10 | 111 → 43 | 10 | 0.005-0.2 | 0.0001 |
| 2-pentylfuran | 9.483 | 138 → 81 | 10 | 81 → 53 | 10 | 0.005-0.2 | 0.00001 |
| 2-heptanol | 10.584 | 83 → 55 | 5 | 70 → 55 | 10 | 0.005-0.2 | 0.001 |
| tetrahydrolinalool | 11.956 | 73 → 55 | 10 | 69 → 41 | 10 | 0.005-0.2 | 0.005 |
| methional | 12.42 | 104.0 → 48.0 | 15 | 104.0 → 76.0 | 15 | 0.05-0.2 | 0.05 |
| decanal | 12.954 | 82 → 67 | 15 | 57 → 41 | 25 | 0.005-0.2 | 0.001 |
| Cis-5-octen-1-ol | 14.102 | 95→ 67 | 10 | 81 → 79 | 10 | 0.05-0.2 | 0.05 |
| 2-acetyl-1-methylpyrrole | 14.792 | 123 → 108 | 10 | 108 → 53 | 20 | 0.005-0.2 | 0.001 |
| cis-6-nonen-1-ol | 15.213 | 82 → 67 | 10 | 67 → 41 | 15 | 0.005-0.2 | 0.001 |
| gamma-heptalactone | 16.414 | 85 → 29 | 10 | 85 → 57 | 5 | 0.005-0.2 | 0.005 |
| gamma-octalactone | 17.5 | 100 → 43 | 15 | 85 → 29 | 15 | 0.005-0.2 | 0.001 |
| methyl-2-pyrrolyl ketone | 17.91 | 109 → 94 | 10 | 94 → 66 | 10 | 0.005-0.2 | 0.005 |
| nerolidol | 18.33 | 93 → 77 | 10 | 107 → 91 | 10 | 0.005-0.2 | 0.001 |
| thymol | 19.581 | 150 → 135 | 10 | 135 → 91 | 15 | 0.005-0.2 | 0.0001 |
| omega-pentadecalactone | 21.102 | 96 → 81 | 5 | 83 → 55 | 5 | 0.005-0.2 | 0.001 |
| gamma-dodecalactone | 22.07 | 43 → 41 | 5 | 43 → 27 | 10 | 0.005-0.2 | 0.005 |
| Methyl β-naphthyl ketone | 24.612 | 170 → 155 | 10 | 155 → 127 | 10 | 0.005-0.2 | 0.001 |
| Valeraldehyde | 6.5 | 58 → 57 | 10 | 57 → 29 | 5 | 0.005-0.2 | 0.005 |
| 2-isobutyl-4-methyl-1,3- | 8.668 | 87 → 59 | 5 | 87 → 31 | 15 | 0.005-0.2 | 0.005 |
| dioxolane | | | | | | | |
| hexyl acetate | 10.09 | 69.0 → 41.0 | 15 | 84.0 → 69.0 | 5 | 0.05-0.2 | 0.0005 |
| 2-ethyl-3-methylpyrazine | 11.904 | 122 → 121 | 10 | 121 → 93 | 15 | 0.005-0.2 | 0.001 |
| p,a-dimethylstyrene | 12.222 | 117 → 115 | 10 | 132 → 117 | 15 | 0.005-0.2 | 0.00001 |
| allyl heptanoate | 12.53 | 113 → 43 | 5 | 100 → 55 | 5 | 0.005-0.2 | 0.00001 |
| 4,5,6,7-tetrahydro-3,6- | 12.87 | 150 → 108 | 10 | 91 → 65 | 15 | 0.005-0.2 | 0.00001 |
| dimethylbenzofuran | | | | | | | |
| D-camphor | 13.445 | 152 → 108 | 5 | 108 → 93 | 5 | 0.005-0.2 | 0.001 |
| b-caryophellene | 14.285 | 133 → 105 | 15 | 93 → 77 | 15 | 0.005-0.2 | 0.0001 |
| phenylacetaldehyde | 14.66 | 120 → 91 | 10 | 91 → 65 | 15 | 0.005-0.2 | 0.001 |
| gamma-hexalactone | 15.389 | 85 → 29 | 15 | 86 → 29 | 15 | 0.005-0.2 | 0.001 |
| citral | 15.513 | 84 → 83 | 5 | 69 → 41 | 10 | 0.005-0.2 | 0.001 |
| cuminaldehyde | 16.182 | 148 → 119 | 10 | 148 → 133 | 10 | 0.005-0.2 | 0.0001 |
| benzyl alcohol | 16.9604 | 108 → 79 | 15 | 79 → 51 | 25 | 0.005-0.2 | 0.005 |
| 2-methoxy-4-methylphenol | 17.709 | 138 → 123 | 15 | 138 → 95 | 15 | 0.005-0.2 | 0.00001 |
| 2,4,6-trimethylphenol (mesitol) | 18.019 | 136 → 121 | 15 | ? | 0 | 0.005-0.2 | 0.00005 |
| 5-methyl-2-phenyl-2-hexenal | 18.836 | 117 → 115 | 15 | 104 → 78 | 10 | 0.005-0.2 | 0.001 |
| phenethyl tiglate | 19.971 | 104 → 78 | 15 | 83 → 55 | 5 | 0.005-0.2 | 0.00005 |
| gamma-undecalactone | 20.761 | 55 → 29 | 10 | 55 → 27 | 20 | 0.05-0.2 | 0.01 |
| Hexadecanol | 21.567 | 97 → 55 | 5 | 83 → 55 | 10 | 0.005-0.2 | 0.001 |
| trans-2-hexen-1-al | 9.495 | 83 → 55 | 5 | 69 → 41 | 5 | 0.03-0.13 | 0.03 |
| octanal | 10.34 | 84 → 55 | 10 | 84 → 69 | 5 | 0.0028-0.112 | 0.002 |
| 2-isopropyl-4-methyl thiazole | 11.183 | 141 → 126 | 10 | 126 → 73 | 10 | 0.005-0.2 | 0.001 |
| 4-mercapto-4-methyl-2- | 11.552 | 132 → 89 | 5 | 99 → 43 | 5 | 0.0005-0.002 | 0.0005 |
| pentanone | | | | | | | |
| 5-methyl furfural | 13.79 | 110 → 109 | 10 | 109 → 53 | 10 | 0.005-0.2 | 0.001 |
| methionyl acetate (3-methylthio- | 14.323 | 148 → 88 | 5 | 88 → 73 | 5 | 0.005-0.2 | 0.001 |
| propylacetate) | | | | | | | |
| furfuryl thioacetate | 15.868 | 156 → 81 | 15 | 81 → 53 | 15 | 0.005-0.2 | 0.001 |
| 3-phenylpropanal | 16.075 | 134 → 92 | 10 | 91 → 65 | 15 | 0.005-0.2 | 0.001 |
| Methyl cyclopentenolone | 16.45 | 112 → 84 | 5 | 112 → 56 | 10 | 0.002-0.08 | 0.005 |
| Methyl cinnamate | 18.814 | 103 → 77 | 10 | 131 → 103 | 10 | 0.0004-0.015 | 0.0001 |
| carvacrol | 19.778 | 150 → 135 | 10 | 135 → 91 | 10 | 0.0038-0.153 | 0.001 |
| methyl anthranilate | 20.42 | 151 → 119 | 10 | 119 → 92 | 5 | 0.005-0.2 | 0.001 |
| 5-ethyl-3-hydroxy-4-methyl- | 20.566 | 142 → 97 | 5 | 97 → 69 | 5 | 0.05-0.2 | 0.001 |
| 2(5H)-furanone (maple | | | | | | | |
| furanone) | | | | | | | |
| isoeugenol | 21.401 | 164 → 104 | 15 | 164 → 149 | 10 | 0.005-0.2 | 0.001 |
| indole | 22.79 | 117 → 90 | 10 | 90 → 89 | 10 | 0.0009-0.034 | 0.0001 |
| benzyl benzoate | 25.85 | 105 → 77 | 15 | 91 → 65 | 15 | 0.005-0.2 | 0.0001 |
| 1-para-menthene-8-thiol | 9.173 | 68 → 67 | 5 | 93 → 77 | 10 | n/a | 1 |
| propyl butyrate | 8.131 | 89 → 43 | 10 | 71 → 43 | 5 | 0.005-0.2 | 0.001 |
| hexyl isobutyrate | 10.874 | 89 → 43 | 5 | 71 → 43 | 10 | 0.005-0.2 | 0.00005 |
| d-fenchone | 11.852 | 69 → 41 | 5 | 81 → 41 | 15 | 0.005-0.2 | 0.005 |
| cis-3-hexenyl butyrate | 12.35 | 82 → 67 | 5 | 71 → 43 | 5 | 0.005-0.2 | 0.001 |
| 2-methoxy-3-(1-methylpropyl) | 12.898 | 124 → 94 | 10 | 138 → 123 | 10 | 0.005-0.2 | 0.001 |
| pyrazine | | | | | | | |
| cis-3-hexenyl valerate | 13.493 | 85 → 57 | 5 | 82 → 67 | 10 | 0.005-0.2 | 0.0001 |
| L-menthyl acetate | 13.654 | 138 → 95 | 5 | 123 → 81 | 5 | 0.005-0.2 | 0.00001 |
| methyl benzoate | 14.351 | 105 → 77 | 5 | 136 → 105 | 5 | 0.0062-0.246 | 0.05 |
| valencene | 15.527 | 161 → 105 | 15 | 189 → 133 | 10 | 0.005-0.2 | 0.001 |
| Perillaldehyde | 16.2 | 122 → 107 | 5 | 107 → 79 | 5 | 0.005-0.2 | 0.0001 |
| ethyl 2-trans-4-cis-decadienoate | 16.472 | 125 → 97 | 10 | 97 → 69 | 10 | 0.0042-0.1660 | 0.001 |
| Phenethyl 2-methylbutyrate | 17.846 | 107 → 78 | 15 | 105 → 79 | 15 | 0.005-0.2 | 0.00005 |
| isoamyl phenylacetate | 18.072 | 136 → 91 | 10 | 136 → 92 | 5 | 0.005-0.2 | 0.00001 |
| anisyl acetate | 19.381 | 180 → 138 | 5 | 180 → 120 | 10 | 0.006-0.24 | 0.0005 |
| isoamyl cinnamate | 21.986 | 131 → 103 | 10 | 148 → 147 | 5 | 0.005-0.2 | 0.0001 |
| vanillyl butyl ether | 23.499 | 137 → 94 | 15 | 138 → 123 | 5 | 0.005-0.2 | 0.001 |
| isobutyl propionate | 7.619 | 57 → 29 | 5 | 56 → 41 | 10 | 0.0045-0.179 | 0.0045 |
| 2,3-hexanedione | 8.112 | 114 → 71 | 5 | 71 → 43 | 5 | 0.005-0.2 | 0.005 |
| propyl isovalerate | 8.499 | 103 → 43 | 10 | 85 → 57 | 5 | 0.005-0.2 | 0.0005 |
| isobutyl butyrate | 8.555 | 71 → 43 | 5 | 89 → 43 | 15 | 0.0042-0.168 | 0.001 |
| hexyl formate | 9.362 | 84 → 55 | 10 | 69 → 41 | 5 | 0.005-0.2 | 0.005 |
| 3-heptyl acetate | 9.601 | 101 → 43 | 10 | 129 → 43 | 10 | 0.005-0.2 | 0.0005 |
| Terpinolene | 10.238 | 121 → 93 | 5 | 136 → 121 | 10 | 0.005-0.2 | 0.0005 |
| 2-octanone | 10.321 | 136 → 121 | 10 | 121 → 93 | 5 | 0.005-0.2 | 0.005 |
| hexyl propionate | 10.823 | 84 → 69 | 5 | 75 → 57 | 10 | 0.005-0.2 | 0.001 |
| 6-methyl-5-hepten-2-one | 10.865 | 108 → 93 | 5 | 111 → 43 | 15 | 0.005-0.2 | 0.0005 |
| allyl hexanoate | 11.197 | 99 → 71 | 5 | 84 → 69 | 5 | 0.005-0.2 | 0.0001 |
| hexyl butyrate | 11.773 | 71 → 43 | 5 | 89 → 43 | 10 | 0.005-0.2 | 0.0005 |
| hexyl 3-methylbutanoate | 12.128 | 103 → 43 | 15 | 85 → 57 | 5 | 0.005-0.2 | 0.0001 |
| benzyl formate | 14.955 | 136 → 108 | 5 | 90 → 89 | 10 | 0.005-0.2 | 0.005 |
| butyl butyryllactate | 15.407 | 71 → 43 | 5 | 71 → 41 | 15 | 0.005-0.2 | 0.0001 |
| methionyl butyrate | 15.923 | 88 → 73 | 5 | 73 → 45 | 10 | 0.005-0.2 | 0.0001 |
| benzyl propionate | 16.052 | 164 → 108 | 5 | 108 → 79 | 15 | 0.005-0.2 | 0.0001 |
| geranyl propionate | 16.246 | 93 → 77 | 15 | 69 → 41 | 10 | 0.005-0.2 | 0.0001 |
| benzyl butyrate | 16.822 | 108 → 79 | 5 | 91 → 65 | 15 | 0.005-0.2 | 0.0001 |
| geranyl butyrate | 16.979 | 93 → 77 | 10 | 69 → 41 | 10 | 0.005-0.2 | 0.0001 |
| anisyl alcohol | 20.608 | 138 → 137 | 10 | 138 → 109 | 5 | 0.005-0.2 | 0.0005 |
| anisyl butyrate | 20.801 | 121 → 77 | 15 | 138 → 109 | 5 | 0.005-0.2 | 0.0005 |
| dihydrocoumarin | 20.995 | 148 → 120 | 10 | 120 → 91 | 15 | 0.005-0.2 | 0.001 |
| delta-dodecalactone | 22.632 | 99 → 71 | 5 | 99 → 43 | 10 | 0.005-0.2 | 0.001 |
| 2-methoxycinnamaldehyde | 22.756 | 162 → 131 | 5 | n/a | n/a | 0.002-0.074 | 0.001 |
| 3-mercaptohexylacetate | 15.4 | 116 → 55 | 25 | 101 → 59 | 25 | 0.01-0.04 | 0.001 |
| Nonanoic acid | 19.346 | 73 → 55 | 15 | 60 → 42 | 15 | 0.05-0.2 | 0.01 |
| isovaleric acid | 14.616 | 87 → 41 | 15 | 60 → 42 | 25 | 0.05-0.2 | 0.01 |
| ethyl(methylthio) acetate | 12.391 | 134.0 → 88.0 | 5 | 88.0 → 61.0 | 5 | 0.05-0.2 | 0.01 |
| Valeric acid | 15.329 | 73 → 55 | 15 | 60 → 42 | 15 | 0.05-0.2 | 0.01 |
| propanoic acid | 13.168 | 73 → 55 | 10 | 74 → 45 | 35 | 0.05-0.2 | 0.01 |
| octanoic acid | 18.434 | 73 → 55 | 25 | 60 → 42 | 25 | 0.05-0.2 | 0.01 |

NDR = no data reported
n/a = no value determined

TABLE 2A
VOCs in reference alcoholic beverages

| Round 1 assays | 1 | 2 | 3 | 4 | 5 |
|---|---|---|---|---|---|
| (−)alpha-pinene | BC | BC | BC | ND | ND |
| (−)-beta-pinene | 0.0034 | 0.0031 | 0.0048 | 0.0032 | 0.0037 |
| (−)-cis-rose oxide | BC | BC | BC | ND | ND |
| 1-decanol | 0.0016 | 0.0019 | 0.0018 | ND | ND |
| 1-octanol | 0.0006 | 0.0008 | 0.0009 | ND | ND |
| 1-octen-3-ol | 0.0003 | 0.0003 | 0.0021 | ND | ND |
| 2-(methylthio)ethanol | NF | NF | NF | ND | ND |
| 2,3-pentadione | 0.0223 | 0.0392 | 0.0179 | ND | ND |
| 2,6-dimethyl-5-heptenal | BC | BC | BC | ND | ND |
| 2,6-dimethylpyrazine | NF | NF | NF | ND | ND |
| 2-acetylpyridine | 0.0143 | 0.01 | 0.0112 | ND | ND |
| 2-heptanone | 0.0002 | 0.0002 | 0.0004 | ND | ND |
| 2-isobutyl-3-methoxypyrazine | BC | BC | BC | ND | ND |
| 2-isopropyl-3- | 0.0006 | 0.0001 | 0.0001 | ND | ND |
| methoxypyrazine | | | | | |
| 2-methoxy-4-methylphenol | 0.0035 | 0.0026 | 0.0035 | ND | ND |
| 2-methoxy-4-propylphenol | NF | NF | NF | ND | ND |
| 2-methyl-1-butanol | 194.7924 | 244.5273 | 268.3465 | ND | ND |
| 2-methylbutyl acetate | 0.0241 | 0.0221 | 0.0312 | 0.0234 | 0.0238 |
| 2-methylbutyraldehyde | 0.0023 | 0.003 | 0.0025 | ND | ND |
| 2-nonanone | NF | NF | NF | ND | ND |
| 2-phenethyl acetate | 0.0131 | 0.0378 | 0.0382 | ND | ND |
| 2-phenylethanol | 77.952 | 110.6814 | 126.9174 | ND | ND |
| 2-undecanone | 0.0002 | 0.0002 | 0.0002 | ND | ND |
| 3-(methylthio)-1-propanol | 1.6004 | 1.6514 | 1.1891 | ND | ND |
| 3,7 dimethyl-6-octenoic acid | 0.0009 | 0.001 | 0.0009 | ND | ND |
| 3-carene | 0.0067 | 0.0046 | 0.0043 | ND | ND |
| 3-mercaptohexyl acetate | NF | NF | NF | ND | ND |
| 3-methyl-1-pentanol | 0.059 | 0.0492 | 0.088 | ND | ND |
| 3-nonene-2-one | 0.0022 | 0.0026 | 0.0025 | ND | ND |
| 4-carvomenthenol | 0.0013 | 0.0014 | 0.0029 | ND | ND |
| 4-ethyl guaiacol | NF | NF | NF | ND | ND |
| 4-ethyl phenol | 0.0005 | 0.0001 | 0.0001 | ND | ND |
| acetaldehyde | 0.0088 | 0.0241 | 0.0225 | ND | ND |
| acetoin | NF | NF | NF | ND | ND |
| alpha ionone | 0.0001 | 0.0003 | 0.0003 | ND | ND |
| alpha terpineol | 0.4531 | 0.4718 | 0.7241 | ND | ND |
| amyl alcohol | BC | 0.0434* | BC | ND | ND |
| amyl butyrate | 0.0063 | 0.0072 | 0.0073 | ND | ND |
| amyl formate | BC | BC | BC | ND | ND |
| a-phellandrene | 0.014 | 0.0068 | 0.0056 | ND | ND |
| benzaldehyde | 0.0017 | 0.0016 | 0.002 | ND | ND |
| benzyl acetate | NF | NF | NF | ND | ND |
| benzyl alcohol | NF | NF | NF | ND | ND |
| beta-ionone | NF | NF | NF | 0 | 0 |
| butanol | BC | BC | BC | ND | ND |
| butyl acetate | 0.1268 | 0.1345 | 0.1512 | ND | ND |
| butyl formate | 1.1342 | 1.0267 | 1.4068 | 1.1119 | 1.1093 |
| butyl isovalerate | 0.0004 | 0.0006 | 0.0005 | ND | ND |
| butyric acid | 0.0977 | 0.0993 | 0.0701 | ND | ND |
| cinnamaldehyde | 0.0001 | 0.0001 | 0.0001 | ND | ND |
| cis-3-hexen-1-ol | BC | BC | BC | ND | ND |
| cis-3-hexenyl acetate | 0.0017 | 0.0018 | 0.0023 | ND | ND |
| cis-whiskey lactone | 0.0017 | 0.0014 | 0.0009 | 0.0015 | 0.0012 |
| citronellol | NF | NF | 0.0001 | ND | ND |
| citronellyl acetate | NF | NF | NF | ND | ND |
| damascenone | 0.4302 | 0.5365 | 0.9007 | ND | ND |
| damascone | 0.787* | 0.8533* | 0.7467* | ND | ND |
| decanal | NF | NF | NF | ND | ND |
| decanoic acid | 0.2945 | 0.0209 | 0.0056 | ND | ND |
| delta-decalactone | 0.0023 | 0.0007 | 0.0002 | 0.0034 | 0.0007 |
| diethyl succinate | 0.7863 | 1.5732 | 1.4867 | ND | ND |
| dimethyl anthranilate | BC | BC | BC | ND | ND |
| dimethyl succinate | NF | NF | NF | ND | ND |
| dimethyl sulfide | 0.0161 | 0.0097 | 0.0137 | ND | ND |
| ethyl acetate | 153.1713 | 168.7244 | 179.6349 | ND | ND |
| ethyl anthranilate | NF | NF | NF | ND | ND |
| ethyl butyrate | 0.0818 | 0.1169 | 0.1074 | 0.1018 | 0.1045 |
| ethyl cinnamate | NF | NF | NF | ND | ND |
| ethyl decanoate | 0.2702 | 0.0172 | 0.0032 | ND | ND |
| ethyl heptanoate | BC | BC | BC | ND | ND |
| ethyl hexanoate | 2.0475 | 1.194 | 0.3136 | ND | ND |
| ethyl isobutyrate | 0.0646 | 0.0603 | 0.0407 | ND | ND |
| ethyl isovalerate | 0.0048 | 0.0035 | 0.0016 | ND | ND |
| ethyl lactate | 9.5926 | 9.6073 | 8.4912 | 4.1428 | 4.954 |
| ethyl laurate | 0.0741 | 0.1013 | 0.0581 | 0.0773 | 0.0835 |
| ethyl myristate | 0.0196 | 0.0165 | 0.022 | ND | ND |
| ethyl nonanoate | 0.0002 | 0.0002 | 0.0002 | 0.0002 | 0.0002 |
| ethyl octanoate | 5.3134 | 6.1841 | 5.6028 | 6.6972 | 5.9387 |
| ethyl palmitate | 0.0114 | 0.0118 | 0.0171 | ND | ND |
| ethyl phenyl acetate | 0.0004 | 0.0006 | 0.0005 | ND | ND |
| ethyl propionate | 0.0325 | 0.0351 | 0.0444 | 0.0381 | 0.044 |
| ethyl undecanoate | 0.0002 | 0.0002 | 0.0002 | ND | ND |
| ethyl valerate | 0.0003 | 0.0005 | 0.0004 | ND | ND |
| ethyl-2-mercaptopropionate | NF | NF | NF | ND | ND |
| ethyl-2-methylbutyrate | 0.0035 | 0.0032 | 0.0046 | 0.0035 | 0.0034 |
| ethyl-3-hydroxybutyrate | 0.0309 | 0.0432 | 0.0496 | ND | ND |
| ethyl-trans-2-butenoate | NF | NF | NF | ND | ND |
| ethyl-trans-3-hexenoate | BC | BC | BC | ND | ND |
| eucalyptol | 0.0002 | 0.0002 | 0.0002 | ND | ND |
| eugenol | NF | NF | NF | ND | ND |
| furfural | 1.0548 | 1.0871 | 4.6193 | ND | ND |
| furfuryl ether | NF | NF | NF | ND | ND |
| furfuryl mercaptan | NF | NF | NF | 0.0001 | 0 |
| gamma-decalactone | 0.0034 | 0.0007 | 0.0005 | 0.0023 | 0.0007 |
| gamma-dodecalactone | NF | NF | NF | ND | ND |
| gamma-nonalactone | 0.0002 | 0.0001 | 0.0003 | ND | ND |
| gamma-octalactone | 0.0024 | 0.0046 | 0.0035 | ND | ND |
| gamma-terpinene | 0.0004 | 0.0003 | 0.0003 | ND | ND |
| gamma-undecalactone | NF | NF | NF | ND | ND |
| geraniol | 0.0034 | 0.0037 | 0.0055 | 0.0041 | 0.0042 |
| geranyl acetate | BC | BC | BC | ND | ND |
| guaiacol | 0.0031 | 0.0029 | 0.0035 | ND | ND |
| heptyl acetate | 0.0004 | 0.0004 | 0.0004 | ND | ND |
| hexanoic acid | SC | SC | SC | SC | SC |
| hexanol | 0.3946 | 0.4393 | 0.5256 | ND | ND |
| hexyl acetate | 0.014 | 0.0143 | 0.0201 | ND | ND |
| hexyl hexanoate | 0.0018 | 0.0015 | 0.0016 | ND | ND |
| isoamyl acetate | 0.658 | 0.6007 | 0.8561 | 0.6523 | 0.6449 |
| isoamyl alcohol | 17.1494 | 24.2306 | 23.3799 | 1152.675 | 244.3339 |
| isoamyl hexanoate | BC | BC | BC | ND | ND |
| isoamyl octanoate | 0.002 | 0.0019 | 0.0015 | 0.0044 | 0.0046 |
| isoborneol | 0.0026 | 0.0032 | 0.0033 | ND | ND |
| isobutanol | 5.4009 | 6.535 | 6.6788 | 164.093 | 140.3592 |
| isobutyl acetate | 0.0317 | 0.0297 | 0.0385 | ND | ND |
| isobutyric acid | 3.2199 | 4.8063 | 4.9116 | ND | ND |
| isovaleraldehyde | 0.0229 | 0.029 | 0.0274 | ND | ND |
| isovaleric acid | 3.8767 | 3.3551 | 3.8767 | 3.5634 | 3.4007 |
| Jasmine lactone | 0.01 | 0.0104 | 0.0105 | ND | ND |
| L/D-carvone | BC | BC | BC | ND | ND |
| limonene | 0.0015 | 0.0017 | 0.0022 | 0.0015 | 0.0019 |
| linalool | 0.0952 | 0.0888 | 0.2381 | 0.1182 | 0.1278 |
| linalool oxide | 0.2429 | 0.3085 | 0.3627 | ND | ND |
| linalyl acetate | 0.0045 | 0.0049 | 0.0046 | ND | ND |
| linalyl butyrate | 0.0001 | 0.0001 | 0.0001 | ND | ND |
| linalyl formate | NF | NF | NF | ND | ND |
| maltol | 1.9783 | 2.2314 | 3.7793 | ND | ND |
| methional | 0.0002 | 0.0003 | 0.0006 | ND | ND |
| methyl anthranilate | 0.0006 | 0.0001 | NF | ND | ND |
| methyl decanoate | 0.0004 | 0.0003 | 0.0003 | ND | ND |
| methyl dihydrojasmonate | NF | NF | NF | ND | ND |
| methyl hexanoate | 3.4745 | 3.3208 | 3.5423 | ND | ND |
| methyl laurate | 0.0007 | 0.0007 | 0.0006 | ND | ND |
| methyl octanoate | 0.0931 | 0.1003 | 0.1006 | ND | ND |
| methyl salicylate | 0.0001 | 0.0001 | 0.0001 | ND | ND |
| methyl vanillate | 0.1321 | 0.0403 | 0.2557 | 0 | 0 |
| myrcene | 0.0009 | 0.0017 | 0.0015 | ND | ND |
| myrtenol | 0.0669 | 0.0528 | 0.0574 | ND | ND |
| nerol | 0.0015 | 0.0013 | 0.0028 | 0.0016 | 0.0017 |
| neryl acetate/geranyl acetate | 0 | 0 | 0 | ND | ND |
| nonanal | NF | NF | NF | ND | ND |
| octanoic acid | 6.405 | 7.7898 | 8.3655 | 0 | 9.1662 |
| octyl acetate | 0.001 | 0.001 | 0.001 | ND | ND |
| p-anisaldehyde | NF | NF | NF | ND | ND |
| p-cresol | BC | BC | BC | ND | ND |
| p-cymene | 0.0003 | 0.0003 | 0.0002 | ND | ND |
| phenethyl acetaldehyde | NF | NF | NF | ND | ND |
| dimethylacetate | | | | | |
| phenethyl butyrate | BC | BC | BC | BC | BC |
| phenethyl octanoate | ND | 0.0014 | 0.0015 | ND | ND |
| phenethyl propionate | BC | BC | BC | ND | ND |
| propanoic acid | SC | SC | SC | SC | SC |
| propanol | 13.4993 | 9.7047 | 12.131 | 10.1616 | 10.4205 |
| propyl hexanoate | 0.0001 | 0.0001 | 0.0001 | ND | ND |
| trans-2-pentenal | 0.1296 | 0.1473 | 0.1315 | ND | ND |
| trans-2-heptenal | 0.0005 | 0.0005 | NF | ND | ND |
| trans-2-hexen-1-al | 0.0065 | 0.0084 | 0.0065 | ND | ND |
| trans-2-hexen-1-ol | 0.0664 | 0.0754 | 0.0825 | ND | ND |

| Round 1 assays | 6 | 7 | 8 | 9 |
|---|---|---|---|---|
| (−)alpha-pinene | ND | ND | ND | ND |
| (−)-beta-pinene | 0.0037 | ND | ND | ND |
| (−)-cis-rose oxide | ND | ND | ND | ND |
| 1-decanol | ND | ND | ND | ND |
| 1-octanol | ND | ND | ND | ND |
| 1-octen-3-ol | ND | ND | ND | ND |
| 2-(methylthio)ethanol | ND | ND | ND | ND |
| 2,3-pentadione | ND | ND | ND | ND |
| 2,6-dimethyl-5-heptenal | ND | ND | ND | ND |
| 2,6-dimethylpyrazine | ND | ND | ND | ND |
| 2-acetylpyridine | ND | ND | ND | ND |
| 2-heptanone | ND | ND | ND | ND |
| 2-isobutyl-3-methoxypyrazine | ND | ND | ND | ND |
| 2-isopropyl-3- | ND | ND | ND | ND |
| methoxypyrazine | | | | |
| 2-methoxy-4-methylphenol | ND | ND | ND | ND |
| 2-methoxy-4-propylphenol | ND | ND | ND | ND |
| 2-methyl-1-butanol | ND | ND | ND | ND |
| 2-methylbutyl acetate | 0.0259 | ND | ND | ND |
| 2-methylbutyraldehyde | ND | ND | ND | ND |
| 2-nonanone | ND | ND | ND | ND |
| 2-phenethyl acetate | ND | ND | ND | ND |
| 2-phenylethanol | ND | ND | ND | ND |
| 2-undecanone | ND | ND | ND | ND |
| 3-(methylthio)-1-propanol | ND | ND | ND | ND |
| 3,7 dimethyl-6-octenoic acid | ND | ND | ND | ND |
| 3-carene | ND | ND | ND | ND |
| 3-mercaptohexyl acetate | ND | ND | ND | ND |
| 3-methyl-1-pentanol | ND | ND | ND | ND |
| 3-nonene-2-one | ND | ND | ND | ND |
| 4-carvomenthenol | ND | ND | ND | ND |
| 4-ethyl guaiacol | ND | ND | ND | ND |
| 4-ethyl phenol | ND | ND | ND | ND |
| acetaldehyde | ND | ND | ND | ND |
| acetoin | ND | ND | ND | ND |
| alpha ionone | ND | ND | ND | ND |
| alpha terpineol | ND | ND | ND | ND |
| amyl alcohol | ND | ND | ND | ND |
| amyl butyrate | ND | ND | ND | ND |
| amyl formate | ND | ND | ND | ND |
| a-phellandrene | ND | ND | ND | ND |
| benzaldehyde | ND | ND | ND | ND |
| benzyl acetate | ND | ND | ND | ND |
| benzyl alcohol | ND | ND | ND | ND |
| beta-ionone | 0 | ND | ND | ND |
| butanol | ND | ND | ND | ND |
| butyl acetate | ND | ND | ND | ND |
| butyl formate | 1.1305 | ND | ND | ND |
| butyl isovalerate | ND | ND | ND | ND |
| butyric acid | ND | ND | ND | ND |
| cinnamaldehyde | ND | ND | ND | ND |
| cis-3-hexen-1-ol | ND | ND | ND | ND |
| cis-3-hexenyl acetate | ND | ND | ND | ND |
| cis-whiskey lactone | 0.0022 | ND | ND | ND |
| citronellol | ND | ND | ND | ND |
| citronellyl acetate | ND | ND | ND | ND |
| damascenone | ND | ND | ND | ND |
| damascone | ND | ND | ND | ND |
| decanal | ND | ND | ND | ND |
| decanoic acid | ND | ND | ND | ND |
| delta-decalactone | 0.0005 | ND | ND | ND |
| diethyl succinate | ND | ND | ND | ND |
| dimethyl anthranilate | ND | ND | ND | ND |
| dimethyl succinate | ND | ND | ND | ND |
| dimethyl sulfide | ND | ND | ND | ND |
| ethyl acetate | ND | ND | ND | ND |
| ethyl anthranilate | ND | ND | ND | ND |
| ethyl butyrate | 0.0735 | ND | ND | ND |
| ethyl cinnamate | ND | ND | ND | ND |
| ethyl decanoate | ND | ND | ND | ND |
| ethyl heptanoate | ND | ND | ND | ND |
| ethyl hexanoate | ND | ND | ND | ND |
| ethyl isobutyrate | ND | ND | ND | ND |
| ethyl isovalerate | ND | ND | ND | ND |
| ethyl lactate | 5.8814 | ND | ND | ND |
| ethyl laurate | 0.0718 | ND | ND | ND |
| ethyl myristate | ND | ND | ND | ND |
| ethyl nonanoate | 0.0002 | ND | ND | ND |
| ethyl octanoate | 5.934 | ND | ND | ND |
| ethyl palmitate | ND | ND | ND | ND |
| ethyl phenyl acetate | ND | ND | ND | ND |
| ethyl propionate | 0.0398 | ND | ND | ND |
| ethyl undecanoate | ND | ND | ND | ND |
| ethyl valerate | ND | ND | ND | ND |
| ethyl-2-mercaptopropionate | ND | ND | ND | ND |
| ethyl-2-methylbutyrate | 0.0034 | ND | ND | ND |
| ethyl-3-hydroxybutyrate | ND | ND | ND | ND |
| ethyl-trans-2-butenoate | ND | ND | ND | ND |
| ethyl-trans-3-hexenoate | ND | ND | ND | ND |
| eucalyptol | ND | ND | ND | ND |
| eugenol | ND | ND | ND | ND |
| furfural | ND | ND | ND | ND |
| furfuryl ether | ND | ND | ND | ND |
| furfuryl mercaptan | 0 | ND | ND | ND |
| gamma-decalactone | 0.0002 | ND | ND | ND |
| gamma-dodecalactone | ND | ND | ND | ND |
| gamma-nonalactone | ND | ND | ND | ND |
| gamma-octalactone | ND | ND | ND | ND |
| gamma-terpinene | ND | ND | ND | ND |
| gamma-undecalactone | ND | ND | ND | ND |
| geraniol | 0.0036 | ND | ND | ND |
| geranyl acetate | ND | ND | ND | ND |
| guaiacol | ND | ND | ND | ND |
| heptyl acetate | ND | ND | ND | ND |
| hexanoic acid | SC | ND | ND | ND |
| hexanol | ND | ND | ND | ND |
| hexyl acetate | ND | ND | ND | ND |
| hexyl hexanoate | ND | ND | ND | ND |
| isoamyl acetate | 0.6514 | ND | ND | ND |
| isoamyl alcohol | 1442.818 | ND | ND | ND |
| isoamyl hexanoate | ND | ND | ND | ND |
| isoamyl octanoate | 0.0045 | 275.6349 | 1065.758 | 274.3083 |
| isoborneol | ND | ND | ND | ND |
| isobutanol | 179.8129 | ND | ND | ND |
| isobutyl acetate | ND | ND | ND | ND |
| isobutyric acid | ND | 147.6942 | 145.3173 | 148.121 |
| isovaleraldehyde | ND | ND | ND | ND |
| isovaleric acid | 3.3874 | ND | ND | ND |
| Jasmine lactone | ND | ND | ND | ND |
| L/D-carvone | ND | ND | ND | ND |
| limonene | 0.002 | ND | ND | ND |
| linalool | 0.1089 | ND | ND | ND |
| linalool oxide | ND | ND | ND | ND |
| linalyl acetate | ND | ND | ND | ND |
| linalyl butyrate | ND | ND | ND | ND |
| linalyl formate | ND | ND | ND | ND |
| maltol | ND | ND | ND | ND |
| methional | ND | ND | ND | ND |
| methyl anthranilate | ND | ND | ND | ND |
| methyl decanoate | ND | ND | ND | ND |
| methyl dihydrojasmonate | ND | ND | ND | ND |
| methyl hexanoate | ND | ND | ND | ND |
| methyl laurate | ND | ND | ND | ND |
| methyl octanoate | ND | ND | ND | ND |
| methyl salicylate | ND | ND | ND | ND |
| methyl vanillate | 0 | ND | ND | ND |
| myrcene | ND | ND | ND | ND |
| myrtenol | ND | ND | ND | ND |
| nerol | 0.0015 | ND | ND | ND |
| neryl acetate/geranyl acetate | ND | ND | ND | ND |
| nonanal | ND | ND | ND | ND |
| octanoic acid | 2.0322 | ND | ND | ND |
| octyl acetate | ND | ND | ND | ND |
| p-anisaldehyde | ND | ND | ND | ND |
| p-cresol | ND | ND | ND | ND |
| p-cymene | ND | ND | ND | ND |
| phenethyl acetaldehyde | ND | ND | ND | ND |
| dimethylacetate | | | | |
| phenethyl butyrate | BC | ND | ND | ND |
| phenethyl octanoate | ND | ND | ND | ND |
| phenethyl propionate | ND | ND | ND | ND |
| propanoic acid | SC | ND | ND | ND |
| propanol | 10.0028 | 2.713 | 4.7499 | 4.1518 |
| propyl hexanoate | ND | ND | ND | ND |
| trans-2-pentenal | ND | ND | ND | ND |
| trans-2-heptenal | ND | ND | ND | ND |
| trans-2-hexen-1-al | ND | ND | ND | ND |
| trans-2-hexen-1-ol | ND | ND | ND | ND |

TABLE 2B
VOCs in reference alcoholic beverages

| Round 2 assays | 1 | 2 | 3 | Notes |
|---|---|---|---|---|
| (—)alpha-pinene | BC | BC | BC | Detected but below the curve |
| (—)-beta-pinene | 0.001892155 | 0.001715072 | 0.002349202 | |
| (—)-cis-rose oxide | 0.000449433 | 0.000466262 | 0.000549681 | Measured but below the curve |
| 1,1-diethoxyethane | BC | BC | BC | Detected below the curve |
| 1-decanol | 0.003753218 | 0.002998288 | 0.003365339 | |
| 1-octanol | 0.002398118 | 0.002412743 | 0.002821679 | |
| 1-octen-3-ol | 0.002419445 | 0.002242089 | 0.001719782 | |
| 2,3-pentadione | 0.012463133 | 0.013358715 | 0.016290188 | |
| 2-heptanone | BC | BC | BC | Detected below the curve |
| 2-methoxy-4-propylphenol | 0.000124026 | 0.000110236 | 0.000108634 | Measured but below the curve |
| 2-methyl-1-butanol | 27.22852537 | 20.09513892 | 24.18764953 | |
| 2-methylbutyl acetate | 0.008545109 | 0.008308495 | 0.009521471 | |
| 2-methylbutyl isovalerate | BC | BC | BC | Detected below the curve |
| 2-methylbutyraldehyde | 0.001318454 | 0.002261234 | ND | |
| 2-nonanol | SC | SC | SC | Bad curves |
| 2-nonanone | 0.00064378 | 0.00068446 | 0.000490382 | |
| 2-phenylethanol | 27.71891227 | 27.31803315 | 27.73553841 | Above the curve |
| 2-undecanone | 6.98851E−05 | 6.57321E−05 | 6.68176E−05 | Measured but below the curve |
| 3-carene | BC | BC | BC | Detected below the curve |
| 4-carvomenthenol | BC | BC | BC | Detected below the curve |
| 4-ethyl guaiacol | 0.347412368 | 0.345910146 | 0.343918945 | Measured but below the curve |
| 4-ethyl phenol | 0.002992436 | 0.002836355 | 0.002762316 | |
| acetophenone | BC | BC | BC | Detected below the curve |
| alpha ionone | 0.000386261 | 0.000341349 | 0.000348424 | Measured but below the curve |
| alpha terpineol | 0.16794239 | 0.163025192 | 0.171765935 | |
| amyl alcohol | NF | NF | NF | NF |
| amyl butyrate | BC | BC | BC | Detected below the curve |
| benzaldehyde | BC | BC | BC | Detected below the curve |
| benzyl acetate | NF | NF | NF | NF |
| beta-ionone | 9.59876E−05 | 9.45855E−05 | 9.04825E−05 | Measured but below the curve |
| butanol | 0.324946065 | 0.228399036 | ND | |
| butyl acetate | BC | BC | BC | Detected below the curve |
| carvone | NF | NF | NF | NF |
| cinnamaldehyde | 9.99824E−05 | 9.22496E−05 | 0.000117125 | |
| cis-3-hexen-1-ol | 0.049388653 | 0.045126991 | 0.050030327 | |
| cis-3-hexenyl acetate | 0.007928091 | 0.007366221 | 0.009934799 | Above the curve |
| cis-whiskey lactone | 0.005791638 | 0.003812944 | 0.003639476 | Measured but below the curve |
| citronellol | 0.004808149 | 0.004822645 | 0.003374777 | |
| diethyl malate | 34.48890462 | 31.63642633 | 32.03738635 | Above the curve |
| ethyl 3-hydroxyhexanoate | 0.002553921 | 0.002568911 | 0.002609872 | Measured but below the curve |
| ethyl acetate | 24.70768015 | 27.15990791 | 23.51440106 | |
| ethyl benzoate | 6.68237E−05 | 6.47061E−05 | 6.33772E−05 | Measured but below the curve |
| ethyl butanoate | 0.070013523 | 0.061772749 | 0.047458729 | |
| ethyl cinnamate | 3.20106E−05 | 3.01225E−05 | 2.9947E−05 | Measured but below the curve |
| ethyl decanoate | 0.285747423 | 0.285683617 | 0.259995219 | |
| ethyl heptanoate | BC | BC | BC | Detected below the curve |
| ethyl hexanoate | 0.258280699 | 0.245064623 | 0.305386967 | Above the curve |
| ethyl isobutyrate | 0.151177356 | 0.139857008 | 0.148534019 | Above the curve |
| ethyl isovalerate | 0.022632971 | 0.022171187 | 0.018955706 | Above the curve |
| ethyl lactate | 8.252388398 | 7.322633375 | ND | |
| ethyl laurate | 0.003610532 | 0.006781488 | ND | Measured but below the curve |
| ethyl levulinate | 0.003889749 | ND | 0.003971232 | |
| ethyl myristate | 0.000191394 | 5.59587E−05 | 9.99838E−05 | Detected below the curve |
| ethyl nonanoate | BC | BC | BC | Detected below the curve |
| ethyl octanoate | 1.06744332 | 1.135456398 | 0.501912514 | |
| ethyl phenyl acetate | 0.002440098 | 0.002305016 | 0.00207629 | |
| ethyl propionate | 0.07551169 | 0.061985894 | 0.052532184 | |
| ethyl salicylate | BC | BC | BC | Detected below the curve |
| ethyl trans-2-butenoate | 0.002307992 | 0.002442044 | 0.002624217 | Measured but below the curve |
| ethyl trans-3-hexenoate | BC | BC | BC | detected but below the curve |
| ethyl undecanoate | BC | BC | BC | Detected below the curve |
| ethyl valerate | 0.000589868 | 0.000566997 | 0.000432847 | Measured but below the curve |
| ethyl(methylthio) acetate | BC | BC | BC | Detected below the curve |
| ethyl-2-methylbutyrate | BC | BC | BC | Detected below the curve |
| eucalyptol | 0.000352756 | 0.000334686 | 0.000468757 | |
| eugenol | 0.005264017 | 0.005217056 | 0.005235575 | Measured but below the curve |
| farnesol | 0.003400752 | 0.003406477 | 0.003403629 | Detected below the curve |
| furfural | 3.916579419 | 3.406345104 | 3.967095026 | Above the curve |
| gamma-decalactone | 0.005846598 | 0.005829782 | 0.005862139 | |
| gamma-nonalactone | 0.0030033 | 0.003021643 | 0.003001943 | Measured but below the curve |
| gamma-terpinene | 0.000765981 | 0.000837802 | ND | |
| geraniol | 0.005390707 | 0.005364866 | 0.004862677 | |
| geranyl acetone | 0.001492267 | 0.001487225 | 0.001471223 | Measured but below the curve |
| guaiacol | 0.001541856 | 0.001368694 | 0.001371202 | Measured but below the curve |
| heptyl acetate | BC | BC | BC | Detected below the curve |
| hexanol | 0.534931643 | 0.446284222 | 0.427908192 | |
| isoamyl acetate | 0.114420284 | 0.100715094 | 0.127341387 | Above the curve |
| isoamyl alcohol | BC | BC | BC | Detected below the curve |
| isoamyl hexanoate | BC | BC | BC | Detected below the curve |
| isoamyl isobutyrate | BC | BC | BC | Detected below the curve |
| isoamyl isovalerate | NF | NF | NF | NF |
| isoamyl octanoate | BC | BC | BC | Detected below the curve |
| isobutyl acetate | 0.003146512 | 0.002530398 | 0.003168992 | Omit pt 3 |
| isobutyl alcohol | 1.848997646 | 15.75945523 | ND | |
| isobutyl isobutyrate | BC | BC | BC | Detected below the curve |
| isobutyraldehyde | 0.000715638 | 0.000380317 | 0.001763262 | Measured but below the curve |
| isovaleraldehyde | 0.002187486 | 0.003000257 | 0.003187493 | |
| limonene | 0.000382765 | 0.000384636 | 0.000298845 | |
| linalool | 0.102350127 | 0.108132412 | 0.101245113 | Above the curve |
| linalool oxide | 0.583418772 | 0.509669117 | 0.425229285 | Above the curve |
| linalyl acetate | 0.001219178 | 0.001180024 | 0.001124153 | |
| methional | 0.001200728 | 0.001155158 | 0.001145768 | Measured but below the curve |
| methyl acetate | 0.046656793 | ND | 0.043755887 | |
| methyl hexanoate | BC | BC | BC | Detected below the curve |
| methyl laurate | 2.46334E−05 | BC | BC | Detected below the curve |
| methyl octanoate | BC | BC | BC | Detected below the curve |
| methyl salicylate | 0.001907274 | 0.001842859 | 0.001794303 | Measured but below the curve |
| myrcene | BC | BC | BC | Detected below the curve |
| p-anisaldehyde | NF | NF | NF | NF |
| p-cresol | 0.004252195 | 0.004337536 | 0.00433469 | Measured but below the curve |
| p-cymene | BC | BC | BC | Detected below the curve |
| phenethyl acetate | 0.00860563 | 0.00764275 | 0.008215134 | |
| phenethyl butyrate | 0.000825128 | 0.000803692 | 0.000808073 | |
| phenethyl formate | SC | SC | SC | Bad curves |
| phenethyl octanoate | 8.0688E−05 | 7.82664E−05 | 7.93176E−05 | Measured but below the curve |
| phenethyl propionate | 9.96408E−05 | 9.32211E−05 | 9.2439E−05 | Measured but below the curve |
| propanol | 11.6301144 | 8.909499959 | ND | |
| propyl acetate | 0.003979912 | 0.00332731 | 0.00343983 | |
| salicylaldehyde | 0.001 | 0.0008 | 0.0008 | Measured but below the curve |
| vanillyl ethyl ether | NF | NF | NF | NF |

BC = below the standard curve
ND = not done
NF = not found
SC = bad standard curve
*Detected, but below the curve

TABLE 2C
FOCs in reference alcoholic beverages

| Round 3 assays Compound | | | | |
|---|---|---|---|---|
| (mg/L) | 1A | 1B | 2A | 2B |
| (1R)-(—)-myrtenal | 0.00E+00 | ND | 0.00E+00 | ND |
| 1,4-cineole | 0.00E+00 | ND | 0.00E+00 | ND |
| 1-octanol (nat) | 1.79E−02 | ND | 1.04E−02 | ND |
| 1-octen-3-ol | 3.60E−03 | ND | 2.40E−03 | ND |
| 1-para-menthene-8-thiol | 0.00E+00 | ND | 0.00E+00 | ND |
| 2,3-hexanedione | 0.00E+00 | ND | 0.00E+00 | ND |
| 2,3-pentadione | 0.00E+00 | ND | 0.00E+00 | ND |
| 2,4,6-trimethylphenol | 2.50E−03 | ND | 2.30E−03 | ND |
| (mesitol) | | | | |
| 2-acetyl-1-methylpyrrole | 0.00E+00 | ND | 0.00E+00 | ND |
| 2-ethyl-3(5 or 6)- | 0.00E+00 | ND | 0.00E+00 | ND |
| dimethylpyrazine | | | | |
| 2-ethyl-3-methylpyrazine | 0.00E+00 | ND | 0.00E+00 | ND |
| 2-heptanol | 0.00E+00 | ND | 0.00E+00 | ND |
| 2-heptanone | 2.70E−03 | ND | 0.00E+00 | ND |
| 2-isobutyl-3- | 0.00E+00 | ND | 0.00E+00 | ND |
| methoxypyr azine | | | | |
| 2-isobutyl-4-methyl-1,3- | 0.00E+00 | ND | 0.00E+00 | ND |
| dioxolane | | | | |
| 2-isopropyl-4-methyl | 0.00E+00 | ND | 0.00E+00 | ND |
| thiazole | | | | |
| 2-methoxy-3-(1- | 0.00E+00 | ND | 0.00E+00 | ND |
| methylpropyl) pyrazine | | | | |
| 2-Methoxy-4-methylphenol | 0.00E+00 | ND | 0.00E+00 | ND |
| (creosol) | | | | |
| 2-methoxy-4-propylphenol | 0.00E+00 | ND | 0.00E+00 | ND |
| 2-methoxycinnamaldehyde | 0.00E+00 | ND | 0.00E+00 | ND |
| 2-methyl-1-butanol | 2.96E+01 | ND | 4.04E+01 | ND |
| 2-methylbutyl acetate | 1.41E−02 | ND | ND | ND |
| 2-methylbutyl isovalerate | 0.00E+00 | ND | 0.00E+00 | ND |
| 2-methylbutyraldehyde | 7.50E−02 | ND | 6.12E−02 | ND |
| 2-nonanol | 0.00E+00 | ND | 0.00E+00 | ND |
| 2-nonanone | 0.00E+00 | ND | 0.00E+00 | ND |
| 2-octanone | 0.00E+00 | ND | 0.00E+00 | ND |
| 2-pentylfuran | 0.00E+00 | ND | 0.00E+00 | ND |
| 2-undecanone | 7.00E−04 | ND | 0.00E+00 | ND |
| 3-carene | 1.80E−02 | ND | 0.00E+00 | ND |
| 3-heptyl acetate | 0.00E+00 | ND | 0.00E+00 | ND |
| 3-mercaptohexyl acetate | detected, below | ND | detected, below | ND |
| | LOQ | | LOQ | |
| 3-methyl-1-pentanol | 1.12E−02 | ND | 3.05E−02 | ND |
| 3-methylthio hexyl acetate | 0.00E+00 | ND | 0.00E+00 | ND |
| (ug/L) | | | | |
| 3-phenylpropanal | 0.00E+00 | ND | 0.00E+00 | ND |
| 4,5,6,7-tetrahydro-3,6- | 0.00E+00 | ND | 0.00E+00 | ND |
| dimethylbenzofuran | | | | |
| 4-carvomenthenol | 9.30E−03 | ND | 7.60E−03 | ND |
| 4-Ethyl Guaiacol | 0.00E+00 | ND | 0.00E+00 | ND |
| 4-Ethyl Phenol | 0.00E+00 | ND | 0.00E+00 | ND |
| 4-mercapto-4-methyl-2- | 0.00E+00 | ND | 0.00E+00 | ND |
| pentanone | | | | |
| 5-ethyl-3-hydroxy-4-methyl- | 1.07E−01 | ND | 6.18E−02 | ND |
| 2(5H)-furanone (maple | | | | |
| furanone) | | | | |
| 5-methyl furfural | 9.80E−03 | ND | 2.54E−02 | ND |
| 5-methyl-2-phenyl-2-hexenal | 0.00E+00 | ND | 0.00E+00 | ND |
| 6,10-dimethyl-5,9- | 0.00E+00 | ND | 0.00E+00 | ND |
| undecadien-2-one (geranyl | | | | |
| acetone) | | | | |
| 6-methyl-5-hepten-2-one | 1.39E−03 | ND | 1.19E−03 | ND |
| acetal (1,1-diethoxyethane) | 0.00E+00 | ND | 0.00E+00 | ND |
| acetoin | 0.00E+00 | ND | 0.00E+00 | ND |
| acetophenone | 1.30E−03 | ND | 9.00E−04 | ND |
| a-ionone | 0.00E+00 | ND | 0.00E+00 | ND |
| allyl heptanoate | 0.00E+00 | ND | 0.00E+00 | ND |
| allyl hexanoate | 0.00E+00 | ND | 0.00E+00 | ND |
| amyl alcohol | 0.00E+00 | ND | 1.08E−01 | ND |
| amyl butyrate | 1.57E−02 | ND | 7.90E−03 | ND |
| anisyl acetate | 0.00E+00 | ND | 0.00E+00 | ND |
| anisyl alcohol | 0.00E+00 | ND | 0.00E+00 | ND |
| anisyl butyrate | 0.00E+00 | ND | 0.00E+00 | ND |
| a-pinene | 0.00E+00 | ND | 0.00E+00 | ND |
| b-caryophellene | 5.90E−03 | ND | 6.30E−03 | ND |
| benzaldehyde | 1.08E−02 | ND | 7.10E−03 | ND |
| benzyl acetate | 0.00E+00 | ND | 0.00E+00 | ND |
| benzyl alcohol | 4.72E−02 | ND | 2.10E−02 | ND |
| benzyl benzoate | 0.00E+00 | ND | 0.00E+00 | ND |
| benzyl butyrate | 0.00E+00 | ND | 0.00E+00 | ND |
| benzyl formate | 0.00E+00 | ND | 0.00E+00 | ND |
| benzyl propionate | 0.00E+00 | ND | 0.00E+00 | ND |
| beta-ionone | 0.00E+00 | ND | 0.00E+00 | ND |
| beta-pinene | 6.70E−03 | ND | 2.70E−03 | ND |
| butyl acetate | 0.00E+00 | ND | 0.00E+00 | ND |
| butyl alcohol | 1.85E−01 | 1.17E−01 | 1.81E−01 | 1.14E−01 |
| butyl butyryllactate | 0.00E+00 | ND | 0.00E+00 | ND |
| butyl formate | 4.23E−01 | ND | 2.94E−01 | ND |
| butyraldehyde | 0.00E+00 | ND | 0.00E+00 | ND |
| butyric acid | 2.20E−03 | ND | 2.10E−03 | ND |
| carvacrol | 0.00E+00 | ND | 0.00E+00 | ND |
| Cinnamaldehyde | 3.00E−04 | ND | 4.00E−04 | ND |
| cis-3-hexen-1-ol | 5.58E−02 | ND | 1.27E−01 | ND |
| cis-3-hexenyl acetate | 0.00E+00 | ND | 0.00E+00 | ND |
| cis-3-hexenyl butyrate | 0.00E+00 | ND | 0.00E+00 | ND |
| cis-3-hexenyl caproate | 0.00E+00 | ND | 0.00E+00 | ND |
| cis-3-hexenyl valerate | 0.00E+00 | ND | 0.00E+00 | ND |
| Cis-5-octen-1-ol | 0.00E+00 | ND | 0.00E+00 | ND |
| cis-6-nonen-1-ol | 0.00E+00 | ND | 0.00E+00 | ND |
| citral | 7.90E−03 | ND | 7.50E−03 | ND |
| citronellol | 0.00E+00 | ND | 0.00E+00 | ND |
| cuminaldehyde | 0.00E+00 | ND | 0.00E+00 | ND |
| damascenone | 0.00E+00 | ND | 0.00E+00 | ND |
| D-camphor | 1.62E−02 | ND | 1.93E−02 | ND |
| D-carvone | 0.00E+00 | ND | 0.00E+00 | ND |
| decanal | 0.00E+00 | ND | 0.00E+00 | ND |
| decanoic acid | 1.78E−02 | ND | 6.70E−03 | ND |
| decanol | 3.20E−03 | ND | 2.10E−03 | ND |
| delta-decalactone | 2.60E−03 | ND | 3.00E−03 | ND |
| delta-dodecalactone | 0.00E+00 | ND | 0.00E+00 | ND |
| d-fenchone | 0.00E+00 | ND | 0.00E+00 | ND |
| diethyl malate | ND | ND | 7.17E−01 | ND |
| dihydrocoumarin | 0.00E+00 | ND | 0.00E+00 | ND |
| DL-3-methyl-2-butanol | 2.54E−02 | ND | 0.00E+00 | ND |
| ethyl (methylthio) acetate | 0.00E+00 | ND | 0.00E+00 | ND |
| ethyl 2-methylbutyrate | 2.20E−03 | ND | 3.70E−03 | ND |
| ethyl 2-trans-4-cis- | 0.00E+00 | ND | 0.00E+00 | ND |
| decadienoate | | | | |
| ethyl 3-hydroxyhexanoate | 0.00E+00 | ND | 0.00E+00 | ND |
| ethyl acetate | 1.75E+01 | ND | 1.47E+01 | ND |
| ethyl benzoate | 4.20E−03 | ND | 0.00E+00 | ND |
| Ethyl butyrate (ethyl | 2.51E−01 | ND | 1.87E−01 | ND |
| butanoate) | | | | |
| ethyl cinnamate | 0.00E+00 | ND | 0.00E+00 | ND |
| ethyl decanoate | ND | ND | 1.44E+00 | ND |
| ethyl heptanoate | 0.00E+00 | ND | 0.00E+00 | ND |
| ethyl hexanoate | 4.27E−01 | ND | 5.25E−01 | ND |
| ethyl isobutyrate | 1.13E−01 | ND | 1.39E−01 | ND |
| ethyl isovalerate | 0.00E+00 | ND | 3.62E−02 | ND |
| ethyl lactate | ND | ND | 5.13E+00 | ND |
| ethyl laurate | 3.70E−02 | ND | 9.00E−02 | ND |
| ethyl levulinate | 2.90E−03 | ND | 0.00E+00 | ND |
| ethyl myristate | 1.47E−02 | ND | 1.42E−02 | ND |
| ethyl nonanoate | 0.00E+00 | ND | 2.10E−03 | ND |
| ethyl octanoate | 7.08E−01 | ND | ND | ND |
| ethyl phenylacetate | 3.90E−03 | ND | 3.30E−03 | ND |
| ethyl propionate | 5.80E−02 | ND | 4.63E−02 | ND |
| ethyl salicylate | 1.20E−03 | ND | 0.00E+00 | ND |
| ethyl trans-2-butenoate | 5.30E−03 | ND | 3.50E−03 | ND |
| ethyl undecanoate | 7.20E−03 | ND | 7.30E−03 | ND |
| Ethyl Valerate | 0.00E+00 | ND | 0.00E+00 | ND |
| ethyl-trans-3-hexenoate | 0.00E+00 | ND | 0.00E+00 | ND |
| eucalyptol | 0.00E+00 | ND | 0.00E+00 | ND |
| eugenol | 4.00E−04 | ND | 1.00E−04 | ND |
| farnesol | 0.00E+00 | ND | 0.00E+00 | ND |
| furfural | ND | ND | 2.55E−01 | ND |
| furfuryl thioacetate | 0.00E+00 | ND | 0.00E+00 | ND |
| gamma-decalactone | 0.00E+00 | ND | 0.00E+00 | ND |
| gamma-dodecalactone | 0.00E+00 | ND | 0.00E+00 | ND |
| gamma-heptalactone | 0.00E+00 | ND | 0.00E+00 | ND |
| gamma-hexalactone | 0.00E+00 | ND | 2.33E−02 | ND |
| gamma-nonalactone | 0.00E+00 | ND | 0.00E+00 | ND |
| gamma-octalactone | 0.00E+00 | ND | 0.00E+00 | ND |
| gamma-terpinene | 2.08E−02 | ND | 2.05E−02 | ND |
| gamma-undecalactone | 3.35E−02 | ND | 1.92E−02 | ND |
| geraniol | ND | ND | 3.48E−01 | ND |
| geranyl butyrate | 0.00E+00 | ND | 0.00E+00 | ND |
| geranyl propionate | 0.00E+00 | ND | 0.00E+00 | ND |
| guaiacol | 0.00E+00 | ND | 0.00E+00 | ND |
| heptyl acetate | 0.00E+00 | ND | 0.00E+00 | ND |
| Hexadecanol | 1.70E−02 | ND | 8.00E−03 | ND |
| hexanoic acid | 1.66E−01 | ND | 9.93E−02 | ND |
| hexyl 3-methylbutanoate | 0.00E+00 | ND | 0.00E+00 | ND |
| hexyl acetate | 7.30E−03 | ND | 5.20E−03 | ND |
| Hexyl alcohol (hexanol) | 4.40E−01 | ND | 5.70E−01 | ND |
| hexyl butyrate | 0.00E+00 | ND | 0.00E+00 | ND |
| hexyl formate | 0.00E+00 | ND | 0.00E+00 | ND |
| hexyl isobutyrate | 0.00E+00 | ND | 0.00E+00 | ND |
| hexyl propionate | 0.00E+00 | ND | 0.00E+00 | ND |
| indole | 0.00E+00 | ND | 0.00E+00 | ND |
| isoamyl acetate | 2.53E−01 | ND | 4.88E−01 | ND |
| isoamyl alcohol | 5.10E+01 | ND | 5.30E+01 | ND |
| isoamyl cinnamate | 0.00E+00 | ND | 0.00E+00 | ND |
| isoamyl hexanoate | 2.00E−04 | ND | 4.00E−04 | ND |
| isoamyl isobutyrate | 0.00E+00 | 4.29E−05 | 0.00E+00 | 0.00E+00 |
| isoamyl isovalerate | 6.90E−03 | ND | 0.00E+00 | ND |
| isoamyl octanoate | 2.90E−03 | ND | 5.90E−03 | ND |
| isoamyl phenylacetate | 0.00E+00 | ND | 0.00E+00 | ND |
| isobutyl acetate | 8.50E−03 | ND | 7.90E−03 | ND |
| isobutyl butyrate | 0.00E+00 | ND | 0.00E+00 | ND |
| isobutyl isobutyrate | 0.00E+00 | ND | 0.00E+00 | ND |
| isobutyl propionate | 0.00E+00 | ND | 0.00E+00 | ND |
| isobutyraldehyde | 0.00E+00 | ND | 0.00E+00 | ND |
| isoeugenol | 0.00E+00 | ND | 0.00E+00 | ND |
| isovaleraldehyde | 8.78E−02 | ND | 1.26E−01 | ND |
| L-Carvone | 0.00E+00 | ND | 0.00E+00 | ND |
| linalool oxide | 1.23E−01 | ND | 1.95E−01 | ND |
| linalyl acetate | 1.09E−01 | 1.28E−02 | 9.52E−02 | 1.35E−02 |
| linalyl butyrate | 0.00E+00 | ND | 0.00E+00 | ND |
| 1-limonene | 5.50E−03 | ND | 5.60E−03 | ND |
| 1-linalool | 3.61E−02 | ND | 4.75E−02 | ND |
| L-menthyl acetate | 0.00E+00 | ND | 0.00E+00 | ND |
| L-Rose Oxide | 0.00E+00 | ND | 0.00E+00 | ND |
| Maltol | 0.00E+00 | ND | 0.00E+00 | ND |
| methional | 0.00E+00 | ND | 0.00E+00 | ND |
| methionyl acetate (3- | 0.00E+00 | ND | 0.00E+00 | ND |
| methylthio-propylacetate) | | | | |
| methionyl butyrate | 0.00E+00 | ND | 0.00E+00 | ND |
| methyl acetate | 1.12E−01 | ND | 8.79E−02 | ND |
| Methyl anthranilate | 0.00E+00 | ND | 0.00E+00 | ND |
| methyl benzoate | 0.00E+00 | ND | 0.00E+00 | ND |
| Methyl cinnamate | 0.00E+00 | ND | 0.00E+00 | ND |
| Methyl cyclopentenolone | 4.28E−02 | ND | 2.97E−02 | ND |
| methyl decanoate | 3.90E−03 | ND | 4.20E−03 | ND |
| methyl hexanoate | 0.00E+00 | ND | 2.60E−03 | ND |
| methyl laurate | 0.00E+00 | ND | 0.00E+00 | ND |
| Methyl Octanoate | 4.20E−03 | ND | 3.70E−03 | ND |
| methyl salicylate | 0.00E+00 | ND | 5.00E−04 | ND |
| Methyl β-naphthyl ketone | 2.37E−02 | ND | 0.00E+00 | ND |
| methyl-2-pyrrolyl ketone | 0.00E+00 | ND | 0.00E+00 | ND |
| Myrcene | 0.00E+00 | ND | 0.00E+00 | ND |
| nerol | 0.00E+00 | ND | 0.00E+00 | ND |
| nerolidol | 2.20E−03 | ND | 0.00E+00 | ND |
| nonanal | 6.90E−03 | ND | 1.41E−02 | ND |
| octanal | 0.00E+00 | ND | 0.00E+00 | ND |
| omega-pentadecalactone | 0.00E+00 | ND | 0.00E+00 | ND |
| p,a-dimethylstyrene | 2.00E−04 | ND | 3.00E−04 | ND |
| p-anisaldehyde | 0.00E+00 | ND | 0.00E+00 | ND |
| p-cresol | 0.00E+00 | ND | 0.00E+00 | ND |
| p-cymene | 0.00E+00 | ND | 0.00E+00 | ND |
| Perillaldehyde | 0.00E+00 | ND | 0.00E+00 | ND |
| Phenethyl 2-methylbutyrate | 0.00E+00 | ND | 0.00E+00 | ND |
| Phenethyl Acetate (2- | 4.95E−02 | ND | 7.33E−02 | ND |
| phenylethylacetate) | | | | |
| phenethyl alcohol (2- | 3.54E+01 | ND | 6.05E+01 | ND |
| phenylethanol) | | | | |
| Phenethyl Butyrate | 0.00E+00 | ND | 0.00E+00 | ND |
| phenethyl formate | 0.00E+00 | ND | 0.00E+00 | ND |
| phenethyl octanoate | 0.00E+00 | ND | 0.00E+00 | ND |
| phenethyl propionate | 0.00E+00 | ND | 0.00E+00 | ND |
| phenethyl tiglate | 0.00E+00 | ND | 0.00E+00 | ND |
| phenylacetaldehyde | 5.93E−02 | ND | 3.55E−02 | ND |
| phenylacetaldehyde dimethyl | 0.00E+00 | ND | 0.00E+00 | ND |
| acetal | | | | |
| propanal | 0.00E+00 | ND | 0.00E+00 | ND |
| propyl acetate | 0.00E+00 | ND | 0.00E+00 | ND |
| propyl butyrate | 2.16E−03 | ND | 2.15E−03 | ND |
| propyl isovalerate | 0.00E+00 | ND | 0.00E+00 | ND |
| salicylaldehyde | 0.00E+00 | ND | 0.00E+00 | ND |
| Terpinolene | 1.78E−03 | ND | 2.20E−03 | ND |
| tetrahydrolinalool | 0.00E+00 | ND | 0.00E+00 | ND |
| thymol | 0.00E+00 | ND | 0.00E+00 | ND |
| trans-2-Hexen-1-al | 0.00E+00 | ND | 0.00E+00 | ND |
| Valencene | 0.00E+00 | ND | 0.00E+00 | ND |
| valeraldehyde | 0.00E+00 | ND | 0.00E+00 | ND |
| vanillyl butyl ether | 0.00E+00 | ND | 0.00E+00 | ND |
| vanillyl ethyl ether | 0.00E+00 | ND | 0.00E+00 | ND |
| whiskey lactone | 0.00E+00 | ND | 0.00E+00 | ND |

ND = Not determined

TABLE 3A
VOCs in reference alcoholic beverages

| | Round 1 assays (values in mg/L) | | | | | | | | |
|---|---|---|---|---|---|---|---|---|---|
| | 1 | 1 | 1 | 2 | 2 | 2 | 3 | 3 | 3 |
| (−)-beta-pinene | NF | NF | NF | NF | NF | NF | NF | NF | NF |
| 1,1-diethoxyethane | 6.23E−01 | 5.65E−01 | 8.97E−01 | 1.17E+00 | 1.13E+00 | 1.10E+00 | 2.11E−01 | 3.76E−01 | 3.17E−01 |
| 2-methyl-1-butanol | 1.90E+02 | 1.52E+02 | 2.02E+02 | 4.72E+02 | 5.29E+02 | 5.07E+02 | 2.97E+02 | 3.18E+02 | 3.01E+02 |
| 2-phenylethanol | 2.50E−01 | 2.29E−01 | 2.73E−01 | 5.13E−01 | 5.48E−01 | 5.61E−01 | 7.43E−01 | 7.86E−01 | 7.45E−01 |
| 2-phenylethylacetate | 3.67E+01 | 2.78E+01 | 3.53E+01 | 3.07E+01 | 3.44E+01 | 3.50E+01 | 5.74E+01 | 6.85E+01 | 6.84E+01 |
| 4-Ethyl Guaiacol | NF | NF | NF | 3.06E−02 | 3.38E−02 | 3.85E−02 | 3.17E+00 | 3.50E+00 | 3.24E+00 |
| acetoin | NF | NF | NF | NF | NF | NF | NF | NF | NF |
| a-terpineol | NF | NF | NF | NF | NF | NF | NF | NF | NF |
| beta-ionone | NF | NF | NF | 1.79E−02 | 1.55E−02 | 1.60E−02 | NF | NF | NF |
| butanol | 8.51E+00 | 6.63E+00 | 7.68E+00 | 3.41E+00 | 2.44E+00 | 3.74E+00 | 9.54E+00 | 1.06E+01 | 1.03E+01 |
| citronellol | 2.15E−02 | 1.76E−02 | 2.32E−02 | 4.23E−03 | 9.40E−03 | 7.05E−03 | 8.17E−03 | 1.12E−02 | 4.30E−04 |
| damascenone | 4.26E−02 | 4.52E−02 | 4.73E−02 | 7.05E−03 | 7.99E−03 | 4.70E−03 | 5.33E−02 | 4.77E−02 | 4.73E−02 |
| diethyl succinate | 9.70E+00 | 8.14E+00 | 1.12E+01 | 1.23E+00 | 1.51E+00 | 1.22E+00 | 2.40E+00 | 2.69E+00 | 2.59E+00 |
| ethyl acetate | 2.93E+02 | 2.36E+02 | 2.70E+02 | 3.00E+02 | 3.35E+02 | 3.17E+02 | 1.30E+02 | 1.32E+02 | 1.24E+02 |
| ethyl butanoate | 9.84E−01 | 7.65E−01 | 1.05E+00 | 5.95E−01 | 6.83E−01 | 6.96E−01 | 6.05E−01 | 6.33E−01 | 6.05E−01 |
| ethyl cinnamate | 9.03E−03 | 9.03E−03 | 1.12E−02 | 8.46E−03 | 8.46E−03 | 9.40E−03 | 1.16E−02 | 1.12E−02 | 1.20E−02 |
| ethyl decanoate | 8.57E+00 | 1.06E+01 | 8.72E+00 | 4.62E+00 | 4.13E+00 | 4.48E+00 | 5.95E+00 | 5.15E+00 | 5.89E+00 |
| ethyl hexanoate | 2.09E−01 | 2.26E−01 | 2.58E−01 | 2.21E−02 | 2.73E−02 | 2.16E−02 | 4.47E−02 | 4.52E−02 | 4.17E−02 |
| ethyl isobutyrate | 1.67E+00 | 1.37E+00 | 1.67E+00 | 1.93E−01 | 2.64E−01 | 2.10E−01 | 5.79E−01 | 6.87E−01 | 6.50E−01 |
| ethyl isovalerate | 7.81E−01 | 6.42E−01 | 8.32E−01 | NF | NF | NF | 2.08E−01 | 2.91E−01 | 2.37E−01 |
| ethyl lactate | 4.70E+00 | 4.69E+00 | 4.62E+00 | NF | NF | NF | NF | NF | NF |
| ethyl laurate | 3.08E+01 | 3.39E+01 | 3.14E+01 | 1.40E+01 | 1.17E+01 | 1.36E+01 | 1.61E+01 | 1.46E+01 | 1.55E+01 |
| ethyl nonanoate | 5.13E−01 | 6.88E−01 | 5.87E−01 | 2.21E+00 | 2.06E+00 | 2.09E+00 | 1.30E+00 | 1.20E+00 | 1.31E+00 |
| ethyl octanoate | 3.71E+01 | 5.87E+01 | 5.31E+01 | 5.91E+00 | 5.91E+00 | 5.66E+00 | 9.67E+00 | 8.09E+00 | 9.29E+00 |
| ethyl-2-methylbutyrate | 7.15E−01 | 6.76E−01 | 7.92E−01 | 3.62E−02 | 2.77E−02 | 3.20E−02 | 2.24E−01 | 2.13E−01 | 2.30E−01 |
| eugenol | 2.37E−01 | 2.27E−01 | 2.74E−01 | 3.61E−01 | 3.22E−01 | 3.81E−01 | 3.64E−01 | 3.11E−01 | 3.25E−01 |
| guaiacol | 1.20E−02 | 2.15E−02 | 3.61E−02 | 1.36E−02 | 7.76E−02 | 4.70E−02 | 2.50E+00 | 3.09E+00 | 3.54E+00 |
| hexanol | 3.23E−02 | 2.75E−02 | 3.23E−02 | 9.26E−02 | 1.02E−01 | 1.09E−01 | 6.54E−02 | 7.48E−02 | 7.91E−02 |
| isoamyl acetate | 4.49E−01 | 3.56E−01 | 5.63E−01 | 1.93E+00 | 2.21E+00 | 2.16E+00 | 1.39E+00 | 1.50E+00 | 1.44E+00 |
| isoamyl alcohol | 6.47E+02 | 5.32E+02 | 6.76E+02 | 1.63E+03 | 1.86E+03 | 1.79E+03 | 1.04E+03 | 1.12E+03 | 9.29E+02 |
| isobutanol | 4.64E+02 | 3.16E+02 | 4.09E+02 | 7.96E+02 | 8.61E+02 | 7.57E+02 | 6.74E+02 | 7.74E+02 | 7.27E+02 |
| isobutyl acetate | 8.04E−02 | 7.05E−02 | 9.29E−02 | 1.47E−01 | 1.66E−01 | 1.36E−01 | 1.09E−01 | 1.10E−01 | 9.46E−02 |
| Isovaleraldehyde | 1.79E−01 | 1.92E−01 | 1.56E−01 | 3.29E−02 | 3.43E−02 | 3.53E−02 | 3.07E−01 | 3.56E−01 | 3.43E−01 |
| linalool oxide | 2.65E−01 | 2.13E−01 | 2.17E−01 | 2.61E−01 | 3.14E−01 | 2.69E−01 | NF | 2.37E−01 | 1.57E−01 |
| linalyl acetate | 5.59E−03 | 1.38E−02 | 4.30E−04 | 2.54E−02 | 1.03E−02 | 2.16E−02 | NF | NF | 2.15E−03 |
| Myrtenol | 3.00E−01 | 4.18E−01 | 3.85E−01 | 1.37E−01 | 1.56E−01 | 1.37E−01 | 2.00E−01 | 1.70E−01 | 1.97E−01 |
| propanol | 2.75E+02 | 2.00E+02 | 2.51E+02 | 1.35E+02 | 9.64E+01 | 1.39E+02 | 2.88E+02 | 3.05E+02 | 2.61E+02 |
| whiskey lactone | 5.36E−01 | 4.17E−01 | 5.67E−01 | 3.61E+00 | 3.89E+00 | 3.67E+00 | 1.46E+00 | 1.65E+00 | 1.43E+00 |

TABLE 3B
VOCs in reference alcoholic beverages

| | Round 2 assays (values in mg/L) | | | | | | | |
|---|---|---|---|---|---|---|---|---|
| | 1 | 1 | 1 | 2 | 2 | 2 | 3 | 3 |
| (−)-alpha-pinene | NF | NF | NF | BC | BC | ND | BC | BC |
| (−)-beta-pinene | NF | NF | NF | NF | NF | NF | NF | NF |
| (−)-cis-rose oxide | 1.33E−04 | 1.73E−04 | 1.69E−04 | 6.92E−04 | 5.40E−04 | 5.62E−04 | 2.26E−04 | 2.41E−04 |
| 1,1-diethoxyethane | 1.39E+00 | 1.45E+00 | 2.00E+00 | 2.53E+00 | 2.19E+00 | ND | 1.05E+00 | 1.02E+00 |
| 1-decanol | 1.44E−01 | 1.38E−01 | 1.38E−01 | 3.62E−02 | 3.83E−02 | 4.58E−02 | 3.13E−01 | 3.54E−01 |
| 1-octanol | 1.04E−01 | 1.12E−01 | 1.12E−01 | 1.21E−01 | 1.09E−01 | 9.45E−02 | 1.15E−01 | 1.16E−01 |
| 1-octen-3-ol | 2.00E−01 | 1.93E−01 | 1.87E−01 | 3.64E−01 | 4.16E−01 | 3.84E−01 | 1.06E−01 | 1.06E−01 |
| 2,3-pentadione | NF | NF | NF | NF | NF | NF | NF | NF |
| 2-heptanone | 3.44E−02 | 3.26E−02 | 3.27E−02 | BC | BC | BC | 3.08E−02 | 3.15E−02 |
| 2-methoxy-4-propylphenol | 1.23E−03 | 8.79E−04 | 9.42E−04 | 1.49E−03 | 1.38E−03 | 1.20E−03 | 3.16E−02 | 2.81E−02 |
| 2-methyl-1-butanol | 2.41E+02 | 2.08E+02 | 2.30E+02 | 2.55E+02 | 3.33E+02 | 2.45E+02 | 2.11E+02 | 2.64E+02 |
| 2-methylbutyl acetate | 2.80E−01 | 2.36E−01 | 3.59E−01 | 6.98E−01 | 7.77E−01 | 6.24E−01 | 5.63E−01 | 5.55E−01 |
| 2-methylbutyl isovalerate | BC | BC | BC | NF | NF | ND | NF | NF |
| 2-methylbutyraldehyde | 2.47E−02 | 2.83E−02 | 2.72E−02 | 1.57E−02 | 1.45E−02 | ND | 6.84E−02 | 7.11E−02 |
| 2-nonanol | NF | NF | NF | NF | NF | NF | NF | NF |
| 2-nonanone | 4.19E−02 | 4.20E−02 | 3.64E−02 | 1.72E−03 | 1.21E−03 | 5.42E−04 | 3.48E−02 | 3.47E−02 |
| 2-phenylethanol | 4.38E+01 | 4.48E+01 | 4.41E+01 | 4.46E+01 | 4.36E+01 | 4.56E+01 | 7.91E+01 | 7.30E+01 |
| 2-phenylethylacetate | 1.41E−01 | 1.32E−01 | 1.49E−01 | 2.22E−01 | 2.77E−01 | 2.67E−01 | 3.05E−01 | 3.21E−01 |
| 2-undecanone | 5.75E−04 | 6.13E−04 | 6.25E−04 | 4.49E−04 | 3.46E−04 | 3.82E−04 | 5.25E−04 | 6.23E−04 |
| 3-carene | BC | BC | BC | NF | NF | NF | NF | NF |
| 4-carvomenthenol | NF | NF | NF | BC | BC | BC | NF | NF |
| 4-Ethyl Guaiacol | 2.78E+00 | 2.68E+00 | 2.65E+00 | 3.60E+00 | 3.73E+00 | 3.55E+00 | 6.67E+01 | 6.78E+01 |
| 4-Ethyl Phenol | NF | NF | NF | NF | NF | NF | NF | NF |
| acetophenone | 2.71E−03 | 2.74E−03 | 2.73E−03 | 2.79E−03 | 3.09E−03 | 2.74E−03 | 4.07E−02 | 4.15E−02 |
| alpha ionone | NF | NF | NF | 8.25E−03 | 5.68E−03 | 7.03E−03 | 1.42E−03 | 1.44E−03 |
| amyl alcohol | 8.75E−03 | 9.18E−03 | 2.67E−03 | 1.17E−02 | 1.11E−02 | 1.85E−02 | 1.24E−02 | 1.17E−02 |
| amyl butyrate | NF | NF | NF | NF | NF | ND | NF | NF |
| a-terpineol | NF | NF | NF | NF | NF | NF | NF | NF |
| benzaldehyde | 1.42E−01 | 1.74E−01 | 1.59E−01 | BC | BC | BC | 5.50E−02 | 2.34E−02 |
| benzyl acetate | NF | NF | NF | NF | NF | NF | NF | NF |
| beta-ionone | 6.82E−04 | 6.80E−04 | 7.00E−04 | 1.25E−02 | 1.20E−02 | ND | 1.78E−03 | 1.75E−03 |
| butanol | 1.26E+01 | 1.10E+01 | 8.17E+00 | 5.19E+00 | 4.90E+00 | 5.01E+00 | 1.76E+01 | 1.73E+01 |
| butyl acetate | BC | BC | BC | 4.90E−02 | 2.30E−02 | 4.70E−02 | BC | BC |
| carvone | NF | NF | NF | 1.08E−03 | 1.06E−03 | 1.08E−03 | 1.12E−03 | 1.17E−03 |
| Cinnamaldehyde | 1.28E−03 | 1.74E−03 | 2.51E−03 | 2.18E−03 | 2.41E−03 | 2.37E−03 | 5.88E−03 | 2.67E−03 |
| cis-3-hexen-1-ol | 8.36E−02 | 7.87E−02 | 8.56E−02 | 8.25E−02 | 7.80E−02 | 7.62E−02 | 7.35E−02 | 7.23E−02 |
| cis-3-hexenyl acetate | 1.16E−03 | 1.38E−03 | 1.54E−03 | 5.96E−04 | 6.75E−04 | 6.16E−04 | 1.23E−03 | 1.07E−03 |
| citronellol | 4.87E−03 | 4.77E−03 | 4.76E−03 | 7.26E−03 | 7.12E−03 | 7.01E−03 | 6.21E−03 | 5.20E−03 |
| diethyl malate | 2.50E+01 | 2.06E+01 | 2.29E+01 | 1.91E+00 | 1.77E+00 | 1.39E+00 | 3.26E+00 | 3.31E+00 |
| ethyl 3-hydroxy hexanoate | 1.00E−02 | 1.01E−02 | 1.04E−02 | 1.02E−02 | 1.01E−02 | ND | 9.65E−03 | 9.68E−03 |
| ethyl acetate | 3.91E+02 | 3.88E+02 | 3.67E+02 | 3.55E+02 | 3.31E+02 | 3.42E+02 | 1.11E+02 | 1.07E+02 |
| ethyl benzoate | 1.09E−02 | 1.06E−02 | 1.02E−02 | 1.11E−02 | 1.22E−02 | 1.13E−02 | 1.79E−02 | 1.82E−02 |
| ethyl butanoate | 5.34E−01 | 5.10E−01 | 5.10E−01 | 2.97E−01 | 2.27E−01 | 2.98E−01 | 2.85E−01 | 2.86E−01 |
| ethyl cinnamate | 7.25E−04 | 7.42E−04 | 8.01E−04 | 4.64E−04 | 4.78E−04 | 4.95E−04 | 7.99E−04 | 8.64E−04 |
| ethyl decanoate | 1.53E+01 | 1.45E+01 | 1.38E+01 | 3.42E+00 | 4.09E+00 | 4.29E+00 | 3.53E+00 | 5.74E+00 |
| ethyl heptanoate | BC | BC | BC | BC | BC | BC | BC | BC |
| ethyl hexanoate | 2.00E+00 | 1.87E+00 | 1.91E+00 | 5.70E−01 | 2.78E−01 | 5.90E−01 | 6.09E−01 | 5.98E−01 |
| ethyl isobutyrate | 2.34E+00 | 2.46E+00 | 2.72E+00 | 3.70E−01 | 3.29E−01 | ND | 1.08E+00 | 1.08E+00 |
| ethyl isovalerate | 7.14E−01 | 7.23E−01 | 6.43E−01 | 3.31E−02 | 3.96E−02 | 3.43E−02 | 1.21E−01 | 1.96E−01 |
| ethyl lactate | 2.58E+01 | 2.10E+01 | 3.11E+01 | 7.64E+00 | 6.83E+00 | ND | 6.96E+00 | 8.68E+00 |
| ethyl laurate | 1.78E+00 | 1.71E+00 | 1.61E+00 | 5.19E−01 | 6.07E−01 | ND | 6.70E−01 | 6.54E−01 |
| ethyl levulinate | 5.54E−02 | 5.51E−02 | 6.31E−02 | 1.55E−02 | 1.42E−02 | 1.51E−02 | 1.12E−02 | 1.74E−02 |
| ethyl myristate | 5.32E−02 | 5.08E−02 | 5.05E−02 | 4.48E−02 | 1.36E−02 | 1.90E−02 | 3.81E−02 | 1.37E−02 |
| ethyl nonanoate | 1.87E−02 | 1.50E−02 | 1.62E−02 | 4.78E−02 | 4.00E−02 | ND | 3.55E−02 | 3.52E−02 |
| ethyl octanoate | 1.58E+01 | 1.54E+01 | 1.65E+01 | 2.54E+00 | 2.03E+00 | ND | 4.60E+00 | 4.56E+00 |
| ethyl phenyl acetate | 5.75E−02 | 5.28E−02 | 5.25E−02 | 9.43E−02 | 1.04E−01 | 9.56E−02 | 4.41E−02 | 4.55E−02 |
| ethyl propionate | 1.42E+00 | 1.37E+00 | 1.32E+00 | 6.63E−01 | 5.00E−01 | 6.96E−01 | 1.25E+00 | 1.26E+00 |
| ethyl salicylate | BC | BC | BC | BC | BC | ND | BC | BC |
| ethyl trans-2-butenoate | 1.60E−02 | 1.54E−02 | 1.58E−02 | 8.91E−03 | 8.89E−03 | 7.88E−03 | 1.17E−02 | 1.04E−02 |
| ethyl trans-3-hexenoate | NF | NF | NF | NF | NF | NF | NF | NF |
| ethyl undecanoate | BC | BC | BC | BC | BC | BC | BC | BC |
| ethyl valerate | 6.13E−02 | 6.45E−02 | 7.20E−02 | 7.14E−02 | 6.01E−02 | ND | 1.12E−01 | 1.15E−01 |
| ethyl(methylthio) acetate | NF | NF | NF | NF | NF | NF | NF | NF |
| ethyl-2-methylbutyrate | 1.77E−01 | 1.85E−01 | 2.12E−01 | BC | BC | ND | 2.82E−02 | 2.79E−02 |
| eucalyptol | NF | NF | NF | NF | NF | NF | NF | NF |
| eugenol | 7.08E−02 | 6.87E−02 | 6.79E−02 | 1.27E−01 | 1.34E−01 | 1.25E−01 | 1.13E−01 | 1.16E−01 |
| farnesol | 2.36E−02 | 2.34E−02 | 2.27E−02 | 1.67E−02 | 1.67E−02 | 1.68E−02 | 2.44E−02 | 2.65E−02 |
| furfural | 9.22E+00 | 8.59E+00 | 8.85E+00 | 3.85E+00 | 4.65E+00 | 4.31E+00 | 6.06E+00 | 6.17E+00 |
| gamma-decalactone | 6.09E−02 | 6.26E−02 | 6.42E−02 | 7.19E−02 | 6.63E−02 | 8.53E−02 | 6.00E−02 | 9.04E−02 |
| gamma-nonalactone | 2.44E−02 | 2.42E−02 | 2.73E−02 | 2.25E−02 | 2.13E−02 | ND | 3.26E−02 | 3.30E−02 |
| gamma-terpinene | 1.62E−04 | 1.59E−04 | 1.61E−04 | 4.10E−04 | 3.66E−04 | ND | 4.10E−04 | 4.18E−04 |
| geraniol | 2.05E−02 | 2.11E−02 | 1.99E−02 | 2.37E−02 | 2.52E−02 | ND | 1.94E−02 | 1.96E−02 |
| geranyl acetone | 7.09E−03 | 7.03E−03 | 7.11E−03 | 1.62E−02 | 1.58E−02 | ND | 8.12E−03 | 8.08E−03 |
| guaiacol | 1.28E−02 | 1.22E−02 | 1.29E−02 | 2.60E−02 | 2.97E−02 | 2.61E−02 | 6.59E−01 | 7.12E−01 |
| heptyl acetate | BC | BC | BC | BC | BC | BC | BC | BC |
| hexanol | 1.60E+00 | 1.58E+00 | 1.47E+00 | 2.82E+00 | 2.65E+00 | 2.29E+00 | 2.07E+00 | 1.99E+00 |
| isoamyl acetate | 1.26E+00 | 1.16E+00 | 1.29E+00 | 2.59E+00 | 1.72E+00 | 3.02E+00 | 2.05E+00 | 1.92E+00 |
| isoamyl alcohol | 1.02E+02 | 1.05E+02 | 9.70E+01 | 1.45E+03 | 1.37E+03 | 1.84E+03 | 1.02E+03 | 7.68E+02 |
| isoamyl hexanoate | BC | BC | BC | BC | BC | BC | BC | BC |
| isoamyl isobutyrate | BC | BC | BC | BC | BC | BC | BC | BC |
| isoamyl isovalerate | BC | BC | BC | BC | BC | BC | BC | BC |
| isoamyl octanoate | 3.96E−03 | 4.18E−03 | 4.16E−03 | 5.33E−03 | 2.25E−03 | 4.47E−03 | 1.35E−03 | 1.04E−03 |
| isobutanol | 1.68E+02 | 1.44E+02 | 1.65E+02 | 3.14E+02 | 5.36E+02 | 4.66E+02 | 3.57E+02 | 3.08E+02 |
| isobutyl acetate | 7.02E−02 | 6.40E−02 | 7.12E−02 | 9.33E−02 | 7.07E−02 | 1.15E−01 | 7.23E−02 | 7.33E−02 |
| isobutyl isobutyrate | BC | BC | BC | NF | NF | NF | BC | BC |
| isobutyraldehyde | 5.74E−01 | 5.09E−01 | 4.77E−01 | 6.21E−02 | 4.39E−02 | 5.86E−02 | 2.38E−01 | 2.26E−01 |
| Isovaleraldehyde | 3.85E−01 | 4.01E−01 | 4.15E−01 | 2.04E−01 | 2.27E−01 | 1.79E−01 | 4.53E−01 | 4.33E−01 |
| limonene | 3.02E−05 | 3.45E−05 | 3.20E−05 | 1.21E−03 | 2.14E−03 | 1.32E−03 | 8.31E−06 | 2.43E−05 |
| linalool | NF | NF | NF | NF | NF | NF | NF | NF |
| linalool oxide | 3.63E−02 | 3.34E−02 | 3.34E−02 | 3.46E−02 | 3.95E−02 | 3.90E−02 | 5.07E−02 | 5.30E−02 |
| linalyl acetate | 2.25E−04 | 1.90E−04 | 1.41E−04 | 6.99E−04 | 7.17E−04 | 6.20E−04 | 7.13E−05 | BC |
| methional | 3.64E−03 | 3.49E−03 | 3.55E−03 | 3.84E−03 | 3.83E−03 | 3.81E−03 | 3.66E−03 | 3.61E−03 |
| methyl acetate | BC | BC | BC | 1.08E−01 | 1.36E−01 | 1.23E−01 | BC | BC |
| methyl hexanoate | BC | BC | BC | BC | BC | BC | BC | BC |
| methyl laurate | 1.52E−04 | 1.22E−04 | 1.15E−04 | BC | BC | BC | 1.02E−05 | BC |
| Methyl Octanoate | BC | BC | BC | BC | BC | BC | BC | BC |
| methyl salicylate | 1.01E−02 | 9.84E−03 | 9.75E−03 | 7.66E−03 | 7.72E−03 | 7.61E−03 | 7.45E−03 | 7.51E−03 |
| Myrcene | NF | NF | NF | NF | NF | NF | NF | NF |
| p-anisaldehyde | NF | NF | NF | NF | NF | NF | NF | NF |
| p-cresol | 1.73E−02 | 1.73E−02 | 1.77E−02 | 2.18E−02 | 1.96E−02 | ND | 2.52E+00 | 2.50E+00 |
| p-cymene | BC | BC | BC | BC | BC | ND | BC | BC |
| Phenethyl Butyrate | 3.44E−03 | 3.44E−03 | 3.43E−03 | 3.66E−03 | 3.68E−03 | 3.77E−03 | 3.65E−03 | 3.67E−03 |
| phenethyl formate | 2.49E−02 | 2.49E−02 | 2.50E−02 | 2.69E−02 | 2.69E−02 | ND | 2.64E−02 | 2.65E−02 |
| phenethyl octanoate | 2.91E−03 | 2.87E−03 | 2.78E−03 | 4.87E−04 | 4.61E−04 | 4.70E−04 | 1.94E−03 | 2.05E−03 |
| phenethyl propionate | 4.98E−04 | 4.88E−04 | 4.62E−04 | 5.93E−04 | 5.37E−04 | 6.02E−04 | 7.43E−04 | 7.77E−04 |
| propanol | 2.75E+02 | 2.83E+02 | 3.74E+02 | 1.50E+02 | 1.50E+02 | ND | 3.42E+02 | 3.19E+02 |
| propyl acetate | 1.12E−01 | 9.50E−02 | 1.03E−01 | 3.90E−02 | 4.06E−02 | 5.19E−02 | 6.20E−02 | 5.70E−02 |
| salicylaldehyde | 9.43E−03 | 9.37E−03 | 9.46E−03 | 8.85E−03 | 8.25E−03 | 8.33E−03 | 9.59E−03 | 1.03E−02 |
| vanillyl ethyl ether | 2.66E−02 | 2.74E−02 | 2.60E−02 | 2.15E−02 | 2.14E−02 | 2.18E−02 | 3.41E−02 | 3.13E−02 |
| whiskey lactone | 9.95E−01 | 1.05E+00 | 1.00E+00 | 5.56E+00 | 5.33E+00 | 5.37E+00 | 2.67E+00 | 2.49E+00 |

| | Round 2 assays (values in mg/L) | | | | | | |
|---|---|---|---|---|---|---|---|
| | 3 | 4 | 4 | 4 | 5 | 5 | 5 |
| (−)-alpha-pinene | BC | BC | BC | BC | BC | BC | BC |
| (−)-beta-pinene | NF | NF | NF | NF | NF | NF | NF |
| (−)-cis-rose oxide | 1.69E−04 | 6.67E−04 | 7.17E−04 | 6.89E−04 | NF | NF | NF |
| 1,1-diethoxyethane | 1.19E+00 | 1.46E+00 | 1.11E+00 | 8.00E−01 | 1.92E+00 | 1.58E+00 | 1.80E+00 |
| 1-decanol | 3.47E−01 | 7.95E−02 | 7.98E−02 | 9.25E−02 | 1.58E−01 | 1.73E−01 | 1.81E−01 |
| 1-octanol | 1.14E−01 | 1.80E−01 | 1.80E−01 | 1.78E−01 | 1.29E−01 | 1.08E−01 | 1.28E−01 |
| 1-octen-3-ol | 1.07E−01 | 1.21E−01 | 1.16E−01 | 1.26E−01 | 4.80E−02 | 5.10E−02 | 5.51E−02 |
| 2,3-pentadione | NF | NF | NF | NF | NF | NF | 7.26E−04 |
| 2-heptanone | 3.00E−02 | 5.50E−03 | 5.28E−03 | 5.51E−03 | 1.39E−02 | 1.31E−02 | 1.66E−02 |
| 2-methoxy-4-propylphenol | 2.75E−02 | 1.72E−03 | 1.64E−03 | 1.59E−03 | 1.91E−02 | 2.11E−02 | 2.46E−02 |
| 2-methyl-1-butanol | 2.63E+02 | 2.71E+02 | 2.91E+02 | 2.47E+02 | 2.39E+02 | 2.58E+02 | 2.40E+02 |
| 2-methylbutyl acetate | 5.26E−01 | 7.47E−01 | 7.30E−01 | 6.80E−01 | 7.74E−01 | 7.57E−01 | 8.66E−01 |
| 2-methylbutyl isovalerate | NF | NF | NF | NF | NF | NF | NF |
| 2-methylbutyraldehyde | 7.37E−02 | 1.74E−02 | 1.62E−02 | 1.38E−02 | 4.99E−02 | 4.12E−02 | 4.58E−02 |
| 2-nonanol | NF | NF | NF | NF | NF | NF | NF |
| 2-nonanone | 3.44E−02 | 6.30E−03 | 6.01E−03 | 7.23E−03 | 2.48E−02 | 2.37E−02 | 3.04E−02 |
| 2-phenylethanol | 7.92E+01 | 6.29E+01 | 5.99E+01 | 6.12E+01 | 6.07E+01 | 6.42E+01 | 4.23E+01 |
| 2-phenylethylacetate | 3.28E−01 | 2.03E−01 | 1.89E−01 | 2.23E−01 | 5.58E−01 | 5.77E−01 | 5.99E−01 |
| 2-undecanone | 6.61E−04 | 5.78E−04 | 5.87E−04 | 5.50E−04 | 6.68E−04 | 5.65E−04 | 4.00E−04 |
| 3-carene | NF | NF | NF | NF | NF | NF | NF |
| 4-carvomenthenol | NF | NF | NF | NF | NF | NF | NF |
| 4-Ethyl Guaiacol | 7.13E+01 | 2.12E+01 | 2.12E+01 | 2.23E+01 | 4.13E+01 | 4.21E+01 | 4.43E+01 |
| 4-Ethyl Phenol | NF | NF | NF | NF | NF | NF | NF |
| acetophenone | 4.19E−02 | 8.10E−03 | 8.10E−03 | 8.32E−03 | 3.04E−02 | 2.90E−02 | 3.47E−02 |
| alpha ionone | 1.48E−03 | 6.28E−03 | 5.66E−03 | 5.64E−03 | NF | NF | NF |
| amyl alcohol | 1.62E−02 | 1.58E−02 | 1.33E−02 | 1.49E−02 | 4.18E−03 | 3.10E−03 | 0.00E+00 |
| amyl butyrate | NF | NF | NF | NF | NF | NF | NF |
| a-terpineol | NF | NF | NF | NF | NF | NF | NF |
| benzaldehyde | 6.12E−02 | BC | BC | BC | BC | 5.90E−03 | BC |
| benzyl acetate | NF | NF | NF | NF | NF | NF | NF |
| beta-ionone | 1.85E−03 | 1.49E−02 | 1.39E−02 | 1.22E−02 | 5.89E−04 | 5.72E−04 | 5.66E−04 |
| butanol | 1.63E+01 | 9.25E+00 | 8.24E+00 | 8.71E+00 | 1.57E+01 | 1.54E+01 | 1.61E+01 |
| butyl acetate | BC | BC | BC | BC | 4.45E−01 | 4.58E−01 | 4.87E−01 |
| carvone | 1.14E−03 | 1.05E−03 | 1.03E−03 | 1.02E−03 | NF | NF | NF |
| Cinnamaldehyde | 7.12E−03 | 2.84E−03 | 2.47E−03 | 2.09E−03 | 1.71E−04 | 2.31E−03 | 1.05E−03 |
| cis-3-hexen-1-ol | 7.32E−02 | 7.77E−02 | 7.61E−02 | 7.54E−02 | 6.85E−02 | 6.66E−02 | 6.95E−02 |
| cis-3-hexenyl acetate | 1.19E−03 | 7.92E−04 | 8.79E−04 | 7.72E−04 | 8.69E−04 | 7.81E−04 | 8.31E−04 |
| citronellol | 5.71E−03 | 4.65E−03 | 4.49E−03 | 4.54E−03 | 4.04E−03 | 4.07E−03 | 3.43E−03 |
| diethyl malate | 3.03E+00 | 4.90E+00 | 4.84E+00 | 4.95E+00 | 2.41E+00 | 3.05E+00 | 2.88E+00 |
| ethyl 3-hydroxy hexanoate | 9.71E−03 | 1.01E−02 | 1.01E−02 | 9.95E−03 | 1.04E−02 | 1.02E−02 | 1.04E−02 |
| ethyl acetate | 1.21E+02 | 3.84E+02 | 3.91E+02 | 3.65E+02 | 1.24E+02 | 1.62E+02 | 8.51E+01 |
| ethyl benzoate | 1.89E−02 | 6.84E−03 | 7.08E−03 | 7.16E−03 | 1.09E−02 | 1.10E−02 | 1.14E−02 |
| ethyl butanoate | 2.73E−01 | 4.51E−01 | 4.20E−01 | 4.33E−01 | 4.36E−01 | 4.39E−01 | 4.57E−01 |
| ethyl cinnamate | 8.83E−04 | 7.20E−04 | 6.95E−04 | 8.56E−04 | 7.40E−04 | 7.67E−04 | 8.00E−04 |
| ethyl decanoate | 5.84E+00 | 5.19E+00 | 5.15E+00 | 4.31E+00 | 9.84E+00 | 9.23E+00 | 5.95E+00 |
| ethyl heptanoate | BC | BC | BC | BC | BC | BC | BC |
| ethyl hexanoate | 6.28E−01 | 1.01E+00 | 8.64E−01 | 8.37E−01 | 1.24E+00 | 1.22E+00 | 1.35E+00 |
| ethyl isobutyrate | 1.16E+00 | 6.88E−01 | 5.49E−01 | 4.68E−01 | 1.58E+00 | 1.41E+00 | 1.52E+00 |
| ethyl isovalerate | 2.14E−01 | 1.44E−01 | 1.34E−01 | 1.20E−01 | 2.52E−01 | 2.57E−01 | 1.64E−01 |
| ethyl lactate | 8.82E+00 | 3.73E+01 | 3.13E+01 | 2.61E+01 | 4.01E+00 | 2.95E+00 | 3.35E+00 |
| ethyl laurate | 7.44E−01 | 6.50E−01 | 5.92E−01 | 5.37E−01 | 1.36E+00 | 5.87E−01 | 1.39E+00 |
| ethyl levulinate | 1.56E−02 | 1.97E−02 | 2.02E−02 | 2.29E−02 | 1.41E−02 | 1.63E−02 | 1.62E−02 |
| ethyl myristate | 1.37E−02 | 4.16E−02 | 3.88E−02 | 3.46E−02 | 3.23E−02 | 2.97E−02 | 3.30E−02 |
| ethyl nonanoate | 3.98E−02 | 1.09E−01 | 8.58E−02 | 7.24E−02 | 1.84E−02 | 1.61E−02 | 1.74E−02 |
| ethyl octanoate | 4.89E+00 | 5.63E+00 | 4.40E+00 | 3.68E+00 | 1.02E+01 | 9.03E+00 | 9.68E+00 |
| ethyl phenyl acetate | 4.84E−02 | 1.31E−01 | 1.34E−01 | 1.41E−01 | 1.89E−02 | 1.95E−02 | 2.07E−02 |
| ethyl propionate | 1.18E+00 | 1.16E+00 | 1.04E+00 | 1.13E+00 | 1.33E+00 | 1.33E+00 | 1.40E+00 |
| ethyl salicylate | BC | BC | BC | BC | BC | BC | BC |
| ethyl trans-2-butenoate | 1.05E−02 | 1.17E−02 | 1.17E−02 | 1.16E−02 | 1.57E−02 | 1.70E−02 | 1.78E−02 |
| ethyl trans-3-hexenoate | NF | NF | NF | NF | NF | NF | NF |
| ethyl undecanoate | BC | BC | BC | BC | BC | BC | BC |
| ethyl valerate | 1.21E−01 | 1.05E−01 | 8.35E−02 | 6.99E−02 | 1.15E−01 | 9.86E−02 | 1.10E−01 |
| ethyl(methylthio) acetate | NF | NF | NF | NF | NF | NF | NF |
| ethyl-2-methylbutyrate | 3.06E−02 | 1.95E−02 | 1.06E−02 | 5.65E−03 | 4.92E−02 | 4.09E−02 | 4.46E−02 |
| eucalyptol | NF | NF | NF | NF | NF | NF | NF |
| eugenol | 1.23E−01 | 1.10E−01 | 1.09E−01 | 1.15E−01 | 7.50E−02 | 7.70E−02 | 8.13E−02 |
| farnesol | 2.55E−02 | 1.61E−02 | 1.61E−02 | 1.59E−02 | 1.96E−02 | 1.95E−02 | 1.77E−02 |
| furfural | 6.23E+00 | 2.98E+00 | 2.25E+00 | 2.64E+00 | 2.33E+00 | 2.39E+00 | 2.22E+00 |
| gamma-decalactone | 9.11E−02 | 9.90E−02 | 8.84E−02 | 7.02E−02 | 3.63E−02 | 3.30E−02 | 1.98E−02 |
| gamma-nonalactone | 3.13E−02 | 5.90E−02 | 5.59E−02 | 5.11E−02 | 2.18E−02 | 2.10E−02 | 2.10E−02 |
| gamma-terpinene | 4.49E−04 | 5.75E−04 | 4.63E−04 | 4.24E−04 | 2.37E−04 | 2.54E−04 | 2.82E−04 |
| geraniol | 1.96E−02 | 2.13E−02 | 2.12E−02 | 2.08E−02 | 2.03E−02 | 2.03E−02 | 2.04E−02 |
| geranyl acetone | 8.21E−03 | 1.43E−02 | 1.40E−02 | 1.31E−02 | 6.98E−03 | 6.91E−03 | 6.90E−03 |
| guaiacol | 7.40E−01 | 2.24E−02 | 1.95E−02 | 2.18E−02 | 4.42E−01 | 4.35E−01 | 4.64E−01 |
| heptyl acetate | BC | BC | BC | BC | BC | BC | BC |
| hexanol | 1.98E+00 | 2.30E+00 | 2.08E+00 | 2.19E+00 | 1.49E+00 | 1.28E+00 | 1.47E+00 |
| isoamyl acetate | 2.11E+00 | 2.13E+00 | 1.77E+00 | 1.73E+00 | 3.86E+00 | 3.77E+00 | 4.08E+00 |
| isoamyl alcohol | 8.01E+02 | 1.65E+03 | 1.92E+03 | 1.58E+03 | 4.99E+02 | 5.01E+02 | 2.71E+02 |
| isoamyl hexanoate | BC | BC | BC | BC | BC | BC | BC |
| isoamyl isobutyrate | BC | BC | BC | BC | BC | BC | BC |
| isoamyl isovalerate | BC | BC | BC | BC | BC | BC | BC |
| isoamyl octanoate | 1.70E−03 | 2.06E−03 | 1.77E−03 | 1.96E−03 | 1.94E−03 | 1.62E−03 | 1.63E−03 |
| isobutanol | 3.36E+02 | 2.35E+02 | 1.70E+02 | 2.68E+02 | 3.23E+02 | 3.02E+02 | 2.99E+02 |
| isobutyl acetate | 7.62E−02 | 7.35E−02 | 5.92E−02 | 5.41E−02 | 1.12E−01 | 1.07E−01 | 1.16E−01 |
| isobutyl isobutyrate | BC | NF | NF | NF | BC | BC | BC |
| isobutyraldehyde | 2.10E−01 | 3.93E−02 | 3.70E−02 | 3.99E−02 | 1.12E−01 | 1.17E−01 | 1.27E−01 |
| Isovaleraldehyde | 4.16E−01 | 1.51E−01 | 1.51E−01 | 1.50E−01 | 2.80E−01 | 2.89E−01 | 3.07E−01 |
| limonene | 3.31E−05 | 4.45E−03 | 4.04E−03 | 2.69E−03 | 3.04E−05 | 3.22E−05 | 3.10E−05 |
| linalool | NF | NF | NF | NF | NF | NF | NF |
| linalool oxide | 5.58E−02 | 4.13E−02 | 3.91E−02 | 4.17E−02 | 1.22E−02 | 1.38E−02 | 1.51E−02 |
| linalyl acetate | BC | BC | BC | BC | BC | BC | BC |
| methional | 3.61E−03 | 3.70E−03 | 3.69E−03 | 3.72E−03 | 3.56E−03 | 3.52E−03 | 0.00E+00 |
| methyl acetate | BC | 3.19E−02 | 1.90E−02 | 2.02E−02 | BC | BC | BC |
| methyl hexanoate | BC | BC | BC | BC | BC | BC | BC |
| methyl laurate | BC | BC | BC | BC | BC | BC | BC |
| Methyl Octanoate | BC | BC | BC | BC | BC | BC | BC |
| methyl salicylate | 7.52E−03 | 8.82E−03 | 8.89E−03 | 8.93E−03 | 6.26E−03 | 6.26E−03 | 6.30E−03 |
| Myrcene | NF | BC | BC | BC | NF | NF | NF |
| p-anisaldehyde | NF | NF | NF | NF | NF | NF | NF |
| p-cresol | 2.47E+00 | 2.36E−02 | 2.30E−02 | 2.20E−02 | 1.76E+00 | 1.75E+00 | 1.76E+00 |
| p-cymene | BC | BC | BC | BC | BC | BC | BC |
| Phenethyl Butyrate | 3.67E−03 | 3.92E−03 | 3.86E−03 | 4.06E−03 | 3.68E−03 | 3.70E−03 | 3.74E−03 |
| phenethyl formate | 2.64E−02 | 2.62E−02 | 2.58E−02 | 2.58E−02 | 2.73E−02 | 2.69E−02 | 2.50E−02 |
| phenethyl octanoate | 2.24E−03 | 5.64E−04 | 5.62E−04 | 5.71E−04 | 1.28E−03 | 1.26E−03 | 1.24E−03 |
| phenethyl propionate | 7.10E−04 | 9.79E−04 | 9.25E−04 | 9.34E−04 | 9.22E−04 | 7.88E−04 | 7.33E−04 |
| propanol | 3.44E+02 | 1.99E+02 | 1.76E+02 | 1.54E+02 | 3.68E+02 | 3.15E+02 | 3.45E+02 |
| propyl acetate | 6.34E−02 | 6.39E−02 | 5.26E−02 | 5.06E−02 | 9.20E−02 | 8.89E−02 | 9.19E−02 |
| salicylaldehyde | 1.06E−02 | 8.70E−03 | 8.14E−03 | 8.62E−03 | 8.90E−03 | 9.16E−03 | 9.43E−03 |
| vanillyl ethyl ether | 3.20E−02 | 2.73E−02 | 2.54E−02 | 2.15E−02 | 1.86E−02 | 1.86E−02 | 1.47E−02 |
| whiskey lactone | 2.45E+00 | 7.42E+00 | 6.69E+00 | 6.80E+00 | 6.96E−01 | 6.94E−01 | 4.15E−01 |

TABLE 3C
FOCs in reference alcoholic beverages

| Round 3 assays (values in mg/L) | 6 |
|---|---|
| (—)-alpha-pinene | 1.12E−03 |
| (—)-beta-pinene | 1.60E−04 |
| (—)-cis-rose oxide | NF |
| 1,1-diethoxyethane | 3.33E−01 |
| 1-decanol | 3.76E−03 |
| 1-octen-3-ol | 9.92E−03 |
| 2,3-pentadione | NF |
| 2-heptanone | 3.73E−04 |
| 2-methoxy-4-propylphenol | NF |
| 2-methyl-1-butanol | 4.59E−01 |
| 2-methylbutyl acetate | 1.32E−01 |
| 2-methylbutyl isovalerate | 2.67E−04 |
| 2-methylbutyraldehyde | 7.97E−03 |
| 2-nonanol | NF |
| 2-nonanone | 1.41E−03 |
| 2-phenylethanol | 2.99E−01 |
| 2-phenylethylacetate | 5.75E−02 |
| 2-undecanone | 2.93E−04 |
| 3-carene | 6.67E−04 |
| 4-carvomenthenol | NF |
| 4-ethyl guaiacol | NF |
| 4-ethyl phenol | NF |
| acetoin | 7.09E−03 |
| acetophenone | 1.97E−03 |
| alpha ionone | NF |
| amyl alcohol | 3.80E−02 |
| amyl butyrate | 2.40E−04 |
| a-terpineol | 2.93E−03 |
| benzaldehyde | 1.65E−03 |
| benzyl acetate | 1.63E−03 |
| beta-ionone | NF |
| butanol | 4.69E−01 |
| butyl acetate | 1.07E−04 |
| butyl formate | NF |
| butyraldehyde | NF |
| butyric acid | NF |
| carvone | 2.13E−03 |
| cinnamaldehyde | 1.87E−04 |
| cis-3-hexen-1-ol | NF |
| cis-3-hexenyl acetate | NF |
| citronellol | 7.76E−03 |
| damascenone | NF |
| decanoic acid | NF |
| delta-decalactone | NF |
| diethyl malate | NF |
| diethyl succinate | 5.87E−04 |
| ethyl 3-hydroxyhexanoate | NF |
| ethyl acetate | 9.41E+00 |
| ethyl benzoate | 1.55E−03 |
| ethyl butanoate | 2.26E−02 |
| ethyl cinnamate | 7.73E−04 |
| ethyl decanoate | 4.35E−01 |
| ethyl heptanoate | 6.03E−03 |
| ethyl hexanoate | 5.11E−02 |
| ethyl isobutyrate | 5.71E−03 |
| ethyl isovalerate | 1.76E−03 |
| ethyl lactate | 5.67E−02 |
| ethyl laurate | 4.23E−01 |
| ethyl levulinate | 5.37E−02 |
| ethyl myristate | 6.19E−02 |
| ethyl nonanoate | 2.11E−02 |
| ethyl octanoate | 4.80E−01 |
| ethyl phenyl acetate | 1.71E−03 |
| ethyl propionate | 1.71E−02 |
| ethyl salicylate | 2.67E−05 |
| ethyl trans-2-butenoate | 5.33E−05 |
| ethyl trans-3-hexenoate | NF |
| ethyl undecanoate | 2.72E−03 |
| ethyl valerate | 7.20E−04 |
| ethyl(methylthio) acetate | 1.07E−03 |
| ethyl-2-methylbutyrate | 1.81E−03 |
| eucalyptol | NF |
| eugenol | 3.20E−04 |
| furfural | 4.19E−03 |
| gamma-decalactone | NF |
| gamma-nonalactone | NF |
| gamma-terpinene | 8.80E−04 |
| geraniol | 1.31E−01 |
| geranyl acetone | 5.63E−03 |
| guaiacol | 1.04E−03 |
| heptyl acetate | 1.17E−03 |
| hexanoic acid | NF |
| hexanol | 6.63E−02 |
| isoamyl acetate | 6.60E−01 |
| isoamyl alcohol | 4.97E+01 |
| isoamyl hexanoate | 5.07E−04 |
| isoamyl isobutyrate | NF |
| isoamyl isovalerate | 3.73E−04 |
| isoamyl octanoate | 4.96E−03 |
| isobutanol | 1.84E+01 |
| isobutyl acetate | 1.33E−02 |
| isobutyl isobutyrate | NF |
| isobutyraldehyde | 1.62E−02 |
| isobutyric acid | NF |
| isovaleraldehyde | 1.74E−02 |
| isovaleric acid | NF |
| limonene | 2.67E−04 |
| linalool | 1.51E−02 |
| linalool oxide | NF |
| linalyl acetate | 2.67E−03 |
| maltol | NF |
| methional | NF |
| methyl acetate | NF |
| methyl decanoate | 3.71E−03 |
| methyl hexanoate | 9.87E−04 |
| methyl laurate | 2.75E−03 |
| methyl octanoate | 3.47E−04 |
| methyl salicylate | 8.00E−05 |
| myrcene | 3.09E−03 |
| nonanal | 1.07E−03 |
| nonanoic acid | 4.52E−02 |
| octanoic acid | NF |
| p-anisaldehyde | NF |
| p-cresol | NF |
| p-cymene | NF |
| phenethyl butyrate | 2.93E−04 |
| phenethyl formate | 2.93E−03 |
| phenethyl octanoate | NF |
| phenethyl propionate | NF |
| propanol | 1.97E+01 |
| propionaldehyde | NF |
| propionic acid | NF |
| propyl acetate | 4.88E−03 |
| salicylaldehyde | 1.07E−04 |
| valeraldehyde | 1.07E−04 |
| valeric acid | NF |
| vanillyl ethyl ether | NF |
| whiskey lactone | NF |

TABLE 17A
VOCs in reference alcoholic beverages

| | 1 | | 2 | | 3 | | 4 | | 5 | |
|---|---|---|---|---|---|---|---|---|---|---|
| VOCs (all values in mg/L) | min | max | min | max | min | max | min | max | min | max |
| (−)alpha-pinene | 0.00E+00 | 0.00E+00 | 9.00E−04 | 9.00E−04 | 0.00E+00 | 0.00E+00 | 0.00E+00 | 0.00E+00 | 9.00E−04 | 9.00E−04 |
| (−)cis-rose-oxide | 0.00E+00 | 0.00E+00 | 0.00E+00 | 0.00E+00 | 0.00E+00 | 0.00E+00 | 0.00E+00 | 0.00E+00 | 0.00E+00 | 1.40E−03 |
| 1,1-diethoxyethane | ND | ND | ND | ND | ND | ND | ND | ND | ND | ND |
| 1-decanol | ND | ND | 1.00E−04 | 1.00E−04 | ND | ND | ND | ND | 0.00E+00 | 1.00E−04 |
| 1-octanol | 1.20E−03 | 1.50E−03 | 0.00E+00 | 0.00E+00 | ND | ND | ND | ND | 0.00E+00 | 0.00E+00 |
| 1-octen-3-ol | 7.00E−04 | 1.20E−03 | 0.00E+00 | 0.00E+00 | 6.00E−04 | 6.00E−04 | 0.00E+00 | 0.00E+00 | 0.00E+00 | 0.00E+00 |
| 2-(methylthio)ethanol | 0.00E+00 | 0.00E+00 | 0.00E+00 | 0.00E+00 | 0.00E+00 | 0.00E+00 | 0.00E+00 | 1.00E−04 | 0.00E+00 | 0.00E+00 |
| 2,3-pentadione | ND | ND | 5.09E−02 | 5.79E−02 | ND | ND | ND | ND | 4.83E−02 | 5.85E−02 |
| 2,6-dimethyl-5-heptenal | ND | ND | 0.00E+00 | 0.00E+00 | ND | ND | ND | ND | 0.00E+00 | 0.00E+00 |
| 2,6-dimethylpyrazine | ND | ND | 0.00E+00 | 0.00E+00 | ND | ND | ND | ND | 0.00E+00 | 0.00E+00 |
| 2-acetylpyridine | ND | ND | 0.00E+00 | 0.00E+00 | ND | ND | ND | ND | 0.00E+00 | 0.00E+00 |
| 2-heptanone | 0.00E+00 | 0.00E+00 | 4.00E−04 | 4.00E−04 | ND | ND | ND | ND | 0.00E+00 | 0.00E+00 |
| 2-isobutyl-3-methoxypyrazine | 2.20E−03 | 1.68E−02 | 0.00E+00 | 0.00E+00 | 1.75E−02 | 6.31E−02 | ND | ND | 0.00E+00 | 0.00E+00 |
| 2-isopropyl-3- | 0.00E+00 | 0.00E+00 | 0.00E+00 | 0.00E+00 | 2.10E−03 | 2.50E−03 | ND | ND | 0.00E+00 | 0.00E+00 |
| methoxypyrazine | | | | | | | | | | |
| 2-methoxy-4-methylphenol | ND | ND | 0.00E+00 | 0.00E+00 | ND | ND | ND | ND | 0.00E+00 | 0.00E+00 |
| 2-methoxy-4-propyl-phenol | ND | ND | 0.00E+00 | 0.00E+00 | ND | ND | ND | ND | 0.00E+00 | 0.00E+00 |
| 2-methyl-1-butanol | 4.39E+01 | 4.71E+01 | 6.13E−02 | 4.15E−01 | 3.18E+01 | 3.76E+01 | ND | ND | 0.00E+00 | 4.01E+00 |
| 2-methylbutyl acetate | 2.41E−02 | 2.70E−02 | 0.00E+00 | 0.00E+00 | 9.90E−03 | 1.38E−02 | 8.87E−02 | 9.45E−02 | 0.00E+00 | 0.00E+00 |
| 2-methylbutyl isovalerate | ND | ND | ND | ND | ND | ND | ND | ND | ND | ND |
| 2-methylbutyraldehyde | ND | ND | 1.21E−02 | 1.53E−02 | ND | ND | ND | ND | 3.40E−03 | 6.50E−03 |
| 2-nonanol | ND | ND | ND | ND | ND | ND | ND | ND | ND | ND |
| 2-nonanone | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| 2-phenylethanol | 6.00E+01 | 6.28E+01 | 2.94E−02 | 3.14E−02 | 5.37E+01 | 5.85E+01 | ND | ND | 2.25E−01 | 2.54E−01 |
| 2-phenylethylacetate | 1.30E−03 | 1.40E−03 | 1.21E−02 | 1.26E−02 | 1.50E−03 | 1.50E−03 | ND | ND | 1.19E−02 | 1.22E−02 |
| 2-undecanone | 0.00E+00 | 0.00E+00 | 0.00E+00 | 0.00E+00 | ND | ND | ND | ND | 0.00E+00 | 0.00E+00 |
| 3-(methylthio)-1-propanol | 1.77E+00 | 2.11E+00 | 0.00E+00 | 0.00E+00 | 1.32E+00 | 2.04E+00 | ND | ND | 0.00E+00 | 0.00E+00 |
| 3,7-dimethyl-6-octanoic acid | ND | ND | ND | ND | ND | ND | ND | ND | ND | ND |
| 3,7-dimethyl-6-octenoic acid | ND | ND | ND | ND | ND | ND | ND | ND | ND | ND |
| 3,7-dimethyl-6-octenoic acid | ND | ND | 3.00E−04 | 4.00E−04 | ND | ND | ND | ND | 0.00E+00 | 2.00E−04 |
| 3-carene | ND | ND | 0.00E+00 | 1.00E−04 | ND | ND | ND | ND | 1.00E−04 | 2.00E−04 |
| 3-mercaptohexylacetate | 0.00E+00 | 1.00E−04 | 0.00E+00 | 0.00E+00 | 0.00E+00 | 2.00E−04 | ND | ND | 0.00E+00 | 0.00E+00 |
| 3-methyl-1-pentanol | 1.61E−01 | 2.33E−01 | 0.00E+00 | 0.00E+00 | 2.01E−01 | 2.19E−01 | 0.00E+00 | 4.00E−04 | 0.00E+00 | 0.00E+00 |
| 3-nonen-2-one | ND | ND | 0.00E+00 | 0.00E+00 | ND | ND | ND | ND | 0.00E+00 | 0.00E+00 |
| 4-(4-Hydroxyphenyl)-2- | ND | ND | ND | ND | ND | ND | ND | ND | ND | ND |
| butanone | | | | | | | | | | |
| 4-carvomenthenol | 0.00E+00 | 1.00E−04 | 1.27E−02 | 1.29E−02 | 1.00E−04 | 1.00E−04 | 0.00E+00 | 0.00E+00 | 1.24E−02 | 1.25E−02 |
| 4-ethylguaiacol | 0.00E+00 | 1.00E−04 | 0.00E+00 | 0.00E+00 | 3.00E−04 | 1.30E−03 | ND | ND | 0.00E+00 | 0.00E+00 |
| 4-ethylphenol | 0.00E+00 | 0.00E+00 | 1.03E−01 | 1.04E−01 | 8.00E−03 | 9.20E−03 | ND | ND | 1.01E−01 | 1.02E−01 |
| 4-Hydroxy-2,5-dimethyl- | ND | ND | ND | ND | ND | ND | ND | ND | ND | ND |
| 3(2H)-furanone | | | | | | | | | | |
| acetal | ND | ND | ND | ND | ND | ND | ND | ND | ND | ND |
| acetaldehyde | ND | ND | 1.53E+00 | 1.85E+00 | ND | ND | ND | ND | 6.71E−01 | 8.06E−01 |
| acetaldehyde, diethyl acetal | 1.76E+01 | 2.14E+01 | ND | ND | ND | ND | ND | ND | ND | ND |
| acetoin | ND | ND | ND | ND | ND | ND | ND | ND | ND | ND |
| acetophenone | ND | ND | ND | ND | ND | ND | ND | ND | ND | ND |
| a-ionone | ND | ND | 0.00E+00 | 0.00E+00 | ND | ND | ND | ND | 0.00E+00 | 0.00E+00 |
| Amyl alcohol | ND | ND | 1.80E−03 | 1.49E−02 | ND | ND | ND | ND | 0.00E+00 | 2.12E−02 |
| amyl butyrate | 0.00E+00 | 0.00E+00 | 1.00E−04 | 1.00E−04 | ND | ND | ND | ND | 1.00E−04 | 1.00E−04 |
| Amyl formate | ND | ND | 0.00E+00 | 0.00E+00 | ND | ND | ND | ND | 0.00E+00 | 0.00E+00 |
| a-phellandrene | ND | ND | 6.00E−04 | 1.20E−03 | ND | ND | ND | ND | 1.00E−04 | 8.00E−04 |
| a-terpineol | 6.00E−04 | 7.00E−04 | 6.04E−02 | 6.40E−02 | 9.00E−04 | 1.00E−03 | 0.00E+00 | 0.00E+00 | 5.89E−02 | 6.07E−02 |
| benzaldehyde | 2.00E−04 | 4.00E−04 | 5.80E−03 | 7.00E−03 | ND | ND | ND | ND | 9.00E−04 | 1.30E−03 |
| benzyl acetate | ND | ND | 0.00E+00 | 0.00E+00 | ND | ND | ND | ND | 0.00E+00 | 0.00E+00 |
| benzyl alcohol | 1.50E−01 | 1.60E−01 | 0.00E+00 | 0.00E+00 | 1.26E−01 | 1.46E−01 | ND | ND | 0.00E+00 | 0.00E+00 |
| beta pinene | 0.00E+00 | 0.00E+00 | 1.10E−03 | 1.40E−03 | 0.00E+00 | 0.00E+00 | 0.00E+00 | 1.00E−04 | 1.10E−03 | 1.10E−03 |
| beta-ionone | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| butanol | 1.18E+00 | 1.22E+00 | 1.72E+00 | 1.75E+00 | 1.10E+00 | 1.20E+00 | ND | ND | 7.89E−01 | 9.36E−01 |
| butyl acetate | ND | ND | 9.00E−03 | 1.64E−02 | ND | ND | ND | ND | 2.57E−02 | 5.37E−02 |
| butyl formate | 2.11E+00 | 2.47E+00 | 2.81E+00 | 3.49E+00 | 1.83E+00 | 2.14E+00 | 6.04E−01 | 7.49E−01 | 4.16E+00 | 4.33E+00 |
| butyl isovalerate | ND | ND | 0.00E+00 | 0.00E+00 | ND | ND | ND | ND | 0.00E+00 | 0.00E+00 |
| butyric acid | 4.42E−02 | 4.84E−02 | 1.11E+00 | 1.30E+00 | 6.39E−02 | 6.71E−02 | ND | ND | 2.88E+00 | 3.23E+00 |
| carvone | 0.00E+00 | 1.00E−04 | 0.00E+00 | 0.00E+00 | ND | ND | ND | ND | 0.00E+00 | 0.00E+00 |
| cinnamaldehyde | 1.10E−03 | 1.90E−03 | 0.00E+00 | 0.00E+00 | ND | ND | ND | ND | 0.00E+00 | 0.00E+00 |
| cis-2-hexenol | ND | ND | ND | ND | ND | ND | ND | ND | ND | ND |
| cis-3-hexen-1-ol | 2.00E−03 | 1.55E−02 | 0.00E+00 | 0.00E+00 | 8.50E−03 | 1.97E−02 | ND | ND | 0.00E+00 | 0.00E+00 |
| cis-3-hexenyl acetate | ND | ND | 0.00E+00 | 0.00E+00 | ND | ND | ND | ND | 0.00E+00 | 0.00E+00 |
| citronellol | 0.00E+00 | 0.00E+00 | 0.00E+00 | 0.00E+00 | 0.00E+00 | 0.00E+00 | ND | ND | 6.70E−03 | 7.40E−03 |
| citronellyl acetate | ND | ND | 0.00E+00 | 0.00E+00 | ND | ND | ND | ND | 0.00E+00 | 0.00E+00 |
| damascenone | 4.30E−03 | 4.90E−03 | 4.64E−02 | 5.21E−02 | 1.59E−02 | 1.69E−02 | 0.00E+00 | 0.00E+00 | 4.69E−02 | 7.14E−02 |
| Damascone | ND | ND | 0.00E+00 | 0.00E+00 | ND | ND | ND | ND | 0.00E+00 | 0.00E+00 |
| decanal | ND | ND | 0.00E+00 | 0.00E+00 | ND | ND | ND | ND | 0.00E+00 | 0.00E+00 |
| decanoic acid | 1.51E−02 | 1.56E−02 | ND | ND | 4.87E−02 | 7.89E−02 | ND | ND | ND | ND |
| delta-decalactone | 2.00E−04 | 3.00E−04 | ND | ND | 1.00E−04 | 2.00E−04 | 1.00E−04 | 1.70E−03 | ND | ND |
| diacetyl | 3.29E−02 | 6.40E−02 | 1.76E+00 | 2.38E+00 | 4.43E−02 | 1.15E+00 | ND | ND | 9.64E−01 | 1.16E+00 |
| diethyl succinate | 1.46E+01 | 1.56E+01 | 0.00E+00 | 0.00E+00 | 1.10E+01 | 1.16E+01 | ND | ND | 2.46E−02 | 2.61E−02 |
| dimethyl anthranilate | ND | ND | 3.26E−02 | 3.82E−02 | ND | ND | ND | ND | 5.44E−02 | 6.37E−02 |
| dimethyl succinate | ND | ND | 0.00E+00 | 0.00E+00 | ND | ND | ND | ND | 0.00E+00 | 0.00E+00 |
| dimethyl sulfide | 1.79E−01 | 2.01E−01 | 0.00E+00 | 0.00E+00 | 1.38E−01 | 1.73E−01 | 1.30E−03 | 1.50E−03 | 0.00E+00 | 0.00E+00 |
| ethyl acetate | 4.78E+02 | 5.06E+02 | 3.18E+01 | 3.76E+01 | 2.67E+02 | 2.76E+02 | ND | ND | 1.39E+02 | 1.56E+02 |
| ethyl anthranilate | 1.00E−04 | 4.00E−04 | 0.00E+00 | 0.00E+00 | 1.00E−04 | 3.00E−04 | 1.00E−04 | 6.00E−04 | 0.00E+00 | 0.00E+00 |
| ethyl butanoate | 4.46E−02 | 4.69E−02 | 1.00E−03 | 1.10E−03 | 6.34E−02 | 6.73E−02 | ND | ND | 3.20E−03 | 3.40E−03 |
| ethyl cinnamate | 0.00E+00 | 0.00E+00 | 0.00E+00 | 0.00E+00 | 0.00E+00 | 2.00E−04 | ND | ND | 0.00E+00 | 0.00E+00 |
| ethyl decanoate | 1.78E−02 | 1.81E−02 | 3.64E−02 | 3.92E−02 | 7.31E−02 | 7.80E−02 | ND | ND | 3.57E−02 | 4.83E−02 |
| ethyl heptanoate | 1.00E−04 | 1.00E−04 | 9.00E−04 | 9.00E−04 | 1.00E−04 | 1.00E−04 | 0.00E+00 | 0.00E+00 | 9.00E−04 | 9.00E−04 |
| ethyl hexanoate | 1.81E−01 | 1.93E−01 | 3.30E−03 | 5.00E−03 | 5.08E−01 | 5.25E−01 | ND | ND | 8.70E−03 | 1.27E−02 |
| ethyl isobutyrate | 6.17E−02 | 6.58E−02 | 1.62E−02 | 1.71E−02 | 5.46E−02 | 5.76E−02 | ND | ND | 4.32E−02 | 4.90E−02 |
| ethyl isovalerate | 1.39E−02 | 1.49E−02 | 0.00E+00 | 0.00E+00 | 1.92E−02 | 1.97E−02 | ND | ND | 4.30E−03 | 4.60E−03 |
| ethyl lactate | 1.41E+02 | 1.43E+02 | 3.90E−03 | 1.24E−02 | 4.08E+01 | 5.62E+01 | ND | ND | 6.92E+00 | 9.86E+00 |
| ethyl laurate | 1.20E−03 | 1.80E−03 | 4.44E−02 | 4.58E−02 | 7.73E−02 | 9.76E−02 | 0.00E+00 | 0.00E+00 | 3.55E−02 | 4.91E−02 |
| ethyl myristate | 9.00E−04 | 1.40E−03 | 1.02E−02 | 1.28E−02 | 1.30E−02 | 1.45E−02 | 3.00E−04 | 1.30E−03 | 1.05E−02 | 1.59E−02 |
| ethyl nonanoate | 0.00E+00 | 0.00E+00 | 2.00E−03 | 2.00E−03 | 0.00E+00 | 0.00E+00 | 0.00E+00 | 0.00E+00 | 2.00E−03 | 2.00E−03 |
| ethyl octanoate | 5.59E−01 | 5.98E−01 | 1.54E−02 | 1.70E−02 | 1.54E+00 | 1.65E+00 | 4.96E−01 | 6.31E−01 | 3.85E−02 | 3.91E−02 |
| ethyl palmitate | 9.00E−04 | 9.00E−04 | 3.00E−04 | 8.00E−04 | 5.40E−02 | 5.68E−02 | 3.00E−04 | 5.00E−04 | 3.00E−04 | 9.00E−03 |
| ethyl phenyl acetate | ND | ND | 0.00E+00 | 0.00E+00 | ND | ND | ND | ND | 0.00E+00 | 0.00E+00 |
| ethyl propionate | 2.44E−01 | 2.79E−01 | 1.15E−01 | 1.24E−01 | 2.86E−01 | 3.17E−01 | 1.85E−01 | 2.23E−01 | 1.79E−01 | 1.82E−01 |
| ethyl undecanoate | ND | ND | 1.00E−04 | 1.00E−04 | ND | ND | ND | ND | 1.00E−04 | 1.00E−04 |
| ethyl valerate | 8.00E−04 | 1.00E−03 | 0.00E+00 | 0.00E+00 | ND | ND | ND | ND | 1.00E−04 | 1.00E−04 |
| ethyl-2-mercaptopropionate | 0.00E+00 | 0.00E+00 | 1.81E−01 | 1.83E−01 | 0.00E+00 | 2.00E−04 | ND | ND | 0.00E+00 | 0.00E+00 |
| ethyl-2-methylbutyrate | 1.67E−02 | 2.67E−02 | 7.00E−04 | 7.00E−04 | 2.02E−02 | 2.19E−02 | 1.00E−04 | 1.00E−04 | 1.50E−03 | 1.60E−03 |
| ethyl-3-hydroxybutyrate | 2.39E+00 | 2.87E+00 | 0.00E+00 | 3.50E−03 | ND | ND | ND | ND | 0.00E+00 | 2.00E−04 |
| ethyl-trans-2-butenoate | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| ethyl-trans-3-hexenoate | 0.00E+00 | 1.00E−04 | 0.00E+00 | 0.00E+00 | 1.00E−04 | 1.00E−04 | 0.00E+00 | 0.00E+00 | 0.00E+00 | 0.00E+00 |
| eucalyptol | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| eugenol | 1.47E−02 | 2.22E−02 | 0.00E+00 | 0.00E+00 | ND | ND | ND | ND | 0.00E+00 | 0.00E+00 |
| furfural | 1.54E−01 | 2.63E−01 | 9.85E−01 | 1.20E+00 | 2.14E−01 | 2.34E−01 | 3.44E−02 | 4.44E−02 | 4.48E−01 | 5.66E−01 |
| furfuryl ether | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| furfuryl mercaptan | 0.00E+00 | 3.00E−04 | 0.00E+00 | 0.00E+00 | 0.00E+00 | 0.00E+00 | 0.00E+00 | 4.00E−04 | 0.00E+00 | 1.30E−01 |
| gamma-decalactone | 0.00E+00 | 0.00E+00 | 0.00E+00 | 0.00E+00 | 0.00E+00 | 0.00E+00 | 1.00E−04 | 1.70E−03 | 0.00E+00 | 0.00E+00 |
| gamma-dodecalactone | ND | ND | 0.00E+00 | 0.00E+00 | ND | ND | ND | ND | 0.00E+00 | 0.00E+00 |
| gamma-nonalactone | 2.00E−04 | 4.00E−04 | 0.00E+00 | 0.00E+00 | 1.00E−04 | 2.00E−04 | 0.00E+00 | 0.00E+00 | 0.00E+00 | 0.00E+00 |
| gamma-octalactone | 8.00E−04 | 1.30E−03 | 0.00E+00 | 0.00E+00 | ND | ND | ND | ND | 0.00E+00 | 1.00E−04 |
| gamma-terpinene | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| gamma-undecalactone | 5.00E−04 | 1.20E−03 | 0.00E+00 | 0.00E+00 | ND | ND | ND | ND | 0.00E+00 | 0.00E+00 |
| geraniol | 6.00E−04 | 7.00E−04 | 0.00E+00 | 0.00E+00 | 1.30E−03 | 1.50E−03 | 3.00E−04 | 4.00E−04 | 0.00E+00 | 0.00E+00 |
| geranyl acetate | ND | ND | 0.00E+00 | 0.00E+00 | ND | ND | ND | ND | 0.00E+00 | 0.00E+00 |
| guaiacol | ND | ND | 0.00E+00 | 1.70E−03 | ND | ND | ND | ND | 3.20E−03 | 4.70E−03 |
| heptyl acetate | ND | ND | 0.00E+00 | 0.00E+00 | ND | ND | ND | ND | 0.00E+00 | 0.00E+00 |
| hexanal | 0.00E+00 | 0.00E+00 | ND | ND | ND | ND | ND | ND | ND | ND |
| hexanoic acid | 1.00E+02 | 1.10E+02 | ND | ND | 2.03E+02 | 2.17E+02 | 0.00E+00 | 0.00E+00 | ND | ND |
| Hexanol | 3.45E−01 | 5.38E−01 | 0.00E+00 | 0.00E+00 | 8.43E−01 | 1.01E+00 | ND | ND | 0.00E+00 | 4.09E−02 |
| hexyl acetate | 0.00E+00 | 1.00E−04 | 0.00E+00 | 0.00E+00 | 1.00E−04 | 1.00E−04 | 0.00E+00 | 0.00E+00 | 0.00E+00 | 0.00E+00 |
| hexyl hexanoate | ND | ND | 3.00E−04 | 3.00E−04 | ND | ND | ND | ND | 3.00E−04 | 4.00E−04 |
| isoamyl acetate | 2.06E−01 | 2.21E−01 | 2.86E−02 | 3.30E−02 | 1.39E−01 | 1.54E−01 | 9.97E−01 | 1.05E+00 | 3.37E−02 | 3.99E−02 |
| isoamyl alcohol | 1.25E+03 | 1.41E+03 | 1.50E+01 | 6.90E+01 | 1.06E+03 | 1.24E+03 | 1.97E+02 | 7.31E+02 | 1.74E+01 | 8.16E+01 |
| isoamyl hexanoate | 0.00E+00 | 1.00E−04 | 0.00E+00 | 0.00E+00 | 1.00E−04 | 1.00E−04 | 0.00E+00 | 0.00E+00 | 0.00E+00 | 0.00E+00 |
| isoamyl octanoate | 1.00E−04 | 2.00E−04 | 2.00E−04 | 3.00E−04 | 7.00E−04 | 9.00E−04 | 0.00E+00 | 1.00E−04 | 3.00E−04 | 5.00E−04 |
| isoborneol | 1.00E−04 | 2.00E−04 | 0.00E+00 | 0.00E+00 | ND | ND | ND | ND | 0.00E+00 | 0.00E+00 |
| isobutanol | 2.79E+02 | 3.26E+02 | 2.38E+01 | 1.78E+02 | 1.47E+02 | 1.86E+02 | 1.69E+02 | 2.24E+02 | 2.47E+01 | 1.50E+02 |
| isobutyl acetate | 4.18E−02 | 4.97E−02 | 9.10E−03 | 1.02E−02 | 1.25E−02 | 1.39E−02 | 7.63E−02 | 7.96E−02 | 1.23E−02 | 1.40E−02 |
| isobutyric acid | ND | ND | 1.53E−01 | 1.67E−01 | ND | ND | ND | ND | 2.96E−01 | 3.78E−01 |
| isovaleraldehyde | 1.58E−01 | 1.60E−01 | 6.58E−02 | 7.35E−02 | ND | ND | ND | ND | 3.70E−02 | 4.05E−02 |
| isovaleric acid | 1.55E+01 | 1.76E+01 | 0.00E+00 | 0.00E+00 | 1.92E+01 | 2.07E+01 | 1.47E+00 | 2.58E+00 | 0.00E+00 | 0.00E+00 |
| Jasmine lactone | ND | ND | 0.00E+00 | 0.00E+00 | ND | ND | ND | ND | 0.00E+00 | 0.00E+00 |
| limonene | 0.00E+00 | 2.00E−04 | 0.00E+00 | 0.00E+00 | 0.00E+00 | 2.00E−04 | 0.00E+00 | 0.00E+00 | 0.00E+00 | 0.00E+00 |
| linalool | 0.00E+00 | 0.00E+00 | 2.30E−03 | 3.50E−03 | 0.00E+00 | 2.00E−04 | 0.00E+00 | 0.00E+00 | 2.00E−03 | 2.20E−03 |
| linalool oxide | 8.59E−02 | 9.77E−02 | 1.24E−02 | 1.34E−02 | ND | ND | ND | ND | 1.00E−02 | 1.39E−02 |
| linalyl acetate | 1.10E−03 | 1.20E−03 | 0.00E+00 | 0.00E+00 | 1.70E−03 | 1.90E−03 | 5.00E−04 | 5.00E−04 | 1.60E−03 | 1.60E−03 |
| linalyl butyrate | 1.00E−04 | 1.00E−04 | 0.00E+00 | 0.00E+00 | 1.00E−04 | 1.00E−04 | 0.00E+00 | 0.00E+00 | 0.00E+00 | 0.00E+00 |
| linalyl formate | ND | ND | 0.00E+00 | 0.00E+00 | ND | ND | ND | ND | 0.00E+00 | 0.00E+00 |
| maltol | 6.00E−04 | 8.00E−04 | 7.94E−02 | 7.99E−02 | 7.00E−04 | 1.00E−03 | 0.00E+00 | 2.00E−04 | 7.90E−02 | 7.92E−02 |
| methional | ND | ND | 0.00E+00 | 3.00E−04 | ND | ND | ND | ND | 1.00E−04 | 5.00E−04 |
| methyl anthranilate | 0.00E+00 | 2.00E−04 | 1.27E−02 | 1.27E−02 | 0.00E+00 | 1.00E−04 | 0.00E+00 | 3.00E−04 | 1.27E−02 | 1.27E−02 |
| methyl decanoate | 0.00E+00 | 1.00E−04 | 2.00E−03 | 2.10E−03 | 0.00E+00 | 0.00E+00 | 0.00E+00 | 0.00E+00 | 2.10E−03 | 2.10E−03 |
| methyl dihydrojasmonate | ND | ND | 0.00E+00 | 0.00E+00 | ND | ND | ND | ND | 0.00E+00 | 0.00E+00 |
| methyl hexanoate | 7.03E−01 | 7.44E−01 | 3.22E−02 | 3.97E−02 | 4.64E−01 | 4.85E−01 | 3.30E−03 | 4.00E−03 | 7.65E−02 | 7.76E−02 |
| methyl laurate | ND | ND | 4.00E−04 | 4.00E−04 | ND | ND | ND | ND | 4.00E−04 | 4.00E−04 |
| methyl octanoate | 1.00E−04 | 1.00E−04 | 0.00E+00 | 0.00E+00 | ND | ND | ND | ND | 0.00E+00 | 0.00E+00 |
| methyl salicylate | 0.00E+00 | 1.00E−04 | 1.19E−02 | 1.20E−02 | 0.00E+00 | 1.00E−04 | 0.00E+00 | 0.00E+00 | 1.23E−02 | 1.24E−02 |
| methyl vanillate | 0.00E+00 | 1.66E−02 | 0.00E+00 | 0.00E+00 | 0.00E+00 | 1.86E−02 | 0.00E+00 | 2.17E−02 | 0.00E+00 | 0.00E+00 |
| myrcene | 7.70E−03 | 8.30E−03 | 0.00E+00 | 1.00E−04 | ND | ND | ND | ND | 0.00E+00 | 0.00E+00 |
| myrtenol | 9.00E−03 | 9.90E−03 | 1.00E−04 | 3.00E−04 | ND | ND | ND | ND | 6.00E−04 | 7.00E−04 |
| nerol | 1.00E−04 | 1.00E−04 | 3.20E−03 | 4.20E−03 | 1.00E−04 | 2.00E−04 | 0.00E+00 | 0.00E+00 | 3.60E−03 | 4.30E−03 |
| neryl acetate | ND | ND | 0.00E+00 | 0.00E+00 | ND | ND | ND | ND | 0.00E+00 | 0.00E+00 |
| nonanal | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| octanoic acid | 5.50E−01 | 5.82E−01 | ND | ND | 1.51E+00 | 1.64E+00 | 0.00E+00 | 0.00E+00 | ND | ND |
| octyl acetate | ND | ND | 0.00E+00 | 0.00E+00 | ND | ND | ND | ND | 0.00E+00 | 1.00E−04 |
| p-anisaldehyde | ND | ND | 0.00E+00 | 0.00E+00 | ND | ND | ND | ND | 0.00E+00 | 0.00E+00 |
| p-cresol | ND | ND | 0.00E+00 | 0.00E+00 | ND | ND | ND | ND | 0.00E+00 | 0.00E+00 |
| p-cymene | 6.00E−04 | 6.00E−04 | 1.20E−03 | 1.20E−03 | 4.00E−04 | 4.00E−04 | 0.00E+00 | 0.00E+00 | 1.30E−03 | 1.30E−03 |
| phenethyl acetaldehyde | ND | ND | 0.00E+00 | 0.00E+00 | ND | ND | ND | ND | 0.00E+00 | 0.00E+00 |
| dimethyl acetal | | | | | | | | | | |
| phenethyl butyrate | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| phenethyl isobutyrate | ND | ND | ND | ND | ND | ND | ND | ND | ND | ND |
| phenethyl octanoate | ND | ND | 0.00E+00 | 8.00E−04 | ND | ND | ND | ND | 0.00E+00 | 2.20E−03 |
| phenethyl propionate | 0.00E+00 | 0.00E+00 | 2.20E−03 | 2.20E−03 | 0.00E+00 | 0.00E+00 | 0.00E+00 | 0.00E+00 | 2.20E−03 | 2.20E−03 |
| propanoic acid | 1.23E+01 | 1.82E+01 | ND | ND | 6.92E+00 | 1.23E+01 | 3.67E+01 | 8.50E+01 | ND | ND |
| propanol | 4.90E+01 | 5.92E+01 | 6.46E+01 | 6.93E+01 | 4.38E+01 | 5.75E+01 | 1.04E+02 | 1.41E+02 | 3.51E+01 | 4.05E+01 |
| propyl hexanoate | ND | ND | 0.00E+00 | 0.00E+00 | ND | ND | ND | ND | 0.00E+00 | 0.00E+00 |
| sotolon | ND | ND | ND | ND | ND | ND | ND | ND | ND | ND |
| trans-2-heptenal | ND | ND | 1.50E−03 | 1.80E−03 | ND | ND | ND | ND | 0.00E+00 | 0.00E+00 |
| trans-2-hexen-1-al | ND | ND | 0.00E+00 | 0.00E+00 | ND | ND | ND | ND | 0.00E+00 | 0.00E+00 |
| trans-2-hexen-1-ol | 1.48E−01 | 1.51E−01 | 0.00E+00 | 3.80E−03 | ND | ND | ND | ND | 0.00E+00 | 0.00E+00 |
| trans-2-pentenal | ND | ND | 6.08E−02 | 8.24E−02 | ND | ND | ND | ND | 3.92E−02 | 1.24E−01 |
| whiskey lactone | 1.09E−01 | 1.28E−01 | 0.00E+00 | 0.00E+00 | 4.30E−02 | 5.04E−02 | 0.00E+00 | 8.00E−04 | 0.00E+00 | 0.00E+00 |

TABLE 17B
VOCs in reference alcoholic beverages

| | 6 | | 7 | | 8 | | 9 | | 10 | |
|---|---|---|---|---|---|---|---|---|---|---|
| VOCs (all values in mg/L) | min | max | min | max | min | max | min | max | min | max |
| (−)alpha-pinene | ND | ND | 1.00E−03 | 1.00E−03 | 0.00E+00 | 0.00E+00 | 1.20E−03 | 1.20E−03 | 0.00E+00 | 0.00E+00 |
| (−)cis-rose-oxide | ND | ND | 0.00E+00 | 1.40E−03 | 0.00E+00 | 0.00E+00 | 0.00E+00 | 0.00E+00 | 0.00E+00 | 0.00E+00 |
| 1,1-diethoxyethane | ND | ND | ND | ND | ND | ND | ND | ND | ND | ND |
| 1-decanol | ND | ND | 0.00E+00 | 1.00E−04 | ND | ND | 0.00E+00 | 0.00E+00 | ND | ND |
| 1-octanol | ND | ND | 0.00E+00 | 0.00E+00 | ND | ND | 0.00E+00 | 0.00E+00 | ND | ND |
| 1-octen-3-ol | ND | ND | 0.00E+00 | 0.00E+00 | 6.00E−04 | 6.00E−04 | 0.00E+00 | 0.00E+00 | 6.00E−04 | 6.00E−04 |
| 2-(methylthio)ethanol | ND | ND | 0.00E+00 | 0.00E+00 | 0.00E+00 | 1.50E−03 | 0.00E+00 | 0.00E+00 | 0.00E+00 | 0.00E+00 |
| 2,3-pentadione | ND | ND | 6.72E−02 | 7.64E−02 | ND | ND | 9.83E−02 | 1.09E−01 | ND | ND |
| 2,6-dimethyl-5-heptenal | ND | ND | 0.00E+00 | 0.00E+00 | ND | ND | 0.00E+00 | 0.00E+00 | ND | ND |
| 2,6-dimethylpyrazine | ND | ND | 0.00E+00 | 0.00E+00 | ND | ND | 0.00E+00 | 0.00E+00 | ND | ND |
| 2-acetylpyridine | ND | ND | 0.00E+00 | 1.00E−04 | ND | ND | 0.00E+00 | 1.00E−04 | ND | ND |
| 2-heptanone | ND | ND | 0.00E+00 | 0.00E+00 | ND | ND | 1.40E−03 | 1.70E−03 | ND | ND |
| 2-isobutyl-3-methoxypyrazine | 4.00E−03 | 1.33E−02 | 0.00E+00 | 0.00E+00 | ND | ND | 0.00E+00 | 0.00E+00 | 2.20E−03 | 1.48E−02 |
| 2-isopropyl-3- | 0.00E+00 | 0.00E+00 | 0.00E+00 | 0.00E+00 | ND | ND | 1.86E−02 | 1.91E−02 | 2.00E−04 | 4.00E−04 |
| methoxypyrazine | | | | | | | | | | |
| 2-methoxy-4-methylphenol | ND | ND | 0.00E+00 | 0.00E+00 | ND | ND | 0.00E+00 | 0.00E+00 | ND | ND |
| 2-methoxy-4-propyl-phenol | ND | ND | 0.00E+00 | 0.00E+00 | ND | ND | 0.00E+00 | 0.00E+00 | ND | ND |
| 2-methyl-1-butanol | 2.91E+01 | 3.57E+01 | 0.00E+00 | 0.00E+00 | ND | ND | 7.86E−01 | 7.86E−01 | 4.31E+01 | 5.72E+01 |
| 2-methylbutyl acetate | 2.93E−02 | 3.31E−02 | 0.00E+00 | 0.00E+00 | 1.18E−02 | 1.27E−02 | 0.00E+00 | 0.00E+00 | 2.05E−02 | 2.40E−02 |
| 2-methylbutyl isovalerate | ND | ND | ND | ND | ND | ND | ND | ND | ND | ND |
| 2-methylbutyraldehyde | ND | ND | 5.50E−03 | 7.10E−03 | ND | ND | 1.45E−02 | 1.50E−02 | ND | ND |
| 2-nonanol | ND | ND | ND | ND | ND | ND | ND | ND | ND | ND |
| 2-nonanone | ND | ND | 0.00E+00 | 0.00E+00 | 0.00E+00 | 0.00E+00 | 3.00E−04 | 3.00E−04 | 0.00E+00 | 0.00E+00 |
| 2-phenylethanol | 4.89E+01 | 5.68E+01 | 2.05E−01 | 3.54E−01 | ND | ND | 1.51E−01 | 1.62E−01 | 6.33E+01 | 8.18E+01 |
| 2-phenylethylacetate | 3.90E−03 | 4.40E−03 | 1.21E−02 | 1.27E−02 | ND | ND | 1.31E−02 | 1.35E−02 | 1.40E−03 | 1.60E−03 |
| 2-undecanone | ND | ND | 0.00E+00 | 0.00E+00 | ND | ND | 0.00E+00 | 0.00E+00 | ND | ND |
| 3-(methylthio)-1-propanol | 1.37E+00 | 2.63E+00 | 0.00E+00 | 0.00E+00 | ND | ND | 0.00E+00 | 0.00E+00 | 1.88E+00 | 3.34E+00 |
| 3,7-dimethyl-6-octanoic acid | ND | ND | ND | ND | ND | ND | ND | ND | ND | ND |
| 3,7-dimethyl-6-octenoic acid | ND | ND | ND | ND | ND | ND | ND | ND | ND | ND |
| 3,7-dimethyl-6-octenoic acid | ND | ND | 0.00E+00 | 0.00E+00 | ND | ND | 0.00E+00 | 0.00E+00 | ND | ND |
| 3-carene | ND | ND | 1.00E−04 | 1.00E−04 | ND | ND | 3.00E−04 | 4.00E−04 | ND | ND |
| 3-mercaptohexylacetate | 0.00E+00 | 1.00E−04 | 0.00E+00 | 0.00E+00 | ND | ND | 0.00E+00 | 0.00E+00 | 0.00E+00 | 0.00E+00 |
| 3-methyl-1-pentanol | ND | ND | 0.00E+00 | 0.00E+00 | 5.21E−02 | 6.93E−02 | 0.00E+00 | 0.00E+00 | 2.41E−01 | 2.66E−01 |
| 3-nonen-2-one | ND | ND | 0.00E+00 | 0.00E+00 | ND | ND | 0.00E+00 | 0.00E+00 | ND | ND |
| 4-(4-Hydroxyphenyl)-2- | ND | ND | ND | ND | ND | ND | ND | ND | ND | ND |
| butanone | | | | | | | | | | |
| 4-carvomenthenol | ND | ND | 1.23E−02 | 1.24E−02 | 2.00E−04 | 2.00E−04 | 1.23E−02 | 1.23E−02 | 0.00E+00 | 1.00E−04 |
| 4-ethylguaiacol | 0.00E+00 | 1.00E−04 | 0.00E+00 | 0.00E+00 | ND | ND | 0.00E+00 | 0.00E+00 | 0.00E+00 | 1.00E−04 |
| 4-ethylphenol | 1.00E−04 | 1.00E−04 | 1.01E−01 | 1.01E−01 | ND | ND | 1.00E−01 | 1.00E−01 | 9.00E−04 | 1.80E−03 |
| 4-Hydroxy-2,5-dimethyl- | ND | ND | ND | ND | ND | ND | ND | ND | ND | ND |
| 3(2H)-furanone | | | | | | | | | | |
| acetal | ND | ND | ND | ND | ND | ND | ND | ND | ND | ND |
| acetaldehyde | ND | ND | 5.89E−01 | 7.43E−01 | ND | ND | 2.06E+00 | 2.24E+00 | ND | ND |
| acetaldehyde, diethyl acetal | ND | ND | ND | ND | ND | ND | ND | ND | ND | ND |
| acetoin | ND | ND | ND | ND | ND | ND | ND | ND | ND | ND |
| acetophenone | ND | ND | ND | ND | ND | ND | ND | ND | ND | ND |
| a-ionone | ND | ND | 0.00E+00 | 0.00E+00 | ND | ND | 0.00E+00 | 0.00E+00 | ND | ND |
| Amyl alcohol | ND | ND | 1.69E−02 | 2.24E−02 | ND | ND | 0.00E+00 | 2.17E−02 | ND | ND |
| amyl butyrate | ND | ND | 0.00E+00 | 1.00E−04 | ND | ND | 1.00E−04 | 1.00E−04 | ND | ND |
| Amyl formate | ND | ND | 0.00E+00 | 0.00E+00 | ND | ND | 0.00E+00 | 0.00E+00 | ND | ND |
| a-phellandrene | ND | ND | 3.00E−04 | 4.00E−04 | ND | ND | 9.00E−04 | 1.30E−03 | ND | ND |
| a-terpineol | ND | ND | 5.85E−02 | 5.98E−02 | 1.30E−03 | 1.60E−03 | 5.80E−02 | 5.88E−02 | 6.00E−04 | 6.00E−04 |
| benzaldehyde | ND | ND | 7.00E−04 | 9.00E−04 | ND | ND | 1.50E−03 | 1.80E−03 | ND | ND |
| benzyl acetate | ND | ND | 0.00E+00 | 0.00E+00 | ND | ND | 0.00E+00 | 0.00E+00 | ND | ND |
| benzyl alcohol | 1.26E−01 | 1.72E−01 | 0.00E+00 | 0.00E+00 | ND | ND | 0.00E+00 | 0.00E+00 | 1.70E−01 | 4.56E−01 |
| beta pinene | 0.00E+00 | 0.00E+00 | 1.10E−03 | 1.10E−03 | 1.00E−04 | 1.00E−04 | 1.10E−03 | 1.20E−03 | 0.00E+00 | 0.00E+00 |
| beta-ionone | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| butanol | 1.16E+00 | 1.59E+00 | 7.80E−01 | 9.84E−01 | ND | ND | 1.84E+00 | 1.88E+00 | 1.10E+00 | 1.36E+00 |
| butyl acetate | ND | ND | 1.62E−02 | 2.55E−02 | ND | ND | 4.89E−02 | 5.55E−02 | ND | ND |
| butyl formate | 1.70E+00 | 2.18E+00 | 4.28E+00 | 5.39E+00 | 1.21E+00 | 1.47E+00 | 3.31E+00 | 3.56E+00 | 2.24E+00 | 2.48E+00 |
| butyl isovalerate | ND | ND | 0.00E+00 | 0.00E+00 | ND | ND | 0.00E+00 | 0.00E+00 | ND | ND |
| butyric acid | 4.27E−02 | 5.74E−02 | 2.39E+00 | 2.89E+00 | ND | ND | 1.22E+01 | 1.23E+01 | 5.53E−02 | 5.79E−02 |
| carvone | ND | ND | 0.00E+00 | 0.00E+00 | ND | ND | 0.00E+00 | 0.00E+00 | ND | ND |
| cinnamaldehyde | ND | ND | 0.00E+00 | 0.00E+00 | ND | ND | 0.00E+00 | 0.00E+00 | ND | ND |
| cis-2-hexenol | ND | ND | ND | ND | ND | ND | ND | ND | ND | ND |
| cis-3-hexen-1-ol | 5.00E−03 | 1.58E−02 | 0.00E+00 | 1.33E−01 | ND | ND | 0.00E+00 | 0.00E+00 | 2.80E−03 | 2.10E−02 |
| cis-3-hexenyl acetate | ND | ND | 0.00E+00 | 0.00E+00 | ND | ND | 0.00E+00 | 0.00E+00 | ND | ND |
| citronellol | 0.00E+00 | 0.00E+00 | 5.70E−03 | 7.70E−03 | ND | ND | 0.00E+00 | 0.00E+00 | 0.00E+00 | 0.00E+00 |
| citronellyl acetate | ND | ND | 0.00E+00 | 0.00E+00 | ND | ND | 0.00E+00 | 0.00E+00 | ND | ND |
| damascenone | ND | ND | 3.93E−02 | 4.65E−02 | 6.36E−02 | 7.05E−02 | 2.47E−02 | 2.68E−02 | 1.18E−02 | 1.25E−02 |
| Damascone | ND | ND | 0.00E+00 | 0.00E+00 | ND | ND | 0.00E+00 | 0.00E+00 | ND | ND |
| decanal | ND | ND | 0.00E+00 | 0.00E+00 | ND | ND | 0.00E+00 | 0.00E+00 | ND | ND |
| decanoic acid | 9.80E−03 | 1.58E−02 | ND | ND | ND | ND | ND | ND | 2.31E−02 | 3.36E−02 |
| delta-decalactone | 2.00E−04 | 3.00E−04 | ND | ND | 2.00E−04 | 4.10E−03 | ND | ND | 0.00E+00 | 2.00E−04 |
| diacetyl | 7.84E−01 | 1.09E+00 | 1.14E+00 | 1.59E+00 | ND | ND | 1.91E+00 | 2.30E+00 | 1.23E−01 | 2.59E+00 |
| diethyl succinate | 7.12E+00 | 8.36E+00 | 2.31E−02 | 2.51E−02 | ND | ND | 2.35E−02 | 2.59E−02 | 2.23E+01 | 2.55E+01 |
| dimethyl anthranilate | ND | ND | 7.30E−02 | 9.52E−02 | ND | ND | 2.74E−02 | 2.78E−02 | ND | ND |
| dimethyl succinate | ND | ND | 0.00E+00 | 0.00E+00 | ND | ND | 0.00E+00 | 0.00E+00 | ND | ND |
| dimethyl sulfide | ND | ND | 0.00E+00 | 0.00E+00 | 1.22E−01 | 1.35E−01 | 0.00E+00 | 0.00E+00 | 1.05E−01 | 1.29E−01 |
| ethyl acetate | 2.23E+02 | 3.10E+02 | 1.13E+02 | 1.22E+02 | ND | ND | 8.01E+02 | 9.28E+02 | 3.52E+02 | 4.01E+02 |
| ethyl anthranilate | ND | ND | 0.00E+00 | 0.00E+00 | 1.00E−04 | 4.00E−04 | 0.00E+00 | 0.00E+00 | 1.00E−04 | 1.50E−03 |
| ethyl butanoate | 4.29E−02 | 5.72E−02 | 2.20E−03 | 2.30E−03 | ND | ND | 4.44E−02 | 4.76E−02 | 5.46E−02 | 5.64E−02 |
| ethyl cinnamate | 0.00E+00 | 0.00E+00 | 0.00E+00 | 0.00E+00 | ND | ND | 3.00E−04 | 4.00E−04 | 0.00E+00 | 0.00E+00 |
| ethyl decanoate | 1.71E−02 | 1.80E−02 | 2.86E−02 | 3.10E−02 | ND | ND | 1.93E−02 | 1.99E−02 | 2.74E−02 | 3.80E−02 |
| ethyl heptanoate | ND | ND | 0.00E+00 | 0.00E+00 | 1.00E−04 | 1.00E−04 | 1.10E−03 | 1.10E−03 | 1.00E−04 | 1.00E−04 |
| ethyl hexanoate | 3.48E−01 | 3.91E−01 | 5.90E−03 | 8.20E−03 | ND | ND | 1.00E−02 | 1.21E−02 | 2.57E−01 | 2.88E−01 |
| ethyl isobutyrate | 3.08E−02 | 4.15E−02 | 2.24E−02 | 2.76E−02 | ND | ND | 1.22E−01 | 1.37E−01 | 6.22E−02 | 6.48E−02 |
| ethyl isovalerate | 4.40E−03 | 5.30E−03 | 2.00E−03 | 2.30E−03 | ND | ND | 2.06E−02 | 2.40E−02 | 1.19E−02 | 1.24E−02 |
| ethyl lactate | 9.99E+01 | 1.15E+02 | 5.03E+00 | 6.62E+00 | ND | ND | 2.01E+01 | 2.33E+01 | 1.70E+02 | 1.99E+02 |
| ethyl laurate | 1.00E−04 | 2.00E−04 | 2.93E−02 | 3.71E−02 | 5.80E−03 | 9.40E−03 | 3.12E−02 | 3.58E−02 | 1.04E−02 | 1.17E−02 |
| ethyl myristate | ND | ND | 9.00E−03 | 1.18E−02 | 1.50E−03 | 1.80E−03 | 1.65E−02 | 1.89E−02 | 4.50E−03 | 6.80E−03 |
| ethyl nonanoate | 0.00E+00 | 0.00E+00 | 0.00E+00 | 0.00E+00 | 1.00E−04 | 1.00E−04 | 2.10E−03 | 2.10E−03 | 0.00E+00 | 0.00E+00 |
| ethyl octanoate | 1.38E+00 | 1.51E+00 | 2.39E−02 | 2.71E−02 | 7.99E−01 | 1.07E+00 | 2.38E−02 | 2.50E−02 | 8.81E−01 | 8.90E−01 |
| ethyl palmitate | ND | ND | 3.00E−04 | 1.10E−03 | 1.10E−03 | 1.50E−03 | 2.30E−03 | 6.00E−03 | 4.19E−02 | 4.84E−02 |
| ethyl phenyl acetate | ND | ND | 0.00E+00 | 0.00E+00 | ND | ND | 0.00E+00 | 0.00E+00 | ND | ND |
| ethyl propionate | 1.75E−01 | 2.13E−01 | 1.43E−01 | 1.48E−01 | 1.70E−01 | 1.87E−01 | 2.97E−01 | 3.23E−01 | 9.40E−02 | 1.83E−01 |
| ethyl undecanoate | ND | ND | 1.00E−04 | 1.00E−04 | ND | ND | 1.00E−04 | 1.00E−04 | ND | ND |
| ethyl valerate | ND | ND | 0.00E+00 | 0.00E+00 | ND | ND | 4.00E−04 | 4.00E−04 | ND | ND |
| ethyl-2-mercaptopropionate | 0.00E+00 | 1.00E−04 | 0.00E+00 | 0.00E+00 | ND | ND | 0.00E+00 | 0.00E+00 | 0.00E+00 | 0.00E+00 |
| ethyl-2-methylbutyrate | 5.30E−03 | 6.10E−03 | 9.00E−04 | 9.00E−04 | 5.20E−03 | 5.80E−03 | 3.70E−03 | 4.00E−03 | 1.64E−02 | 1.82E−02 |
| ethyl-3-hydroxybutyrate | ND | ND | 0.00E+00 | 0.00E+00 | ND | ND | 0.00E+00 | 1.80E−03 | ND | ND |
| ethyl-trans-2-butenoate | ND | ND | 0.00E+00 | 0.00E+00 | 0.00E+00 | 0.00E+00 | 0.00E+00 | 0.00E+00 | 0.00E+00 | 0.00E+00 |
| ethyl-trans-3-hexenoate | ND | ND | 0.00E+00 | 0.00E+00 | 0.00E+00 | 0.00E+00 | 0.00E+00 | 0.00E+00 | 1.00E−04 | 1.00E−04 |
| eucalyptol | ND | ND | 0.00E+00 | 0.00E+00 | 0.00E+00 | 0.00E+00 | 0.00E+00 | 0.00E+00 | 0.00E+00 | 0.00E+00 |
| eugenol | ND | ND | 0.00E+00 | 0.00E+00 | ND | ND | 0.00E+00 | 0.00E+00 | ND | ND |
| furfural | ND | ND | 3.32E−01 | 9.14E−01 | 2.63E−01 | 2.98E−01 | 2.45E+00 | 2.69E+00 | 5.91E−02 | 6.04E−02 |
| furfuryl ether | ND | ND | 0.00E+00 | 0.00E+00 | 0.00E+00 | 0.00E+00 | 0.00E+00 | 0.00E+00 | 0.00E+00 | 0.00E+00 |
| furfuryl mercaptan | 0.00E+00 | 2.00E−04 | 0.00E+00 | 1.30E−01 | 1.00E−04 | 4.00E−04 | 0.00E+00 | 0.00E+00 | 0.00E+00 | 0.00E+00 |
| gamma-decalactone | 0.00E+00 | 0.00E+00 | 0.00E+00 | 0.00E+00 | 2.00E−04 | 4.10E−03 | 0.00E+00 | 0.00E+00 | 0.00E+00 | 0.00E+00 |
| gamma-dodecalactone | ND | ND | 0.00E+00 | 0.00E+00 | ND | ND | 0.00E+00 | 0.00E+00 | ND | ND |
| gamma-nonalactone | ND | ND | 0.00E+00 | 0.00E+00 | 0.00E+00 | 1.00E−04 | 0.00E+00 | 0.00E+00 | 2.00E−04 | 3.00E−04 |
| gamma-octalactone | ND | ND | 1.00E−04 | 2.00E−04 | ND | ND | 0.00E+00 | 1.00E−04 | ND | ND |
| gamma-terpinene | ND | ND | 0.00E+00 | 0.00E+00 | 4.00E−04 | 4.00E−04 | 4.00E−04 | 4.00E−04 | 0.00E+00 | 0.00E+00 |
| gamma-undecalactone | ND | ND | 0.00E+00 | 0.00E+00 | ND | ND | 0.00E+00 | 0.00E+00 | ND | ND |
| geraniol | 1.40E−03 | 1.80E−03 | 0.00E+00 | 0.00E+00 | 2.70E−03 | 3.80E−03 | 0.00E+00 | 0.00E+00 | 7.00E−04 | 8.00E−04 |
| geranyl acetate | ND | ND | 0.00E+00 | 0.00E+00 | ND | ND | 0.00E+00 | 0.00E+00 | ND | ND |
| guaiacol | ND | ND | 0.00E+00 | 1.70E−03 | ND | ND | 1.26E−02 | 1.42E−02 | ND | ND |
| heptyl acetate | ND | ND | 0.00E+00 | 0.00E+00 | ND | ND | 0.00E+00 | 1.00E−04 | ND | ND |
| hexanal | ND | ND | ND | ND | ND | ND | ND | ND | ND | ND |
| hexanoic acid | 1.60E+02 | 1.74E+02 | ND | ND | 0.00E+00 | 0.00E+00 | ND | ND | 1.31E+02 | 1.34E+02 |
| Hexanol | 7.69E−01 | 1.06E+00 | 0.00E+00 | 4.12E−02 | ND | ND | 0.00E+00 | 0.00E+00 | 4.32E−01 | 6.10E−01 |
| hexyl acetate | ND | ND | 0.00E+00 | 0.00E+00 | 6.00E−04 | 6.00E−04 | 0.00E+00 | 0.00E+00 | 0.00E+00 | 0.00E+00 |
| hexyl hexanoate | ND | ND | 3.00E−04 | 3.00E−04 | ND | ND | 2.00E−04 | 2.00E−04 | ND | ND |
| isoamyl acetate | 6.27E−01 | 7.15E−01 | 3.90E−02 | 4.40E−02 | 1.69E−01 | 1.90E−01 | 1.11E−01 | 1.12E−01 | 2.06E−01 | 2.18E−01 |
| isoamyl alcohol | 9.96E+02 | 1.26E+03 | 1.86E+01 | 1.06E+02 | 3.65E+02 | 1.51E+03 | 1.57E+01 | 7.90E+01 | 1.31E+03 | 1.44E+03 |
| isoamyl hexanoate | ND | ND | 0.00E+00 | 0.00E+00 | 0.00E+00 | 0.00E+00 | 0.00E+00 | 0.00E+00 | 1.00E−04 | 1.00E−04 |
| isoamyl octanoate | ND | ND | 3.00E−04 | 5.00E−04 | 2.00E−04 | 3.00E−04 | 2.00E−04 | 4.00E−04 | 6.00E−04 | 7.00E−04 |
| isoborneol | ND | ND | 0.00E+00 | 0.00E+00 | ND | ND | 0.00E+00 | 0.00E+00 | ND | ND |
| isobutanol | 1.96E+02 | 2.77E+02 | 2.72E+01 | 2.08E+02 | 3.41E+02 | 4.80E+02 | 2.01E+01 | 1.27E+02 | 2.22E+02 | 2.89E+02 |
| isobutyl acetate | ND | ND | 1.14E−02 | 1.25E−02 | 3.66E−02 | 4.17E−02 | 3.65E−02 | 3.83E−02 | 2.92E−02 | 3.03E−02 |
| isobutyric acid | ND | ND | 1.79E−01 | 1.94E−01 | ND | ND | 9.15E−01 | 1.11E+00 | ND | ND |
| isovaleraldehyde | ND | ND | 4.02E−02 | 4.13E−02 | ND | ND | 4.10E−02 | 4.45E−02 | ND | ND |
| isovaleric acid | 6.46E+00 | 8.32E+00 | 0.00E+00 | 0.00E+00 | 2.94E+00 | 3.84E+00 | 4.37E−02 | 4.46E−02 | 1.35E+01 | 1.48E+01 |
| Jasmine lactone | ND | ND | 0.00E+00 | 0.00E+00 | ND | ND | 0.00E+00 | 4.10E−03 | ND | ND |
| limonene | 1.00E−04 | 5.00E−04 | 0.00E+00 | 0.00E+00 | 1.00E−04 | 1.00E−04 | 1.50E−03 | 1.70E−03 | 1.00E−04 | 2.00E−04 |
| linalool | 3.00E−04 | 1.80E−03 | 1.90E−03 | 2.20E−03 | 0.00E+00 | 1.00E−04 | 2.00E−03 | 2.20E−03 | 0.00E+00 | 4.00E−04 |
| linalool oxide | ND | ND | 7.00E−03 | 9.50E−03 | ND | ND | 8.70E−03 | 8.90E−03 | ND | ND |
| linalyl acetate | ND | ND | 0.00E+00 | 0.00E+00 | 3.60E−03 | 3.90E−03 | 0.00E+00 | 0.00E+00 | 1.10E−03 | 1.20E−03 |
| linalyl butyrate | ND | ND | 0.00E+00 | 0.00E+00 | 0.00E+00 | 0.00E+00 | 5.10E−03 | 5.10E−03 | 0.00E+00 | 0.00E+00 |
| linalyl formate | ND | ND | 0.00E+00 | 0.00E+00 | ND | ND | 0.00E+00 | 0.00E+00 | ND | ND |
| maltol | ND | ND | 7.90E−02 | 7.90E−02 | 6.00E−04 | 8.00E−04 | 7.92E−02 | 7.94E−02 | 7.00E−04 | 1.00E−03 |
| methional | ND | ND | 0.00E+00 | 3.00E−04 | ND | ND | 1.00E−04 | 4.00E−04 | ND | ND |
| methyl anthranilate | ND | ND | 1.27E−02 | 1.27E−02 | 0.00E+00 | 1.00E−04 | 1.27E−02 | 1.27E−02 | 0.00E+00 | 9.00E−04 |
| methyl decanoate | ND | ND | 2.00E−03 | 2.10E−03 | 1.00E−04 | 1.00E−04 | 2.00E−03 | 2.00E−03 | 0.00E+00 | 1.00E−04 |
| methyl dihydrojasmonate | ND | ND | 0.00E+00 | 0.00E+00 | ND | ND | 0.00E+00 | 0.00E+00 | ND | ND |
| methyl hexanoate | ND | ND | 5.81E−02 | 7.17E−02 | 4.28E−01 | 4.41E−01 | 3.97E−02 | 5.30E−02 | 2.18E−01 | 2.42E−01 |
| methyl laurate | ND | ND | 4.00E−04 | 4.00E−04 | ND | ND | 4.00E−04 | 4.00E−04 | ND | ND |
| methyl octanoate | ND | ND | 0.00E+00 | 0.00E+00 | ND | ND | 0.00E+00 | 0.00E+00 | ND | ND |
| methyl salicylate | ND | ND | 1.22E−02 | 1.22E−02 | 2.00E−04 | 3.00E−04 | 1.22E−02 | 1.24E−02 | 2.00E−04 | 3.00E−04 |
| methyl vanillate | ND | ND | 0.00E+00 | 0.00E+00 | 2.88E−02 | 4.09E−02 | 0.00E+00 | 0.00E+00 | 0.00E+00 | 6.44E−02 |
| myrcene | ND | ND | 0.00E+00 | 0.00E+00 | ND | ND | 1.00E−04 | 1.00E−04 | ND | ND |
| myrtenol | ND | ND | 3.00E−04 | 4.00E−04 | ND | ND | 5.00E−04 | 6.00E−04 | ND | ND |
| nerol | 2.00E−04 | 2.00E−04 | 4.00E−03 | 4.30E−03 | 1.70E−03 | 2.10E−03 | 2.30E−03 | 2.80E−03 | 1.00E−04 | 1.00E−04 |
| neryl acetate | ND | ND | 0.00E+00 | 0.00E+00 | ND | ND | 0.00E+00 | 0.00E+00 | ND | ND |
| nonanal | ND | ND | 0.00E+00 | 0.00E+00 | 0.00E+00 | 0.00E+00 | 0.00E+00 | 0.00E+00 | 0.00E+00 | 0.00E+00 |
| octanoic acid | 1.35E+00 | 1.49E+00 | ND | ND | 0.00E+00 | 0.00E+00 | ND | ND | 8.65E−01 | 8.93E−01 |
| octyl acetate | ND | ND | 0.00E+00 | 0.00E+00 | ND | ND | 0.00E+00 | 1.00E−04 | ND | ND |
| p-anisaldehyde | ND | ND | 0.00E+00 | 0.00E+00 | ND | ND | 0.00E+00 | 1.00E−04 | ND | ND |
| p-cresol | ND | ND | 0.00E+00 | 0.00E+00 | ND | ND | 3.56E−02 | 5.55E−02 | ND | ND |
| p-cymene | ND | ND | 1.20E−03 | 1.30E−03 | 8.00E−04 | 8.00E−04 | 2.90E−03 | 3.00E−03 | 3.00E−04 | 3.00E−04 |
| phenethyl acetaldehyde | ND | ND | 0.00E+00 | 0.00E+00 | ND | ND | 0.00E+00 | 0.00E+00 | ND | ND |
| dimethyl acetal | | | | | | | | | | |
| phenethyl butyrate | ND | ND | 0.00E+00 | 0.00E+00 | 0.00E+00 | 0.00E+00 | 0.00E+00 | 0.00E+00 | 0.00E+00 | 0.00E+00 |
| phenethyl isobutyrate | ND | ND | ND | ND | ND | ND | ND | ND | ND | ND |
| phenethyl octanoate | ND | ND | 0.00E+00 | 1.00E−03 | ND | ND | 0.00E+00 | 1.00E−03 | ND | ND |
| phenethyl propionate | ND | ND | 2.20E−03 | 2.20E−03 | 0.00E+00 | 0.00E+00 | 2.20E−03 | 2.20E−03 | 0.00E+00 | 0.00E+00 |
| propanoic acid | 7.65E+00 | 9.37E+00 | ND | ND | 4.73E+00 | 5.51E+01 | ND | ND | 2.31E+00 | 1.43E+01 |
| propanol | 4.96E+01 | 8.38E+01 | 3.57E+01 | 4.20E+01 | 5.25E+01 | 8.69E+01 | 1.74E+01 | 1.92E+01 | 2.22E+01 | 3.50E+01 |
| propyl hexanoate | ND | ND | 0.00E+00 | 0.00E+00 | ND | ND | 0.00E+00 | 0.00E+00 | ND | ND |
| sotolon | ND | ND | ND | ND | ND | ND | ND | ND | ND | ND |
| trans-2-heptenal | ND | ND | 5.00E−04 | 5.00E−04 | ND | ND | 5.00E−04 | 5.00E−04 | ND | ND |
| trans-2-hexen-1-al | ND | ND | 0.00E+00 | 0.00E+00 | ND | ND | 0.00E+00 | 0.00E+00 | ND | ND |
| trans-2-hexen-1-ol | ND | ND | 0.00E+00 | 0.00E+00 | ND | ND | 0.00E+00 | 0.00E+00 | ND | ND |
| trans-2-pentenal | ND | ND | 4.60E−02 | 1.31E−01 | ND | ND | 3.63E−02 | 9.85E−02 | ND | ND |
| whiskey lactone | 3.08E−02 | 4.92E−02 | 0.00E+00 | 0.00E+00 | 1.98E−02 | 2.89E−02 | 0.00E+00 | 0.00E+00 | 4.08E−02 | 4.62E−02 |

TABLE 17C
VOCs in reference alcoholic beverages

| | 11 | | 12 | | 13 | | 14 | | 15 | |
|---|---|---|---|---|---|---|---|---|---|---|
| VOCs (all values in mg/L) | min | max | min | max | min | max | min | max | min | max |
| (—)alpha-pinene | 0.00E+00 | 0.00E+00 | 0.00E+00 | 0.00E+00 | 0.00E+00 | 0.00E+00 | ND | ND | 9.00E−04 | 9.00E−04 |
| (—)cis-rose-oxide | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| 1,1-diethoxyethane | ND | ND | ND | ND | ND | ND | ND | ND | ND | ND |
| 1-decanol | 1.60E−03 | 1.90E−03 | ND | ND | 0.00E+00 | 1.00E−04 | 1.00E−04 | 4.00E−04 | 1.00E−04 | 1.00E−04 |
| 1-octanol | 6.00E−04 | 9.00E−04 | ND | ND | 0.00E+00 | 0.00E+00 | 1.00E−04 | 1.00E−04 | 0.00E+00 | 0.00E+00 |
| l-octen-3-ol | 3.00E−04 | 2.10E−03 | 1.00E−03 | 1.20E−03 | 3.00E−04 | 1.50E−03 | ND | ND | 0.00E+00 | 0.00E+00 |
| 2-(methylthio)ethanol | 0.00E+00 | 0.00E+00 | 0.00E+00 | 0.00E+00 | 0.00E+00 | 0.00E+00 | ND | ND | 0.00E+00 | 0.00E+00 |
| 2,3-pentadione | 1.79E−02 | 3.92E−02 | ND | ND | 3.32E−02 | 3.56E−02 | 4.62E−02 | 2.48E−01 | 3.56E−02 | 4.47E−02 |
| 2,6-dimethyl-5-heptenal | 0.00E+00 | 0.00E+00 | ND | ND | 0.00E+00 | 0.00E+00 | 0.00E+00 | 0.00E+00 | 0.00E+00 | 0.00E+00 |
| 2,6-dimethylpyrazine | 0.00E+00 | 0.00E+00 | ND | ND | 0.00E+00 | 0.00E+00 | 0.00E+00 | 0.00E+00 | 0.00E+00 | 0.00E+00 |
| 2-acetylpyridine | 1.00E−02 | 1.43E−02 | ND | ND | 0.00E+00 | 0.00E+00 | 0.00E+00 | 0.00E+00 | 0.00E+00 | 1.00E−04 |
| 2-heptanone | 2.00E−04 | 4.00E−04 | ND | ND | 1.10E−03 | 1.40E−03 | 4.00E−04 | 1.60E−03 | 2.00E−04 | 3.00E−04 |
| 2-isobutyl-3- | 0.00E+00 | 0.00E+00 | 0.00E+00 | 0.00E+00 | 0.00E+00 | 0.00E+00 | ND | ND | 0.00E+00 | 0.00E+00 |
| methoxypyrazine | | | | | | | | | | |
| 2-isopropyl-3- | 1.00E−04 | 6.00E−04 | 1.0E−04 | 1.00E−04 | 0.00E+00 | 0.00E+00 | ND | ND | 0.00E+00 | 0.00E+00 |
| methoxypyrazine | | | | | | | | | | |
| 2-methoxy-4- | 2.60E−03 | 3.50E−03 | ND | ND | 0.00E+00 | 4.00E−04 | 0.00E+00 | 0.00E+00 | 0.00E+00 | 0.00E+00 |
| methylphenol | | | | | | | | | | |
| 2-methoxy-4-propyl- | 0.00E+00 | 0.00E+00 | ND | ND | 0.00E+00 | 0.00E+00 | 4.90E−03 | 3.32E−02 | 0.00E+00 | 0.00E+00 |
| phenol | | | | | | | | | | |
| 2-methyl-1-butanol | 1.95E+02 | 2.68E+02 | 2.58E+02 | 2.58E+02 | 2.43E+02 | 4.60E+02 | ND | ND | 4.04E+00 | 4.04E+00 |
| 2-methylbutyl acetate | 2.21E−02 | 3.12E−02 | 1.24E−02 | 1.31E−01 | 2.02E−02 | 2.19E−02 | 2.22E−01 | 3.00E−01 | 0.00E+00 | 0.00E+00 |
| 2-methylbutyl isovalerate | ND | ND | ND | ND | ND | ND | ND | ND | ND | ND |
| 2-methylbutyraldehyde | 2.30E−03 | 3.00E−03 | ND | ND | 2.53E−02 | 3.33E−02 | 1.68E−02 | 1.69E−02 | 9.80E−03 | 1.35E−02 |
| 2-nonanol | ND | ND | ND | ND | ND | ND | ND | ND | ND | ND |
| 2-nonanone | 0.00E+00 | 0.00E+00 | 0.00E+00 | 0.00E+00 | 0.00E+00 | 0.00E+00 | 0.00E+00 | 1.00E−04 | 0.00E+00 | 0.00E+00 |
| 2-phenylethanol | 7.80E+01 | 1.27E+02 | 3.83E+01 | 4.01E+01 | 1.14E+00 | 1.66E+00 | 2.92E+01 | 3.01E+01 | 1.52E−02 | 1.70E−02 |
| 2-phenylethylacetate | 1.31E−02 | 3.82E−02 | 1.0E−04 | 1.0E−04 | 3.00E−04 | 3.00E−04 | 4.32E−01 | 7.60E−01 | 1.01E−02 | 1.05E−02 |
| 2-undecanone | 2.00E−04 | 2.00E−04 | ND | ND | 0.00E+00 | 0.00E+00 | 0.00E+00 | 0.00E+00 | 0.00E+00 | 0.00E+00 |
| 3-(methylthio)-1-propanol | 1.19E+00 | 1.65E+00 | 1.96E+00 | 2.08E+00 | 0.00E+00 | 2.35E−01 | 1.28E+00 | 1.48E+00 | 0.00E+00 | 0.00E+00 |
| 3,7-dimethyl-6-octanoic | ND | ND | ND | ND | ND | ND | 0.00E+00 | 0.00E+00 | ND | ND |
| acid | | | | | | | | | | |
| 3,7-dimethyl-6-octenoic | ND | ND | ND | ND | ND | ND | ND | ND | ND | ND |
| acid | | | | | | | | | | |
| 3,7-dimethyl-6-octenoic | 9.00E−04 | 1.00E−03 | ND | ND | 0.00E+00 | 0.00E+00 | ND | ND | 3.00E−04 | 4.00E−04 |
| acid | | | | | | | | | | |
| 3-carene | 4.30E−03 | 6.70E−03 | ND | ND | 0.00E+00 | 0.00E+00 | 0.00E+00 | 0.00E+00 | 1.00E−04 | 1.00E−04 |
| 3 -mercaptohexylacetate | 0.00E+00 | 0.00E+00 | 0.00E+00 | 0.00E+00 | 0.00E+00 | 0.00E+00 | ND | ND | 0.00E+00 | 0.00E+00 |
| 3-methyl-1-pentanol | 4.92E−02 | 8.80E−02 | 5.25E−02 | 5.64E−02 | 1.86E−02 | 1.19E−01 | ND | ND | 0.00E+00 | 0.00E+00 |
| 3-nonen-2-one | 2.20E−03 | 2.60E−03 | ND | ND | 0.00E+00 | 0.00E+00 | 1.00E−04 | 2.10E−03 | 0.00E+00 | 0.00E+00 |
| 4-(4-Hydroxyphenyl)-2- | ND | ND | ND | ND | ND | ND | ND | ND | ND | ND |
| butanone | | | | | | | | | | |
| 4-carvomenthenol | 1.30E−03 | 2.90E−03 | 1.00E−04 | 1.00E−04 | 1.00E−04 | 1.00E−04 | ND | ND | 1.25E−02 | 1.27E−02 |
| 4-ethylguaiacol | 0.00E+00 | 1.00E−04 | 0.00E+00 | 0.00E+00 | 0.00E+00 | 0.00E+00 | ND | ND | 0.00E+00 | 0.00E+00 |
| 4-ethylphenol | 1.00E−04 | 5.00E−04 | 1.00E−04 | 1.00E−04 | 0.00E+00 | 1.00E−04 | 2.00E−04 | 9.00E−04 | 1.03E−01 | 1.03E−01 |
| 4-Hydroxy-2,5-dimethyl- | ND | ND | ND | ND | ND | ND | ND | ND | ND | ND |
| 3(2H)-furanone | | | | | | | | | | |
| acetal | ND | ND | ND | ND | ND | ND | 6.55E−01 | 8.03E−01 | ND | ND |
| acetaldehyde | 8.80E−03 | 2.41E−02 | ND | ND | 3.30E+00 | 3.67E+00 | 4.72E−01 | 5.26E−01 | 1.18E+00 | 1.47E+00 |
| acetaldehyde, diethyl | ND | ND | ND | ND | ND | ND | 0.00E+00 | 0.00E+00 | ND | ND |
| acetal | | | | | | | | | | |
| acetoin | ND | ND | ND | ND | ND | ND | ND | ND | ND | ND |
| acetophenone | ND | ND | ND | ND | ND | ND | ND | ND | ND | ND |
| a-ionone | 1.00E−04 | 3.00E−04 | ND | ND | 0.00E+00 | 0.00E+00 | 0.00E+00 | 0.00E+00 | 0.00E+00 | 0.00E+00 |
| Amyl alcohol | 0.00E+00 | 4.34E−02 | ND | ND | 0.00E+00 | 2.28E−02 | 7.89E−02 | 9.40E−02 | 2.60E−03 | 1.41E−02 |
| amyl butyrate | 6.30E−03 | 7.30E−03 | ND | ND | 0.00E+00 | 0.00E+00 | 0.00E+00 | 0.00E+00 | 1.00E−04 | 1.00E−04 |
| Amyl formate | 0.00E+00 | 0.00E+00 | ND | ND | 0.00E+00 | 0.00E+00 | 0.00E+00 | 0.00E+00 | 0.00E+00 | 0.00E+00 |
| a-phellandrene | 5.60E−03 | 1.40E−02 | ND | ND | 0.00E+00 | 0.00E+00 | 1.00E−04 | 1.00E−04 | 8.00E−04 | 1.10E−03 |
| a-terpineol | 4.53E−01 | 7.24E−01 | 5.00E−04 | 6.00E−04 | 6.00E−04 | 7.00E−04 | ND | ND | 6.00E−02 | 6.34E−02 |
| benzaldehyde | 1.60E−03 | 2.00E−03 | ND | ND | 8.60E−03 | 9.50E−03 | 1.65E−02 | 4.33E−02 | 6.10E−03 | 6.20E−03 |
| benzyl acetate | 0.00E+00 | 0.00E+00 | ND | ND | 0.00E+00 | 0.00E+00 | 1.00E−04 | 1.70E−03 | 0.00E+00 | 0.00E+00 |
| benzyl alcohol | 0.00E+00 | 0.00E+00 | 2.09E+00 | 2.30E+00 | 0.00E+00 | 0.00E+00 | 9.10E−03 | 1.50E−02 | 0.00E+00 | 0.00E+00 |
| beta pinene | 3.10E−03 | 4.80E−03 | 0.00E+00 | 1.00E−04 | 0.00E+00 | 0.00E+00 | ND | ND | 1.10E−03 | 1.10E−03 |
| beta-ionone | 0.00E+00 | 0.00E+00 | 0.00E+00 | 0.00E+00 | 0.00E+00 | 0.00E+00 | ND | ND | 0.00E+00 | 0.00E+00 |
| butanol | 0.00E+00 | 0.00E+00 | 2.25E+00 | 2.32E+00 | 4.32E+00 | 8.15E+00 | 1.56E+00 | 2.40E+00 | 1.90E+00 | 2.03E+00 |
| butyl acetate | 1.27E−01 | 1.51E−01 | ND | ND | 3.41E−02 | 3.94E−02 | 3.94E−01 | 5.95E−01 | 0.00E+00 | 9.60E−03 |
| butyl formate | 1.03E+00 | 1.41E+00 | 1.03E+00 | 1.36E+00 | 7.58E−01 | 9.00E−01 | 6.31E−01 | 8.75E−01 | 3.31E+00 | 3.47E+00 |
| butyl isovalerate | 4.00E−04 | 6.00E−04 | ND | ND | 0.00E+00 | 0.00E+00 | 0.00E+00 | 2.00E−04 | 0.00E+00 | 0.00E+00 |
| butyric acid | 7.01E−02 | 9.93E−02 | 7.12E−02 | 8.55E−02 | 1.88E−02 | 3.07E−02 | 7.46E+01 | 1.13E+02 | 1.44E+00 | 1.62E+00 |
| carvone | 0.00E+00 | 0.00E+00 | ND | ND | 0.00E+00 | 0.00E+00 | 0.00E+00 | 0.00E+00 | 0.00E+00 | 0.00E+00 |
| cinnamaldehyde | 1.00E−04 | 1.00E−04 | ND | ND | 0.00E+00 | 0.00E+00 | 3.50E−03 | 3.50E−03 | 0.00E+00 | 0.00E+00 |
| cis-2-hexenol | ND | ND | ND | ND | ND | ND | 4.08E−02 | 7.72E−02 | ND | ND |
| cis-3-hexen-1-ol | 0.00E+00 | 0.00E+00 | 0.00E+00 | 0.00E+00 | 0.00E+00 | 0.00E+00 | ND | ND | 0.00E+00 | 1.34E−01 |
| cis-3-hexenyl acetate | 1.70E−03 | 2.30E−03 | ND | ND | 0.00E+00 | 0.00E+00 | 0.00E+00 | 0.00E+00 | 0.00E+00 | 0.00E+00 |
| citronellol | 0.00E+00 | 1.00E−04 | 0.00E+00 | 0.00E+00 | 0.00E+00 | 0.00E+00 | ND | ND | 5.00E−03 | 7.40E−03 |
| citronellyl acetate | 0.00E+00 | 0.00E+00 | ND | ND | 0.00E+00 | 0.00E+00 | 0.00E+00 | 0.00E+00 | 0.00E+00 | 0.00E+00 |
| damascenone | 4.30E−01 | 9.01E−01 | 9.10E−03 | 1.03E−02 | 2.60E−03 | 1.68E−02 | 1.22E−02 | 1.67E−02 | 7.63E−02 | 8.02E−02 |
| Damascone | 0.00E+00 | 0.00E+00 | ND | ND | 0.00E+00 | 0.00E+00 | ND | ND | 0.00E+00 | 0.00E+00 |
| decanal | 0.00E+00 | 0.00E+00 | ND | ND | 0.00E+00 | 0.00E+00 | 0.00E+00 | 0.00E+00 | 0.00E+00 | 0.00E+00 |
| decanoic acid | 5.60E−03 | 2.95E−01 | 1.00E−04 | 1.60E−03 | 3.48E−01 | 4.80E−01 | ND | ND | ND | ND |
| delta-decalactone | 2.00E−04 | 3.40E−03 | 2.00E−04 | 4.40E−03 | 2.00E−04 | 1.80E−03 | ND | ND | ND | ND |
| diacetyl | 0.00E+00 | 0.00E+00 | 2.97E+00 | 3.29E+00 | 0.00E+00 | 0.00E+00 | 1.88E−01 | 2.02E−01 | 1.36E+00 | 1.60E+00 |
| diethyl succinate | 7.86E−01 | 1.57E+00 | 1.87E+01 | 1.89E+01 | 1.99E−02 | 3.85E−02 | 8.11E−02 | 1.76E−01 | 0.00E+00 | 0.00E+00 |
| dimethyl anthranilate | 0.00E+00 | 0.00E+00 | ND | ND | 7.00E−04 | 3.40E−03 | 1.00E−04 | 2.20E−03 | 4.86E−02 | 6.39E−02 |
| dimethyl succinate | 0.00E+00 | 0.00E+00 | ND | ND | 0.00E+00 | 0.00E+00 | 0.00E+00 | 0.00E+00 | 0.00E+00 | 0.00E+00 |
| dimethyl sulfide | 9.70E−03 | 1.61E−02 | 8.85E−02 | 1.00E−01 | 3.60E−03 | 2.09E−01 | ND | ND | 0.00E+00 | 0.00E+00 |
| ethyl acetate | 1.53E+02 | 1.80E+02 | 3.99E+02 | 4.09E+02 | 2.14E+02 | 3.77E+02 | 1.37E+02 | 1.80E+02 | 7.13E+01 | 8.07E+01 |
| ethyl anthranilate | 0.00E+00 | 2.00E−03 | 1.00E−04 | 4.00E−04 | 1.00E−04 | 3.00E−04 | ND | ND | 0.00E+00 | 0.00E+00 |
| ethyl butanoate | 7.35E−02 | 1.17E−01 | 7.28E−02 | 9.05E−02 | 2.65E−02 | 4.34E−02 | 2.73E−01 | 6.03E−01 | 1.10E−03 | 1.50E−03 |
| ethyl cinnamate | 0.00E+00 | 0.00E+00 | 0.00E+00 | 0.00E+00 | 0.00E+00 | 0.00E+00 | 1.80E−03 | 3.40E−03 | 0.00E+00 | 0.00E+00 |
| ethyl decanoate | 3.20E−03 | 2.70E−01 | 1.00E−04 | 1.50E−03 | 1.59E−01 | 1.76E−01 | 7.90E−03 | 1.15E−02 | 5.12E−02 | 6.06E−02 |
| ethyl heptanoate | 0.00E+00 | 0.00E+00 | 1.00E−04 | 1.00E−04 | 2.00E−04 | 2.00E−04 | 0.00E+00 | 0.00E+00 | 9.00E−04 | 9.00E−04 |
| ethyl hexanoate | 3.14E−01 | 2.05E+00 | 9.97E−02 | 1.98E−01 | 3.06E−02 | 4.14E−02 | 1.24E+00 | 1.49E+00 | 6.30E−03 | 7.30E−03 |
| ethyl isobutyrate | 4.07E−02 | 6.46E−02 | 4.21E−02 | 4.93E−02 | 5.43E−02 | 8.59E−02 | 1.40E−03 | 2.60E−03 | 3.63E−02 | 4.15E−02 |
| ethyl isovalerate | 1.60E−03 | 4.80E−03 | 1.20E−03 | 1.80E−03 | 3.50E−03 | 5.70E−03 | 2.00E−04 | 2.00E−04 | 1.30E−03 | 1.40E−03 |
| ethyl lactate | 4.14E+00 | 9.61E+00 | 1.91E+02 | 1.99E+02 | 4.18E+00 | 1.05E+01 | 1.58E+00 | 4.68E+00 | 1.20E−03 | 5.40E−03 |
| ethyl laurate | 5.81E−02 | 1.01E−01 | 2.00E−04 | 3.00E−04 | 4.40E−01 | 5.50E−01 | ND | ND | 7.08E−02 | 8.42E−02 |
| ethyl myristate | 1.65E−02 | 2.20E−02 | 2.00E−03 | 2.20E−03 | 3.10E−03 | 3.42E−02 | ND | ND | 1.40E−02 | 1.54E−02 |
| ethyl nonanoate | 2.00E−04 | 2.00E−04 | 2.00E−04 | 2.00E−04 | 1.00E−04 | 1.0E−04 | ND | ND | 2.00E−03 | 2.00E−03 |
| ethyl octanoate | 5.31E+00 | 6.70E+00 | 5.60E−01 | 7.11E−01 | 4.56E−01 | 5.04E−01 | 5.31E−01 | 6.49E−01 | 2.90E−02 | 2.99E−02 |
| ethyl palmitate | 1.14E−02 | 1.71E−02 | 2.00E−03 | 4.20E−03 | 5.80E−03 | 2.03E−02 | ND | ND | 6.00E−04 | 8.00E−04 |
| ethyl phenyl acetate | 4.00E−04 | 6.00E−04 | ND | ND | 1.00E−04 | 1.00E−04 | 8.00E−04 | 2.70E−03 | 0.00E+00 | 0.00E+00 |
| ethyl propionate | 3.25E−02 | 4.44E−02 | 1.37E−01 | 1.47E−01 | 9.91E−02 | 1.19E−01 | 6.27E−02 | 7.68E−02 | 1.36E−01 | 1.47E−01 |
| ethyl undecanoate | 2.00E−04 | 2.00E−04 | ND | ND | 3.00E−04 | 4.00E−04 | 1.00E−04 | 8.60E−03 | 1.00E−04 | 1.00E−04 |
| ethyl valerate | 3.00E−04 | 5.00E−04 | ND | ND | 4.00E−04 | 7.00E−04 | 1.00E−04 | 1.00E−04 | 0.00E+00 | 0.00E+00 |
| ethyl-2- | 0.00E+00 | 0.00E+00 | 0.00E+00 | 0.00E+00 | 0.00E+00 | 0.00E+00 | ND | ND | 1.82E−01 | 1.82E−01 |
| mercaptopropionate | | | | | | | | | | |
| ethyl-2-methylbutyrate | 3.20E−03 | 4.60E−03 | 2.60E−03 | 3.00E−03 | 4.00E−03 | 4.30E−03 | 1.00E−04 | 1.00E−04 | 8.00E−04 | 1.00E−03 |
| ethyl-3-hydroxybutyrate | 3.09E−02 | 4.96E−02 | ND | ND | 0.00E+00 | 0.00E+00 | 3.69E−01 | 3.94E−01 | 0.00E+00 | 0.00E+00 |
| ethyl-trans-2-butenoate | 0.00E+00 | 0.00E+00 | 0.00E+00 | 0.00E+00 | 0.00E+00 | 0.00E+00 | 1.40E−03 | 2.60E−03 | 0.00E+00 | 0.00E+00 |
| ethyl-trans-3-hexenoate | 0.00E+00 | 0.00E+00 | 0.00E+00 | 0.00E+00 | 0.00E+00 | 0.00E+00 | ND | ND | 0.00E+00 | 0.00E+00 |
| eucalyptol | 2.00E−04 | 2.00E−04 | 0.00E+00 | 0.00E+00 | 0.00E+00 | 0.00E+00 | ND | ND | 0.00E+00 | 0.00E+00 |
| eugenol | 0.00E+00 | 4.50E−03 | ND | ND | 0.00E+00 | 0.00E+00 | 0.00E+00 | 0.00E+00 | 0.00E+00 | 0.00E+00 |
| furfural | 1.05E+00 | 4.62E+00 | 2.00E−01 | 2.34E−01 | 1.84E−01 | 4.84E+00 | 1.92E−02 | 4.36E−02 | 1.15E+00 | 1.35E+00 |
| furfuryl ether | 0.00E+00 | 0.00E+00 | 0.00E+00 | 0.00E+00 | 0.00E+00 | 0.00E+00 | ND | ND | 0.00E+00 | 0.00E+00 |
| furfuryl mercaptan | 0.00E+00 | 2.00E−04 | 0.00E+00 | 2.00E−04 | 0.00E+00 | 2.00E−04 | ND | ND | 0.00E+00 | 0.00E+00 |
| gamma-decalactone | 2.00E−04 | 3.40E−03 | 2.00E−04 | 4.40E−03 | 2.00E−04 | 1.80E−03 | ND | ND | 0.00E+00 | 0.00E+00 |
| gamma-dodecalactone | 0.00E+00 | 0.00E+00 | ND | ND | 0.00E+00 | 0.00E+00 | 0.00E+00 | 0.00E+00 | 0.00E+00 | 0.00E+00 |
| gamma-nonalactone | 1.00E−04 | 3.00E−04 | 1.00E−04 | 2.00E−04 | 1.00E−04 | 4.00E−04 | ND | ND | 0.00E+00 | 0.00E+00 |
| gamma-octalactone | 2.40E−03 | 4.60E−03 | ND | ND | 0.00E+00 | 0.00E+00 | 1.00E−04 | 1.00E−04 | 0.00E+00 | 0.00E+00 |
| gamma-terpinene | 3.00E−04 | 4.00E−04 | 1.00E−04 | 1.00E−04 | 0.00E+00 | 0.00E+00 | ND | ND | 0.00E+00 | 0.00E+00 |
| gamma-undecalactone | 0.00E+00 | 0.00E+00 | ND | ND | 0.00E+00 | 0.00E+00 | 0.00E+00 | 0.00E+00 | 0.00E+00 | 0.00E+00 |
| geraniol | 3.40E−03 | 5.50E−03 | 1.10E−03 | 1.40E−03 | 0.00E+00 | 0.00E+00 | 3.00E−04 | 5.00E−04 | 0.00E+00 | 0.00E+00 |
| geranyl acetate | 0.00E+00 | 0.00E+00 | ND | ND | 0.00E+00 | 0.00E+00 | 1.00E−04 | 1.00E−04 | 0.00E+00 | 0.00E+00 |
| guaiacol | 2.90E−03 | 3.50E−03 | ND | ND | 3.80E−03 | 4.30E−03 | 5.20E−03 | 5.50E−03 | 0.00E+00 | 1.70E−03 |
| heptyl acetate | 4.00E−04 | 4.00E−04 | ND | ND | 0.00E+00 | 0.00E+00 | 1.00E−04 | 3.00E−04 | 0.00E+00 | 0.00E+00 |
| hexanal | ND | ND | ND | ND | ND | ND | 0.00E+00 | 0.00E+00 | ND | ND |
| hexanoic acid | 0.00E+00 | 1.80E+00 | 0.00E+00 | 0.00E+00 | 0.00E+00 | 0.00E+00 | ND | ND | ND | ND |
| Hexanol | 3.95E−01 | 5.26E−01 | 1.64E+00 | 1.66E+00 | 2.93E−02 | 5.18E−02 | 1.79E−01 | 1.98E−01 | 0.00E+00 | 0.00E+00 |
| hexyl acetate | 1.40E−02 | 2.01E−02 | 3.00E−04 | 3.00E−04 | 1.0E−04 | 1.00E−04 | 0.00E+00 | 0.00E+00 | 0.00E+00 | 0.00E+00 |
| hexyl hexanoate | 1.50E−03 | 1.80E−03 | ND | ND | 1.30E−03 | 1.50E−03 | 2.00E−04 | 3.80E−03 | 4.00E−04 | 4.00E−04 |
| isoamyl acetate | 6.01E−01 | 8.56E−01 | 1.57E−01 | 1.81E−01 | 2.78E−02 | 2.97E−02 | 1.50E+00 | 1.79E+00 | 2.57E−02 | 2.83E−02 |
| isoamyl alcohol | 1.71E+01 | 1.44E+03 | 3.81E+02 | 1.16E+03 | 3.14E+01 | 5.16E+01 | 1.55E+01 | 3.06E+02 | 1.49E+01 | 6.86E+01 |
| isoamyl hexanoate | 0.00E+00 | 0.00E+00 | 0.00E+00 | 0.00E+00 | 0.00E+00 | 0.00E+00 | 5.00E−04 | 8.00E−04 | 0.00E+00 | 0.00E+00 |
| isoamyl octanoate | 1.50E−03 | 4.60E−03 | 2.00E−04 | 2.00E−04 | 2.00E−04 | 1.50E−03 | 2.00E−04 | 1.90E−03 | 2.00E−04 | 4.00E−04 |
| isoborneol | 2.60E−03 | 3.30E−03 | ND | ND | 0.00E+00 | 0.00E+00 | 3.00E−04 | 3.00E−04 | 0.00E+00 | 0.00E+00 |
| isobutanol | 5.40E+00 | 1.80E+02 | 3.23E+02 | 4.69E+02 | 3.06E+01 | 3.98E+01 | 9.28E+00 | 1.48E+02 | 2.28E+01 | 1.87E+02 |
| isobutyl acetate | 2.97E−02 | 3.85E−02 | 3.87E−02 | 4.27E−02 | 2.60E−02 | 3.82E−02 | 2.15E−01 | 2.74E−01 | 1.02E−02 | 1.21E−02 |
| isobutyric acid | 3.22E+00 | 4.91E+00 | ND | ND | 2.16E+00 | 2.37E+00 | 4.26E−01 | 6.87E−01 | 2.09E−01 | 2.64E−01 |
| isovaleraldehyde | 2.29E−02 | 2.90E−02 | ND | ND | 8.34E−02 | 9.41E−02 | 4.81E−02 | 8.47E−01 | 6.35E−02 | 7.20E−02 |
| isovaleric acid | 3.36E+00 | 3.88E+00 | 2.48E+00 | 3.40E+00 | 3.08E+00 | 4.12E+00 | 1.67E+00 | 2.30E+00 | 0.00E+00 | 0.00E+00 |
| Jasmine lactone | 1.00E−02 | 1.05E−02 | ND | ND | 0.00E+00 | 0.00E+00 | 5.10E−03 | 5.30E−03 | 0.00E+00 | 0.00E+00 |
| limonene | 1.50E−03 | 2.20E−03 | 0.00E+00 | 1.00E−04 | 0.00E+00 | 0.00E+00 | ND | ND | 0.00E+00 | 0.00E+00 |
| linalool | 8.88E−02 | 2.38E−01 | 0.00E+00 | 0.00E+00 | 0.00E+00 | 0.00E+00 | ND | ND | 2.30E−03 | 3.30E−03 |
| linalool oxide | 2.43E−01 | 3.63E−01 | ND | ND | 0.00E+00 | 0.00E+00 | 0.00E+00 | 0.00E+00 | 1.19E−02 | 1.45E−02 |
| linalyl acetate | 4.50E−03 | 4.90E−03 | 1.90E−03 | 2.10E−03 | 1.00E−03 | 1.10E−03 | 1.60E−03 | 1.80E−03 | 0.00E+00 | 0.00E+00 |
| linalyl butyrate | 1.00E−04 | 1.00E−04 | 0.00E+00 | 0.00E+00 | 0.00E+00 | 0.00E+00 | ND | ND | 5.40E−03 | 5.60E−03 |
| linalyl formate | 0.00E+00 | 0.00E+00 | ND | ND | 0.00E+00 | 0.00E+00 | 0.00E+00 | 0.00E+00 | 0.00E+00 | 0.00E+00 |
| maltol | 1.98E+00 | 3.78E+00 | 6.00E−04 | 8.00E−04 | 2.00E−04 | 3.20E−03 | ND | ND | 7.94E−02 | 7.98E−02 |
| methional | 2.00E−04 | 6.00E−04 | ND | ND | 0.00E+00 | 2.00E−04 | 6.00E−04 | 8.00E−04 | 0.00E+00 | 2.00E−04 |
| methyl anthranilate | 0.00E+00 | 6.00E−04 | 0.00E+00 | 2.00E−04 | 0.00E+00 | 1.00E−04 | ND | ND | 1.27E−02 | 1.27E−02 |
| methyl decanoate | 3.00E−04 | 4.00E−04 | 0.00E+00 | 0.00E+00 | 0.00E+00 | 0.00E+00 | 8.00E−04 | 1.40E−03 | 2.10E−03 | 2.10E−03 |
| methyl dihydrojasmonate | 0.00E+00 | 0.00E+00 | ND | ND | 0.00E+00 | 0.00E+00 | 5.90E−03 | 7.50E−03 | 0.00E+00 | 0.00E+00 |
| methyl hexanoate | 3.32E+00 | 3.54E+00 | 3.07E−01 | 3.28E−01 | 8.80E−03 | 5.38E−01 | 4.60E−03 | 7.10E−03 | 4.35E−02 | 5.54E−02 |
| methyl laurate | 6.00E−04 | 7.00E−04 | ND | ND | 4.00E−04 | 4.00E−04 | 4.00E−04 | 1.14E−02 | 5.00E−04 | 5.00E−04 |
| methyl octanoate | 9.31E−02 | 1.01E−01 | ND | ND | 0.00E+00 | 0.00E+00 | 3.00E−04 | 3.00E−04 | 0.00E+00 | 0.00E+00 |
| methyl salicylate | 1.00E−04 | 1.00E−04 | 2.00E−04 | 2.00E−04 | 2.00E−04 | 3.00E−04 | ND | ND | 1.20E−02 | 1.21E−02 |
| methyl vanillate | 0.00E+00 | 2.56E−01 | 2.50E−02 | 3.74E−02 | 0.00E+00 | 0.00E+00 | 1.20E+00 | 1.20E+00 | 0.00E+00 | 0.00E+00 |
| myrcene | 9.00E−04 | 1.70E−03 | ND | ND | 0.00E+00 | 0.00E+00 | 0.00E+00 | 0.00E+00 | 1.00E−04 | 1.00E−04 |
| myrtenol | 5.28E−02 | 6.69E−02 | ND | ND | 7.40E−03 | 8.80E−03 | 5.90E−03 | 1.91E−02 | 5.00E−04 | 6.00E−04 |
| nerol | 1.30E−03 | 2.80E−03 | 1.90E−03 | 2.40E−03 | 0.00E+00 | 0.00E+00 | ND | ND | 3.90E−03 | 4.00E−03 |
| neryl acetate | 0.00E+00 | 0.00E+00 | ND | ND | 0.00E+00 | 0.00E+00 | 0.00E+00 | 0.00E+00 | 0.00E+00 | 0.00E+00 |
| nonanal | 0.00E+00 | 0.00E+00 | 0.00E+00 | 0.00E+00 | 0.00E+00 | 0.00E+00 | 1.00E−04 | 2.00E−04 | 0.00E+00 | 0.00E+00 |
| octanoic acid | 0.00E+00 | 9.17E+00 | 0.00E+00 | 0.00E+00 | 0.00E+00 | 0.00E+00 | 5.36E−01 | 6.57E−01 | ND | ND |
| octyl acetate | 1.00E−03 | 1.00E−03 | ND | ND | 0.00E+00 | 2.00E−04 | 3.00E−04 | 5.00E−04 | 0.00E+00 | 0.00E+00 |
| p-anisaldehyde | 4.00E−04 | 4.00E−04 | ND | ND | 0.00E+00 | 0.00E+00 | 4.70E−03 | 7.30E−03 | 0.00E+00 | 0.00E+00 |
| p-cresol | 0.00E+00 | 0.00E+00 | ND | ND | 0.00E+00 | 0.00E+00 | 0.00E+00 | 0.00E+00 | 0.00E+00 | 0.00E+00 |
| p-cymene | 2.00E−04 | 3.00E−04 | 2.00E−04 | 2.00E−04 | 1.00E−04 | 1.00E−04 | 0.00E+00 | 1.00E−04 | 1.40E−03 | 1.40E−03 |
| phenethyl acetaldehyde | 0.00E+00 | 0.00E+00 | ND | ND | 0.00E+00 | 0.00E+00 | 0.00E+00 | 0.00E+00 | 0.00E+00 | 0.00E+00 |
| dimethyl acetal | | | | | | | | | | |
| phenethyl butyrate | 0.00E+00 | 0.00E+00 | 0.00E+00 | 0.00E+00 | 0.00E+00 | 0.00E+00 | 2.00E−04 | 1.40E−03 | 0.00E+00 | 0.00E+00 |
| phenethyl isobutyrate | ND | ND | ND | ND | ND | ND | 6.00E−04 | 4.40E−03 | ND | ND |
| phenethyl octanoate | 0.00E+00 | 1.50E−03 | ND | ND | 0.00E+00 | 1.40E−03 | 4.00E−04 | 4.00E−04 | 0.00E+00 | 1.10E−03 |
| phenethyl propionate | 0.00E+00 | 0.00E+00 | 0.00E+00 | 0.00E+00 | 0.00E+00 | 0.00E+00 | 0.00E+00 | 5.00E−04 | 2.20E−03 | 2.20E−03 |
| propanoic acid | 0.00E+00 | 0.00E+00 | 2.70E+01 | 5.45E+01 | 1.33E+02 | 1.40E+02 | ND | ND | ND | ND |
| propanol | 2.71E+00 | 1.35E+01 | 6.11E+01 | 1.02E+02 | 4.60E+01 | 1.76E+02 | 1.82E+01 | 4.23E+01 | 7.01E+01 | 8.18E+01 |
| propyl hexanoate | 1.00E−04 | 1.00E−04 | ND | ND | 0.00E+00 | 0.00E+00 | 1.00E−04 | 1.00E−04 | 0.00E+00 | 0.00E+00 |
| sotolon | ND | ND | ND | ND | ND | ND | ND | ND | ND | ND |
| trans-2-heptenal | 0.00E+00 | 5.00E−04 | ND | ND | 0.00E+00 | 5.00E−04 | 4.00E−04 | 4.00E−04 | 9.00E−04 | 1.80E−03 |
| trans-2-hexen-1-al | 6.50E−03 | 8.40E−03 | ND | ND | 6.90E−03 | 1.10E−02 | 1.80E−02 | 2.39E−02 | 0.00E+00 | 1.00E−04 |
| trans-2-hexen-1-ol | 6.64E−02 | 8.25E−02 | ND | ND | 0.00E+00 | 2.00E−03 | 7.13E−02 | 9.29E−02 | 0.00E+00 | 0.00E+00 |
| trans-2-pentenal | 1.30E−01 | 1.47E−01 | ND | ND | 0.00E+00 | 0.00E+00 | 8.57E−02 | 9.16E−02 | 3.52E−02 | 8.81E−02 |
| whiskey lactone | 1.20E−03 | 2.20E−03 | 2.41E−02 | 3.64E−02 | 3.40E−03 | 5.30E−03 | 0.00E+00 | 0.00E+00 | 0.00E+00 | 0.00E+00 |

TABLE 17D
VOCs in reference alcoholic beverages

| | 16 | | 17 | | 18 | | 19 | | 20 | |
|---|---|---|---|---|---|---|---|---|---|---|
| VOCs (all values in mg/L) | min | max | min | max | min | max | min | max | min | max |
| (—)alpha-pinene | 0.00E+00 | 0.00E+00 | ND | ND | 0.00E+00 | 0.00E+00 | 0.00E+00 | 9.00E−04 | 0.00E+00 | 0.00E+00 |
| (—)cis-rose-oxide | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| 1,1-diethoxyethane | ND | ND | ND | ND | ND | ND | ND | ND | ND | ND |
| 1-decanol | 3.00E−04 | 3.00E−04 | 2.00E−04 | 4.00E−04 | ND | ND | 1.00E−04 | 1.00E−04 | ND | ND |
| 1-octanol | 2.00E−04 | 2.10E−03 | 0.00E+00 | 0.00E+00 | ND | ND | 0.00E+00 | 0.00E+00 | ND | ND |
| 1-octen-3-ol | 1.20E−03 | 1.50E−03 | ND | ND | 6.00E−04 | 1.00E−03 | 0.00E+00 | 0.00E+00 | 7.00E−04 | 9.00E−04 |
| 2-(methylthio)ethanol | 0.00E+00 | 0.00E+00 | ND | ND | 0.00E+00 | 0.00E+00 | 0.00E+00 | 0.00E+00 | 0.00E+00 | 3.00E−04 |
| 2,3-pentadione | 5.99E−02 | 3.60E−01 | 4.44E−02 | 1.62E−01 | ND | ND | 5.37E−02 | 7.38E−02 | ND | ND |
| 2,6-dimethyl-5-heptenal | 0.00E+00 | 0.00E+00 | 0.00E+00 | 0.00E+00 | ND | ND | 0.00E+00 | 0.00E+00 | ND | ND |
| 2,6-dimethylpyrazine | 0.00E+00 | 0.00E+00 | ND | ND | ND | ND | 0.00E+00 | 0.00E+00 | ND | ND |
| 2-acetylpyridine | 1.50E−03 | 2.10E−03 | ND | ND | ND | ND | 0.00E+00 | 0.00E+00 | ND | ND |
| 2-heptanone | 1.70E−03 | 8.10E−03 | 3.20E−03 | 3.90E−03 | ND | ND | 0.00E+00 | 2.00E−04 | ND | ND |
| 2-isobutyl-3- | 0.00E+00 | 0.00E+00 | ND | ND | 0.00E+00 | 0.00E+00 | 0.00E+00 | 0.00E+00 | 0.00E+00 | 0.00E+00 |
| methoxypyrazine | | | | | | | | | | |
| 2-isopropyl-3- | 4.00E−04 | 3.40E−03 | ND | ND | 2.00E−04 | 7.00E−04 | 0.00E+00 | 0.00E+00 | 5.08E−02 | 6.56E−02 |
| methoxypyrazine | | | | | | | | | | |
| 2-methoxy-4-methylphenol | 7.20E−03 | 4.23E−02 | ND | ND | ND | ND | 0.00E+00 | 0.00E+00 | ND | ND |
| 2-methoxy-4-propyl-phenol | 0.00E+00 | 0.00E+00 | 5.00E−03 | 2.47E−02 | ND | ND | 0.00E+00 | 0.00E+00 | ND | ND |
| 2-methyl-1-butanol | 2.81E+02 | 4.27E+02 | ND | ND | 2.85E+02 | 3.56E+02 | 1.80E−01 | 4.08E−01 | 3.98E+02 | 5.27E+02 |
| 2-methylbutyl acetate | 1.37E−02 | 1.62E−02 | 1.23E−01 | 1.86E−01 | 1.82E−02 | 2.19E−02 | 0.00E+00 | 0.00E+00 | 1.12E−02 | 8.32E−02 |
| 2-methylbutyl isovalerate | ND | ND | ND | ND | ND | ND | ND | ND | ND | ND |
| 2-methylbutyraldehyde | 1.70E−03 | 3.20E−03 | ND | ND | ND | ND | 1.47E−02 | 1.66E−02 | ND | ND |
| 2-nonanol | ND | ND | ND | ND | ND | ND | ND | ND | ND | ND |
| 2-nonanone | 0.00E+00 | 0.00E+00 | 1.00E−04 | 2.00E−04 | 0.00E+00 | 0.00E+00 | 0.00E+00 | 0.00E+00 | 0.00E+00 | 0.00E+00 |
| 2-phenylethanol | 7.82E+01 | 9.55E+01 | 2.83E+01 | 3.23E+01 | 6.76E+01 | 8.64E+01 | 5.80E−03 | 6.80E−03 | 1.09E+02 | 1.30E+02 |
| 2-phenylethylacetate | 2.00E−04 | 1.64E−02 | 3.14E−01 | 5.52E−01 | 1.60E−03 | 2.20E−03 | 1.01E−02 | 1.03E−02 | 3.00E−04 | 3.00E−04 |
| 2-undecanone | 0.00E+00 | 0.00E+00 | 0.00E+00 | 0.00E+00 | ND | ND | 0.00E+00 | 0.00E+00 | ND | ND |
| 3 (methylthio)-1-propanol | 1.95E+00 | 4.09E+00 | 1.83E+00 | 2.57E+00 | 2.29E+00 | 2.98E+00 | 0.00E+00 | 0.00E+00 | 3.78E+00 | 4.47E+00 |
| 3,7-dimethyl-6-octanoic acid | 3.69E−02 | 6.15E−02 | 0.00E+00 | 1.10E−03 | ND | ND | ND | ND | ND | ND |
| 3,7-dimethyl-6-octenoic acid | ND | ND | ND | ND | ND | ND | ND | ND | ND | ND |
| 3,7-dimethyl-6-octenoic acid | 0.00E+00 | 0.00E+00 | ND | ND | ND | ND | 3.00E−04 | 4.00E−04 | ND | ND |
| 3-carene | 0.00E+00 | 0.00E+00 | ND | ND | ND | ND | 1.00E−04 | 1.00E−04 | ND | ND |
| 3 -mercaptohexylacetate | 0.00E+00 | 0.00E+00 | ND | ND | 0.00E+00 | 0.00E+00 | 0.00E+00 | 0.00E+00 | 0.00E+00 | 0.00E+00 |
| 3-methyl-1-pentanol | 9.14E−02 | 1.19E−01 | ND | ND | 6.07E−02 | 7.73E−02 | 0.00E+00 | 0.00E+00 | 1.07E−01 | 1.21E−01 |
| 3-nonen-2-one | 3.50E−03 | 3.50E−03 | 0.00E+00 | 2.50E−03 | ND | ND | 0.00E+00 | 0.00E+00 | ND | ND |
| 4-(4-Hydroxyphenyl)-2- | ND | ND | ND | ND | ND | ND | ND | ND | ND | ND |
| butanone | | | | | | | | | | |
| 4-carvomenthenol | 1.00E−04 | 1.00E−04 | ND | ND | 0.00E+00 | 0.00E+00 | 1.24E−02 | 1.24E−02 | 0.00E+00 | 1.00E−04 |
| 4-ethylguaiacol | 0.00E+00 | 5.00E−04 | ND | ND | 0.00E+00 | 1.00E−04 | 0.00E+00 | 0.00E+00 | 4.00E−04 | 6.00E−04 |
| 4-ethylphenol | 4.00E−04 | 2.90E−03 | 2.00E−04 | 1.00E−03 | 1.00E−04 | 5.00E−04 | 1.02E−01 | 1.02E−01 | 4.94E−02 | 6.27E−02 |
| 4-Hydroxy-2,5-dimethyl- | ND | ND | ND | ND | ND | ND | ND | ND | ND | ND |
| 3(2H)-furanone | | | | | | | | | | |
| acetal | 1.02E−01 | 1.16E−01 | 5.02E−01 | 6.30E−01 | ND | ND | ND | ND | ND | ND |
| acetaldehyde | 5.45E−02 | 6.32E−02 | ND | ND | ND | ND | 1.73E+00 | 1.98E+00 | ND | ND |
| acetaldehyde, diethyl acetal | 6.91E+00 | 1.56E+01 | 0.00E+00 | 0.00E+00 | ND | ND | ND | ND | ND | ND |
| acetoin | ND | ND | ND | ND | ND | ND | ND | ND | ND | ND |
| acetophenone | ND | ND | ND | ND | ND | ND | ND | ND | ND | ND |
| a-ionone | 4.00E−04 | 1.40E−03 | 0.00E+00 | 8.40E−03 | ND | ND | 0.00E+00 | 0.00E+00 | ND | ND |
| Amyl alcohol | 8.40E−03 | 4.09E−01 | 8.84E−02 | 1.16E−01 | ND | ND | 0.00E+00 | 1.02E−02 | ND | ND |
| amyl butyrate | 1.00E−04 | 2.00E−04 | 0.00E+00 | 0.00E+00 | ND | ND | 1.00E−04 | 1.00E−04 | ND | ND |
| Amyl formate | 0.00E+00 | 0.00E+00 | ND | ND | ND | ND | 0.00E+00 | 0.00E+00 | ND | ND |
| a-phellandrene | 3.00E−04 | 1.40E−03 | 0.00E+00 | 0.00E+00 | ND | ND | 5.00E−04 | 8.00E−04 | ND | ND |
| a-terpineol | 6.00E−04 | 7.00E−04 | ND | ND | 4.00E−04 | 6.00E−04 | 5.97E−02 | 6.11E−02 | 4.00E−04 | 4.00E−04 |
| benzaldehyde | 1.80E−03 | 6.10E−03 | 5.83E−02 | 6.04E−02 | ND | ND | 3.00E−03 | 3.40E−03 | ND | ND |
| benzyl acetate | 7.00E−04 | 1.40E−03 | 1.00E−04 | 1.00E−03 | ND | ND | 0.00E+00 | 0.00E+00 | ND | ND |
| benzyl alcohol | 1.00E−04 | 2.42E+00 | 6.70E−03 | 3.66E−02 | 2.95E−01 | 3.54E−01 | 0.00E+00 | 0.00E+00 | 4.93E−01 | 7.85E−01 |
| beta pinene | 1.00E−04 | 2.00E−04 | ND | ND | 0.00E+00 | 0.00E+00 | 1.10E−03 | 1.30E−03 | 1.00E−04 | 1.00E−04 |
| beta-ionone | 0.00E+00 | 0.00E+00 | ND | ND | 0.00E+00 | 0.00E+00 | 0.00E+00 | 0.00E+00 | 0.00E+00 | 0.00E+00 |
| butanol | 1.46E+00 | 2.47E+00 | 1.85E−01 | 2.47E−01 | 1.08E+00 | 1.73E+00 | 1.41E+00 | 1.45E+00 | 1.52E+00 | 2.91E+00 |
| butyl acetate | 9.03E−02 | 1.60E−01 | 5.45E−01 | 6.52E−01 | ND | ND | 6.30E−03 | 1.54E−02 | ND | ND |
| butyl formate | 1.38E+00 | 1.64E+00 | 6.19E−01 | 6.64E−01 | 1.17E+00 | 1.38E+00 | 2.75E+00 | 3.17E+00 | 1.50E+00 | 2.03E+00 |
| butyl isovalerate | 2.00E−04 | 5.00E−04 | 0.00E+00 | 1.00E−04 | ND | ND | 0.00E+00 | 0.00E+00 | ND | ND |
| butyric acid | 6.44E−02 | 9.18E−02 | 7.10E+01 | 1.13E+02 | 4.19E−02 | 5.73E−02 | 9.28E−01 | 1.04E+00 | 5.01E−02 | 6.54E−02 |
| carvone | 0.00E+00 | 0.00E+00 | 0.00E+00 | 0.00E+00 | ND | ND | 0.00E+00 | 0.00E+00 | ND | ND |
| cinnamaldehyde | 8.00E−04 | 3.50E−03 | 3.50E−03 | 3.60E−03 | ND | ND | 0.00E+00 | 0.00E+00 | ND | ND |
| cis-2-hexenol | 2.04E−01 | 2.34E−01 | 3.86E−02 | 7.28E−02 | ND | ND | ND | ND | ND | ND |
| cis-3-hexen-1-ol | 0.00E+00 | 0.00E+00 | ND | ND | 0.00E+00 | 0.00E+00 | 0.00E+00 | 0.00E+00 | 0.00E+00 | 0.00E+00 |
| cis-3-hexenyl acetate | 0.00E+00 | 0.00E+00 | 0.00E+00 | 0.00E+00 | ND | ND | 0.00E+00 | 0.00E+00 | ND | ND |
| citronellol | 0.00E+00 | 0.00E+00 | ND | ND | 0.00E+00 | 0.00E+00 | 0.00E+00 | 0.00E+00 | 0.00E+00 | 0.00E+00 |
| citronellyl acetate | 0.00E+00 | 0.00E+00 | 0.00E+00 | 0.00E+00 | ND | ND | 0.00E+00 | 0.00E+00 | ND | ND |
| damascenone | 1.60E−02 | 1.68E−02 | 2.88E−02 | 4.09E−02 | 0.00E+00 | 1.60E−03 | 3.97E−02 | 4.46E−02 | 0.00E+00 | 6.00E−04 |
| Damascone | 0.00E+00 | 0.00E+00 | ND | ND | ND | ND | 0.00E+00 | 0.00E+00 | ND | ND |
| decanal | 0.00E+00 | 0.00E+00 | 0.00E+00 | 0.00E+00 | ND | ND | 0.00E+00 | 0.00E+00 | ND | ND |
| decanoic acid | 3.00E−04 | 2.54E−02 | ND | ND | 2.00E−04 | 6.01E−02 | ND | ND | 8.00E−04 | 4.57E−02 |
| delta-decalactone | 2.00E−04 | 3.70E−03 | ND | ND | 2.00E−04 | 5.00E−04 | ND | ND | 2.00E−04 | 4.40E−03 |
| diacetyl | 9.44E−01 | 1.22E+00 | 1.90E−01 | 2.53E−01 | 3.94E+00 | 4.17E+00 | 1.47E+00 | 2.00E+00 | 1.87E+00 | 2.37E+00 |
| diethyl succinate | 3.73E+01 | 4.47E+01 | 2.35E−01 | 9.68E−01 | 2.73E+01 | 3.74E+01 | 0.00E+00 | 0.00E+00 | 4.47E+01 | 5.34E+01 |
| dimethyl anthranilate | 4.00E−04 | 4.00E−04 | 4.00E−04 | 1.00E−03 | ND | ND | 3.20E−02 | 3.79E−02 | ND | ND |
| dimethyl succinate | 0.00E+00 | 0.00E+00 | ND | ND | ND | ND | 0.00E+00 | 0.00E+00 | ND | ND |
| dimethyl sulfide | 1.90E−01 | 2.09E−01 | ND | ND | 2.85E−01 | 3.42E−01 | 0.00E+00 | 0.00E+00 | 1.17E−01 | 1.21E−01 |
| ethyl acetate | 4.47E+02 | 5.33E+02 | 1.34E+02 | 1.55E+02 | 1.52E+02 | 5.47E+02 | 1.83E+01 | 2.21E+01 | 4.04E+02 | 4.33E+02 |
| ethyl anthranilate | 1.00E−04 | 3.00E−04 | ND | ND | 1.00E−04 | 1.90E−03 | 0.00E+00 | 0.00E+00 | 1.00E−04 | 3.00E−04 |
| ethyl butanoate | 7.12E−02 | 2.07E−01 | 6.27E−01 | 7.36E−01 | 4.46E−02 | 6.17E−02 | 5.00E−04 | 6.00E−04 | 5.36E−02 | 7.25E−02 |
| ethyl cinnamate | 2.00E−04 | 2.00E−04 | 1.80E−03 | 2.70E−03 | 0.00E+00 | 0.00E+00 | 0.00E+00 | 0.00E+00 | 0.00E+00 | 0.00E+00 |
| ethyl decanoate | 3.00E−04 | 2.49E−02 | 2.16E−02 | 3.08E−02 | 2.00E−04 | 5.44E−02 | 2.99E−02 | 3.41E−02 | 8.00E−04 | 4.35E−02 |
| ethyl heptanoate | 2.00E−04 | 2.00E−04 | 1.00E−04 | 1.00E−04 | 0.00E+00 | 1.00E−04 | 9.00E−04 | 9.00E−04 | 1.00E−04 | 1.00E−04 |
| ethyl hexanoate | 1.36E−01 | 4.39E−01 | 1.86E+00 | 2.53E+00 | 6.36E−02 | 2.73E−01 | 2.00E−03 | 3.00E−03 | 1.73E−01 | 4.26E−01 |
| ethyl isobutyrate | 4.79E−02 | 6.89E−02 | 1.40E−03 | 1.60E−03 | 9.00E−02 | 1.26E−01 | 7.00E−03 | 7.30E−03 | 6.47E−02 | 8.25E−02 |
| ethyl isovalerate | 3.20E−03 | 6.20E−03 | 1.00E−04 | 3.00E−04 | 2.70E−03 | 5.30E−03 | 0.00E+00 | 0.00E+00 | 4.60E−03 | 7.20E−03 |
| ethyl lactate | 3.06E+02 | 6.17E+02 | 3.92E+00 | 4.39E+00 | 1.37E+02 | 1.62E+02 | 8.20E−03 | 2.75E−02 | 1.65E+02 | 2.79E+02 |
| ethyl laurate | 1.00E−04 | 2.00E−04 | ND | ND | 4.20E−03 | 6.00E−03 | 4.17E−02 | 4.55E−02 | 3.00E−04 | 6.00E−04 |
| ethyl myristate | 3.10E−03 | 3.30E−03 | ND | ND | 7.00E−04 | 3.50E−03 | 1.07E−02 | 1.20E−02 | 1.10E−03 | 1.80E−03 |
| ethyl nonanoate | 1.00E−04 | 2.00E−04 | ND | ND | 0.00E+00 | 0.00E+00 | 0.00E+00 | 0.00E+00 | 1.00E−04 | 1.00E−04 |
| ethyl octanoate | 4.71E−01 | 5.56E−01 | 8.12E−01 | 1.40E+00 | 7.07E−01 | 7.25E−01 | 1.20E−02 | 1.32E−02 | 5.11E−01 | 5.85E−01 |
| ethyl palmitate | 1.97E−02 | 2.03E−02 | ND | ND | 7.00E−04 | 2.00E−03 | 7.00E−04 | 8.00E−04 | 1.20E−03 | 2.20E−03 |
| ethyl phenyl acetate | 2.00E−04 | 3.90E−03 | 5.00E−04 | 1.80E−03 | ND | ND | 0.00E+00 | 0.00E+00 | ND | ND |
| ethyl propionate | 2.08E−01 | 2.48E−01 | 9.14E−02 | 1.27E−01 | 2.51E−01 | 2.91E−01 | 1.12E−01 | 1.15E−01 | 1.34E−01 | 1.57E−01 |
| ethyl undecanoate | 1.00E−04 | 6.40E−03 | 5.00E−04 | 4.90E−03 | ND | ND | 1.00E−04 | 1.00E−04 | ND | ND |
| ethyl valerate | 5.00E−04 | 9.00E−04 | 2.00E−04 | 2.00E−04 | ND | ND | 0.00E+00 | 0.00E+00 | ND | ND |
| ethyl-2-mercaptopropionate | 0.00E+00 | 0.00E+00 | ND | ND | 0.00E+00 | 0.00E+00 | 1.82E−01 | 1.99E−01 | 0.00E+00 | 0.00E+00 |
| ethyl-2-methylbutyrate | 4.80E−03 | 9.30E−03 | 1.00E−04 | 1.00E−04 | 5.00E−03 | 5.50E−03 | 8.00E−04 | 9.00E−04 | 6.00E−03 | 6.70E−03 |
| ethyl-3-hydroxybutyrate | 1.32E−01 | 2.31E+00 | ND | ND | ND | ND | 0.00E+00 | 0.00E+00 | ND | ND |
| ethyl-trans-2-butenoate | 0.00E+00 | 0.00E+00 | 2.10E−03 | 2.60E−03 | 0.00E+00 | 0.00E+00 | 0.00E+00 | 0.00E+00 | 0.00E+00 | 0.00E+00 |
| ethyl-trans-3-hexenoate | 0.00E+00 | 0.00E+00 | ND | ND | 0.00E+00 | 0.00E+00 | 0.00E+00 | 0.00E+00 | 0.00E+00 | 0.00E+00 |
| eucalyptol | 0.00E+00 | 0.00E+00 | ND | ND | 0.00E+00 | 0.00E+00 | 0.00E+00 | 0.00E+00 | 0.00E+00 | 0.00E+00 |
| eugenol | 5.10E−03 | 2.00E−02 | 0.00E+00 | 0.00E+00 | ND | ND | 0.00E+00 | 0.00E+00 | ND | ND |
| furfural | 1.84E−01 | 2.20E−01 | 4.04E−02 | 1.40E−01 | 2.75E−01 | 2.96E−01 | 7.95E−01 | 8.03E−01 | 4.31E−02 | 4.64E−02 |
| furfuryl ether | 0.00E+00 | 0.00E+00 | ND | ND | 0.00E+00 | 0.00E+00 | 0.00E+00 | 0.00E+00 | 0.00E+00 | 0.00E+00 |
| furfuryl mercaptan | 1.00E−04 | 1.70E−03 | ND | ND | 0.00E+00 | 1.00E−04 | 0.00E+00 | 1.30E−01 | 1.00E−04 | 4.00E−04 |
| gamma-decalactone | 2.00E−04 | 3.70E−03 | ND | ND | 0.00E+00 | 1.00E−04 | 0.00E+00 | 0.00E+00 | 2.00E−04 | 4.40E−03 |
| gamma-dodecalactone | 0.00E+00 | 0.00E+00 | 0.00E+00 | 0.00E+00 | ND | ND | 0.00E+00 | 0.00E+00 | ND | ND |
| gamma-nonalactone | 3.00E−04 | 4.00E−04 | ND | ND | 2.00E−04 | 6.00E−04 | 0.00E+00 | 0.00E+00 | 1.00E−04 | 2.00E−04 |
| gamma-octalactone | 1.10E−03 | 1.10E−03 | 0.00E+00 | 0.00E+00 | ND | ND | 0.00E+00 | 0.00E+00 | ND | ND |
| gamma-terpinene | 0.00E+00 | 0.00E+00 | ND | ND | 0.00E+00 | 0.00E+00 | 0.00E+00 | 0.00E+00 | 0.00E+00 | 0.00E+00 |
| gamma-undecalactone | 4.00E−04 | 1.00E−03 | 0.00E+00 | 0.00E+00 | ND | ND | 0.00E+00 | 0.00E+00 | ND | ND |
| geraniol | 5.00E−04 | 8.00E−04 | 3.00E−04 | 5.00E−04 | 8.00E−04 | 1.00E−03 | 0.00E+00 | 0.00E+00 | 6.00E−04 | 9.00E−04 |
| geranyl acetate | 8.40E−03 | 9.30E−03 | 0.00E+00 | 1.00E−04 | ND | ND | 0.00E+00 | 0.00E+00 | ND | ND |
| guaiacol | 1.21E−02 | 1.51E−02 | ND | ND | ND | ND | 0.00E+00 | 1.70E−03 | ND | ND |
| heptyl acetate | 1.00E−04 | 9.00E−04 | 1.00E−04 | 2.00E−04 | ND | ND | 0.00E+00 | 0.00E+00 | ND | ND |
| hexanal | 0.00E+00 | 0.00E+00 | 0.00E+00 | 0.00E+00 | ND | ND | ND | ND | ND | ND |
| hexanoic acid | 0.00E+00 | 0.00E+00 | ND | ND | 7.77E+01 | 8.26E+01 | ND | ND | 0.00E+00 | 0.00E+00 |
| Hexanol | 9.69E−01 | 1.34E+00 | 1.21E−01 | 1.38E−01 | 6.20E−01 | 9.14E−01 | 0.00E+00 | 4.09E−02 | 1.27E+00 | 1.88E+00 |
| hexyl acetate | 1.00E−04 | 1.00E−04 | 1.00E−04 | 1.00E−04 | 3.00E−04 | 4.00E−04 | 0.00E+00 | 0.00E+00 | 0.00E+00 | 1.00E−04 |
| hexyl hexanoate | 4.00E−04 | 4.10E−03 | 4.00E−04 | 2.40E−03 | ND | ND | 3.00E−04 | 3.00E−04 | ND | ND |
| isoamyl acetate | 1.77E−01 | 1.91E−01 | 9.12E−01 | 1.16E+00 | 3.72E−01 | 4.12E−01 | 1.65E−02 | 1.99E−02 | 9.44E−02 | 1.06E−01 |
| isoamyl alcohol | 3.14E+01 | 1.52E+02 | 4.13E+01 | 2.27E+02 | 7.01E+02 | 8.24E+02 | 1.14E+01 | 4.91E+01 | 5.82E+02 | 1.48E+03 |
| isoamyl hexanoate | 0.00E+00 | 0.00E+00 | 6.00E−04 | 7.00E−04 | 0.00E+00 | 0.00E+00 | 0.00E+00 | 0.00E+00 | 0.00E+00 | 1.00E−04 |
| isoamyl octanoate | 2.00E−04 | 9.00E−04 | 1.20E−03 | 1.40E−03 | 0.00E+00 | 1.00E−04 | 1.00E−04 | 3.00E−04 | 2.00E−04 | 2.00E−04 |
| isoborneol | 1.00E−04 | 2.00E−04 | 2.00E−04 | 2.00E−04 | ND | ND | 0.00E+00 | 0.00E+00 | ND | ND |
| isobutanol | 1.18E+01 | 1.71E+02 | 7.11E+01 | 1.28E+02 | 1.81E+02 | 2.26E+02 | 1.93E+01 | 1.68E+02 | 2.44E+02 | 3.95E+02 |
| isobutyl acetate | 2.60E−02 | 3.00E−02 | 7.56E−02 | 9.76E−02 | 3.32E−02 | 3.94E−02 | 6.40E−03 | 7.30E−03 | 2.05E−02 | 2.20E−02 |
| isobutyric acid | 3.75E+00 | 4.22E+00 | 0.00E+00 | 0.00E+00 | ND | ND | 1.01E−01 | 1.02E−01 | ND | ND |
| isovaleraldehyde | 8.90E−03 | 3.02E−01 | 4.45E−01 | 6.03E−01 | ND | ND | 6.02E−02 | 6.79E−02 | ND | ND |
| isovaleric acid | 3.50E+00 | 7.08E+00 | 1.19E+00 | 1.48E+00 | 6.45E+00 | 7.47E+00 | 0.00E+00 | 4.00E−04 | 3.05E+00 | 7.00E+00 |
| Jasmine lactone | 0.00E+00 | 0.00E+00 | ND | ND | ND | ND | 0.00E+00 | 0.00E+00 | ND | ND |
| limonene | 0.00E+00 | 1.00E−04 | ND | ND | 2.00E−04 | 3.00E−04 | 0.00E+00 | 0.00E+00 | 0.00E+00 | 1.00E−04 |
| linalool | 1.00E−04 | 2.00E−04 | ND | ND | 1.00E−04 | 8.00E−04 | 2.10E−03 | 2.90E−03 | 0.00E+00 | 1.00E−04 |
| linalool oxide | 1.32E−02 | 3.50E−01 | 0.00E+00 | 0.00E+00 | ND | ND | 5.70E−03 | 1.02E−02 | ND | ND |
| linalyl acetate | 1.00E−03 | 1.10E−03 | 1.50E−03 | 1.70E−03 | 1.20E−03 | 1.30E−03 | 1.50E−03 | 1.50E−03 | 1.20E−03 | 1.30E−03 |
| linalyl butyrate | 0.00E+00 | 0.00E+00 | ND | ND | 0.00E+00 | 0.00E+00 | 0.00E+00 | 0.00E+00 | 0.00E+00 | 0.00E+00 |
| linalyl formate | 1.01E−02 | 1.07E−02 | 0.00E+00 | 0.00E+00 | ND | ND | 0.00E+00 | 0.00E+00 | ND | ND |
| maltol | 4.00E−04 | 3.20E−03 | ND | ND | 3.00E−04 | 4.00E−04 | 7.90E−02 | 7.97E−02 | 2.00E−04 | 3.00E−04 |
| methional | 4.00E−04 | 2.00E−03 | ND | ND | ND | ND | 0.00E+00 | 4.00E−04 | ND | ND |
| methyl anthranilate | 0.00E+00 | 1.00E−04 | ND | ND | 0.00E+00 | 1.10E−03 | 1.27E−02 | 1.27E−02 | 0.00E+00 | 1.00E−04 |
| methyl decanoate | 0.00E+00 | 0.00E+00 | 8.00E−04 | 1.00E−03 | 0.00E+00 | 2.00E−04 | 2.00E−03 | 2.10E−03 | 0.00E+00 | 0.00E+00 |
| methyl dihydrojasmonate | 5.40E−03 | 5.50E−03 | 5.50E−03 | 6.40E−03 | ND | ND | 0.00E+00 | 0.00E+00 | ND | ND |
| methyl hexanoate | 5.14E−01 | 5.38E−01 | 9.90E−03 | 1.18E−02 | 2.67E−01 | 4.71E−01 | 2.51E−02 | 3.03E−02 | 3.22E−01 | 3.38E−01 |
| methyl laurate | 4.00E−04 | 7.90E−03 | 2.50E−03 | 6.90E−03 | ND | ND | 4.00E−04 | 4.00E−04 | ND | ND |
| methyl octanoate | 1.00E−04 | 1.39E−02 | 0.00E+00 | 1.00E−04 | ND | ND | 0.00E+00 | 0.00E+00 | ND | ND |
| methyl salicylate | 2.00E−04 | 3.00E−04 | ND | ND | 1.00E−04 | 3.00E−04 | 0.00E+00 | 0.00E+00 | 1.00E−04 | 1.00E−04 |
| methyl vanillate | 1.20E+00 | 1.20E+00 | 0.00E+00 | 1.20E+00 | 0.00E+00 | 7.80E−02 | 0.00E+00 | 0.00E+00 | 0.00E+00 | 0.00E+00 |
| myrcene | 5.00E−04 | 9.70E−03 | 0.00E+00 | 0.00E+00 | ND | ND | 1.00E−04 | 1.00E−04 | ND | ND |
| myrtenol | 8.30E−03 | 1.37E−02 | 3.41E−02 | 3.66E−02 | ND | ND | 1.00E−04 | 1.00E−04 | ND | ND |
| nerol | 2.00E−04 | 3.00E−04 | ND | ND | 3.00E−04 | 3.00E−04 | 2.70E−03 | 3.70E−03 | 0.00E+00 | 2.00E−04 |
| neryl acetate | 0.00E+00 | 0.00E+00 | ND | ND | ND | ND | 0.00E+00 | 0.00E+00 | ND | ND |
| nonanal | 0.00E+00 | 0.00E+00 | 1.00E−04 | 3.00E−04 | 0.00E+00 | 0.00E+00 | 0.00E+00 | 0.00E+00 | 0.00E+00 | 0.00E+00 |
| octanoic acid | 0.00E+00 | 0.00E+00 | 8.06E−01 | 1.39E+00 | 6.88E−01 | 7.09E−01 | ND | ND | 0.00E+00 | 0.00E+00 |
| octyl acetate | 1.00E−04 | 1.00E−04 | 0.00E+00 | 1.00E−04 | ND | ND | 0.00E+00 | 0.00E+00 | ND | ND |
| p-anisaldehyde | 3.60E−03 | 3.60E−03 | 3.90E−03 | 5.60E−03 | ND | ND | 0.00E+00 | 0.00E+00 | ND | ND |
| p-cresol | 0.00E+00 | 0.00E+00 | ND | ND | ND | ND | 0.00E+00 | 0.00E+00 | ND | ND |
| p-cymene | 1.00E−04 | 1.00E−04 | 0.00E+00 | 1.00E−04 | 0.00E+00 | 1.00E−04 | 1.20E−03 | 1.20E−03 | 2.00E−04 | 2.00E−04 |
| phenethyl acetaldehyde | 1.00E−03 | 1.20E−03 | 0.00E+00 | 0.00E+00 | ND | ND | 0.00E+00 | 0.00E+00 | ND | ND |
| dimethyl acetal | | | | | | | | | | |
| phenethyl butyrate | 0.00E+00 | 0.00E+00 | 2.00E−04 | 9.00E−04 | 0.00E+00 | 0.00E+00 | 0.00E+00 | 0.00E+00 | 0.00E+00 | 0.00E+00 |
| phenethyl isobutyrate | 2.30E−03 | 4.70E−03 | 6.00E−04 | 2.90E−03 | ND | ND | ND | ND | ND | ND |
| phenethyl octanoate | 0.00E+00 | 7.00E−04 | ND | ND | ND | ND | 0.00E+00 | 8.00E−04 | ND | ND |
| phenethyl propionate | 0.00E+00 | 0.00E+00 | 0.00E+00 | 3.00E−04 | 0.00E+00 | 0.00E+00 | 0.00E+00 | 0.00E+00 | 0.00E+00 | 0.00E+00 |
| propanoic acid | 8.30E+00 | 5.45E+01 | ND | ND | 8.75E+00 | 1.08E+01 | ND | ND | 2.11E+01 | 5.23E+01 |
| propanol | 2.74E+01 | 1.19E+02 | 2.37E+01 | 3.80E+01 | 4.27E+01 | 5.64E+01 | 5.62E+01 | 6.06E+01 | 3.46E+01 | 6.87E+01 |
| propyl hexanoate | 1.00E−04 | 1.00E−04 | 1.00E−04 | 1.00E−04 | ND | ND | 0.00E+00 | 0.00E+00 | ND | ND |
| sotolon | ND | ND | ND | ND | ND | ND | ND | ND | ND | ND |
| trans-2-heptenal | 6.00E−04 | 6.00E−04 | 0.00E+00 | 0.00E+00 | ND | ND | 1.50E−03 | 1.80E−03 | ND | ND |
| trans-2-hexen-1-al | 7.60E−03 | 9.40E−03 | ND | ND | ND | ND | 0.00E+00 | 1.00E−04 | ND | ND |
| trans-2-hexen-1-ol | 9.65E−02 | 1.72E−01 | 6.18E−02 | 7.38E−02 | ND | ND | 0.00E+00 | 0.00E+00 | ND | ND |
| trans-2-pentenal | 0.00E+00 | 0.00E+00 | ND | ND | ND | ND | 2.13E−02 | 6.65E−02 | ND | ND |
| whiskey lactone | 5.01E−02 | 7.67E−02 | 3.00E−03 | 1.38E−02 | 1.85E−01 | 2.23E−01 | 0.00E+00 | 0.00E+00 | 3.58E−02 | 5.75E−02 |

TABLE 17E
VOCs in reference alcoholic beverages

| VOCs (all values in mg/L) | min | max | min | max | min | max |
|---|---|---|---|---|---|---|
| (—)alpha-pinene | 9.00E−04 | 1.00E−03 | 1.00E−03 | 1.00E−03 | 9.00E−04 | 1.00E−03 |
| (—)cis-rose-oxide | 0.00E+00 | 0.00E+00 | 0.00E+00 | 0.00E+00 | 0.00E+00 | 0.00E+00 |
| 1,1-diethoxyethane | ND | ND | ND | ND | ND | ND |
| 1-decanol | 1.00E−04 | 1.00E−04 | ND | ND | ND | ND |
| 1-octanol | 0.00E+00 | 0.00E+00 | ND | ND | ND | ND |
| 1-octen-3-ol | 0.00E+00 | 0.00E+00 | 0.00E+00 | 0.00E+00 | 0.00E+00 | 0.00E+00 |
| 2-(methylthio)ethanol | 0.00E+00 | 0.00E+00 | 0.00E+00 | 0.00E+00 | 0.00E+00 | 0.00E+00 |
| 2,3-pentadione | 2.66E−02 | 2.77E−02 | ND | ND | ND | ND |
| 2,6-dimethyl-5-heptenal | 0.00E+00 | 0.00E+00 | ND | ND | ND | ND |
| 2,6-dimethylpyrazine | 0.00E+00 | 0.00E+00 | ND | ND | ND | ND |
| 2-acetylpyridine | 0.00E+00 | 0.00E+00 | ND | ND | ND | ND |
| 2-heptanone | 0.00E+00 | 0.00E+00 | ND | ND | ND | ND |
| 2-isobutyl-3- | 0.00E+00 | 0.00E+00 | 0.00E+00 | 0.00E+00 | 0.00E+00 | 0.00E+00 |
| methoxypyrazine | | | | | | |
| 2-isopropyl-3- | 0.00E+00 | 0.00E+00 | 0.00E+00 | 0.00E+00 | 2.21E−02 | 2.33E−02 |
| methoxypyrazine | | | | | | |
| 2-methoxy-4- | 0.00E+00 | 0.00E+00 | ND | ND | ND | ND |
| methylphenol | | | | | | |
| 2-methoxy-4-propyl- | 0.00E+00 | 0.00E+00 | ND | ND | ND | ND |
| phenol | | | | | | |
| 2-methyl-1-butanol | 3.49E−01 | 6.41E+00 | 0.00E+00 | 0.00E+00 | 0.00E+00 | 0.00E+00 |
| 2-methylbutyl acetate | 0.00E+00 | 0.00E+00 | 0.00E+00 | 0.00E+00 | 0.00E+00 | 0.00E+00 |
| 2-methylbutyl isovalerate | ND | ND | ND | ND | ND | ND |
| 2-methylbutyraldehyde | 4.80E−03 | 5.90E−03 | ND | ND | ND | ND |
| 2-nonanol | ND | ND | ND | ND | ND | ND |
| 2-nonanone | 0.00E+00 | 0.00E+00 | 0.00E+00 | 0.00E+00 | 0.00E+00 | 0.00E+00 |
| 2-phenylethanol | 3.31E−01 | 3.49E−01 | 9.08E−01 | 1.19E+00 | 2.19E−01 | 2.27E−01 |
| 2-phenylethylacetate | 1.12E−02 | 1.12E−02 | 2.63E−02 | 2.76E−02 | 1.11E−02 | 1.13E−02 |
| 2-undecanone | 0.00E+00 | 0.00E+00 | ND | ND | ND | ND |
| 3-(methylthio)-1-propanol | 0.00E+00 | 0.00E+00 | 0.00E+00 | 0.00E+00 | 0.00E+00 | 0.00E+00 |
| 3,7-dimethyl-6-octanoic | ND | ND | ND | ND | ND | ND |
| acid | | | | | | |
| 3,7-dimethyl-6-octenoic | ND | ND | ND | ND | ND | ND |
| acid | | | | | | |
| 3,7-dimethyl-6-octenoic | 0.00E+00 | 3.00E−04 | ND | ND | ND | ND |
| acid | | | | | | |
| 3-carene | 0.00E+00 | 2.00E−04 | ND | ND | ND | ND |
| 3-mercaptohexylacetate | 0.00E+00 | 0.00E+00 | 0.00E+00 | 0.00E+00 | 0.00E+00 | 0.00E+00 |
| 3-methyl-1-pentanol | 0.00E+00 | 0.00E+00 | 0.00E+00 | 0.00E+00 | 0.00E+00 | 0.00E+00 |
| 3-nonen-2-one | 0.00E+00 | 0.00E+00 | ND | ND | ND | ND |
| 4-(4-Hydroxyphenyl)-2- | ND | ND | ND | ND | ND | ND |
| butanone | | | | | | |
| 4-carvomenthenol | 1.24E−02 | 1.25E−02 | 1.28E−02 | 1.29E−02 | 0.00E+00 | 0.00E+00 |
| 4-ethylguaiacol | 0.00E+00 | 0.00E+00 | 4.00E−03 | 4.00E−03 | 3.70E−03 | 3.80E−03 |
| 4-ethylphenol | 1.02E−01 | 1.03E−01 | 1.03E−01 | 1.04E−01 | 9.88E−02 | 9.89E−02 |
| 4-Hydroxy-2,5-dimethyl- | ND | ND | ND | ND | ND | ND |
| 3(2H)-furanone | | | | | | |
| acetal | ND | ND | ND | ND | ND | ND |
| acetaldehyde | 1.09E+00 | 1.30E+00 | ND | ND | ND | ND |
| acetaldehyde, diethyl | ND | ND | ND | ND | ND | ND |
| acetal | | | | | | |
| acetoin | ND | ND | ND | ND | ND | ND |
| acetophenone | ND | ND | ND | ND | ND | ND |
| a-ionone | 0.00E+00 | 0.00E+00 | ND | ND | ND | ND |
| Amyl alcohol | 0.00E+00 | 2.31E−02 | ND | ND | ND | ND |
| amyl butyrate | 1.00E−04 | 1.00E−04 | ND | ND | ND | ND |
| Amyl formate | 0.00E+00 | 0.00E+00 | ND | ND | ND | ND |
| a-phellandrene | 5.00E−04 | 9.00E−04 | ND | ND | ND | ND |
| a-terpineol | 5.95E−02 | 6.24E−02 | 6.12E−02 | 6.23E−02 | 5.71E−02 | 5.71E−02 |
| benzaldehyde | 1.10E−03 | 1.60E−03 | ND | ND | ND | ND |
| benzyl acetate | 0.00E+00 | 0.00E+00 | ND | ND | ND | ND |
| benzyl alcohol | 0.00E+00 | 0.00E+00 | 0.00E+00 | 0.00E+00 | 0.00E+00 | 0.00E+00 |
| beta pinene | 1.10E−03 | 1.10E−03 | 1.30E−03 | 1.30E−03 | 0.00E+00 | 1.10E−03 |
| beta-ionone | 0.00E+00 | 0.00E+00 | 0.00E+00 | 0.00E+00 | 0.00E+00 | 0.00E+00 |
| butanol | 1.02E+00 | 1.13E+00 | 7.86E−01 | 8.62E−01 | 9.61E−01 | 1.05E+00 |
| butyl acetate | 1.59E−02 | 1.87E−02 | ND | ND | ND | ND |
| butyl formate | 4.01E+00 | 5.27E+00 | 5.31E+00 | 5.62E+00 | 3.90E+00 | 5.83E+00 |
| butyl isovalerate | 0.00E+00 | 0.00E+00 | ND | ND | ND | ND |
| butyric acid | 4.10E+00 | 4.57E+00 | 1.12E+01 | 1.24E+01 | 3.15E+00 | 3.85E+00 |
| carvone | 0.00E+00 | 0.00E+00 | ND | ND | ND | ND |
| cinnamaldehyde | 0.00E+00 | 0.00E+00 | ND | ND | ND | ND |
| cis-2-hexenol | ND | ND | ND | ND | ND | ND |
| cis-3-hexen-1-ol | 0.00E+00 | 0.00E+00 | 0.00E+00 | 0.00E+00 | 0.00E+00 | 0.00E+00 |
| cis-3-hexenyl acetate | 0.00E+00 | 0.00E+00 | ND | ND | ND | ND |
| citronellol | 5.80E−03 | 8.00E−03 | 9.10E−03 | 1.11E−02 | 0.00E+00 | 0.00E+00 |
| citronellyl acetate | 0.00E+00 | 0.00E+00 | ND | ND | ND | ND |
| damascenone | 7.82E−02 | 8.58E−02 | 8.15E−02 | 8.92E−02 | 2.66E−02 | 2.81E−02 |
| Damascone | 0.00E+00 | 0.00E+00 | ND | ND | ND | ND |
| decanal | 0.00E+00 | 0.00E+00 | ND | ND | ND | ND |
| decanoic acid | ND | ND | ND | ND | ND | ND |
| delta-decalactone | ND | ND | ND | ND | ND | ND |
| diacetyl | 8.17E−01 | 1.17E+00 | 1.96E−01 | 2.52E−01 | 6.58E−01 | 2.40E+00 |
| diethyl succinate | 3.59E−02 | 4.05E−02 | 4.55E−02 | 5.01E−02 | 1.96E−02 | 2.17E−02 |
| dimethyl anthranilate | 6.03E−02 | 6.80E−02 | ND | ND | ND | ND |
| dimethyl succinate | 0.00E+00 | 0.00E+00 | ND | ND | ND | ND |
| dimethyl sulfide | 0.00E+00 | 0.00E+00 | 0.00E+00 | 0.00E+00 | 0.00E+00 | 0.00E+00 |
| ethyl acetate | 1.90E+02 | 2.01E+02 | 1.66E+02 | 1.93E+02 | 3.98E+02 | 4.26E+02 |
| ethyl anthranilate | 0.00E+00 | 0.00E+00 | 0.00E+00 | 0.00E+00 | 0.00E+00 | 0.00E+00 |
| ethyl butanoate | 6.60E−03 | 8.30E−03 | ND | ND | ND | ND |
| ethyl cinnamate | 0.00E+00 | 0.00E+00 | 0.00E+00 | 0.00E+00 | 0.00E+00 | 0.00E+00 |
| ethyl decanoate | 5.18E−02 | 6.08E−02 | 6.32E−02 | 7.29E−02 | 2.26E−02 | 2.46E−02 |
| ethyl heptanoate | 9.00E−04 | 9.00E−04 | 9.00E−04 | 9.00E−04 | 9.00E−04 | 9.00E−04 |
| ethyl hexanoate | 1.58E−02 | 1.75E−02 | 3.01E−02 | 3.38E−02 | 6.90E−03 | 7.40E−03 |
| ethyl isobutyrate | 7.15E−02 | 7.58E−02 | 6.33E−02 | 7.16E−02 | 3.59E−02 | 3.96E−02 |
| ethyl isovalerate | 8.70E−03 | 1.53E−02 | 4.90E−03 | 5.20E−03 | 5.60E−03 | 6.70E−03 |
| ethyl lactate | 8.24E+00 | 9.58E+00 | ND | ND | ND | ND |
| ethyl laurate | 4.67E−02 | 5.78E−02 | 7.73E−02 | 8.23E−02 | 3.29E−02 | 3.67E−02 |
| ethyl myristate | 9.80E−03 | 1.27E−02 | 1.48E−02 | 1.60E−02 | 1.95E−02 | 2.41E−02 |
| ethyl nonanoate | 2.00E−03 | 2.00E−03 | 2.00E−03 | 2.00E−03 | 2.00E−03 | 2.00E−03 |
| ethyl octanoate | 6.09E−02 | 6.74E−02 | 6.76E−02 | 7.45E−02 | 2.12E−02 | 2.34E−02 |
| ethyl palmitate | 5.00E−04 | 3.70E−03 | 2.00E−03 | 2.80E−03 | 3.20E−03 | 1.29E−02 |
| ethyl phenyl acetate | 0.00E+00 | 0.00E+00 | ND | ND | ND | ND |
| ethyl propionate | 1.96E−01 | 2.25E−01 | 4.94E−01 | 5.39E−01 | 3.01E−01 | 3.37E−01 |
| ethyl undecanoate | 1.00E−04 | 1.0E−04 | ND | ND | ND | ND |
| ethyl valerate | 1.00E−04 | 2.00E−04 | ND | ND | ND | ND |
| ethyl-2- | 0.00E+00 | 0.00E+00 | 0.00E+00 | 0.00E+00 | 0.00E+00 | 0.00E+00 |
| mercaptopropionate | | | | | | |
| ethyl-2-methylbutyrate | 2.50E−03 | 3.20E−03 | 2.60E−03 | 2.80E−03 | 1.00E−03 | 1.20E−03 |
| ethyl-3-hydroxybutyrate | 0.00E+00 | 0.00E+00 | ND | ND | ND | ND |
| ethyl-trans-2-butenoate | 0.00E+00 | 0.00E+00 | 0.00E+00 | 0.00E+00 | 0.00E+00 | 0.00E+00 |
| ethyl-trans-3-hexenoate | 0.00E+00 | 0.00E+00 | 2.20E−03 | 2.20E−03 | 0.00E+00 | 0.00E+00 |
| eucalyptol | 0.00E+00 | 0.00E+00 | 3.71E−02 | 3.72E−02 | 0.00E+00 | 0.00E+00 |
| eugenol | 0.00E+00 | 0.00E+00 | ND | ND | ND | ND |
| furfural | 7.36E−01 | 8.59E−01 | 1.96E+00 | 2.52E+00 | 1.82E+00 | 3.50E+00 |
| furfuryl ether | 0.00E+00 | 0.00E+00 | 0.00E+00 | 0.00E+00 | 0.00E+00 | 0.00E+00 |
| furfuryl mercaptan | 0.00E+00 | 0.00E+00 | 0.00E+00 | 0.00E+00 | 0.00E+00 | 0.00E+00 |
| gamma-decalactone | 0.00E+00 | 0.00E+00 | 0.00E+00 | 8.20E−03 | 0.00E+00 | 0.00E+00 |
| gamma-dodecalactone | 0.00E+00 | 0.00E+00 | ND | ND | ND | ND |
| gamma-nonalactone | 0.00E+00 | 0.00E+00 | 0.00E+00 | 0.00E+00 | 0.00E+00 | 0.00E+00 |
| gamma-octalactone | 0.00E+00 | 1.00E−04 | ND | ND | ND | ND |
| gamma-terpinene | 0.00E+00 | 0.00E+00 | 0.00E+00 | 0.00E+00 | 0.00E+00 | 0.00E+00 |
| gamma-undecalactone | 0.00E+00 | 0.00E+00 | ND | ND | ND | ND |
| geraniol | 0.00E+00 | 0.00E+00 | 0.00E+00 | 0.00E+00 | 0.00E+00 | 0.00E+00 |
| geranyl acetate | 0.00E+00 | 0.00E+00 | ND | ND | ND | ND |
| guaiacol | 2.80E−03 | 3.70E−03 | ND | ND | ND | ND |
| heptyl acetate | 0.00E+00 | 0.00E+00 | ND | ND | ND | ND |
| hexanal | ND | ND | ND | ND | ND | ND |
| hexanoic acid | ND | ND | ND | ND | ND | ND |
| Hexanol | 0.00E+00 | 0.00E+00 | 0.00E+00 | 0.00E+00 | 0.00E+00 | 4.13E−02 |
| hexyl acetate | 0.00E+00 | 0.00E+00 | 0.00E+00 | 0.00E+00 | 0.00E+00 | 0.00E+00 |
| hexyl hexanoate | 4.00E−04 | 4.00E−04 | ND | ND | ND | ND |
| isoamyl acetate | 3.73E−02 | 4.26E−02 | 4.86E−02 | 5.27E−02 | 4.94E−02 | 5.69E−02 |
| isoamyl alcohol | 1.92E+01 | 1.70E+02 | 6.08E+01 | 8.91E+01 | 5.17E+01 | 7.39E+01 |
| isoamyl hexanoate | 0.00E+00 | 0.00E+00 | 0.00E+00 | 0.00E+00 | 0.00E+00 | 0.00E+00 |
| isoamyl octanoate | 3.00E−04 | 5.00E−04 | 4.00E−04 | 5.00E−04 | 3.00E−04 | 3.00E−04 |
| isoborneol | 0.00E+00 | 0.00E+00 | ND | ND | ND | ND |
| isobutanol | 2.61E+01 | 1.69E+02 | 8.66E+01 | 1.03E+02 | 9.60E+01 | 1.17E+02 |
| isobutyl acetate | 1.70E−02 | 1.98E−02 | 9.90E−03 | 1.06E−02 | 1.76E−02 | 1.94E−02 |
| isobutyric acid | 4.33E−01 | 5.22E−01 | ND | ND | ND | ND |
| isovaleraldehyde | 3.58E−02 | 4.19E−02 | ND | ND | ND | ND |
| isovaleric acid | 0.00E+00 | 3.00E−04 | 0.00E+00 | 0.00E+00 | 0.00E+00 | 1.00E−04 |
| Jasmine lactone | 0.00E+00 | 0.00E+00 | ND | ND | ND | ND |
| limonene | 0.00E+00 | 0.00E+00 | 0.00E+00 | 0.00E+00 | 0.00E+00 | 0.00E+00 |
| linalool | 2.50E−03 | 3.00E−03 | 2.30E−03 | 2.50E−03 | 1.40E−03 | 1.40E−03 |
| linalool oxide | 1.12E−02 | 1.57E−02 | ND | ND | ND | ND |
| linalyl acetate | 1.50E−03 | 1.60E−03 | 1.60E−03 | 1.70E−03 | 0.00E+00 | 0.00E+00 |
| linalyl butyrate | 0.00E+00 | 0.00E+00 | 0.00E+00 | 0.00E+00 | 0.00E+00 | 0.00E+00 |
| linalyl formate | 0.00E+00 | 0.00E+00 | ND | ND | ND | ND |
| maltol | 7.94E−02 | 8.03E−02 | 7.90E−02 | 7.90E−02 | 7.90E−02 | 7.90E−02 |
| methional | 0.00E+00 | 1.50E−03 | ND | ND | ND | ND |
| methyl anthranilate | 1.27E−02 | 1.27E−02 | 1.27E−02 | 1.27E−02 | 1.27E−02 | 1.27E−02 |
| methyl decanoate | 2.10E−03 | 2.10E−03 | 2.10E−03 | 2.10E−03 | 2.00E−03 | 2.00E−03 |
| methyl dihydrojasmonate | 0.00E+00 | 0.00E+00 | ND | ND | ND | ND |
| methyl hexanoate | 1.13E−01 | 1.36E−01 | 1.07E−01 | 1.14E−01 | 4.37E−02 | 4.49E−02 |
| methyl laurate | 4.00E−04 | 4.00E−04 | ND | ND | ND | ND |
| methyl octanoate | 0.00E+00 | 0.00E+00 | ND | ND | ND | ND |
| methyl salicylate | 1.19E−02 | 1.29E−02 | 1.53E−02 | 1.57E−02 | 1.21E−02 | 1.21E−02 |
| methyl vanillate | 0.00E+00 | 0.00E+00 | ND | ND | ND | ND |
| myrcene | 0.00E+00 | 1.00E−04 | ND | ND | ND | ND |
| myrtenol | 1.00E−03 | 1.40E−03 | ND | ND | ND | ND |
| nerol | 3.80E−03 | 4.80E−03 | 7.20E−03 | 8.40E−03 | 0.00E+00 | 0.00E+00 |
| neryl acetate | 0.00E+00 | 0.00E+00 | ND | ND | ND | ND |
| nonanal | 0.00E+00 | 0.00E+00 | 0.00E+00 | 0.00E+00 | 0.00E+00 | 0.00E+00 |
| octanoic acid | ND | ND | ND | ND | ND | ND |
| octyl acetate | 0.00E+00 | 0.00E+00 | ND | ND | ND | ND |
| p-anisaldehyde | 0.00E+00 | 0.00E+00 | ND | ND | ND | ND |
| p-cresol | 0.00E+00 | 0.00E+00 | ND | ND | ND | ND |
| p-cymene | 1.40E−03 | 1.50E−03 | 2.10E−03 | 2.10E−03 | 1.10E−03 | 1.10E−03 |
| phenethyl acetaldehyde | 0.00E+00 | 0.00E+00 | ND | ND | ND | ND |
| dimethyl acetal | | | | | | |
| phenethyl butyrate | 0.00E+00 | 0.00E+00 | 1.00E−04 | 1.00E−04 | 0.00E+00 | 0.00E+00 |
| phenethyl isobutyrate | ND | ND | ND | ND | ND | ND |
| phenethyl octanoate | 0.00E+00 | 1.70E−03 | ND | ND | ND | ND |
| phenethyl propionate | 2.20E−03 | 2.20E−03 | 2.20E−03 | 2.20E−03 | 2.20E−03 | 2.20E−03 |
| propanoic acid | ND | ND | ND | ND | ND | ND |
| propanol | 3.72E+01 | 4.03E+01 | ND | ND | ND | ND |
| propyl hexanoate | 0.00E+00 | 0.00E+00 | ND | ND | ND | ND |
| sotolon | ND | ND | ND | ND | ND | ND |
| trans-2-heptenal | 0.00E+00 | 5.00E−04 | ND | ND | ND | ND |
| trans-2-hexen-1-al | 0.00E+00 | 2.00E−04 | ND | ND | ND | ND |
| trans-2-hexen-1-ol | 0.00E+00 | 0.00E+00 | ND | ND | ND | ND |
| trans-2-pentenal | 5.26E−02 | 1.23E−01 | ND | ND | ND | ND |
| whiskey lactone | 0.00E+00 | 0.00E+00 | 0.00E+00 | 0.00E+00 | 0.00E+00 | 0.00E+00 |

TABLE 17F
VOCs in reference alcoholic beverages

| VOCs (all values in mg/L) | 24 | 25 | 26 | 27 | 28 | 29 |
|---|---|---|---|---|---|---|
| 1,1-diethoxyethane | 0.00E+00 | 0.00E+00 | 0.00E+00 | 1.36E+00 | 1.48E+00 | 1.53E+00 |
| 2-methyl-1-butanol | 2.35E+02 | 2.35E+02 | 2.19E+02 | 1.18E+02 | 1.33E+02 | 1.47E+02 |
| 2-phenylethanol | 2.03E+00 | 1.90E+00 | 1.92E+00 | 3.03E+00 | 3.20E+00 | 3.26E+00 |
| 4-ethylguaiacol | 4.44E−01 | 3.78E−01 | 3.65E−01 | 1.56E−02 | 0.00E+00 | 2.32E−02 |
| acetoin | 0.00E+00 | 0.00E+00 | 0.00E+00 | 0.00E+00 | 0.00E+00 | 0.00E+00 |
| a-terpineol | 1.54E−01 | 1.50E−01 | 1.28E−01 | 1.16E−01 | 1.17E−01 | 1.27E−01 |
| beta pinene | 1.06E+01 | 1.20E+01 | 1.14E+01 | 0.00E+00 | 0.00E+00 | 0.00E+00 |
| beta-ionone | 0.00E+00 | 0.00E+00 | 0.00E+00 | 0.00E+00 | 0.00E+00 | 0.00E+00 |
| butanol | 3.24E+00 | 2.67E+00 | 2.32E+00 | 8.35E+00 | 1.10E+01 | 9.47E+00 |
| citronellol | 4.66E−01 | 4.46E−01 | 4.65E−01 | 1.38E−01 | 1.48E−01 | 1.50E−01 |
| damascenone | 1.89E+00 | 1.90E+00 | 1.88E+00 | 5.80E−02 | 6.52E−02 | 6.00E−02 |
| diethyl succinate | 2.27E−01 | 1.54E−01 | 1.51E−01 | 5.20E−03 | 0.00E+00 | 1.20E−03 |
| ethyl acetate | 0.00E+00 | 0.00E+00 | 0.00E+00 | 1.74E+01 | 1.90E+01 | 2.07E+01 |
| ethyl butanoate | 1.25E−01 | 1.30E−01 | 1.39E−01 | 4.88E−02 | 4.08E−02 | 5.92E−02 |
| ethyl cinnamate | 5.60E−03 | 6.00E−03 | 5.20E−03 | 5.20E−03 | 5.60E−03 | 0.00E+00 |
| ethyl decanoate | 2.43E+00 | 2.48E+00 | 2.24E+00 | 2.69E+00 | 2.95E+00 | 2.88E+00 |
| ethyl hexanoate | 1.02E−01 | 1.06E−01 | 1.11E−01 | 0.00E+00 | 0.00E+00 | 0.00E+00 |
| ethyl isobutyrate | 0.00E+00 | 0.00E+00 | 0.00E+00 | 0.00E+00 | 0.00E+00 | 0.00E+00 |
| ethyl isovalerate | 0.00E+00 | 0.00E+00 | 0.00E+00 | 0.00E+00 | 0.00E+00 | 0.00E+00 |
| ethyl lactate | 0.00E+00 | 0.00E+00 | 0.00E+00 | 0.00E+00 | 0.00E+00 | 0.00E+00 |
| ethyl laurate | 6.94E−01 | 7.74E−01 | 6.34E−01 | 1.10E+01 | 1.13E+01 | 1.18E+01 |
| ethyl nonanoate | 8.88E−02 | 1.00E−01 | 8.76E−02 | 2.52E−02 | 3.00E−02 | 2.64E−02 |
| ethyl octanoate | 1.98E+02 | 2.27E+02 | 2.06E+02 | 7.67E−01 | 1.01E+00 | 9.42E−01 |
| ethyl phenyl acetate | 3.85E+00 | 3.55E+00 | 3.39E+00 | 6.28E−02 | 5.24E−02 | 5.64E−02 |
| ethyl-2-methylbutyrate | 0.00E+00 | 0.00E+00 | 0.00E+00 | 0.00E+00 | 0.00E+00 | 0.00E+00 |
| eugenol | 0.00E+00 | 0.00E+00 | 0.00E+00 | 0.00E+00 | 0.00E+00 | 0.00E+00 |
| guaiacol | 3.00E−02 | 1.56E−02 | 2.40E−02 | 5.36E−02 | 6.28E−02 | 5.48E−02 |
| Hexanol | 5.32E−02 | 5.00E−02 | 4.96E−02 | 0.00E+00 | 0.00E+00 | 0.00E+00 |
| isoamyl acetate | 1.03E+00 | 1.06E+00 | 1.04E+00 | 0.00E+00 | 0.00E+00 | 0.00E+00 |
| isoamyl alcohol | 8.38E+02 | 8.48E+02 | 8.78E+02 | 4.22E+02 | 4.73E+02 | 4.03E+02 |
| isobutanol | 9.33E+01 | 1.03E+02 | 1.27E+02 | 3.95E+02 | 4.68E+02 | 4.09E+02 |
| isobutyl acetate | 1.80E−02 | 1.84E−02 | 1.40E−02 | 1.32E−02 | 1.20E−02 | 2.08E−02 |
| isovaleraldehyde | 0.00E+00 | 0.00E+00 | 0.00E+00 | 3.05E−01 | 2.27E−01 | 2.58E−01 |
| linalool oxide | 1.55E+00 | 1.23E+00 | 1.10E+00 | 1.06E+00 | 9.64E−01 | 9.43E−01 |
| linalyl acetate | 2.40E+01 | 2.15E+01 | 1.98E+01 | 6.72E−02 | 1.44E−02 | 1.08E−02 |
| myrtenol | 4.24E−01 | 3.48E−01 | 3.51E−01 | 3.92E−02 | 5.00E−02 | 3.92E−02 |
| propanol | 9.66E+01 | 8.44E+01 | 8.10E+01 | 4.58E+02 | 6.08E+02 | 4.72E+02 |
| whiskey lactone | 5.16E−02 | 4.08E−02 | 5.72E−02 | 0.00E+00 | 2.00E−03 | 2.00E−03 |

LC-MS was used to measure the levels of various non-volatile compounds in several reference Moscato and whiskey samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:

Polarity: positive or negative mode, as indicated for each method

Resolution: 70,000

Scan range: 60-900 m/z for all methods with the exception of the lipid method, which is 134-2000 m/z

Isolation window: 1.5 m/z

MS/MS collision energy: 30

Preparation of Analytical Standards:

Stock solutions at a concentration of 1 mg/mL were made for each compound in 50% methanol. Serial dilutions were then made of each compound to create a 7-point standard curve, ranging from 10 ng/mL to 20 μg/mL. Standard curves were run in combinations of 7-12 compounds from each category per set, so long as there were no overlaps in retention time, which would have hindered quantitation.

Retention times were pre-determined for each compound by running the analytical standard at a 20 μg/mL dilution, and identifying the compound based on its accurate mass.

In all cases, five μL of each standard mix was injected through the autosampler and LC to the MS. Separation took place on a chromatographic column that was specific to each class of compounds. The conditions for each chromatographic method are described below, including the column, mobile phase and gradient used for each method.

Several types of columns were used for the different classes of compounds, as indicated in TABLE 4.

TABLE 4
List of compounds quantified by each method

| HILIC positive | HILIC negative | Omega negative | C18 positive | C18 negative |
|---|---|---|---|---|
| methionine | rhamnose | tartaric acid | quinic acid | rutin |
| histidine | glucose | citric acid | polydatin | quercetin |
| lysine | arabinose | lactic acid | acetovanillone | salicylic acid |
| serine | mannitol | 3,4-dihydroxybenzoic acid | epicatechin gallate | indole-3-lactic acid |
| leucine | fructose | gallic acid | vanillic acid | sinapinic acid |
| isoleucine | ribose | glucuronic acid | syringic acid | epicatechin |
| phenylalanine | arabitol | fumaric acid | caffeic acid | catechin |
| aspartic acid | inositol | ferulic acid | coumaric acid | resveratrol |
| tyrosine | fucose | malic acid | cinnamic acid | propyl gallate |
| glycine | mannose | galacturonic acid | syringaldehyde | herperetin |
| γ-aminobutyric acid | xylose | 2-isopropylmalic acid | pantothenic acid | trans-ferulic acid |
| pyridoxine | sorbitol | 2-furoic acid | vanillin | adipic acid |
| glucosamine | galactose | pyruvic acid | trans-4-hydroxy proline | methyl gallate |
| choline | beta-alanine | succinic acid | L-citrulline | ellagic acid |
| arginine | citrulline | | tryptamine | D-glucuronic acid |
| valine | myo-inositol | | tyramine | |
| proline | | | adenine | |
| alanine | | | guanine | |
| cysteine | | | acetylcholine | |
| asparagine | | | kynurenic acid | |
| glutamic acid | | | sorbic acid | |
| tryptophan | | | lauric acid | |
| ornithine | | | palmitic acid | |
| glutamine | | | 2,3,5,6- | |
| | | | tetramethylpyrazine | |
| threonine | | | 2,3,5-trimethylpyrazine | |
| carnitine | | | 2,3-dimethylpyrazine | |
| betaine | | | camphoric acid | |
| carnosine | | | methyl 2-pyrrolyl | |
| | | | ketone | |
| cystine | | | piperine | |
| homoserine | | | pyridine | |
| pipecolinic acid | | | 4-guanidinobutyric acid | |
| | | | cytosine | |
| | | | cytidine | |
| | | | uracil | |

Quantitation of Amino Acids and Similar Polar Compounds:

A HILIC (hydrophilic interaction liquid chromatography) column was used to assess polar compounds that can retain a positive charge. The mobile phase used with this column included A: H₂O+5 mM Ammonium Acetate+0.1% TFA (trifluoroacetic acid), and B: 90/10 ACN (Acetonitrile)/H₂O+5 mM Ammonium Acetate+0.1% TFA. Each chromatographic run was 27.5 minutes long, and the column temperature was maintained at 40° C. The column used was a Phenomenex Luna, 3 μm NH2, 100 Å, 150×2 mm (Product #00F-4377-BO), and the guard column was a Phenomenex Security Guard Cartridges, NH2, 4×2 mm (#PRD-196870).

TABLE 5
HILIC positive mode gradient conditions

| | Flow Rate | | |
|---|---|---|---|
| Time | (mL/min) | % A | % B |
| 0 | 0.5 | 5 | 95 |
| 6 | 0.5 | 5 | 95 |
| 18 | 0.5 | 60 | 40 |
| 20 | 0.5 | 80 | 20 |
| 22 | 0.5 | 5 | 95 |
| 27 | 0.5 | 5 | 95 |

Quantitation of Sugars and Sugar Alcohols:

The same HILIC column used for quantitation of the amino acids was used for quantitation of sugars, but the polarity of the MS was run in negative mode. While the same mobile phases were used, the gradient was slightly modified to help with retention. The temperature of the column also was held at 50° C. for better peak shape and separation of the isobaric sugars.

TABLE 6
HILIC negative mode gradient conditions

| | Flow Rate | | |
|---|---|---|---|
| Time | (mL/min) | % A | % B |
| 0 | 0.5 | 0 | 100 |
| 3 | 0.5 | 0 | 100 |
| 18 | 0.5 | 18 | 82 |
| 19 | 0.5 | 26 | 74 |
| 20 | 0.5 | 60 | 40 |
| 21 | 0.4 | 80 | 20 |
| 23 | 0.4 | 0 | 100 |
| 28 | 0.4 | 0 | 100 |

Quantitation of Non-Polar Compounds:

A C18 column was used to assess non-polar compounds, as they are retained in the long carbon chains under polar conditions. This method was run in both positive and negative modes, depending on each compound and whether it ionizes better with a positive or negative charge, respectively. The mobile phases used for this method were A: H2O+0.1% FA, and B: Methanol, and the temperature of the column was held at 50° C. The column used was an Agilent Poroshell 120, EC-C18 2.7 μm, 3.0×100 mm (Product #695975-302).

TABLE 7
C18 positive/negative mode gradient conditions

| | Flow Rate | | |
|---|---|---|---|
| Time | (mL/min) | % A | % B |
| 0 | 0.6 | 100 | 0 |
| 1.5 | 0.6 | 100 | 0 |
| 4 | 0.6 | 0 | 100 |
| 6 | 0.6 | 0 | 100 |
| 6.1 | 0.6 | 100 | 0 |
| 9 | 0.6 | 100 | 0 |

Quantitation of Organic Acids and Similarly Charged Polar Compounds:

To look at organic acids, a charged C18 column was used. The gradient used for the organic method was the same as for the C18 non-polar methods, as shown in TABLE 8. There was a modification to mobile phase B for this method, in that B: ACN+0.1% FA. The column used was a Phenomenex Luna Omega, 1.6 μm, PS C18 100 Å, 100×2.1 mm (Product #00D-4752-AN).

Quantitation of Lipids:

As lipids are very hydrophobic, they require stronger organic solvents in order to elute from any chromatographic column. The C18 column discussed above (Agilent Poroshell) was used to quantitate lipids, but the mobile phases that were used had a higher concentration of organic solvents. Samples were run in both positive and negative ionization modes, but the positive mode was used for quantitation of the two lipid standards. Mobile phase A: 60/40 H2O/ACN+5 mM Ammonium Acetate+0.1% FA, and B: 90/10 IPA/ACN+5 mM Ammonium Acetate+0.1% FA. The column temperature was held at 50° C.

TABLE 8
C18 Lipid positive/negative mode gradient conditions

| | Flow Rate | | |
|---|---|---|---|
| Time | (mL/min) | % A | % B |
| 0 | 0.6 | 80 | 20 |
| 1.5 | 0.6 | 80 | 20 |
| 4 | 0.6 | 45 | 55 |
| 10 | 0.6 | 20 | 80 |
| 11.5 | 0.6 | 0 | 100 |
| 15 | 0.6 | 0 | 100 |
| 15.5 | 0.6 | 80 | 20 |
| 17.5 | 0.6 | 80 | 20 |

Data Analysis:

Data analysis methods were developed with the XCalibur Processing Setup program, where methods were made for each standard cassette for each LC method. The compound mass and retention time was added for each standard, and calibration levels were applied for each standard. To calculate concentrations in samples, the samples and standards for each run were processed together using XCalibur Quan software, and concentrations calculated based on the respective compound calibration curve. Limits of detection were determined for each standard by running each standard curve at low levels until nothing was detected.

The LODs for non-volatile standard compounds are shown in TABLES 9A and 9B.

TABLE 9A
LODs for standards being quantified (in pg/mL, ng/mL, or ug/mL)

| Cassette | Compound | LOD | |
|---|---|---|---|
| 10 | methionine | 500 | pg |
| 10 | histidine | 10 | ng |
| 10 | lysine | 10 | ng |
| 10 | serine | 2 | ng |
| 10 | leucine | 500 | pg |
| 10 | phenylalanine | 500 | pg |
| 10 | aspartic acid | 5 | ug |
| 10 | tyrosine | 2 | ng |
| 10 | GABA | 2 | ng |
| 10 | pyridoxine | 100 | pg |
| 10 | glucosamine | 50 | ng |
| 10 | choline | 2 | ng |
| 11 | arginine | 10 | ng |
| 11 | valine | 100 | ng |
| 11 | proline | 2 | ng |
| 11 | alanine | 10 | ng |
| 11 | isoleucine | 10 | ng |
| 11 | cysteine | 1 | ug |
| 11 | asparagine | 10 | ng |
| 11 | glutamic acid | 10 | ng |
| 11 | tryptophan | 2 | ng |
| 11 | ornithine | 10 | ng |
| 11 | glutamine | 10 | ng |
| 11 | threonine | 10 | ng |
| 11 | carnitine | 500 | pg |
| 12 | tartaric acid | 100 | pg |
| 12 | citric acid | 10 | ng |
| 12 | 2-isopropylmalic acid | 100 | pg |
| 12 | lactic acid | 2 | ng |
| 12 | 3,4-dihydroxybenzoic acid | 100 | pg |
| 12 | gallic acid | 500 | pg |
| 12 | D-glucuronic acid | 100 | pg |
| 12 | fumaric acid | 500 | pg |
| 12 | malic acid | 100 | pg |
| 12 | galacturonic acid | 100 | pg |
| 12 | 2-furoic acid | 10 | ng |
| 12 | pyruvic acid | 100 | pg |
| 12 | succinic acid | 500 | pg |
| 13 | rhamnose | 10 | ng |
| 13 | glucose | 100 | ng |
| 13 | mannitol | 2 | ng |
| 13 | fructose | 2 | ng |
| 13 | Ribose | 10 | ng |
| 13 | arabitol | 2 | ng |
| 14 | rutin | 1 | ng |
| 14 | quercetin | 1 | ng |
| 14 | salicylic acid | 200 | pg |
| 14 | sinapinic acid | 200 | pg |
| 14 | epicatechin | 1 | ng |
| 14 | resveratrol | 4 | ng |
| 14 | propyl gallate | 200 | pg |
| 14 | trans-ferulic acid | 1 | ng |
| 14 | hesperetin | 200 | pg |
| 14 | adipic acid | 200 | pg |
| 14 | methyl gallate | 200 | pg |
| 14 | catechin | 1 | ng |
| 14 | ellagic acid | 1 | ng |
| 15 | inositol | 10 | ng |
| 15 | fucose | 100 | ng |
| 15 | mannose | 10 | ng |
| 15 | xylose | 100 | ng |
| 15 | sorbitol | 2 | ng |
| 15 | galactose | 10 | ng |
| 16 | quinic acid | 1 | ng |
| 16 | polydatin | 4 | ng |
| 16 | acetovanillone | 1 | ng |
| 16 | pantothenic acid | 0.2 | ng |
| 16 | vanillic acid | 10 | ng |
| 16 | syringic acid | 50 | ng |
| 16 | caffeic acid | 20 | ng |
| 16 | epicatechin gallate | 2 | ng |
| 16 | coumaric acid | 4 | ng |
| 16 | cinnamic acid | 500 | ng |
| 16 | syringaldehyde | 1 | ng |
| 16 | vanillin | 200 | pg |
| 17 | trans-4-hydroxy proline | 200 | pg |
| 17 | l-citrulline | 200 | pg |
| 17 | tryptamine | 200 | pg |
| 17 | tyramine | 1 | ng |
| 17 | adenine | 200 | pg |
| 17 | guanine | 200 | pg |
| 17 | acetylcholine | 1 | ng |
| 17 | kynurenic acid | 200 | pg |
| 17 | sorbic acid | 100 | ng |
| 17 | lauric acid | 200 | pg |
| 17 | palmitic acid | 200 | pg |

TABLE 9B
Additional LODs for standards being quantified (by parts)

| Compound | LOD | |
|---|---|---|
| 2,3,5,6-tetramethylpyrazine | <1 | ppb |
| 2,3,5-trimethylpyrazine | <1 | ppb |
| 2,3-dimethylpyrazine | <1 | ppb |
| b-alanine-2 | 100 | ppb |
| camphoric acid | not detected well | |
| citrulline | 100 | ppb |
| methyl 2-pyrrolyl ketone | <1 | ppb |
| piperine | <1 | ppb |
| pyridine | <1 | ppb |
| 4-guanidinobutyric acid | 100 | ppt |
| Betaine | <10 | ppb |
| carnosine | <10 | ppb |
| cystine | <100 | ppb |
| cytidine | 5 | ppb |
| cytosine | 100 | ppt |
| D-glucuronic acid | 500 | ppt |
| homoserine | <10 | ppb |
| myo-inositol | 50 | ppb |
| pipecolinic acid | <10 | ppb |
| uracil | 5 | ppb |
| glycine | 50 | ppb |

The levels of the non-volatile compounds measured in some reference samples are shown in TABLES 10A and 10B.

TABLE 10A
LC-MS of reference alcoholic beverages

| All values in mg/L | Sample 1 | Sample 2 | Sample 3 |
|---|---|---|---|
| Pyridine | NF | NF | NF |
| 2,3-dimethylpyrazine | NF | NF | NF |
| methyl-2-pyrrolyl ketone | NF | NF | NF |
| 2,3,5-trimethylpyrazine | NF | NF | NF |
| 2,3,5,6-tetramethylpyrazine | NF | NF | NF |
| Piperine | NQ | NQ | NQ |
| Pyridoxine | 0.199403036 | 0.481805766 | ND |
| Choline | 85.89217218 | 102.0707945 | 86.33845921 |
| Leucine | 10.1607167 | 10.30465706 | 10.94670147 |
| Phenylalanine | 4.678012476 | 6.015765027 | 5.839726201 |
| Methionine | 3.129717542 | 3.019698073 | 3.042192261 |
| GABA | 7.666032533 | 6.437404735 | 8.532519272 |
| Tyrosine | 4.661794734 | 4.509714182 | 5.284092148 |
| Serine | 1.414917723 | 1.661177711 | 1.795057091 |
| Aspartic Acid | ND | ND | ND |
| Glycine | ND | ND | ND |
| Glucosamine | 257.0063222 | 308.7104292 | 361.5683058 |
| Histidine | 1.851027247 | 1.869704239 | 2.044785509 |
| Lysine | 3.496517415 | 3.807746962 | 4.251842785 |
| Alanine | NM | NM | NM |
| Isoleucine | 3.546537195 | 4.890278584 | 5.30473154 |
| Carnitine | 1.947609282 | 2.97327195 | 3.608953903 |
| Tryptophan | 4.362924516 | 5.806331467 | 6.317194064 |
| Proline | 309.0802197 | 284.9568228 | 338.0987606 |
| Beta-ine | 16.931 | 16.632 | 16.418 |
| Valine | 0.394883618 | 0.414967712 | 0.008732626 |
| B-alanine-2 | ND | ND | ND |
| Threonine | 2.46966573 | 2.719806129 | 2.741757978 |
| Glutamine | NF | NF | NF |
| Asparagine | 1.607431843 | 1.761555118 | 1.766558253 |
| Glutamic acid | 10.34480463 | 9.511553646 | 10.01683479 |
| Cysteine | ND | ND | ND |
| Arginine | 3.603475444 | 3.981742654 | 4.362710993 |
| Ornithine | 0.113000686 | 0.114867698 | 0.11378003 |
| Trans-4-hydroxy-L-proline | 2.156342797 | 2.199709855 | 2.254573909 |
| Citrulline | NQ | NQ | NQ |
| Adenine | 9.466662642 | 9.759000998 | 9.625748602 |
| Guanine | 0.80676112 | 0.818507298 | 0.931713305 |
| Tyramine | NF | NF | NF |
| Tryptamine | NF | NF | NF |
| Kynurenic acid | 0.012133655 | 0.028393279 | 0.021038721 |
| Sorbic acid | NF | NF | NF |
| Quinic acid | 30.30410149 | 34.47217975 | 31.04242236 |
| Pantothenic acid | 0.112870494 | 0.134855337 | 0.30964594 |
| Vanillic acid | NF | NF | NF |
| Caffeic acid | 15.68024577 | 15.95698585 | 16.58111781 |
| Epicatechin gallate | NF | NF | NF |
| Syringic acid | NF | NF | NF |
| Polydatin | 0.838486448 | 0.831157928 | 0.81266767 |
| Vanillin | NF | NF | NF |
| Syringaldehyde | NF | NF | NF |
| Coumaric acid | 3.664934204 | 3.719916262 | 3.699873722 |
| Acetovanillone | NF | NF | NF |
| Cinnamic acid | NF | NF | NF |
| Tartaric acid | 3774.741249 | 3600.333332 | 3615.108763 |
| Malic acid | 2138.70021 | 2134.870694 | 2067.056371 |
| Pyruvic acid | 74.4477403 | 78.76383667 | 77.58717987 |
| D-Glucuronic acid | 895.8479408 | 836.9347522 | 810.5812616 |
| Lactic acid | 97.36245583 | 106.7936816 | 110.6277224 |
| Citric acid | 385.6209301 | 380.2923421 | 374.2760298 |
| Fumaric acid | 4.867614826 | 5.071537659 | 5.958585671 |
| Succinic acid | 522.9927958 | 559.8262557 | 555.9312262 |
| Gallic acid | 1.736642269 | 1.996493364 | 2.127515928 |
| 2-Furoic acid | 429.6685299 | 463.3777596 | 478.8691217 |
| 3,4-dihydroxybenzoic acid | 0.563215665 | 0.632488065 | 0.567838455 |
| 2-Isopropylmalic acid | 0.246916427 | 0.19745168 | 0.303795213 |
| Catechin | 3.991959802 | 3.645419926 | 3.486911825 |
| Adipic acid | NF | NF | NF |
| Epicatechin | 0.966455038 | 0.854674717 | 0.909006893 |
| Methyl gallate | NF | NF | NF |
| Rutin | NF | NF | NF |
| Sinapinic acid | NF | NF | NF |
| Trans-Ferulic acid | ND | ND | ND |
| Resveratrol | NF | NF | NF |
| Ellagic acid | 0.059393451 | 0.145636683 | 0.154033941 |
| Propyl gallate | NF | NF | NF |
| Quercetin | NQ | NQ | NQ |
| Salicylic acid | 0.779498799 | 0.750042681 | 0.909546731 |
| Hesperetin | NF | NF | NF |
| Fructose | 121429.3813 | 145080.3803 | 144274.656 |
| Glucose | 103257.5921 | 110684.659 | 118104.6196 |
| Ribose | 92.61139715 | 98.71946603 | 92.87288931 |
| Arabitol | 153.3447793 | 136.398207 | 113.3905107 |
| Xylose | NF | NF | NF |
| Fucose | NF | NF | NF |
| Sorbitol | 31.47383412 | 32.50075144 | 29.42672705 |
| Mannose | NF | NF | NF |
| Galactose | ND | ND | ND |
| Inositol | NF | NF | NF |
| Mannitol | 164.877 | 179.4467 | 153.0881 |

NF = not present or below the limit of detection
NQ = present but below the standard curve (e.g., below the LOQ)
ND = not determined
NM = no method

TABLE 10B
LC-MS of reference alcoholic beverages

| Round 2 assays (mg/L) | 1A | 1B | 1C | 2A | 2B | 2C |
|---|---|---|---|---|---|---|
| Pyridine | NF | NF | NF | NF | NF | NF |
| 2,3-dimethylpyrazine | NF | NF | NF | NF | NF | NF |
| Methyl 2-pyrrolyl ketone | NF | NF | NF | NF | NF | NF |
| 2,3,5-trimethylpyrazine | OC | OC | OC | NF | NF | NF |
| 2,3,5,6-Tetramethylpyrazine | OC | OC | OC | NF | NF | NF |
| Piperine | NF | NF | OC | NF | NF | NF |
| Pyridoxine | OC | 1.11E−01 | 1.07E−01 | 3.73E−01 | 3.37E−01 | 3.32E−01 |
| Choline | 1.97E+01 | 2.01E+01 | 1.96E+01 | OC | OC | OC |
| Leucine | 3.44E+00 | 3.44E+00 | 3.36E+00 | NR | 4.41E+00 | 5.50E+00 |
| Phenylalanine | 3.62E+00 | 3.53E+00 | 3.54E+00 | NR | 8.16E+00 | 1.06E+01 |
| Methionine | 1.49E+00 | 1.53E+00 | 1.49E+00 | NR | 2.36E+00 | 2.79E+00 |
| GABA | NF | NF | NF | NR | 1.00E+00 | 9.07E−01 |
| Tyrosine | 2.29E+00 | 2.32E+00 | 2.23E+00 | NR | 3.26E+00 | 3.32E+00 |
| Serine | 1.77E+00 | 1.72E+00 | 1.71E+00 | NR | 1.36E+00 | 1.44E+00 |
| Aspartic acid | OC | OC | OC | NR | NF | NF |
| Glycine | 1.87E+00 | 1.88E+00 | 1.87E+00 | NR | 1.02E+00 | 1.21E+00 |
| Glucosamine | NF | NF | NF | NR | 1.87E+01 | 1.66E+01 |
| Histidine | 1.44E+00 | 1.47E+00 | 1.39E+00 | NR | 1.52E+00 | 1.61E+00 |
| Lysine | OC | OC | OC | NR | 2.64E+00 | OC |
| isoleucine | OC | OC | OC | NR | OC | OC |
| Carnitine | 1.00E+00 | 1.02E+00 | 1.02E+00 | NR | 1.59E+00 | 1.92E+00 |
| tryptophan | 1.30E+00 | 1.42E+00 | 1.39E+00 | NR | 5.06E−01 | 5.13E−01 |
| proline | 1.13E+02 | 1.12E+02 | 1.12E+02 | NR | OC | OC |
| betaine | 3.98E+00 | 4.08E+00 | 4.09E+00 | NF | NF | NF |
| valine | NF | NF | NF | NR | 3.55E+00 | OC |
| beta-alanine | 1.87E+00 | 2.07E+00 | 1.98E+00 | NR | 1.42E+00 | 1.70E+00 |
| Threonine | 1.93E+00 | 9.36E−01 | 8.67E−01 | NR | OC | OC |
| Glutamine | NF | NF | NF | NR | NF | NF |
| asparagine | 1.06E+00 | 1.05E+00 | 1.06E+00 | NR | 9.49E−01 | 1.10E+00 |
| Glutamic acid | 4.83E+00 | 4.81E+00 | 4.27E+00 | NR | 1.61E+01 | 2.24E+01 |
| cysteine | NF | NF | NF | NR | NF | NF |
| arginine | 1.60E+00 | 1.66E+00 | 1.62E+00 | NR | 1.82E+00 | 3.45E+00 |
| Ornithine | NF | NF | NF | NR | NF | NF |
| 4-Guanidinobutyric acid | OC | OC | OC | OC | OC | OC |
| Pipecolinic acid | 1.22E+00 | 1.12E+00 | 1.13E+00 | NF | NF | NF |
| Carnosine | NF | NF | NF | NR | 2.23E−01 | 2.35E−01 |
| Homoserine | 7.08E−01 | 7.60E−01 | 7.68E−01 | NR | 6.14E−01 | 7.62E−01 |
| Cystine | NF | NF | NF | NR | NF | NF |
| Trans-4-hydroxyproline | 1.49E+00 | 1.49E+00 | 1.41E+00 | NR | 7.47E−01 | 9.77E−01 |
| Citrulline | NF | NF | NF | NR | NF | NF |
| Adenine | OC | OC | OC | 2.54E+00 | 2.45E+00 | 2.33E+00 |
| Guanine | 3.92E+02 | 3.92E+02 | 3.92E+02 | OC | OC | OC |
| Tyramine | NF | NF | NF | NF | NF | NF |
| Tryptamine | NF | NF | NF | NF | NF | NF |
| Kynurenic acid | NR | NR | NR | NR | NF | NF |
| Sorbic acid | NF | NF | NF | NF | NF | NF |
| Cytosine | OC | OC | OC | OC | OC | OC |
| Cytidine | 3.15E−01 | 3.16E−01 | 3.08E−01 | OC | OC | OC |
| Uracil | 1.87E+00 | 1.82E+00 | 1.81E+00 | 3.42E+00 | 3.41E+00 | 3.43E+00 |
| Quinic acid | NF | NF | NF | NF | NF | NF |
| Pantothenic acid | NR | NR | NR | OC | OC | OC |
| Vanillic acid | NR | NR | NR | NF | NF | NF |
| Caffeic acid | NR | NR | NR | 1.08E+01 | 1.03E+01 | 1.09E+01 |
| Epicatechin gallate | NR | NR | NR | NF | NF | NF |
| Syringic acid | NR | NR | NR | NF | NF | NF |
| Polydatin | NR | NR | NR | 2.38E−01 | 4.00E−01 | 2.20E−01 |
| Vanillin | NR | NR | NR | NF | NF | NF |
| Syringaldehyde | NR | NR | NR | NF | NF | NF |
| Coumaric acid | NR | NR | NR | 3.54E+00 | 3.36E+00 | 3.66E+00 |
| Acetovanillone | NR | NR | NR | OC | OC | OC |
| Cinnamic acid | NR | NR | NR | OC | OC | OC |
| Tartaric acid | 1.53E+03 | 1.42E+03 | 1.48E+03 | NR | OC | OC |
| Malic acid | 1.02E+03 | 9.72E+02 | 9.92E+02 | OC | OC | OC |
| Pyruvic acid | 3.53E+01 | 3.67E+01 | 3.80E+01 | 2.62E+01 | 2.64E+01 | 2.58E+01 |
| D-Glucuronic acid | 1.37E+03 | 1.36E+03 | 1.33E+03 | OC | OC | OC |
| Lactic acid | 4.43E+01 | 4.36E+01 | 4.29E+01 | NF | NF | NF |
| Citric acid | 2.91E+02 | 2.92E+02 | 2.89E+02 | NR | OC | OC |
| Fumaric acid | 2.71E+00 | 2.69E+00 | 2.61E+00 | NF | NF | NF |
| Succinic acid | 3.91E+02 | 3.98E+02 | 3.95E+02 | OC | OC | OC |
| Gallic acid | 1.24E+00 | 1.25E+00 | 1.27E+00 | 1.75E+00 | 1.66E+00 | 1.64E+00 |
| 2-Furoic acid | NF | NF | NF | OC | OC | OC |
| 3,4-dihydroxybenzoic acid | 3.24E−01 | 3.30E−01 | 3.33E−01 | 1.99E−01 | 1.92E−01 | 1.85E−01 |
| 2-Isopropylmalic acid | 8.00E+00 | 7.97E+00 | 8.90E+00 | 6.20E+00 | 6.26E+00 | 6.19E+00 |
| Catechin | 1.39E+00 | 1.40E+00 | 1.37E+00 | 4.41E−01 | 4.41E−01 | 4.41E−01 |
| Adipic acid | NF | NF | NF | NF | NF | NF |
| Epicatechin | 3.26E−01 | 3.35E−01 | 3.34E−01 | OC | OC | OC |
| Methyl gallate | NF | NF | NF | NF | NF | NF |
| Rutin | NF | NF | NF | NF | NF | NF |
| Sinapinic acid | OC | NF | NF | NF | NF | NF |
| Trans-Ferulic acid | 2.59E−01 | 2.43E−01 | 2.55E−01 | OC | OC | OC |
| Resveratrol | NF | NF | NF | 8.27E−03 | 8.27E−03 | 8.27E−03 |
| Ellagic acid | NF | NF | NF | 1.48E−01 | 1.48E−01 | 1.48E−01 |
| Propyl gallate | NF | NF | NF | NF | NF | NF |
| Quercetin | OC | OC | OC | OC | OC | OC |
| Salicylic acid | OC | 4.64E−02 | 6.46E−02 | OC | OC | OC |
| Hesperetin | OC | OC | OC | NF | NF | NF |
| Camphoric acid | OC | OC | OC | OC | OC | OC |
| Fructose | OC | OC | OC | 7.66E+03 | 5.52E+03 | 6.36E+03 |
| Glucose | OC | OC | OC | 8.72E+03 | 8.81E+03 | 8.06E+03 |
| Ribose | NF | NF | NF | NF | NF | NF |
| Arabitol | 1.10E+01 | 1.11E+01 | 1.17E+01 | NF | NF | NF |
| Xylose | NR | NR | NR | 2.59E+04 | 2.94E+04 | 2.82E+04 |
| Fucose | 8.52E+01 | 8.22E+01 | 1.09E+02 | 1.60E+03 | 2.27E+03 | 1.91E+03 |
| Sorbitol | NR | NR | NR | 1.60E+02 | 1.82E+02 | 1.83E+02 |
| Mannose | NR | NR | NR | NR | NR | NR |
| Galactose | NR | NR | NR | NR | NR | NR |
| Inositol | 3.29E+02 | 3.39E+02 | 2.89E+02 | NF | NF | NF |
| Mannitol | 2.25E+01 | 2.13E+01 | 2.20E+01 | 6.40E+01 | 7.72E+01 | 7.25E+01 |
| Rhamnose | 1.87E+01 | 1.97E+01 | 2.05E+01 | NF | NF | NF |
| Round 2 assays (mg/L) | 3A | 3B | 3C | 4A | 4B | 4C |
| Pyridine | NF | NF | NF | NF | NF | NF |
| 2,3-dimethylpyrazine | NF | NF | NF | NF | NF | NF |
| Methyl 2-pyrrolyl ketone | NF | NF | NF | NF | NF | NF |
| 2,3,5-trimethylpyrazine | OC | OC | OC | NF | NF | NF |
| 2,3,5,6-Tetramethylpyrazine | OC | OC | OC | NF | NF | NF |
| Piperine | NF | NF | OC | NF | NF | NF |
| Pyridoxine | OC | OC | 1.18E−01 | 2.84E−01 | 3.15E−01 | 2.96E−01 |
| Choline | 1.59E+01 | 1.59E+01 | 1.52E+01 | OC | OC | OC |
| Leucine | 5.00E−01 | 4.55E−01 | 5.00E−01 | OC | OC | OC |
| Phenylalanine | OC | OC | OC | 4.31E+00 | 4.25E+00 | 2.45E+00 |
| Methionine | OC | OC | OC | 8.40E−01 | 8.70E−01 | 7.02E−01 |
| GABA | NF | NF | NF | OC | OC | NF |
| Tyrosine | 9.28E−01 | 9.35E−01 | 8.90E−01 | 1.95E+00 | 2.02E+00 | 1.50E+00 |
| Serine | OC | OC | OC | 8.48E−01 | 8.36E−01 | 7.34E−01 |
| Aspartic acid | OC | OC | OC | NF | NF | NF |
| Glycine | OC | OC | OC | 4.08E−01 | 4.54E−01 | 4.87E−01 |
| Glucosamine | NF | NF | NF | 2.07E+01 | 1.71E+01 | 1.57E+01 |
| Histidine | OC | OC | OC | 4.85E−01 | 4.91E−01 | 4.65E−01 |
| Lysine | OC | OC | OC | OC | OC | OC |
| isoleucine | NF | NF | NF | OC | OC | OC |
| Carnitine | 8.58E−01 | 8.89E−01 | 8.85E−01 | 1.80E+00 | 1.80E+00 | 1.71E+00 |
| tryptophan | 5.17E−01 | 5.08E−01 | 5.01E−01 | 5.49E−01 | 5.30E−01 | 7.29E−01 |
| proline | 3.16E+01 | 3.17E+01 | 3.18E+01 | 6.24E+01 | 6.44E+01 | 5.96E+01 |
| betaine | 4.19E+00 | 4.31E+00 | 4.32E+00 | NF | NF | NF |
| valine | NF | NF | NF | OC | OC | OC |
| beta-alanine | 5.24E−01 | 4.04E−01 | 4.69E−01 | 1.37E−01 | 1.33E−01 | OC |
| Threonine | 2.06E−01 | 1.69E−01 | 1.83E−01 | OC | OC | OC |
| Glutamine | NF | NF | NF | NF | NF | NF |
| asparagine | 3.09E−01 | OC | 2.99E−01 | 4.03E−01 | 3.81E−01 | 3.36E−01 |
| Glutamic acid | 1.03E+00 | 9.01E−01 | 8.96E−01 | 6.16E+00 | 7.24E+00 | 7.21E+00 |
| cysteine | NF | NF | NF | NF | NF | NF |
| arginine | 4.31E−01 | 4.25E−01 | 3.73E−01 | 3.97E−01 | 3.46E−01 | 3.66E−01 |
| Ornithine | NF | NF | NF | NF | NF | NF |
| 4-Guanidinobutyric acid | OC | OC | OC | OC | OC | OC |
| Pipecolinic acid | 1.60E+00 | 1.63E+00 | 1.54E+00 | NF | NF | NF |
| Carnosine | NF | NF | NF | 6.20E−02 | 5.51E−02 | OC |
| Homoserine | OC | OC | OC | 4.11E−01 | 3.98E−01 | 4.06E−01 |
| Cystine | NF | NF | NF | NF | NF | NF |
| Trans-4-hydroxyproline | 7.79E−01 | 7.39E−01 | 7.97E−01 | 6.56E−01 | 7.37E−01 | 6.59E−01 |
| Citrulline | NF | NF | NF | NF | NF | NF |
| Adenine | OC | OC | OC | 9.91E−01 | 1.18E+00 | 9.58E−01 |
| Guanine | 3.91E+02 | 3.91E+02 | 3.91E+02 | OC | OC | OC |
| Tyramine | NF | NF | NF | NF | NF | NF |
| Tryptamine | NF | NF | NF | NF | NF | NF |
| Kynurenic acid | NR | NR | NR | NF | NF | NF |
| Sorbic acid | NF | NF | NF | NF | NF | NF |
| Cytosine | OC | OC | OC | OC | OC | OC |
| Cytidine | 3.73E−01 | 3.85E−01 | 3.92E−01 | OC | OC | OC |
| Uracil | 2.40E+00 | 2.52E+00 | 2.55E+00 | 3.30E+00 | 3.39E+00 | 3.36E+00 |
| Quinic acid | NF | NF | NF | NF | NF | NF |
| Pantothenic acid | NR | NR | NR | OC | OC | OC |
| Vanillic acid | NR | NR | NR | NF | NF | 6.17E−01 |
| Caffeic acid | NR | NR | NR | 6.38E+00 | 6.56E+00 | 6.54E+00 |
| Epicatechin gallate | NR | NR | NR | NF | NF | NF |
| Syringic acid | NR | NR | NR | NF | NF | NF |
| Polydatin | NR | NR | NR | OC | OC | OC |
| Vanillin | NR | NR | NR | NF | NF | NF |
| Syringaldehyde | NR | NR | NR | NF | NF | NF |
| Coumaric acid | NR | NR | NR | 2.06E+00 | 2.02E+00 | 1.85E+00 |
| Acetovanillone | NR | NR | NR | OC | OC | OC |
| Cinnamic acid | NR | NR | NR | 1.51E−01 | OC | OC |
| Tartaric acid | 6.12E+03 | 5.89E+03 | 6.03E+03 | OC | OC | OC |
| Malic acid | 4.31E+03 | 4.24E+03 | 4.16E+03 | OC | OC | OC |
| Pyruvic acid | 6.94E+01 | 7.01E+01 | 6.86E+01 | 4.02E+01 | 4.45E+01 | 4.08E+01 |
| D-Glucuronic acid | 8.48E+02 | 8.15E+02 | 8.15E+02 | OC | OC | OC |
| Lactic acid | 3.08E+01 | 3.38E+01 | 2.62E+01 | NF | NF | NF |
| Citric acid | OC | OC | OC | OC | OC | OC |
| Fumaric acid | 2.11E+00 | 1.82E+00 | 2.39E+00 | NF | NF | NF |
| Succinic acid | 3.65E+02 | 3.57E+02 | 3.52E+02 | OC | OC | OC |
| Gallic acid | 7.08E−01 | 7.08E−01 | 7.11E−01 | 1.13E+00 | 1.11E+00 | 1.06E+00 |
| 2-Furoic acid | NF | NF | NF | OC | OC | OC |
| 3,4-dihydroxybenzoic acid | 3.01E−01 | 2.98E−01 | 3.00E−01 | 1.09E−01 | 1.11E−01 | 1.05E−01 |
| 2-Isopropylmalic acid | 1.19E+01 | 1.22E+01 | 1.21E+01 | 8.81E+00 | 8.28E+00 | 8.47E+00 |
| Catechin | 1.65E+00 | 1.56E+00 | 1.79E+00 | 7.81E−01 | 7.81E−01 | 7.81E−01 |
| Adipic acid | NF | NF | NF | NF | NF | NF |
| Epicatechin | 3.74E−01 | 3.84E−01 | 4.07E−01 | OC | OC | OC |
| Methyl gallate | NF | NF | NF | NF | NF | NF |
| Rutin | NF | NF | NF | NF | NF | NF |
| Sinapinic acid | OC | NF | OC | NF | NF | NF |
| Trans-Ferulic acid | OC | OC | 1.48E−01 | OC | OC | OC |
| Resveratrol | NF | NF | NF | OC | OC | OC |
| Ellagic acid | NF | NF | NF | 4.48E−01 | 4.48E−01 | 4.48E−01 |
| Propyl gallate | NF | NF | NF | NF | NF | NF |
| Quercetin | 6.80E−01 | OC | 6.91E−01 | 6.22E−01 | 6.22E−01 | 6.22E−01 |
| Salicylic acid | OC | OC | OC | OC | OC | OC |
| Hesperetin | OC | OC | OC | NF | NF | NF |
| Camphoric acid | OC | OC | OC | 2.93E+01 | 3.28E+01 | 2.53E+01 |
| Fructose | OC | OC | OC | 6.25E+03 | 7.54E+03 | 1.54E+04 |
| Glucose | OC | OC | OC | 8.42E+03 | 1.14E+04 | 2.41E+04 |
| Ribose | NF | NF | NF | NF | NF | NF |
| Arabitol | 2.16E+00 | 2.39E+00 | 2.45E+00 | NF | NF | NF |
| Xylose | NR | NR | NR | 2.03E+04 | 2.01E+04 | 1.73E+04 |
| Fucose | 3.07E+01 | 3.71E+01 | 3.00E+01 | 2.56E+03 | 1.60E+03 | 2.50E+03 |
| Sorbitol | NR | NR | NR | 1.15E+02 | 1.11E+02 | 1.24E+02 |
| Mannose | NR | NR | NR | NR | NR | NR |
| Galactose | NR | NR | NR | NR | NR | NR |
| Inositol | 2.65E+02 | 2.21E+02 | 2.65E+02 | NF | NF | NF |
| Mannitol | 6.08E+00 | 6.09E+00 | 5.87E+00 | OC | OC | OC |
| Rhamnose | 3.43E+00 | 4.96E+00 | 2.90E+00 | NF | NF | NF |

NR = not run
NF = not found
OC = outside standard curve

The average levels of the non-volatile compounds measured some reference alcoholic beverage samples are shown in TABLE 11.

TABLE 11
LC-MS of reference alcoholic beverages

| Average values in mg/L | 1 | 2 | 3 | 4 | 5 | 6 | 7 |
|---|---|---|---|---|---|---|---|
| 2,3,5,6-tetramethylpyrazine | ND | ND | ND | ND | ND | ND | NF |
| 2,3,5-trimethylpyrazine | ND | ND | ND | ND | ND | ND | NF |
| 2,3-dimethylpyrazine | 2.21E−01 | ND | 1.75E−01 | 1.44E−01 | ND | ND | NF |
| 2-furoic acid | NF | NF | NF | NF | NF | NF | NF |
| 2-isopropylmalic acid | 1.52E+00 | 1.20E−01 | 7.02E−02 | 5.52E−02 | 1.64E+00 | 2.10E−01 | NF |
| 3,4-dihydroxybenzoic acid | 6.95E−01 | 5.00E−01 | 2.11E−01 | 2.23E−01 | 6.41E−01 | 4.62E−01 | NF |
| acetovanillone | 1.01E−01 | 1.87E−01 | 2.56E−02 | 5.26E−02 | 1.29E−01 | 1.92E−01 | NF |
| adenine | 7.31E−02 | ND | ND | ND | 1.57E−02 | ND | ND |
| arabitol | 1.43E+00 | 9.97E−01 | 2.00E−01 | 1.96E−01 | 1.66E+00 | 5.78E−01 | NF |
| arginine | 1.59E−01 | 8.87E−02 | 8.40E−02 | 8.15E−02 | 9.56E−02 | 8.91E−02 | NF |
| asparagine | 4.17E−02 | NF | NF | NF | NF | NF | NF |
| aspartic acid | 2.97E−01 | 2.87E−02 | 2.17E−02 | 2.17E−02 | 6.35E−02 | 2.92E−02 | NF |
| b-alanine | 2.28E−01 | NF | NF | NF | 1.41E−01 | NF | NF |
| caffeic acid | 1.41E+00 | 1.90E+00 | 1.63E+00 | 1.30E+00 | 1.74E+00 | 1.81E+00 | NF |
| camphoric acid | BC | BC | BC | BC | BC | BC | 9.62E+00 |
| carnitine | 3.18E−02 | ND | ND | ND | 1.35E−02 | ND | NF |
| choline | 1.27E+00 | 4.64E−01 | 3.03E−01 | 2.45E−01 | 1.15E+00 | 4.45E−01 | ND |
| cinnamic acid | NF | NF | NF | NF | NF | NF | NF |
| citric acid | 2.66E+00 | NF | 1.42E−01 | 1.42E−01 | 2.98E+00 | 3.21E+00 | NF |
| citrulline | 1.20E−02 | 2.77E−02 | 8.57E−03 | 1.11E−02 | 8.05E−03 | 1.14E−02 | NF |
| coumaric acid | 1.41E+00 | 1.59E+00 | 7.02E−01 | 1.13E+00 | 1.63E+00 | 2.31E+00 | NF |
| cysteine | NF | NF | NF | NF | NF | NF | NF |
| D-glucuronic acid | 9.87E+00 | 8.70E−01 | 3.89E−01 | 2.65E−01 | 9.64E+00 | 1.48E+00 | NF |
| epicatechin gallate | NF | NF | NF | NF | NF | NF | NF |
| fructose | 6.85E+01 | 8.45E+00 | 3.22E+01 | 2.12E+01 | 3.14E+01 | 6.95E+00 | NF |
| fucose | 3.24E+01 | 6.59E+01 | 2.02E+01 | 2.68E+01 | 5.33E+01 | 5.51E+01 | NF |
| fumaric acid | 2.92E−01 | 2.01E−01 | 1.57E−01 | 1.54E−01 | 2.48E−01 | 1.44E−01 | NF |
| GABA | 1.37E+00 | 4.44E−02 | 4.13E−02 | 2.43E−02 | 1.06E+00 | 5.25E−02 | NF |
| galactose | 1.19E+01 | 3.59E+00 | 1.12E+01 | 1.08E+01 | 7.64E+00 | 3.04E+00 | NF |
| gallic acid | 5.64E+00 | 5.22E+00 | 1.76E+00 | 2.62E+00 | 2.17E+01 | 6.72E+00 | NF |
| glucosamine | 2.58E−01 | 2.70E−02 | NF | 2.70E−02 | 1.70E−01 | 2.70E−02 | NF |
| glucose | 5.40E+01 | 1.60E+01 | 2.67E+01 | 2.33E+01 | 5.00E+01 | 1.71E+01 | NF |
| glutamic acid | 1.17E−01 | 2.21E−02 | 1.88E−02 | NF | 6.68E−02 | 2.54E−02 | NF |
| glutamine | 2.15E−02 | NF | NF | NF | NF | NF | NF |
| guanine | 2.21E−01 | 9.38E−03 | 2.01E−04* | ND | 8.16E−02 | 2.83E−03 | ND |
| histidine | 7.84E−02 | 7.39E−02 | NF | NF | NF | 7.88E−02 | NF |
| isoleucine | NF | NF | NF | NF | NF | NF | NF |
| kynurenic acid | 7.46E−02 | 1.34E−02 | 8.14E−03 | 8.06E−03 | 5.48E−02 | 1.24E−02 | NF |
| lactic acid | 1.65E+01 | 8.81E+00 | 4.75E+00 | 3.91E+00 | 1.53E+01 | 4.18E+00 | NF |
| leucine | NF | NF | NF | NF | NF | NF | NF |
| lysine | 1.21E−01 | 1.12E−01 | NF | NF | 1.12E−01 | 1.12E−01 | NF |
| malic acid | 7.78E+00 | 2.80E+00 | 6.68E−01 | 9.90E−01 | 7.50E+00 | 3.38E+00 | NF |
| mannitol | 1.91E+00 | 8.07E−01 | 1.16E−01 | 1.53E−01 | 3.00E+00 | 9.49E−01 | NF |
| mannose | NF | NF | NF | NF | NF | NF | NF |
| methionine | 3.46E−02 | 3.79E−02 | 3.55E−02 | 3.44E−02 | NF | 3.79E−02 | NF |
| Methyl 2-pyrrolyl ketone | NF | NF | NF | NF | NF | NF | NF |
| inositol | 8.21E+00 | 6.74E+00 | 1.23E+00 | 2.36E+00 | 1.07E+01 | 6.91E+00 | NF |
| ornithine | NF | NF | NF | NF | NF | NF | NF |
| pantothenic acid | NF | NF | NF | NF | NF | NF | NF |
| phenylalanine | 1.77E−01 | NF | 4.72E−02 | 4.72E−02 | NF | NF | NF |
| piperine | NF | NF | NF | NF | NF | NF | NF |
| polydatin | NF | NF | NF | NF | NF | NF | NF |
| proline | 1.36E+01 | 1.07E+00 | 4.35E−01 | 2.14E−01 | 6.32E+00 | 1.46E+00 | NF |
| pyridine | 1.76E+00 | ND | 1.86E+00 | 2.94E+00 | ND | ND | NF |
| pyridoxine | 3.51E−03 | 1.51E−02 | ND | 1.12E−03* | ND | 1.62E−02 | ND |
| pyruvic acid | 3.36E−01 | NF | 1.98E+00 | 4.01E−01 | 3.97E−01 | 5.29E−01 | NF |
| quinic acid | 9.52E−01 | 7.13E+00 | 1.36E+00 | 1.25E+00 | 1.54E+00 | 1.74E+00 | ND |
| rhamnose | 1.39E+01 | 2.67E+01 | 7.78E+00 | 1.08E+01 | 2.23E+01 | 2.32E+01 | NF |
| ribose | 2.90E+01 | 4.55E+01 | 1.33E+01 | 1.92E+01 | 4.60E+01 | 4.62E+01 | NF |
| serine | 1.19E−01 | 3.72E−02 | 3.43E−02 | 3.43E−02 | 6.14E−02 | 3.86E−02 | NF |
| sorbic acid | NF | NF | NF | NF | NF | NF | ND |
| sorbitol | 2.32E+00 | 3.62E−01 | 4.12E−01 | 3.95E−01 | 1.68E+00 | 3.04E−01 | NF |
| succinic acid | 7.80E+00 | 1.27E+00 | 3.74E−01 | 4.44E−01 | 4.79E+00 | 1.77E+00 | NF |
| syringaldehyde | 4.78E+00 | 7.91E+00 | 1.17E+00 | 2.82E+00 | 5.99E+00 | 7.61E+00 | NF |
| syringic acid | 2.29E−02 | 3.38E+00 | 1.46E+00 | 1.45E+00 | 2.56E+00 | 2.57E+00 | NF |
| tartaric acid | 1.95E+02 | 8.32E−01 | 3.70E+00 | 5.53E−01 | 2.54E+02 | 1.51E+00 | NF |
| threonine | NF | NF | NF | NF | NF | NF | NF |
| Trans-4-hydroxy-L-proline | 4.92E−01 | 1.57E−01 | 1.48E−02 | 3.29E−02 | 3.76E−01 | 1.40E−01 | NF |
| trans-ferulic acid | ND | ND | ND | ND | ND | ND | NF |
| tryptamine | NF | NF | NF | NF | NF | NF | ND |
| tryptophan | NF | 1.46E−02 | NF | NF | NF | 1.44E−02 | NF |
| tyramine | 2.22E−03* | NF | NF | NF | 3.84E−03* | NF | ND |
| tyrosine | ND | NF | NF | NF | NF | NF | NF |
| valine | NF | NF | NF | NF | NF | NF | NF |
| vanillic acid | 4.44E+01 | 1.17E+02 | 2.11E+01 | 4.09E+01 | 5.31E+01 | 1.02E+02 | NF |
| vanillin | 2.43E+00 | 3.95E+00 | 7.37E−01 | 1.85E+00 | 3.36E+00 | 2.95E+00 | NF |
| xylose | NF | NF | NF | NF | NF | NF | NF |

Values are the average of measurements for three samples of each whiskey type, except where noted by an asterisk(*).
NF = not present or below the limit of detection
ND = not determined
BC = bad curve

Levels of the non-volatile compounds measured some reference alcoholic beverages are shown in TABLES 18A, 18B, and 18C.

TABLE 18A
LC-MS of reference alcoholic beverages

| Compound (mg/L, | 1 | | 2 | | 3 | |
|---|---|---|---|---|---|---|
| unless noted) | min | max | min | max | min | max |
| alanine | 0.00E+00 | 0.00E+00 | 8.34E+00 | 8.34E+00 | 0.00E+00 | 0.00E+00 |
| arginine | 0.00E+00 | 0.00E+00 | 3.14E+01 | 3.14E+01 | 0.00E+00 | 0.00E+00 |
| asparagine | 0.00E+00 | 0.00E+00 | 7.98E+00 | 7.98E+00 | 0.00E+00 | 0.00E+00 |
| Aspartic acid | 0.00E+00 | 0.00E+00 | 9.55E+01 | 9.55E+01 | 0.00E+00 | 0.00E+00 |
| Beta-alanine | 0.00E+00 | 0.00E+00 | 8.34E+00 | 8.34E+00 | 0.00E+00 | 0.00E+00 |
| citrulline | 0.00E+00 | 0.00E+00 | 2.00E+01 | 2.00E+01 | 0.00E+00 | 0.00E+00 |
| cysteine | 0.00E+00 | 0.00E+00 | 0.00E+00 | 0.00E+00 | 0.00E+00 | 0.00E+00 |
| GABA | 1.20E−01 | 1.20E−01 | 1.88E+01 | 1.88E+01 | 0.00E+00 | 0.00E+00 |
| Glutamic acid | 0.00E+00 | 0.00E+00 | 2.70E+01 | 2.70E+01 | 0.00E+00 | 0.00E+00 |
| glutamine | 0.00E+00 | 0.00E+00 | 0.00E+00 | 0.00E+00 | 0.00E+00 | 0.00E+00 |
| glycine | 0.00E+00 | 0.00E+00 | 3.42E+01 | 3.42E+01 | 0.00E+00 | 0.00E+00 |
| histidine | 0.00E+00 | 0.00E+00 | 2.57E+00 | 2.57E+00 | 0.00E+00 | 0.00E+00 |
| isoleucine | 0.00E+00 | 0.00E+00 | 2.71E+01 | 2.71E+01 | 0.00E+00 | 0.00E+00 |
| leucine | 0.00E+00 | 0.00E+00 | 2.18E+01 | 2.18E+01 | 0.00E+00 | 0.00E+00 |
| lysine | 0.00E+00 | 0.00E+00 | 9.04E+00 | 9.04E+00 | 0.00E+00 | 0.00E+00 |
| methionine | 0.00E+00 | 0.00E+00 | 3.75E+00 | 3.75E+00 | 0.00E+00 | 0.00E+00 |
| phenylalanine | 0.00E+00 | 0.00E+00 | 6.82E+00 | 6.82E+00 | 0.00E+00 | 0.00E+00 |
| proline | 2.21E+00 | 2.21E+00 | 1.33E+03 | 1.33E+03 | 0.00E+00 | 0.00E+00 |
| serine | 0.00E+00 | 0.00E+00 | 7.01E+00 | 7.01E+00 | 0.00E+00 | 0.00E+00 |
| threonine | 0.00E+00 | 0.00E+00 | 6.94E+00 | 6.94E+00 | 0.00E+00 | 0.00E+00 |
| tryptophan | 0.00E+00 | 0.00E+00 | 2.11E+00 | 2.11E+00 | 0.00E+00 | 0.00E+00 |
| tyrosine | 6.31E−01 | 6.31E−01 | 7.12E+00 | 7.12E+00 | 0.00E+00 | 0.00E+00 |
| valine | 1.28E+00 | 1.28E+00 | 2.82E+02 | 2.82E+02 | 0.00E+00 | 0.00E+00 |
| acetic acid (% v/v) | 0.00E+00 | 0.00E+00 | 5.00E−01 | 2.00E+00 | 0.00E+00 | 0.00E+00 |
| Citric acid | 0.00E+00 | 0.00E+00 | 1.11E+02 | 1.79E+02 | 2.00E+02 | 4.00E+02 |
| D-gluconolactone | 9.93E+00 | 9.93E+00 | 1.10E+03 | 1.10E+03 | 0.00E+00 | 0.00E+00 |
| (gluconic acid) | | | | | | |
| fumaric acid | 3.34E−02 | 3.34E−02 | 7.76E+00 | 7.76E+00 | 0.00E+00 | 0.00E+00 |
| lactic acid | 6.86E+00 | 6.86E+00 | 2.58E+03 | 4.43E+03 | 2.25E+01 | 1.13E+02 |
| malic acid | 2.00E+00 | 2.00E+00 | 4.30E+01 | 5.25E+02 | 5.00E+01 | 2.00E+02 |
| pyruvic acid | 0.00E+00 | 0.00E+00 | 0.00E+00 | 0.00E+00 | 0.00E+00 | 0.00E+00 |
| succinic acid | 2.05E+00 | 2.05E+00 | 8.96E+01 | 1.12E+03 | 0.00E+00 | 1.00E+02 |
| Syringic acid | 2.39E+01 | 2.39E+01 | 0.00E+00 | 0.00E+00 | 0.00E+00 | 0.00E+00 |
| tartaric acid | 1.77E+01 | 1.77E+01 | 1.73E+03 | 4.13E+03 | 0.00E+00 | 0.00E+00 |
| vanillic acid | 4.85E+00 | 4.85E+00 | 6.80E+00 | 5.08E+02 | 0.00E+00 | 0.00E+00 |
| fructose | 1.12E+02 | 1.12E+02 | 2.00E+03 | 5.92E+03 | 0.00E+00 | 9.80E+02 |
| glucosamine | 7.77E+01 | 7.77E+01 | 3.91E−01 | 3.91E−01 | 0.00E+00 | 0.00E+00 |
| glucose | 2.45E+02 | 2.45E+02 | 3.71E+03 | 3.71E+03 | 0.00E+00 | 2.30E+02 |
| Mannose | 4.16E+01 | 4.16E+01 | 2.08E+02 | 2.08E+02 | 0.00E+00 | 0.00E+00 |
| glycerol | 0.00E+00 | 0.00E+00 | 1.30E+03 | 2.00E+04 | 0.00E+00 | 0.00E+00 |
| Inositol | 0.00E+00 | 0.00E+00 | 6.06E+02 | 6.06E+02 | 0.00E+00 | 0.00E+00 |
| Mannitol | 1.04E+01 | 1.04E+01 | 8.40E+02 | 8.40E+02 | 0.00E+00 | 0.00E+00 |
| Myo-Inositol | 1.78E+01 | 1.78E+01 | 0.00E+00 | 0.00E+00 | 0.00E+00 | 0.00E+00 |
| sorbitol | 1.11E+01 | 1.11E+01 | 3.57E+02 | 3.57E+02 | 0.00E+00 | 0.00E+00 |
| choline | 1.45E+01 | 1.45E+01 | 1.63E+02 | 1.63E+02 | 0.00E+00 | 0.00E+00 |
| surfactant (% v/v) | 0.00E+00 | 0.00E+00 | 0.00E+00 | 0.00E+00 | 0.00E+00 | 0.00E+00 |
| Pantothenic acid | 0.00E+00 | 0.00E+00 | 1.00E+00 | 1.00E+00 | 0.00E+00 | 0.00E+00 |
| pyridoxine | 0.00E+00 | 0.00E+00 | 6.60E−01 | 6.60E−01 | 0.00E+00 | 0.00E+00 |
| Acetovanillone | 4.51E−01 | 4.51E−01 | 0.00E+00 | 0.00E+00 | 0.00E+00 | 0.00E+00 |
| Carnitine | 0.00E+00 | 0.00E+00 | 2.55E+00 | 2.55E+00 | 0.00E+00 | 0.00E+00 |
| disodium 5′ | 0.00E+00 | 0.00E+00 | 6.00E−01 | 6.00E−01 | 0.00E+00 | 0.00E+00 |
| ribonucleotides (5′- | | | | | | |
| guanylate & 5′- | | | | | | |
| inosinate) | | | | | | |
| monosodium | 0.00E+00 | 0.00E+00 | 1.00E+01 | 1.00E+01 | 0.00E+00 | 0.00E+00 |
| glutamate | | | | | | |
| Syringaldehyde | 8.16E+00 | 8.16E+00 | 0.00E+00 | 0.00E+00 | 0.00E+00 | 0.00E+00 |
| Vanillin | 2.61E+01 | 2.61E+01 | 0.00E+00 | 0.00E+00 | 0.00E+00 | 0.00E+00 |
| Compound (mg/L, | 4 | | 5 | | 6 | |
| unless noted) | min | max | min | max | min | max |
| alanine | 6.55E+01 | 6.55E+01 | 1.88E+00 | 1.88E+00 | 0.00E+00 | 0.00E+00 |
| arginine | 3.02E+02 | 3.02E+02 | 3.72E+00 | 3.72E+00 | 2.83E+01 | 2.96E+02 |
| asparagine | 3.68E+01 | 3.68E+01 | 7.20E−01 | 7.20E−01 | 1.58E+01 | 7.82E+01 |
| Aspartic acid | 8.51E+01 | 8.51E+01 | 3.57E+00 | 3.57E+00 | 0.00E+00 | 6.19E+01 |
| Beta-alanine | 6.55E+01 | 6.55E+01 | 1.88E+00 | 1.88E+00 | 3.79E+01 | 2.07E+02 |
| citrulline | 0.00E+00 | 0.00E+00 | 0.00E+00 | 0.00E+00 | 0.00E+00 | 0.00E+00 |
| cysteine | 0.00E+00 | 0.00E+00 | 0.00E+00 | 0.00E+00 | 0.00E+00 | 0.00E+00 |
| GABA | 1.71E+02 | 1.71E+02 | 4.59E+00 | 4.59E+00 | 5.08E+00 | 5.69E+01 |
| Glutamic acid | 1.10E+02 | 1.10E+02 | 1.19E+01 | 1.19E+01 | 1.85E+01 | 1.69E+02 |
| glutamine | 1.94E+00 | 1.94E+00 | 4.50E−01 | 4.50E−01 | 0.00E+00 | 1.46E+01 |
| glycine | 5.17E+01 | 5.17E+01 | 1.08E+00 | 1.08E+00 | 0.00E+00 | 1.54E+02 |
| histidine | 3.33E+01 | 3.33E+01 | 2.54E+00 | 2.54E+00 | 6.05E+00 | 3.50E+01 |
| isoleucine | 2.35E+01 | 2.35E+01 | 3.54E+00 | 3.54E+00 | 1.80E+01 | 6.60E+01 |
| leucine | 6.34E+01 | 6.34E+01 | 3.93E+00 | 3.93E+00 | 5.46E+01 | 1.88E+02 |
| lysine | 3.41E+01 | 3.41E+01 | 9.73E+00 | 9.73E+00 | 1.46E+01 | 4.13E+01 |
| methionine | 1.27E+01 | 1.27E+01 | 8.00E−02 | 8.00E−02 | 4.29E+00 | 1.06E+01 |
| phenylalanine | 3.00E+01 | 3.00E+01 | 2.52E+00 | 2.52E+00 | 2.32E+01 | 8.16E+01 |
| proline | 4.59E+02 | 4.59E+02 | 1.59E+02 | 1.59E+02 | 4.09E+01 | 2.02E+02 |
| serine | 5.61E+01 | 5.61E+01 | 0.00E+00 | 0.00E+00 | 1.60E+01 | 8.34E+01 |
| threonine | 4.15E+01 | 4.15E+01 | 4.05E+00 | 4.05E+00 | 0.00E+00 | 2.00E+01 |
| tryptophan | 7.96E+00 | 7.96E+00 | 1.58E+00 | 1.58E+00 | 0.00E+00 | 4.62E+00 |
| tyrosine | 4.13E+01 | 4.13E+01 | 8.81E+00 | 8.81E+00 | 4.18E+01 | 2.21E+02 |
| valine | 1.35E+02 | 1.35E+02 | 3.84E+02 | 3.84E+02 | 1.95E+01 | 1.20E+03 |
| acetic acid (% v/v) | 6.00E−01 | 2.00E+00 | 1.00E+00 | 1.00E+00 | 0.00E+00 | 0.00E+00 |
| Citric acid | 1.03E+02 | 4.40E+02 | 1.40E+02 | 7.42E+02 | 3.50E+01 | 5.41E+01 |
| D-gluconolactone | 0.00E+00 | 0.00E+00 | 0.00E+00 | 0.00E+00 | 0.00E+00 | 0.00E+00 |
| (gluconic acid) | | | | | | |
| fumaric acid | 0.00E+00 | 0.00E+00 | 0.00E+00 | 0.00E+00 | 3.23E+00 | 3.23E+00 |
| lactic acid | 2.30E+03 | 2.92E+03 | 4.05E+01 | 1.67E+03 | 5.58E+01 | 6.99E+02 |
| malic acid | 5.00E+01 | 1.37E+02 | 6.89E+02 | 1.75E+03 | 2.26E+02 | 2.26E+02 |
| pyruvic acid | 0.00E+00 | 0.00E+00 | 0.00E+00 | 0.00E+00 | 3.79E+01 | 3.79E+01 |
| succinic acid | 4.67E+02 | 5.00E+02 | 1.68E+02 | 3.33E+02 | 1.61E+02 | 7.48E+02 |
| Syringic acid | 0.00E+00 | 0.00E+00 | 0.00E+00 | 0.00E+00 | 0.00E+00 | 0.00E+00 |
| tartaric acid | 1.80E+03 | 3.19E+03 | 1.17E+03 | 4.37E+03 | 3.52E+00 | 3.52E+00 |
| vanillic acid | 0.00E+00 | 0.00E+00 | 0.00E+00 | 0.00E+00 | 0.00E+00 | 0.00E+00 |
| fructose | 6.00E+03 | 2.00E+03 | 1.99E+04 | 1.20E+05 | 1.22E+02 | 7.25E+03 |
| glucosamine | 0.00E+00 | 0.00E+00 | 0.00E+00 | 0.00E+00 | 0.00E+00 | 0.00E+00 |
| glucose | 0.00E+00 | 0.00E+00 | 5.00E+03 | 4.59E+04 | 1.06E+04 | 2.09E+04 |
| Mannose | 0.00E+00 | 0.00E+00 | 7.00E+02 | 7.00E+02 | 4.35E+00 | 4.35E+00 |
| glycerol | 1.20E+04 | 1.20E+04 | 1.62E+03 | 6.30E+03 | 0.00E+00 | 0.00E+00 |
| Inositol | 0.00E+00 | 0.00E+00 | 8.63E+02 | 8.63E+02 | 0.00E+00 | 0.00E+00 |
| Mannitol | 0.00E+00 | 0.00E+00 | 7.34E+01 | 7.34E+01 | 6.25E+01 | 6.25E+01 |
| Myo-Inositol | 0.00E+00 | 0.00E+00 | 0.00E+00 | 0.00E+00 | 1.99E+00 | 1.99E+00 |
| sorbitol | 0.00E+00 | 0.00E+00 | 3.71E+01 | 3.71E+01 | 6.28E+01 | 6.28E+01 |
| choline | 0.00E+00 | 0.00E+00 | 0.00E+00 | 0.00E+00 | 0.00E+00 | 0.00E+00 |
| surfactant (% v/v) | 0.00E+00 | 0.00E+00 | 4.00E−03 | 4.00E−03 | 0.00E+00 | 0.00E+00 |
| Pantothenic acid | 0.00E+00 | 0.00E+00 | 0.00E+00 | 0.00E+00 | 0.00E+00 | 0.00E+00 |
| pyridoxine | 0.00E+00 | 0.00E+00 | 0.00E+00 | 0.00E+00 | 0.00E+00 | 0.00E+00 |
| Acetovanillone | 0.00E+00 | 0.00E+00 | 0.00E+00 | 0.00E+00 | 0.00E+00 | 0.00E+00 |
| Carnitine | 0.00E+00 | 0.00E+00 | 0.00E+00 | 0.00E+00 | 0.00E+00 | 0.00E+00 |
| disodium 5′ | 6.00E−01 | 6.00E−01 | 6.00E−01 | 6.00E−01 | 0.00E+00 | 0.00E+00 |
| ribonucleotides (5′- | | | | | | |
| guanylate & 5′- | | | | | | |
| inosinate) | | | | | | |
| monosodium | 1.00E+01 | 1.00E+01 | 1.00E+01 | 1.00E+01 | 0.00E+00 | 0.00E+00 |
| glutamate | | | | | | |
| Syringaldehyde | 0.00E+00 | 0.00E+00 | 0.00E+00 | 0.00E+00 | 0.00E+00 | 0.00E+00 |
| Vanillin | 0.00E+00 | 0.00E+00 | 0.00E+00 | 0.00E+00 | 0.00E+00 | 0.00E+00 |

ND = Not determined

TABLE 18B
LC-MS of reference alcoholic beverages

| Compound (mg/L, | | | | | | | | | |
|---|---|---|---|---|---|---|---|---|---|
| unless noted) | 1A | 1B | 1C | 2A | 2B | 2C | 3A | 3B | 3C |
| arginine | 1.33E−01 | 1.33E−01 | 1.27E−01 | 6.83E−02 | 6.86E−02 | 6.82E−02 | 6.83E−02 | 6.81E−02 | 6.80E−02 |
| asparagine | 3.43E−02 | 3.16E−02 | 3.11E−02 | 1.71E−02 | 1.59E−02 | NF | NF | NF | NF |
| Aspartic acid | 9.86E−02 | 9.88E−02 | 9.59E−02 | 1.61E−01 | 1.43E−01 | 1.21E−01 | 2.29E−02 | 2.52E−02 | 2.30E−02 |
| B-Alanine-2 | NF | NF | NF | NF | NF | NF | NF | NF | NF |
| citrulline | NF | NF | NF | 1.21E−02 | 2.23E−02 | 2.61E−02 | 7.46E−03 | 8.01E−03 | 6.95E−03 |
| cysteine | NF | NF | NF | NF | NF | NF | NF | NF | NF |
| GABA | 1.09E−01 | 8.01E−02 | 6.89E−02 | 1.14E−02 | 1.04E−02 | 9.85E−03 | 1.28E−02 | 1.16E−02 | 1.09E−02 |
| Glutamic acid | 4.81E−02 | 4.53E−02 | 4.36E−02 | 3.66E−02 | 3.43E−02 | 3.17E−02 | 2.32E−02 | 2.27E−02 | 2.33E−02 |
| glutamine | 3.08E−02 | 2.82E−02 | 2.87E−02 | NF | NF | NF | NF | NF | NF |
| glycine | ND | ND | ND | NF | NF | NF | NF | NF | NF |
| histidine | 8.09E−02 | 8.00E−02 | 7.76E−02 | 1.21E−01 | 1.15E−01 | 1.09E−01 | NF | 7.66E−02 | 7.65E−02 |
| isoleucine | 5.68E−02 | 5.33E−02 | 5.63E−02 | NF | NF | NF | NF | NF | NF |
| leucine | NF | NF | NF | 6.05E−02 | 6.03E−02 | 6.01E−02 | NF | NF | NF |
| lysine | 1.15E−01 | 1.15E−01 | 1.15E−01 | 1.17E−01 | 1.17E−01 | 1.15E−01 | NF | NF | NF |
| methionine | 3.63E−02 | 3.64E−02 | 3.66E−02 | 2.15E−02 | 2.13E−02 | 2.11E−02 | NF | NF | NF |
| phenylalanine | 5.10E−02 | 5.02E−02 | 5.03E−02 | 5.14E−02 | 4.88E−02 | 4.86E−02 | NF | NF | NF |
| proline | 9.31E+00 | 9.02E+00 | 8.83E+00 | 1.05E−01 | 9.76E−02 | 7.68E−02 | 5.14E−02 | 3.65E−02 | 2.00E−02 |
| serine | 4.38E−02 | 4.45E−02 | 4.20E−02 | 1.66E−01 | 1.46E−01 | 1.29E−01 | 3.30E−02 | 3.30E−02 | 3.32E−02 |
| threonine | 2.18E−02 | 2.18E−02 | 2.04E−02 | 2.75E−02 | 2.46E−02 | 2.26E−02 | NF | NF | NF |
| tryptophan | 1.84E−01 | 1.83E−01 | 1.89E−01 | 2.97E−02 | 3.02E−02 | 2.68E−02 | NF | NF | NF |
| tyrosine | 7.73E−03 | 7.36E−03 | 7.27E−03 | NF | NF | NF | NF | NF | NF |
| valine | 2.48E−01 | 2.72E−01 | 2.77E−01 | NF | NF | NF | NF | NF | NF |
| Tyramine | NF | NF | NF | NF | NF | NF | NF | NF | NF |
| Tryptamine | OC | OC | OC | OC | OC | OC | OC | OC | OC |
| Ornithine | 1.16E−01 | 1.12E−01 | 1.10E−01 | 1.26E−01 | 1.26E−01 | 1.17E−01 | NF | NF | NF |
| Trans-4- | OC | OC | OC | 3.23E−02 | 9.17E−02 | 9.24E−02 | 5.65E−02 | 5.39E−02 | 4.37E−02 |
| hydroxyproline | | | | | | | | | |
| Citric acid | NF | NF | NF | NF | NF | NF | NF | NF | NF |
| fumaric acid | OC | OC | 1.28E−02 | 1.45E−02 | 1.16E−02 | 2.62E−03 | NF | NF | NF |
| lactic acid | 2.39E+00 | 2.66E+00 | 3.23E+00 | 8.37E−01 | 6.90E−01 | 6.85E−01 | 3.11E−01 | 2.84E−01 | 2.43E−01 |
| malic acid | 5.67E−01 | 5.48E−01 | 5.53E−01 | 7.41E−01 | 6.94E−01 | 6.64E−01 | 1.17E−01 | 8.96E−02 | 6.97E−02 |
| pyruvic acid | NF | NF | NF | 4.12E−01 | 3.54E−01 | 3.34E−01 | 1.33E−01 | 1.17E−01 | 8.38E−02 |
| succinic acid | 7.73E−01 | 7.12E−01 | 7.69E−01 | 4.64E−01 | 4.54E−01 | 4.21E−01 | 1.16E−01 | 1.13E−01 | 1.05E−01 |
| Syringic acid | NF | NF | NF | 1.06E+00 | 1.31E+00 | 1.22E+00 | 6.83E−01 | 6.17E−01 | 3.53E−01 |
| tartaric acid | 3.55E+00 | 3.40E+00 | 3.60E+00 | 1.30E−01 | 1.53E−01 | 1.40E−01 | 1.56E−01 | 1.29E−01 | 1.33E−01 |
| vanillic acid | 7.08E−01 | 6.17E−01 | 5.64E−01 | 4.64E+01 | 5.72E+01 | 6.37E+01 | 5.78E+01 | 5.83E+01 | 5.68E+01 |
| Sorbic acid | 2.63E+00 | 2.82E+00 | 2.64E+00 | 2.98E+00 | 3.39E+00 | 2.92E+00 | 3.26E+00 | 3.55E+00 | 2.79E+00 |
| D-Glucuronic acid | 5.69E+00 | 5.59E+00 | 5.60E+00 | 1.88E−01 | 1.60E−01 | 1.46E−01 | OC | OC | OC |
| Quinic acid | 5.82E−02 | 3.25E−02 | 5.23E−02 | 5.82E−01 | 8.21E−01 | 8.32E−01 | 2.42E+00 | 2.32E+00 | 2.15E+00 |
| Gallic acid | 2.22E−01 | 2.38E−01 | 2.61E−01 | 5.34E−01 | 5.45E−01 | 5.29E−01 | 1.29E−01 | 1.18E−01 | 8.30E−02 |
| 2-Furoic acid | NF | NF | NF | 0.00E+00 | 0.00E+00 | 0.00E+00 | 0.00E+00 | 0.00E+00 | 0.00E+00 |
| 3,4- | 8.11E−03 | 1.29E−02 | 1.46E−02 | 0.00E+00 | 0.00E+00 | 0.00E+00 | 0.00E+00 | 0.00E+00 | 0.00E+00 |
| dihydroxybenzoic | | | | | | | | | |
| acid | | | | | | | | | |
| 2-Isopropylmalic | 6.06E−02 | 7.84E−02 | 7.46E−02 | 0.00E+00 | 0.00E+00 | 0.00E+00 | 0.00E+00 | 0.00E+00 | 0.00E+00 |
| acid | | | | | | | | | |
| Adipic acid | 4.66E−02 | 4.27E−02 | 4.47E−02 | 3.60E−02 | 5.41E−02 | 3.64E−02 | 5.00E−02 | 5.46E−02 | 3.76E−02 |
| Trans-Ferulic acid | 1.95E−02 | 1.80E−02 | 1.77E−02 | 8.76E−02 | 9.61E−02 | 9.20E−02 | 6.75E−02 | 7.30E−02 | 6.05E−02 |
| Sinapinic acid | NF | NF | NF | 6.15E−02 | 6.30E−02 | 6.31E−02 | 6.39E−02 | 6.68E−02 | 6.49E−02 |
| Ellagic acid | 1.70E−01 | 1.53E−01 | 1.25E−01 | 1.23E+01 | 1.49E+01 | 1.25E+01 | 6.18E+00 | 7.73E+00 | 6.55E+00 |
| Cinnamic acid | 3.65E+00 | 4.38E+00 | 3.95E+00 | NF | NF | NF | NF | NF | NF |
| Coumaric acid | 3.01E−02 | 3.42E−02 | 7.29E−02 | 3.32E−01 | 3.83E−01 | 3.49E−01 | 5.95E−01 | 4.35E−01 | 4.63E−01 |
| Kynurenic acid | NF | NF | NF | 5.67E−03 | 7.50E−03 | 6.83E−03 | 8.99E−03 | 8.53E−03 | 8.00E−03 |
| fructose | 1.45E+03 | 1.40E+03 | 1.32E+03 | 2.21E+00 | 2.28E+00 | 2.20E+00 | 1.90E+00 | 2.03E+00 | 2.04E+00 |
| glucosamine | NF | NF | NF | NF | NF | NF | NF | NF | NF |
| glucose | NF | NF | NF | 5.56E+00 | 5.54E+00 | 5.07E+00 | 4.62E+00 | 3.65E+00 | 3.78E+00 |
| Ribose | NF | NF | NF | 1.41E+01 | 1.34E+01 | 1.25E+01 | 1.24E+01 | 1.28E+01 | 1.17E+01 |
| Arabitol | NF | NF | NF | 2.80E−01 | 2.69E−01 | 2.56E−01 | 9.27E−01 | 9.46E−01 | 8.83E−01 |
| Rhamnose | NF | NF | NF | 6.96E−01 | 6.58E−01 | 6.86E−01 | 9.56E−01 | 9.17E−01 | 9.13E−01 |
| Xylose | NF | NF | NF | 1.31E+01 | 1.23E+01 | 1.16E+01 | 1.16E+01 | 1.17E+01 | 1.09E+01 |
| Fucose | 4.07E−01 | 1.82E−01 | 2.00E−01 | 1.54E+00 | 1.40E+00 | 1.41E+00 | 2.27E+00 | 2.25E+00 | 2.16E+00 |
| Mannitol | 1.51E−01 | 1.52E−01 | 1.45E−01 | 3.71E−01 | 3.58E−01 | 3.49E−01 | 5.63E−01 | 5.63E−01 | 5.57E−01 |
| Inositol | NF | NF | NF | 1.54E+00 | 1.62E+00 | 1.52E+00 | 1.99E+00 | 1.79E+00 | 1.66E+00 |
| sorbitol | 6.08E−02 | 6.68E−02 | 6.25E−02 | 2.56E−01 | 2.55E−01 | 2.56E−01 | 4.43E−01 | 4.45E−01 | 4.55E−01 |
| choline | 2.00E−01 | 1.88E−01 | 1.85E−01 | 6.92E−02 | 6.91E−02 | 6.46E−02 | 7.28E−02 | 6.62E−02 | 7.16E−02 |
| Pantothenic acid | OC | OC | OC | OC | OC | OC | OC | OC | OC |
| pyridoxine | OC | OC | OC | OC | OC | OC | OC | OC | OC |
| Acetovanillone | OC | OC | OC | OC | 7.91E−04 | 1.00E−02 | 8.45E−03 | 9.56E−03 | 3.14E−03 |
| Carnitine | 2.17E−02 | 2.12E−02 | 1.96E−02 | 1.14E−03 | 1.40E−03 | 1.21E−03 | 1.72E−03 | 1.77E−03 | 1.58E−03 |
| Syringaldehyde | OC | OC | OC | 1.19E+00 | 1.56E+00 | 1.71E+00 | 2.43E+00 | 2.41E+00 | 2.26E+00 |
| Vanillin | 4.96E−03 | 1.22E−02 | 2.10E−02 | 6.54E−01 | 8.78E−01 | 9.90E−01 | 1.42E+00 | 1.47E+00 | 1.40E+00 |
| Adenine | 4.30E−04 | OC | OC | OC | OC | OC | OC | OC | OC |
| Guanine | 9.58E−03 | 9.88E−03 | 1.26E−02 | OC | OC | 1.99E−04 | 8.23E−03 | 1.04E−02 | 1.09E−02 |
| Catechin | 5.42E−02 | 5.42E−02 | 5.44E−02 | 5.51E−02 | 5.53E−02 | 5.55E−02 | 5.55E−02 | 5.63E−02 | 5.63E−02 |
| Methyl gallate | 6.10E−02 | 6.10E−02 | 6.11E−02 | 6.53E−02 | 6.67E−02 | 6.62E−02 | 6.57E−02 | 6.65E−02 | 6.61E−02 |
| Epicatechin | 6.97E−02 | 6.96E−02 | 7.02E−02 | 7.13E−02 | 7.17E−02 | 7.20E−02 | 7.23E−02 | 7.40E−02 | 7.31E−02 |
| Rutin | NF | NF | NF | NF | NF | NF | NF | NF | NF |
| Resveratrol | NF | NF | NF | NF | NF | NF | NF | NF | NF |
| Propyl gallate | 4.66E−02 | 4.66E−02 | 4.67E−02 | 5.30E−02 | 5.38E−02 | 5.30E−02 | 5.37E−02 | 5.67E−02 | 5.54E−02 |
| Quercetin | 1.55E−01 | 1.54E−01 | 1.54E−01 | 1.63E−01 | 1.66E−01 | 1.67E−01 | 1.70E−01 | 1.74E−01 | 1.74E−01 |
| Hesperetin | NF | NF | NF | NF | NF | NF | NF | NF | NF |
| Epicatechin gallate | NF | NF | NF | NF | NF | NF | NF | NF | NF |
| Polydatin | NF | NF | NF | NF | NF | NF | NF | NF | NF |

ND = not determined
NF = not found
OC = outside of standard curve

TABLE 18C
LC-MS of reference alcoholic beverages

| Compound (mg/L, | | | | | | | | | |
|---|---|---|---|---|---|---|---|---|---|
| unless noted) | 4A | 4B | 4C | 5A | 5B | 5C | 6A | 6B | 6C |
| arginine | 6.86E−02 | 6.84E−02 | 6.79E−02 | 6.79E−02 | 6.82E−02 | 6.78E−02 | 6.86E−02 | 6.83E−02 | 6.83E−02 |
| asparagine | NF | NF | NF | NF | NF | NF | NF | NF | NF |
| Aspartic acid | NF | NF | NF | NF | NF | NF | NF | ND | NF |
| Beta-alanine | NF | NF | NF | NF | NF | NF | NF | NF | NF |
| citrulline | 6.72E−03 | 7.33E−03 | 8.30E−03 | 1.11E−02 | 1.24E−02 | 1.31E−02 | 7.52E−03 | 7.52E−03 | 7.86E−03 |
| cysteine | NF | NF | NF | NF | NF | NF | NF | NF | NF |
| GABA | 1.43E−02 | 1.29E−02 | 1.09E−02 | 8.69E−03 | 8.27E−03 | 8.37E−03 | 1.27E−02 | ND | 1.04E−02 |
| Glutamic acid | NF | NF | NF | NF | NF | NF | NF | NF | NF |
| glutamine | NF | NF | NF | NF | NF | NF | NF | NF | NF |
| glycine | NF | NF | NF | NF | NF | NF | NF | ND | NF |
| histidine | 7.74E−02 | 7.73E−02 | 7.68E−02 | 7.69E−02 | 7.72E−02 | 7.67E−02 | 7.71E−02 | ND | 7.66E−02 |
| isoleucine | NF | NF | NF | NF | NF | NF | NF | NF | NF |
| leucine | NF | NF | NF | NF | NF | NF | NF | ND | NF |
| lysine | NF | NF | NF | NF | NF | NF | NF | ND | NF |
| methionine | NF | NF | NF | NF | NF | NF | NF | ND | 2.52E−02 |
| phenylalanine | NF | NF | NF | NF | NF | NF | NF | ND | 3.46E−02 |
| proline | 1.02E−01 | 9.62E−02 | 6.70E−02 | 3.47E−02 | 4.19E−02 | 2.64E−02 | 7.84E−02 | 6.99E−02 | 6.18E−02 |
| serine | 3.30E−02 | 3.26E−02 | 3.28E−02 | NF | NF | NF | NF | ND | NF |
| threonine | NF | NF | NF | NF | NF | NF | NF | NF | NF |
| tryptophan | NF | NF | NF | NF | NF | NF | NF | NF | NF |
| tyrosine | NF | NF | NF | NF | NF | NF | NF | ND | NF |
| valine | NF | NF | NF | NF | NF | NF | NF | NF | NF |
| Tyramine | NF | NF | NF | NF | NF | NF | NF | NF | NF |
| Tryptamine | OC | OC | OC | OC | OC | OC | OC | OC | OC |
| Ornithine | NF | NF | NF | NF | NF | NF | NF | NF | NF |
| Trans-4- | 2.40E−02 | 3.09E−02 | 3.61E−02 | OC | 1.86E−02 | 1.91E−02 | OC | 2.88E−02 | 3.84E−02 |
| hydroxyproline | | | | | | | | | |
| Citric acid | NF | NF | NF | NF | NF | NF | NF | NF | NF |
| fumaric acid | 2.88E−02 | 4.76E−02 | 4.70E−02 | NF | NF | NF | 8.45E−04 | 7.89E−03 | 9.11E−03 |
| lactic acid | 3.16E+00 | 4.87E+00 | 4.21E+00 | OC | 2.41E−02 | 2.48E−02 | 3.05E+00 | 2.72E+00 | 2.57E+00 |
| malic acid | 5.79E−01 | 8.88E−01 | 7.37E−01 | NF | NF | NF | 5.79E−01 | 6.03E−01 | 6.13E−01 |
| pyruvic acid | 1.82E−01 | 2.03E−01 | 1.62E−01 | NF | NF | NF | 8.43E−02 | 7.30E−02 | 6.13E−02 |
| succinic acid | 4.00E−01 | 5.44E−01 | 4.44E−01 | 5.62E−02 | 5.81E−02 | 5.82E−02 | 3.02E−01 | 3.10E−01 | 3.35E−01 |
| Syringic acid | NF | NF | NF | NF | NF | NF | NF | NF | NF |
| tartaric acid | 2.55E+00 | 3.56E+00 | 3.06E+00 | 6.50E−02 | 6.66E−02 | 6.50E−02 | 1.60E−01 | 1.79E−01 | 1.97E−01 |
| vanillic acid | 1.61E+00 | 1.42E+00 | 2.40E+00 | 1.14E+00 | 9.07E−01 | 1.31E+00 | 7.71E−01 | 5.72E−01 | 7.29E−01 |
| Sorbic acid | 3.61E+00 | 3.65E+00 | 3.49E+00 | 1.78E+00 | 2.37E+00 | 2.35E+00 | 3.47E+00 | 6.37E+00 | 6.32E+00 |
| D-Glucuronic acid | 3.37E−01 | 4.73E−01 | 3.68E−01 | OC | OC | OC | 1.05E−01 | 1.02E−01 | 9.36E−02 |
| Quinic acid | 7.83E+00 | 6.42E+00 | 1.08E+01 | 1.83E−02 | 1.14E−02 | 2.30E−02 | 1.03E−02 | 3.80E−03 | 1.04E−02 |
| Gallic acid | 1.65E+00 | 2.54E+00 | 2.18E+00 | NF | NF | NF | 1.15E+00 | 1.30E+00 | 1.31E+00 |
| 2-Furoic acid | 0.00E+00 | 0.00E+00 | 0.00E+00 | 0.00E+00 | 0.00E+00 | 0.00E+00 | 0.00E+00 | ND | 0.00E+00 |
| 3,4- | 0.00E+00 | 0.00E+00 | 0.00E+00 | 0.00E+00 | 0.00E+00 | 0.00E+00 | 0.00E+00 | ND | 0.00E+00 |
| dihydroxybenzoic | | | | | | | | | |
| acid | | | | | | | | | |
| 2-Isopropylmalic | 0.00E+00 | 0.00E+00 | 0.00E+00 | 0.00E+00 | 0.00E+00 | 0.00E+00 | 0.00E+00 | ND | 0.00E+00 |
| acid | | | | | | | | | |
| Adipic acid | 4.10E−02 | 9.07E−02 | 5.20E−02 | 4.33E−02 | 5.85E−02 | 5.97E−02 | 3.66E−02 | 5.08E−02 | 4.87E−02 |
| Trans-Ferulic acid | 2.58E−02 | 6.33E−02 | 1.07E−01 | 1.96E−02 | 2.05E−02 | 1.99E−02 | 2.02E−02 | 2.44E−02 | 2.10E−02 |
| Sinapinic acid | 7.46E−02 | 8.45E−02 | 7.40E−02 | NF | NF | NF | NF | NF | NF |
| Ellagic acid | 1.28E+00 | 1.71E+00 | 1.60E+00 | 3.24E−01 | 4.05E−01 | 3.76E−01 | 2.58E−01 | 3.31E−01 | 2.73E−01 |
| Cinnamic acid | NF | NF | NF | NF | NF | NF | NF | NF | NF |
| Coumaric acid | 2.85E−02 | 1.64E−02 | 3.20E−02 | 1.86E−02 | OC | 1.34E−02 | 1.21E−01 | 5.39E−02 | 9.56E−02 |
| Kynurenic acid | 6.25E−03 | 5.76E−03 | 5.76E−03 | 5.17E−03 | 4.99E−03 | 4.96E−03 | 4.62E−03 | 5.04E−03 | 4.83E−03 |
| fructose | 3.17E+00 | 3.00E+00 | 3.21E+00 | 3.77E+00 | 4.00E+00 | 3.72E+00 | 2.17E+00 | 2.32E+00 | 2.20E+00 |
| glucosamine | NF | NF | NF | NF | NF | NF | NF | ND | NF |
| glucose | 7.70E−01 | 7.72E−01 | 6.96E−01 | NF | NF | NF | 1.18E+00 | 1.25E+00 | 1.05E+00 |
| Mannose | ND | ND | ND | ND | ND | ND | ND | ND | ND |
| Ribose | 1.83E−01 | 1.52E−01 | 1.67E−01 | NF | NF | NF | NF | NF | NF |
| Arabitol | 5.70E−02 | 5.34E−02 | 5.32E−02 | NF | NF | NF | NF | NF | NF |
| Rhamnose | 8.35E−02 | 8.39E−02 | 9.32E−02 | NF | NF | NF | NF | NF | NF |
| Xylose | 4.50E−01 | 4.53E−01 | 5.27E−01 | NF | NF | NF | NF | NF | NF |
| Fucose | OC | OC | OC | NF | NF | NF | NF | NF | NF |
| Mannitol | 1.94E−01 | 1.94E−01 | 2.08E−01 | 1.27E−01 | 1.20E−01 | 1.24E−01 | 1.51E−01 | 1.59E−01 | 1.60E−01 |
| Inositol | 7.06E−01 | 5.53E−01 | 6.15E−01 | 1.24E−01 | 1.84E−01 | 1.73E−01 | 2.04E−01 | 2.65E−01 | 2.98E−01 |
| sorbitol | 1.06E−01 | 1.09E−01 | 1.26E−01 | 3.57E−02 | 4.00E−02 | 4.36E−02 | 6.23E−02 | 7.27E−02 | 7.17E−02 |
| choline | 2.07E−02 | 1.93E−02 | 1.96E−02 | OC | OC | OC | 2.20E−03 | ND | 6.77E−03 |
| Pantothenic acid | OC | OC | OC | OC | OC | OC | OC | OC | OC |
| pyridoxine | OC | OC | OC | OC | OC | OC | OC | ND | 1.74E−03 |
| Acetovanillone | OC | OC | OC | OC | OC | OC | 4.50E−03 | OC | OC |
| Carnitine | 9.88E−04 | 1.30E−03 | 1.06E−03 | 1.79E−04 | 2.65E−04 | 2.30E−04 | 1.75E−03 | 9.23E−04 | 8.56E−04 |
| Syringaldehyde | 4.39E−02 | 2.83E−02 | 7.50E−02 | OC | OC | OC | OC | OC | OC |
| Vanillin | 5.66E−02 | 4.61E−02 | 1.04E−01 | 2.28E−02 | 9.61E−03 | 2.73E−02 | 3.70E+00 | 2.87E+00 | 3.38E+00 |
| Adenine | OC | OC | OC | OC | OC | OC | OC | OC | OC |
| Guanine | OC | OC | OC | OC | OC | OC | NF | NF | NF |
| Catechin | 7.27E−02 | 9.13E−02 | 1.41E−01 | 5.46E−02 | 5.49E−02 | 5.48E−02 | 5.46E−02 | 5.50E−02 | 5.48E−02 |
| Methyl gallate | 1.09E−01 | 9.96E−02 | 1.37E−01 | 6.17E−02 | 6.21E−02 | 6.20E−02 | 6.19E−02 | 6.25E−02 | 6.23E−02 |
| Epicatechin | 1.14E−01 | 1.20E−01 | 1.09E−01 | 7.01E−02 | 7.07E−02 | 7.03E−02 | 7.02E−02 | 7.04E−02 | 7.04E−02 |
| Rutin | NF | NF | NF | NF | NF | NF | NF | NF | NF |
| Resveratrol | NF | NF | NF | NF | NF | NF | NF | NF | NF |
| Propyl gallate | 1.68E−01 | 1.76E−01 | 2.05E−01 | 4.70E−02 | 4.83E−02 | 4.82E−02 | 4.78E−02 | 4.81E−02 | 4.84E−02 |
| Quercetin | 4.84E−01 | 5.31E−01 | 5.20E−01 | 1.59E−01 | 1.60E−01 | 1.60E−01 | 1.57E−01 | 1.59E−01 | 1.58E−01 |
| Hesperetin | NF | NF | NF | NF | NF | NF | NF | NF | NF |
| Epicatechin gallate | NF | NF | NF | NF | NF | NF | NF | NF | NF |
| Polydatin | NF | NF | NF | NF | NF | NF | NF | NF | NF |

ND = not determined
NF = not found
OC = outside of standard curve

### Example 2—Exemplary Moscato Replica

A Moscato replica was prepared from individual components. The ingredients included the VOCs listed in TABLE 12A and the non-volatile compounds and ethanol (e.g., 75.5% ethanol) as listed in TABLE 12B. Additional non-volatile formulations are listed in TABLE 13.

### Moscato Base Preparation:

1) A 1 L beaker was filled to about 700 mL with room temperature tap water. Tartaric, malic, succinic, and citric acids were added and dissolved completely with stirring. The mixture was transferred to a 1 L graduated cylinder, which was then filled to 1 L with tap water. The solution was then deposited into a 10 L carboy.

2) The 1 L beaker was filled to about 700 mL with tap water, and sorbitol, inositol, mannose, and mannitol were added and allowed to dissolve completely with stirring. The solution was transferred to the 1 L graduated cylinder, brought to 1 L with tap water, and deposited into the 10 L carboy.

3) The 1 L beaker was filled to about 400 mL with tap water. Glycerol was measured via a weigh boat; glycerol residue was washed from the weigh boat into the beaker using 100 mL 5% acetic acid. The lactic acid, 5′R, and MSG solutions were added to the beaker, followed by the amino acids. (Solutions of 1 g/50 mL were prepared ahead of time for those compounds requiring less than 10 mg, for convenience.) Water was added to the beaker to bring the volume to about 900 mL to aid in dissolution. Once the solution was homogeneous, it was transferred to the 1 L graduated cylinder, brought to 1 L with tap water, and deposited into the 10 L carboy.

4) Half of the glucose was weighed and dissolved in about 700 mL water in the 1 L beaker. Once it was dissolved, it was transferred to the graduated cylinder, brought to 1 L with tap water, and added to the carboy. This step was repeated with the other half of the glucose.

5) One third of the fructose was weighed out and dissolved in about 700 mL water in the 1 L beaker. Once the fructose was dissolved completely, it was transferred to the graduated cylinder, brought to 1 L with tap water, and transferred to the carboy. This step was repeated twice. In the first repetition, the Carotene color was added, and in the second repetition, the Caramel color was added.

6) The 1 L beaker was filled with about 800 mL water. The KOH was quickly weighed out and added to the 1 L beaker (KOH reacts with air if left out longer than a minute or two). The KOH was completely dissolved, and the solution was transferred to the graduated cylinder, brought to 1 L with tap water, and added to the carboy. The overall solution was mixed well.

7) The ethanol and then the VOCs were added to the graduated cylinder, according to the amounts shown in TABLE 12A. The cylinder was filled to 1 L with tap water and the solution was added to the carboy. After thorough mixing, the solution was refrigerated for several hours.

Alternatively, amounts of non-volatile compounds and ethanol as in TABLE 12B can be used, following the same procedure Carbonation:

1) 1 L of the Moscato base preparation was transferred from the carboy to a separate container and stored for later.

2) The remaining 9 L of Moscato base was transferred to a 2.5 gal Cornelius Keg (also referred to as a “kegerator;” obtained from AEB Kegs, Italy).

3) The kegerator was sealed with a carbonating stone placed inside. A CO₂ line was attached to the central valve on the lid of the kegerator (not to the valves to labelled ‘IN’ or ‘OUT’).

4) The gas (beverage grade CO₂) was set to 45-50 psi.

5) Once the gas line was attached, carbonation was allowed to proceed overnight or for at least 8 hours in a refrigerator (at about 3-5° C.).

### Bottling:

1) A dispensing apparatus was assembled. The apparatus consisted of a rubber stopper fit to the bottles, pierced by a dispensing tube of a length to extend almost to the bottom of the bottles when the stopper was firmly inserted. The dispensing apparatus also had a valved line connected to a CO₂ supply, and another valved line connected to the kegerator. The gas line had an adjustable pressure release valve and a pressure gauge rated to at least 60 psi.

2) The dispensing tube was inserted into a clean 750 mL bottle, forming a tight seal with the stopper.

3) After ensuring that the line connecting to the keg was closed, it was attached to the kegerator's ‘OUT’ valve.

4) The gas line was opened and the release valve was adjusted to pressurize the bottle to about 40 psi. The gas line was then closed.

5) The kegerator line was opened to begin filling the bottle. Gas escaped as the Moscato entered the bottle. The release valve was adjusted to maintain a pressure of about 37 psi while filling.

6) The kegerator line was closed about 2-3 inches below the bottom of the rubber stopper.

7) Using the pressure release valve, the bottle was slowly depressurized, as bubbles will rapidly leave the solution and flood the release valve if the pressure is relieved too quickly.

8) The rubber stopper was removed and 30 uL surfactant was added to the bottle.

9) The bottle was corked and inverted to mix in the surfactant.

10) The Moscato was refrigerated until needed.

The Moscato generated by the above method was an ode to those found in the northwestern Italian appellation of Moscato d'Asti. Like its Italian counterparts, the pale yellow-colored wine had a bit of froth upon pour, displaying notes of lychee, banana, peach, and flowers. The wine's gentle mousse on the palate opened up with sweetness but with bright acidity to balance it out, and with flavors that last. The alcohol was relatively low, matching the development method of Moscato d'Asti—arrested fermentation meant that sugar remained in the Moscato replica, and carbon dioxide derived from fermentation was captured in the bottles.

It is noted that the above process, and similar processes using variations of the VOC and non-volatile ingredient lists, can be scaled up for commercial production of a Moscato-like alcoholic beverage. Such scaled up processes (e.g., to generate 1000 L or more) can utilize tanks or vats for carbonation.

TABLE 12A
VOCs in Moscato formulation (mg/L)

| Compound | Amount | Compound | Amount |
|---|---|---|---|
| ethyl laurate | 0.06-0.12 | hexanol | 0.38-0.71 |
| ethyl decanoate | 0.29-0.54 | propanol | 0.23-0.42 |
| nerol | 0.12-0.23 | gamma-terpinene | 0.06-0.11 |
| citronellol | 0.07-0.12 | (−)-beta-Pinene | 0.06-0.11 |
| ethyl lactate | 0.59-1.09 | delta-decalactone | 0.007-0.013 |
| ethyl octanoate | 0.79-1.47 | 4-carvomenthenol | 0.04-0.07 |
| ethyl acetate | 0.63-1.17 | alpha-terpineol | 0.09-0.17 |
| isoamyl acetate | 10-35 | benzaldehyde | 0.017-0.031 |
| geraniol | 0.12-0.23 | benzyl alcohol | 0.014-0.026 |
| ethyl hexanoate | 1.1-2.0 | decanoic acid | 1.6-2.9 |
| linalool | 1.3-2.4 | dimethyl succinate | 0.028-0.053 |
| linalyl acetate | 0.63-1.16 | ethyl isobutyrate | 0.29-0.53 |
| linalyl butyrate | 1.3-2.5 | ethyl valerate | 0.12-0.23 |
| damascenone | 0.007-0.013 | isobutyl alcohol | 10.2-19.0 |
| ethyl butanoate | 10-19 | 2-methylbutyl acetate | 0.012-0.023 |
| octanoic acid | 2.7-5.0 | 2-nonanone | 0.034-0.064 |
| butyric acid | 0.023-0.042 | 3-methyl-1-pentanol | 0.016-0.030 |
| hexanoic acid | 1.3-2.5 | 4-vinylphenol | 0.100-0.185 |
| 2-phenethyl acetate | 0.39-0.72 | acetovanillone | 0.0004-0.0008 |
| isoamyl alcohol | 16-30 | isobutyric acid | 0.20-0.36 |
| 2-phenylethanol | 7.9-14.7 | methyl decanoate | 0.0012-0.0023 |
| limonene | 0.6-1.1 | methyl hexanoate | 0.41-0.77 |
| hexyl acetate | 0.35-0.65 | phenethyl butyrate | 0.014-0.026 |
| 2-methyl-1-butanol | 11.2-20.8 | butanol | 0.27-0.51 |
| gamma-decalactone | 1.3-2.5 | phenethyl propionate | 0.062-0.116 |
| 3-mercaptohexyl acetate | 0.00041-0.00077 | (−)-cis-rose oxide | 0.022-0.041 |
| ethyl isovalerate | 1.8-3.4 | | |

TABLE 12B
non-volatiles and ethanol in Moscato formulation

| Component | Range | Component | Range |
|---|---|---|---|
| tartaric acid (g) | 2.36E+01-4.38E+01 | alanine (mg) | 1.32E+01-2.44E+01 |
| malic acid (g) | 1.26E+01-2.34E+01 | arginine (mg) | 2.60E+01-4.84E+01 |
| citric acid (g) | 9.80E−01-1.82E+00 | asparagine (mg) | 5.04E+00-9.36E+00 |
| succinic acid (g) | 1.18E+00-2.18E+00 | b-alanine (mg) | 1.32E+01-2.44E+01 |
| sorbitol (g) | 2.59E−01-4.81E−01 | GABA (mg) | 3.21E+01-5.97E+01 |
| inositol (g) | 6.04E+00-1.12E+01 | glutamic acid (mg) | 8.33E+01-1.55E+02 |
| mannose (g) | 4.17E+00-7.74E+00 | glutamine (mg) | 3.15E+00-5.85E+00 |
| mannitol (g) | 5.97E−01-1.11E+00 | glycine (mg) | 7.56E+00-1.40E+01 |
| lactic acid (μL; 88% stock) | 6.23E+02-1.16E+03 | histidine (mg) | 1.78E+01-3.30E+01 |
| acetic acid (mL; 5% stock) | 7.00E+01-1.30E+02 | isoleucine (mg) | 2.48E+01-4.60E+01 |
| glycerol (g) | 1.13E+01-2.11E+01 | leucine (mg) | 2.75E+01-5.11E+01 |
| glucose (g) | 3.48E+02-6.45E+02 | lysine (mg) | 6.81E+01-1.26E+02 |
| fructose (g) | 6.20E+02-1.15E+03 | methionine (mg) | 5.60E−01-1.04E+00 |
| monosodium glutamate | 2.80E+00-5.20E+00 | phenylalanine (mg) | 1.76E+01-3.28E+01 |
| (mL; stock 1.25 g/50 mL) | | proline (g) | 1.11E+00-2.07E+00 |
| 5′ ribonucleotides | 4.20E+00-7.80E+00 | threonine (mg) | 2.84E+01-5.27E+01 |
| (mL; stock 1 mg/mL) | | tryptophan (mg) | 1.11E+01-2.05E+01 |
| KOH (g) | 7.84E+00-1.46E+01 | tyrosine (mg) | 6.17E+00-1.15E+02 |
| carotene color (μL) | 1.05E+02-1.95E+02 | valine (g) | 2.69E+00-4.99E+00 |
| caramel color (μL) | 7.00E+01-1.30E+02 | | |
| surfactant (μL) | 2.52E+02-4.68E+02 | | |
| ethanol (mL) | 4.43E+02-8.22+02 | | |

TABLE 13
Non-volatile form ulations for Moscato

| *all values in mg/L, unless noted | Purity | Range | Subrange A | Subrange B | Subrange C | Subrange D |
|---|---|---|---|---|---|---|
| tartaric acid | 100% | 1000-4500 | 1000-2500 | 2500-3500 | 3500-4500 | 2300-4500 |
| malic acid | 99% | 650-3000 | 650-800 | 1500-2500 | 2500-3000 | 1200-2400 |
| citric acid | 100% | 0-750 | 0-200 | 200-600 | 600-750 | 90-180 |
| succinic acid | 99% | 0-1800 | 0-500 | 500-1500 | 1500-1800 | 110-225 |
| sorbitol | 97% | 0-250 | 0-50 | 50-150 | 150-250 | 25-50 |
| inositol | 100% | 0-5000 | 0-1000 | 1000-4000 | 4000-5000 | 0-1200 |
| Mannose | 100% | 0-1050 | 0-400 | 400-800 | 800-1050 | 0-775 |
| Mannitol | 97-102% | 0-410 | 0-50 | 50-100 | 100-410 | 1-125 |
| lactic acid | 88% | 0-1600 | 0-100 | 100-500 | 500-1600 | 50-110 |
| acetic acid (% v/v) | 5% | 0.5-1.5 | 0.5-0.7 | 0.7-1.2 | 1.2-1.5 | 7000-13000 |
| | | | | | | (mg/L) |
| glycerol (vegetable glycerin) | 99.70% | 1100-5000 | 1600-1800 | 1800-4000 | 4000-5000 | 1100-2100 |
| glucose (from corn) | | 5000-95000 | 5000-8000 | 8000-35000 | 35000-90000 | 34000-65000 |
| fructose (from corn) | 100% | 19000-120000 | 19000-40000 | 40000-80000 | 80000-120000 | 60000-115000 |
| disodium 5′-guanylate and 5′-inosinate | | 0.4-1.0 | 0.5-0.7 | 0.7-0.9 | 0.8-1.0 | 0.4-0.8 |
| monosodium glutamate | | 5-15 | 5-7 | 7-12 | 12-15 | 7-13 |
| KOH (target pH 3.15) | 90.00% | 300-1750 | 300-400 | 400-800 | 800-1750 | 750-1500 |
| ethanol (% v/v) (from grains) | 75.5 | 5-10 | 5-7 | 7-9 | 8-10 | 4-8 |
| food coloring Carotene (% v/v) | ? | 0.001-0.005 | 0.001-0.002 | 0.002-0.003 | 0.003-0.004 | 0.001-0.002 |
| food coloring Caramel (% v/v) | ? | 0.0001-0.015 | 0.0001-0.0005 | 0.0005-0.002 | 0.002-0.015 | 0.0007-0.0013 |
| surfactant (% v/v) (from Quillaja | ? | 0-0.005 | 0-0.002 | 0.002-0.003 | 0.003-0.005 | 0 |
| saponaria) | | | | | | |
| gum arabic (pre hydrated, spray dried | ? | 0-150 | 0-10 | 10-75 | 75-150 | 0 |
| powder) | | | | | | |
| pectin (Pectin 1400 pretested) | ? | 0-75 | 0-10 | 10-35 | 35-75 | 0 |
| alanine | 100% | 1-5 | 1.5-1.7 | 1.7-1.9 | 1.8-2.0 | 1-5 |
| arginine | 100% | 2.5-27.5 | 3.5-5.0 | 5.0-20.0 | 5.0-27.5 | 2.5-5 |
| aspartic acid | 100% | 0-5 | 3.0-3.3 | 3.3-3.6 | 3.6-4.0 | 0-5 |
| asparagine | 100% | 0-1.5 | 0.6-0.8 | 0.8-1.3 | 1.3-1.5 | 0-1 |
| b-alanine | 99% | 0-2.5 | 1.5-1.7 | 1.7-1.9 | 1.8-2.0 | 0-2.5 |
| cysteine | 98.2-102% | 0 | NA | NA | NA | 0 |
| GABA | 100% | 0-6 | 0-2 | 2-4 | 4-5 | 3-6 |
| glutamic acid | 99% | 8-30 | 11-15 | 15-22 | 22-28 | 8-16 |
| glutamine | 100% | 0-0.6 | 0.3-0.4 | 0.4-0.5 | 0.5-0.6 | 0-0.6 |
| glycine | 100% | 0-1.5 | 0-0.5 | 0.5-1.0 | 1.0-1.5 | 0-1.5 |
| histidine | 100% | 0-3.5 | 2.5-2.7 | 2.7-2.9 | 2.9-3.0 | 0-3.5 |
| isoleucine | 101% | 0-4.6 | 0-1 | 1-2.5 | 2.5-3.6 | 2.5-4.6 |
| leucine | 95% | 0-5.1 | 0-2.0 | 2.0-3.0 | 3.0-5.0 | 2.7-5.1 |
| lysine | 99% | 6.5-13 | 9.5-10.0 | 10-11.5 | 11.5-12.5 | 6.5-13 |
| methionine | 98.5-101.5% | 0-1.5 | 0.05-0.1 | 0.1-0.8 | 0.8-1.5 | 0-0.1 |
| phenylalanine | 98.5-101.5% | 1.5-5.0 | 2.5-3.0 | 3.0-4.0 | 4.0-5.0 | 1.5-3.3 |
| proline | 98.5-101% | 0-210 | 150-175 | 175-190 | 190-200 | 0-210 |
| serine | 98.5-101% | 0-3.5 | 0-1.5 | 1.5-2.7 | 2.7-3.5 | 0 |
| threonine | 99-100.5% | 0-5.3 | 0-2.0 | 2.0-3.5 | 3.5-4.5 | 2.8-5.3 |
| tryptophan | 98.5-101.5% | 1.5-1.9 | 1.5-1.6 | 1.6-1.7 | 1.7-1.9 | 0-2 |
| tyrosine | 98.5-101.5% | 5.5-12 | 5.5-6.5 | 6.5-8.0 | 8.0-9.0 | 6-12 |
| valine | 98.5-101.5% | 0-5000 | 110-150 | 150-350 | 350-400 | 0-500 |

### Example 3—Exemplary Whiskey Replicas

A 10 L batch of whiskey replica was prepared from individual components. The ingredients included:

| | | |
|---|---|---|
| 458 mg tartaric acid | 53.5 mg ribose | 481 μL malic acid |
| 104 mg gallic acid | 19.8 mg fructose | (1 g/50 mL H₂O) |
| 10.6 mg vanillic acid | 9.52 mg mannitol | 228 μL succinic acid |
| 99.8 mg syringic acid | 231 mg glucose | (1 g/50 mL H₂O) |
| 54.2 mg vanillin | 18.9 mg inositol | 42.4 μL lactic acid |
| 51.9 mg syringaldehyde | 1900 mL oak extract | [88% (stock)] |
| | | 4240 mL 75.5% EtOH |
| | | 500 mL Tannin solution |
| | | ~200 mL VOC solution |
| | | (TABLE 14) |

To prepare oak extract, America Oak chips were ground in a coffee grinder, and 35 g of ground chips was placed into each of two 1 L Erlenmeyer flasks. To each flask, 1 L 40% EtOH solution (530 mL ethanol, 470 mL tap water) was added. The flasks were covered with PARAFILM®, swirled vigorously, and stored in the dark for 24 hours. The extracted oak was vacuum filtered; the filtrate was saved and the remaining wood chips were discarded. The filtrate was divided into 40 Falcon tubes (˜47 mL each), which were centrifuged for 5 minutes at 5000 rpm.

To prepare Tannin solution, 0.8 g Tannin tannin powder was added to 50 mL water in a Falcon tube, and mixed by vortexing. This was repeated nine times to yield 10 tubes of Tannin solution. Each tube was centrifuged at 5000 rpm for 5 minutes and decanted twice, saving the liquid portion both times.

To prepare the whiskey replica, about 500 mL water was placed in a beaker with a stir bar on a stir plate. All dry chemicals were weighed out and added to the water in the beaker. 240 mL ethanol was added to the beaker, followed by the malic acid, succinic acid, and lactic acid. Once the mixture was uniform, it was poured into a 2 L graduated cylinder (without the stir bar). All (500 mL) of the prepared Tannin solution was added to the cylinder, which was then filled to 2 L with water. The contents of cylinder were poured into a 10 L carboy. Oak extract from all 40 tubes was added into the 2 L cylinder, and water was added to 2 L. The diluted oak extract was added to the carboy. The remaining ethanol (4 L) was then added to the carboy using the 2 L cylinder. Finally, the VOCs and remaining ethanol (500 mL) were added to the cylinder, which was topped up to 2 L with water and added to the carboy. The whiskey was carefully but vigorously shaken to mix the contents.

The whiskey replica had a final ABV of 43%, and was identical to whiskey crafted by traditional methods in terms of color; like many whiskeys, it had an amber color with characteristic “tears” on the sides of the glass upon swirling, and the mouthfeel (viscosity) was comparable to that of traditional whiskey. Much like traditionally-made whiskey, the whiskey replica had peaty, grain-like, fruity, floral, and woody aromas. In particular, the whiskey replica had a grain-like character on the nose, dominated with sweet wood-like aromas including vanilla and baking spices, along with aromas reminiscent of ripe apple, caramel, and very light hints of smoke. The taste characteristics of the whiskey replica, including sweetness, alcoholic perception, flavors, and finish or length also were analogous to those of traditionally-made whiskeys. In particular, on the palate, the whiskey replica had a creamy body with some spicy heat and an echo of the flavors found on the nose.

It is noted that the above process, and similar processes using variations of the VOC and non-volatile ingredient lists, can be scaled up for commercial production of a whiskey-like alcoholic beverage. Such scaled up processes (e.g., to generate 1000 L or more) can utilize tanks or vats.

It also is noted that in some cases, a portion of the water that is included in a whiskey replica can be replaced with a neutral spirit such as, without limitation, corn whiskey. When such a substitution is made, the neutral spirit is added such that the ethanol provided by the neutral spirit is not less than 5%, on a proof gallon basis, of the total amount of ethanol in the whiskey replica. For example, 10 L of a whiskey replica containing 3.1 L ethanol (192 proof), 0.38 L of corn whiskey (135 proof) and 1.8 L of oak extract (151 proof) contains 6.4% alcohol, on a proof gallon basis, from the corn whiskey, which is 2.6% ABV.

As an example, a 1000 L batch of whiskey replica was prepared from individual components, including:

| | Concentration in final product |
|---|---|
| Component | (mg/L, unless denoted otherwise) |
| Ethanol (192 proof) | 310 L (per 1000 L) |
| Corn whiskey | 38 L (per 1000 L) |
| Filtered water | 506 L (per 1000 L; 420 L + |
| | 86 L from 5x wood-tannin) |
| American Oak Wood Chips | 7000 |
| Tannin Powder | 0.80 |
| Ethanol (151 proof) | 114 L (per 1000 L; |
| | from 5X wood-tannin) |
| Malic acid | 4.34 |
| Tartaric acid | 67.15 |
| Lactic acid | 11.8 |
| Citric acid | 17 |
| D-Glucuronic acid | 11.56 |
| Succinic acid | 2.85 |
| Cinnamic acid | 2.0 |
| Fructose | 23 |
| Glucose | 45 |
| Glycerol | 8000 |
| Gum Arabic | 1.0 |

First, 1000 L of a 5× wood-tannin solution was prepared by placing 35000 g of American Oak Wood chips and 4000 g of Tannin Powder in a filter bag, and submerging in a mixture of 570 L ethanol (151 proof) and 430 L filtered water. The mixture was recirculated for 18-24 hours, and then filtered through a 1 micron filter pad. Malic acid (22 g), tartaric acid (340 g), lactic acid (59 g), citric acid (85 g), D-glucuronic acid (58 g), succinic acid (14 g), and cinnamic acid (10 g) were added to the mixture, which was then recirculated until all ingredients were dissolved (about 5 minutes).

Separately, 310 L of ethanol (192 proof), 38 L of corn whiskey, and 420 L of filtered water were added to a mixing tank and recirculated for 10-15 minutes. Fructose (23 g), glucose (45 kg), glycerol (8000 g), and gum arabic (1.0 g) were added to the mixture, which was then recirculated until all ingredients were dissolved (about 15-20 minutes). The VOCs (3-5 L total) and 200 L of the wood-tannin solution were added to the mixture and recirculated for 30 minutes. The mixture was pad filtered (0.5 micron filter) and held until bottling.

TABLE 14
VOCs in whiskey formulations (mg/L)

| All values in mg/L | Formulation 1 | Formulation 2 | Formulation 3 | Formulation 4 | Formulation 5 |
|---|---|---|---|---|---|
| 1,1-diethoxyethane | 0 | 2.1E+00-3.9E+00 | 0.0E+00-6.6E+00 | 0 | 2.1E+00-3.9E+00 |
| 1-decanol | 1.2E−05-2.2E−05 | 6.8E−03-1.3E−02 | 6.8E−03-3.0E−02 | 2.2E−03-4.0E−03 | 6.8E−03-1.3E−02 |
| 1-octanol | 0 | 0 | 4.4E−02-8.2E−02 | 0 | 0 |
| 1-octen-3-ol | 2.3E−03-4.4E−03 | 6.9E−03-1.3E−02 | 6.9E−03-2.6E−02 | 4.6E−03-8.6E−03 | 6.9E−03-1.3E−02 |
| 2,3-pentadione | 0 | 6.9E−04-1.3E−03 | 0.0E+00-2.6E−03 | 3.9E−04-7.2E−04 | 6.9E−04-1.3E−03 |
| 2-heptanone | 0 | 0 | 0.0E+00-7.7E−02 | 0 | 2.2E−02-4.2E−02 |
| 2-methyl-1-butanol | 3.8E+02-7.1E+02 | 2.5E+00-4.7E+00 | 2.5E+00-1.0E+01 | 2.8E+00-5.2E+00 | 2.5E+00-4.7E+00 |
| 2-methylbutyl acetate | 5.6E−01-1.1E+00 | 0 | 3.2E−02-5.9E−02 | 0 | 0 |
| 2-methylbutyraldehyde | 2.8E−04-5.2E−04 | 2.5E−02-4.6E−02 | 0.0E+00-3.0E−01 | 0 | 0 |
| 2-nonanone | 8.5E−02-1.6E−01 | 0 | 0.0E+00-1.4E−02 | 4.0E−03-7.5E−03 | 0 |
| 2-phenylethanol | 1.8E+01-3.3E+01 | 2.1E+00-3.9E+00 | 2.1E+00-7.8E+00 | 1.6E+00-3.0E+00 | 2.1E+00-3.9E+00 |
| 2-phenylethylacetate | 4.0E−01-7.4E−01 | 5.8E−02-1.1E−01 | 5.8E−02-2.3E−01 | 6.5E−02-1.2E−01 | 5.8E−02-1.1E−01 |
| 2-undecanone | 0 | 0 | 1.4E−03-2.6E−03 | 0 | 0 |
| 3-carene | 0 | 6.7E−04-1.2E−03 | 6.7E−04-1.2E−01 | 0.0E+00-5.0E−01 | 6.7E−02-1.2E−01 |
| 4-carvomenthenol | 0 | 0 | 0.0E+00-1.3E−03 | 6.6E−04-1.4E−03 | 0 |
| 4-Ethyl Guaiacol | 1.8E−02-3.3E−02 | 0 | 0.0E+00-3.9E−01 | 0 | 0 |
| 4-Ethyl Phenol | 2.8E+00-5.3E+00 | 0 | 0.0E+00-1.1E−01 | 1.5E−03-2.9E−03 | 0 |
| acetaldehyde | 0 | 2.1E−01-3.9E−01 | 2.1E−01-3.9E−01 | 6.4E−02-1.2E−01 | 2.1E−01-3.9E−01 |
| acetoin | 0 | 2.6E−02-4.7E−02 | 0.0E+00-6.2E−02 | 0 | 2.6E−02-4.7E−02 |
| acetophenone | 0 | 0 | 0.0E+00-1.7E−02 | 0 | 3.7E−03-6.9E−03 |
| amyl alcohol | 0 | 1.0E−01-1.9E−01 | 1.0E−01-3.8E−01 | 2.9E−02-5.5E−02 | 1.0E−01-1.9E−01 |
| amyl butyrate | 0 | 0 | 0.0E+00-1.0E−01 | 1.2E−06-2.2E−06 | 0 |
| a-terpineol | 8.7E−04-1.6E−03 | 4.2E−02-7.7E−02 | 2.1E−02-1.3E−01 | 7.6E−03-1.4E−02 | 4.2E−02-7.7E−02 |
| benzaldehyde | 6.1E−02-1.4E−01 | 1.0E−03-1.9E−03 | 1.0E−03-1.8E−01 | 6.2E−04-1.1E−03 | 1.0E−03-1.9E−03 |
| benzyl acetate | 0 | 0 | 1.7E−03-3.1E−03 | 0 | 0 |
| beta-ionone | 8.3E−04-1.8E−03 | 6.8E−05-1.3E−04 | 6.8E−05-1.9E−02 | 8.9E−05-1.6E−04 | 6.8E−05-1.3E−04 |
| beta-pinene | 3.8E−02-8.5E−02 | 1.4E−05-2.6E−05 | 0.0E+00-5.1E−05 | 1.8E−04-3.4E−04 | 1.4E−05-2.6E−05 |
| butanol | 2.8E+00-5.2E+00 | 2.9E+00-5.3E+00 | 2.9E+00-1.1E+01 | 2.0E−01-3.7E−01 | 2.9E+00-5.3E+00 |
| butyl acetate | 1.4E−03-2.5E−03 | 3.5E−02-6.6E−02 | 3.5E−02-1.3E+00 | 2.2E−02-4.1E−02 | 3.5E−02-6.6E−02 |
| butyl formate | 5.3E−02-1.1E−01 | 0 | 0.0E+00-4.7E−01 | 2.6E−01-4.8E−01 | 0 |
| Butyraldehyde | | | 0.0E+00-2.6E−02 | | |
| butyric acid | 1.7E+00-3.7E+00 | 0 | 0.0E+00-2.6E−01 | 1.6E−03-3.0E−03 | 0 |
| carvone | 0 | 0 | 8.1E−03-1.5E−02 | 0 | 0 |
| Cinnamaldehyde | 0 | 1.4E−05-2.6E−05 | 1.4E−05-2.6E−02 | 6.4E−05-1.2E−04 | 1.4E−05-2.6E−05 |
| citronellol | 0 | 0 | 0.0E+00-1.3E−01 | 0 | 0 |
| damascenone | 5.4E−02-1.0E−01 | 0 | 0 | 0 | 0 |
| decanoic acid | 5.6E−02-1.2E−01 | 0 | 0 | 0 | 0 |
| delta-decalactone | 1.7E−03-3.8E−03 | 1.4E+00-2.6E+00 | 6.9E−01-2.6E+00 | 0 | 1.4E+00-2.6E+00 |
| diethyl malate | 0 | 1.6E+00-3.1E+00 | 0.0E+00-1.5E+00 | 0 | 8.0E−01-1.5E+00 |
| diethyl succinate | 1.2E+00-2.7E+00 | 6.7E−02-1.3E−01 | 5.7E−02-1.3E−01 | 5.1E−02-9.5E−02 | 6.7E−02-1.3E−01 |
| dimethylsulfide | 2.9E−02-6.6E−02 | 0 | 0 | 0 | 0 |
| ethyl 3-hydroxyhexanoate | 0 | 5.6E−03-1.0E−02 | 0.0E+00-1.0E−02 | 0 | 5.6E−03-1.0E−02 |
| ethyl acetate | 4.4E+02-1.2E+03 | 5.8E+00-1.1E+01 | 5.8E+00-5.0E+01 | 2.4E+01-4.5E+01 | 5.8E+00-1.1E+01 |
| ethyl benzoate | 0 | 6.0E−03-1.1E−02 | 0.0E+00-1.5E−02 | 0 | 0 |
| ethyl butanoate | 8.1E−01-1.5E+00 | 5.7E−02-1.1E−01 | 5.7E−02-1.8E−01 | 8.3E−02-1.5E−01 | 5.7E−02-1.1E−01 |
| ethyl cinnamate | 2.4E−03-4.5E−03 | 3.5E−03-6.5E−03 | 3.5E−03-1.2E−02 | 6.9E−05-1.3E−04 | 3.5E−03-6.5E−03 |
| ethyl decanoate | 1.7E+01-3.2E+01 | 1.4E+00-2.5E+00 | 1.4E+00-4.9E+00 | 9.0E−01-1.7E+00 | 1.4E+00-2.5E+00 |
| ethyl heptanoate | 9.4E−05-1.7E−04 | 0 | 0.0E+00-9.9E−03 | 7.5E−04-1.4E−03 | 0 |
| ethyl hexanoate | 2.4E+00-4.5E+00 | 5.6E−01-1.0E+00 | 5.6E−01-1.9E+00 | 1.8E−01-3.4E−01 | 5.6E−01-1.0E+00 |
| ethyl isobutyrate | 8.3E+01-1.5E+02 | 0 | 0.0E+00-2.5E−01 | 1.4E−01-2.7E−01 | 0.0E+00-7.8E−02 |
| ethyl isovalerate | 1.5E+00-3.4E+00 | 5.1E−01-9.5E−01 | 5.1E−01-1.9E+00 | 5.0E−01-9.3E−01 | 5.1E−01-9.5E−01 |
| ethyl lactate | 7.1E−01-1.3E+00 | 1.4E+01-2.5E+01 | 6.9E+00-4.6E+01 | 2.5E−01-4.7E−01 | 1.4E+01-2.5E+01 |
| ethyl laurate | 6.3E+00-1.6E+01 | 7.1E−01-1.3E+00 | 7.1E−01-2.6E+00 | 8.0E+00-1.5E+01 | 7.1E−01-1.3E+00 |
| ethyl levulinate | 0 | 3.2E−02-5.9E−02 | 0.0E+00-1.4E−01 | 0 | 6.3E−02-1.2E−01 |
| ethyl myristate | 2.4E−02-4.5E−02 | 1.3E−01-2.5E−01 | 1.3E−01-3.7E−01 | 8.1E−02-1.5E−01 | 1.3E−01-2.5E−01 |
| ethyl nonanoate | 3.1E−02-6.8E−02 | 0 | 0.0E+00-4.2E−02 | 0 | 0.0E+00-6.3E−03 |
| ethyl octanoate | 9.1E+00-1.7E+01 | 3.5E−01-6.4E−01 | 3.5E−01-1.3E+00 | 7.5E−01-1.4E+00 | 3.5E−01-6.4E−01 |
| ethyl palmitate | 2.2E−01-4.0E−01 | 0 | 0 | 0 | 0 |
| ethyl phenyl acetate | 1.0E−03-1.9E−03 | 1.7E−03-3.2E−03 | 1.4E−03-6.4E−03 | 2.3E−03-4.2E−03 | 1.7E−03-3.2E−03 |
| ethyl propionate | 1.7E−01-3.3E−01 | 5.5E−02-1.0E−01 | 5.1E−02-2.0E−01 | 1.1E−01-2.0E−01 | 5.5E−02-1.0E−01 |
| ethyl trans-2-butenoate | 0 | 0 | 0.0E+00-3.0E−02 | 0 | 1.1E−02-2.0E−02 |
| ethyl undecanoate | 0 | 2.1E−03-3.9E−03 | 0.0E+00-1.9E−01 | 0 | 1.0E−01-1.9E−01 |
| ethyl valerate | 9.8E−04-1.8E−03 | 8.2E−03-1.5E−02 | 4.1E−03-1.5E−02 | 2.1E−03-4.0E−03 | 8.2E−03-1.5E−02 |
| ethyl-2-methylbutyrate | 4.0E−01-7.4E−01 | 3.8E−02-7.1E−02 | 0.0E+00-8.3E−02 | 0 | 3.8E−02-7.0E−02 |
| eugenol | 0 | 1.4E−03-2.6E−03 | 1.4E−03-2.7E−02 | 2.2E−03-4.0E−03 | 1.4E−03-2.6E−03 |
| farnesol | 0 | 1.4E−02-3.0E−02 | 0.0E+00-3.0E−02 | 0 | 0 |
| furfural | 2.4E+00-7.9E+00 | 1.3E+00-2.5E+00 | 1.3E+00-7.3E+00 | 4.3E−01-8.0E−01 | 1.3E+00-2.5E+00 |
| gamma-decalactone | 1.7E+00-3.8E+00 | 3.1E−03-5.7E−03 | 0.0E+00-1.2E−02 | 6.2E−03-1.2E−02 | 3.1E−03-5.7E−03 |
| gamma-nonalactone | 0 | 6.8E−03-1.4E−02 | 0.0E+00-1.4E−02 | 0 | 4.5E−03-8.3E−03 |
| gamma-terpinene | 1.5E−01-3.3E−01 | 0 | 0.0E+00-1.7E−03 | 9.4E−04-1.7E−03 | 0 |
| geraniol | 0 | 2.5E−02-4.7E−02 | 0.0E+00-5.6E+00 | 0 | 5.0E−02-9.3E−02 |
| guaiacol | 1.4E−02-6.9E−02 | 1.4E−03-2.6E−03 | 1.4E−03-1.3E−01 | 0 | 1.4E−03-2.6E−03 |
| Hexanoic acid | | | 0.0E+00-2.6E−01 | | |
| hexanol | 4.8E−01-1.1E+00 | 0 | 5.0E−02-9.2E−02 | 0 | 0 |
| isoamyl acetate | 2.6E+00-4.8E+00 | 0 | 0.0E+00-4.5E−01 | 2.5E−01-4.6E−01 | 0 |
| isoamyl alcohol | 1.4E+01-3.2E+01 | 6.8E−01-1.3E+00 | 6.8E−01-1.3E+02 | 1.3E+00-2.5E+00 | 6.8E−01-1.3E+00 |
| isoamyl hexanoate | 2.0E−04-3.8E−04 | 4.1E−03-7.6E−03 | 3.9E−03-1.5E−02 | 8.3E−03-1.5E−02 | 4.1E−03-7.6E−03 |
| isoamyl isovalerate | 0 | 0 | 1.5E−02-2.8E−02 | 0 | 0 |
| isoamyl octanoate | 5.1E−04-9.4E−04 | 3.0E−04-5.5E−04 | 3.0E−04-8.3E−03 | 3.0E−04-5.5E−04 | 3.0E−04-5.5E−04 |
| isobutanol | 1.8E+02-3.4E+02 | 1.4E+01-2.6E+01 | 1.4E+01-5.8E+01 | 2.2E+01-4.0E+01 | 1.4E+01-2.6E+01 |
| isobutyl acetate | 1.2E−02-2.2E−02 | 3.5E−01-6.4E−01 | 3.3E−02-6.4E−01 | 6.1E−03-1.1E−02 | 3.5E−01-6.4E−01 |
| isobutyl isobutyrate | 0 | 0 | 5.6E−04-1.0E−03 | 0 | 0 |
| isobutyraldehyde | 0 | 3.3E+00-6.2E+00 | 0.0E+00-6.2E+00 | 0 | 6.6E+00-1.2E+01 |
| Isobutyric Acid | 1.5E+00-2.8E+00 | 0 | 0 | 0 | 0 |
| Isovaleraldehyde | 2.7E−02-5.1E−02 | 0 | 1.7E−02-3.0E−01 | 0 | 0 |
| Isovaleric acid | | | 0.0E+00-3.5E+00 | | |
| limonene | 9.8E−06-2.2E−05 | 5.7E−03-1.1E−02 | 5.7E−03-1.5E−02 | 3.0E−03-5.5E−03 | 5.7E−03-1.1E−02 |
| linalool | 3.6E−06-6.7E−06 | 4.3E−06-8.0E−06 | 4.3E−06-1.9E−01 | 0 | 8.6E−04-1.6E−03 |
| linalool oxide | 0 | 7.7E−03-1.4E−02 | 5.6E−03-2.9E−02 | 7.7E−03-1.4E−02 | 7.7E−03-1.4E−02 |
| linalyl acetate | 0 | 2.8E−02-5.2E−02 | 1.4E−02-5.2E−01 | 0 | 2.8E−01-5.2E−01 |
| Maltol | 5.3E−04-3.9E−03 | 5.2E−05-9.6E−05 | 0.0E+00-5.3E+00 | 1.1E−04-2.0E−04 | 5.2E−05-9.6E−05 |
| methional | 0 | 0 | 0.0E+00-2.2E−03 | 0 | 1.2E−03-2.2E−03 |
| methyl decanoate | 3.3E−05-6.1E−05 | 0 | 1.3E−02-2.4E−02 | 0 | 0 |
| methyl hexanoate | 5.0E−02-9.2E−02 | 0 | 1.1E−03-2.1E−03 | 0 | 0 |
| methyl laurate | 7.0E−05-1.3E−04 | 0 | 9.8E−03-1.8E−02 | 0 | 0 |
| Methyl Octanoate | 5.4E−07-1.0E−06 | 6.4E−09-1.2E−08 | 0.0E+00-1.2E−08 | 6.4E−09-1.2E−08 | 6.4E−09-1.2E−08 |
| methyl salicylate | 3.4E−04-6.4E−04 | 2.1E−05-3.8E−05 | 2.1E−05-1.0E−03 | 2.1E−05-3.8E−05 | 2.1E−05-3.8E−05 |
| Myrcene | 5.6E−05-1.0E−04 | 3.1E−06-5.8E−06 | 3.1E−06-2.6E−03 | 1.3E−05-2.4E−05 | 3.1E−06-5.8E−06 |
| Myrtenol | 1.9E−03-3.5E−03 | 0 | 0 | 0 | 0 |
| nonanal | 9.6E−03-2.2E−02 | 0 | 3.9E−03-7.3E−03 | 0 | 0 |
| Nonanoic acid | | | 0.0E+00-1.8E−01 | | |
| octanoic acid | 6.4E+00-1.4E+01 | 0 | 0 | 0 | 0 |
| p-anisaldehyde | 0 | 0 | 0.0E+00-5.2E−02 | 0 | 0 |
| p-cresol | 1.8E−02-4.0E−02 | 2.9E−04-5.5E−04 | 0.0E+00-5.5E−04 | 2.9E−04-5.5E−04 | 2.9E−04-5.5E−04 |
| p-cymene | 1.3E−05-2.5E−05 | 1.2E−06-2.2E−06 | 0.0E+00-3.1E−03 | 1.2E−06-2.2E−06 | 1.2E−06-2.2E−06 |
| Phenethyl Butyrate | 4.5E−06-8.3E−06 | 2.6E−07-4.8E−07 | 0.0E+00-4.8E−07 | 2.6E−07-4.8E−07 | 2.6E−07-4.8E−07 |
| phenethyl formate | 0 | 2.5E−02-4.7E−02 | 0.0E+00-4.7E−02 | 0 | 1.2E−02-2.3E−02 |
| phenethyl octanoate | 3.0E−04-5.7E−04 | 0 | 0 | 0 | 0 |
| propanol | 1.2E+02-2.4E+02 | 0 | 0.0E+00-2.4E+01 | 4.2E+00-7.9E+00 | 0 |
| Propionaldehyde | 0 | 0 | 0.0E+00-1.3E−01 | 0 | 0 |
| Propionic acid | | | 0.0E+00-2.6E−01 | | |
| propyl acetate | 0 | 3.4E−02-6.3E−02 | 0.0E+00-6.6E−02 | 0 | 3.4E−02-6.4E−02 |
| salicylaldehyde | 0 | 2.4E−03-4.5E−03 | 0.0E+00-6.5E−02 | 0 | 1.1E−03-2.1E−03 |
| trans-2-hexen-1-al | 4.8E−04-8.8E−04 | 0 | 0 | 0 | 0 |
| Valeraldehyde | 0 | 0 | 0.0E+00-6.2E−02 | 0 | 0 |
| Valeric acid | | | 0.0E+00-7.8E−02 | | |
| vanillyl ethyl ether | 0 | 1.9E−02-3.5E−02 | 0.0E+00-3.5E−02 | 0 | 1.9E−02-3.5E−02 |
| whiskey lactone | 1.4E+00-2.5E+00 | 9.6E−02-1.8E−01 | 5.0E−02-1.8E−01 | 5.0E−02-9.3E−02 | 9.6E−02-1.8E−01 |

It is noted that while whiskey replicas can include volatile compounds as listed in TABLE 14, the added compounds may react with one another to generate additional compounds, or to change the effective amount of one or more of the added compounds within the whiskey replica formulation.

### Example 4—Generation of Concentrated Whiskey Replicas

Whiskey replica concentrates were made in ˜100 L test batches and held for a minimum of 8 weeks, with periodic sampling at 1, 2, 4, 6, and 8 weeks. Density measurements were taken each week, and three replicate bottles of whiskey replica were produced by adding 43% ABV spirit whiskey prior to filtering through a 0.45 PVDF vacuum filter. Samples were then submitted for analytical testing versus a corresponding non-concentrated whiskey replica, and versus each other, to assess volatile and non-volatile components. Organoleptic comparisons also were conducted. The concentrates were held in HDPE vessels, or in stainless steel at the highest concentration, to ensure that there were no changes in composition due to the storage material.

To generate a 5× whiskey replica concentrate, the following ingredients below were added to 140 L of 43% ABV grain neutral spirits. This was an effective 700 L batch, but due to loss during decanting and filtering, excess was needed.

| Ingredient | Kg added |
|---|---|
| tannins | 0.560 |
| wood | 4.880 |

The ingredients were stirred in and held for 24 hours. The liquid was then decanted and held for 24 hours to allow larger particulates to settle. This liquid was then filtered through a 5 micron absolute polypropylene cartridge filter prior to being dosed to 100 L in an HDPE open top drum that had been pre-measured to 100 L.

The following ingredients, as well as the VOCs for a 500 L (5×100 L) batch of one of Formulation 1-5 (above) were added to the drum and stirred thoroughly.

| Ingredient | Grams added |
|---|---|
| malic acid | 4.500 |
| tartaric acid | 38.000 |
| lactic acid | 10.500 |
| citric acid | 8.500 |
| D-glucuronic acid | 2.500 |
| cinnamic acid | 1.000 |
| succinic acid | 2.500 |
| fructose | 11.500 |
| glucose | 22.500 |
| gum arabic | 0.500 |
| glycerol | 4000.000 |

To generate a 10× whiskey replica concentrate, the following ingredients below were added to 140 L of 43% ABV grain neutral spirits. Again, this was an effective 700 L batch, but due to loss during decanting and filtering, excess was needed.

| Ingredient | Kg added |
|---|---|
| tannins | 1.120 |
| wood | 9.760 |

The ingredients were stirred in and held for 24 hours. The liquid was then decanted and held for 24 hours to allow larger particulates to settle. This liquid was then filtered through a 5 micron absolute polypropylene cartridge filter prior to being dosed to 100 L in an HDPE open top drum that had been pre-measured to 100 L.

The following ingredients, as well as the VOCs for a 1000 L batch (10×100 L) of one of Formulations 1-5 (above) were added to the drum and stirred thoroughly.

| Ingredient | Grams added |
|---|---|
| malic acid | 9.000 |
| tartaric acid | 76.000 |
| lactic acid | 21.000 |
| citric acid | 17.000 |
| D-glucuronic acid | 5.000 |
| cinnamic acid | 2.000 |
| succinic acid | 5.000 |
| fructose | 23.000 |
| glucose | 45.000 |
| gum arabic | 1.000 |
| glycerol | 8000.000 |

To generate a 20× whiskey replica concentrate, the following ingredients below were added to 350 L of 43% ABV grain neutral spirits. Again, this was an effective 700 L batch, but due to loss during decanting and filtering, excess was needed.

| Ingredient | Kg added |
|---|---|
| tannins | 5.60 |
| wood | 48.790 |

The ingredients were stirred in and held for 24 hours. The liquid was then decanted and held for 24 hours to allow larger particulates to settle. This liquid was then filtered through a 5 micron absolute polypropylene cartridge filter prior to being dosed to 100 L in an HDPE open top drum that had been pre-measured to 100 L.

The following ingredients, as well as the VOCs for a 2000 L batch (20×100 L) of one of Formulations 1-5 (above) were added to the drum and stirred thoroughly.

| Ingredient | Grams added |
|---|---|
| malic acid | 18.000 |
| tartaric acid | 152.000 |
| lactic acid | 42.000 |
| citric acid | 34.000 |
| D-glucuronic acid | 10.000 |
| cinnamic acid | 4.000 |
| succinic acid | 10.000 |
| fructose | 46.000 |
| glucose | 90.000 |
| gum arabic | 2.000 |
| glycerol | 16000.00 |

To find the appropriate volume of concentrate (5×, 10×, or 20×) to add to create a finished product, the following formulas were used:

$$( {C}_{concentrate} ) ( {V}_{concentrate} ) = ( {C}_{final product} ) ( {V}_{final product} )$$

$${V}_{concentrate} = \frac{( 1 ) ( {V}_{final product} )}{( {C}_{concentrate} )}$$

### Where:

C_{final product}=concentration of final product=1 (i.e., 1×)

V_{final product}=desired volume of finished product

C_{concentrate}=concentration of the concentrate (5×, 10×, or 20×)

V_{concentrate}=volume of concentrate to add to create finished product

### Example 5—Evaluation of the Moscato of Example 2

A Moscato replica was made as in Example 2 (non-volatiles were from Subrange D in Table 13) and the VOCs and non-volatiles were measured as set forth in Example 1. The measured volatiles are listed in TABLE 15, and the measured non-volatile compounds are listed in TABLE 16.

TABLE 15
VOCs measured in Moscato replica

| Compound (mg/L) | Run 1 | Run 2 |
|---|---|---|
| (1R)-(−)-myrtenal | 0 | ND |
| 1,4-cineole | 0 | ND |
| 1-octanol (nat) | 0 | ND |
| 1-octen-3-ol | 0 | ND |
| 1-propanol | 0 | ND |
| 2,3-hexanedione | 0 | ND |
| 2,3-pentadione | 0 | ND |
| 2,4,6-trimethylphenol (mesitol) | 0 | ND |
| 2-acetyl-1-methylpyrrole | 0 | ND |
| 2-ethyl-3(5 or 6)-dimethylpyrazine | 0 | ND |
| 2-ethyl-3-methylpyrazine | 0 | ND |
| 2-heptanol | 0 | ND |
| 2-heptanone | 0 | ND |
| 2-isobutyl-3-methoxypyrazine | 0 | ND |
| 2-isobutyl-4-methyl-1,3-dioxolane | 0 | ND |
| 2-isopropyl-4-methyl thiazole | 0 | ND |
| 2-methoxy-3-(1-methylpropyl) pyrazine | 0 | ND |
| 2-Methoxy-4-methylphenol (creosol) | 0 | ND |
| 2-methoxy-4-propylphenol | 0 | ND |
| 2-methoxycinnamaldehyde | 0 | ND |
| 2-methyl-1-butanol | 9.5802-17.7918 | ND |
| 2-methylbutyl acetate | 0 | ND |
| 2-methylbutyl isovalerate | 0 | ND |
| 2-methylbutyraldehyde | 0 | ND |
| 2-nonanol | 0.0455-0.0845 | ND |
| 2-nonanone | 0.0462-0.0858 | ND |
| 2-octanone | 0 | ND |
| 2-pentylfuran | 0 | ND |
| 2-undecanone | 0.00385-0.00715 | ND |
| 3-carene | 0 | ND |
| 3-heptyl acetate | 0 | ND |
| 3-mercaptohexyl acetate | 0 | ND |
| 3-methyl-1-pentanol | 0.00973-0.01807 | ND |
| 3-methylthio hexyl acetate (ug/L) | 0 | ND |
| 3-phenylpropanal | 0 | ND |
| 4,5,6,7-tetrahydro-3,6-dimethylbenzofuran | 0 | ND |
| 4-carvomenthenol | 0.04921-0.09139 | ND |
| 4-Ethyl Guaiacol | 0 | ND |
| 4-Ethyl Phenol | 0 | ND |
| 4-mercapto-4-methyl-2-pentanone | 0 | ND |
| 5-ethyl-3-hydroxy-4-methyl-2(5H)-furanone | 0 | ND |
| (maple furanone) | | |
| 5-methyl-2-phenyl-2-hexenal | 0 | ND |
| 6,10-dimethyl-5,9-undecadien-2-one | 0 | ND |
| (geranyl acetone) | | |
| 6-methyl-5-hepten-2-one | 0 | ND |
| acetal (1,1-diethoxyethane) | 0 | ND |
| acetoin | 0 | ND |
| acetophenone | 0 | ND |
| allyl heptanoate | 0 | ND |
| allyl hexanoate | 0 | ND |
| amyl alcohol | 0 | ND |
| amyl butyrate | 0 | ND |
| anisyl acetate | 0 | ND |
| anisyl alcohol | 0 | ND |
| anisyl butyrate | 0 | ND |
| a-pinene | 0 | ND |
| a-terpineol | 0.41013-0.76167 | ND |
| b-caryophellene | 0 | ND |
| benzaldehyde | 0.11207-0.20813 | ND |
| benzyl acetate | 0 | ND |
| benzyl benzoate | 0 | ND |
| benzyl butyrate | 0 | ND |
| benzyl propionate | 0 | ND |
| beta-ionone | 0 | ND |
| beta-pinene | 0.00798-0.01482 | ND |
| butyl acetate | 0 | ND |
| butyl alcohol | 0.32403-0.60177 | 0.30975-0.57525 |
| butyl butyryllactate | 0 | ND |
| butyl formate | 0 | ND |
| butyraldehyde | 0 | ND |
| butyric acid | 0.02975-0.05525 | ND |
| carvacrol | 0 | ND |
| Cinnamaldehyde | 0 | ND |
| cis-3-hexen-1-ol | 0 | ND |
| cis-3-hexenyl acetate | 0 | ND |
| cis-3-hexenyl butyrate | 0 | ND |
| cis-3-hexenyl caproate | 0 | ND |
| cis-3-hexenyl valerate | 0 | ND |
| Cis-5-octen-1-ol | 0 | ND |
| cis-6-nonen-1-ol | 0 | ND |
| citral | 0 | ND |
| citronellol | 0.10311-0.19149 | ND |
| cuminaldehyde | 0 | ND |
| D-camphor | 0 | ND |
| D-carvone | 0 | ND |
| decanal | 0 | ND |
| decanoic acid | 0.10108-0.18772 | ND |
| decanol | 0 | ND |
| delta-decalactone | 0.00385-0.00715 | ND |
| delta-dodecalactone | 0 | ND |
| d-fenchone | 0 | ND |
| diethyl malate | 0.11116-0.20644 | ND |
| diethyl succinate | 0.03178-0.05902 | ND |
| dihydrocoumarin | 0 | ND |
| DL-3-methyl-2-butanol | 0 | ND |
| ethyl (methylthio) acetate | 0 | ND |
| ethyl 2-methylbutyrate | 0.00385-0.00715 | ND |
| ethyl 2-trans-4-cis-decadienoate | 0 | ND |
| ethyl 3-hydroxyhexanoate | 0 | ND |
| ethyl acetate | 0 | ND |
| ethyl benzoate | 0 | ND |
| Ethyl butyrate (ethyl butanoate) | 0.6965-1.2935 | ND |
| ethyl cinnamate | 0 | ND |
| ethyl decanoate | 0.14483-0.26897 | ND |
| ethyl heptanoate | 0 | ND |
| ethyl isobutyrate | 0.44646-0.82914 | ND |
| ethyl lactate | 1.99766-3.70994 | ND |
| ethyl laurate | 0.05663-0.10517 | ND |
| ethyl levulinate | 0 | ND |
| ethyl myristate | 0.03234-0.06006 | ND |
| ethyl nonanoate | 0 | ND |
| ethyl octanoate | 0.30163-0.56017 | ND |
| ethyl phenylacetate | 0 | ND |
| ethyl propionate | 0 | ND |
| ethyl salicylate | 0.00035-0.00065 | ND |
| ethyl trans-2-butenoate | 0 | ND |
| ethyl undecanoate | 0 | ND |
| Ethyl Valerate | 0 | ND |
| ethyl-trans-3-hexenoate | 0 | ND |
| eucalyptol | 0.01596-0.02964 | ND |
| eugenol | 0 | ND |
| farnesol | 0 | ND |
| furfuryl thioacetate | 0 | ND |
| gamma-decalactone | 0 | ND |
| gamma-dodecalactone | 0 | ND |
| gamma-heptalactone | 0 | ND |
| gamma-nonalactone | 0 | ND |
| gamma-octalactone | 0 | ND |
| gamma-terpinene | 0.01428-0.02652 | ND |
| gamma-undecalactone | 0 | ND |
| geraniol | 0.25333-0.47047 | ND |
| geranyl butyrate | 0 | ND |
| guaiacol | 0 | ND |
| heptyl acetate | 0 | ND |
| Hexadecanol | 0 | ND |
| hexanoic acid | 1.6751-3.1109 | ND |
| hexyl 3-methylbutanoate | 0 | ND |
| hexyl acetate | 0.1134-0.2106 | ND |
| Hexyl alcohol (hexanol) | 0.378-0.702 | ND |
| hexyl butyrate | 0 | ND |
| hexyl formate | 0 | ND |
| hexyl isobutyrate | 0 | ND |
| hexyl propionate | 0 | ND |
| indole | 0 | ND |
| isoamyl acetate | 9.443-17.537 | ND |
| isoamyl alcohol | 15.5694-28.9146 | ND |
| isoamyl cinnamate | 0 | ND |
| isoamyl hexanoate | 0 | ND |
| isoamyl isobutyrate | 0 | 0 |
| isoamyl isovalerate | 0 | ND |
| isoamyl octanoate | 0 | ND |
| isoamyl phenylacetate | 0 | ND |
| isobutyl acetate | 0 | ND |
| isobutyl alcohol | 13.41991-24.92269 | ND |
| isobutyl butyrate | 0 | ND |
| isobutyl isobutyrate | 0 | ND |
| isobutyl propionate | 0 | ND |
| isobutyraldehyde | 0.11963-0.22217 | ND |
| Isobutyric Acid | 0.18417-0.34203 | ND |
| isoeugenol | 0 | ND |
| isovaleraldehyde | 0 | ND |
| L-Carvone | 0 | ND |
| linalyl acetate | 0.50162-0.93158 | 0.5712-1.0608 |
| linalyl butyrate | 0 | ND |
| l-limonene | 0.01491-0.02769 | ND |
| L-menthyl acetate | 0 | ND |
| L-Rose Oxide | 0.03297-0.06123 | ND |
| Maltol | 0 | ND |
| methional | 0 | ND |
| methionyl acetate (3-methylthio- | 0 | ND |
| propylacetate) | | |
| methionyl butyrate | 0 | ND |
| methyl acetate | 0 | ND |
| Methyl anthranilate | 0 | ND |
| methyl benzoate | 0 | ND |
| Methyl cinnamate | 0 | ND |
| methyl decanoate | 0 | ND |
| methyl laurate | 0 | ND |
| Methyl Octanoate | 0 | ND |
| methyl salicylate | 0 | ND |
| Methyl β-naphthyl ketone | 0 | ND |
| methyl-2-pyrrolyl ketone | 0 | ND |
| Myrcene | 0 | ND |
| nerol | 0.05306-0.09854 | ND |
| nerolidol | 0 | ND |
| nonanal | 0 | ND |
| octanal | 0 | ND |
| omega-pentadecalactone | 0 | ND |
| p,a-dimethylstyrene | 0 | ND |
| p-anisaldehyde | 0 | ND |
| p-cresol | 0 | ND |
| p-cymene | 0.00714-0.01326 | ND |
| Perillaldehyde | 0 | ND |
| Phenethyl 2-methylbutyrate | 0 | ND |
| Phenethyl Acetate (2-phenylethylacetate) | 0.32928-0.61152 | ND |
| phenethyl alcohol (2-phenylethanol) | 6.5765-12.2135 | ND |
| Phenethyl Butyrate | 0.01687-0.03133 | ND |
| phenethyl formate | 0 | ND |
| phenethyl octanoate | 0 | ND |
| phenethyl propionate | 0.03318-0.06162 | ND |
| phenethyl tiglate | 0 | ND |
| phenylacetaldehyde | 0 | ND |
| phenylacetaldehyde dimethyl acetal | 0 | ND |
| propanal | 0 | ND |
| propyl acetate | 0 | ND |
| propyl isovalerate | 0 | ND |
| salicylaldehyde | 0 | ND |
| Terpinolene | 0 | ND |
| tetrahydrolinalool | 0 | ND |
| thymol | 0 | ND |
| valencene | 0 | ND |
| valeraldehyde | 0 | ND |
| vanillyl butyl ether | 0 | ND |
| vanillyl ethyl ether | 0 | ND |
| whiskey lactone | 0 | ND |

ND = Not determined

TABLE 16
Non-volatile compounds measured in Moscato replica

| | Run 1 | Run 2 | Run 3 | Run 4 | Run 5 | Run 6 |
|---|---|---|---|---|---|---|
| 2,3,5,6-Tetramethylpyrazine | OC | OC | OC | NF | NF | NF |
| 2,3,5-trimethylpyrazine | NF | OC | OC | NF | NF | NF |
| 2,3-dimethylpyrazine | NF | NF | NF | NF | NF | NF |
| 2-Furoic acid | NF | NF | NF | OC | OC | OC |
| 2-Isopropylmalic acid | OC | OC | OC | 9.87E−02 | 9.72E−02 | 1.05E−01 |
| 3,4-dihydroxybenzoic acid | NF | NF | NF | OC | OC | OC |
| 4-Guanidinobutyric acid | NF | NF | NF | NF | NF | NF |
| Acetovanillone | NR | NR | NR | NF | NF | NF |
| Adenine | NF | NF | NF | NF | NF | NF |
| Adipic acid | NF | NF | NF | NF | NF | NF |
| Arabitol | OC | 2.05E−01 | OC | NF | NF | NF |
| arginine | 2.20E+00 | 2.16E+00 | 2.05E+00 | 1.24E+01 | 1.44E+01 | 1.15E+01 |
| asparagine | 2.82E−01 | OC | 2.86E−01 | 1.06E+00 | 1.15E+00 | 1.24E+00 |
| Aspartic acid | NF | NF | NF | NF | NF | NF |
| B-Alanine | 4.54E+00 | 4.29E+00 | 4.60E+00 | 8.16E+00 | 8.12E+00 | 9.16E+00 |
| betaine | NF | NF | NF | NF | NF | NF |
| Caffeic acid | NR | NR | NR | NF | NF | NF |
| Camphoric acid | OC | OC | OC | OC | OC | OC |
| Carnitine | NF | NF | NF | OC | OC | OC |
| Carnosine | NF | NF | NF | NF | NF | NF |
| Catechin | NF | NF | NF | NF | NF | NF |
| Choline | OC | OC | OC | OC | OC | OC |
| Cinnamic acid | NR | NR | NR | OC | OC | OC |
| Citric acid | 1.20E+02 | 1.19E+02 | 1.21E+02 | OC | OC | OC |
| Citrulline | NF | NF | NF | NF | NF | NF |
| Coumaric acid | NR | NR | NR | NF | NF | NF |
| cysteine | NF | NF | NF | NF | NF | NF |
| Cystine | NF | NF | NF | NF | NF | NF |
| Cytidine | NF | NF | NF | NF | NF | NF |
| Cytosine | NF | NF | NF | NF | NF | NF |
| D-Glucuronic acid | 7.76E+00 | 9.00E+00 | 8.10E+00 | 2.55E+00 | 1.57E+00 | 1.83E+00 |
| Ellagic acid | NF | NF | NF | 5.62E−02 | 5.62E−02 | 5.62E−02 |
| Epicatechin | NF | NF | NF | NF | NF | NF |
| Epicatechin gallate | NR | NR | NR | NF | NF | NF |
| Fructose | OC | OC | OC | 1.92E+04 | 1.78E+04 | 2.36E+04 |
| Fucose | 1.95E+02 | 1.89E+02 | 1.65E+02 | 1.58E+03 | 2.07E+03 | 1.56E+03 |
| Fumaric acid | 8.02E+00 | 7.62E+00 | 7.57E+00 | 6.85E+00 | 6.82E+00 | 7.68E+00 |
| GABA | NF | NF | NF | 6.71E+00 | 6.64E+00 | 7.20E+00 |
| Gallic acid | NF | NF | NF | NF | NF | NF |
| Glucosamine | NF | NF | NF | 1.76E+01 | 1.83E+01 | 1.73E+01 |
| Glucose | OC | OC | OC | 2.40E+04 | 2.42E+04 | 3.74E+04 |
| Glutamic acid | 1.53E+01 | 1.55E+01 | 1.57E+01 | 8.09E+01 | OC | OC |
| Glutamine | NF | NF | NF | 6.33E−02 | 6.80E−02 | 7.54E−02 |
| Glycine | 1.45E+00 | 1.49E+00 | 1.47E+00 | 1.36E+00 | 1.38E+00 | 1.49E+00 |
| Guanine | NF | NF | 3.92E+02 | NF | NF | NF |
| Hesperetin | OC | OC | OC | NF | NF | NF |
| Histidine | 1.98E+00 | 1.96E+00 | 1.96E+00 | 3.12E+00 | 3.25E+00 | 3.79E+00 |
| Homoserine | NF | NF | NF | NF | NF | NF |
| isoleucine | 2.44E+01 | 2.44E+01 | 2.44E+01 | 8.14E+00 | 8.27E+00 | NF |
| Kynurenic acid | NR | NR | NR | NF | NF | NF |
| Lactic acid | 4.30E+01 | 4.12E+01 | 4.09E+01 | NF | NF | NF |
| Leucine | 7.41E+00 | 7.03E+00 | 7.47E+00 | 2.82E+01 | 2.89E+01 | 2.95E+01 |
| Lysine | OC | OC | OC | 1.34E+01 | 1.37E+01 | 1.39E+01 |
| Malic acid | 3.00E+03 | 2.97E+03 | 2.89E+03 | OC | OC | OC |
| Mannitol | 5.37E+01 | 5.23E+01 | 5.22E+01 | 9.54E+01 | 9.73E+01 | 1.00E+02 |
| Methionine | NF | NF | NF | NF | NF | NF |
| Methyl Gallate | NF | NF | NF | NF | NF | NF |
| Methyl 2-pyrrolyl ketone | NF | NF | NF | NF | NF | NF |
| Myo-Inositol | OC | OC | OC | NF | NF | NF |
| Ornithine | NF | NF | NF | NF | NF | NF |
| Pantothenic acid | NR | NR | NR | OC | OC | OC |
| Phenylalanine | 3.92E+00 | 3.90E+00 | 3.88E+00 | 1.23E+01 | 1.27E+01 | 1.33E+01 |
| Pipecolinic acid | NF | NF | NF | NF | NF | NF |
| Piperine | NF | NF | OC | NF | NF | NF |
| Polydatin | NR | NR | NR | NF | NF | NF |
| proline | 1.35E+02 | 1.34E+02 | 1.34E+02 | OC | OC | OC |
| Propyl gallate | NF | NF | NF | NF | NF | NF |
| Pyridine | NF | NF | NF | NF | NF | NF |
| Pyridoxine | NF | NF | NF | NF | NF | NF |
| Pyruvic acid | NF | NF | NF | 1.43E−01 | 4.04E−01 | NF |
| Quercetin | OC | OC | OC | OC | OC | OC |
| Quinic acid | NF | NF | NF | NF | NF | NF |
| Resveratrol | NF | NF | NF | NF | NF | NF |
| Rhamnose | 4.55E+01 | 4.33E+01 | 3.87E+01 | NF | NF | NF |
| Ribose | NF | NF | NF | NF | NF | NF |
| Rutin | NF | NF | NF | NF | NF | NF |
| Salicylic acid | OC | OC | OC | OC | OC | OC |
| Serine | NF | NF | NF | NF | NF | 3.44E−01 |
| Sinapinic acid | OC | NF | NF | NF | NF | NF |
| Sorbic acid | NF | NF | NF | NF | NF | NF |
| Sorbitol | NR | NR | NR | 1.98E+02 | 2.21E+02 | 2.31E+02 |
| Succinic acid | 1.75E+02 | 1.71E+02 | 1.70E+02 | 9.45E+01 | 9.12E+01 | 7.72E+01 |
| Syringaldehyde | NR | NR | NR | NF | NF | NF |
| Syringic acid | NR | NR | NR | NF | NF | NF |
| Tartaric acid | 5.09E+03 | 5.04E+03 | 4.93E+03 | OC | OC | OC |
| Threonine | 3.11E+00 | 3.25E+00 | 3.31E+00 | 4.27E+00 | 4.37E+00 | 4.88E+00 |
| Trans-4-hydroxyproline | OC | OC | OC | NF | NF | NF |
| Trans-Ferulic acid | OC | OC | OC | OC | OC | OC |
| Tryptamine | NF | NF | NF | NF | NF | NF |
| tryptophan | 4.45E+00 | 4.70E+00 | 4.76E+00 | 5.18E+00 | 5.22E+00 | 5.28E+00 |
| Tyramine | NF | NF | NF | NF | NF | NF |
| Tyrosine | 7.78E+00 | 7.63E+00 | 7.61E+00 | 1.01E+01 | 1.00E+01 | 1.09E+01 |
| Uracil | NF | NF | NF | NF | NF | NF |
| valine | 3.17E+02 | 3.19E+02 | 3.20E+02 | 3.90E+00 | 2.95E+00 | 3.40E+00 |
| Vanillic acid | NR | NR | NR | OC | NF | NF |
| Vanillin | NR | NR | NR | OC | OC | OC |
| Xylose | NR | NR | NR | 1.49E+04 | 1.62E+04 | 1.75E+04 |

NR = Not run
NF = Not found
OC = Outside of standard curve

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. An alcoholic beverage replica comprising:
ethanol;
water; and
one or more additional volatile organic compounds (VOCs), wherein the one or more additional VOCs comprise at least one VOC that is not present in a corresponding traditional alcoholic beverage.

2. The alcoholic beverage replica of claim 1, wherein the one or more additional VOCs do not comprise at least one VOC that is present in a corresponding traditional alcoholic beverage.

3.-4. (canceled)

5. The alcoholic beverage replica of claim 1, wherein the at least one VOC that is not present in a corresponding traditional alcoholic beverage is selected from the group consisting of 1 para-menthene-8-thiol, 2 isopropyl-4-methyl thiazole, 3 phenylpropanal, 4,5,6,7-tetrahydro-3,6-dimethylbenzofuran, 5 methyl-2-phenyl-2-hexenal, allyl hexanoate, cis-3-hexenyl valerate, methionyl butyrate, methyl-2-pyrrolyl ketone, omega-pentadecalactone, phenethyl tiglate, and combinations thereof.

6. The alcoholic beverage replica of claim 1, wherein the one or more additional VOCs do not comprise at least one VOC that is present in a corresponding traditional alcoholic beverage, and wherein the at least one VOC that is present in a corresponding traditional alcoholic beverage is selected from the group consisting of 2,4,6-trimethylphenol (mesitol), 5-ethyl-3-hydroxy-4-methyl-2(5H)-furanone (maple furanone), 6-methyl-5-hepten-2-one, b-caryophellene, cis-2-hexenol, hexadecanol, methyl cyclopentenolone, nonanoic acid, and terpinolene.

7. The alcoholic beverage replica of claim 1, wherein the one or more additional VOCs comprise:
an ester;
an alcohol;
optionally, an acid;
optionally, an aldehyde, a ketone, or an aldehyde and a ketone;
optionally, a terpene, an isoprenoid, or a terpene and an isoprenoid;
optionally, a phenol;
optionally, a lactone;
optionally, an amine, a pyrazine, or an amine and a pyrazine;
optionally, a thiol, a thiazole, a sulfide, or any combination thereof;
optionally, an ether;
optionally, an acetal; and
optionally, a furan.

8. The alcoholic beverage replica of claim 1, wherein the one or more additional VOCs comprise one or more esters.

9. The alcoholic beverage replica of claim 8, wherein the one or more esters are selected from the group consisting of 2-methylbutyl acetate, 2-methylbutyl isovalerate, 2-phenylethylacetate, amyl butyrate, benzyl acetate, butyl acetate, butyl formate, butyl isovalerate, cis-3-hexenyl acetate, diethyl malate, diethyl succinate, dimethyl anthranilate, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl salicylate, ethyl undecanoate, ethyl valerate, ethyl(methylthio) acetate, ethyl-2-mercaptopropionate, ethyl-2-methylbutyrate, ethyl-3-hydroxybutyrate, ethyl-trans-2-butenoate, ethyl-trans-3-hexenoate, geranyl acetate, heptyl acetate, hexyl acetate, hexyl hexanoate, isoamyl acetate, isoamyl hexanoate, isoamyl isobutyrate, isoamyl isovalerate, isoamyl octanoate, isobutyl acetate, linalyl acetate, linalyl butyrate, linalyl formate, methyl acetate, methyl anthranilate, methyl decanoate, methyl dihydrojasmonate, methyl hexanoate, methyl laurate, methyl octanoate, methyl salicylate, methyl vanillate, octyl acetate, phenethyl acetate, phenethyl butyrate, phenethyl formate, phenethyl isobutyrate, phenethyl octanoate, phenethyl propionate, propyl acetate, propyl butyrate, propyl hexanoate, and mixtures thereof.

10. The alcoholic beverage replica of claim 8, wherein the one or more esters are present in a total amount of about 0.009 mg/L to about 1.5 g/L.

11. The alcoholic beverage replica of claim 1, wherein the one or more additional VOCs comprise one or more acids.

12. The alcoholic beverage replica of claim 11, wherein the one or more acids are selected from the group consisting of 3,7-dimethyl-6-octanoic acid, 3,7-dimethyl-6-octenoic acid, butyric acid, decanoic acid, hexanoic acid, isobutyric acid, isovaleric acid, nonanoic acid, octanoic acid, propanoic acid, and mixtures thereof.

13. The alcoholic beverage replica of claim 11, wherein the one or more acids are present in a total amount of about 0.03 mg/L to about 325 mg/L.

14. The alcoholic beverage replica of claim 1, wherein the one or more additional VOCs comprise one or more alcohols.

15. The alcoholic beverage replica of claim 14, wherein the one or more alcohols are selected from the group consisting of 1-decanol, 1-octanol, 1-octen-3-ol, 2-(methylthio)ethanol, 2-methyl-1-butanol, 2-phenylethanol, 3-(methylthio)-1-propanol, 3-methyl-1-pentanol, amyl alcohol, benzyl alcohol, butanol, cis-2-hexenol, cis-3-hexen-1-ol, DL-3-methyl-2-butanol, hexadecanol, hexanol, isoamyl alcohol, isobutanol, propanol, trans-2-hexen-1-ol, and mixtures thereof.

16. The alcoholic beverage replica of claim 13, wherein the one or more alcohols are present in a total amount of about 0.08 mg/L to about 4.5 mg/L.

17. The alcoholic beverage replica of claim 1, wherein the one or more additional VOCs comprise one or more aldehydes or ketones.

18. The alcoholic beverage replica of claim 17, wherein the one or more aldehydes or ketones are selected from the group consisting of 2,3-pentadione, 2-heptanone, 2-methylbutyraldehyde, 2-nonanone, 2-undecanone, 3-nonen-2-one, 5-ethyl-3-hydroxy-4-methyl-2(5H)-furanone (maple furanone), 5-methyl furfural, 6-methyl-5-hepten-2-one, acetaldehyde, acetoin, acetophenone, benzaldehyde, cinnamaldehyde, damascenone, diacetyl, furfural, isobutyraldehyde, isovaleraldehyde, maltol, methional, methyl cyclopentenolone, methyl β-naphthyl ketone, nonanal, p-anisaldehyde, phenylacetaldehyde, salicylaldehyde, trans-2-heptenal, trans-2-hexen-1-al, trans-2-pentenal, valeraldehyde, and mixtures thereof.

19. The alcoholic beverage replica of claim 17, wherein the one or more aldehydes or ketones are present in a total amount of about 0.02 mg/L to about 14 mg/L.

20. The alcoholic beverage replica of claim 1, wherein the one or more additional VOCs comprise one or more terpenes or isoprenoids.

21. The alcoholic beverage of claim 20, wherein the one or more terpenes or isoprenoids are selected from the group consisting of (−)alpha-pinene, (−)cis-rose-oxide, 3-carene, 4-carvomenthenol, 4-ethylguaiacol, a-ionone, a-phellandrene, a-terpineol, b-caryophellene, beta pinene, beta-ionone, carvone, citral, citronellol, D-camphor, eucalyptol, farnesol, gamma-terpinene, geraniol, geranyl acetone, isoborneol, limonene, linalool, linalool oxide, myrcene, myrtenol, nerol, nerolidol, p,a-dimethylstyrene, p-cymene, terpinolene, and mixtures thereof.

22. The alcoholic beverage replica of claim 20, wherein the one or more terpenes or isoprenoids are present in a total amount of about 0.0002 mg/L to about 95 mg/L.

23. The alcoholic beverage replica of claim 1, wherein the one or more additional VOCs comprise one or more phenols.

24. The alcoholic beverage replica of claim 23, wherein the one or more phenols are selected from the group consisting of 2,4,6-trimethylphenol (mesitol), 2-methoxy-4-methylphenol, 2-methoxy-4-propyl-phenol, 4-ethylphenol, eugenol, guaiacol, p-cresol, and mixtures thereof.

25. The alcoholic beverage replica of claim 23, wherein the one or more phenols are present in a total amount of about 0.00007 mg/L to about 5 mg/L.

26. The alcoholic beverage replica of claim 1, wherein the one or more additional VOCs comprise one or more lactones.

27. The alcoholic beverage replica of claim 26, wherein the one or more lactones are selected from the group consisting of delta-decalactone, gamma-decalactone, gamma-hexalactone, gamma-nonalactone, gamma-octalactone, gamma-undecalactone, Jasmine lactone, whiskey lactone, and mixtures thereof.

28. The alcoholic beverage replica of claim 26, wherein the one or more lactones are present in a total amount of about 0.00007 mg/L to about 10 mg/L.

29. The alcoholic beverage replica of claim 1, wherein the one or more additional VOCs comprise one or more amines or pyrazines.

30. The alcoholic beverage replica of claim 29, wherein the one or more amines or pyrazines are selected from the group consisting of 2-acetylpyridine, 2-isobutyl-3-methoxypyrazine, 2-isopropyl-3-methoxypyrazine, and mixtures thereof.

31. The alcoholic beverage replica of claim 29, wherein the one or more amines or pyrazines are present in a total amount of about 0.00007 mg/L to about 0.09 mg/L.

32. The alcoholic beverage replica of claim 1, wherein the one or more additional VOCs comprise one or more thiols, thiazoles, or sulfides.

33. The alcoholic beverage replica of claim 32, wherein the one or more thiols, thiazoles, or sulfides are selected from the group consisting of 3-mercaptohexylacetate, dimethyl sulfide, furfuryl mercaptan, and mixtures thereof.

34. The alcoholic beverage replica of claim 32, wherein the one or more thiols, thiazoles, or sulfides are present in a total amount of about 0.00007 mg/L to about 0.45 mg/L.

35. The alcoholic beverage replica of claim 1, wherein the one or more additional VOCs comprise one or more ethers.

36. The alcoholic beverage replica of claim 35, wherein the one or more ethers comprise vanillyl ethyl ether.

37. The alcoholic beverage replica of claim 35, wherein the one or more ethers are present in a total amount of about 0.01 to about 0.05 mg/L.

38. The alcoholic beverage replica of claim 1, wherein the one or more additional VOCs comprise one or more acetals.

39. The alcoholic beverage replica of claim 38, wherein the one or more acetals are selected from the group consisting of acetal, acetaldehyde diethyl acetal, phenethyl acetaldehyde dimethyl acetal, and mixtures thereof.

40. The alcoholic beverage replica of claim 38, wherein the one or more acetals are present in an amount of about 0.15 mg/L to about 28 mg/L.

41. The alcoholic beverage replica of claim 1, wherein the one or more additional VOCs comprise one or more furans.

42. The alcoholic beverage replica of claim 41, wherein the one or more furans comprise 2-pentyl furan.

43. The alcoholic beverage replica of claim 1, wherein the one or more additional VOCs comprise at least 5 compounds selected from the group consisting of 1-decanol, 1-octanol, 1-octen-3-ol, 2,3-pentadione, 2,4,6-trimethylphenol (mesitol), 2-heptanone, 2-isopropyl-3-methoxypyrazine, 2-methyl-1-butanol, 2-methylbutyl acetate, 2-methylbutyraldehyde, 2-phenylethanol, 2-phenylethylacetate, 2-undecanone, 3-(methylthio)-1-propanol, 3,7-dimethyl-6-octanoic acid, 3,7-dimethyl-6-octenoic acid, 3-methyl-1-pentanol, 4-carvomenthenol, 4-ethylguaiacol, 4-ethylphenol, 5-ethyl-3-hydroxy-4-methyl-2(5H)-furanone (maple furanone), 5-methyl furfural, 6-methyl-5-hepten-2-one, acetal, acetaldehyde, acetaldehyde, diethyl acetal, acetophenone, amyl alcohol, a-phellandrene, a-terpineol, b-caryophellene, benzaldehyde, beta pinene, butanol, butyl acetate, butyl formate, butyric acid, cinnamaldehyde, cis-2-hexenol, citral, citronellol, damascenone, D-camphor, decanoic acid, delta-decalactone, diacetyl, diethyl malate, diethyl succinate, dimethyl anthranilate, dimethyl sulfide, DL-3-methyl-2-butanol, ethyl 3-hydroxyhexanoate, ethyl acetate, ethyl anthranilate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eugenol, farnesol, furfural, gamma-decalactone, gamma-hexalactone, gamma-nonalactone, gamma-octalactone, geraniol, geranyl acetone, guaiacol, hexadecanol, hexanol, hexyl hexanoate, isoamyl acetate, isoamyl alcohol, isoamyl octanoate, isobutanol, isobutyl acetate, isobutyraldehyde, isobutyric acid, isovaleraldehyde, isovaleric acid, limonene, linalool, linalool oxide, linalyl acetate, maltol, methional, methyl acetate, methyl anthranilate, methyl cyclopentenolone, methyl decanoate, methyl hexanoate, methyl laurate, methyl salicylate, methyl β-naphthyl ketone, myrtenol, nerol, nerolidol, nonanoic acid, octanoic acid, p,a-dimethylstyrene, p-cymene, phenethyl acetate, phenethyl formate, phenethyl isobutyrate, phenethyl octanoate, phenethyl propionate, phenylacetaldehyde, propanoic acid, propanol, propyl acetate, propyl butyrate, salicylaldehyde, terpinolene, trans-2-heptenal, trans-2-hexen-1-al, trans-2-hexen-1-ol, trans-2-pentenal, vanillyl ethyl ether, and whiskey lactone.

44. The alcoholic beverage replica of claim 1, wherein the one or more additional VOCs comprise at least 1 compound selected from the group consisting of (−)alpha-pinene, (−)cis-rose-oxide, 2-(methylthio)ethanol, 2-acetylpyridine, 2-isobutyl-3-methoxypyrazine, 2-methoxy-4-methylphenol, 2-methoxy-4-propyl-phenol, 2-methylbutyl isovalerate, 2-nonanone, 3-carene, 3-mercaptohexylacetate, 3-nonen-2-one, acetoin, a-ionone, amyl butyrate, benzyl acetate, benzyl alcohol, beta-ionone, butyl isovalerate, carvone, cis-3-hexen-1-ol, cis-3-hexenyl acetate, ethyl salicylate, ethyl(methylthio) acetate, ethyl-2-mercaptopropionate, ethyl-trans-2-butenoate, ethyl-trans-3-hexenoate, eucalyptol, furfuryl mercaptan, gamma-terpinene, gamma-undecalactone, geranyl acetate, heptyl acetate, hexanoic acid, hexyl acetate, isoamyl hexanoate, isoamyl isobutyrate, isoamyl isovalerate, isoborneol, jasmine lactone, linalyl butyrate, linalyl formate, methyl dihydrojasmonate, methyl octanoate, methyl vanillate, myrcene, nonanal, octyl acetate, p-anisaldehyde, p-cresol, phenethyl acetaldehyde dimethyl acetal, phenethyl butyrate, propyl hexanoate, valeraldehyde.

45. The alcoholic beverage replica of claim 1, further comprising one or more non-volatile compounds.

46. The alcoholic beverage replica of claim 45, wherein the one or more non-volatile compounds comprise one or more non-volatile compounds that are not present in a corresponding traditional alcoholic beverage.

47. The alcoholic beverage replica of claim 46, wherein the one or more non-volatile compounds that are not present in a traditional alcoholic beverage are selected from the group consisting of cysteine, cystine, epicatechin gallate, methyl 2-pyrrolyl ketone, and rutin.

48. The alcoholic beverage replica of claim 45, wherein the one or more non-volatile compounds do not comprise one or more non-volatile compounds that are present in a corresponding traditional alcoholic beverage.

49. The alcoholic beverage replica of claim 48, wherein the one or more non-volatile compounds that are present in a corresponding traditional alcoholic beverage are selected from the group consisting of 4-guanidinobutyric acid, adenine, cytidine, cytosine, homoserine, and uracil.

50. The alcoholic beverage of claim 45, wherein the one or more non-volatile compounds comprise at least 5 compounds selected from the group consisting of 2,3,5,6-tetramethylpyrazine, 2,3,5-trimethylpyrazine, 2,3-dimethylpyrazine, 2-isopropylmalic acid, 3,4-dihydroxybenzoic acid, 4-guanidinobutyric acid, acetic acid, acetovanillone, adenine, adipic acid, alanine, arabitol, arginine, aspartic acid, betaine, caffeic acid, camphoric acid, carnitine, catechin, choline, citric acid, citrulline, coumaric acid, cytidine, cytosine, D-glucuronic acid, disodium 5′ ribonucleotides (5′-guanylate & 5′-inosinate), ellagic acid, epicatechin, fructose, fucose, fumaric acid, GABA, galactose, gallic acid, glucose, glutamic acid, guanine, histidine, homoserine, kynurenic acid, lactic acid, lysine, malic acid, mannitol, methionine, methyl gallate, monosodium glutamate, inositol, phenylalanine, pipecolinic acid, proline, propyl gallate, pyridine, pyridoxine, pyruvic acid, quercetin, quinic acid, rhamnose, ribose, salicylic acid, serine, sorbitol, succinic acid, syringaldehyde, tartaric acid, trans-4-hydroxyproline, trans-ferulic acid, uracil, vanillic acid, and vanillin.

51. The alcoholic beverage replica of claim 45, wherein the one or more non-volatile compounds comprise at least 1 compound selected from the group consisting of 2-furoic acid, asparagine, beta-alanine, carnosine, cinnamic acid, D-gluconolactone (gluconic acid), glucosamine, glutamine, glycerol, glycine, hesperetin, isoleucine, leucine, mannose, ornithine, pantothenic acid, piperine, polydatin, resveratrol, sinapinic acid, sorbic acid, a surfactant, syringic acid, threonine, tryptamine, tryptophan, tyramine, tyrosine, valine, and xylose.

52. The alcoholic beverage replica of claim 45, wherein the non-volatile compounds comprise one or more compounds selected from the group consisting of a surfactant, gum arabic, and pectin.

53. A method of making an alcoholic beverage replica, the method comprising:
combining ingredients comprising:
water;
ethanol;
five or more additional VOCs, wherein at least five of the five or more additional VOCs are provided as separate ingredients.

54. (canceled)

55. The alcoholic beverage replica of claim 45, wherein the one or more non-volatile compounds comprise a sugar or a sugar alcohol, an acid, a pH-modifying salt, a nucleotide monophosphate, an amino acid, or a combination thereof.

56. The alcoholic beverage replica of claim 55, wherein the acid comprises tartaric acid, malic acid, citric acid, succinic acid, lactic acid, acetic acid, or a combinations thereof.

57. The alcoholic beverage replica of claim 55, wherein the sugar or sugar alcohol comprises glycerol, glucose, fructose, sorbitol, inositol, mannose, mannitol, or a combination thereof.

58.-64. (canceled)

65. A spirit or wine replica concentrate comprising:
ethanol;
water; and
one or more additional VOCs, wherein at least one of the one or more additional VOCs is present in a concentration of at least about 2-fold the concentration of the same VOC in a corresponding traditional spirit or wine.

66.-67. (canceled)
